(19) United States
(12) Patent Application Publication
(10) Pub. No.: US 2025/0005516 A1
(43) Pub. Date: Jan. 2, 2025

(54) ORDER FULFILLMENT TECHNIQUES

(71) Applicant: Thomas Francis, Dubuque, IA (US)

(72) Inventor: Thomas Francis, Dubuque, IA (US)

(21) Appl. No.: 18/756,033

(22) Filed: Jun. 27, 2024

Related U.S. Application Data
(60) Provisional application No. 63/510,480, filed on Jun. 27, 2023.

(51) Int. Cl. G06Q 10/087

(52) U.S. Cl. CPC G06Q 10/087

(57) ABSTRACT

A customer application renders a customer graphical user interface including a plurality of items for sale at a store and generates a customer order in response to input received from the customer. The customer order includes a plurality of ordered items for picking in the store. The customer application is configured to generate an order modification interface configured to receive at least one of addition modifications, deletion modifications, and substitution modifications. A computing system is configured to determine whether the customer order is eligible to be modified by the customer based on satisfaction of one or more modification eligibility conditions and send an eligibility determination to the customer device that indicates whether the customer order is eligible to be modified. The customer application is configured to receive customer input in the order modification interface that modifies the customer order when the customer order is eligible to be modified.

### CROSS-REFERENCE TO RELATED APPLICATION

This application claims the benefit of U.S. Provisional Application No. 63/510,480, filed on Jun. 27, 2023. The disclosure of the above application is incorporated herein by reference in its entirety.

### TECHNICAL FIELD

The disclosure relates to techniques for filling orders, and more particularly, to techniques for filling orders using mobile computing devices.

### BACKGROUND

Customers purchase products from a variety of different types of stores. Stores may sell a variety of different products or be limited to particular types of products. Example products include dry goods, grocery products, or any other items a customer may purchase. Different stores may have a variety of different sizes and layouts. Some stores may sell tens of thousands of products over a floor space covering tens of thousands of square feet. Stores may be referred to by different names, depending on the types of products sold at the store, the size of the store, the location of the store, and other factors. For example, a store may be referred to as a retail store, a grocery store, a supermarket, a hypermarket, a warehouse, a distribution facility, an outdoor market, or by another name.

Customers may interact with stores in a variety of different ways. In some scenarios, a customer may travel to the store and select products from within the store. Typically, the customer selects the desired products within the store and purchases the products at a checkout section of the store. In other scenarios, a customer may place an order for products from a location remote from the store (e.g., via the Internet or phone). In these scenarios, the purchased products may be shipped from the store to the customer's home.

### SUMMARY

In some examples, a system comprises a customer application and a computing system. The customer application is configured to render, on a customer device, a customer graphical user interface (GUI) including a plurality of items for sale at a store and generate a customer order in response to input received from the customer. The customer order includes a plurality of ordered items for picking in the store. The customer application is configured to generate an order modification interface configured to receive at least one of addition modifications, deletion modifications, and substitution modifications. The computing system is configured to determine whether the customer order is eligible to be modified by the customer based on satisfaction of one or more modification eligibility conditions and send an eligibility determination to the customer device that indicates whether the customer order is eligible to be modified, wherein the customer application is configured to receive customer input in the order modification interface that modifies the customer order when the customer order is eligible to be modified.

In some examples, an order filling system comprises a first entity system and a second entity system. The first entity system includes a first computing system and a first mobile computing device configured to be carried throughout a store by a first user. The second entity system includes a second computing system and a second mobile computing device configured to be used by a second user. The first computing system is configured to receive a customer order that includes a plurality of ordered items for picking in the store and allocate one or more tasks to the second entity system to be assigned to the second mobile computing device and performed by the second user, wherein the one or more tasks are associated with fulfilling the customer order. In some implementations, the one or more tasks include at least one of picking the plurality of ordered items and delivering the customer order to a customer location. In some implementations, the first computing system is configured to allocate picking a first portion of the plurality of ordered items to the second entity system, wherein the second entity system is configured to assign picking of the first portion of the plurality of ordered items to the second mobile computing device for picking by the second user. In some implementations, the first computing system is configured to allocate delivery of the customer order to the second entity system, wherein the second entity system is configured to assign delivery of the customer order to the second mobile computing device. In some implementations, the first computing system is configured to allocate the one or more tasks to the second entity system by sending a request to the second entity system for assistance in performing the one or more tasks, wherein the second entity system is configured to at least one of confirm or deny the request. In some implementations, the second mobile computing device is configured to render a GUI for the second user that includes a GUI element the second user may select to confirm that the second user intends on performing the allocated one or more tasks. In some implementations, the first computing system determines whether to allocate the one or more tasks based on at least one of a number of outstanding items to be picked at the store and a number of outstanding orders to be picked at the store. In some implementations, the first computing system determines whether to allocate the one or more tasks based on a number of available users at the store to pick items. In some implementations, the first computing system determines whether to allocate the one or more tasks to the second entity system based on data received from the second entity system. In some implementations, the data received from the second entity system includes a location of the second user. In some implementations, the first computing system is configured to determine whether to allocate delivery of the customer order to the second user based on the location of the second user relative to the store. In some implementations, the first computing system is configured to determine whether to allocate the one or more tasks based on whether the second user is on their way to the store. In some implementations, the first computing system is configured to determine whether to allocate the one or more tasks based on whether the second user is located in the store. In some implementations, the data received from the second entity system includes a route for the second user to pick items in the store, wherein the first computing system is configured to determine whether to allocate picking of a portion of the customer order to the second user based on the route for the second user relative to locations of items in the customer order. In some implementations, the first computing system is configured to provide credits to the second entity system in response to allocating the one or more tasks to the second entity system, wherein the credits indicate at least one of: a) a number of items picked, b) an number of orders delivered, and c) a cost of the allocated one or more tasks.

In some examples, a system comprises a computing system and a non-transitory computer-readable medium. The computing system is configured to determine whether recruitment conditions are satisfied, wherein satisfaction of the recruitment conditions indicate that the computing system should recruit a user to perform a task associated with fulfilling a customer order in a store. If recruitment conditions are satisfied, the computing system is configured to determine a set of potential users to be recruited, select a first user from the set of potential users for recruitment, and generate a recruitment request that requests the first user start the task associated with fulfilling the customer order. The non-transitory computer-readable medium comprises computer-executable instructions configured to cause a processing unit of a mobile device associated with the first user to render a task GUI for the task. In some implementations, the task includes at least one of picking the customer order, packing the customer order, and delivering the customer order. In some implementations, the recruitment conditions include a number of items to be picked in the store. In some implementations, the recruitment conditions include a number of pending orders for the store. In some implementations, the recruitment conditions include a number of current users in the store. In some implementations, the recruitment conditions include a number of items to be picked in the store relative to a number of current users in the store. In some implementations, the recruitment conditions include at least one of a picking rate for items in the store and a delivery rate for orders from the store. In some implementations, the recruitment conditions include an average order filling time for the store. In some implementations, the recruitment conditions include an average customer wait time for the store. In some implementations, the recruitment conditions include presence of one or more priority items in the customer order. In some implementations, the recruitment conditions include a total amount of movement needed for picking orders in the store. In some implementations, the set of potential users for recruitment for the task includes inactive users in the store that are not currently assigned tasks. In some implementations, the set of potential users for recruitment for the task include active users that are currently assigned other tasks. In some implementations, the computing system is configured to select the first user based on a location of the first user. In some implementations, the computing system is configured to select the first user based on the location of the first user relative to the task associated with fulfilling the customer order in the store. In some implementations, the computing system is configured to select the first user based on the location of the first user relative to one or more items in the customer order. In some implementations, the computing system is configured to send the recruitment request to the mobile device associated with the first user. In some implementations, the computing system is configured to send the recruitment request to an intermediate device that is different than the mobile device associated with the first user. In some implementations, the intermediate device is an additional mobile device carried by the first user. In some implementations, the intermediate device is an intercom device that produces an audible intercom recruitment request for the first user.

In some examples, a system comprises a computing system and a non-transitory computer-readable medium. The computing system is configured to determine whether dismissal conditions are satisfied, wherein satisfaction of the dismissal conditions indicate that the computing system should dismiss a user that is currently assigned one or more tasks in a store. If dismissal conditions are satisfied, the computing system is configured to determine a set of potential users to be dismissed, select a first user from the set of potential users for dismissal, and generate a dismissal command that removes a first task from the first user associated with a customer order. The non-transitory computer-readable medium comprises computer-executable instructions configured to cause a processing unit of a mobile device associated with the first user to render a task GUI for the first task. The computer-executable instructions are further configured to inform the first user that the first user is dismissed from performing the first task. In some implementations, the first task includes at least one of picking the customer order, packing the customer order, and delivering the customer order. In some implementations, the dismissal conditions include a number of items to be picked in the store. In some implementations, the dismissal conditions include a number of pending orders for the store. In some implementations, the dismissal conditions include a number of current users in the store. In some implementations, the dismissal conditions include a number of items to be picked in the store relative to a number of current users in the store. In some implementations, the dismissal conditions include at least one of a picking rate for items in the store and a delivery rate for orders from the store. In some implementations, the dismissal conditions include an average order filling time for the store. In some implementations, the dismissal conditions include an average customer wait time for the store. In some implementations, the dismissal conditions include presence of one or more priority items in the customer order. In some implementations, the dismissal conditions include a total amount of movement needed for picking orders in the store. In some implementations, the computing system is configured to select the first user based on a location of the first user. In some implementations, the computing system is configured to select the first user based on when the first user was assigned the first task. In some implementations, the computing system is configured to send the dismissal command to the mobile device associated with the first user. In some implementations, the computing system is configured to send the dismissal command to an intermediate device that is different than the mobile device associated with the first user. In some implementations, the intermediate device is an additional mobile device carried by the first user. In some implementations, the intermediate device is an intercom device that produces an audible intercom dismissal command for the first user.

In some examples, a system comprises a computing system, a first mobile device, and a second mobile device. The computing system is configured to select a plurality of tasks to be offered to one or more users. The first mobile device is used by a first user and is configured to wirelessly receive the plurality of tasks from the computing system, render the plurality of tasks on a first display screen of the first mobile device in a first task selection GUI, and for each task in the first task selection GUI, render an associated task claim GUI element, wherein selection by the first user of a first task claim GUI element for a first task indicates to the computing system that the first user intends on performing the first task. The second mobile device is used by a second user and is configured to wirelessly receive the plurality of tasks from the computing system and render the plurality of tasks on a second display screen of the second mobile device in a second task selection GUI, wherein selection by the first user of the first task claim GUI element for an associated first task causes the computing system to assign the first task to the first mobile device and instruct the second mobile device to remove the first task from the second task selection GUI. In some implementations, the first task is picking a customer order in a store. In some implementations, the first task is packing a customer order in a store. In some implementations, the first task is delivering a customer order from a store. In some implementations, the first task is providing customer assistance to a customer in a store. In some implementations, the first task selection GUI includes a picking task for a customer order in a store, a delivery task for the customer order, and a customer assistance task. In some implementations, the computing system is configured to select the plurality of tasks based on the locations of at least one of the first user and the second user. In some implementations, the computing system is configured to select the plurality of tasks based on historical behavior of at least one of the first user and the second user. In some implementations, the computing system is configured to select the plurality of tasks based on historical tasks performed by at least one of the first user and the second user. In some implementations, selection by the first user of the first task claim GUI element for the associated first task causes the computing system to assign future tasks to the first user of the same type as the first task. In some implementations, selection by the first user of the first task claim GUI element for the associated first task causes the computing system to assign future tasks to the first user that are included in the same location as the first task. In some implementations, the first task is picking a first customer order, wherein selection by the first user of the first task claim GUI element for the associated first task causes the computing system to assign future customer orders to the first user that include items in the same locations as the first customer order. In some implementations, the first task is a first customer order delivery task, wherein selection by the first user of the first task claim GUI element for the associated first task causes the computing system to assign other customer order deliveries to the first user based on the location of the first customer order delivery and the other customer order deliveries. In some implementations, the first mobile device is configured to render a first task rejection GUI element for a second task in the task selection GUI, wherein selection by the first user of the first task rejection GUI element indicates to the computing system that the first user does not intend to perform the second task, and wherein selection by the first user of the first task rejection GUI element causes the first mobile device to remove the second task from the task selection GUI interface. In some implementations, selection by the first user of the first task rejection GUI element causes the computing system to assign the second task to the second mobile device.

In some examples, a system comprises a first mobile device, a second mobile device, and a computing system. The first mobile device is configured to be moved throughout a store by a first user. The second mobile device is configured to be moved throughout the store by a second user. The second mobile device is configured to render a first GUI including a rush item request GUI element associated with a high priority item that is stocked in the store and detect user selection of the rush item request GUI element by the second user. User selection of the rush item request GUI element indicates that the second user is requesting the high priority item for immediately fulfilling a customer order. The second mobile device is further configured to, in response to detection of user selection of the rush item request GUI element, wirelessly transmit first data that indicates the high priority item is needed for fulfilling the customer order. The computing system is configured to wirelessly receive the first data transmitted from the second mobile device and send second data to the first mobile device, wherein the second data indicates the high priority item that is needed for fulfilling the customer order, wherein the first mobile device is configured to render the high priority item for viewing by the first user. In some implementations, the first mobile device is configured to render a task GUI associated with performing a task in the store and render the high priority item in the task GUI. In some implementations, the task GUI includes an item picking GUI for picking items in the store. In some implementations, the computing system is configured to send the second data to a plurality of additional mobile devices, wherein each of the additional mobile devices is configured to render the high priority item for viewing by respective users of the additional mobile devices. In some implementations, the first mobile device is configured to send third data to the computing system indicating that the first user has picked the high priority item. In some implementations, the computing system is configured to notify the plurality of additional devices that the high priority item has been picked, wherein each of the additional mobile devices is configured to remove the high priority item from view by the respective users in response to notice from the computing system. In some implementations, the first mobile device is configured to receive manual user input from the first user indicating that the first user has picked the high priority item. In some implementations, the first mobile device is configured to scan the high priority item to indicate that the first user has picked the high priority item. In some implementations, the computing system is configured to select the first mobile device to receive the second data based on one or more current tasks assigned to the first mobile device. In some implementations, the computing system is configured to select the first mobile device to receive the second data based on a current location of the first mobile device. In some implementations, the computing system is configured to select the first mobile device to receive the second data based on a predicted future location of the first mobile device. In some implementations, the computing system is configured to select the first mobile device to receive the second data based on the predicted future location of the first mobile device on an assigned picking route through the store. In some implementations, the second data includes text that indicates to the first user why the high priority item is classified as high priority, wherein the first mobile device is configured to render the text in association with the high priority item for viewing by the first user.

In some examples, a system comprises a first mobile device associated with a first user, a second mobile device associated with a second user, and a computing system. The computing system is configured to receive a first customer order and a second customer order from a first customer and a second customer, respectively. The computing system is configured to assign picking of the first customer order to the first mobile device, assign picking of the second customer order to the second mobile device, and determine that a first item picked by the second user for the second customer order should be used to fulfill the first customer order. The computing system is configured to send item transfer instructions to at least one of the first mobile device, the second mobile device, and an additional mobile device indicating that the first item should be transferred from its current location in a store to a location in the store for use in fulfilling the first customer order. The computing system is configured to send item replacement instructions to at least one of the first mobile device, the second mobile device, and the additional mobile device to pick a replacement item for the first item that was transferred to the first customer order. In some implementations, the second customer order is assigned to the second mobile device after picking of first customer order is started by the first user. In some implementations, the second customer order is assigned to the second mobile device after the first customer order has been completely picked by the first user. In some implementations, the computing system is configured to determine that the first item should be used to fulfill the first customer order in response to a manual request for the first item generated by the first customer. In some implementations, the computing system is configured to determine that the first item should be used to fulfill the first customer order in response to a manual request from at least one of the first mobile device, the second mobile device, and the additional mobile device. In some implementations, the computing system is configured to determine that the first item should be used to fulfill the first customer order in response to a determination that the first customer is in transit to the store. In some implementations, the computing system is configured to determine that the first item should be used to fulfill the first customer order in response to a determination that the first customer is located at the store. In some implementations, the computing system is configured to determine that the first item should be used to fulfill the first customer order in response to a determination that the first item is needed for immediate delivery to the first customer. In some implementations, the computing system is configured to determine whether the first item should be picked based on an estimated reduction in wait time for the first customer as a result of having the first item used to fulfill the first customer order. In some implementations, the computing system is configured to determine whether the first item should be picked based on an estimated increase in wait time for the second customer as a result of having the first item used to fulfill the first customer order. In some implementations, the computing system is configured to determine whether the first item should be picked based on an estimated time at which the replacement item will be picked. In some implementations, the computing system is configured to determine whether the first item should be picked based on an estimated time at which the first item will need to be replaced by the replacement item. In some implementations, at least one of the first mobile device, the second mobile device, and the additional mobile device are configured to scan the first item to indicate that the first item has been transferred to the first customer order and that the first customer has received the first item. In some implementations, at least one of the first mobile device, the second mobile device, and the additional mobile device are configured to scan the replacement item one or more times to indicate that the replacement item has been picked for the second customer order. In some implementations, the computing system is configured to receive confirmation from a customer computing device operated by the first customer that the first customer has received the first item.

In some examples, a system comprises a computing system and a mobile device including a display. The computing system is configured to store a location map for a store that includes a customer area and an alternative stocking area, wherein the location map defines a plurality of locations within the customer area and at least one location in the alternative stocking area. The computing system is configured to store associations between stocked items in the store and locations included in at least the customer area and the alternative stocking area, receive an electronic customer order that includes a plurality of ordered items for picking, and wirelessly transmit the electronic customer order. The mobile device is configured to wirelessly receive the electronic customer order, arrange the ordered items of the electronic customer order on the display based on locations of the ordered items in the store relative to the mobile device, and indicate, on the display, that some of the ordered items are located in the customer area and some of the ordered items are located in the alternative stocking area. In some implementations, the location map includes at least one of a backstock items location for backstock items, a customer-canceled items location for canceled customer items, and a customer-returned items location for returned customer items. In some implementations, the alternative stocking area includes a predicted item area, wherein the location map includes a predicted item location associated with the predicted item area, and wherein the predicted item area stores predicted items that are picked by users in response to a determination by the computing system that the items will be used to fulfill a future customer order. In some implementations, the computing system determines which items are stocked in the alternative stocking area based on manual user entry into one or more user devices by users in the store. In some implementations, the computing system determines which items are stocked in the alternative stocking area based on user device scans of the at least one location in the alternative stocking area and the associated items. In some implementations, the system further comprises an additional mobile device including an additional display, wherein the computing system is configured to send instructions to the additional mobile device to instruct a user of the additional mobile device to pick stocked items in the customer area for placement in the alternative stocking area. In some implementations, the computing system is configured to send instructions to the additional mobile device to instruct the user of the additional mobile device to pick items that are part of a current advertising campaign to customer devices. In some implementations, the computing system is configured to predict which stocked items will be ordered by customers in the future, wherein the instructions include a list of one or more of the items that are predicted to be ordered by customers in the future. In some implementations, the computing system is configured to predict which stocked items will be ordered by customers based on popularity of the items. In some implementations, popularity of the items is based on purchases of the items across a plurality of customers over a period of time. In some implementations, the computing system is configured to predict which stocked items will be ordered by customers based on items associated with the customers in customer applications that are not yet paid for by the customers. In some implementations, the items associated with the customers include items in online shopping carts in the customer applications. In some implementations, the computing system is configured to recommend items to customer devices in response to the items being included in the alternative stock locations.

### BRIEF DESCRIPTION OF THE DRAWINGS

FIG. 1 shows an example implementation of an order filling system (OFS) implemented in a store.

FIGS. 2A-2D illustrate a central computing system (CCS) and a third-party computing system (TPCS) communicating with a plurality of customer computing devices.

FIGS. 3A-3B show perspective views of example racks of a store.

FIGS. 4A-9 show example racks including location indicators in different locations.

FIGS. 10A-10C show example location indicators that transmit location signals.

FIGS. 11A-11C show different example readable codes which may be used as location indicators.

FIGS. 12-18 illustrate example arrangements of location indicators and associated location values that are associated with different areas of a store.

FIGS. 19A-22B show example stores and associated location maps.

FIGS. 23A-23B show an example store and an associated location map including items.

FIGS. 24-25 show functional block diagrams of example mobile scanning devices (MSDs).

FIGS. 26A-26I show example MSD form factors.

FIG. 27 shows the placement of customer orders with a CCS and wireless transmission of the customer orders to MSDs.

FIGS. 28A-28C show how multiple MSDs may display customer orders to users.

FIGS. 29A-29B show example communications between MSDs and a CCS.

FIGS. 30A-30C show the store and the MSDs of FIGS. 28A-28C after the MSDs have moved through the store and some items have been picked.

FIGS. 31A-31C show how a display of an MSD may be updated as the MSD is moved throughout a store.

FIGS. 32A-32E show displays of multiple MSDs and how the displays are updated when items are picked.

FIG. 33 is a method that describes operation of an OFS from the time a customer order is received until the order is provided to the customer.

FIG. 34 is a method that describes operation of an MSD configured to receive location signals.

FIG. 35 is a method that describes operation of an MSD configured to scan location indicators that include readable codes.

FIG. 36 is a method that describes operation of an MSD when items are picked by the MSD and other MSDs.

FIGS. 37A-37E show generation of an item association table and updating of the item association table.

FIG. 38 illustrates a method for generating an item association table.

FIGS. 39A-39C illustrate GUIs for an MSD in an item association mode.

FIG. 40 illustrates an example method for generating a location map.

FIGS. 41A-41D illustrate automatic generation of a location map using a single MSD.

FIGS. 42A-42F illustrate automatic generation of a location map using multiple MSDs.

FIGS. 43A-43B illustrate automatic updating of a location map upon the introduction of a location indicator to the store.

FIGS. 44A-44B illustrate automatic updating of a location map in response to loss of a location indicator.

FIGS. 45A-45B illustrate an example store including a plurality of items and an item adjacency map indicating adjacency of the items.

FIGS. 46A-46C illustrate example item scan time data and item adjacency maps generated based on the item scan time data.

FIG. 47 illustrates a method describing operation of an MSD configured to generate an item adjacency map indicating adjacency of a plurality of items.

FIG. 48 illustrates an example store including a plurality of items.

FIG. 49 illustrates an example item adjacency map indicating adjacency of a plurality of items included in a store.

FIG. 50 illustrates a method describing operation of an MSD configured to display a plurality of items based on an associated item adjacency map.

FIG. 51 illustrates an example CCS that generates tables and maps based on scan data from a plurality of MSDs.

FIG. 52 illustrates an example method for generating an item adjacency map.

FIGS. 53A-53B illustrate example clusters of items.

FIG. 54 illustrates an example method for generating, using, and updating an item adjacency map.

FIG. 55 illustrates an example method for using an item association table, location map, and item adjacency map.

FIGS. 56A-56D illustrate an example implementation of the OFS that uses location indicators and item adjacency mapping.

FIGS. 57A-57D illustrate an example implementation of the OFS that uses item adjacency and directionality to display items.

FIG. 58 illustrates an example image of a rack that includes a plurality of items.

FIGS. 59A-60B describe communication between MSDs and the CCS with respect to generating image-based maps and/or picking items based on acquired images.

FIGS. 61A-61B illustrate example camera directions, orientations, and fields of view.

FIGS. 62A-62B illustrate multiple images of items on the same rack.

FIG. 63 illustrates a box of KELLOGG'S FROOT LOOPS cereal including portions that may be used to identify the item.

FIGS. 64A-64C illustrate example store objects that the CCS and/or MSDs may identify.

FIGS. 65A-66B illustrate portions of stores that include object-based zones.

FIG. 67 illustrates an example method for generating maps including object-based zones.

FIGS. 68A-68B illustrate example methods for generating maps and picking items.

FIGS. 69A-69C illustrate features of an inventory system.

FIGS. 70A-70C illustrate features of an advertisement system.

FIGS. 71-89B illustrate example features of an OFS associated with generating routes, updating routes, and displaying routes in GUIs.

FIGS. 90-94B illustrate example stores and maps including sections.

FIGS. 95A-95B illustrate determination and usage of priority values for orders and items.

FIGS. 96A-96B illustrate example GUIs for picking a route associated with a plurality of sections.

FIGS. 97A-97B illustrate example GUIs that provide for user selection of picking locations and items.

FIGS. 98A-107 illustrate example features of the OFS directed to picking items, packing items, and tracking various parties, item carriers, and items.

FIG. 108 illustrates assignment of customer orders to users (e.g., pickers) based on user data associated with the users.

FIG. 109 illustrates an example method that describes selection of a picker according to their availability to pick customer orders (e.g., based on an order limit parameter).

FIG. 110 illustrates an example CCS that may assign items/orders to pickers based on one or more carriers associated with the pickers.

FIG. 111 illustrates an example method that describes features of a CCS that may assign items to pickers based on the carriers associated with the pickers.

FIG. 112 illustrates an example OFS using picker data and/or carrier data.

FIG. 113 is a method that describes example operation of the OFS illustrated and described with respect to FIG. 112.

FIGS. 114A-115B illustrate example techniques for instructing pickers where to place items in a packing area.

FIGS. 116A-116D illustrate example user interfaces for selecting carriers, picking items (e.g., for main orders and additional orders), and dropping off items in a packing area.

FIGS. 117-121 illustrate example features of the OFS directed to fulfilling unscheduled and scheduled orders for pickup or delivery.

FIGS. 122-128 illustrate example features of the OFS directed to fulfilling orders using multiple order fulfillment procedures.

FIG. 129 illustrates an example method that describes features of an example OFS that provides order modification functionality.

FIG. 130 illustrates an example scenario in which a customer places an order that the customer subsequently modifies.

FIG. 131 illustrates an example method for allocating tasks/orders among different entities.

FIG. 132 is a functional block diagram illustrating allocation of tasks between two entities.

FIGS. 133-134 illustrate example recruiting and dismissing methods.

FIG. 135 illustrates a method that describes example operations of an OFS that implements task claiming and task rejection features.

FIG. 136 illustrates example operation of two user devices and a CCS that implement claiming and rejecting tasks and roles in the OFS.

FIG. 137 illustrates a method that describes example communications between users in which a first user requests assistance with a task from one or more other users.

FIG. 138 illustrates example communications between user devices in which a first user requests additional tasks from other users.

FIG. 139 illustrates a method that describes example communications between user devices in which a first user requests that a rush item be picked immediately by another user.

FIG. 140 illustrates a method that describes example operations for transferring items between customer orders.

FIG. 141 illustrates a store that includes a packing area including an alternative stocking area.

### DETAILED DESCRIPTION

An order filling system (OFS) of the present disclosure may be used to fill orders (e.g., customer orders) for a variety of different products. The OFS may be implemented in a variety of different locations (e.g., a retail store, a warehouse, an outdoor market, etc.). Although the OFS is generally described herein as being implemented in a store (e.g., a grocery store) to fill customer orders, the OFS may be implemented in other locations to fill other types of orders. For example, the OFS may be implemented in a warehouse or other building to fill warehouse orders. As used herein, a “store” may generally refer to any location in which the OFS may be implemented (e.g., a retail store, grocery store, warehouse, outdoor market, etc.).

The OFS of the present disclosure may include a central computing system (CCS) and one or more mobile scanning devices (MSDs). In some implementations, the OFS may include one or more location indicators. Although the OFS may include one or more location indicators, some features of the OFS described herein may not require location indicators. Although various features (e.g., various computing operations) of the OFS may be attributed to the CCS and one or more MSDs, the CCS and MSDs may generally implement any of the OFS features (e.g., various computing operations) alone or in combination. For example, one or more MSDs may implement features attributed to the CCS herein. As another example, the CCS may implement one or more features attributed to the MSDs herein.

The CCS may receive electronic customer orders from customer computing devices (CCDs) via a computer network, such as the Internet. The CCDs may include any type of computing device used by customers to place orders with the CCS. For example, the CCDs may include cell phones, tablet computers, laptop computers, desktop computers, wearable computers, or other computing devices. Each of the customer orders may include one or more items located in the store (e.g., arranged on racks). An item may generally refer to any type of product that may be picked from the store (e.g., items for purchase by a customer and/or inventory included in a factory/warehouse). For example, an item may be a food product, a personal hygiene product, an electronic product, or any other product in inventory in the store.

The CCS, which may be located inside/outside the store, may wirelessly transmit the customer orders to one or more of the MSDs. For example, the CCS may include wireless communication functionality (e.g., BLUETOOTH, IEEE 802.11, cellular, etc.) for wirelessly transmitting the customer orders to the MSDs. The MSDs, which may be transported throughout the store by users, may wirelessly receive the customer orders and display the customer orders to the users so that the users may fill the customer orders transmitted to the MSDs. In some cases, the users may be employees (e.g., store employees/contractors) that transport the MSDs around the store while filling the customer orders displayed on the MSDs. In some examples, the MSDs may be configured to be held in the users' hands. In other examples, the MSDs may be placed in carts (e.g., a shopping cart, basket, or similar cart for carrying items), which may be pushed around the store by users while the users gather items to fill customer orders. In still other examples, the MSDs may be configured to attach to a user (e.g., around the forearm of a user or as a display worn on a user's head). In some implementations, the CCS is present in a location other than the store. In these implementations, the CCS transmits the customer orders to the MSDs in a similar manner as described herein using any of a variety of different wireless transmission techniques (e.g., via the Internet and an intermediate computing device that is located within the store or via cellular communication). Although users may refer to employees (e.g., store employees/contractors, or other pickers), users may also include customers that pick their own items in the store.

In some implementations, a user may transport items (e.g., picked items) throughout the store in one or more item carriers. Any object that a user may use to hold and transport items may be referred to generally as an “item carrier” or a “carrier.” Example item carriers may include, but are not limited to, carts, totes, tubs, baskets, boxes, bins, bags, and packs. Example carts may include, but are not limited to, wheeled carts, shopping carts, pushcarts, utility carts, multi-shelf carts, clothes hanger carts, or other types of carts. A user may pick items, place items in the cart, and move (e.g., push/pull) the cart throughout the store. Totes, tubs, baskets, boxes, and bins may refer to item carriers that can hold items and be carried by a user and/or placed on a cart for movement throughout the store. In some implementations, totes, tubs, baskets, boxes, and/or bins may include wheels for pulling on the ground. Totes, tubs, baskets, boxes, and bins may be made from plastic, wood, or other similar structural material. A bag or pack may refer to a carrier that the user can wear and/or place on a cart for movement throughout the store. An example bag/pack may include, but is not limited to, a shoulder bag, backpack, hip pack, duffel bag, or wheeled bag. Bags may be made from a variety of materials, such as thin plastic, textiles, or other materials. In some implementations, bags may be collapsible when not in use. In some implementations, an item carrier may include a pallet, or other type of object, that is transported using another device, such as a hand truck, pallet jack, or fork truck. In some implementations, item carriers may include powered item carriers that move throughout the store, such as fork trucks and automated robotic carriers (e.g., motorized carts).

In some cases, a user may transport items in multiple item carriers in the course of picking/packing. For example, the user may transport multiple item carriers at the same time. In one example, a user may push multiple carts while picking/packing. As another example, a user may push a cart and also carry a backpack or other bag while picking/packing. In some cases, a single “main item carrier” or “main carrier” may include multiple item carriers, referred to as “sub-carriers” or “subcarriers.” The main item carrier may transport the one or more associated sub-carriers. Separate sub-carriers may be transported on, or within, the main carrier. In one example, a single cart (e.g., a main carrier) may include a plurality of totes (e.g., a plurality of sub-carriers). Another example main carrier and sub-carrier scenario is a cart or tub that has divided portions. For example, a single cart may have permanent or adjustable dividers that form separate sub-carriers in the single cart. In this example, the cart may be referred to as a main carrier, and the separate divided portions may be referred to as sub-carriers. Another example item carrier may include a cart with multiple shelves. In some cases, each of the shelves may be sub-carriers. In other cases, a multi-shelf cart may be identified as a single carrier. Another example carrier/sub-carrier scenario may include a single bag main carrier that includes multiple pouches and/or smaller tote sub-carriers.

As described herein, the CCS may monitor users/MSDs that pick items, along with which carriers/sub-carriers are associated with the users/MSDs. For example, the CCS may monitor users, MSDs, and/or carriers/sub-carriers based on identifiers (IDs) associated with the users, MSDs, and/or carriers/sub-carriers. Monitoring users, MSDs, and carriers may help improve efficiency of the order filling operations (e.g., picking and/or packing efficiency). Although users may use a variety of different types of item carriers, in some cases, item carriers may generally be referred to herein as a “cart.”

In some cases, the customer may use an MSD owned by the store to pick their own customer orders. In some cases, the functionality of the MSD may be included on a CCD (e.g., a customer's smartphone). In these cases, the customer may place the order using their own CCD and then pick the order using their own CCD, which may have the functionality of an MSD described herein. In other cases, the customer may place their order using a first CCD (e.g., their laptop or desktop computer) and then pick the order using a second CCD (e.g., their smartphone).

The users may begin filling the customer orders by gathering (i.e., picking) the items displayed on the MSDs. After gathering the items, one or more of the users may assemble (e.g., pack) the customer orders from the gathered items (e.g., in a store packing area). Subsequently, the customer that placed the customer order with the CCS may receive the filled customer order. In some examples, the customer may pick up the filled customer order at the store. In other examples, the filled customer order may be delivered to the customer (e.g., at the customer's home).

Each of the items in the store may be associated with an item indicator (e.g., a barcode/sticker/RFID), which may be located along with the item, such as on the item (e.g., a barcode), attached to the item (e.g., a sticker/tag), or located with the item (e.g., an RFID tag within the item's box). In general, an item indicator may be any object or device that the MSDs/CCS can use to identify (e.g., uniquely identify) the item. For example, the item indicators may be barcodes or analogous indicators. In some examples, the MSDs may scan the item indicators (e.g., scan the barcodes) and identify the items based on the scanned item indicators. In other examples, the item indicators may generate item signals (e.g., via a RFID device). For example, the item indicators may wirelessly transmit the item signals. The MSDs may receive the transmitted item signals and determine one or more items located within the store based on the detected item signals. The item indicators may be scanned by the MSDs or may transmit item signals in a variety of different ways. Similarly, the MSDs may be configured to scan the item indicators or detect the transmitted item signals in a variety of different ways. Examples of item indicators, item signals, and of scanning the item indicators or detecting the item signals by an MSD are described hereinafter in more detail. In some examples, an item indicator is associated with a single item. In other examples, an item indicator is associated with multiple items. In still other examples, multiple item indicators are associated with a single item.

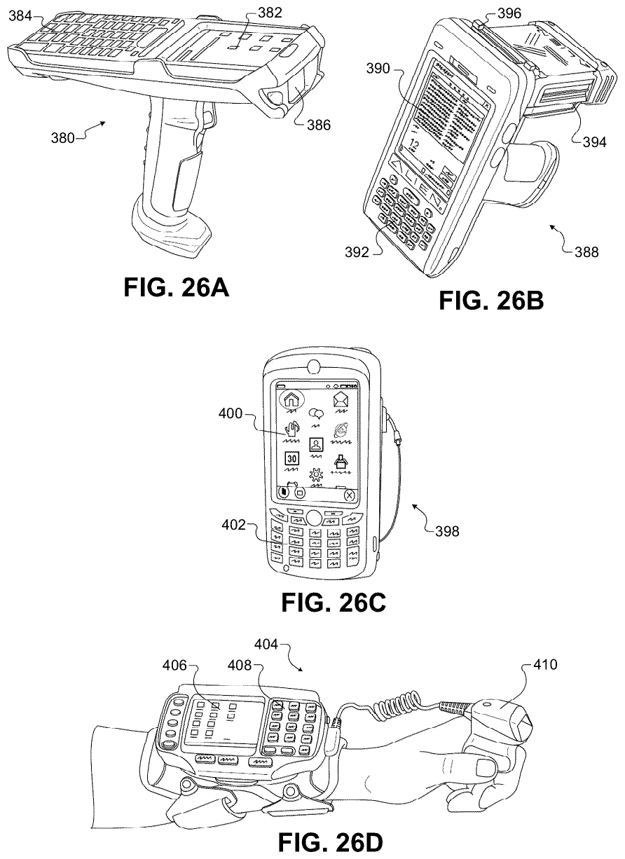

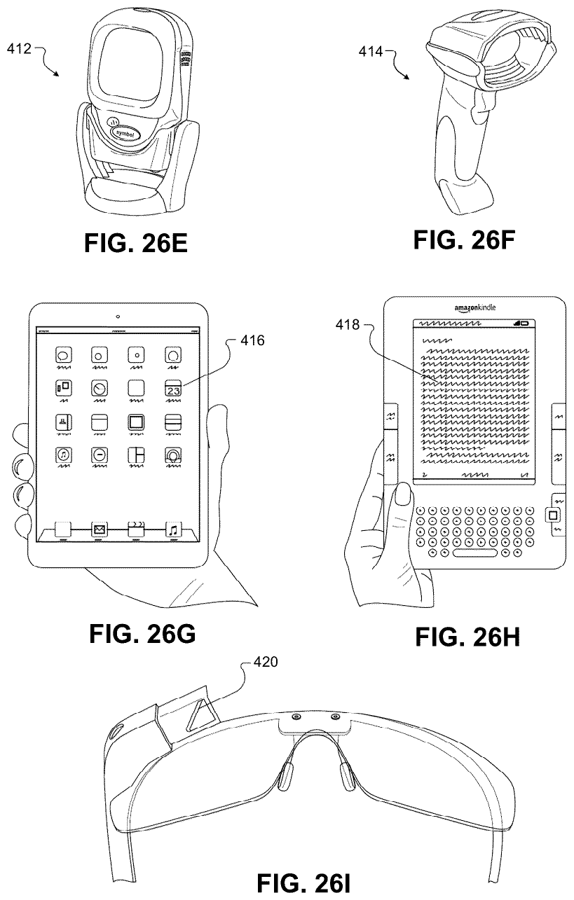

The MSDs may have a variety of different configurations. For example, the MSDs may have a variety of different form factors and different functionalities, depending on how the OFS is implemented in the store. As described herein, the MSDs may have handheld form factors and/or be configured to be placed in carts and pushed by a user. Example form factors are illustrated and described in FIGS. 26A-26I.

The MSDs may include wireless communication functionality (e.g., IEEE 802.11, BLUETOOTH, cellular, etc.) for communicating with the CCS, other MSDs, and/or other wireless devices. For example, the MSDs may receive customer orders wirelessly from the CCS/Internet and indicate to the CCS and/or other MSDs when items from the customer orders have been scanned.

An MSD may also include a display for displaying information to the user. In some examples, the display may be a liquid crystal display (LCD), an organic light-emitting diode (OLED) display, an electrophoretic display, or be implemented using other display technologies. For example, an MSD having a handheld form factor may include an LCD display. In other examples, an MSD having a head-mounted form factor may include a head-mounted display.

The MSD display may display the items of the customer orders to the users. Additionally, the MSD display may display information to the users other than the customer orders. The users may view the items on the display and subsequently pick the items from racks or other containers in the store. The users may then scan the items (e.g., scan barcodes on the items) and take the items to an area in the store (e.g., a collection/packing area) where the orders may be bagged for customer pickup or delivery. A location in the store where items of customer orders are collected and packed may be generally referred to herein as a “packing area.”

A customer order may include one or more items. For example, an item included in a customer order may be any product that a customer may purchase at the store. In some examples, the customer order may include a plurality of grocery items, such as cereal, canned food, chicken, milk, ice cream, eggs, fruits, vegetables, etc. In some examples, a customer order may include other items available at a retail store, such as personal hygiene items (e.g., shampoo, razor blades, and soap). A customer order may also include items such as movies, videogames, and electronic devices.

An item indicator corresponding to an item located within the store may be associated with an item identification code (hereinafter, “item ID code”). An item ID code, as used herein, may generally refer to any code (e.g., alphanumeric or other type of code) that may be associated with an item located within the store that serves to identify that item (e.g., uniquely identifies the item). Each item in the store may be associated with, or identified by, an item ID code. In some examples, an item ID code corresponding to an item may be acquired by scanning an item indicator associated with the item, such as a barcode (e.g., 1 or 2 dimensional barcode) present on the item. The barcode may be printed on packaging of the item and/or or printed on a sticker attached to packaging of the item. In other examples, the item ID code may be retrieved from an item signal transmitted by the item indicator, such as an RFID device (e.g., an RFID tag or other RFID form factor) attached to packaging of the item and/or included in packaging of the item. In still other examples, the item ID code may be a number (e.g., a product look-up code) printed on the item indicator (e.g., an adhesive label attached to the item) that may be entered manually by a user. Such a code may be used to identify produce items (e.g., fruits and vegetables), for example.

An MSD may acquire an item ID code in a variety of different ways, depending on the type of item ID code associated with the item. As described herein, an item ID code may be acquired from a barcode, an RFID tag, or may be manually entered by a user. In some examples, an MSD may include a scanning module configured to scan barcodes to retrieve the item ID code. In some examples, an MSD may include a scanning module configured to acquire item ID codes from RFID tags. For example, as described herein, the MSD may scan/acquire an item ID code corresponding to a particular item by detecting an item signal transmitted by an RFID tag associated with the item. In some examples, an MSD may include a user interface (e.g., touchscreen and/or buttons) configured to receive user input, such as manually-entered item ID codes. Although an item ID code may be acquired via a barcode, an RFID tag, or be manually-entered in some examples, it is contemplated that other types of item ID codes and modes of acquisition may be implemented. It is also contemplated that an MSD may be configured to acquire other types of item ID codes.

A customer order may be identified by a customer order identification number (hereinafter, “order ID number”). An order ID number may generally refer to any code (e.g., alphanumeric or other type of code) that may be associated with a customer order that serves to identify that customer order (e.g., uniquely identifies the customer order). In some examples, the CCS may assign each customer order a different order ID number that may uniquely identify that customer order. Each of the items included in the customer order may also be associated with the order ID number.

A store may include location indicators that indicate locations in the store. In some implementations, location indicators may transmit location signals that indicate the location within the store, such as a location within an aisle. In some implementations, location indicators (e.g., readable location indicators) may be objects (e.g., printed barcodes) including codes that indicate a location within a store. An MSD may scan (e.g., read) a readable location indicator to determine a location in the store associated with the location indicator.

The CCS and/or MSDs may generate item association tables that indicate the location of items relative to location indicators. For example, the item association tables may include items and associated location values determined from the location indicators near the items. The CCS and/or MSDs may also generate location maps that indicate how areas associated with location indicators (e.g., near location indicators) are arranged relative to one another in the store. The CCS and/or MSDs may map the store using the item association tables and location maps. The MSDs may use the item association tables and location maps to efficiently pick items from customer orders.

Additionally, or alternatively, the CCS and/or MSDs may generate item adjacency maps that indicate the location of items relative to one another. In some cases, the CCS and/or MSDs may generate the item adjacency maps based on scan times between consecutively scanned items. For example, scanning two items within less than a threshold amount of time may indicate that the items are near each other (e.g., less than a threshold distance from one another). The CCS and/or MSDs may generate and update item adjacency maps to indicate the items that are adjacent to one another. The CCS and/or MSDs may map the store using the item adjacency maps alone, or in combination with the item association tables and location maps. The CCS and/or MSDs may also use the item adjacency maps alone, or in combination with the item association tables, to efficiently pick items from customer orders.

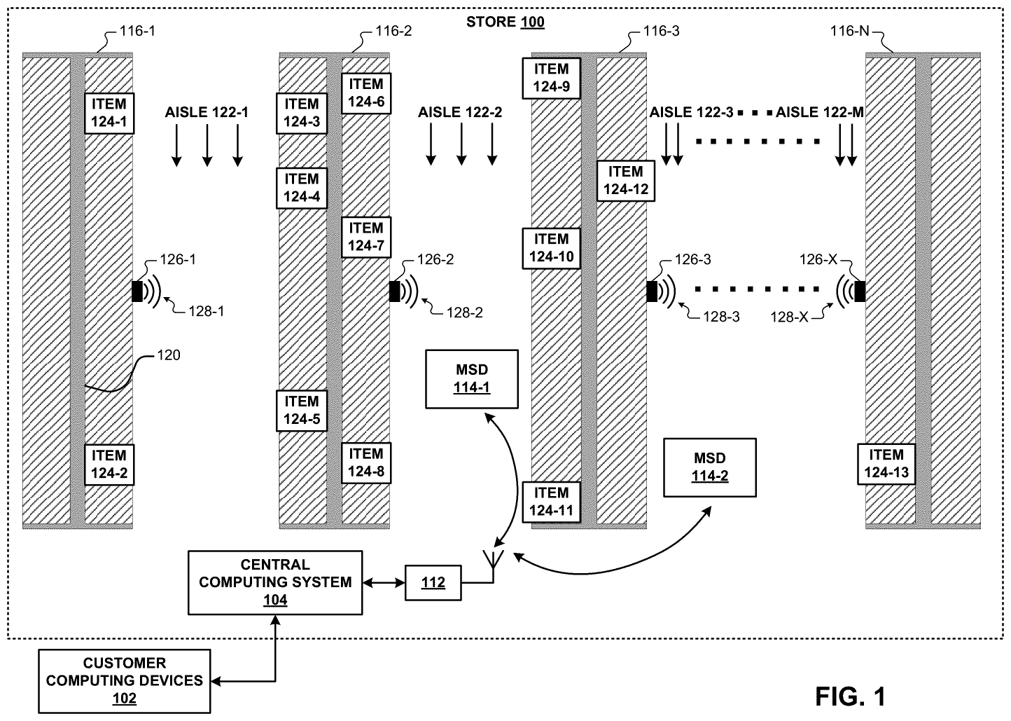

FIG. 1 shows an example implementation of an OFS implemented in a store 100. Store 100 is illustrated as a dotted box. Store 100 may represent any building structure that may house the items described herein. Although store 100 is generally described herein as a grocery store, supermarket, big-box store, hypermarket, etc., it is contemplated that the systems and methods for filling orders described herein may be applicable to other types of businesses and buildings, such as warehouses (e.g., a manufacturer or retailer warehouse), factories, distribution centers (e.g., a manufacturing or retail company distribution center), convenience stores, shopping plazas, or outdoor markets.

Customers may place customer orders to have filled at store 100 using CCDs 102. A CCS 104 may receive the customer orders from CCDs 102. A CCD 102 may include any electronic device that a customer may use to place a customer order. For example, a CCD 102 may include a desktop computer or a mobile computing device such as a laptop computer, smart phone, or tablet computer. In some examples, CCDs 102 may be devices that are located external to store 100. In these examples, CCS 104 may be configured to receive the customer orders from CCDs 102 via the Internet, or other computer network. In other examples, CCDs 102 may be located in store 100. For example, CCDs 102 may be mobile computing devices that customers have brought into store 100. As an additional example, store 100 may include CCDs 102 (e.g., desktops or kiosks) that may be used by the customers to place customer orders.

CCS 104 may implement a variety of different functions. In general, CCS 104 may refer to one or more of a variety of computing devices configured to provide the functionality described herein. For example, CCS 104 may include computer networks, servers (e.g., web servers), data stores, routers, software, etc. Although CCS 104 is illustrated as included in store 100 (e.g., FIG. 1), a portion of CCS 104, or all of CCS 104, may be located outside of store 100 in some examples. Put another way, CCS 104 may include one or more different computing devices that are located at one or more locations within or outside of store 100.

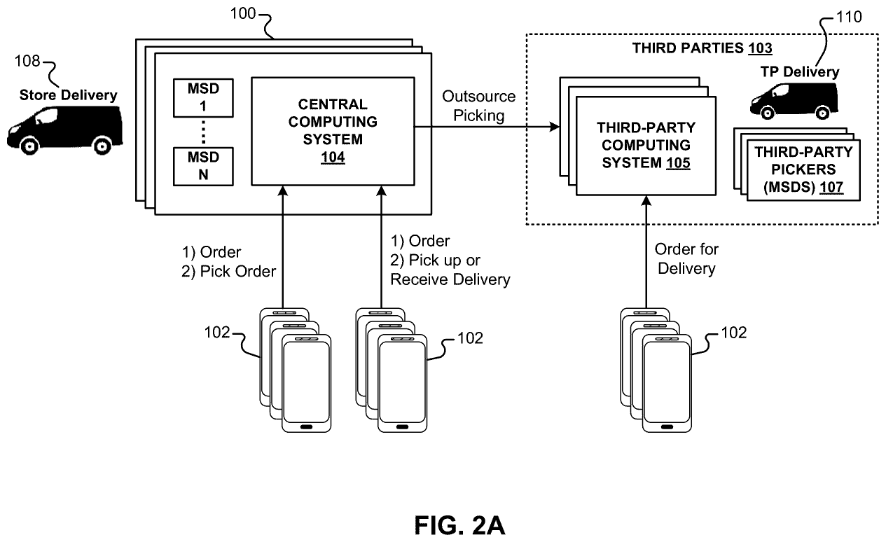

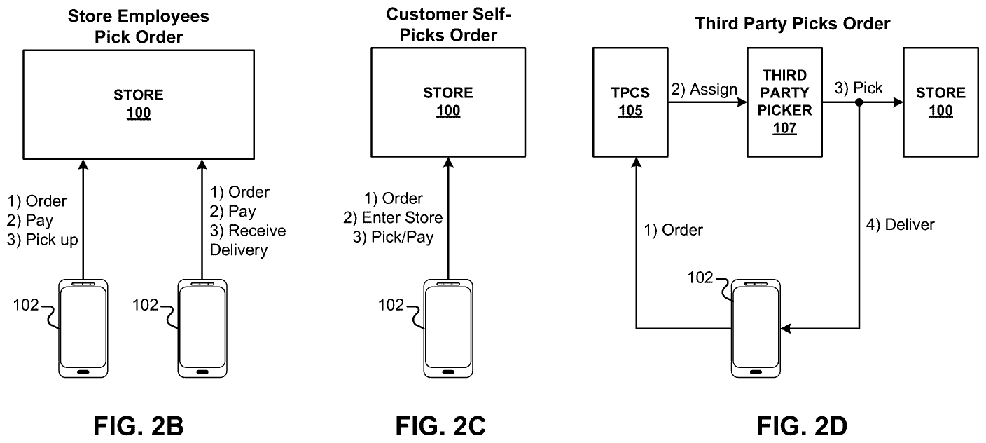

Referring to FIG. 2A, CCS 104 may be configured to communicate with a plurality of CCDs 102 via a computer network (e.g., the Internet). CCS 104 may provide electronic commerce (i.e., ecommerce) functionality so that customers may use CCDs 102 to place customer orders with store 100. In some examples, CCS 104 may provide online shopping functionality. For example, CCS 104 may provide a shopping website to CCDs 102 or provide other data to an application running on CCDs 102 so that customers may place electronic customer orders with store 100 using CCDs 102. The shopping website or other data provided to CCDs 102, may include information related to items the customer may order at store 100, such as item names, prices, availability, and reviews.

A customer may place an electronic customer order that includes one or more items. In some examples, the customer may place a customer order via a website accessed using a CCD 102. In other examples, a customer may place a customer order via a dedicated software application (e.g., an “app”) running on a CCD 102, such as a mobile phone or a tablet computer. CCS 104 may be configured to accept payment for the customer order (e.g., using a credit card). Additionally, or alternatively, a customer may pay for the customer order in store 100 (e.g., using a credit card, check, or cash).

After a customer order is placed, CCS 104 may transmit (e.g., wirelessly transmit) the customer order to one or more MSDs. The users in store 100 may then pick each of the items of the customer order and pack the items of the customer order for customer pickup or delivery. In some examples, CCS 104 may notify the customer that the customer order has been picked by sending a notification to a CCD 102 (e.g., a text message, email, and/or notification via a shopping application).

FIG. 2A illustrates a plurality of stores 100 that may each include a CCS 104 and MSDs for picking items. In some implementations, third parties 103 (e.g., business other than the store) may operate third-party computing systems 105 (“TPCS 105”) that include similar functionality as the CCS 104. TPCS 105 may be configured to communicate with CCDs 102 via a computer network (e.g., the Internet). TPCS 105 may provide electronic commerce (i.e., ecommerce) functionality so that customers may use CCDs 102 to place customer orders with the third parties. For example, TPCS 105 may provide online shopping functionality, such as a shopping website or other application running on CCDs 102 so that customers may place electronic customer orders with the third parties using CCDs 102. A customer may place an electronic customer order that includes one or more items with TPCS 105.

After a customer order is placed with TPCS 105, TPCS 105 may transmit the customer order to one or more third-party MSDs 107 being used by third-party pickers (e.g., employees/contractors of the third-party businesses). The third-party MSDs 107 may include similar form factors and functionality as MSDs used by the store 100. For example, third-party MSDs 107 may include personal computing devices (e.g., smartphones or tablets) and/or specific hardware for picking customer orders. The third-party pickers may be located remotely from the store 100 when the customer order is received. In these cases, third-party MSDs 107 may receive customer orders via the Internet or other communication system. After receiving a customer order, a third-party picker may pick each of the items of the customer order and pack the items of the customer order for delivery by the third party. For example, the third-party picker may deliver the picked order or have another third-party delivery service 110 deliver the order. In some cases, a customer may pick up an order at the store 100 that was picked by a third party. In some examples, TPCS 105 may notify the customer that the customer order has been picked by sending a notification to a CCD 102.

FIGS. 2A-2D illustrate a plurality of scenarios in which customer orders may be picked by one or more parties. In one example, a customer may use a CCD 102 to place a customer order with the CCS 104 and subsequently pick the order from the store. In this example, the customer may use their CCD that placed the customer order (or another CCD) as an MSD to pick the order. Alternatively, a customer may use an MSD provided by the store to pick their own order. In another example, a customer may use a CCD to place a customer order with the CCS that is then picked by users (e.g., employees) in the store 100. The customer may then pick up the filled customer order or have the order delivered. FIGS. 2B-2C further illustrate these scenarios.

In another example, the customer may use a CCD 102 to place a customer order with a TPCS 105. The TPCS 105 may assign the order to a third-party MSD 107 (e.g., a third-party picker) that may pick the items from the store 100. The third-party picker may then deliver the filled customer order to the customer. FIG. 2D further illustrates the scenario of a third-party picking service being used by the customer. FIG. 2A illustrates another example scenario in which the customer places a customer order with the CCS 104, and the CCS 104 subsequently outsources the picking of the order to a third party via the TPCS 105.

Note that FIG. 2A illustrates a plurality of delivery options. In some implementations, the store 100 may operate a delivery service 108 that delivers customer orders to the customers. In other implementations, the third-party pickers 107 may deliver the customer orders to the customers. In other implementations, third parties may operate delivery services 110 (e.g., delivery-only services) that deliver customer orders for the store 100 and/or other third-party pickers.

The various features (e.g., mapping/picking) of the OFS attributed to the CCS and/or MSDs herein may also be provided by the TPCS, third-party MSDs, and CCDs. For example, the TPCS may receive customer orders, store one or more tables and maps for one or more stores, and send the tables and maps to store MSDs, third-party MSDs, and/or CCDs. As another example, any features of the CCS and/or MSDs described herein, such as processing and communication features, may be implemented by the TPCS and/or the third-party MSDs. As another example, the CCS and/or TPCS may communicate with the MSDs, third-party MSDs, and/or CCDs in a similar manner described herein with respect to the CCS and the MSDs.

Referring back to FIG. 1, the OFS may include a wireless communication system 112 (hereinafter “communication system 112”) configured to provide wireless communication functionality within store 100. Communication system 112 may represent electronic hardware and software that provides wireless communication functionality with a plurality of wireless devices within store 100. For example, communication system 112 may include one or more wireless routers, antennas, and other devices that facilitate communication with wireless devices in store 100. In some examples, communication system 112 may provide wireless communication using BLUETOOTH, IEEE 802.11, and/or another wireless communication technology. In some examples, the one or more MSDs may communicate via a communication system that includes components that are external to store 100, such as via cellular communication.

The OFS includes one or more MSDs (e.g., MSD 114-1 and/or MSD 114-2). MSD 114-1 and MSD 114-2 may be referred to collectively as “MSDs 114.” MSDs 114 may be transported throughout store 100 by users. Although two MSDs 114 are illustrated in FIG. 1, it is contemplated that more than two MSDs may be included in the OFS of the present disclosure. It is also contemplated that only a single MSD may be used in some implementations of the OFS of the present disclosure.

Communication system 112 may communicate with MSDs 114. For example, communication system 112 may transmit data (e.g., customer orders) to MSDs 114 and receive data from MSDs 114. Communication system 112 may also communicate with CCS 104. For example, communication system 112 may receive data from CCS 104 and transmit the received data to MSDs 114. As another example, communication system 112 may receive data from MSDs 114 and transmit data to CCS 104. Accordingly, MSDs 114 may communicate (e.g., transmit/receive data) with CCS 104 via communication system 112. In some implementations, CCS 104 may communicate with MSDs 114 via communication systems outside of store 100, such as via cellular communication.

In some implementations, the users (e.g., pickers) and their MSDs (e.g., cell phones) may be located outside of the store. For example, the users may be employees of the store that are offsite performing other services, such as delivering filled orders. As another example, the users may be store employees/contractors that pick/deliver items for the one or more stores. In these cases, a user MSD may receive a customer order from the Internet (e.g., via a cellular connection) and use their MSD (e.g., cell phone) in the store to pick the customer order.

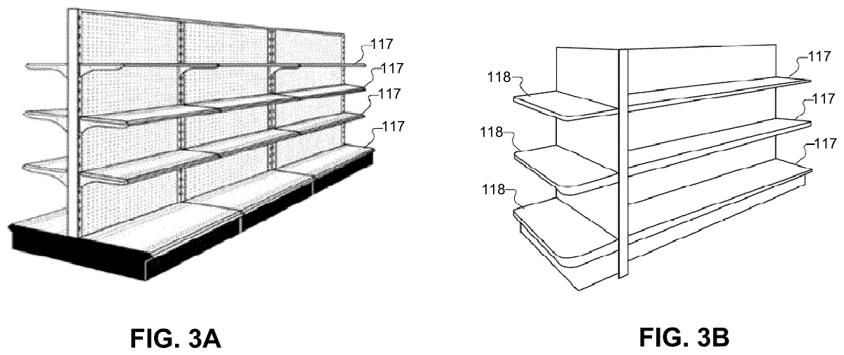

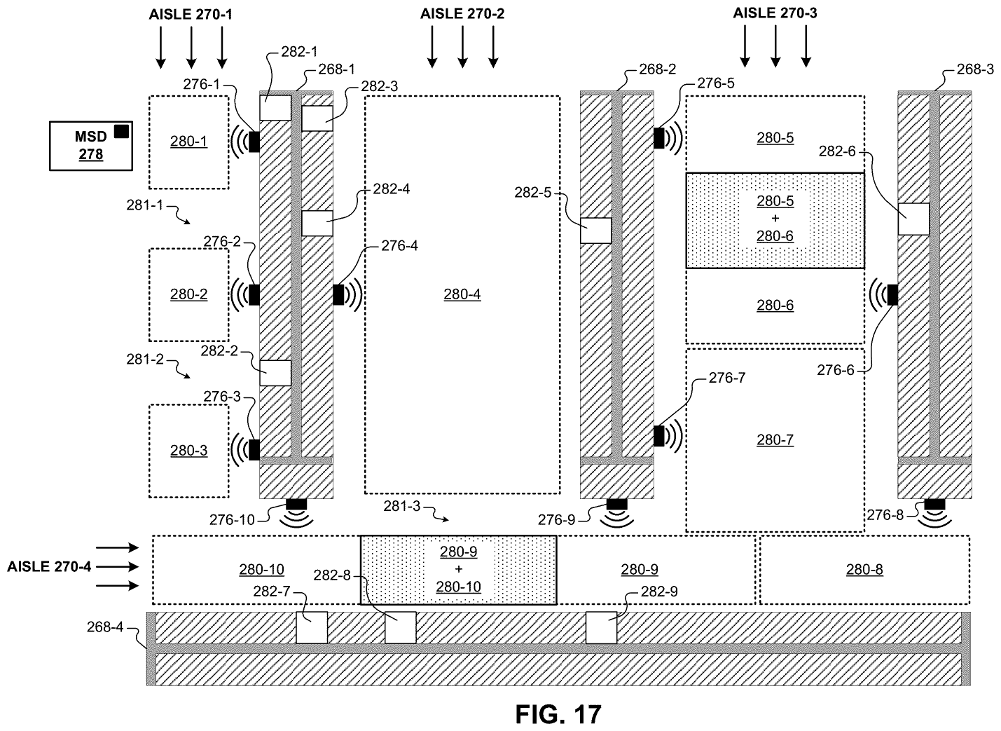

Store 100 includes racks 116-1, 116-2, 116-3, . . . , and 116-N (collectively “racks 116”). Racks 116 may represent any type of structure used to hold items. Racks 116 in FIG. 1 are illustrated from a top down perspective. The material (e.g., metal) that forms racks 116 is represented by gray shaded areas. Space on racks 116 for the storage of items is illustrated as hashed regions. In some figures (e.g., FIG. 1), specific items included in customer orders are illustrated and labeled (e.g., items 124-1 to 124-13 in FIG. 1). Illustrations of racks 116 herein are meant to represent a top down view of racks/shelving that are typically found in retail and grocery stores. Example 3D perspective views of racks 116 are shown in FIG. 3A and FIG. 3B. FIG. 3A shows a perspective view of racks 116 illustrated in FIG. 1 that include space on shelves 117 for storage of items. FIG. 3B shows a similar rack that includes shelves 117 and an end portion 118. The rack shown in FIG. 3B is illustrated in a top down perspective in FIG. 17, for example.

Racks (e.g., racks 116) described herein are not limited to the types of racks illustrated in FIG. 3A and FIG. 3B. Instead, racks 116 may represent any type of structure used to hold items, such as shelving, bins, baskets, pallets, and hooks. Racks 116 may also represent refrigerated storage units including, but not limited to, beverage refrigerators, display coolers/freezers, and walk-in refrigerators/freezers. In some examples, racks 116 may be mobile. For example, racks 116 may include pallets or carts having wheels.

Each of racks 116 illustrated in FIG. 1 include space for items (hashed regions) and a dividing portion (e.g., dividing portion 120 of rack 116-1) that divides the spaces for items. The hashed regions of racks 116 represent one or more shelves on which items may be placed. The number of shelves included on a rack may vary. In some examples, racks may include a single shelf. In other examples, racks may include a plurality of shelves which may be spaced evenly from one another or may be variably spaced. The dividing portions (e.g., portion 120) of racks may separate the shelves. Typically, when items on one side of a rack are accessible to a user, items on the other side of the rack are out of reach of the user due to the dividing portion.

Store 100 may include open floor space where a user (e.g., store employee and/or store customer) may move. In some examples, open floor space between racks may be referred to as aisles, such as aisles 122-1, 122-2, . . . , and 122-M (collectively “aisles 122”). Although FIG. 1 illustrates racks 116 as linear and illustrates aisles 122 as linear portions of open floor space defined by racks 116, it is contemplated that store 100 may include racks and aisles having a variety of different geometries. The techniques of the present disclosure are not limited to any specific type of rack and aisle layout, but instead, the techniques may be implemented in any variety of different rack and aisle layouts.

As described above, the hashed regions on racks 116 illustrate space on racks where items are stored. Some portions of the hashed regions on racks 116 include white boxes labeled with item numbers. For example, racks 116 include items 124-1 to 124-13. The boxes labeled as items 124-1 to 124-13 illustrate the location of items on shelves. For example, items 124-1, 124-2, 124-3, 124-4, 124-5 are included on rack 116-1 and rack 116-2. Items 124-1, 124-2, 124-3, 124-4, 124-5 are accessible by a user that is located in aisle 122-1. Similarly, items 124-6, 124-7, . . . , 124-11 are accessible by a user that is located in aisle 122-2.

Similar types of items may be grouped together along an aisle in a typical store. For example, the items located along aisle 122-1 (i.e., the items accessible in aisle 122-1 from rack 116-1 and rack 116-2) may be items of a similar type. In one example, the items along aisle 122-1 may be cereal items (e.g., bags or boxes of cereal). In another example, items along aisle 122-1 may be beverage items such as soft drinks and water. In another example, items along aisle 122-1 may be frozen items such as frozen entrees, pizzas, and ice cream. In examples where items along aisle 122-1 are frozen items, rack 116-1 and rack 116-2 may be refrigerated storage units (e.g., display coolers/freezers). Although the techniques of the present disclosure may be implemented in stores in which similar types of items are grouped together (e.g., in a typical grocery store), the techniques of the present disclosure do not require that similar types of items be grouped along the same aisle.

Store 100 includes location indicators 126-1, 126-2, 126-3, . . . , and 126-X (collectively “location indicators 126”). Location indicators 126 may include any device or object that indicates a location in store 100. In some examples, location indicators 126 may indicate a location within store 100 by transmitting location signals that indicate the location within store 100. For example, location indicator 126-1 may transmit location signal 128-1 that may indicate a location within aisle 122-1. Similarly, location indicator 126-2 may transmit location signal 128-2 that may indicate a location within aisle 122-2. Although location signals (e.g., 128-1, 128-2) are illustrated as transmitted in a cone radiation pattern having approximately a 90 degree angle, the illustration of location signals (e.g., 128-1, 128-2) in this manner is merely meant to indicate that location indicators of the present disclosure are transmitting/emitting signals. It is contemplated that the location signals may be transmitted in a variety of different radiation patterns and distances. Additionally, the location indicators described herein may be mounted to racks, or other structures (e.g., walls, floors, ceilings), at different angles in order to direct the transmission of location signals in different directions.

In other examples, location indicators may be objects (e.g., printed barcodes) including codes that indicate a location within a store. For example, location indicator 126-1 may be replaced by a location indicator including a code (e.g., a printed barcode) indicating a location within aisle 122-1. Similarly, location indicator 126-2 may be replaced by a location indicator including a code (e.g., a printed barcode) indicating a location within aisle 122-2. Such location indicators including codes (e.g., barcodes) may be scanned by MSDs (e.g., using barcode scanners included in the MSDs).

MSDs 114 may be configured to determine a location within store 100 in a variety of different ways, depending on the type of device or object used as a location indicator. In examples where location indicators 126 wirelessly transmit location signals that indicate a location within store 100, MSDs 114 may be configured to acquire the location signals and determine locations within store 100 based on the acquired location signals. In examples where location indicators are objects that include codes (e.g., barcodes), MSDs 114 may be configured to scan the codes on the location indicators and determine a location within store 100 based on the scanned codes.

Location indicators 126 may be configured to transmit location signals using any type of wireless transmission technology. In some examples, location indicators 126 may include an antenna (e.g., a metal antenna) that transmits location signals. In some examples, location indicators 126 may include a light emitting device (e.g., an LED or other photonic devices) that transmit location signals. In some examples, location indicators 126 may include an acoustic device that transmits location signals (e.g., sound waves).

The distance over which location indicators 126 transmit location signals 128, and the area covered by location signals 128, may vary depending on a variety of different factors including, but not limited to, the amount of power used to generate location signals 128, the location of location indicators 126 within store 100, and the technology included in location indicators 126 (e.g., an antenna, an LED, or acoustic device). In some examples, location indicators 126 may be configured to transmit location signals 128 over a relatively short distance and a small area within store 100. In other examples, location indicators 126 may be configured to transmit location signals 128 over longer distances and larger areas within store 100. For example, location indicators 126 may be configured to transmit location signals 128 from a few centimeters up to distances of tens of meters (e.g., 100 meters). In some examples, location indicators 126 may transmit location signals 128 along the length of an aisle or even across the length of store 100.

Location indicators 126 may transmit location signals 128 in a variety of different patterns which are described hereinafter with respect to location indicator 126-1. In some examples, location indicator 126-1 may transmit a location signal 128-1 along a line. For example, location indicator 126-1 may include a laser that transmits a laser beam along a straight line. In other examples, location indicator 126-1 may include an antenna that radiates location signal 128-1 in a directional manner. For example, location indicator 126-1 may include an antenna that radiates location signals having lobes and nulls. In other examples, location indicator 126-1 may transmit location signal 128-1 in nearly all directions. For example, location indicator 126-1 may include an antenna that generally radiates in all directions, or an LED that emits light in nearly all directions. It is contemplated that the directionality and power of the location signals may be adjusted to adjust the area of store 100 covered by the location signals. For example, the amount of power used to generate a location signal may be increased in order to transmit the location signal a greater distance.

The location of location indicators 126 within store 100 may affect the distance and area covered by location signals 128. As described herein, location indicators 126 may be placed in a variety of different locations in store 100. For example, location indicators 126 may be attached to the walls of store 100, mounted on shelves (e.g., near the floor or head height), placed on the floor, mounted overhead of the users, connected to the ceiling, or located at any other location within store 100.

Referring to FIG. 1, location indicator 126-1 transmits location signal 128-1 into aisle 122-1. Location indicator 126-1 is illustrated as connected to rack 116-1. Location indicator 126-1 may be connected to rack 116-1 in a variety of different locations. In some examples, location indicator 126-1 may be attached to, or placed on, any one of a plurality of shelves of rack 116-1. In some examples, location indicator 126-1 may be placed where rack 116-1 meets the floor. In other examples, location indicator 126-1 may be connected to rack 116-1 overhead of users. For example, rack 116-1 may include a piece that overhangs aisle 122-1. Although location indicators 126 are illustrated as connected to racks 116 in FIG. 1, location indicators 126 may be placed in other locations (e.g., on the floor, attached to the ceiling, etc.).

The area covered by location signals 128 may depend on the location of location indicators 126. With respect to FIG. 1, if location indicator 126-2 is attached to a shelf of rack 116-2, location signal 128-2 may be transmitted throughout aisle 122-2. In other words, if location indicator 126-2 is attached to a shelf of rack 116-2, location signal 128-2 may cover some or all of aisle 122-2. Depending on the directionality and power of location signal 128-2, location signal 128-2 may cover only a portion of aisle 122-2, or may cover all of aisle 122-2 and even spill outside of aisle 122-2 to floor space adjacent to aisle 122-2. If location indicator 126-2 is attached to a shelf of rack 116-2, location signal 128-2 may not penetrate racks 116-2, 116-3 and/or the items on racks 116-2, 116-3 in some examples. In these examples, location signal 128-2 may not cover floor space in aisles 122-1 and 122-3, and, therefore, location signal 128-2 may not be detectable in these areas in some examples. In other examples, location signal 128-2 may be detectable in aisles 122-1, 122-3. For example, location signal 128-2 may penetrate racks 116-2, 116-3 and items on racks 116-2, 116-3 such that location signal 128-2 covers some area in aisles 122-1, 122-3. As an additional example, location signal 128-2 may be detectable by MSDs 114 in aisles 122-1, 122-3 if gaps exist in racks 116-2, 116-3 and between items on racks 116-2, 116-3. Furthermore, in some examples, location signal 128-2 may be detectable by MSDs 114 in aisles 122-1, 122-3 if location signal 128-2 exits aisle 122-2 and reflects back into aisles 122-1, 122-3.

The location indicators may be arranged throughout the store. In general, a location indicator may be any object or device that indicates a location within the store. In some examples, the location indicators may generate location signals. For example, the location indicators may wirelessly transmit the location signals. The MSDs may receive the transmitted location signals and determine a location within the store based on the detected location signal(s). The location indicators may transmit location signals and the MSDs may be configured to detect the transmitted location signals in a variety of different ways. Although the location indicators may transmit location signals in some examples, in other examples, the location indicators may be objects that may be read by the MSDs. For example, the location indicators may be barcodes attached to racks in the store. Furthermore, although the MSDs may determine a location within the store based on location signals generated by location indicators within the store, in other examples, the MSDs may determine a location within the store in response to signals generated outside of the store, such as in response to global positioning system (GPS) signals received from GPS satellites. In still other examples, the MSDs may determine a location within the store using other techniques and technologies. For example, the MSDs may determine a location using a Wi-Fi signal transmitted within the store.

The MSDs may be configured to detect the location signals transmitted from the location indicators and perform various operations in response to detecting the location signals. A location signal received by an MSD may be thought of as indicating a particular location within the store. For example, assuming that a first aisle of the store includes a first location indicator that transmits a first location signal and a second aisle includes a second location indicator that transmits a second location signal, an MSD may determine that the MSD is located in the first or second aisle when the MSD detects the first or second location signal, respectively. The location signals may also be thought of as indicating which items included in the store are in proximity to an MSD at a given time. For example, since each of the items in the store may be associated with one or more location signals (i.e., a location value), an MSD may, upon detection of a location signal, determine which one or more of the items are in the vicinity of the MSD. As described herein, based on this determination, the MSD may further arrange items included in a customer order on a display of the MSD.

Using location indicators and/or location signals, an MSD may determine a location within, or outside of, the store. In some examples, an MSD may determine a location value based on detected location signals. As described herein, a location value may generally refer to any value or plurality of values (e.g., alphanumeric values) determined by an MSD that indicate a location of the MSD within, or outside of, the store. A location value determined by an MSD based on a location indicator and/or a location signal may depend on the types of location indicators and/or location signals used in the store.

An MSD may acquire location signals from location indicators as the MSD is transported throughout the store by a user. The location indicators may be set up throughout the store in various configurations. In some examples, the location indicators are set up such that the MSD picks up a location signal at any location within the store. In these examples, the location indicators are set up such that the location signals generated by the location indicators overlap to varying degrees and an MSD may acquire multiple location signals simultaneously in some locations. Additionally, or alternatively, the location indicators may be arranged such that the location signals do not quite overlap, but instead abut one another or are separated by a short distance. In these examples, an MSD may detect a first location signal in a first location and then abruptly detect a second location signal upon moving out of range of the first location signal. In other examples, the location indicators are set up such that an MSD does not pick up location signals at some locations within the store. In these examples, there may be dead zones in which an MSD may not acquire location signals because location signals may be absent, or not be sufficiently strong. Various configurations of location indicators within a store are illustrated and described herein.

In some implementations, the techniques of this disclosure may make use of location indicators and/or location signals in conjunction with the item indicators, item signals, and/or an item adjacency map. As described herein, an MSD may perform a variety of different operations based on a location and a corresponding location value determined by the MSD, irrespective of whether the location and location value are determined using location indicators/signals alone or in conjunction with item indicators/signals.

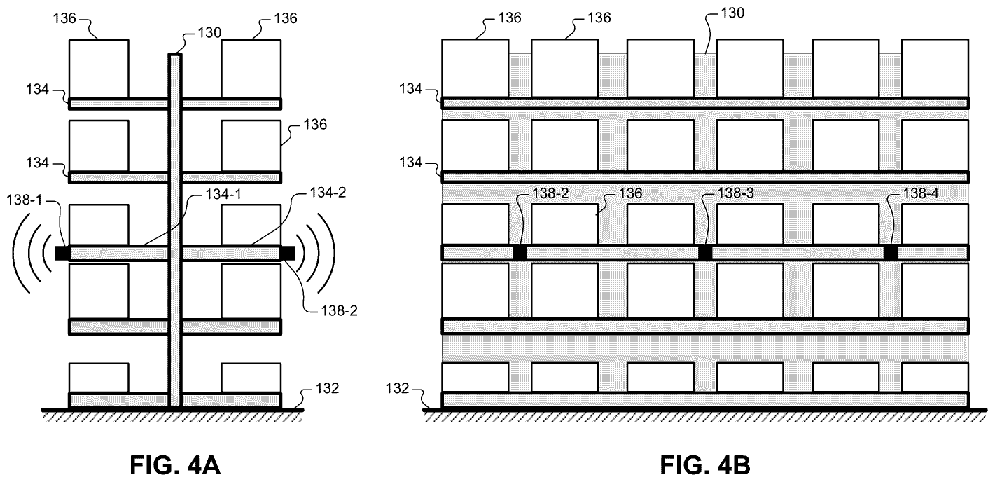

FIGS. 4A-9 show example racks including location indicators in different locations. FIGS. 4A-4B show an example rack 130 on floor 132. Rack 130 includes shelves 134. Items 136 (illustrated as white boxes) are arranged on shelves 134. In some implementations, rack 130 may be approximately 6 feet high. Shelves 134 may be approximately 1-2 feet apart. FIG. 4A shows a view of rack 130 from the end of rack 130 such that rack 130 would extend into and out of the page. FIG. 4B shows a view of rack 130 as would be viewed from an aisle.

In FIGS. 4A-4B, location indicators 138-1, 138-2, 138-3, 138-4 are attached to shelves 134-1, 134-2. Shelves 134-1, 134-2 may be approximately waist height (e.g., approximately 3 feet from floor 132). Accordingly, location indicators 138-1, 138-2 are located at approximately waist height and may transmit location signals from approximately waist height.

Location indicators of the present disclosure may be arranged along racks at a variety of different distances. With respect to FIG. 4B, location indicators 138-2, 138-3, 138-4 are evenly separated along rack 130. Although location indicators 138-2, 138-3, 138-4 are evenly separated in FIG. 4B, in other examples, location indicators 138-2, 138-3, 138-4 may be separated by varying distances. Although 3 location indicators 138-2, 138-3, 138-4 are illustrated in FIG. 4B, in some examples, more or less than 3 location indicators may be arranged along rack 130.

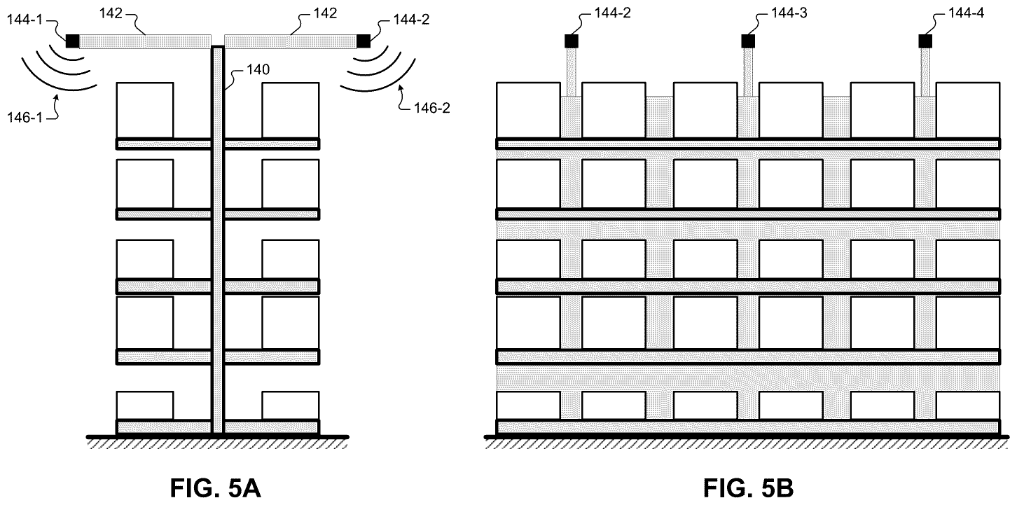

FIGS. 5A-5B show another example arrangement of location indicators along a rack. In FIGS. 5A-5B, rack 140 includes supporting members 142 configured to hold location indicators 144-1, 144-2, 144-3, 144-4 above rack 140 (e.g., over customer heads). In some examples, supporting members 142 may include metal rods that may be connected (e.g., clamped) to rack 140. Supporting members 142 may also be used to hold other objects, such as signs indicating what items are included in the aisle. Location indicators 144-1, 144-2, 144-3, 144-4 are connected to supporting members 142 and configured to generate location signals (e.g., 146-1, 146-2) that cover areas of the store adjacent to rack 140. For example, location indicators 144-1, 144-2, 144-3, 144-4 may be configured to point downward toward areas adjacent to rack 140 such that an MSD located in the aisle adjacent to rack 140 may detect one of location signals 146-1, 146-2.

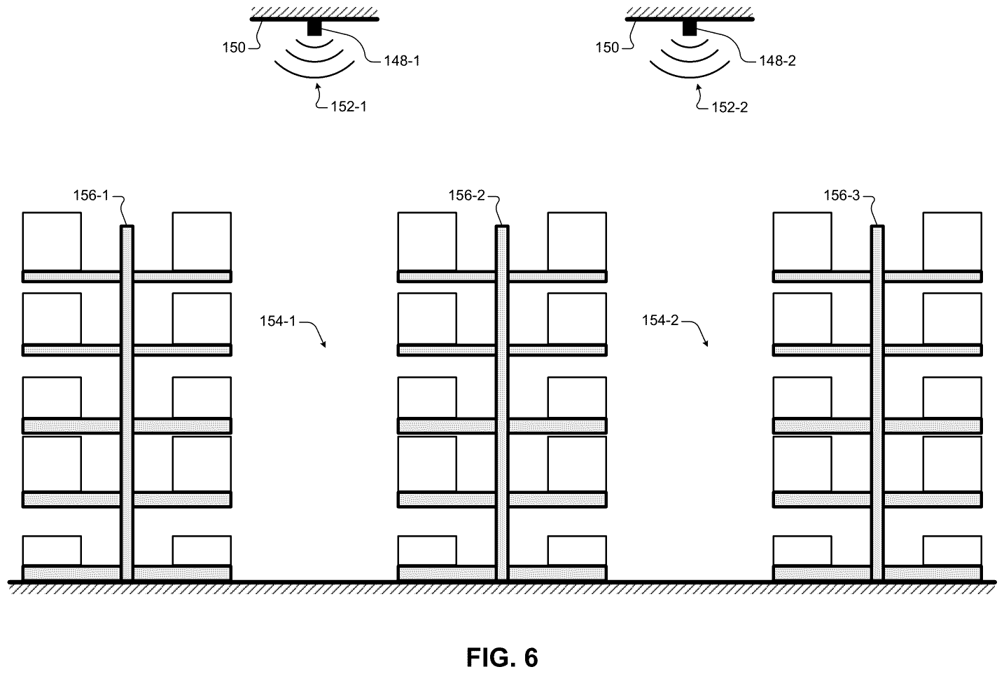

FIG. 6 shows another example arrangement of location indicators in which location indicators are located above racks. For example, location indicators 148-1, 148-2 may be attached to ceiling 150 (e.g., rafters or lighting) of the store. In this example, location indicators 148-1, 148-2 may transmit location signals 152-1, 152-2 into aisles 154-1, 154-2 between racks 156-1, 156-2, 156-3. In some implementations, lighting in the store may implement similar functionality as the location indicators (e.g., lighting may transmit location signals in a manner that is not perceptible by a user).

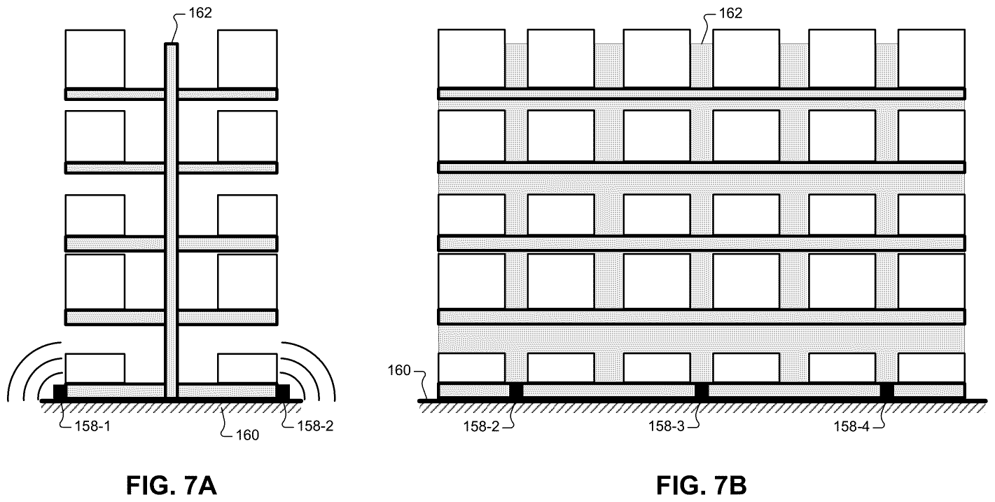

FIGS. 7A-7B show another example arrangement of location indicators. In FIGS. 7A-7B, location indicators 158-1, 158-2, 158-3, 158-4 are located near floor 160. For example, location indicators 158-1, 158-2, 158-3, 158-4 may be attached to the bottom shelves of rack 162 or connected to floor 160 near the bottom of rack 162. In some examples, location indicators 158-1, 158-2, 158-3, 158-4 may be embedded in floor 160. Although location indicators 158-2, 158-3, 158-4 are evenly separated in FIG. 7B, in other examples, location indicators 158-2, 158-3, 158-4 may be separated by varying distances. Although 3 location indicators 158-2, 158-3, 158-4 are illustrated in FIG. 7B, in some examples, more or less than 3 location indicators may be arranged along rack 162.

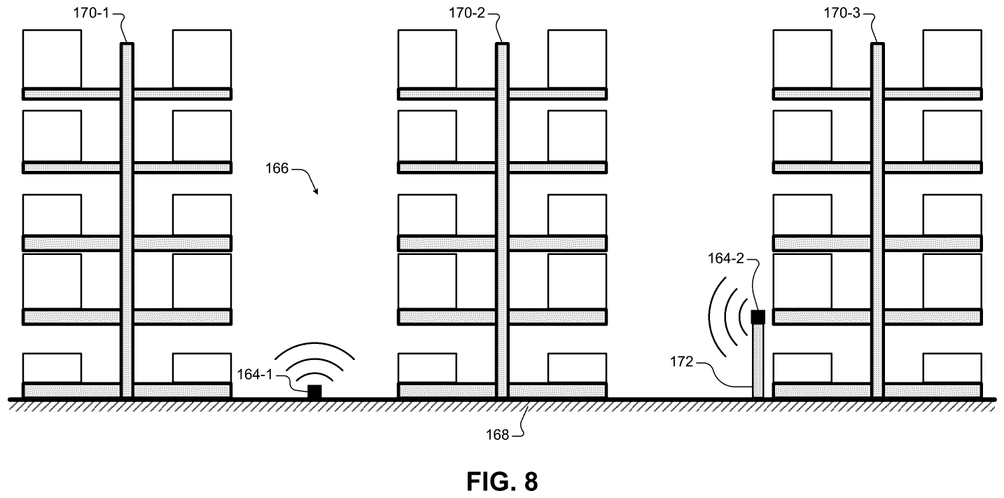

FIG. 8 shows other example arrangements of location indicators. In FIG. 8, location indicator 164-1 is located in aisle 166 on floor 168. Although location indicator 164-1 is illustrated as centrally located in aisle 166, location indicator 164-1 may instead be located nearer to one of racks 170-1, 170-2. Location indicator 164-1 may be attached to the surface of floor 168 in some examples. In other examples, location indicator 164-1 may be embedded in floor 168. For example, location indicator 164-1 may be embedded flush with floor 168 or embedded under floor 168 such that location indicator 164-1 is not visible.

In FIG. 8, location indicator 164-2 is connected to a supporting member 172 (e.g., in the aisle between racks 170-2 and 170-3 or at the end of rack 170-3). Supporting member 172 may rest on floor 168 or be connected to floor 168. Supporting member 172 may be a pole, tripod, or other device configured to hold location indicator 164-2. Accordingly, supporting member 172 may be configured to hold location indicator 164-2 at one end and connect to floor 168, or rest on floor 168, at the other end. Using supporting member 172 to hold location indicator 164-2 may allow placement of location indicator 164-2 in any location within the store, regardless of the location of racks, walls, or other structures in the store that may also be used for mounting location indicator 164-2.

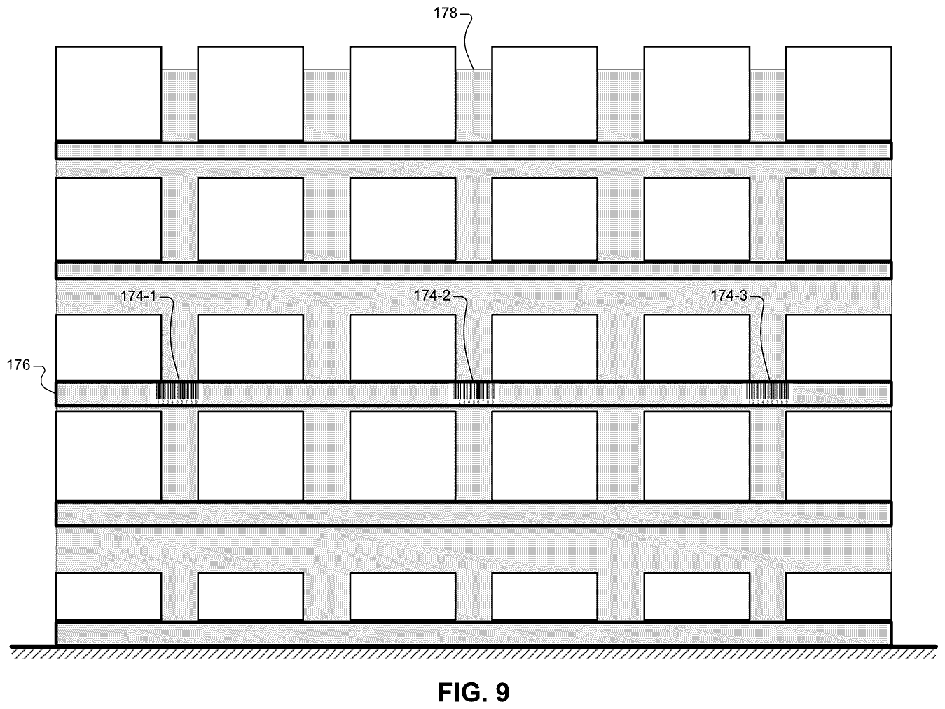

FIG. 9 shows an example arrangement of location indicators that include readable codes (e.g., printed barcodes). In FIG. 9, location indicators 174-1, 174-2, 174-3 are barcodes that are attached to shelf 176 of rack 178. Since location indicators 174-1, 174-2, 174-3 are barcodes, location indicators 174-1, 174-2, 174-3 may not transmit location signals. Instead, as described hereinafter, a user may use an MSD to scan location indicators 174-1, 174-2, 174-3 using a barcode scanner to determine a current location. Location indicators 174-1, 174-2, 174-3 may include different barcode values that indicate different locations to MSDs. In some examples, a store may include only location indicators that have readable codes (e.g., barcodes). In other words, in these examples, the store may not include location indicators that transmit location signals. In other examples, a store may not include location indicators with readable codes. Instead, in these examples, the store may include only location indicators that transmit location signals. In still other examples, a store may include both location indicators that have readable codes and location indicators that transmit location signals.

Although location indicators 174-1, 174-2, 174-3 are illustrated as attached to a shelf in FIG. 9, other arrangements of readable location indicators are contemplated. For example, readable location indicators may be attached to lower shelves or higher shelves, the wall of a store, the ceiling of the store, and/or attached to the floor. In general, readable location indicators may be attached in any location in a store that may be read by an MSD. It is contemplated that a store may include location indicators in any of the locations described with respect to FIGS. 4A-9. Additionally, a store may include location indicators in other locations which may not be explicitly illustrated in FIGS. 4A-9.

The number of location indicators and the arrangement of location indicators in a store may vary. In some examples, a larger store may include more location indicators to cover the larger area of the store. The density of location indicators (e.g., the number of location indicators per area of the store) may also vary. In some examples, a greater number of location indicators per area of store may create more locations per area of store, which may result in smaller zones (i.e., a higher location resolution).

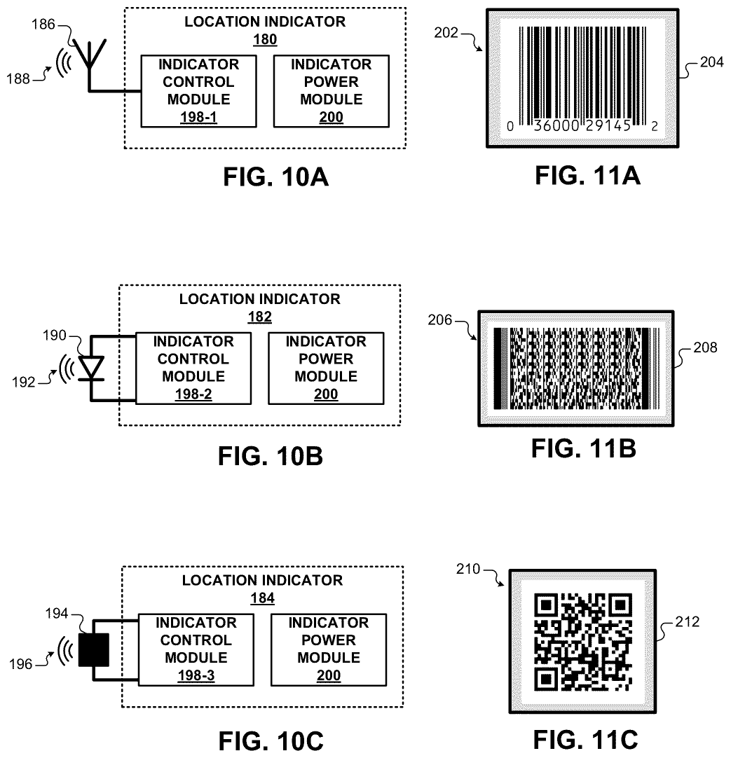

Example location indicators are described hereinafter with reference to FIGS. 10A-10C. Location indicators may include one or more different technologies for wirelessly transmitting location signals. For example, location indicators 180, 182, 184 of FIGS. 10A-10C may transmit location signals via an antenna, an LED, or an acoustic device. Additionally, location indicators of the present disclosure may encode location signals in a variety of different formats. In general, location indicators may be configured so that each location indicator transmits a different location signal. For example, when location indicators encode location signals using different frequency content, each location indicator may transmit a location signal having different frequency content. MSDs may be configured to acquire the different location signals and discriminate between the different location signals.

Location indicators may include a variety of different technologies. FIGS. 10A-10C illustrate some example technologies that may be used in location indicators that transmit location signals. FIG. 10A shows an example location indicator 180 that includes an antenna 186 for transmitting location signal 188. In some implementations, the location indicator 180 may include BLUETOOTH communication functionality (e.g., BLUETOOTH low energy (BLE)). In these implementations, the location indicator 180 may transmit location signals (e.g., as a BLUETOOTH beacon) using the BLUETOOTH communication functionality. MSDs (e.g., a mobile phone, tablet, or a dedicated computing device configured for use in the store) may communicate (e.g., receive transmissions) with the location indicators including BLUETOOTH functionality to determine location values. FIG. 10B shows an example location indicator 182 that includes an LED 190 for emitting location signal 192. In some implementations, the location indicator 182 (e.g., an LED) that emits light may be included in overhead lighting fixtures (e.g., FIG. 6) that provide lighting to the store. In these implementations, the location indicator 182 may transmit location signals and may also provide the store with lighting. The location signals may be undetectable by the human eye, but may be detected by the MSDs (e.g., a mobile phone, tablet, or a dedicated computing device configured for use in the store). FIG. 10C shows an example location indicator 184 that includes an acoustic device 194 for emitting location signal 196. Although FIGS. 10A-10C illustrate location indicators 180, 182, 184 using an antenna 186, LED 190, and acoustic device 194, it is contemplated that other types of devices may be used to transmit location signals within a store.

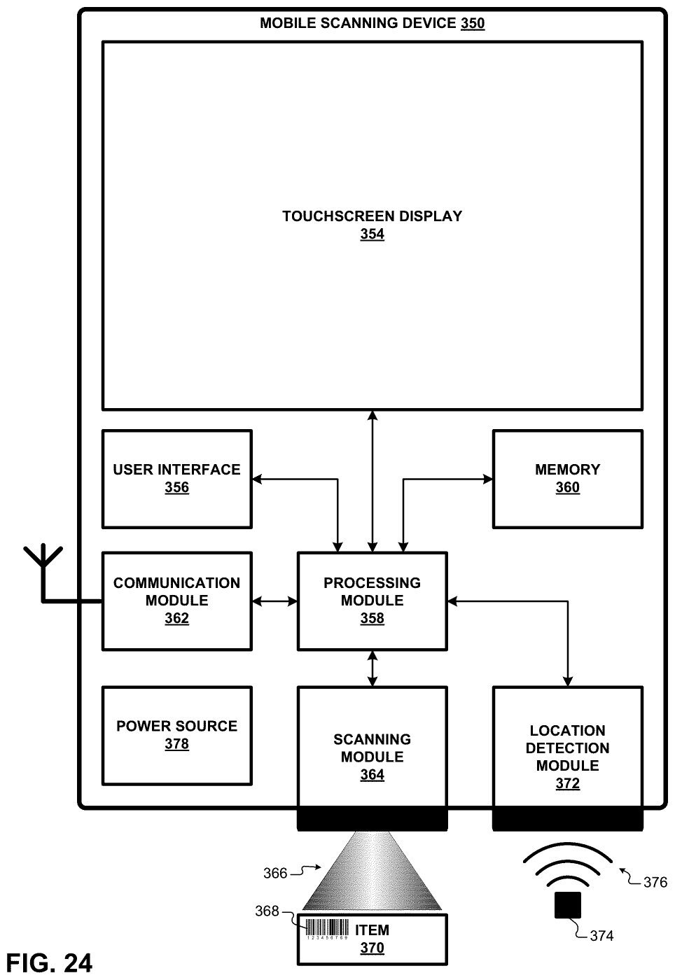

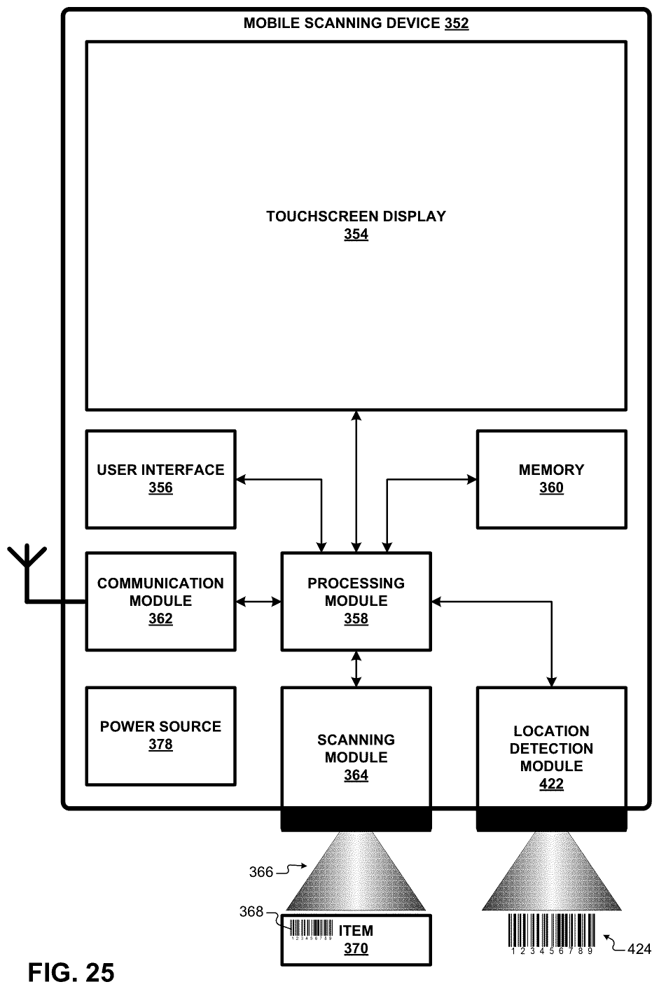

As described herein, MSDs may include location detection modules (e.g., location detection modules 372, 422 of FIGS. 24-25) that are configured to acquire location signals transmitted by location indicators. For example, when location indicators transmit location signals via an antenna, location detection modules of MSDs may include antennas configured to receive the transmitted location signals. As an additional example, when location indicators transmit location signals from an LED, location detection modules of MSDs may include devices configured to detect the transmitted light (e.g., an LED, or other light detection circuit). In still other examples, when location indicators transmit location signals from an acoustic device (e.g., sound waves), location detection modules of MSDs may include devices configured to detect the sound waves (e.g., a sound detection device). Although location indicators may include antennas, light emitting devices, and acoustic devices for transmitting location signals, other types of technologies may be included in location indicators for transmitting location signals. Accordingly, MSDs may include other types of location detection modules that are configured to detect location signals transmitted by other types of technologies used in location indicators.

In some examples, a single type of location indicator technology may be implemented in a store. For example, all location indicators may include light emitting devices (e.g., LEDs) and all MSDs may include light detection devices for detecting location signals. As an additional example, all location indicators may include an antenna for transmitting location signals and all MSDs may include antennas for receiving the transmitted location signals. In other examples, different location indicators may include different technologies within the store. For example, some of the location indicators may include light emitting devices, while other ones of the location indicators may include antennas. In still other examples, some of the location indicators may include multiple different technologies. For example, a location indicator may include both an antenna and a light emitting device.

Location indicators 180, 182, 184 include indicator control modules 198-1, 198-2, 198-3 that are configured to control operation of location indicators 180, 182, 184. In general, indicator control modules 198-1, 198-2, 198-3 may represent electronic hardware and software/firmware included in location indicators 180, 182, 184 that controls the transmission of location signals 188, 192, 196. Location indicators 180, 182, 184 may also include an indicator power module 200 configured to provide power to location indicators 180, 182, 184. Indicator power module 200 may include a variety of different electronic components that provide power to location indicators 180, 182, 184.

In some examples, location indicators 180, 182, 184 may be powered by mains power systems. In these examples, indicator power module 200 may include a connector to receive mains power (e.g., a three pronged plug or other connector) and power supply electronics for receiving mains power and delivering power to the electronics of location indicators 180, 182, 184 (e.g., indicator control modules 198-1, 198-2, 198-3). In other examples, location indicators 180, 182, 184 may be powered by batteries. In these examples, indicator power module 200 may include sockets for holding batteries and/or connectors for receiving battery power via wires. Additionally, in these examples, indicator power module 200 may include electronics for receiving power from batteries and delivering power to electronics of location indicators 180, 182, 184 (e.g., indicator control modules 198-1, 198-2, 198-3). In other examples, indicator power module 200 may include other power sources such as solar panels or a capacitor used for energy storage. In other examples, location indicators may receive power from MSDs. For example, a location indicator (e.g., an RFID tag) may include an antenna that receives energy transmitted by an MSD.

FIG. 10A shows an example location indicator 180 that includes an antenna 186. Indicator control module 198-1 may transmit location signal 188 via antenna 186. It is contemplated that antenna 186 may be implemented using a variety of different antenna structures. In some examples, antenna 186 may include a metal wire (e.g., monopole antenna, dipole antenna, a helical antenna, etc.) mounted to a printed circuit board (PCB) of location indicator 180. In other examples, antenna 186 may be included on traces of the PCB of location indicator 180. Although a single antenna is illustrated in FIG. 10A, it is contemplated that location indicators described herein may include more than one antenna in some examples.

As described above, location indicator 180 includes an indicator control module 198-1 (e.g., electronic hardware, firmware, and/or software) configured to transmit location signal 188 via antenna 186. Indicator control module 198-1 may also include memory that includes instructions that, when executed by indicator control module 198-1, cause indicator control module 198-1 to perform various functions attributed to indicator control module 198-1 described herein. Memory of indicator control module 198-1 may store programs and other operating parameters that define properties (e.g., codes, frequency parameters, etc.) of location signal 188.

The components of location indicator 180 may be enclosed in a housing. For example, the housing may enclose a PCB, antenna 186, indicator control module 198-1, and indicator power module 200, along with other components. The housing may have a variety of different form factors, depending on where location indicator 180 is to be located within a store. For example, the housing may be configured for resting or mounting on a shelf or wall, mounting on the floor, mounting on the ceiling, or embedding in the floor.

Location indicator 180 may encode location signal 188 in a variety of different formats. For example, location signal 188 may include one or more frequency components over a range of frequencies from approximately DC frequencies up to GHz frequencies. In some examples, indicator control module 198-1 may be configured to transmit one or more waveforms via antenna 186, such as on/off signals, sine waves, triangle waves, square waves, etc. In some examples, indicator control module 198-1 may be configured to generate carrier signals and modulate the carrier signal using analog modulation techniques (e.g., amplitude modulation) and/or digital modulation techniques (e.g., amplitude-shift keying). In some examples, indicator control module 198-1 may encode digital data (e.g., multiple bits) using modulation techniques.

MSDs may be configured to receive location signal 188 (e.g., via an antenna) and differentiate location signal 188 from location signals transmitted by other location indicators. For example, MSDs may be configured to detect parameters (e.g., frequency content) of location signal 188 and/or the digital data encoded by location signal 188. As described hereinafter, MSDs may detect location signal 188 and determine a location value based on location signal 188. In some examples, the location values may be unique. In other examples, some location values determined throughout the store may be the same.

Location indicator 180 of FIG. 10A may represent an RFID tag in some examples, such as an active RFID tag, a passive RFID tag, or other type of RFID tag. If location indicator 180 is an RFID tag, antenna 186 may represent one or more antennas of the RFID tag that transmit signals to an MSD and/or wirelessly receives energy from an MSD. Indicator power module 200 may include circuits that receive energy via an antenna in some examples. In other examples, indicator power module 200 may represent a battery included in the RFID tag. Indicator control module 198-1 may represent circuits that transmit RFID data via antenna 186. For example, indicator control module 198-1 may include an identification number that is transmitted via antenna 186 when the RFID tag is interrogated by an MSD. In some examples, an RFID tag may include a power source and be configured to transmit location signal 188. In other examples, an RFID tag may be “awoken” by an MSD and may transmit a location signal in response to being awoken by the MSD. In examples where RFID tags harvest power from MSDs, the location indicators may not require mains or battery power.

FIG. 10B shows an example location indicator 182 that includes a light emitting device 190 (e.g., one or more LEDs or other photonic devices). Location indicator 182 includes an indicator control module 198-2 (e.g., electronic hardware, software, and/or firmware) configured to transmit location signal 192 via light emitting device 190. Indicator control module 198-2 may also include memory that includes instructions that cause indicator control module 198-2 to perform various functions attributed to indicator control module 198-2 described herein. Memory of indicator control module 198-2 may store programs and other operating parameters that define properties (e.g., codes, frequency parameters, etc.) of location signal 192.

The components of location indicator 182 may be enclosed in a housing. For example, the housing may enclose a PCB, light emitting device 190, indicator control module 198-2, and indicator power module 200, along with other components. The housing may have a variety of different form factors, depending on where location indicator 182 is to be located within a store. For example, the housing may be configured for resting or mounting on a shelf or wall, mounting on the floor, mounting on the ceiling, or embedding in the floor.

Location indicator 182 may encode location signal 182 in a variety of different formats. For example, location signal 192 may include one or more frequency components over a range of frequencies from approximately DC frequencies up to GHz frequencies. In some examples, indicator control module 198-2 may be configured to transmit one or more waveforms via light emitting device 190, such as sine waves, triangle waves, square waves, etc. In some examples, indicator control module 198-2 may be configured to generate carrier signals and modulate the carrier signal using analog modulation techniques (e.g., amplitude modulation) and/or digital modulation techniques (e.g., amplitude-shift keying). In some examples, indicator control module 198-2 may encode digital data (e.g., multiple bits) using modulation techniques.

MSDs may be configured to receive location signal 192 (e.g., via a light detection device such as a photodiode, phototransistor, or other device) and differentiate location signal 192 from location signals transmitted by other location indicators. For example, MSDs may be configured to detect parameters (e.g., frequency content) of location signal 192 and/or the digital data encoded by location signal 192. As described hereinafter, MSDs may detect location signal 192 and determine a location value based on location signal 192.

FIG. 10C shows an example location indicator 184 that includes an acoustic device 194 that transmits location signal 196 by transmitting sound waves. Location indicator 184 includes an indicator control module 198-3 (e.g., electronic hardware, software, and/or firmware) configured to transmit location signal 196 via acoustic device 194. Indicator control module 198-3 may also include memory that includes instructions that cause indicator control module 198-3 to perform various functions attributed to indicator control module 198-3 described herein. Memory of indicator control module 198-3 may store programs and other operating parameters that define properties (e.g., codes, frequency parameters, etc.) of location signal 196.

The components of location indicator 184 may be enclosed in a housing. For example, the housing may enclose a PCB, acoustic device 194, indicator control module 198-3, and indicator power module 200, along with other components. The housing may have a variety of different form factors, depending on where location indicator 184 is to be located within a store. For example, the housing may be configured for resting or mounting on a shelf or wall, mounting on the floor, mounting on the ceiling, or embedding in the floor.

Location indicator 184 may encode location signal 196 in a variety of different formats. For example, location signal 196 may include one or more frequency components over a range of frequencies (e.g., audible to inaudible frequencies). In some examples, indicator control module 198-3 may be configured to transmit one or more waveforms via acoustic device 194, such as sine waves, triangle waves, square waves, etc. In some examples, indicator control module 198-3 may be configured to generate carrier signals and modulate the carrier signal using analog modulation techniques (e.g., amplitude modulation) and/or digital modulation techniques (e.g., amplitude-shift keying). In some examples, indicator control module 198-3 may encode digital data (e.g., multiple bits) using modulation techniques.

MSDs may be configured to receive location signal 196 (e.g., via an acoustic detection device) and differentiate location signal 196 from location signals transmitted by other location indicators. For example, MSDs may be configured to detect parameters (e.g., frequency content) of location signal 196 and/or the digital data encoded by location signal 196. As described hereinafter, MSDs may detect location signal 196 and determine a location value based on location signal 196.

In some examples, location indicators may include readable codes. For example, the readable codes may be printed onto objects (e.g., labels) and attached to shelves, walls, the floor, etc. FIGS. 11A-11C show different example readable codes which may be used as location indicators. FIG. 11A shows a location indicator 202 that includes a bar code (e.g., a UPC-A barcode) attached to a label 204. Label 204 may be a paper label including an adhesive for attaching label 204 to shelves, walls, etc. In other examples, label 204 may be a metal tab that may be attached to shelves, walls, etc. FIG. 11B shows a location indicator 206 that includes a different type of readable code (e.g., a PDF417) attached to a label 208. FIG. 11C shows a location indicator 210 that includes a different type of readable code (e.g., a QR code) attached to a label 212.

Readable codes on location indicators (e.g., 202, 206, 210) may encode a variety of different data. For example, the readable codes may represent alphanumeric codes. Different location indicators in a store may have different codes. In examples where location indicators include readable codes, each location indicator within a store may have a different readable code. MSDs may scan the readable codes on the location indicators to determine a location within the store. Since each location indicator may have a different readable code, the MSDs may uniquely identify a location within the store based on the readable code that is scanned from the location indicator.

MSDs (e.g., MSDs 114 of FIG. 1) may be configured to determine a location value based on one or more received location signals (e.g., location signals 128 of FIG. 1) and/or scanned readable codes (e.g., readable codes 174-1, 174-2, 174-3). In general, a location value may refer to any value or plurality of values (e.g., alphanumeric values) determined by an MSD that indicate a location of the MSD within, or outside of, a store. The location values determined by MSDs may depend on the types of location indicators used in a store. In examples where location indicators transmit location signals, MSDs may determine a location value based on one or more received location signals. In examples where location indicators include readable codes (e.g., barcodes), MSDs may scan the readable codes and determine a location value based on the scanned readable codes.

As describe above, a location value may refer to any value or plurality of values that indicate a location of the MSD within, or outside of, a store. In some examples, an MSD may determine a location value based on a location signal that was transmitted by a location indicator in proximity to the MSD. In other examples, an MSD may determine a location value by scanning a location indicator (e.g., a readable code) in proximity to the MSD. Accordingly, an MSD may determine a location value in an area of the store in proximity to the location indicator that indicates that location value. In a sense, an area in a store adjacent to a location indicator may be associated with that location indicator and the location value associated with that location indicator. An area of a store (e.g., the floor space) associated with a location value may also be referred to herein as a “zone” of the store.

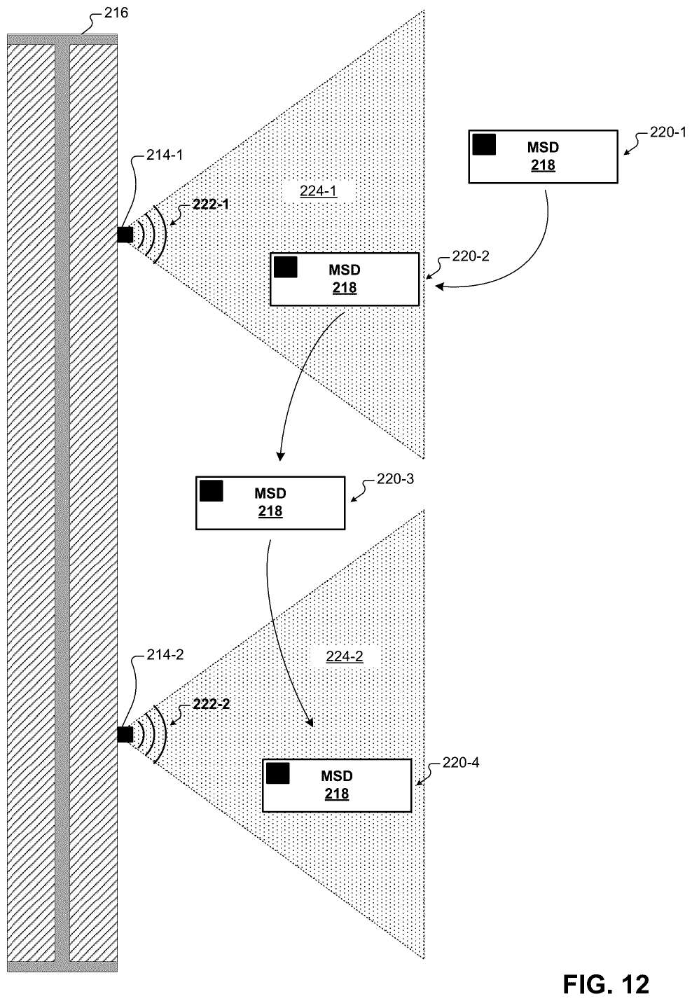

FIGS. 12-18 illustrate example arrangements of location indicators and associated location values that are associated with different areas of a store. Referring now to FIG. 12, location indicators 214-1, 214-2 are connected to rack 216. MSD 218 is moved along rack 216. The movement of MSD 218 is indicated by callouts 220-1, 220-2, 220-3, 220-4. As described hereinafter, MSD 218 includes a location detection module that is configured to acquire location signals 222-1, 222-2. The location detection module of MSD 218 is represented as a black box on MSD 218 in FIG. 12.

Initially, MSD 218 is located at position 220-1. At position 220-1, MSD 218 is outside of the range of location signal 222-1. Accordingly, MSD 218 may not be detecting a location signal at position 220-1. As described herein, an area in which an MSD does not acquire a location signal may be referred to as a “dead zone.” The areas covered by location signals 222-1, 222-2 are illustrated in FIG. 12 as shaded areas (e.g., shaded triangular areas). MSDs may acquire location signals within the areas covered by the location signals. In another example, the areas covered by location signals are illustrated as dotted rectangles (e.g., in FIG. 17).

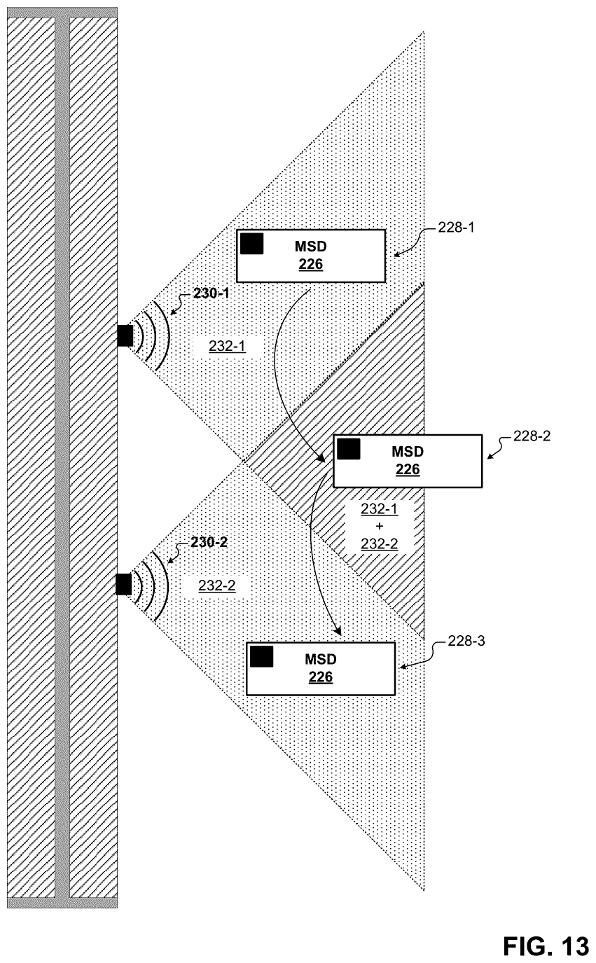

MSD 218 is moved from position 220-1 to position 220-2. MSD 218 begins acquiring location signal 222-1 as MSD 218 is moved to position 220-2. MSD 218 may determine a location value of 224-1 based on received location signal 222-1. A convention used herein is to assign the same reference numbers for location values and the areas in which MSDs determine the location values. For example, in FIG. 12, MSD 218 receives location signal 222-1 and determines a location value 224-1 in area 224-1 (i.e., zone 224-1). Similarly, MSD 218 receives location signal 222-2 and determines location value 224-2 in area 224-2 (i.e., zone 224-2) in FIG. 12. As an additional example, MSD 226 receives location signals 230-1, 230-2 and determines location value “232-1+232-2” in area “232-1+232-2” in FIG. 13.

Referring back to FIG. 12, MSD 218 is moved from position 220-2 to position 220-3. MSD 218 does not detect a location signal at position 220-3 (i.e., position 220-3 is a “dead zone”). Accordingly, when moving from position 220-2 to position 220-3, MSD 218 moves from a position in which a location signal is detected to a position in which location signals are not detected. MSD 218 is then moved from position 220-3 to position 220-4. MSD 218 acquires location signal 222-2 in position 220-4. MSD 218 may determine a location value of 224-2 in area 224-2 based on received location signal 222-2.

FIG. 13 shows an example in which an MSD is moved through a portion of a store in which location signals overlap in some regions. Initially, MSD 226 is located at position 228-1. MSD 226 detects location signal 230-1 at position 228-1. MSD 226 may determine a location value of 232-1 in area 232-1 based on detected location signal 230-1. MSD 226 is then moved from position 228-1 to position 228-2. When moving from position 228-1 to position 228-2, MSD 226 moves from a position in which a single location signal is detected to a position in which multiple location signals are detected.

Location signal 230-1 overlaps with location signal 230-2 at position 228-2 (as indicated by the triangular hashed region). Put another way, location signals 230-1, 230-2 cover the same area such that MSD 226 may detect multiple location signals at position 228-2. In areas where MSDs detect multiple location signals, the location values and the areas are illustrated in the figures and described in the text as a sum of values within quotes. For example, at position 228-2, MSD 226 may detect location signals 230-1, 230-2 and determine a location value of “232-1+232-2” in area “232-1+232-2” based on detected location signals 230-1, 230-2. MSD 226 is then moved from position 228-2 to position 228-3. MSD 226 acquires location signal 230-2 in position 228-3. MSD 226 may determine a location value of 232-2 in area 232-2 based on received location signal 230-2.

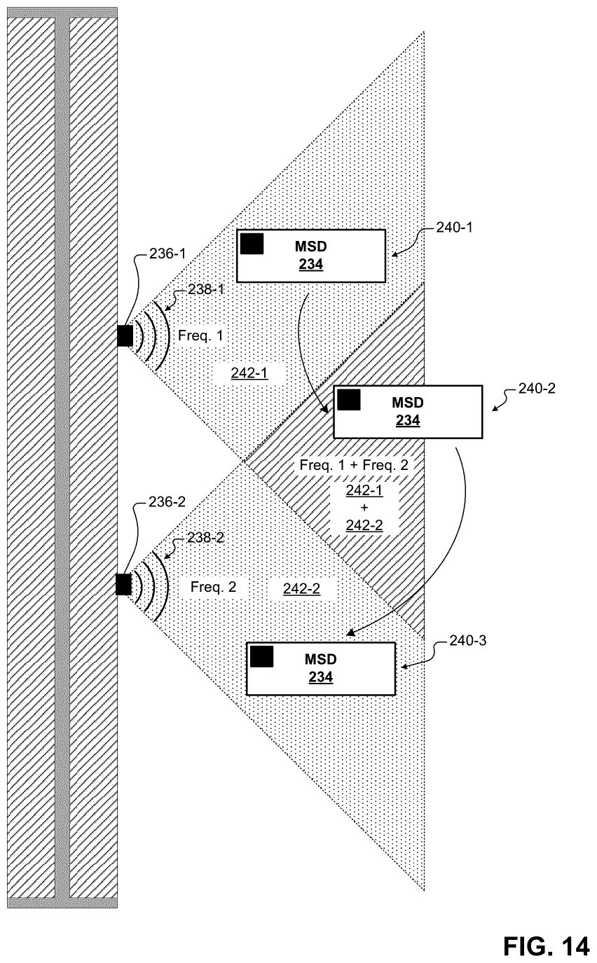

FIG. 14 shows an example in which an MSD 234 is moved through a portion of a store in which location indicators 236-1, 236-2 transmit location signals 238-1, 238-2 having different frequency content. For example, location indicator 236-1 may transmit a location signal 238-1 having a first frequency component (“Freq. 1” in FIG. 14) that is different from a frequency component included in location signal 238-2. Similarly, location indicator 236-2 may transmit a location signal 238-2 having a second frequency component (“Freq. 2” in FIG. 14) that is different from a frequency component included in location signal 238-1.

In one example, location signal 238-1 and location signal 238-2 may be sine wave signals having first and second frequencies, respectively. In this example, the first frequency may be different than the second frequency. For example, location signal 238-1 may be a sine wave having a frequency of 1 kHz and location signal 238-2 may be a sine wave having a frequency of 2 kHz. MSD 238 may detect the different frequencies and differentiate between location signals 238-1, 238-2 based on the different frequencies. In examples where a store includes an additional plurality of location indicators, each of the location indicators may transmit sine waves having different frequencies. In these examples, MSD 234 be configured to detect the different frequencies and differentiate between the different frequencies of sine waves transmitted by the additional location indicators.

Initially, MSD 234 is located at position 240-1. MSD 234 detects location signal 238-1 having a first frequency component at position 240-1. MSD 234 may determine a location value of 242-1 in area 242-1 based on detected location signal 238-1 having the first frequency component. MSD 234 is then moved from position 240-1 to position 240-2. When moving from position 240-1 to position 240-2, MSD 234 moves from a position in which only a first frequency component is detected to a position in which first and second frequency components are detected.

Location signal 238-1 overlaps with location signal 238-2 at position 240-2 such that MSD 234 may detect first and second frequency components at position 240-2. Accordingly, at position 240-2, MSD 234 may detect first and second frequency components of location signals 238-1, 238-2 and determine a location value of “242-1+242-2” in area “242-1+242-2” based on the detected frequency components of location signals 238-1, 238-2. MSD 234 is then moved from position 240-2 to position 240-3. MSD 234 acquires the second frequency component of location signal 238-2 in position 240-3, but may not detect the first frequency component of location signal 238-1. Accordingly, MSD 234 may determine a location value of 242-2 in area 242-2 based on the detected second frequency component of location signal 238-2.

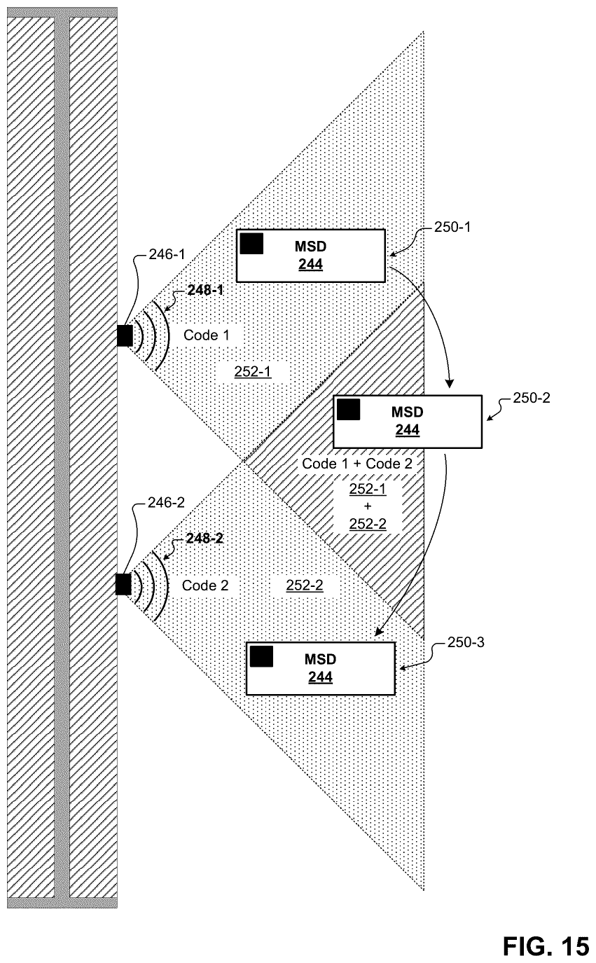

FIG. 15 shows an example in which an MSD 244 is moved through a portion of a store in which location indicators 246-1, 246-2 transmit location signals 248-1, 248-2 including different coded values. For example, location indicator 246-1 may transmit a location signal 248-1 including a first code (“Code 1” in FIG. 15) that is different from a second code included in location signal 248-2. Similarly, location indicator 246-2 may transmit a location signal 248-2 having a second code (“Code 2” in FIG. 15) that is different from the first code included in location signal 248-1. The codes transmitted by location indicators 246-1, 246-2 may be digital codes (e.g., alphanumeric codes) in some examples.

MSD 244 may detect the different codes and differentiate between location signals 248-1, 248-2 based on the different codes. In examples where a store includes an additional plurality of location indicators, each of the location indicators may transmit different codes. In these examples, MSD 244 may be configured to detect the different codes and differentiate between the different codes transmitted by the additional location indicators.

Initially, MSD 244 is located at position 250-1. MSD 244 detects location signal 248-1 including a first code at position 250-1. MSD 244 may determine a location value of 252-1 in area 252-1 based on detected location signal 248-1 having the first code. MSD 244 is then moved from position 250-1 to position 250-2. When moving from position 250-1 to position 250-2, MSD 244 moves from a position in which only the first code is detected to a position in which first and second codes are detected.

Location signal 248-1 overlaps with location signal 248-2 at position 250-2 such that MSD 244 may detect first and second codes at position 250-2. Accordingly, at position 250-2, MSD 244 may detect first and second codes and determine a location value of “252-1+252-2” in area “252-1+252-2” based on the detected codes of location signals 248-1, 248-2. MSD 244 is then moved from position 250-2 to position 250-3. MSD 244 acquires the second code in position 250-3, but may not detect the first code. Accordingly, MSD 244 may determine a location value of 252-2 in area 252-2 based on the detected second code.

As described herein, location values may be associated with stocked items. For example, each stocked item in the store may be associated with a location value. Each location value may be associated with multiple different stocked items. In general, a stocked item may be associated with a location value that may be determined by an MSD in proximity to that stocked item. In the case where a first location indicator generates a first location signal including a first location value, items in proximity to the first location signal may be associated with the first location value. In the case where a first location indicator includes a first readable code including a first location value, items in proximity to the first location indicator including the readable code may be associated with the first location value. The associations between location values and items may be generated manually by a user in some examples. In other examples, the associations between location values and items may be generated automatically (e.g., by one or more MSDs and/or the CCS). The associations between location values and stocked items may be stored in one or more MSDs and/or the CCS.

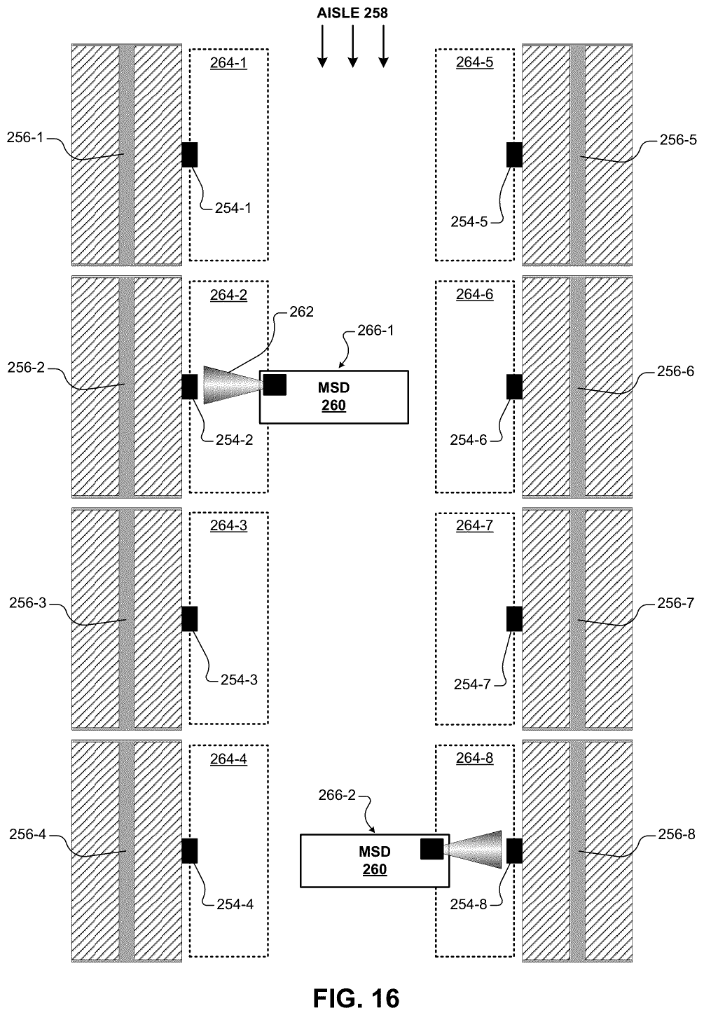

FIG. 16 illustrates example arrangements of location indicators and associated location values that are associated with different areas of a store. Location indicators 254-1, 254-2, . . . , 254-8 (hereinafter “location indicators 254”) may include readable codes. For example, location indicators 254 may be readable codes printed onto objects (e.g., labels) and attached to racks 256-1, 256-2, . . . , 256-8 along aisle 258. The readable codes may represent a variety of different data, such as alphanumeric codes.

MSD 260 may scan readable codes on location indicators 254 to determine location values associated with location indicators 254. As described hereinafter, MSD 260 includes a location detection module (e.g., location detection module 422 of FIG. 25) that is configured to scan readable codes of location indicators 254. Scanning by MSD 260 is illustrated as a shaded cone 262. Each of location indicators 254 may have different readable codes such that MSD 260 determines different location values for each of location indicators 254. Since each of location indicators 254 may have a different readable code, MSD 260 may uniquely identify a location within the store based on the readable code that is scanned from the location indicator.

The area of the store associated with a location value of a readable code may be the area of the store in proximity to the readable code. For example, in FIG. 16, each of racks 256 includes a single location indicator (e.g., a single location value) that may be associated with the areas in front of racks 256. The areas associated with location indicators 254 are illustrated as dotted rectangles in FIG. 16. In one example, MSD 260 may scan location indicator 254-1 to determine location value 264-1 for area 264-1. Similarly, MSD 260 may scan location indicator 254-7 to determine location value 264-7 for area 264-7.

Initially, MSD 260 is located at position 266-1. At position 266-1, MSD 260 scans location indicator 254-2 and determines location value 264-2 in area 264-2. MSD 260 is moved from position 266-1 to position 266-2. At position 266-2, MSD 260 scans location indicator 254-8 and determines location value 264-8 in area 264-8. As described hereinafter, location value 264-2 may be associated with items on rack 256-2 that may be accessible in area 264-2. Similarly, location value 264-8 may be associated with items on rack 256-8 that may be accessible in area 264-8.

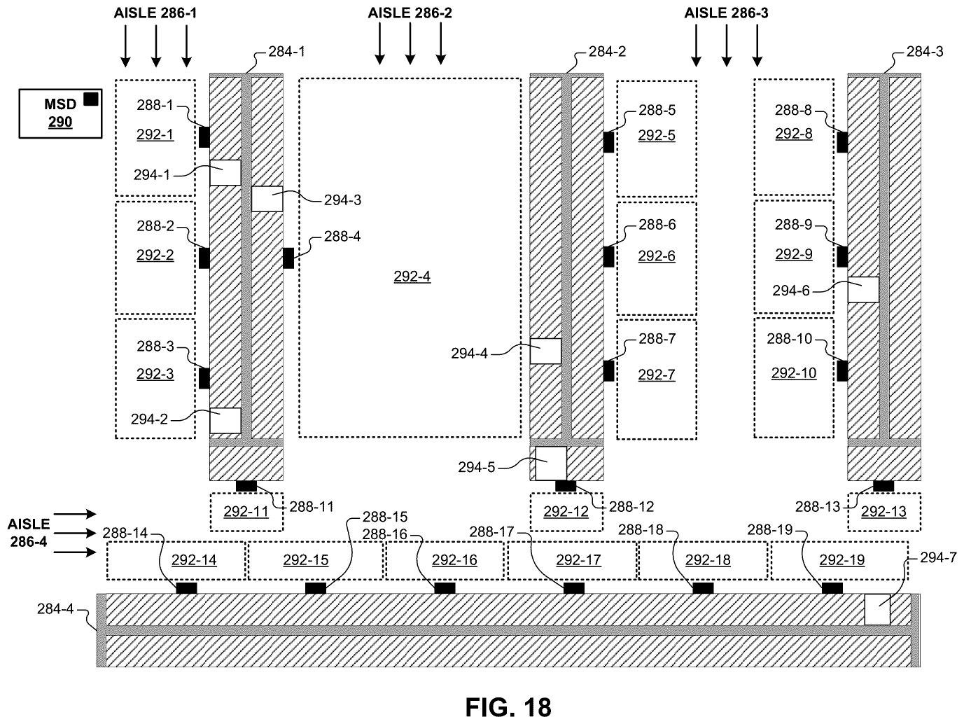

FIGS. 17-18 show example store layouts including a variety of location indicators and items. As described herein, items may be associated with location values. For example, the CCS, MSDs, and/or other computing devices may store associations between items and location values. In general, when the MSD determines a location value, items associated with that location value may be in proximity to the MSD. Put another way, an item may be associated with a location value that would be determined by an MSD in proximity to that item. In some examples, the associations between the items and the location values may be entered manually by a user. In other examples, the associations between the items and the location values may be automatically generated.

FIG. 17 shows a store layout including four racks 268-1, 268-2, 268-3, 268-4 (collectively “racks 268”) that define four aisles 270-1, 270-2, 270-3, 270-4 (collectively “aisles 274”). The store of FIG. 17 includes location indicators 276-1, 276-2, . . . , 276-10 (collectively “location indicators 276”) that transmit location signals. MSD 278 may determine location values 280-1, 280-2, . . . , 280-10, “280-5+280-6”, “280-9+280-10” (collectively “location values 280”) based on detected location signals. The areas covered by location signals are illustrated in FIG. 17 as dotted rectangles. Areas in which multiple location signals are detected are illustrated as shaded rectangles in FIG. 17. The store of FIG. 17 also includes dead zones 281-1, 281-2, 281-3.

The store of FIG. 17 includes items 282-1, 282-2, . . . , 282-9 (collectively “items 282”). Items 282 are associated with location values 280 (i.e., areas) of the store. The associations between items 282 and location values 280 may be stored in the CCS, one or more MSDs, and/or other computing devices. In general, items are associated with location signals (i.e., areas) in proximity to the items. For example, item 282-1 may be associated with location value 280-1. Items 282-3, 282-4, 282-5 may be associated with location value 280-4. Item 282-6 may be associated with location value “280-5+280-6”. Item 282-7 and item 282-9 may be associated with location value 280-10 and location value 280-9, respectively. Item 282-8 may be associated with location value “280-9+280-10”.

In FIG. 17, it may be assumed that MSD 278 has received a customer order including items 282. As described hereinafter in greater detail, MSD 278 may include a display that displays some, or all, of items 282 to a user. MSD 278 may arrange the displayed items based on which of location signals are detected. In general, MSD 278 may arrange the displayed items such that the items in proximity to MSD 278 (i.e., in proximity to the user) are viewable by the user on the display. In one example, MSD 278 may arrange items on the display such that those items in proximity to the user are more prominently displayed than those items that are farther away from MSD 278. For example, MSD 278 may display items in the current area at the top of the display. Additionally, or alternatively, MSD 278 may display the items in bold and/or colored text to indicate those items that are in proximity to the user. Displaying of items based on the currently determined location value is described hereinafter in greater detail.

FIG. 18 shows a store layout including four racks 284-1, 284-2, 284-3, 284-4 (collectively “racks 284”) that define four aisles 286-1, 286-2, 286-3, 286-4 (collectively “aisles 286”). The store of FIG. 18 includes location indicators 288-1, 288-2, . . . , 288-19 (collectively “location indicators 288”) that include readable codes. MSD 290 may scan location indicators 288 to determine location values 292-1, 292-2, . . . , 292-19 in areas 292-1, 292-2, . . . , 292-19 (collectively “areas 292”). Areas 292 in proximity to location indicators 288 are illustrated as dotted rectangles. For example, MSD 290 may scan location indicator 288-1 to determine location value 292-1 for area 292-1. Similarly, MSD 290 may scan location indicator 288-19 to determine location value 292-19 for area 292-19.

The store of FIG. 18 includes items 294-1, 294-2, . . . , 294-7 (collectively “items 294”). Items 294 are associated with location values 292 (i.e., areas) of the store. The associations between items 294 and location values 292 may be stored in the CCS, one or more MSDs, and/or other computing devices. In general, items are associated with location values (i.e., areas) in proximity to the items. For example, item 294-1 and item 294-2 may be associated with location value 292-1 and location value 292-3, respectively. Similarly, items 294-3, 294-4 may be associated with location value 292-4. As another example, item 294-5 may be associated with location value 292-12.

In FIG. 18, it may be assumed that MSD 290 has received a customer order including items 294. As described hereinafter in greater detail, MSD 290 may include a display that displays some, or all, of items 294 to a user. MSD 290 may arrange the displayed items based on which of location values 292 are determined. In general, MSD 290 may arrange the displayed items such that the items in proximity to MSD 290 (i.e., in proximity to the user) are viewable by the user on the display. In one example, MSD 290 may arrange items on the display such that those items in proximity to the user are more prominently displayed than those items that are farther away from MSD 290. For example, MSD 290 may display items in the current area at the top of the display. Additionally, or alternatively, MSD 290 may display the items in bold and/or colored text to indicate those items that are in proximity to the user.

One or more computing devices may store a location map that defines the spatial relationships between different areas of the store. For example, a location map may define the relative distances between different areas of the store. In some examples, two areas may be adjacent to one another. For example, the two areas may be touching one another. In other examples, two areas may not be adjacent to one another. Instead, one or more additional areas may be located between the two areas.

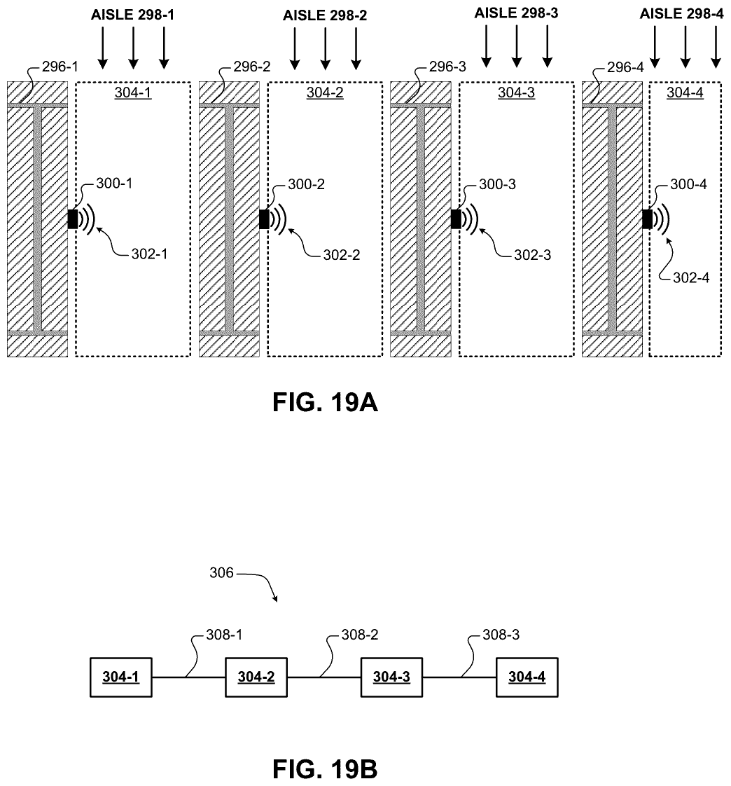

Example location maps are illustrated and described with respect to FIGS. 19A-22B. Location maps are graphically represented herein using boxes to represent different areas in the store. The boxes are connected to one another using one or more junctions (e.g., 308-1, 308-2 of FIG. 19B). The areas that are adjacent to one another may be connected using a single junction. For example, in FIG. 19B, area 304-1 is connected to area 304-2 by junction 308-1. Areas that are separated from one another (e.g., by another junction) may be connected via one or more junctions. For example, area 304-1 is connected to area 304-3 via junction 308-1 and junction 308-2 in FIG. 19B because area 304-2 is located between area 304-1 and area 304-3 in FIG. 19A. Location maps may be generated manually by a user in some examples. In other examples, the location maps may be generated automatically (e.g., by one or more MSDs and/or the CCS). The location maps may be stored in one or more MSDs and/or the CCS.

In general, location maps may define the spatial relationships between different areas of the store. In examples where location indicators transmit location signals, the location map may define how the areas of the store covered by the location signals are arranged relative to one another. For example, the location map may define the distances between the areas of the store covered by the location signals. In examples where the location indicators include readable codes, the location map may define the location of each of the location indicators (i.e., readable codes) relative to one another. For example, the location map may define the distances between different readable codes.

Since items may be associated with location values, and the location map may indicate the distance between areas in which the location values are determined by an MSD, an MSD may determine the distance between items using the location map. After an MSD determines the distance between ordered items using the location map, the MSD may arrange the items on the display based on the distance of each of the items from the current location of the MSD (i.e., the user).

Referring now to FIGS. 19A-19B, the store of FIG. 19A includes four racks 296-1, 296-2, 296-3, 296-4 (collectively “racks 296”) that define four aisles 298-1, 298-2, 298-3, 298-4 (collectively “aisles 298”). The store of FIG. 19A includes location indicators 300-1, 300-2, 300-3, 300-4 (collectively “location indicators 300”) that transmit location signals 302-1, 302-2, 302-3, 302-4 (collectively “location signals 302”). An MSD may determine location values 304-1, 304-2, 304-3, 304-4 based on detected location signals 302-1, 302-2, 302-3, 302-4, respectively. Areas 304-1, 304-2, 304-3, 304-4 (collectively “areas 304”) covered by location signals 302 are illustrated in FIG. 19A as dotted rectangles.

In FIG. 19A, area 304-1 is adjacent to area 304-2. Area 304-2 is adjacent to area 304-1 and area 304-3. Area 304-3 is adjacent to area 304-2 and area 304-4. Area 304-4 is adjacent to area 304-3. Location map 306 of FIG. 19B may represent the relative distances between areas 304. For example, area 304-1 is connected to area 304-2 by a single junction 308-1 to represent that area 304-1 is adjacent to area 304-2. Similarly, area 304-2 is connected to area 304-3 by a single junction 308-2 to represent that area 304-2 is adjacent to area 304-3. Area 304-1 and area 304-4 are the areas of FIG. 19A that are farthest apart. The distance between area 304-1 and area 304-4 may be represented by the three junctions 308-1, 308-2, 308-3 that separate area 304-1 and area 304-4 in location map 306.

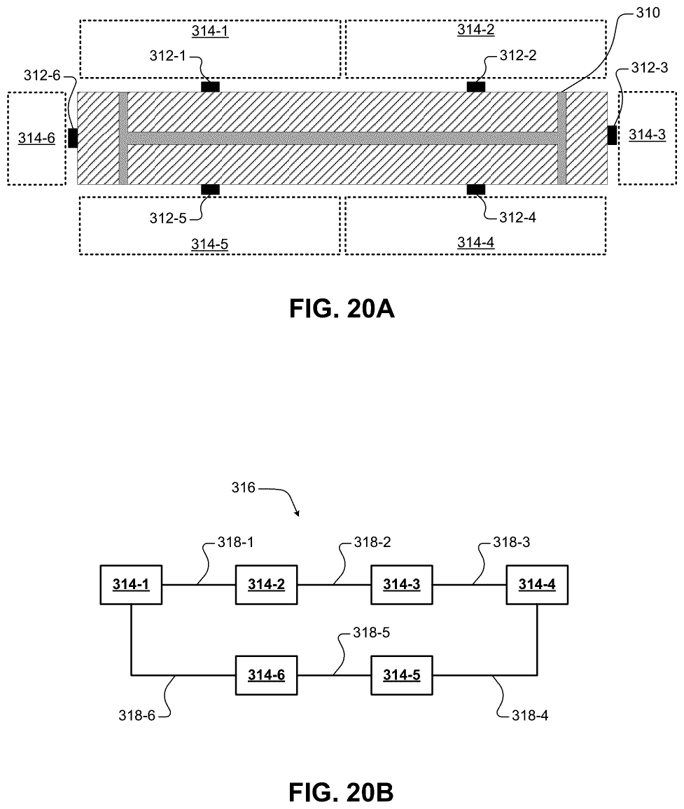

FIGS. 20A-20B show another example location indicator layout. FIG. 20A includes rack 310 that may be accessed from all sides. Rack 310 includes location indicators 312-1, 312-2, . . . , 312-6 (collectively “location indicators 312”) having readable codes. An MSD may scan location indicators 312 to determine location values 314-1, 314-2, . . . , 314-6. Areas 314-1, 314-2, . . . , 314-6 (collectively “areas 314”) surround rack 310 such that the location indicator layout in FIG. 20A results in a location map 316 in which each of areas 314 are adjacent to two other areas. Junctions 318-1, 318-2, . . . , 318-6 may represent the relative distances between areas 314. For example, area 314-1 is connected to area 314-2 by a single junction 318-1 to represent that area 314-1 is adjacent to area 314-2. Similarly, area 314-2 is connected to area 314-3 by a single junction 318-2 to represent that area 314-2 is adjacent to area 314-3. The distance between area 314-1 and area 314-4, which are not adjacent, may be represented by the three junctions 318-1, 318-2, 318-3 that separate area 314-1 and area 314-4 in location map 316. Similarly, the distance between area 314-3 and area 314-6 may be represented by the three junctions 318-3, 318-4, 318-5 that separate area 314-3 and area 314-6 in location map 316. Alternatively, a user may travel from area 314-3 to area 314-6 via areas 314-1, 314-2. The distance between area 314-3 and area 314-6 via areas 314-1, 314-2 may be represented by three junctions 318-1, 318-2, 318-6 that separate area 314-3 and area 314-6.

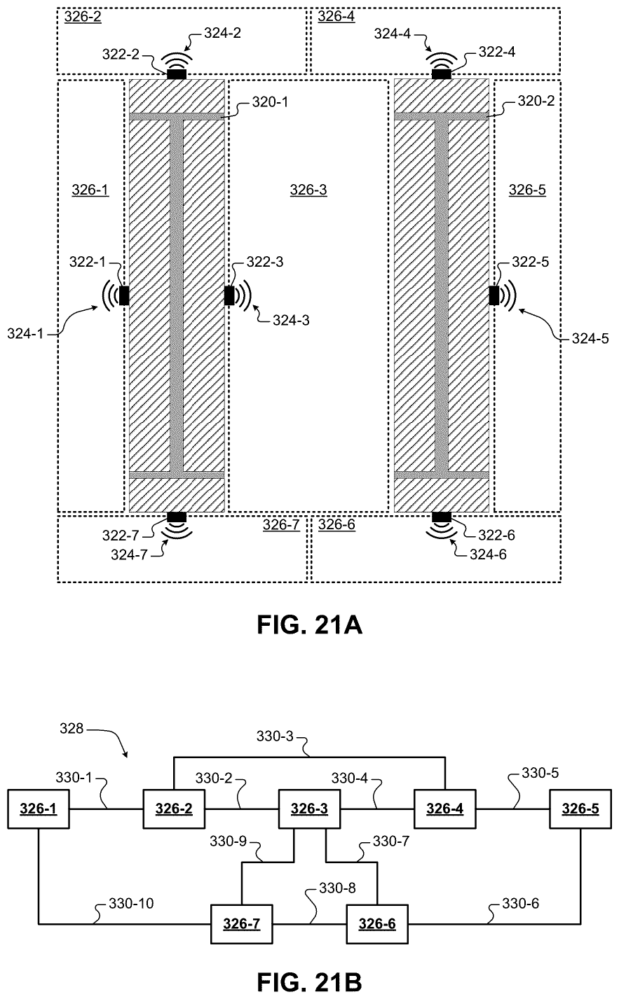

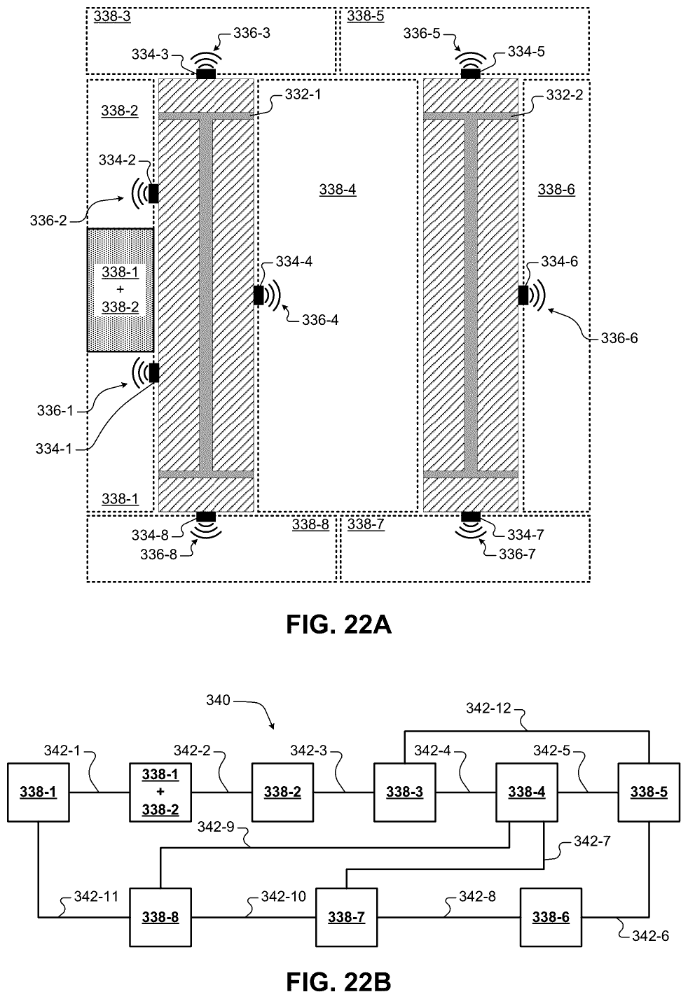

FIGS. 21A-22B illustrate location indicator layouts which are more elaborate than those layouts illustrated in FIGS. 19A-20B. The store of FIG. 21A includes racks 320-1, 320-2. The store of FIG. 21A includes location indicators 322-1, 322-2, . . . , 322-7 (collectively “location indicators 322”) that transmit location signals 324-1, 324-2, . . . , 324-7 (collectively “location signals 324”). An MSD may determine location values 326-1, 326-2, . . . , 326-7 based on detected location signals 324 in areas 326-1, 326-2, . . . , 326-7 (collectively “areas 326”).

The layout of location indicators in FIG. 21A may be considered to be more elaborate than the layout of location indicators in FIGS. 19A-20B in that the store of FIG. 21A includes a greater number of areas. Furthermore, areas 326 in FIG. 21A may be adjacent to up to four other areas. For example, area 326-3 is adjacent to areas 326-2, 326-4, 326-6, 326-7. Multiple other areas are also adjacent to three other areas. For example, area 326-2 is adjacent to areas 326-1, 326-3, 326-4.

Location map 328 includes junctions 330-1, 330-2, . . . , 330-10 (collectively “junctions 330”). Junctions 330 may represent distances between areas 326. For example, adjacent areas (i.e., those connected by one junction) may be closer to one another than non-adjacent areas. However, since areas 322 are not all of equal size, all of junctions 330 may not represent equal distances. For example, areas 326-1, 326-3, 326-5 are slightly larger than areas 326-2, 326-4, 326-6, 326-7. Therefore, any path through location map 328 including areas 326-1, 326-3, 326-5 may represent a slightly longer distance than paths that do not include areas 326-1, 326-3, 326-5. For example, a path from area 326-6 to area 326-4 via area 326-5 (i.e., via junctions 330-6, 330-5) may represent a slightly greater distance than a path from area 326-5 to area 326-7 via area 326-6 (i.e., via junctions 330-6, 330-8).

As described above with respect to FIGS. 21A-21B, the number of junctions between areas may generally represent the distance between areas. However, in some examples, the distance represented by a junction may vary depending on the amount of area covered by a location indicator. Accordingly, it follows that the arrangement of location indicators and the areas covered by location signals may be adjusted in order to adjust the information conveyed by a location map stored within a computing device. For example, when location indicators are arranged at approximately equal distances from one another, the junctions of a location map may represent approximately equal distances between different areas of the store.

FIGS. 22A-22B illustrate a location indicator layout in which two location signals overlap to form an area of the store in which an MSD detects multiple location signals. The store of FIG. 22A includes racks 332-1, 332-2. The store of FIG. 22A includes location indicators 334-1, 334-2, . . . , 334-8 (collectively “location indicators 334”) that transmit location signals 336-1, 336-2, . . . , 336-8 (collectively “location signals 336”). An MSD may determine location values 338-1, 338-2, . . . , 338-8, and “338-1+338-2” based on detected location signals 336 in areas 338-1, 338-2, . . . , 338-8, and “338-1+338-2” (collectively “areas 338”). Note that location map 340 of FIG. 22B includes an area “338-1+338-2” in which two location signals 336-1, 336-2 are detected by an MSD. In this example, area “338-1+338-2” is mapped as an area that is adjacent to area 338-1 and area 338-2. Location map 340 includes junctions 342-1, 342-2, . . . , 342-12 (collectively “junctions 342”). Junctions 342 may represent distances between areas 338. Each of junctions 342 may not represent equal distances, as described above with respect to FIGS. 21A-21B.

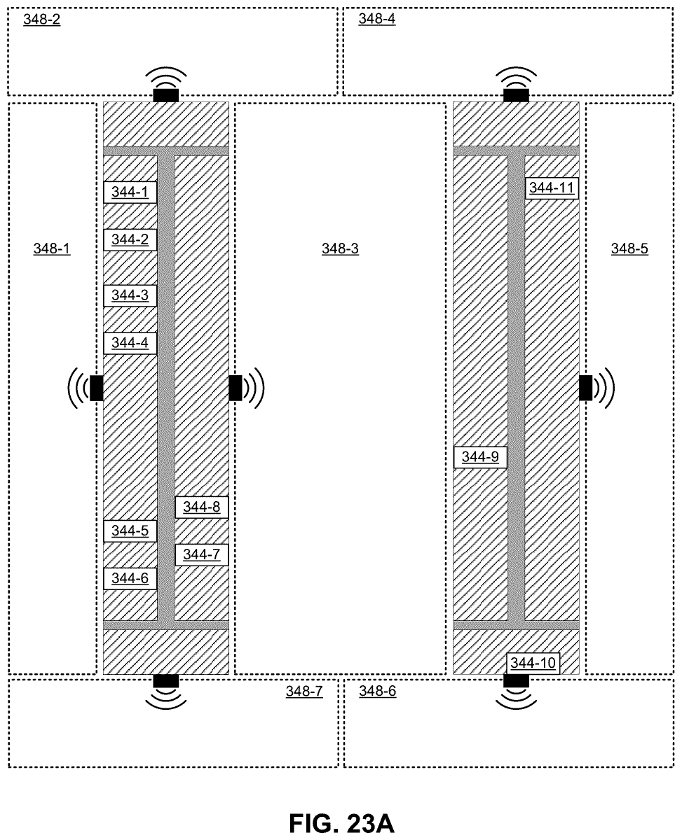

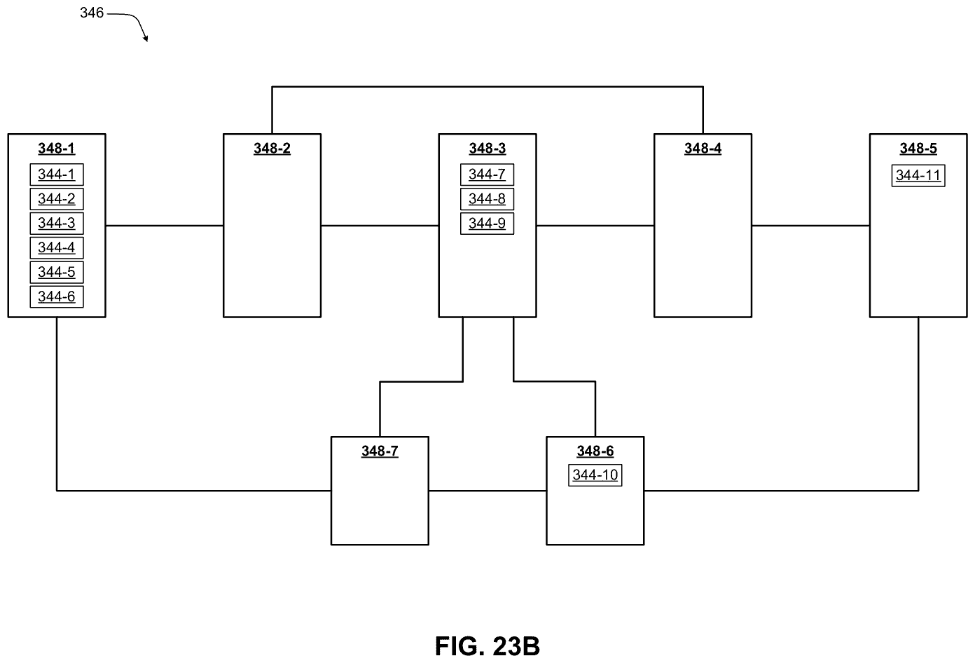

FIG. 23A shows an example store including items 344-1, 344-2, . . . , 344-11 (collectively “items 344”). FIG. 23B shows a location map 346 including items 344. Location map 346 illustrates the association between location values 348 and items 344. Note that the layout of the location indicators and the location map 346 of FIGS. 23A-23B have been described with reference to FIGS. 21A-21B.

Each of items 344 is associated with a location value. For example, items 344-1, 344-2, . . . , 344-6 are proximate to area 348-1 and associated with location value 348-1. Items 344-7, 344-8, 344-9 are proximate to area 348-3 and associated with location value 348-3. Item 344-10 is proximate to area 348-6 and associated with location value 348-6. Item 344-11 is proximate to area 348-5 and associated with location value 348-5. As described hereinafter, items may be displayed on an MSD based on a location map and a currently determined location value. For example, an MSD may include a location map which the MSD may use to arrange ordered items on the display of the MSD.

FIGS. 24-25 show functional block diagrams of example MSDs. MSD 350 of FIG. 24 is configured to receive location signals and determine location values based on received location signals. MSD 352 of FIG. 25 is configured to scan location indicators that include readable objects and determine location values based on the scanned readable objects. MSDs 350, 352 may be implemented using a variety of different form factors.

Referring now to FIG. 24, MSD 350 includes a touchscreen display 354 and a user interface 356. Touchscreen display 354 may include a combination display (e.g., an LCD or OLED display) and a touchscreen. Touchscreen display 354 may display information (e.g., ordered items) to a user. Touchscreen display 354 may also receive user touch input, such as tapping, swiping, and multi-finger input. Although MSDs 350, 352 include touchscreen display 354, in other examples, the display of an MSD may not include touchscreen capabilities.

User interface 356 may represent user interface components, other than touchscreen display 354, which may provide a user interface experience. A user may interact with MSD 350 using user interface 356. User interface 356 may include input components which a user may use to input information into MSD 350, such as touch controls (e.g., capacitive touch buttons, a touchpad, and/or a touch wheel), a keypad (e.g., alphanumeric keys), buttons, a directional pad, an analog stick, switches, a scroll wheel, a track ball, accelerometers, a microphone, or other user interface components. User interface 356 may also include one or more feedback components that provide feedback to a user. Feedback components may include a speaker that provides audible feedback, a vibrating device that provides tactile feedback, and/or visual feedback devices (e.g., LEDs).

A user may interact with MSD 350 using touchscreen display 354 and/or user interface 356. For example, a user may view items included in customer orders along with other information on touchscreen display 354. A user may also swipe their finger across touchscreen display 354 to scroll through the items displayed on touchscreen display 354. As described herein, the items displayed on touchscreen display 354 may be arranged based on a current location of MSD 350.

MSD 350 includes a processing module 358 and memory 360. Processing module 358 may take the form of one or more microprocessors, microcontrollers, digital signal processors (DSPs), application-specific integrated circuits (ASICs), field-programmable gate arrays (FPGAs), programmable logic circuitry, or the like. The functions attributed to processing module 358 herein may be embodied as hardware, firmware, software or any combination thereof. Processing module 358 may provide any of the functionality ascribed herein to MSD 350, or otherwise perform any of the methods described herein.

Memory 360 may store instructions that cause processing module 358 to provide the functionality ascribed to MSD 350 herein. Memory 360 may include any fixed or removable media. For example, memory 360 may include magnetic or electrical media, such as RAM, ROM, magnetic disks, EEPROM, or the like. Memory 360 may also include a removable memory portion that may be used to provide memory updates or increases in memory capacities.

MSD 350 includes a communication module 362 that may provide wireless communication functionality. MSD 350 may communicate with other computing devices using communication module 362, which may be coupled to an internal antenna or an external antenna. For example, MSD 350 may send data to other computing devices using communication module 362. Additionally, MSD 350 may receive data from other computing devices using communication module 362. Examples of wireless communication techniques that may be employed to facilitate communication between MSD 350 and other computing devices using communication module 362 may include communication according to 802.11 or BLUETOOTH specification sets, infrared communication (e.g., according to the IrDA standard), near-field communication (NFC), cellular communication, or other standard or proprietary communication protocols.

In some examples, MSD 350 may communicate directly with other MSDs. For example, MSD 350 may transmit data from communication module 362 to a communication module of another MSD. Similarly, MSD 350 may receive data from one or more MSDs via communication module 362. In other examples, MSD 350 may communicate with other MSDs via a communication system of a store (e.g., communication system 112 of FIG. 1). In these examples, MSD 350 may transmit data to the communication system from communication module 362. The transmitted data may then be sent from the communication system to other MSDS.

In some examples, MSD 350 may communicate with a CCS of a store (e.g., CCS 104 of FIG. 1) via a communication system (e.g., communication system 112 of FIG. 1) of the store. For example, MSD 350 may transmit data from communication module 362 to the communication system. The communication system may then send the data to the CCS. MSD 350 may also receive data from the communication system. For example, the CCS may send data to the communication system which then wirelessly transmits the data to communication module 362.

MSD 350 includes a scanning module 364 that may represent any devices (e.g., electronic hardware, software/firmware) configured to scan item ID codes. For example, scanning module 364 may be configured to scan printed codes, such as barcodes (e.g., linear, 2D, or QR barcodes). Scanning module 364 may include one or more types of technology for scanning item ID codes. In some examples, scanning module 364 may include one or more photodiodes and associated electronics/software for reading light and dark portions of an item ID code on the item. In some examples, scanning module 364 may include one or more lasers and associated electronics/software for scanning back and forth across an item ID code to read the item ID code. In some examples, scanning module 364 may include one or more charge-coupled device readers (“CCD readers”) and associated electronics/software for reading light and dark portions of an item ID code on the item. In some examples, scanning module 364 may include a small camera (e.g., CCD reader or CMOS imaging) and associated image processing electronics/software for interpreting the item ID code. Shading 366 included in FIGS. 24-25 is meant to illustrate the scanning of item ID code 368 (e.g., a barcode) on item 370 (e.g., using a photodiode, one or more lasers, or other technology).

Scanning module 364 may be configured to scan item ID codes in response to user input. For example, a user may press a key (e.g., pull a trigger) on user interface 356 to cause scanning module 364 to scan an item ID code. Example form factors of MSD 350 including a key (e.g., a trigger) which may be pressed by a user to initiate an item scan are illustrated in FIGS. 26A, 26B, 26D, 26F. In other examples, scanning module 364 may not require user input to operate. Instead, scanning module 364 may constantly operate. In these examples, a laser, or other technology included in scanning module 364 may constantly operate and may scan an item ID code when the user places the item including the item ID code in front of scanning module 364.

In some examples, item ID codes may not be included on items as printed codes. Instead, items may include RFID tags that include the item ID codes. It is contemplated that scanning module 364 may include an RFID tag reader in addition to, or instead of, optical scanning technology in order to allow scanning module 364 to scan RFID tags. Accordingly, scanning module 364 may also represent RFID reader electronics/software for scanning RFID tags.

MSD 350 includes a location detection module 372 that receives a location signal and determines a location value based on the received location signal. A location indicator 374 that transmits location signal 376 is included in FIG. 24 to indicate that location detection module 372 is configured to receive location signals. Location detection module 372 may generally represent any devices (e.g., electronic hardware and software) capable of receiving location signals and generating location values described herein. In some examples, location detection module 372 may include an antenna for receiving location signals transmitted by antennas included on location indicators. In other examples, location detection module 372 may include a light detection device for receiving location signals transmitted by light emitting devices (e.g., LEDs or other photonic devices). In other examples, location detection module 372 may include an acoustic device for receiving location signals (e.g., sound waves) transmitted by an acoustic device. In other examples, where location indicators in the store include RFID tags, location detection module 372 may be configured to scan the RFID tags and determine a location value based on the data retrieved from the RFID tags. Additionally, in some examples, location detection module 372 may be configured to transmit energy to energize RFID tags so that the RFID tags may transmit data to location detection module 372.

MSD 350 includes a power source 378 that delivers operating power to the components of MSD 350. Power source 378 may include a fixed or removable battery in some examples. In some examples, power source 378 may include an adapter for charging the battery.

Processing module 358 may receive input and data from various components of MSD 350. For example, processing module 358 may receive user input from user interface 356 and touchscreen display 354. Additionally, processing module 358 may receive data from communication module 362 (e.g., received wireless data and customer orders), scanning module 364 (e.g., item IDs), and location detection module 372 (e.g., location values). Processing module 358 may also receive data from memory 360 (e.g., a location map and associations between items and location values).

Processing module 358 may also send data to components of MSD 350. For example, processing module 358 may store a list of items in memory 360 from the customer orders that have been placed. Processing module 358 may store the items of customer orders in memory 360 as follows. When a customer order is placed, a communication system (e.g., communication system 112) may transmit the customer order to communication module 362. Processing module 358 may then store the received customer order in memory 360.

Processing module 358 may then update the customer orders in memory 360 as new customer orders are placed.

Processing module 358 may also control components of MSD 350, such as touchscreen display 354 and scanning module 364. For example, processing module 358 may control the image (e.g., the ordered items) displayed on touchscreen display 354. Additionally, processing module 358 may control when scanning module 364 scans an item. For example, when processing module 358 detects a user pushing a scan button (e.g., a trigger) of user interface 356, processing module 358 may instruct scanning module 364 to scan an item ID code. After scanning module 364 scans an item ID code, scanning module 364 may send the item ID code to processing module 358. As described hereinafter, processing module 358 may keep track of which items have been scanned by MSD 350 and other MSDs. For example, processing module 358 may remove the item ID code from the list of currently ordered items in memory 360 after the item has been scanned.

Although the MSDs are illustrated in FIGS. 24-25 as rectangular, MSD 350 may be configured into a variety of different form factors. In general, MSD 350 may have a form factor that may be transported by a user throughout the store. In some examples, MSD 350 may have a handheld form factor. In other examples, MSD 350 may be configured to be placed in, or attached to, a cart and moved around the store by a user.

In some examples, components of MSD 350 may be included in a single housing (e.g., a molded plastic housing). For example, touchscreen display 354, user interface 356, memory 360, communication module 362, processing module 358, scanning module 364, location detection module 372, and power source 378 may be housed in a single housing. When housed in the single housing, in some examples, MSD 350 may be embodied as a hand-held computing device that a user may easily transport throughout the store.

Although the MSDs in FIGS. 24-25 are illustrated as included in a single rectangular housing, it is contemplated that components of MSDs may be housed in multiple different housings. In these examples, the different components of MSDs may be wired together or may wirelessly communicate with one another. Example MSD form factors are illustrated in FIGS. 26A-26I.

FIG. 26A shows an example from factor 380 in which an MSD of the present disclosure may be implemented. The example device pictured in FIG. 26A is an XG100 W mobile computer available from Janam Technologies. Form factor 380 includes a display 382, keypad 384, and an example scanning module 386 (e.g., barcode reader). Although not shown in FIG. 26A, form factor 380 may be configured to include an internal communication module, memory, processing module, and power source according to the present disclosure. In examples where a store includes location indicators that have readable codes, scanning module 386 may also act as a location detection module. In examples where location indicators transmit location signals, additional components may be added to form factor 380 so that form factor 380 is configured to receive transmitted location signals. For example, an antenna, a light detection device, an acoustic device, and/or an RFID reader may be added to the form factor to receive transmitted location signals.

FIG. 26B shows an example from factor 388 in which an MSD of the present disclosure may be implemented. The example device of FIG. 26B is an Alien ALH-9000 handheld RFID reader available from Alien Technology. Form factor 388 includes a display 390, keypad 392, an example location detection module 394 (e.g., an RFID reader), and an example scanning module 396 (e.g., a barcode reader). Although not shown in FIG. 26B, form factor 388 may be configured to include an internal communication module, memory, processing module, and power source according to the present disclosure.

FIG. 26C shows an example from factor 398 in which an MSD of the present disclosure may be implemented. The example device of FIG. 26C is an MC55A0 handheld terminal available from Motorola. Form factor 398 includes a display 400, keypad 402, and an example scanning module (not shown) (e.g., barcode reader). Although not shown in FIG. 26C, form factor 398 may be configured to include an internal communication module, memory, processing module, and power source according to the present disclosure. In examples where a store includes location indicators that have readable codes, the scanning module may also act as a location detection module. In examples where location indicators transmit location signals, additional components may be added to form factor 398 so that form factor 398 is configured to receive transmitted location signals. For example, an antenna, a light detection device, an acoustic device, and/or an RFID reader may be added to the form factor to receive transmitted location signals.

FIG. 26D shows an example from factor 404 in which an MSD of the present disclosure may be implemented. The example device of FIG. 26D is a WT4090 wearable terminal available from Motorola. Form factor 404 includes a display 406, keypad 408, and an example scanning module 410 (e.g., barcode reader). Although not shown in FIG. 26D, form factor 404 may be configured to include an internal communication module, memory, processing module, and power source according to the present disclosure. In examples where a store includes location indicators that have readable codes, scanning module 410 may also act as a location detection module. In examples where location indicators transmit location signals, additional components may be added to form factor 404 so that form factor 404 is configured to receive transmitted location signals. For example, an antenna, a light detection device, an acoustic device, and/or an RFID reader may be added to the form factor to receive transmitted location signals.

FIGS. 26E-26I show example components that may be included in MSDs according to the present disclosure. FIGS. 26E-26F show example scanning modules 412, 414 (e.g., barcode scanners) that may be included in an MSD. For example, scanning modules 412, 414 may be connected to (e.g., wired/wirelessly) other components of an MSD of the present disclosure. The example devices of FIG. 26E-26F represent typical barcode scanners.

FIG. 26G shows an example touchscreen display 416 that may be included in an MSD. For example, such a touchscreen display 416 may be connected to (e.g., wired/wirelessly) other components of a MSD of the present disclosure. The example device of FIG. 26G is an IPAD MINI available from Apple. FIG. 26H shows an example display 418 (e.g., an electrophoretic display) that may be included in an MSD. For example, such a display 418 may be connected to (e.g., wired/wirelessly) other components of an MSD of the present disclosure. The example device of FIG. 26H is a KINDLE available from Amazon. FIG. 26I shows another example display 420 that may be included in an MSD. Display 420 is a heads-up display that may be worn on a user's head (e.g., as a pair of glasses). Display 420 may be connected to (e.g., wired/wirelessly) other components of an MSD of the present disclosure. The example device of FIG. 26I is a GOOGLE GLASS device available from Google. Although not illustrated in FIGS. 26A-26I, MSDs may also include other computing devices, such as smart phones (e.g., cell phones). Smart phones may include components that provide functionality attributed to the MSDs described herein. For example, smartphones may detect location signals, such as BLUETOOTH-based location signals, light transmissions from LEDs (e.g., using a camera), and acoustic location signals (e.g., using a microphone). Additionally, smartphones may include a camera or other device that can be used to scan an item ID code (e.g., a barcode). Accordingly, in some implementations, the customers may use their own smart phone devices to pick their own orders according to the present disclosure. Additionally, third-party pickers may also use their smart phones (or devices provided by the third-party to the pickers) to pick orders.

FIG. 25 shows another example MSD 352. MSD 352 of FIG. 25 is similar to MSD 350 of FIG. 24, except that location detection module 422 of FIG. 25 is different than location detection module 372 of FIG. 24. Location detection module 422 is configured to scan location indicators that include readable codes (e.g., location indicator 424) and determine a location value based on the scanned readable code. In some examples, the scanning functionality of scanning module 364 and location detection module 422 may be combined. For example, if location indicators include barcodes, MSD 352 may include barcode scanning hardware/software that may scan barcodes included on items and scan barcodes included on location indicators.

Location detection module 422 may represent any devices (e.g., electronic hardware, software/firmware) configured to scan readable codes. For example, location detection module 422 may be configured to scan readable codes (e.g., FIGS. 11A-11C) such as barcodes (e.g., linear, 2D, or QR barcodes). Location detection module 422 may include one or more types of technology for scanning readable codes. In some examples, location detection module 422 may include one or more photodiodes and associated electronics/software for reading light and dark portions of a readable code. In some examples, location detection module 422 may include one or more lasers and associated electronics/software for scanning back and forth across readable codes to read the readable codes. In some examples, location detection module 422 may include one or more CCD readers and associated electronics/software for reading light and dark portions of a readable code. In some examples, location detection module 422 may include a camera (e.g., CCD reader or CMOS imaging) and associated image processing electronics/software for interpreting the readable code. For example, location detection module 422 may acquire an image and identify a readable code in the image, even when the image includes other objects, such as items.

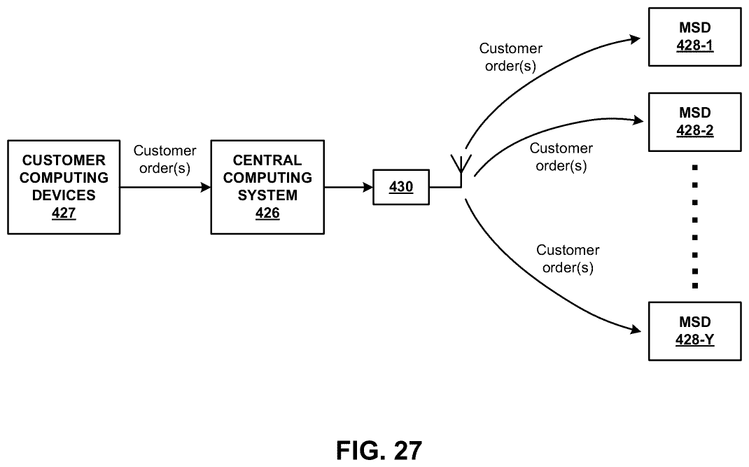

As described above, customers may place customer orders with a CCS. FIG. 27 shows the placement of customer orders with CCS 426 using CCDs 427. In FIG. 27, CCS 426 is configured to wirelessly transmit customer orders to MSDs 428-1, 428-2, . . . , 428-Y (collectively “MSDs 428”) via communication system 430. Each of MSDs 428 may receive the customer orders. Each of MSDs 428 may store the received customer orders in their respective memories.

Each of MSDs 428 may also display at least some of the ordered items on their respective displays. The arrangement of items displayed on each of MSDs 428 may depend on the locations of the MSDs. Arrangement of items on an MSD is described in further detail herein.

Although multiple MSDs 428 are illustrated in FIG. 27, in some examples, a store may include only a single MSD. For example, a store may include only MSD 428-1. In this example, CCS 426 may wirelessly transmit customer orders to MSD 428-1. MSD 428-1 may store the received customer orders in memory. Additionally, MSD 428-1 may determine a location value based on a received location signal (or scanned readable code) and arrange the items (e.g., some of the items) of customer orders on the display according to the determined location value.

A store may include any number of MSDs. As described above, a store may include a single MSD in some examples. In other examples, a store may include two or more MSDs. For example, a store may include 10 or more MSDs in some examples.

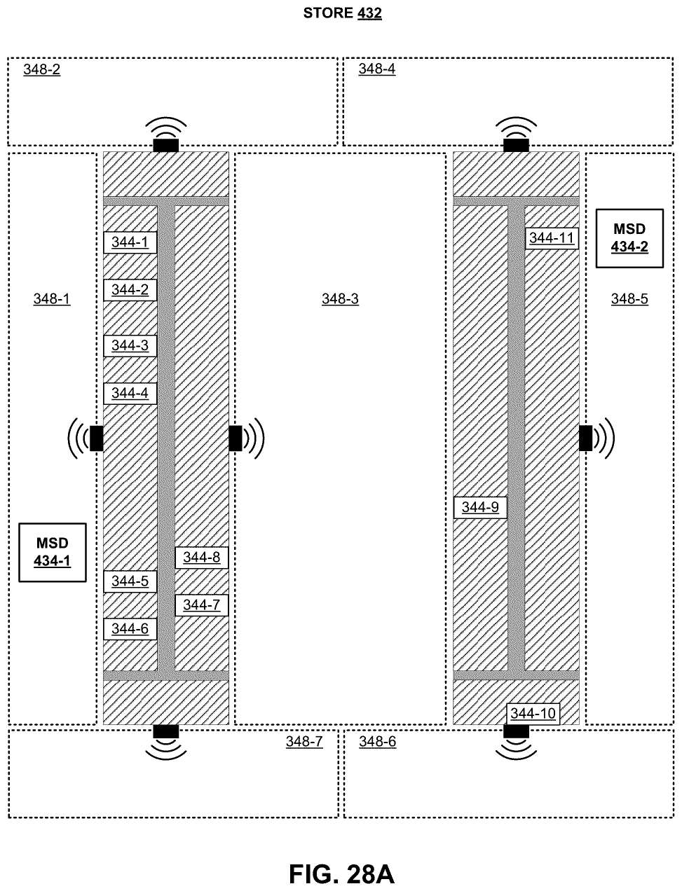

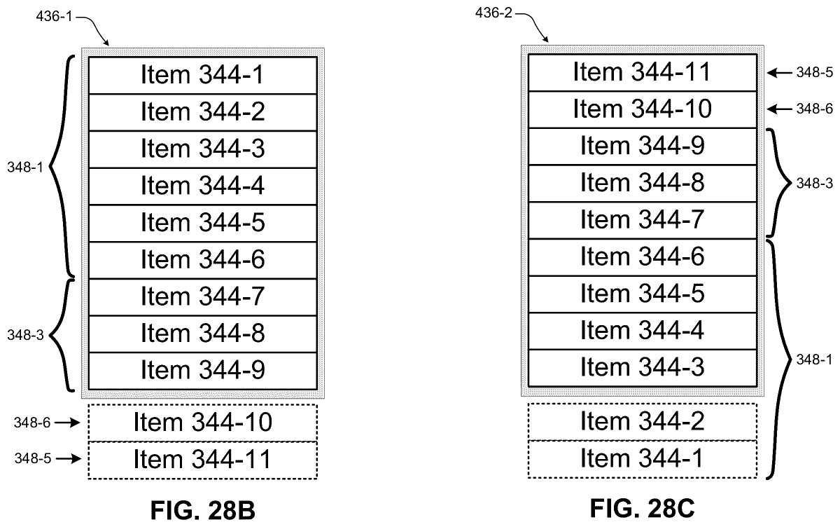

FIGS. 28A-28C show how multiple MSDs may display customer orders to users. In FIG. 28A, store 432 includes two MSDs 434-1, 434-2. It can be assumed that each of MSDs 434-1, 434-2 has received one or more customer orders including items 344-1, 344-2, . . . , 344-11 (collectively “items 344”) from a communication system. For example, a single customer order may have included all items 344. As another example, a first customer order may have included items 344-1, 344-2, and a second customer order may have included the remaining items 344-3, 344-4, . . . , 344-11. It may also be assumed that each of the memories of MSDs 434-1, 434-2 include items 344, a location map of store 432, and associations between items 344 and location values 348. The location map 346 of store 432 including items 344 is illustrated in FIG. 23B.

As shown in FIG. 28A, MSD 434-1 is in zone 348-1 which includes items 344-1, 344-2, . . . , 344-6. Accordingly, MSD 434-1 is likely to be nearest to items 344-1, 344-2, . . . , 344-6. According to location map 346, MSD 434-1 is near zone 348-3 including items 344-7, 344-8, 344-9. The next nearest zones including items of customer orders are zones 348-6, 348-5, which include items 344-10, 344-11. Based on the proximity of the zones described above with respect to location map 346, it may be most efficient for a user of MSD 434-1 to pick items from zone 348-1, then zone 348-3, then zone 348-6 and zone 348-5.

MSD 434-2 is in zone 348-5, which includes item 344-11. Accordingly, MSD 434-2 is likely to be nearest to item 344-11. According to location map 346, MSD 434-2 is near zone 348-6 including item 344-10. The next nearest zones including items of customer orders are zone 348-3 and zone 348-1, which include items 344-7, 344-8, 344-9 and items 344-1, 344-2, . . . , 344-6, respectively. Based on the proximity of the zones described above with respect to location map 346, it may be most efficient for a user of MSD 434-2 to pick items from zone 348-5, then zone 348-6, zone 348-3, and zone 348-1.

FIG. 28B shows an example display 436-1 of MSD 434-1 before MSD 434-1 has picked any of items 344. FIG. 28C shows an example display 436-2 of MSD 434-2 before MSD 434-2 has picked any of items 344. In FIG. 28B, display 436-1 of MSD 434-1 has items 344 arranged such that the items nearest to MSD 434-1 are located at the top of display 436-1. In FIG. 28C, display 436-2 of MSD 434-2 has items 344 arranged such that the items nearest to MSD 434-2 are located at the top of display 436-2. The zones that include each of the items are indicated next to displays 436-1, 436-2. Items in dotted boxes under displays 436-1, 436-2 represent those items that may not fit onto displays 436-1, 436-2. Items in dotted boxes may appear on displays 436-1, 436-2 when MSDs 434-1, 434-2 are moved throughout store 432 and/or MSDs 434-1, 434-2 scan one or more of items 344. In some examples, a user may swipe displays 436-1, 436-2 to scroll down the items 344 to reveal those items that are currently not displayed.

It is contemplated that many customer orders (e.g., dozens of orders) may be placed with a store over a relatively short period of time. Each of the customer orders placed may include many items (e.g., dozens of items). Accordingly, the display of an MSD may not be able to sufficiently display all of the items that are currently ordered. Displaying those items which are likely closest to the users of MSDs, as illustrated in FIGS. 28B-28C, may allow the users to easily determine which items to pick. For example, if more than 100 items are currently ordered by customers, each MSD in a store may display 10-20 of the closest items so that the user can focus on picking those 10-20 items. In examples where more items are ordered than may be displayed on a display, the MSDs may determine an order in which to display those ordered items which are not currently displayed. For example, MSDs may arrange the items in memory based on the distances of the items from the MSDs (e.g., using a location map).

As described above, users may scan item IDs of ordered items using MSDs. In general, a user may scan an item ID using an MSD when the user picks the item off a rack. After scanning the item ID code, the user may place the item in a cart and take the item to a collection area of the store where the items of a customer order are put together for customer pickup or delivery. An MSD may communicate to other computing devices that the MSD has scanned an item. For example, an MSD may communicate to the CCS and/or other MSDs that an item ID code has been scanned. Accordingly, the CCS and/or the MSDs may determine which items of the current customer orders have already been picked by other MSDs.

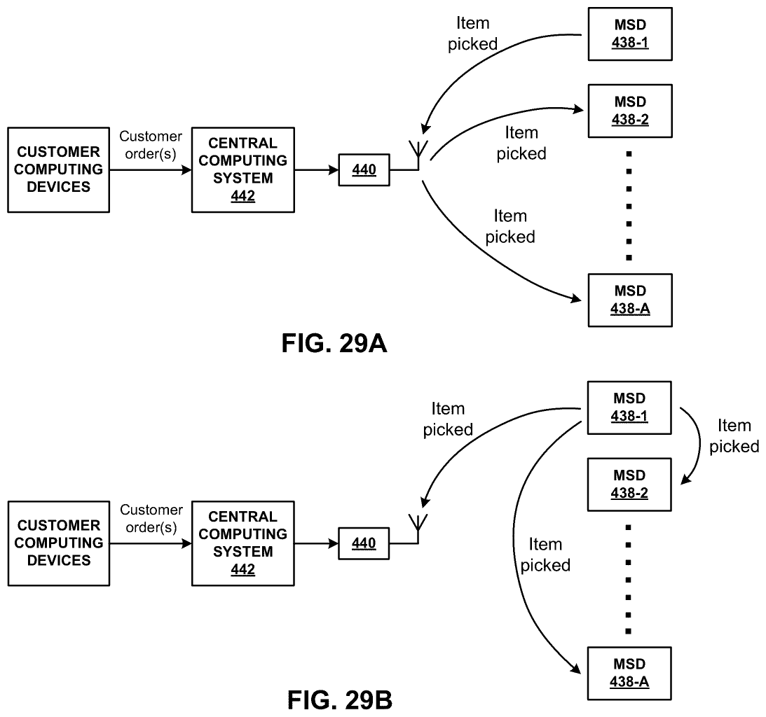

FIGS. 29A-29B show example communications between MSDs and a CCS. In FIGS. 29A-29B, it may be assumed that MSDs 438-1, 438-2, . . . , 438-A (collectively “MSDs 438”) have received customer orders for one or more items. In FIG. 29A, MSD 438-1 scans an item ID code and communicates back to communication system 440 that the item has been picked. Communication system 440 may indicate to CCS 442 that the item has been picked. Based on this information, CCS 442 may update the status of the customer orders in CCS 442 to indicate that the item has been picked. Additionally, or alternatively, CCS 442 may indicate to MSDs 438-2, . . . , 438-A that the item has been picked. MSDs 438 may update their memories to indicate that the item has been picked. For example, MSDs 438 may delete the item from memory and/or remove the items from their displays because users of MSDs 438 no longer need to pick the item.

In FIG. 29B, MSD 438 scans an item ID code and communicates back to communication system 440 and MSDs 438-2, . . . , 438-A that the item has been picked. In FIG. 29B, MSDs 438 are configured to communicate with one another, which may allow any of MSDs 438 to indicate to any other one of MSDs 438 that an item has been picked. MSD 438-1 may also indicate to CCS 442, via communication system 440, that the item has been picked so that CCS 442 may keep track of which items are currently picked. MSDs 438 may update their memories to indicate that the item has been picked. For example, MSDs 438 may delete the item from memory and/or remove the items from their displays because users of MSDs 438 no longer need to pick the item.

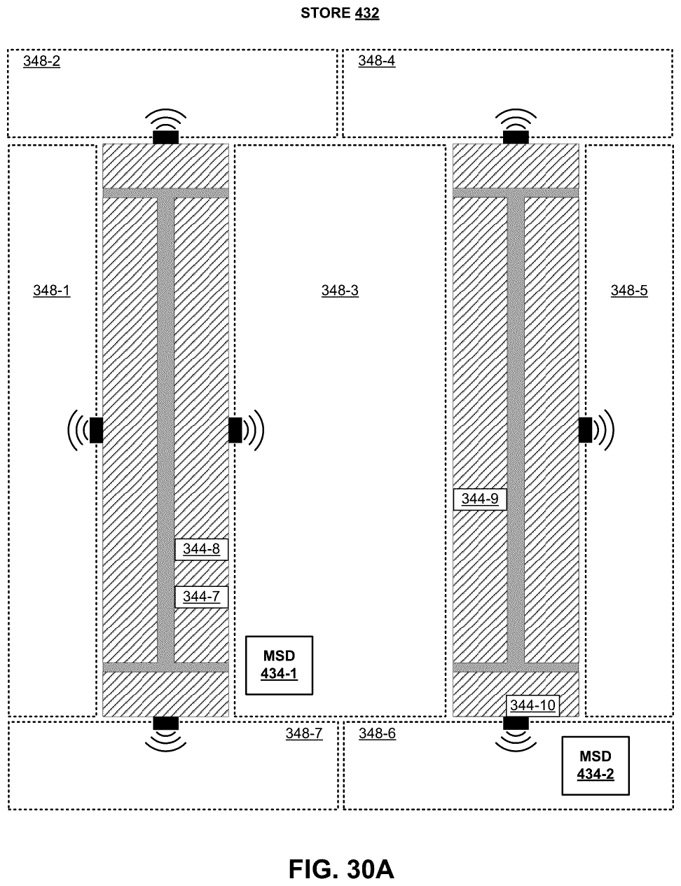

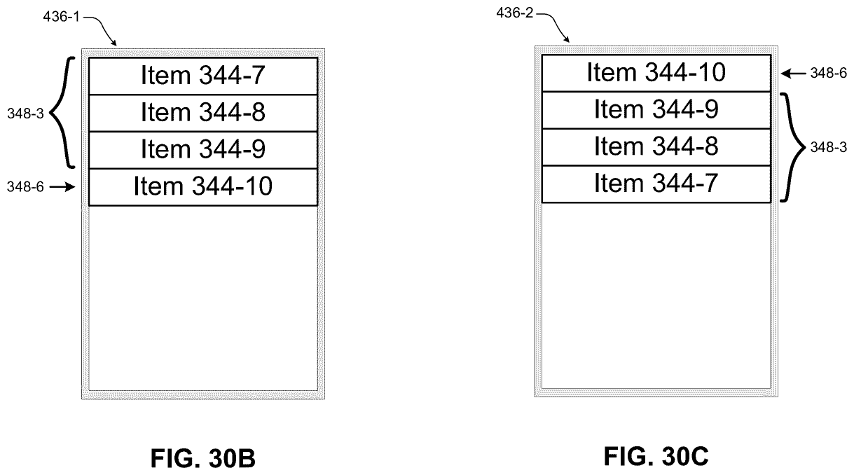

FIGS. 30A-30C show store 432 and MSDs 434-1, 434-2 of FIGS. 28A-28C after MSDs 434-1, 434-2 have moved through store 432 and picked some items. In FIG. 30A, MSD 434-1 has scanned items 344-1, . . . , 344-6 and been moved from zone 348-1 to zone 348-3. In FIG. 30A, MSD 434-2 has scanned item 344-11 and been moved from zone 348-5 to zone 348-6.

As shown in FIG. 30A, MSD 434-1 is in zone 348-3 which includes items 344-7, 344-8, 344-9. Accordingly, MSD 434-1 is likely to be nearest to items 344-7, 344-8, 344-9. According to location map 346, MSD 434-1 is near zone 348-6 including item 344-10. Based on the proximity of the zones described above with respect to location map 346, it may be most efficient for a user of MSD 434-1 to pick items from zone 348-3, then zone 348-6. In FIG. 30B, display 436-1 of MSD 434-1 has items 344-7, 344-8, 344-9, 344-10 arranged such that the items nearest to MSD 434-1 are located at the top of display 436-1, while the items farthest from MSD 434-1 (e.g., item 344-10) are located farther down display 436-1.

As shown in FIG. 30A, MSD 434-2 is in zone 348-6 which includes item 344-10. Accordingly, MSD 434-2 is likely to be near item 344-10. According to location map 346, MSD 434-2 is near zone 348-3 including items 344-7, 344-8, 344-9. Based on the proximity of the zones described above with respect to location map 346, it may be most efficient for a user of MSD 434-2 to pick items from zone 348-6 and then zone 348-3. In FIG. 30C, display 436-2 of MSD 434-2 has items 344-7, 344-8, 344-9, 344-10 arranged such that the items nearest to MSD 434-2 are located at the top of display 436-2, while the items farthest from MSD 434-2 (e.g., item 344-7, 344-8, 344-9) are located farther down the display.

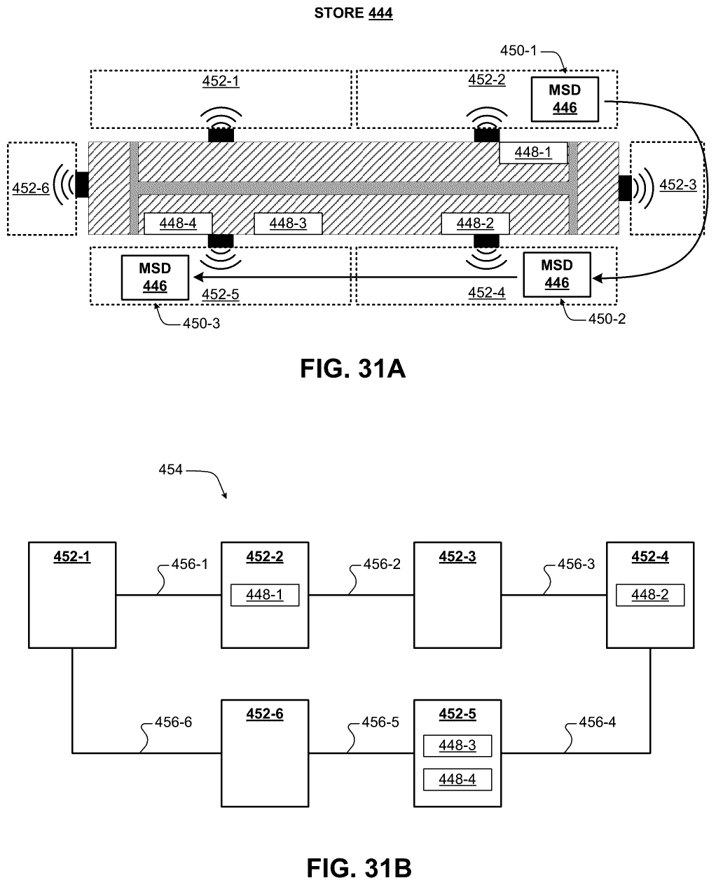

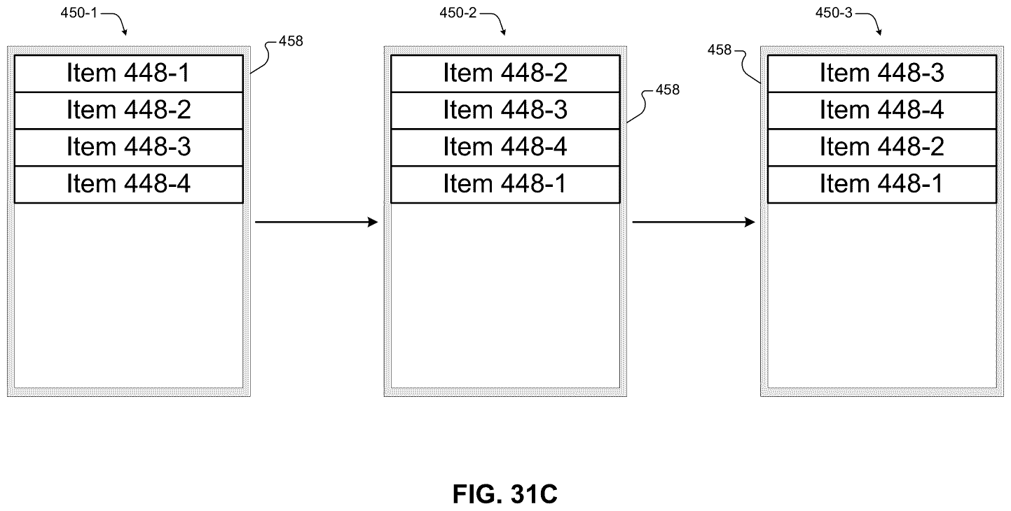

FIGS. 31A-31C show how a display of an MSD may be updated as the MSD is moved throughout a store. FIG. 31A shows a store 444 including an MSD 446. It may be assumed that MSD 446 has received a customer order including items 448-1, 448-2, 448-3, 448-4 (collectively “items 448”). In FIG. 31A, MSD 446 is moved throughout store 444 without picking items 448. Arrows show the path of MSD 446 through store 444. Initially, MSD 446 is at position 450-1 in zone 452-2. MSD 446 then moves to position 450-2 in zone 452-4. Subsequently, MSD 446 moves to position 450-3 in zone 452-5.

FIG. 31B shows a location map 454 of store 444. Location map 454 may be stored in MSD 446 in some examples. Location map 454 includes zones 452-1, 452-2, . . . , 452-6 and junctions 456-1, 456-2, . . . , 456-6. FIG. 31C shows display 458 of MSD 446 at different positions 450-1, 450-2, 450-3 in store 444. MSD 446 may arrange items 448 on display 458 based on location map 454. For example, MSD 446 may arrange items that are nearest to MSD 446 at the top of display 458. MSD 446 may arrange those items that are farther from MSD 446 toward the bottom of display 458. In some circumstances (not illustrated in FIG. 31A), more items may be ordered by customers than could be displayed on display 458. In these circumstances, MSD 446 would include some of the ordered items on display 458 and, as MSD 446 is moved throughout store 444, items that were not originally displayed on display 458 may appear on display 458 as MSD 446 is moved into a zone including those items.

Initially, MSD 446 is located at position 450-1. MSD 446 may determine location value 452-2 in zone 452-2. According to location map 454, item 448-1 is located in zone 452-2. Accordingly, as illustrated in FIG. 31C, MSD 446 may display item 448-1 at the top of display 458. MSD 446 may determine that item 448-2 is the next nearest ordered item since item 448-2 is two junctions 456-2, 456-3 from zone 452-2. Accordingly, item 448-2 may be displayed below item 448-1 on display 458 when MSD 446 is at position 450-1. Items 448-3, 448-4, which are located farthest from zone 452-2 may be displayed at the bottom of the items displayed on display 458 since those items are farthest from zone 452-2.

As illustrated in FIG. 31A, MSD 446 is moved from position 450-1 to position 450-2. MSD 446 may determine location value 452-4 at position 450-2. In zone 452-4, MSD 446 may determine that item 448-2 is nearest to MSD 446. MSD 446 may also determine that items 448-3, 448-4 are the next nearest ordered items because zone 452-5 is adjacent to zone 452-4. Additionally, MSD 446 may determine that item 448-1 is farthest from MSD 446. Accordingly, as illustrated in FIG. 31C, items 448-2, 448-3, 448-4, 448-1 are arranged from the top of display 458 to the bottom of display 458 when MSD 446 is at position 450-2.

As illustrated in FIG. 31A, MSD 446 is moved from position 450-2 to position 450-3. MSD 446 may determine location value 452-5 at position 450-3. In zone 452-5, MSD 446 may determine that items 448-3, 448-4 are nearest to MSD 446. MSD 446 may also determine that item 448-2 is the next nearest ordered item because zone 452-4 is adjacent to zone 452-5. Additionally, MSD 446 may determine that item 448-1 is farthest from MSD 446. Accordingly, as illustrated in FIG. 31C, items 448-3, 448-4, 448-2, 448-1 are arranged from the top of display 458 to the bottom of display 458 when MSD 446 is at position 450-3.

Although an MSD may arrange items nearest to the MSD near the top of the display, the items nearest to the MSD may be indicated on the display in another manner. For example, an MSD may arrange the nearest items near the bottom of the display. In other examples, the MSD may display the nearest items in bold font. In other examples, the MSD may display the nearest items in larger font. In still other examples, the MSD may display the nearest items in different colors.

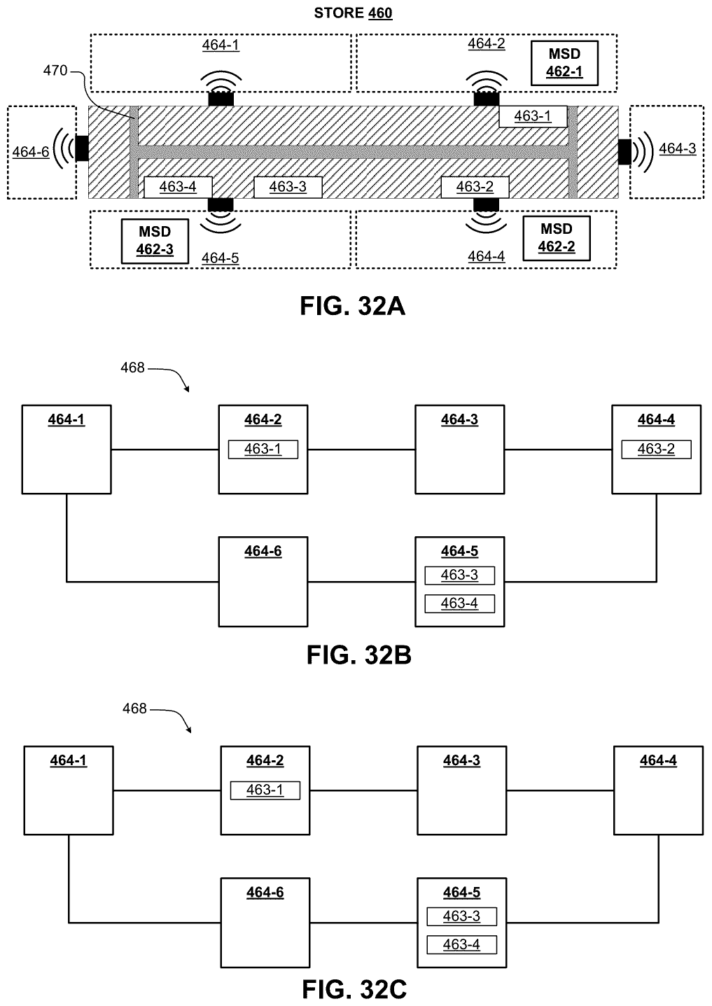

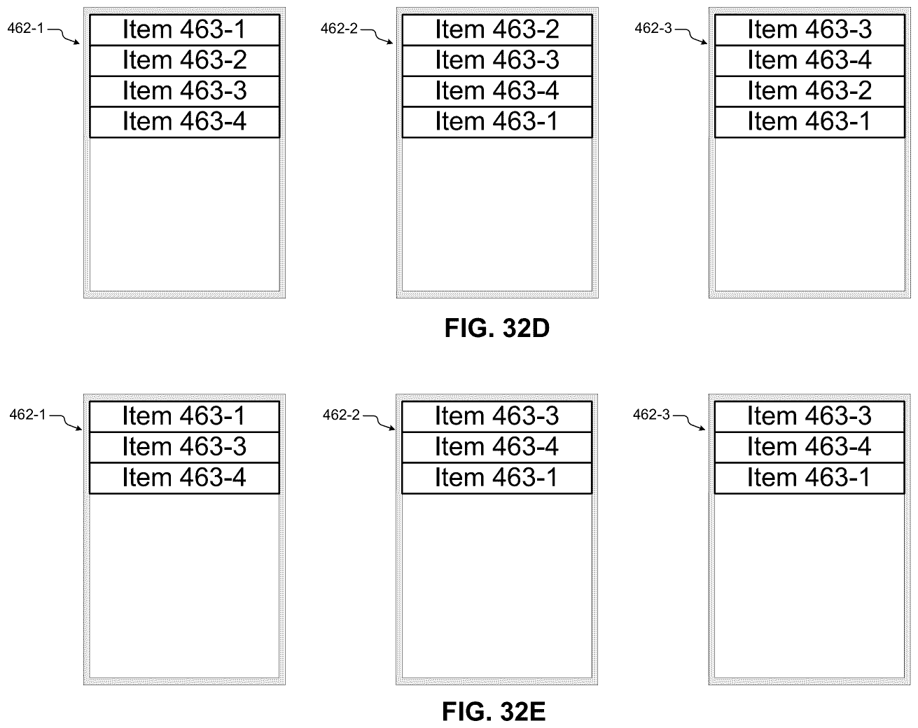

FIGS. 32A-32E show displays of multiple MSDs and how the displays are updated when items are picked. FIG. 32A shows a store 460 including MSDs 462-1, 462-2, 462-3. It may be assumed that MSDs 462-1, 462-2, 462-3 have received a customer order including items 463-1, 463-2, 463-3, 463-4 (collectively “items 463”). In FIGS. 32A-32E, it may be assumed that each of MSDs 462-1, 462-2, 462-3 is maintained in the zones illustrated in FIG. 32A. For example, MSD 462-1 is maintained in zone 464-2. MSD 462-2 is maintained in zone 464-4. MSD 462-3 is maintained in zone 464-5.

FIG. 32B shows a location map 468 before any of items 463 are scanned. FIG. 32D shows displays of each of MSDs 462-1, 462-2, 462-3 before any of items 463 are scanned. Referring back to FIG. 32A, MSD 462-2 may scan the item ID code of item 463-2. For example, a user may pick item 463-2 from rack 470, scan a barcode on item 463-2 using MSD 462-2, and place item 463-2 into a cart. MSD 462-2 may transmit data to other MSDs 462-1, 462-3 indicating that item 463-2 has been picked. For example, MSD 462-2 may transmit an indication to the communication system that item 463-2 has been picked. The communication system may then indicate to MSDs 462-1, 462-3 that item 463-2 has been picked. In response to such an indication, MSDs 462-1, 462-3 may remove item 463-2 from their displays. In examples where MSD 462-2 may directly communicate with MSDs 462-1, 462-3, MSD 462-2 may wirelessly transmit data to other MSDs 462-1, 462-3 indicating that item 463-2 has been picked. In response to such an indication from MSD 462-2, MSDs 462-1, 462-3 may remove item 463-2 from their displays.

FIG. 32C shows an updated location map 468 in which item 463-2 has been removed after item 463-2 has been picked. Location map 468 of FIG. 32C including items 463-1, 463-3, 463-4 may be representative of a location map included in MSDs 462-1, 462-2, 462-3 after MSDs 462-1, 462-3 are notified that item 463-2 has been picked. For example, location map 468 of FIG. 32C may represent the location map of MSD 462-2 after MSD 462-2 scans item 463-2. Similarly, location map 468 of FIG. 32C may represent the location maps of MSDs 462-1, 462-3 after MSDs 462-1, 462-3 have received indications that item 463-2 has been picked. FIG. 32E shows updated displays of MSDs 462-1, 462-2, 462-3 in which MSDs 462-1, 462-2, 462-3 have removed item 463-2 from their displays.

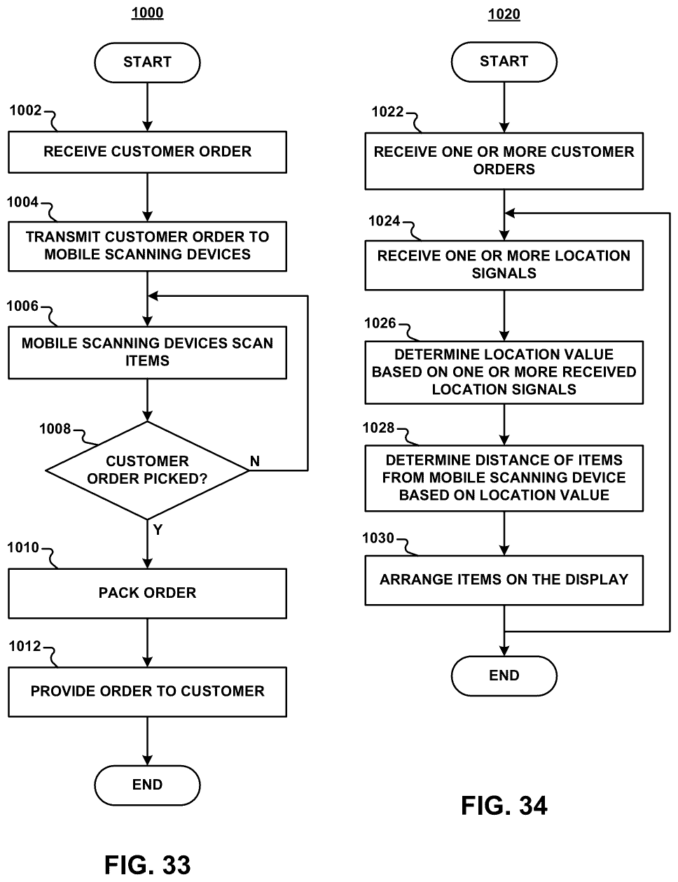

FIGS. 33-36 illustrate methods that describe operations of the OFS. FIG. 33 is a method 1000 that describes operation of an OFS from receipt of a customer order until the order is provided to the customer. The method 1000 of FIG. 33 is now described with reference to FIG. 1. At 1002, the CCS receives a customer order from CCDs. At 1004, the CCS wirelessly transmits the customer order to one or more MSDs via the communication system. At 1006, the MSDs are transported throughout the store 100 by users that scan items of the customer order. The users may pick the items from the racks before scanning the items. The users may place the items in a cart after scanning the items.

If the customer order has not been picked at 1008, the users may continue picking the customer order until the entire customer order is picked. At 1010, the users may assemble the items from the customer order (e.g., in a collection/packing area of the store 100) and pack the items of the customer order (e.g., in grocery bags and/or boxes). In some cases, the users may pack the items for orders as the items are being picked. At 1012, the filled customer order is provided to the customer. For example, the filled customer order may be picked up by the customer at the store 100. In other examples, the filled customer order may be delivered to the customer's home.

FIG. 34 is a method 1020 that describes operation of an MSD configured to receive location signals. At 1022, the MSD receives one or more customer orders via a communication module. At 1024, the MSD receives one or more location signals. For example, the location detection module detects one or more location signals. At 1026, the MSD determines a location value based on the one or more received location signals. For example, the location detection module determines a location value based on the one or more received location signals.

At 1028, the MSD may determine the distance of each of the items from the MSD (i.e., the user). For example, the MSD may determine which items are nearest to the MSD and which items are farthest from the MSD. The MSD may determine the location of items relative to the MSD using a location map of the store and the associations between the items and location values.

At 1030, the MSD arranges the items on the display. In general, the MSD may arrange the displayed items such that the items in proximity to the MSD (i.e., in proximity to the user) are viewable by the user on the display. In one example, the MSD may arrange items on the display such that those items in proximity to the user are more prominently displayed than those items that are farther away from the MSD. For example, the MSD may display items in the current area at the top of the display. Additionally, or alternatively, the MSD may display the items in bold and/or colored text to indicate those items that are in proximity to the user. In some implementations, the MSD may arrange items on the display based on the number of junctions between the user and the items. For example, the MSD may display items more prominently that are separated from the user by a smaller number of junctions. In some implementations, the MSD may arrange items on the display based on the number of junctions between the user and the items along with the number of items in a particular area. For example, the MSD may tend to display items that are closer to the user more prominently, unless many items are located in another direction at a slightly longer distance. In this manner, the MSD may persuade the user to pick the largest number of items in the shortest amount of time. In some implementations, the MSD may generate routes based on the number of items in zones and the distance of the zones from the MSD. For example, an MSD can prefer showing items in zones that are closer and/or associated with more items.

Method 1020 may continue at 1024 as the MSD is moved throughout the store. For example, while picking the one or more received customer orders, the MSD may be moved into areas of the store that receive different location signals. The MSD may determine a new location value based on the different location signals and update the display (e.g., in real-time) to reflect the distance of items from the MSD at the new location.

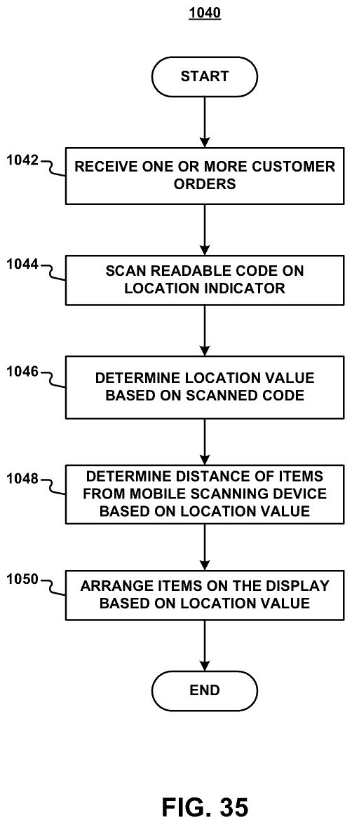

FIG. 35 is a method 1040 that describes operation of an MSD that is configured to determine location values by scanning location indicators that include readable codes. At 1042, the MSD receives one or more customer orders via a communication module. At 1044, the MSD scans a readable code of a location indicator. For example, the location detection module may scan a readable code. At 1046, the MSD determines a location value based on the scanned readable code. For example, the location detection module determines a location value based on the scanned readable code.

At 1048, the MSD may determine the distance of each of the items from the MSD (i.e., the user). For example, the MSD may determine which items are nearest to the MSD and which items are farthest from the MSD. The MSD may determine the location of items relative to the MSD using a location map of the store and the associations between the items and location values.

At 1050, the MSD arranges the items on the display. In general, the MSD may arrange the displayed items such that the items in proximity to the MSD (i.e., in proximity to the user) are viewable by the user on the display. In one example, the MSD may arrange items on the display such that those items in proximity to the user are more prominently displayed than those items that are farther away from the MSD. Method 1040 may continue at 1044 as the MSD is moved throughout the store and new location indicators are scanned. For example, while picking the one or more received customer orders, the MSD may be moved into areas of the store in which the MSD scans different readable codes. The MSD may determine a new location value based on the different readable codes and update the display (e.g., in real-time) to reflect the distance of items from the MSD at the new location.

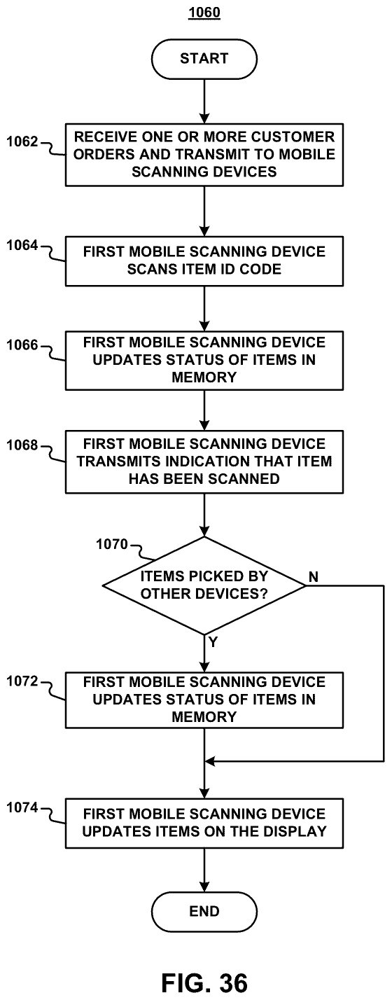

FIG. 36 is a method 1060 that describes operation of an MSD when items are picked by the MSD and other MSDs. The method 1060 of FIG. 36 is now described with reference to FIG. 1. At 1062, the CCS receives one or more customer orders from CCDs and transmits the one or more customer orders to the MSDs via the communication system. At 1064, the first MSD scans an item ID code of one of the items included in the customer orders. At 1066, the first MSD updates the status of the items in memory to indicate that the item has been scanned.

At 1068, the first MSD transmits an indication that the item has been scanned. For example, the first MSD may indicate to the CCS that the item has been scanned. In turn, the CCS may indicate to the second MSD that the item has been scanned so that the second MSD may update the status of items in memory of the second MSD. In other examples, the first MSD may transmit the indication directly to the second MSD.

At 1070, the first MSD determines whether other items have been scanned by the second MSD. The first MSD may determine that other items have been scanned by the second MSD when the first MSD receives an indication (e.g., from the CCS) that the second MSD has scanned other items. If the second MSD has not scanned any other items, method 1060 may continue in block 1074. If the second MSD has scanned other items, the first MSD may update the status of items in memory in block 1072 to indicate that the other items have been picked (e.g., based on indications received from the CCS). At 1074, the first MSD may update the display to indicate which items have been scanned. For example, the first MSD may remove the scanned item(s) from the display.

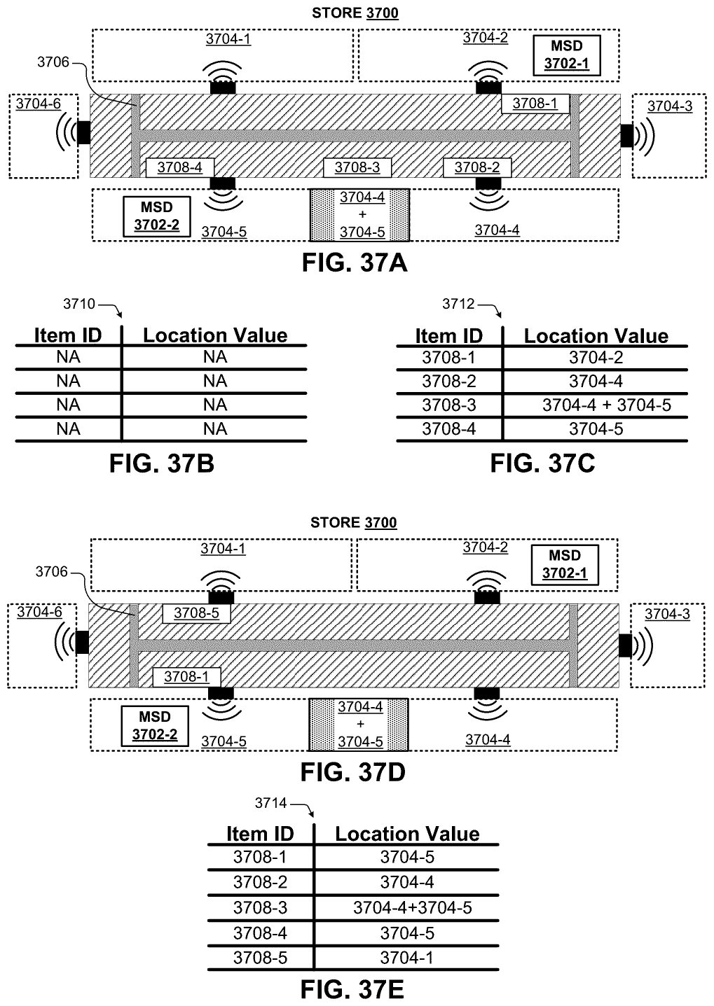

As described above, each of the items in the store may be associated with a location value. The associations between items and location values may be represented herein as an item association table (e.g., item association tables 3710, 3712, 3714 of FIGS. 37B, 37C, 37E). Item association tables (e.g., one or more of the same/similar versions of item association tables) may be stored in memory of the CCS and/or one or more MSDs. In implementations where the CCS stores an item association table, the CCS can transmit the item association table to the one or more MSDs in order to update the item association tables used by the MSDs. In some implementations, the CCS may transmit the item association tables to the MSDs at preselected time intervals (e.g., at periodic intervals). Additionally, or alternatively, the CCS may transmit the item association tables to the MSDs in response to updates to the item association table stored at the CCS. For example, if the CCS updates an item association table (e.g., in response to updates from one or more MSDs), the CCS may transmit the updated item association table to the MSDs in response to the recent update. In some implementations, the MSDs can request the updated item association table from the CCS. For example, the MSDs may be configured to request an up-to-date item association table upon powering up (e.g., from a standby or off state).

In some implementations, an MSD can request the updated item association table from the CCS. The MSD may be configured to receive manual input from the user that causes the MSD to request the item association table. For example, an MSD may receive a user input (e.g., on a touchscreen of the MSD) that instructs the MSD to request the updated item association table. In some examples, the MSD may present the user with an interactive GUI button or other user input (e.g., via a mechanical button) that causes the MSD to request an update of the item association table from the CCS.

In some implementations, the MSD may be configured to automatically request the item association table from the CCS. For example, the MSD may be configured to request the item association table from the CCS at preset times (e.g., periodically or after a threshold amount of time has passed since a most recent update of the item association table stored on the MSD). An MSD may automatically request the item association table in response to other events. For example, an MSD may automatically request an item association table in response to powering on after the MSD has been in an off state or a standby state.

In some cases, the MSDs may not be devices that are owned by the store operator and/or stored at the store. For example, the MSDs used in the store may be brought into the store by third parties and used to pick items for customer orders with the third parties. The third parties may include businesses that provide item delivery services (e.g., grocery delivery services) to customers. These third parties may receive customer orders via the internet, store the customer orders on a TPCS, and transfer the customer orders to the third-party MSDs. Upon entering a store with a third-party MSD, the MSD may be configured to request the item association table from the CCS (e.g., via an internet/cellular connection with the CCS and/or via a local wireless connection). In some cases, the CCS is configured to communicate with a TPCS and may transmit updated item association tables to the TPCS (e.g., in response to requests from the TPCS) so that the TPCS may store an updated version of the store's item association table.

A third-party MSD may request an item association table from the TPCS (e.g., via the internet). Additionally, or alternatively, the third-party MSD may request an item association table from the CCS. The CCS may respond to the request from the third-party MSD (e.g., via the internet or wirelessly in the store) by transmitting an item association table to the third-party MSD. A third-party MSD can make a request for an updated item association table (e.g., from the CCS and/or the third-party computing system) in response to a variety of events. In some implementations, a third-party MSD may make a request automatically in response to the current location of the third-party MSD. For example, a third-party MSD can be configured to request an item association table based on the proximity of the third-party MSD relative to the store. In one example, a third-party MSD may be configured to request an item association table in response to being located within a predetermined distance of the store, such as upon coming within a predetermined distance from the store or entering the store. The third-party MSD may determine location and/or proximity to the store based on a GPS determined location (e.g., from a GPS receiver of the device), based on a wireless connection established in the store (e.g., a Wi-Fi connection between the third-party MSD and the CCS), and/or based on some other form of location determination. In some implementations, the store may include store indicators (e.g., barcodes, QR codes, RFID tags, or other indicators) that may uniquely identify the store to a third-party MSD. Such store indicators may be placed at one or more entry points of the store for example. In these implementations, the third-party MSD can scan the store indicator and then request the item association table for the store corresponding to the store indicator.

In some implementations, the third-party users may manually request the item association table for the store (e.g., using a GUI of the third-party MSD). As another example, a third-party MSD may automatically request an item association table for a store in response to the third-party user selecting the store as the next store from which to pick (e.g., from a group of stores).

In some cases, shoppers at a store (e.g., a grocery store) may use their own devices (referred to herein as “personal scanning devices” or “customer computing devices”) to assist in routing them throughout the store. As described herein, the CCDs can include similar functionality to the MSDs that allows the CCDs to interact with the OFS (e.g., the CCS and the location indicators). For example, the CCDs may include wireless communication functionality (e.g., Wi-Fi or BLUETOOTH) for communicating with the CCS, location signal detection functionality (e.g., BLUETOOTH receivers for detecting BLUETOOTH based location signals and/or light detection functionality such as a camera), and item ID scanning functionality (e.g., a camera). Example CCDs may include computing devices having a variety of different form factors including, but not limited to, smartphones, tablets, and any other handheld or wearable device. A CCD may execute an application (e.g., a native application installed on the CCD) or access a web application that performs similar functionality attributed to the MSDs herein (e.g., the CCD may receive location signals, scan barcodes, determine location values, store a location map, and organize items on the display based on the location of the items relative to the user). The application executing on the CCDs may be provided to the personal scanning devices by the operator of the store (e.g., via a download from an application distribution platform, such as GOOGLE PLAY or APPLE ITUNES).

As described herein, different parties may use MSDs to pick customer orders. For example, employees of the store may use MSDs to pick customer orders. Additionally, or alternatively, third-party users (e.g., employees of a third party) may usc MSDs (e.g., owned by the third parties or the store owners) to pick customer orders. Customers may also use their own devices to pick their own orders. In some implementations of the OFS, any of these parties may pick orders within the same store at the same time, or at different times. In other cases, the OFS may be configured to only allow certain parties to pick items. The MSDs may be described herein as being used by “users”, “pickers”, “customers”, “packers”, or other parties. In general, the functionality provided by the CCS/MSDs and other systems/devices described herein may be used by any party, depending on the scenario. For example, a store employee picker may pick items for customers using an MSD. In this example, a customer may use an MSD (e.g., customer device or store-provided device) providing similar functionality to pick their own items. As such, the party names may be used interchangeably herein.

MSDs used by pickers may be referred to herein as picker/picking MSDs. MSDS used by packers may be referred to herein as packer/packing MSDs. In some cases, the GUIs associated with the pickers that may be rendered on a picker/picking MSD may be referred to as a picker GUI or a picking GUI. Similarly, the GUIs associated with the packers that may be rendered on a packer/packing MSD may be referred to as packer/packing GUIs. As described herein, MSDs used by pickers and packers may be the same or different. As also described herein, in some cases, a picker may pack orders for pickup. In these cases, the picking MSD rendering a picking GUI may transition to a packing MSD that renders a packing GUI.

As described above, MSDs can request updated item association tables from the CCS or TPCS. As described herein, the MSDs may also request other data from the CCS or TPCS, such as updated location maps and/or item adjacency maps (e.g., at preset times and/or in response to a user command). In some implementations, the CCS may request location maps and/or item adjacency maps from the MSDs (e.g., at preset times). In general, the CCS, TPCS, MSDs, and/or CCDs may transfer data between one another based on any factors described herein, such as the factors described for requesting an item association table above.

In some circumstances, items may not be associated with location values. In one example, items may not yet be associated with location values when the location indicators are initially placed in the store. This example may occur when a store is initially equipped with the OFS (e.g., location indicators, MSDs, and the CCS). In another example, items that have been newly added to the racks of the store may not yet be associated with location values. Similarly, when the OFS is initially set up, item adjacency maps may not be initially completed. Over time, the item adjacency maps may be completed as described herein. A TPCS and/or third-party MSDs may also initially include incomplete item association tables, location maps, and item adjacency maps. A TPCS and/or third-party MSDs may acquire (e.g., download) the tables and maps from the CCS. In some implementations, a TPCS and/or third-party MSDs may download different tables and maps for different stores. In some implementations, a TPCS and/or third-party MSDs may generate their own tables and maps independently from the tables and maps included in the CCS. In some cases, a TPCS and/or third-party MSDs may initially acquire tables and maps for a store from the store CCS, and then update the tables and maps over time in a manner that differs from the initial store tables and maps.

In other circumstances described herein, items may be associated with an incorrect association value. For example, an item may initially be associated with a first location value when the item is placed in a first location in the store. Later, the item may be moved to a different place in the store that is associated with a different location. In these circumstances, the location value associated with an item may be updated. Different ways to associate items with a location value and update the associations are described herein.

Items may be associated with location values using a variety of different techniques. In some examples, associations between items and location values may be entered manually by a user. For example, a user may manually populate an item association table using a computing device, such as a desktop computer, laptop computer, an MSD, etc. Put another way, a computing device (e.g., an MSD or other computing device) may be configured to receive manual input from a user, generate associations between items and location values based on the manual input, and store the associations at the CCS. In some implementations, a user may use a keyboard (e.g., on an MSD or other computing device), a touchscreen computing device, or similar device, to populate the item association table. For example, a user may place location indicators in a store and manually associate items with location values that will be determined in proximity to the items. In a more specific example, when a location indicator includes a readable code, a user may place the location indicator on a rack, and then manually associate each of the items on the rack with the location value that is determined based on the readable code of the location indicator. In another specific example, when a location indicator transmits a location signal, a user may place the location indicator on a rack, and then manually associate each of the items near the area where the location signal will be transmitted to the location value that will be determined based on detection of the location signal.

Generating an item association table manually (e.g., manually entered into a user interface on a computing device) may be a somewhat cumbersome process because a store may include thousands of items. Additionally, a user may be prone to errors when manually generating an item association table. Manual generation of an item association table may also be somewhat inaccurate in examples where location indicators transmit signals because a user may not accurately predict exactly where location signals will be transmitted. Although it is contemplated that item association tables including a large number of items could be manually generated, other techniques for generating item association tables described herein may prove more effective. Although other techniques may prove more effective than manually entering item associations, manually entering some item associations may be effective in cases where a few item associations are to be made.

An item association table may be generated automatically (e.g., using an item association mode and/or during normal picking). In some examples, a user may set the MSD into an “item association mode” causing the MSD to generate the item association table by determining location values and scanning items. In general, an “item association mode” may refer to a state (e.g., a mode of operation) of an MSD which may be selected by a user to generate one or more associations between items and location values. A user may set an MSD into the item association mode using the touchscreen display of the MSD and/or the user interface, for example.

When operating in an item association mode, the MSD may determine a location value and associate that location value with a scanned item. In examples where a store includes location indicators having readable codes, the user may first use the MSD to scan the location indicator to determine a location value. Next, the user may begin using the MSD to scan item ID codes. For example, the user may scan a plurality of item ID codes after scanning the location indicator. The MSD may then associate each of the scanned item ID codes with the location value determined from the location indicator. Generating an item association table in this manner may be faster than manually generating an item association table because a user may quickly scan item ID codes after scanning a single location indicator. Instead of first scanning a location indicator and then scanning item ID codes, in other examples, a user may use the MSD to scan a plurality of item ID codes and then scan an associated location indicator in order to associate the scanned item ID codes with the later scanned location indicator.

When operating in an item association mode in a store that includes location indicators that transmit location signals, the MSD may determine a location value based on one or more received location signals and associate scanned item ID codes with the currently determined location value. Since the MSD may acquire location signals without additional user action, the user may freely walk through the store and scan a plurality of item ID codes to generate an item association table. For example, the MSD may associate scanned item ID codes with a first location value determined in a first location. When the MSD is moved to a second location where the MSD determines a second location value, the MSD may associate scanned item ID codes with the second location value. Generating an item association table in this manner may be faster than manually generating an item association table because a user may quickly scan item ID codes without scanning a location indicator.

In some examples, an MSD may generate and/or update an item association table without the user selecting a specific “item association mode.” Instead, the MSD may generate an item association table while the MSD is being used to pick items of customer orders. For example, if an MSD receives a customer order including a first item that is not associated with a location value, the MSD may generate an entry in an item association table for the first item when the MSD scans the item ID code of the first item. The generated entry in the item association table may include the scanned item ID code and the currently determined location value.

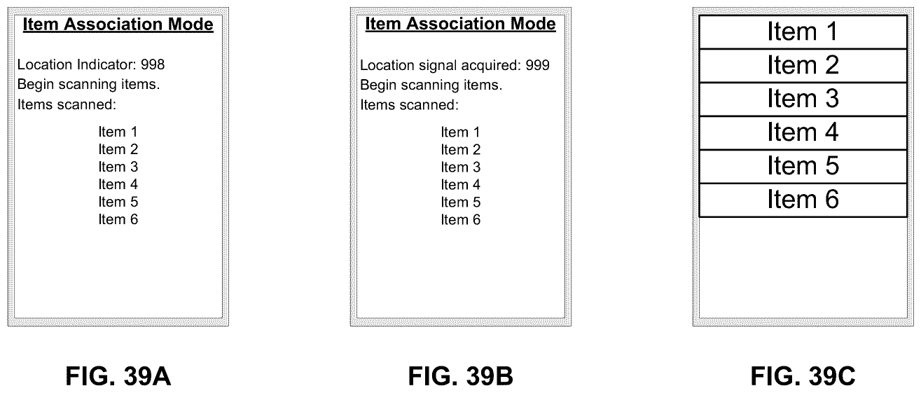

FIGS. 39A-39C illustrate displays of MSDs which may be viewed by a user while generating an item association table. FIGS. 39A-39B illustrate displays of MSDs that are set in an item association mode. The item association modes of the mobile devices of FIGS. 39A-39B may be initiated using the touchscreens and/or user interfaces of the MSDs. In one example, a user may select the “item association mode” from a menu displayed to the user using a touchscreen. In another example, a user may press a dedicated button of the MSD to enter the item association mode. The images on the displays of FIGS. 39A-39B may be displayed to users of MSDs having dedicated item association modes. The image on the display of FIG. 39C may represent an image displayed to a user that is picking items from a store. In FIG. 39C, the MSD may be configured to generate an item association table when the user is picking items. Example operation of MSDs shown in FIGS. 39A-39C are now described. FIGS. 39A-39C are only example images that may be displayed on a display of an MSD. Accordingly, it is contemplated that additional or alternative information may be displayed to a user when generating an item association table.

The image on the display of FIG. 39A may be generated by an MSD used in a store that includes location indicators having readable codes. As indicated on the display, the MSD is operating in an “Item Association Mode.” The user of the MSD may have set the MSD in the item association mode using the touchscreen and/or user interface of the MSD. The display indicates that location indicator 998 has been scanned. After scanning location indicator 998, the display instructs the user to “Begin scanning items.” The display lists the items that have been scanned by the user using the MSD. For example, the display indicates that the user has scanned items 1-6 using the MSD. The MSD may update the display each time a new item is scanned. For example, if an “item 7” was scanned, the display would add “Item 7” under “Item 6” on the display. In FIG. 39A, an item association table would be populated with items 1-6, each of which is associated with the location value 998.

The image on the display of FIG. 39B may be generated by an MSD used in a store that includes location indicators that transmit location signals. As indicated on the display, the MSD is operating in an “Item Association Mode.” The user of the MSD may have set the MSD in the item association mode using the touchscreen and/or user interface of the MSD. The display indicates that the MSD has received a location signal and determined a location value of 999 based on the received location signal. The display instructs the user to “Begin scanning items.” The display lists the items that have been scanned by the user using the MSD. For example, the display indicates that the user has scanned items 1-6 using the MSD. The MSD may update the display each time a new item is scanned. For example, if an “item 7” was scanned, the display would add “Item 7” under “Item 6” on the display. In FIG. 39B, an item association table would be populated with items 1-6, each of which is associated with location value 999.

In some examples, an MSD may generate an item association table without entering a dedicated item association mode. Instead, the MSD may generate an item association table during normal item picking described herein. For example, an MSD may receive a customer order, display the customer order to the user, and generate the item association table as the user picks and scans items of a customer order. The image on the display of FIG. 39C may be an image displayed by an MSD during normal picking of a customer order, as described above.

In FIG. 39C, it may be assumed that a customer order including items 1-6 has been placed with a CCS and that the customer order has been received by the MSD of FIG. 39C. The display displays items 1-6 of the customer order to indicate to the user that items 1-6 should be picked. The MSD may be configured to generate associations in an item association table when the user scans the item ID codes of items 1-6 of the customer order. For example, the MSD may generate an association between item 1 and the currently determined location value (e.g., based on a last scanned readable code or most recently received location signal) when the MSD scans the item ID code of item 1. Similarly, the MSD may generate an association between item 2 and the currently determined location value when the MSD scans the item ID code of item 2. Accordingly, the MSD may have generated associations between items 1-6 and their respective location values after the user has scanned all of items 1-6.

Generating associations in an association table while picking items, as described with reference to FIG. 39C, may provide a positive user experience because the item association table may be generated without the user initiating any additional modes (e.g., an item association mode). Instead, generation of the item association table may happen “in the background,” without burdening the user with the task of actively generating an item association table. In scenarios where most of the items in the store are associated with location values in an item association table, generating updates to the item association table in the manner described with reference to FIG. 39C may also be efficient. For example, items that are moved (e.g., to a different rack) within the store or added to the store may be associated with location values without burdening a user to explicitly update the item association table (e.g., by entering an item association mode).

FIGS. 37A-37E illustrate generation of an item association table and updating of the item association table. Referring now to FIG. 37A, a store 3700 includes location indicators that transmit location signals. MSDs 3702-1, 3702-2 may determine location values 3704-1, 3704-2, . . . , 3704-6, “3704-4+3704-5” in store 3700. Store 3700 includes a rack 3706 that includes items 3708-1, 3708-2, 3708-3, 3708-4. MSDs 3702-1, 3702-2 may be used to generate an item association table including items 3708-1, 3708-2, 3708-3, 3708-4.

FIG. 37B shows an item association table 3710 before any associations are made between items and location values. Item association table 3710 includes an item ID code column and a location value column. Each row of item association table 3710 may be populated to include an association between an item and a location value. Accordingly, the four rows of item association table 3710 may be populated to include four associations. Item association table 3710 of FIG. 37B is filled with “NA” entries indicating that items and location values are in a “non-associated” state. Although item association table 3710 is completely filled with NA entries, in some examples, the table may include item ID codes for items available in the store, with corresponding location values being entered as NA. This may be the case in scenarios where the item association tables are updated to include items in the store, but the items have not yet been associated with location values. Although item association tables 3710, 3712, 3714 illustrated in FIGS. 37B, 37C, and 37E include 4 associations, it is contemplated that an item association table may include thousands of associations or more. In some cases, item association tables may be prefilled with location values, such as a location value in the center of the store, or a location value associated with certain types/categories of products (e.g., frozen food, dry food, etc.).

One or both of MSDs 3702-1, 3702-2 may be used to populate the item association table (e.g., 3710, 3712, 3714). As described above, MSDs 3702-1, 3702-2 may be used to manually enter item associations in some examples. In other examples, the MSDs 3702-1, 3702-2 may automatically generate an item association table for store 3700. In some examples, users may set MSDs 3702-1, 3702-2 into an “item association mode” and generate the item association table, as described above. In other examples described above, MSDs 3702-1, 3702-2 may generate an item association table while MSDs 3702-1, 3702-2 are being used to pick items 3708-1, 3708-2, 3708-3, 3708-4.

FIG. 37C illustrates an item association table 3712 that has been populated to include associations between items 3708 and location values 3704. The associations in item association table 3712 may have been generated by MSD 3702-1 and/or MSD 3702-2. Item association tables may be stored in MSDs 3702 and/or a CCS of store 3700. In one example, MSDs 3702 may be configured to upload associations to the CCS. For example, MSD 3702-1 may generate an association between item ID code 3708-1 and location value 3704-2, and then transmit the association to the CCS. Similarly, MSD 3702-2 may generate an association between item ID code 3708-4 and location value 3704-5, and then transmit the association to the CCS. In this manner, the CCS may receive associations from MSDs 3702 and maintain an item association table that includes item associations generated by each of MSDs 3702. The CCS may transmit the complete item association table to MSDs 3702 so that MSDs 3702 may include a complete updated item association table.

As described above, an item association table may be generated by a plurality of different MSDs. For example, each of the MSDs may generate associations and upload the associations to a CCS that generates a complete item association table based on the associations generated by the plurality of MSDs. The CCS may then transmit the completed item association table to each of the plurality of MSDs so that the MSDs include a complete item association table for operation (e.g., to arrange items on displays to users). Although an item association table may be generated by a plurality of different MSDs, in some examples, a single MSD may be used to generate an item association table.

FIG. 37D shows store 3700 after a new item 3708-5 has been added and after item 3708-1 has been moved. FIG. 37E shows an updated item association table 3714 that includes a new association for item 3708-5 and a different location value associated with item 3708-1. In one scenario, item 3708-5 may not have been included in store 3700 during generation of item association table 3712 of FIG. 37C. Accordingly, item 3708-5 is not present in item association table 3712. In another scenario, item 3708-5 may not have been included in item association table 3712 of FIG. 37C because neither of MSDs 3702 had generated an association between item 3708-5 and a location signal. In either scenario, it may be assumed that one of MSDs 3702 has generated an association including item 3708-5 in FIG. 37D. Accordingly, item association table 3714 of FIG. 37E includes an association between item 3708-5 and location value 3704-1.

Item 3708-1 may have been moved after generating item association table 3712 of FIG. 37C. After initially moving item 3708-1, the association including item 3708-1 may have been incorrect. For example, item 3708-1 may have been associated with location value 3704-2 when item 3708-1 should have been associated with location value 3704-5. After moving item 3708-1, one of MSDs 3702 may generate a new association including item 3708-1. For example, one of MSDs 3702 generated an association between item 3708-1 and location value 3704-5, as shown in association table 3714 of FIG. 37E. Note that a new association including item 3708-1 may replace the old association between item 3708-1 and location value 3704-2. Accordingly, item association table 3714 may be an updated item association table that accurately reflects the movement of item 3708-1 and the addition of a new item 3708-5.

The OFS (e.g., the MSDs and/or CCS) may update the item association table in response to a variety of different factors. In some implementations, the OFS may update the item association table for each scan of an item that indicates the item has been moved to a new location. For example, if an item ID code is initially associated with a first location value, then the OFS determines that the item has been scanned in a new location, the system may update the item association table to reflect that the item is located at the new location. Similarly, if a new item is scanned that has not been previously included in the most recent item association table, the system may update the item association table to include the new item the first time the new item ID is scanned.

In some implementations, instead of updating the item association table after a single item scan (e.g., a new item and/or a moved item), the OFS may require that the items be scanned a number of times (e.g., a threshold number) before updating the item association table. For example, the system (e.g., MSD and/or CCS) may be configured to update the location of an item in the item association table in response to determining that the item has been scanned at a location greater than a threshold number of times (e.g., greater than 3 times). In some implementations, the OFS may require that the item be scanned a threshold number of times consecutively. In other implementations, the OFS may update the item association table to include the most detected location value for the item (e.g., the location value in which the item ID code was most scanned). In a similar manner, the OFS may require that a new item be scanned a threshold number of times before being entered into the system. Putting restrictions on updating the item association table (e.g., requiring a number of scans) may help maintain a stable and accurate OFS that rejects outlying item scans (e.g., in scenarios where a user picks up an item and does not scan the item until the item has been moved a great distance throughout the store).

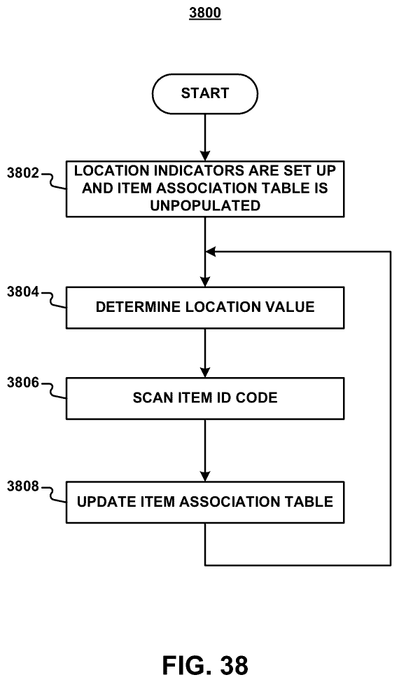

FIG. 38 shows an example method 3800 for generating and updating an item association table. At 3802, location indicators are set up in a store and an item association table for the store is initially unpopulated. For example, the item association table may include NA entries. At 3804, an MSD may determine a location value. For example, the MSD may receive a location signal and determine a location value based on the received location signal.

At 3806, the MSD may scan an item ID code. At 3808, the MSD may generate an association between the currently determined location value and the scanned item ID code. The MSD may then transmit the association to the CCS so that the CCS may maintain an up-to-date item association table, which may be modified by updates from any of a plurality of MSDs in the store. The method 3800 may then return to block 3804. Subsequently, the CCS may again update the item association table based on associations received from one or more MSDs according to method 3800. The method 3800 may be modified according to the disclosure included herein.

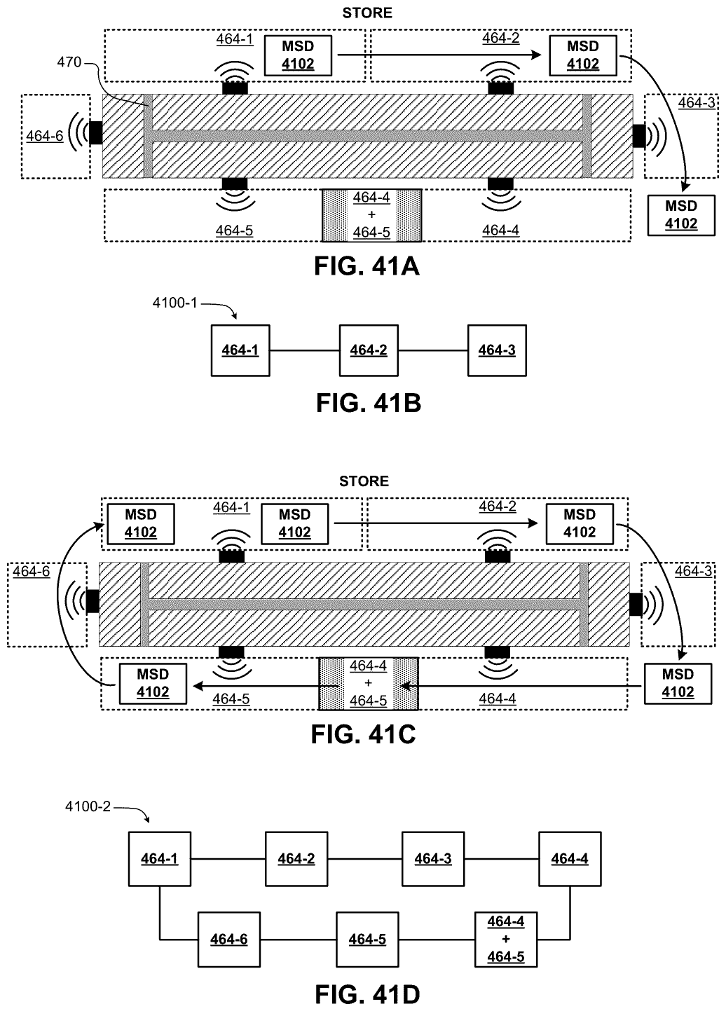

FIGS. 41A-41D illustrate generation of a location map using a single MSD 4102. As described above, one or more computing devices may store a location map that defines the spatial relationships between different areas of a store. For example, a location map may define the relative distances between different areas of the store. In some examples, two areas of the store may be adjacent to one another. In some examples, two adjacent areas may be touching one another. In other examples, two areas may be adjacent to one another when they are separated by a “dead zone.” Two areas may not be adjacent to one another when the shortest path between the two areas includes one or more additional areas. In stores including location indicators that transmit location signals, the location map may define how the areas of the store covered by the location signals are arranged relative to one another. In stores that include location indicators having readable codes, the location map may define how the location indicators (i.e., readable codes) are arranged relative to one another.

A location map may not yet be generated for a store when location indicators are initially placed in the store. This may occur when a store is initially equipped with the OFS (e.g., location indicators, MSDs, and the CCS). The OFS may generate a location map for a store after the location indicators are placed in the store. Location maps may be generated manually by a user in some examples (e.g., using a computing device and uploading the location map to the CCS). In other examples, a location map may be generated automatically (e.g., by one or more MSDs and/or the CCS). The location maps may be stored in one or more MSDs and/or the CCS.

Location maps may be generated using a variety of different techniques. In some examples, location maps may be entered manually by a user. For example, a user may manually generate a location map using a computing device, such as a desktop computer, laptop computer, an MSD, etc. In this example, a user may use a keyboard, or similar device, to generate the location map. For example, a user may place location indicators in a store and manually generate the location map based on where the location indicators are placed. In some examples, the user may generate the location map first, and then place the location indicators according to the generated location map.

Instead of manually generating a location map, a location map may be generated automatically. In stores including location indicators that transmit location signals, a user may transport an MSD throughout the store to generate a location map automatically. In one example, a user may set an MSD into a “location map generation mode” and transport the MSD throughout the store to generate a location map for the store. In other examples, the OFS may be configured to generate a location map while the user moves the MSD throughout the store picking items of customer orders. For example, the MSDs may maintain a location map locally and then indicate to the CCS when the location map should be updated (e.g., based on the absence of a location signal or one or more newly detected location signals).

Generation of location maps in stores including location indicators that transmit signals is illustrated and described with respect to FIGS. 41A-44B. It may be assumed that the MSDs may automatically generate the location maps while a user is picking items of a customer order displayed on the MSDs and/or using a “location map generation mode” of the MSDs.

When location indicators are initially placed in a store, the location map may be incomplete. A location map that is incomplete may not include each of the areas of the store in a proper arrangement. A location map that is incomplete may be referred to herein as an “incomplete location map.” A location map may be incomplete in a variety of different ways described hereinafter. In some examples, a location map may be incomplete when the location map for the store does not include all of the areas of the store. In another example, the location map may be incomplete when the location map does not include all of the junctions between different areas. In still other examples, the location map may be incomplete when the location map includes too many areas. This may occur when a location indicator breaks and fails to transmit location signals.

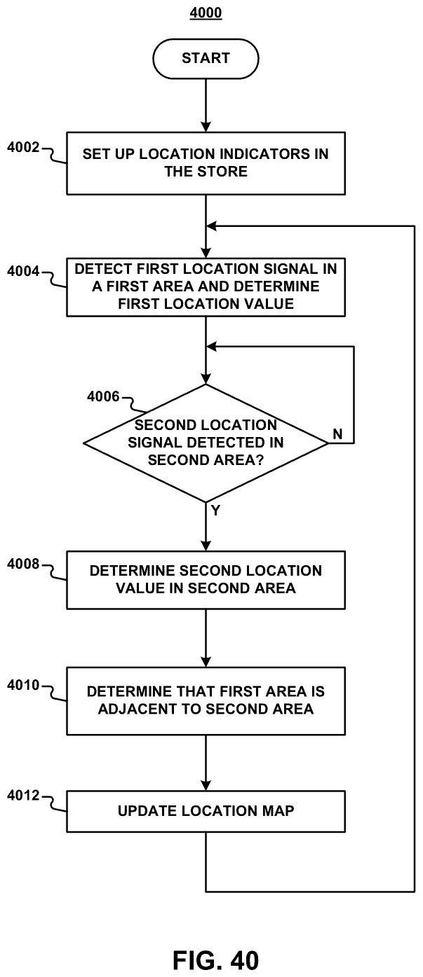

FIG. 40 illustrates an example method 4000 for generating a location map in stores including location indicators that transmit location signals. It may be assumed that location indicators have not been set up in the store at the start of method 4000. At 4002, location indicators that transmit location signals are set up in the store. At 4004, an MSD detects a first location signal in a first area of the store. The MSD determines a first location value based on the received first location signal. At 4006, the MSD determines whether a second location signal is detected. If a second location signal is not detected, method 4000 may continue in block 4006. Accordingly, the MSD may wait until a second location signal is detected in block 4006.

Method 4000 may continue in block 4008 when the MSD detects the second location signal in the second area. The MSD determines a second location value based on the detected second location signal. The MSD may then determine that the first area is adjacent to the second area in block 4010. In some examples, the MSD may determine that the first and second areas are adjacent to one another when the MSD determines that one or more location adjacency criteria are met.

In general, location adjacency criteria may include parameters that the MSD uses to determine the proximity of two different areas in a store. The MSD may determine that two different areas are adjacent to one another (e.g., connected by a single junction) when one or more location adjacency criteria are met. In general, different areas of a store may be adjacent in three different ways. In one example, two different areas of a store may be adjacent when location signals defining the two different areas abut one another. Abutting areas are described with respect to FIG. 17. In FIG. 17, aisle 270-3 includes multiple areas that abut one another. In one example, area 280-5 abuts area “280-5+280-6.” In this example, areas 280-5 and “280-5+280-6” are not separated by any dead zone because location signals overlap at the intersection of the two areas. In another example, area 280-6 abuts area 280-7. In this example, areas 280-6 and 280-7 are separated by a short dead zone in which location signals may not be present at detectable levels.

The size of a dead zone between two adjacent areas may vary. In one example, with respect to FIG. 17, area 280-6 and area 280-7 are separated by a short dead zone. In another example, area 280-1 and 280-2 are separated by a larger dead zone. As another example, the dead zone between area 280-3 and 280-10 is smaller than that between areas 280-1, 280-2, but larger than that between areas 280-6, 280-7. Accordingly, adjacent areas of a store may abut one another or be separated by a dead zone.

As described above, the location adjacency criteria may be used to determine whether two areas are adjacent to one another. In general, two areas may be considered adjacent to one another when the areas abut one another or when the two areas are separated by a relatively short dead zone. Qualitatively, two areas may be considered adjacent when the dead zones between the areas are small or non-existent. Two areas are more likely to be considered non-adjacent by the OFS when the two areas are separated by larger dead zones.

The location adjacency criteria may be used by the OFS to determine whether two areas are considered adjacent to one another.

A first location adjacency criterion may be based on whether two areas include common location values (e.g., are covered by common location signals). For example, if two areas include a common location value, then those two areas may be adjacent. Such a scenario arises when an area is defined by two overlapping signals. In this scenario, three different areas may be defined by two different location signals that overlap. The area in which the location signals overlap may be adjacent to each of the areas defined only by the single non-overlapping portions of the location signals. An example of three such areas are shown in FIG. 17. For example, in FIG. 17, areas 280-5, “280-5+280-6”, 280-6 are defined by two different location signals that overlap. Area “280-5+280-6” may be adjacent to area 280-5 because location value 280-5 is common to both area 280-5 and “280-5+280-6”. Similarly, area “280-5+280-6” may be adjacent to area 280-6 because location value 280-6 is common to both area 280-6 and “280-5+280-6.” Accordingly, area “280-5+280-6” may be adjacent to both areas 280-5 and 280-6.

Another location adjacency criterion may be an amount of time between detection of two different areas in the store. In general, an MSD may determine that first and second areas are adjacent when the amount of time between detecting the two areas is less than a threshold amount of time. In one example, the MSD may determine that first and second areas are adjacent when the MSD detects the second area within a threshold amount of time after detecting the first area. Similarly, the MSD may determine that first and second areas are adjacent when the MSD detects the first area within a threshold amount of time after detecting the second area.

In examples where an MSD uses a threshold amount of time to determine whether two areas are adjacent, the threshold amount of time may be selectable (e.g., by an operator of the OFS or another user). In general, a smaller threshold amount of time may require two areas to be closer to one another to be considered adjacent. A larger threshold amount of time may allow two areas that are farther apart to be considered adjacent.

In the example of adjacent areas 280-5 and “280-5+280-6” described above, an MSD may detect area 280-5 immediately after detecting area “280-5+280-6”. Similarly, an MSD may detect area “280-5+280-6” immediately after detecting area 280-5. Accordingly, an MSD may determine that area 280-5 and area “280-5+280-6” are adjacent for even small thresholds of time because the MSD may detect area 280-5 immediately after detecting area “280-5+280-6.” Similarly, an MSD may determine that area 280-6 and area “280-5+280-6” are adjacent for even small thresholds of time because the MSD may detect area 280-6 immediately after detecting area “280-5+280-6”.

Although areas may be immediately adjacent (e.g., not separated by a dead zone) as described with respect to areas 280-5 and “280-5+280-6,” in some examples, areas separated by dead zones may be considered adjacent. In examples where two areas are separated by a dead zone, the magnitude of the threshold amount of time may determine the amount of dead zone allowed between two areas that are considered adjacent.

Dead zones of different sizes are illustrated in FIG. 17. The size of the dead zone present between area 280-6 and area 280-7 is negligible. The dead zone present between area 280-6 and area 280-7 may be short enough that an MSD detects area 280-7 immediately upon exiting area 280-6. Put another way, the dead zone present between area 280-6 and area 280-7 may be so small that area 280-6 abuts area 280-7. Similarly, the dead zone present between area 280-7 and area 280-8 may be short enough that an MSD detects area 280-8 immediately upon exiting area 280-7.

A relatively short dead zone 281-1 is located between area 280-1 and area 280-2. Similarly, a relatively short dead zone 281-3 is located between area 280-4 and area “280-9+280-10.” A user may move an MSD from area 280-4 to area “280-9+280-10,” or from area 280-1 to area 280-2, on the order of one or more seconds (e.g., 1-3 seconds). Similarly, a user may move an MSD from area 280-4 to area “280-9+280-10,” or from area 280-1 to area 280-2, on the order of one or more seconds (1-3 seconds). A slightly larger dead zone is illustrated between area 280-1 and area 280-4 (e.g., on the side of rack 268-1 that does not include a location indicator). A user may move an MSD from area 280-1 to area 280-4 on the order of a 3 seconds or more.

An even larger dead zone is illustrated between area 280-1 and area 280-5 (e.g., on the sides of racks 268-1, 268-2 that do not include a location indicator). Movement of an MSD from area 280-1 to area 280-5 may take a greater amount of time than movement from area 280-1 to area 280-4. For example, moving an MSD from area 280-1 to area 280-5 may take approximately twice the amount of time (e.g., 5-10 seconds) as moving from area 280-1 to area 280-4.

As described above, an MSD may be configured to determine that two areas are adjacent when the amount of time between detecting the two areas is less than a threshold amount of time. The threshold amount of time used by the MSD may be a selectable value. In one example, the threshold amount of time may be set to 3 seconds. In this example, the MSD may determine that areas 280-1, 280-2 are adjacent to one another. Additionally, the MSD may determine that areas 280-1, 280-4 are adjacent to one another. An MSD may not determine that areas 280-1, 280-5 are adjacent because the MSD may not be moved between areas 280-1, 280-5 within the 3 second threshold, assuming that movement from area 280-1 to area 280-5 takes approximately 5-10 seconds.

In another example, the threshold amount of time may be set to 1 second. In this example, the MSD may determine that areas 280-1, 280-2 are adjacent to one another because an MSD may be moved between areas 280-1, 280-2 within a second. However, in this example, an MSD may determine that areas 280-1, 280-4 are not adjacent because the MSD may not be moved between areas 280-1, 280-4 within the 1 second threshold, assuming movement from area 280-1 to area 280-4 takes approximately 3 seconds or more.

The structure of a location map (e.g., the junctions) may depend on the placement of location indicators in the store and the number of location indicators in the store. In general, a greater density of location indicators within a store may result in a location map including more junctions (i.e., more adjacencies). For example, placing a greater number of location indicators within a given amount of floor space may generally result in a greater number of adjacent areas because there may be more overlapping signals and a smaller number of dead zones. With respect to the threshold amount of time used by an MSD, using a greater threshold amount of time may result in a location map having more adjacencies (i.e., more junctions) because areas separated by larger dead zones may be considered adjacent.

An MSD may use location adjacency criteria to determine if two areas are adjacent. In some examples, an MSD may determine that two areas are adjacent when the two areas include common location values. In some examples, an MSD may determine that two areas are adjacent when the amount of time between detection of the two areas is less than a threshold amount of time. The adjacency of areas may depend on the placement of location indicators in the store and the number of location indicators arranged throughout the store. Although location adjacency criteria may include the use of common location values and/or a threshold amount of time, it is contemplated that an MSD may use other adjacency criteria to determine whether two areas are adjacent.

Referring back to method 4000, an MSD may determine whether two areas are adjacent (e.g., using the location adjacency criteria) in block 4010. In block 4012, the mobile device indicates to the CCS that the two areas are adjacent. The CCS may then update the location map to indicate that the two areas are adjacent. The central system may transmit the updated location map to the one or more MSDs in the store. Over time, one or more MSDs in the store may identify additional adjacent areas. The CCS can further update the location map based on these identified adjacent areas. Continuation of the method 4000 in block 4004 after block 4012 represents that the location map may be continually updated over time as new areas (e.g., new location signals) are detected and new adjacencies are determined by the MSD(s).

FIGS. 41A-41D illustrate generation of a location map using a single MSD 4102. FIGS. 41A-41B illustrate generation of a partial location map including areas 464-1, 464-2, and 464-3. The MSD 4102 may generate the location map 4100-1 including the three areas 464-1, 464-2, 464-3 as the MSD 4102 is moved from area 464-1 to area 464-2 and on to 464-3 in FIG. 41A. In FIG. 41C, the MSD 4102 is moved from through areas 464-4, “464-4+464-5,” 464-5, 464-6, and back to area 464-1. The MSD 4102 may generate the location map 4100-2 illustrated in FIG. 41D during the movement in FIG. 41C. The MSD 4102 may transmit the location map 4100-2 to the CCS which may store the location map 4100-2 and transmit the location map to other MSDs in the store.

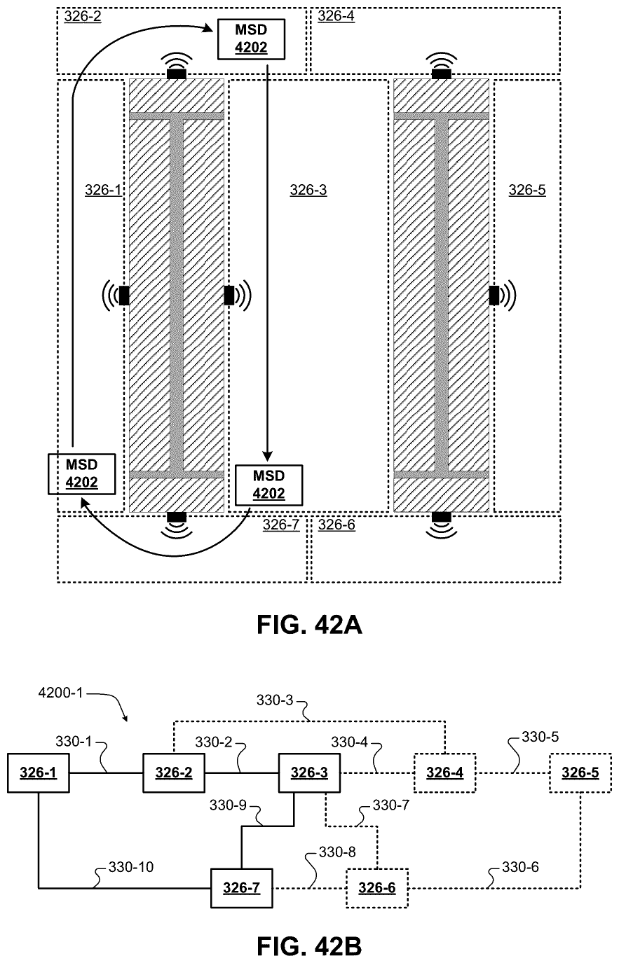

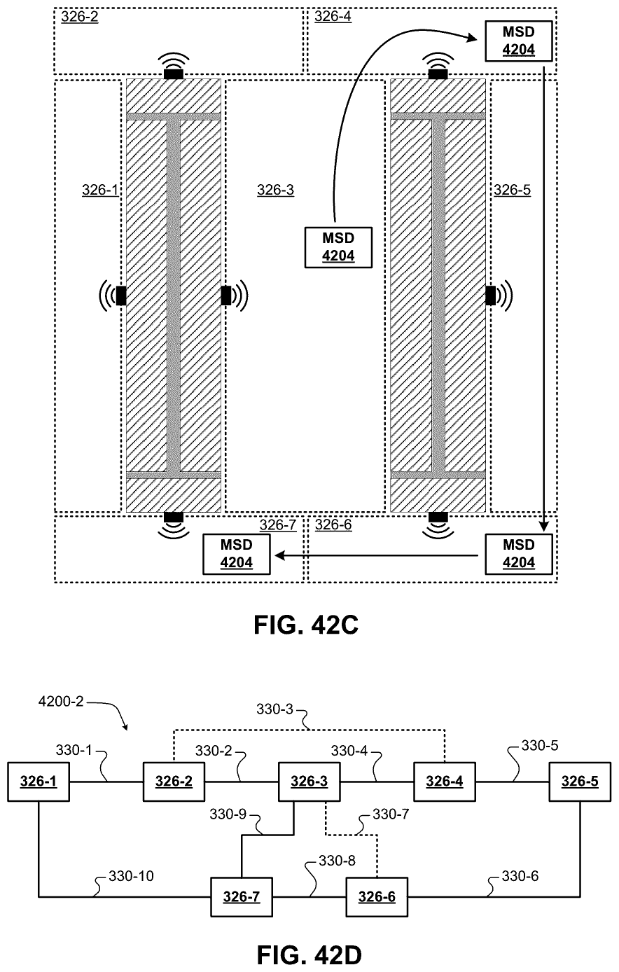

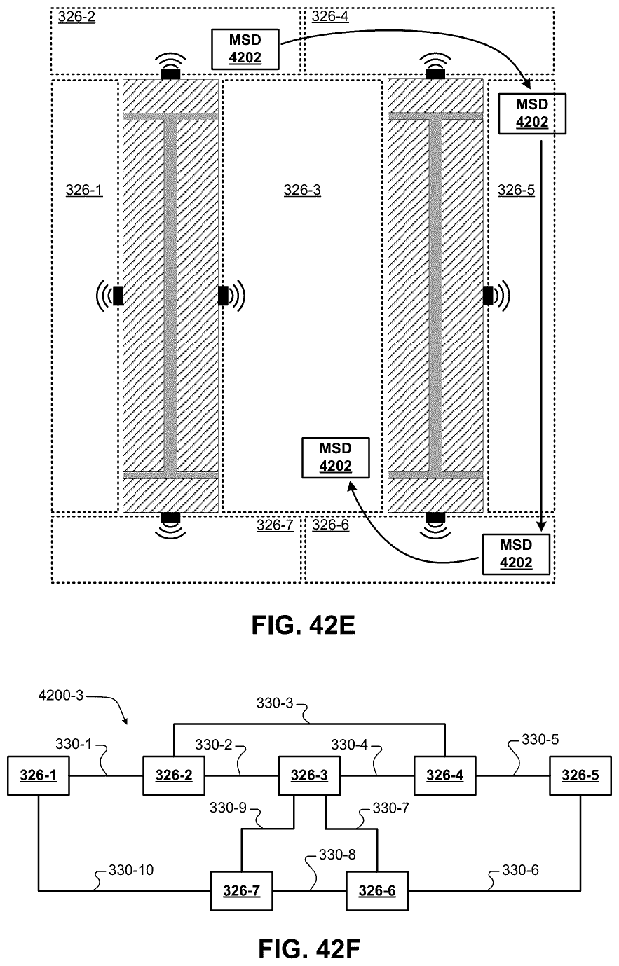

FIGS. 42A-42F illustrate generation of a location map using multiple MSDs. In FIG. 42A, the MSD 4202 is moved from area 326-1 through areas 326-2, 326-3, 326-7, and back to 326-1. The MSD 4202 may generate location map 4200-1 in FIG. 42B based on the movement. The junctions in solid lines indicate the adjacencies determined by the MSD 4202. The MSD 4202 may transmit the location map 4200-1 to the CCS which may update the location map stored at the CCS and then transmit the updated location map back out to other MSDs. The broken lines indicate adjacencies that may be determined in the future by MSDs. The broken lines are illustrated to provide context to the reader as to how the OFS may automatically generate a location map. As such, the broken lines may not represent junctions stored in the memory of the MSDs and CCS.

FIGS. 42C-42D illustrate generation of another portion of a location map 4200-2 using a second MSD 4204. In FIGS. 42C, the second MSD 4204 is moved from area 326-3 through 326-4, 236-5, 326-6, and 326-7. The MSD 4202 may update the location map stored on the MSD 4202 to the location map illustrated in FIG. 42D based on detection of location signals in the areas. The MSD 4202 may transmit the updated location map to the CCS which may update the location map stored at the CCS and then transmit the updated location map back out to the other MSDs.

FIGS. 42E-42F illustrate generation of the remaining portions of a location map using the first MSD 4202. In FIG. 42E, the first MSD 4202 is moved from area 326-2 through areas 236-4, 326-5, 326-6 and 326-3. The MSD 4202 may complete the location map 4200-3 for the store based on such movement. The MSD 4202 may transmit the updated location map to the CCS which may update the location map stored at the CCS and then transmit the updated location map back out to the other MSDs.

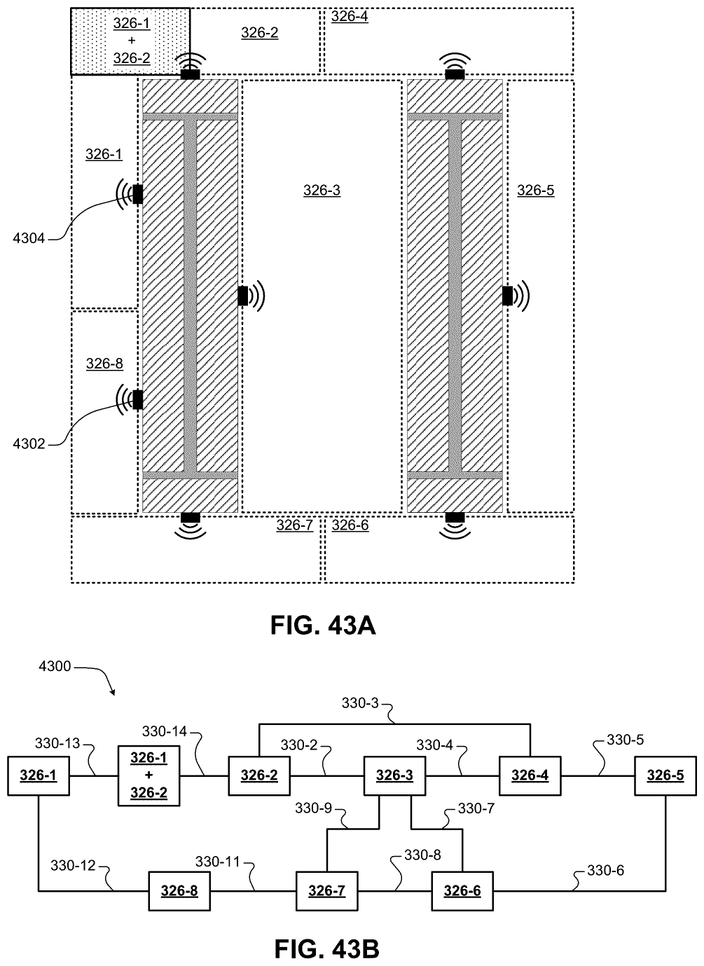

FIGS. 43A-43B illustrate an example updated location indicator layout and an example updated location map 4300 generated based on the updated location indicator layout. Relative to FIG. 42A, the store illustrated in FIG. 43A has had the location indicators updated to include two location indicators 4302, 4304 in the same aisle. Specifically, the location indicator for area 326-1 may have been moved closer to area 326-2, causing an overlap in areas 326-1 and 326-2. Additionally, the new location indicator 4302 has been added to the aisle adjacent to the location indicator for area 326-2. Modification of the location indicator layout cased the formation of 2 new areas 326-8, “326-1+326-2.” One or more MSDs and the CCS may identify the new areas and generate new adjacencies as illustrated in the location map 4300 of FIG. 43B. The MSDs and/or the CCS may then update the item association table based on the updated location map, as described above.

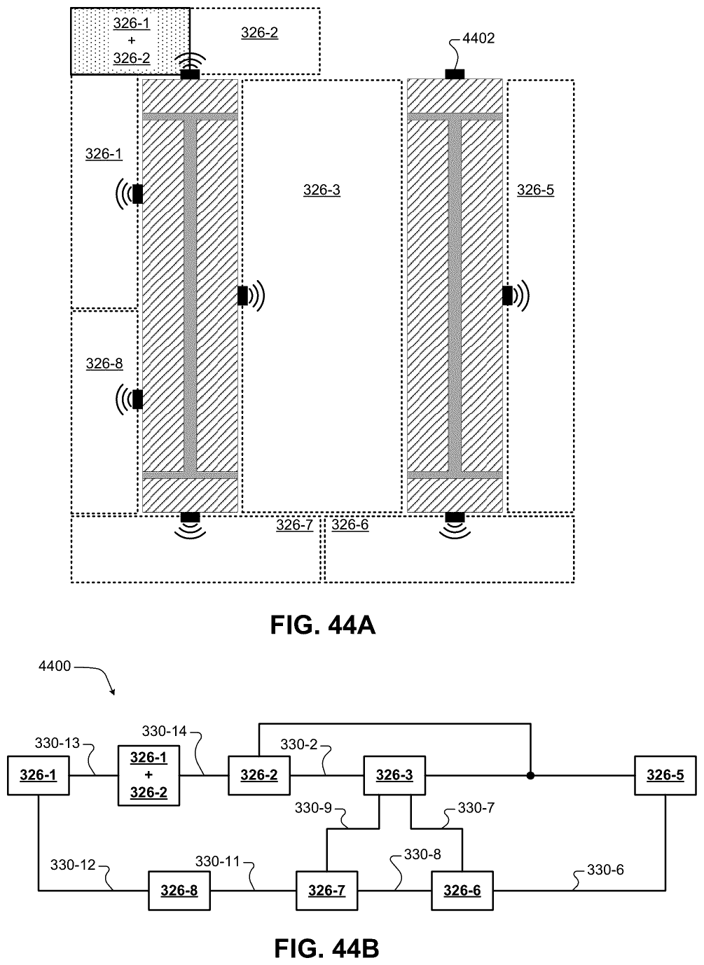

FIGS. 44A-44B illustrate an example location indicator layout similar to FIG. 43A, except that the location indicator 4402 for area 326-4 is not functioning properly. In some examples, the location indicator 4402 may be out of power, broken, or malfunctioning for another reason. In this example, one or more MSDs and the CCS may automatically update the location map 4400 to remove area 326-4, as illustrated in FIG. 44B. In some implementations, the MSDs and/or the CCS may be configured to remove an area from the store in response to detecting the absence of location signals that otherwise were detected in the past. For example, the MSDs and/or CCS may remove the area from the location map after determining that the location signal has not been detected for a threshold amount of time. Upon removing an area from the location map, the MSDs and/or the CCS may initially update the item association table by assigning item ID codes to adjacent areas. Subsequently, over time, the MSDs and/or the CCS may update the item association table based on the updated location map, as described above.

Although generation/update of location maps is described above with respect to location indicators that emit location signals, the OFS may also generate/update location maps in stores that include location indicators having readable codes (e.g., barcodes). For example, MSDs can automatically scan for location indicators (e.g., using a barcode reader or camera) including readable codes and automatically update the location map in a manner similar to that described with respect to FIGS. 41A-44B. Specifically, over time, the MSDs may add areas and/or remove areas associated with location indicators having readable codes, as described above with respect to FIGS. 41A-44B.

In some implementations, the location map updating may be accomplished while the users are picking items from the racks for customer orders. In other examples, the user may set the MSD into a “location mapping mode” and walk through the store with the MSD while the MSD is acquiring location signals and automatically generating the location map based on the acquired location signals. In a store that includes location indicators having readable codes, the user may walk throughout the store and scan the location indicators to generate the location map. In other examples, the MSD may be configured to automatically read the readable codes. For example, the MSD may be configured to rest in a cart pushed throughout the store and scan the racks or other areas for the readable codes. In this example, the MSD may automatically pick up the readable codes as the cart is pushed throughout the store (e.g., using a camera or other barcode scanning device), as described herein with respect to using the MSDs for picking.

The MSDs may be configured to scan the item indicators, or detect the item signals transmitted from the item indicators, and perform various operations in response to scanning the item indicators or detecting the item signals. In one sense, an item indicator that is scanned or an item signal that is received by an MSD may be thought of as indicating a particular location of a corresponding item within the store. For example, a first location (e.g., on a shelf of a rack within an aisle) in the store may include a first item indicator that is scanned by an MSD, or which transmits a first item signal to an MSD. Similarly, a second location may include a second item indicator that is scanned by an MSD, or which transmits a second item signal to an MSD. As a result, an MSD may determine that the MSD is located in the first or second location when the MSD scans the first or second item indicator or detects the first or second item signal, respectively. Additionally, the item indicators or the corresponding item signals scanned or detected by an MSD at a particular time may also be thought of as indicating which of the items available in the store are in proximity to the MSD at that specific time. For example, since each of the items in the store may be associated with one or more item indicators and/or item signals, an MSD may, upon scanning an item indicator or detecting an item signal, determine which one or more of the items are in the vicinity of the MSD at that particular time.

Using the techniques described herein, an MSD may determine a location within the store and/or proximity of the MSD to one or more of the items included in the store. In some examples, the MSD may determine the location based on scanned item indicators or detected item signals. For example, the location may be represented as a location value, which may generally refer to any value or plurality of values (e.g., alphanumeric values) determined by the MSD that indicate a location of the MSD within the store. In some implementations, the MSD may further determine the location and the location value based on scanned location indicators or detected location signals. In general, the location values determined by the MSDs may depend on the types of item indicators/signals and location indicators/signals used in the store. A variety of example item and location indicators and item and location signals are described herein. In examples where the item and location indicators transmit item or location signals, an MSD may determine locations and corresponding location values based on one or more of the signals. In examples where the item and location indicators do not transmit item or location signals, an MSD may determine locations and corresponding location values in a different manner. For example, when item indicators and location indicators are readable objects (e.g., barcodes), an MSD may determine a location within the store and a corresponding location value based on a code included on the readable object.

An MSD may scan item indicators or acquire item signals as the MSD is transported throughout the store by a user. The item indicators may be set up throughout the store in a variety of different configurations. In some examples, the item indicators may be set up in the store such that the MSD may scan an item indicator or pick up an item signal near any given item located within the store. In these examples, the item indicators may be set up such that the item indicators, or item signals generated by the item indicators, overlap to varying degrees such that an MSD may scan multiple item indicators or acquire multiple item signals simultaneously in some locations. Additionally, or alternatively, the item indicators may be arranged such that the item indicators or associated item signals do not quite overlap, but, instead, abut one another or are separated by a short distance such that an MSD may scan a first item indicator or detect a first item signal in a first location, and then abruptly scan a second item indicator or detect a second item signal upon moving out of range of the first item indicator or first item signal. In other examples, the item indicators may be set up such that an MSD may not scan item indicators or pick up item signals at some locations within the store. In these examples, there may be so-called “dead zones” in which an MSD may not scan item indicators or acquire item signals because item indicators or item signals may be absent in that location, or not be sufficiently strong in that location. Various configurations of item indicators within a store are illustrated and described herein.

An MSD may perform a variety of different operations based on a location (e.g., a corresponding location value) and item proximity determined by the MSD. As described herein, the MSD may receive a customer order from the CCS outside of the store or as the MSD is being transported throughout the store by a user. In some examples, the MSD may be configured to display items of the received customer order on a display of the MSD based on a currently determined location, as indicated by a corresponding location value, and based on proximity of the items to the location and to each other, as indicated by an item adjacency map. For example, the MSD may be configured to arrange (e.g., order within a list) the items that are in proximity to the user (i.e., the MSD) at the top of the display for the user to view (e.g., at the top of the list). The MSD may be further configured to arrange the items that are farther from the user lower on the display (e.g., at the bottom of the list). In examples where a large number of items are displayed (e.g., ordered within a list), the items that are more distant from the user may be omitted from the display. Accordingly, in some examples, the items that are in closer proximity to the user may be displayed at the top of the display, while those items that are more distant from the user may be placed at the bottom of the display or not included on the display. Such an arrangement of items on an MSD display may prompt the user to pick items from the racks that are closest to the user. This may speed up the picking process by prompting a user to pick those items that may be picked the quickest and preventing the user from walking by items that are currently ordered by a customer.

The display of an MSD may be updated in real-time as the MSD is moved throughout the store. For example, the arrangement of the items on the display (e.g., within the list) may be updated as the user moves the MSD from a first location where a first item indicator is scanned or a first item signal is detected by the MSD to a second location where a second item indicator is scanned or a second item signal is detected by the MSD. In this example, the items originally arranged on the display may be further rearranged in real-time to reflect which of the items are currently in proximity to the user after the user has moved to the second location. Since the arrangement of the items may vary based on the location of the MSD, it follows that, in some examples, different MSDs present in different locations within the store may display different arrangements of the same items to their respective users.

In some examples, the display of an MSD may also be updated in real-time when new customer orders are received. For example, if a newly-received customer order includes items that are present in the store at the current location of an MSD, the display of that MSD may be updated to include the items of the newly-received order at or near the top of the display of the MSD. This may prevent a user from walking past an item that has just been ordered (e.g., ordered within the past few seconds).

In some examples, the display of an MSD may also be updated in real-time when items are scanned by the MSD. For example, an item may be removed from the display of the MSD when the MSD scans the item. In some examples, the displays of multiple MSDs may be updated in real-time when items are scanned by any one of the multiple MSDs. For example, when an item is scanned by any one of the multiple MSDs, the item may be removed from the displays of all of the MSDs in the store. In these examples, all of the MSDs may be updated each time any of the MSDs in the store scans an ordered item. This may allow multiple users located throughout the store to scan and pick different items of a single customer order. In some circumstances, this may allow customer orders to be picked more quickly than if a single user was picking the entire order.

One or more of the MSDs and/or the CCS may generate an item adjacency map that includes multiple items and indicates whether any two or more of the items are adjacent to one another (e.g., whether the items are located close to one another in the store). Adjacent items may be relatively close to one another in the store, such that the adjacent items may be picked one after another efficiently (e.g., without excessive movement). The distance between adjacent items may be configurable, depending on the item adjacency criteria used (e.g., depending on threshold times). As such, the meaning of adjacency (e.g., in terms of distance/time) may be configurable by the store operator. In a specific example, if the OFS is configured to set items as adjacent that are scanned within less than a few seconds of one another, adjacent items in the store may be very close to one another (e.g., within reach of one another). In general, increasing the amount of scan time allowed between adjacent items may allow for adjacent items to be farther apart from one another.

The MSDs and/or CCS may determine two or more scan times associated with two or more of the items (e.g., any two or more items that are currently displayed to a user of an MSD at the MSD display). The MSDs and/or CCS may determine whether the scan times satisfy an item adjacency criterion (e.g., a predetermined threshold amount of time) and, if so, determine that the items corresponding to the scan times are adjacent to one another. Subsequently, the MSDs and/or CCS may update the item adjacency map to indicate this determination. Alternatively, in the event the MSDs and/or CCS determine that the scan times do not satisfy the item adjacency criterion, the MSDs and/or CCS may determine that the two or more items are not adjacent to one another (or have undetermined adjacency). In some examples, the MSDs and/or CCS may further update the item adjacency map to indicate that the two or more items are not adjacent (e.g., by removing an indication of adjacency).

In some implementations, the item adjacency map may be generated based on scan times associated with picked customer items. Although the item adjacency map may be generated based on picked customer items, in some implementations, an MSD may include an “item adjacency mapping mode” that a user can use to generate some/all of the item adjacency map. For example, the user may set the MSD into the item adjacency mapping mode and scan items (e.g., not included in customer orders) while walking through the store. In some implementations, the item adjacency map may be created based on scans of items that are not included in customer orders, such as item scans that occur passively while a user is picking items.

The item association tables, location maps, and item adjacency maps described herein may also be generated based on data (e.g., location signal detection and scan times) acquired from CCDs used for mapping/picking, third-party MSDs used for mapping/picking, and/or other devices (e.g., robotic scanning devices) used for mapping/picking. The TPCS and CCS may store the item association tables, location maps, and adjacency maps for a single store. In some implementations, the TPCS may acquire the tables and maps from the CCS. In other implementations, the TPCS may generate and store their own tables and maps for the store. In some implementations, the CCS may retrieve tables and maps from the TPCS.

An MSD may receive a customer order including one or more items in the store (e.g., from the CCS) and retrieve the item adjacency map described above. For example, the item adjacency map may be stored at the CCS and transmitted to the MSD and/or the item adjacency map may already be stored at the MSD at the time the customer order is received. The item adjacency map may include multiple items within the store, including items that are in the customer order, and indicate whether any two or more of the items are adjacent. The MSD may display the items in the customer order based on data included in the item adjacency map. In some cases, the MSD may select an initial one of the items in the customer order and then display the items included in the customer order based on the initially selected item and based on the item adjacency map. For example, the MSD may arrange adjacent items (e.g., nearby items) at the top of the display for picking. In this example, the MSD may arrange items that are farther away (e.g., adjacent to currently adjacent items) farther down the display. In one example, the MSD may determine (e.g., estimate) a distance and/or a time required for a user to move between the initial item and one or more other items included in the customer order based on the item adjacency map (e.g., previous scan times). The MSD may then arrange some (or all) of the items of the customer order on the MSD display based on the determined distance and/or time. For example, the MSD may display the initial item at the top of a list. The MSD may further display other items lower within the same list based on the relative distances and/or times associated with the items and the initial item. In a specific example, the MSD may display an item that is closer to the initial item higher within the list compared to an item that is farther from the initial item. In some examples, the MSD arranges all items in the customer order on the display. In other examples, the MSD arranges a subset of the items, with the remaining items accessible to the user by scrolling down the list. In some examples, the MSD may arrange the currently adjacent items in a group near the top of the display and arrange other items farther down the display. In some examples, the MSD arranges the items in the order of closest to farthest with respect to the user (e.g., the MSD). In other examples, the MSD displays the items that are closest to the user at that particular time. In still other examples, the MSD indicates that a specific one of the items is currently adjacent to the user.

Although an MSD may display items based on a determined distance or time, in some implementations, an item adjacency map may not include distance or time data. In these implementations, the item adjacency map may just indicate that items are adjacent, without accompanying time/distance data. In these implementations, the MSD may display items that are determined to be adjacent to a current item/location higher on the display (e.g., for more immediate picking). The MSD may display items that are not adjacent farther down the display (e.g., for subsequent picking). In some cases, the MSD may display the currently non-adjacent items according to whether the currently non-adjacent items are adjacent to items which are currently near the user. For example, the MSD may display items farther down the display (e.g., for subsequent picking) that are adjacent to items which are adjacent to a current item/location. In a similar manner, the MSD may display subsequently adjacent items farther down the list. In some cases, the MSD may arrange an entire order based on adjacency. In other cases, the MSD may be configured to arrange a subset of the items in the list, and then arrange the remaining items that are farther away after the user has started picking the subset of items. In this manner, the MSD may present a list to the user that indicates which items are currently nearby and should be picked.

In some implementations, the OFS may make use of location indicators and/or location signals in conjunction with the item indicators, item signals, location maps and/or an item adjacency maps. As described herein, an MSD may perform a variety of different operations based on a location and a corresponding location value determined by the MSD, irrespective of whether the location and location value are determined using location indicators/signals alone or in conjunction with item indicators/signals. For example, an MSD may be configured to receive a customer order from the CCS while the MSD is being transported throughout the store. The MSD may be further configured to determine a location value associated with a current location of the MSD using one or more location indicators and/or location signals. The MSD may be further configured to display items of the received customer order on an MSD based on the determined location value and an item adjacency map. For example, the MSD may be configured to initially use the location value to orient the MSD as to the MSD's current location within the store and subsequently use the item adjacency map to determine the relative locations of the items in the customer order with respect to that location. For example, the MSD may first determine an initial one of the items included in the customer order that is located closest to (e.g., within) the location associated with the location value. The MSD may then use the item adjacency map to determine the locations of the remaining items of the customer order relative to the location of the initial item. As a result, the techniques of this disclosure may, in some examples, enable more accurate determination of relative locations of items in areas of the store (e.g., aisles) that include many items in close proximity to one another. The techniques of the disclosure may also allow for more efficient item picking.

In some implementations, one or more of the MSDs and/or the CCS may be configured to determine that two items are located adjacent to one another upon an MSD scanning the items and determining that the corresponding scan times are within a predetermined threshold amount of time. In some implementations, one or more of the MSDs and/or the CCS may be configured to determine that two items are located adjacent to one another upon an MSD scanning the items and determining that the corresponding scan times are within a predetermined threshold amount of time N number of times (e.g., a threshold number of times). In other words, in some examples, the techniques of this disclosure include determining that two items are adjacent upon scanning the items within a predetermined threshold amount of time in multiple instances. Similarly, in some examples, the techniques may include determining that two items are not adjacent upon scanning the items outside of a predetermined threshold amount of time in multiple instances. As a result of using data from multiple scans, the techniques may allow determining that the items are likely adjacent and decrease the chance of erroneous adjacency determinations (e.g., using so-called “outlier” scan times).

In some implementations, one or more of the MSDs and/or the CCS may be configured to determine adjacency of groups, or so-called “clusters,” of multiple items. For instance, in some examples, the techniques of this disclosure include grouping multiple items scanned by one or more of the MSDs into each of a first group and a second group. For instance, for any of the first and second groups, a plurality of the items scanned by the MSDs may be included in a particular group based on a number of the items (e.g., N of the items) and/or based on a threshold amount or duration of time during which the items were scanned. The techniques further include determining whether the first group includes one or more items that are the same as, or “overlap with,” one or more items included in the second group. The techniques also include, upon determining that the first and second group include one or more of the same items, determining that the first and second groups are adjacent. This may enable more accurately determining relative locations of the items within a store by grouping the items into groups and determining common items within the groups. In some examples, adjacency among any two of the items may be referred to as primary, or “first-tier,” adjacency. Adjacency among any two groups of items may be referred to as secondary, or “second-tier,” adjacency.

In some implementations, one or more of the MSDs and/or the CCS may be further configured to, upon generating an item adjacency map that indicates adjacency of a plurality of items, also include an indication of time (e.g., estimated time) and/or distance (e.g., estimated distance) required for a user to move (e.g., walk) between two or more of the items in the item adjacency map. In these examples, the MSDs and/or CCS may arrange multiple items on a display of an MSD in the manner described herein based on relative times and/or distances associated with two or more of the items using the item adjacency map including such indication of time and/or distance. In some implementations, the time and/or distance indications in the item adjacency map may be values that indicate relative time and/or distance between items, but not indicate actual time units (e.g., seconds) and/or distance units (e.g., meters). Instead, the time and/or distance indications may be dimensionless (e.g., without units). In other implementations, the time and/or distance indications may include time and/or distance units.

In some implementations, to generate an item adjacency map, one or more of the MSDs and/or the CCS may be configured to process the scan times associated with the items as the scan times are acquired (e.g., in real-time). Alternatively, the MSDs and/or the CCS may be configured to process a scan log including the scan times at a later point in time. The scan log may include data that indicates an MSD that scanned an item, a time when the item was scanned, and other data described herein. For example, a scan log may indicate a location value for the scan, where the location value may be determined based on a location indicator (e.g., a last/next scanned indicator or detected location signal) or other location technology (e.g., GPS, Wi-Fi, etc.).

In some implementations, one or more of the MSDs and/or the CCS may be further configured to perform a calibration of the predetermined threshold amount of time described herein based on user speed (e.g., based on the scan times included in the scan log). For example, the MSDs and/or CCS may be configured to determine the predetermined threshold amount of time by determining user speed and scanning time, and then adjusting the predetermined threshold amount of time based on the user speed. In a specific example, users that pick items at a faster/slower rate may have their threshold scan times decreased/increased for determining adjacency.

In some implementations, one or more of the MSDs and/or the CCS may be configured to infer item adjacency between two items based on determined item adjacency between two or more intervening items. In other words, in some examples, the MSDs and/or CCS may be configured to, upon determining that a first item is adjacent to a second one or more items, and that the second one or more items are adjacent to a third item, further determine that the first and third items are also adjacent.

In some implementations, one or more of the MSDs and/or the CCS may be configured to infer item adjacency between multiple items based on corresponding scan times being within a predetermined threshold amount of time and/or based on sequential scanning of the items. For example, the MSDs and/or the CCS may determine that multiple items are all adjacent to one another upon determining that each of the multiple items was scanned by an MSD within a predetermined threshold amount of time. Additionally, or alternatively, the MSDs and/or the CCS may determine that the multiple items are all adjacent to one another upon determining that the items were scanned in a sequence (e.g., one item directly after another).

In some implementations, one or more of the MSDs may be configured to display multiple items in the manner described herein based on relative numbers of intervening items located between any two of the items, as indicated by an item adjacency map. For example, the MSD may display an initial item at the top of a list and one or more other items lower within the list in the order of how many intervening items are located between each such item and the initial item. In these implementations, the MSDs and/or CCS may generate an item adjacency map to indicate adjacency of a plurality of items using numbers of intervening items as metrics for adjacency. Also, in these implementations, the MSDs and/or CCS may omit any time or distance metrics previously described from the item adjacency map and retain sequence data indicating one or more sequences or orders in which the items in the store are arranged.

In some implementations, an MSD may be configured to display items such that a user of the MSD is directed to keep moving the MSD from a particular group of items to another group of items. For example, the MSD may be configured to, after scanning an item included in a first group of items, display an item included in a different group of items. In other words, the MSD may be configured to display an item that is adjacent to items in the first group, but which is not included in the first group. For example, the MSD may display items from the first group on the display along with another item from the second group of items to move the user in the direction of the second group.

In some implementations, one or more of the MSDs and/or the CCS may be configured to generate an item adjacency map that indicates adjacency of a plurality of items as well as scan directionality, or a scanning order, associated with the items in the item adjacency map. For example, the item adjacency map may indicate a temporal order in which the items in the item adjacency map were scanned by an MSD, in some examples indicating a time at which each item was scanned. The MSD may arrange items on the display based on the known temporal order in which items were scanned and determined as adjacent. Using a known temporal order of adjacency may provide directionality to the user while picking, which may reduce an amount of back-and-forth movement of the user while picking adjacent items. Additionally, the temporal order of adjacency may help the MSD put together a longer and more efficient picking route for one or more customer orders. For example, the temporal order of adjacency may indicate a direction of motion in which the user should pick single items and/or groups of items. In some cases, the historical scanning of intervening items between first and last picked items may provide an indication of direction in which the items may be picked efficiently.

In some implementations, an MSD may display items included in a customer order to a user and receive an input (e.g., a touchscreen tap) from the user selecting one of the items. In these implementations, one or more of the MSDs and/or the CCS may be configured to, upon receiving the input, designate the corresponding item as the next item to be picked by the user. For example, the MSD and/or the CCS may use the corresponding item as a “seed” or a “re-seed” item and determine one or more other items included in the customer order that are adjacent to that item using an item adjacency map (or other table/map). In this manner, each of multiple users of the MSDs may pick the items included in the customer order by selecting an item closest to the user and updating the items on the corresponding MSD to reflect one or more of the items that are adjacent to the user. As a result, multiple users of the MSDs may dynamically enter and exit the process of picking the items included in the customer order described herein. In some implementations, the MSD and/or CCS may “seed” an item in response to a scan of the item. For example, the MSD may assume that the user is in the location of the scanned item in response to the user scanning the item. The seeded item, whether manually selected or scanned, may be used to arrange items based on the item adjacency map and/or the location map and item associations.

In some implementations, one or more of the MSDs and/or the CCS may be configured to arrange items included in a customer order based on one or more location indicators. For example, an MSD may prioritize (e.g., move up a list) items that are located in a zone corresponding to a current location of the MSD, as indicated by an associated location indicator present in that zone.

In some implementations, one or more of the MSDs and/or the CCS may be configured to generate an adjacency map that is represented using any of a variety of other data structures other than those depicted in the figures of this disclosure, such as those indicating a number of item “hops” (e.g., a number of items) between any two items, an amount of time needed for a user to move between any two items, and so forth.

In some implementations, one or more of the MSDs and/or the CCS may be configured to use metadata indicating a type/category (e.g., produce, dairy, meat products) associated with an item included in a customer order to group (e.g., cluster) the item with one or more other items that are also included in the customer order, adjacent to the item, and associated with the same type. In this manner, the MSDs and/or CCS may group or cluster multiple adjacent items in the manner described herein based on item type shared by, or associated with the items, rather than on a number of the items. In some implementations, the MSDs and/or CCS may group items by type in an item adjacency map and then indicate which items are adjacent to one another within the item type group. For example, the item adjacency map may group dairy products together based on type and/or aisle location (e.g., aisle number). The item adjacency map may then further define the location of the items within the group (e.g., item type and/or aisle) using item adjacency or other location indicator mapping described herein. In additional implementations, the MSDs and/or CCS may include multiple items in a group or cluster and then infer that the items share a common item type.

In some implementations, one or more of the MSDs and/or the CCS may be configured to identify a first item included in a first group and identify a second, different item, that is adjacent to the first item but not included in the first group. The MSDs and/or the CCS may be configured to identify one or more additional items that are adjacent to the second item and also not included in the first group and include the second item and the additional items in a second, different group.

In some implementations, one or more of the MSDs and/or the CCS may be configured to generate a cluster map that indicates one or more items that are included in one or more groups (e.g., clusters). The MSDs and/or the CCS may be configured to use the cluster map in a similar manner as described herein with reference to an item adjacency map. For example, the MSDs and/or CCS may be configured to identify an item included in a cluster and use the cluster map to identify and indicate one or more additional items that are also included in the same cluster and are therefore adjacent to the item. In some implementations, one or more of the MSDs and/or the CCS may be configured to use a cluster map to determine a location of one or more items included in a store and/or a location in a store. The cluster maps may be used alone, or with other maps, such as other item adjacency maps and/or location maps. In some implementations, the cluster maps may be used as an alternative to location maps and/or when a location indicator has not been detected and/or is faulty, missing, or outdated (e.g., moved to another location).

In some implementations, one or more of the MSDs and/or the CCS may be configured to determine that two items are adjacent upon scanning the items within a predetermined threshold amount of time after several instances of scanning the items outside of the predetermined threshold amount of time. In this manner, a single scan instance indicating adjacency among the items may negate or remove several prior scan instances indicating non-adjacency among the items. In further examples, non-adjacency among items may be used to fill in missing information in an adjacency map. For example, an MSD may display items that are determined non-adjacent to a current item when adjacent items are missing or not known.

In some implementations, one or more of the MSDs and/or the CCS may be configured to use an item adjacency map in conjunction with one or more location indicators. For example, in these implementations, a store may include one or more zones, each associated with a location indicator. In each such zone, one or more areas associated with one or more items included in the zone may be organized based on adjacency among the items. For example, the item adjacency map may indicate to an MSD and/or the CCS where within the zone the items are located based on the adjacency among the items. In some implementations, the location map and/or item adjacency map may indicate an aisle number and/or a portion of the aisle (e.g., middle, end, etc.).

In various implementations, the MSDs and/or CCS may be configured to identify a first item (e.g., an anchor item) included in a particular zone associated with a location indicator, and then determine relative locations of one or more different items also included in the zone with respect to the first item using an adjacency map. In this manner, the MSDs and/or CCS may add granularity to, or enhance resolution of, relative locations of the items included in the zone. In some examples, one or more of the different items previously not displayed on an MSD (e.g., displayed off-screen) may be displayed upon determining the items are adjacent to the first item. Alternatively, one or more previously displayed items may be removed from being displayed upon determining the items are not adjacent to the first item.

In various implementations, one or more of the MSDs and/or CCS may be configured to make use of items (e.g., an anchor item) included in zones and MSDs transitioning from one zone to another zone. For example, the MSDs and/or the CCS may determine that an item included in a first zone is proximate to an item included in a second zone upon an MSD scanning the two items within a predetermined threshold amount of time when the MSD transitions between the two zones, thereby defining edges of the zones. In various implementations, the items scanned by the MSD in this manner may be referred to as edge items. Identifying edge items and a sequence of items between edge items in a zone may assist the CCS and/or MSDs in determining how to arrange items on the display. For example, if the MSD is about to traverse a zone, the MSD may display items at the entry edge of the zone, and then display sequential items in the zone farther down the list until the items on the opposite edge are reached. Displaying items in this manner may provide for efficient picking in a store that is laid out in long aisles, where most aisles have two ways to enter/leave. In a specific example, if an aisle has one or more zones in a line, the arrangement of items for picking may be organized in a linear fashion down the aisle from zone to zone based on the edge items and sequential items between the edge items.

In some implementations, an MSD may be configured to display a subset of the items included in a customer order (e.g., items that are located proximate to the MSD at that time). In some implementations, the MSD may randomly insert one or more other items included in the customer order into a list of displayed items, such as items that are not adjacent to the MSD or for which adjacency is not known (e.g., to fill a screen). In this manner, the MSD may indicate to a user where the user is ultimately expected to go to fill the customer order and/or enable the user to determine (e.g., refresh) adjacency of the items included in the customer order by prompting the user to move toward items for which adjacency is not known.

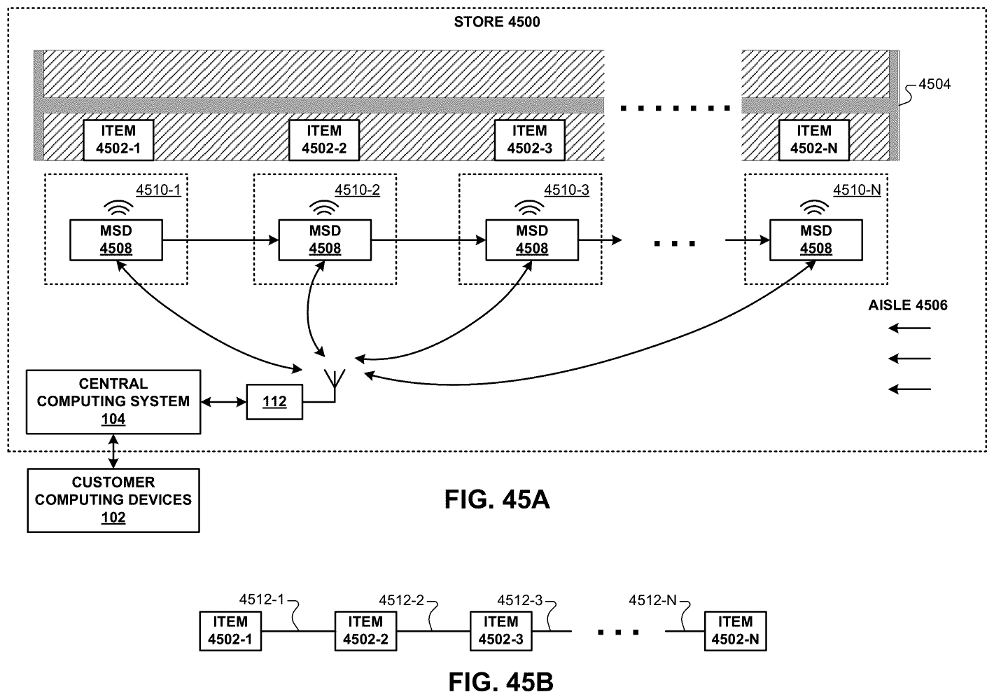

FIG. 45A illustrates an example store 4500 including a plurality of items 4502-1 . . . 4502-N placed on a rack 4504. Example store 4500 also includes an aisle 4506 formed along (e.g., located adjacent to) rack 4504. Items 4502-1 . . . 4502-N include item indicators (e.g., barcodes/RFIDs) that may be associated with item IDs. The items, item indicators, and item IDs may be referred to using the same callouts. Item indicators 4502-1 . . . 4502-N may each identify a corresponding one of items 4502-1 . . . 4502-N to a particular one of MSDS, namely MSD 4508, when MSD 4508 is located proximate to the item. Store 4500 includes CCS 104 that communicates with the one or more MSDs, including MSD 4508, and with one or more CCDs 102, via communication system 112. The broken line boxes labeled 4510 may indicate different scan times for the items (e.g., not necessarily sequential). Although the items are illustrated as being arranged along a straight line on a single rack, item adjacency may be applicable to items in any arrangement on any number of racks throughout the store.

FIG. 45B depicts an example graphical representation of adjacency among items 4502-1 . . . 4502-N described with reference to FIG. 45A. The graphical representation of adjacency indicates that item 4502-1 is adjacent to item 4502-2, item 4502-2 is adjacent to item 4502-3, and so forth. The graphical representation of adjacency depicted in FIG. 45B may correspond to any data structure, including information represented as one or more alphanumeric characters, binary data, or other human- and/or machine-readable information. In the example of FIG. 45B, the graphical representation of adjacency among items 4502-1 . . . 4502-N indicates a substantially linear adjacency relationship between items 4502-1 . . . 4502-N. In other examples, the graphical representation of adjacency among items 4502-1 . . . 4502-N, or other items, may be non-linear, branched, circular, or have other relationships. The junctions 4512 between items 4502 may represent adjacency between the items. In some implementations, the junctions may represent an item adjacency value that indicates the proximity between the items (e.g., a scan time difference between the items).

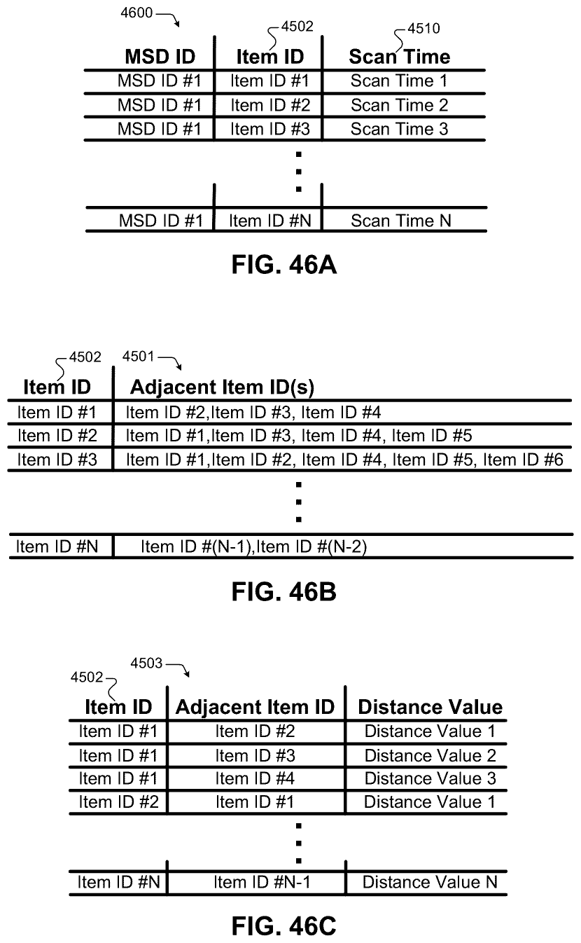

FIG. 46A depicts example item scan time data 4600 associated with the plurality of items 4502 described with reference to FIGS. 45A-45B. As shown in FIG. 46A, item scan time data 4600 includes a table indicating each of the plurality of items 4502. Specifically, item scan time data 4600 includes, for each of the plurality of items 4502, an item identification (ID) number that identifies the item and a scan time associated with the item. As described with reference to FIGS. 46A-46B, the scan time associated with each of the plurality of items 4502 may be determined by scanning the item on a rack of a store using MSD 4508. As shown in FIG. 46A, in some implementations, a scan time associated with each of the plurality of items is represented in numeric form (e.g., hours, minutes, and/or seconds) or other form. As also shown in FIG. 46A, in some implementations, item scan time data 4600 further includes, for each of the plurality of items, an MSD ID number that identifies an MSD 4508 used to acquire the scan time associated with the item.

FIGS. 46B-46C depict example item adjacency maps 4501 and 4503 generated based on the item scan time data 4600 described with reference to FIG. 46A. As shown in FIG. 46B, item adjacency map 4501 includes a table indicating each of the plurality of items 4502 described with reference to FIGS. 45A-45B. In particular, item adjacency map 4501 includes, for each of the plurality of items 4502, an item ID number that identifies the item. Item adjacency map 4501 further includes a list of adjacent items for each of the plurality of items 4502. As shown in FIG. 46C, in some implementations, item adjacency map 4503 further includes estimated relative distances between adjacent items, such as distance values estimated based on scan times between items (e.g., average/median scan times). The item adjacency map 4503 may include scan times and/or distance values, depending on the implementation.

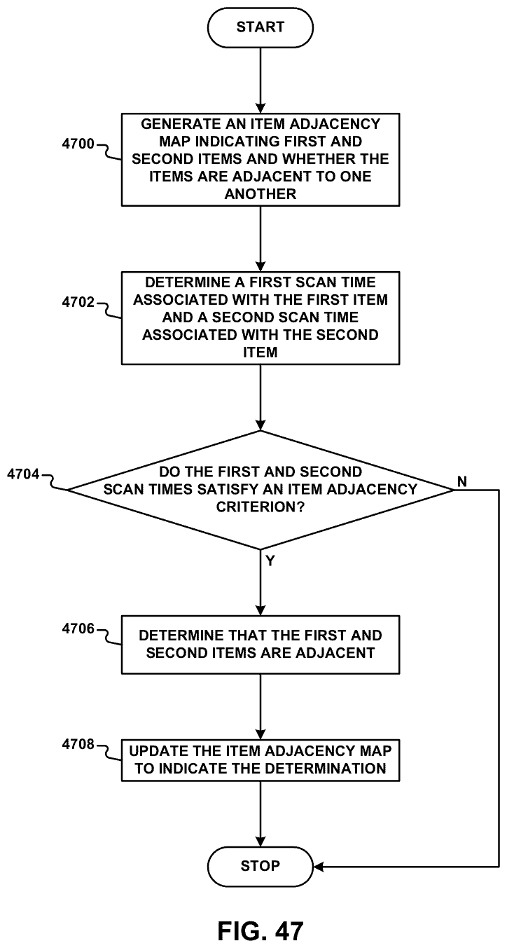

FIG. 47 depicts a method describing operation of an MSD configured to generate an item adjacency map indicating adjacency of a plurality of items. In block 4700, an MSD and/or the CCS initially generates an initial item adjacency map that indicates a plurality of items located on one or more racks included in a store and whether the items are adjacent to one another. Upon initial creation of the item adjacency map, the item adjacency map may include a plurality of items, but may not indicate whether the items are adjacent or not. For example, adjacency between the items may be labeled as undetermined (e.g., N/A). In some implementations, the MSD may initially generate the item adjacency map to partially, or preliminarily, indicate whether the items are adjacent to one another. In other words, the MSD may generate the adjacency map to indicate the plurality of items, as well as indications of whether the items are adjacent to one another.

The adjacency map may be subsequently updated based on scan times associated with the items. For example, an indication of whether two of the items are adjacent to one another may be determined and/or reinforced based on relatively temporally close scan times associated with the items, indicating that the items are adjacent to one another. Alternatively, the indication of whether the two of the items are adjacent to one another may be removed based on relatively temporally distant scan times associated with the items, indicating that the items are not adjacent to one another. Specifically, in block 4700, the MSD generates the item adjacency map to indicate at least first and second items and whether the items are adjacent to one another (or undetermined). As described herein, the MSD may further update the item adjacency map to include one or more additional items and whether each of the additional items is adjacent to each of another one or more items also included in the item adjacency map.

In block 4702, the MSD determines a first scan time associated with the first item and a second scan time associated with the second item. In some implementations, the MSD determines the first and second scan times by scanning the first and second items, as described herein. For example, the MSD may scan the first and second items in a temporally sequential manner automatically as the MSD passes the first and second items while the items are located on one or more racks. As another example, an MSD may determine the first and second scan times when a user manually operates the MSD to scan the items while picking a customer order.

In block 4704, the MSD determines whether the first and second scan times satisfy an item adjacency criterion (e.g., a predetermined threshold amount of time). In some implementations, the MSD determines whether the first and second scan times are sufficiently temporally close to one another, indicating that the first and second items are adjacent to one another. For example, the MSD may determine whether a difference between values associated with the first and second scan times is sufficiently small (e.g., within a predetermined threshold amount of time). In other implementations, the MSD determines whether the first and second scan times satisfy an item adjacency criterion using other techniques/criteria, such as a criterion that may be satisfied by having two or more independent users (e.g., MSDs) scan the items in less than a threshold amount of time.

In some implementations, the MSDs may reject scan times between items that are outliers from other scan times, as such outliers may not be representative of an accurate distance between items. An outlier scan time difference between two items may be a scan time difference that varies by greater than a threshold amount from a typical range (e.g., average or median) of scan times between specific items. For example, if two items are typically scanned within tens of seconds of one another, the MSDs may reject scan time differences of minutes or seconds, as such outlier scan times may indicate an atypical scenario. An atypical scenario may occur when a user holds on to an item for a long period of time and then scans it. This scenario may result in an atypically long scan time between the recently scanned item and a previous item. Another atypical scenario may occur when a user holds on to a first item for a long period of time and then scans the first item just before scanning the second item. This scenario may result in an atypically short scan time between the held first item and the subsequent second item.

In block 4706, in the event the MSD determines that the first and second scan times satisfy the item adjacency criterion, the MSD determines that the first and second items are adjacent to one another. Subsequently, in block 4708, the MSD updates the item adjacency map to indicate this determination. For example, as described herein, the MSD may reinforce an existing indication included in the item adjacency map that indicates that the first and second items are adjacent. In other examples, the MSD may create a new indication that the first and second items are adjacent and include the indication in the item adjacency map. Reinforcing a determination of adjacency may include updating data associated with the adjacent items that indicates the scan times between items have satisfied item adjacency criterion multiple times. For example, the MSD and/or CCS may update the item adjacency map to include, for each pair of adjacent items, a reinforcement indicator value that indicates the number of times the two items have been considered adjacent. The item adjacency map may also include, for each pair of adjacent items, the history of scan times associated with the pair of adjacent items.

In the event the MSD determines that the first and second scan times do not satisfy the item adjacency criterion (“NO” branch of block 4704), the MSD may make a variety of determinations. In some implementations, the MSD may determine that the adjacency status of the first and second items remains undetermined. In these implementations, the item adjacency map may include data that indicates when items are adjacent or whether the status of the adjacency is undetermined.

In some implementations, the item adjacency map may include data that indicates when items are not adjacent. In these implementations, the MSD may determine that the first and second items are not adjacent to one another based on one or more scan times associated with the two items that indicate they are not adjacent. For example, the items may be determined to be non-adjacent when the scan times between the items are large (e.g., sufficiently greater than a threshold value). In some examples, the MSD may further update the item adjacency map to indicate that the first and second items are not adjacent, in a similar manner as described with reference to block 4708. For example, as described herein, the MSD may remove an existing indication included in the item adjacency map that indicates that the first and second items are adjacent. Alternatively, the MSD may explicitly indicate that two items are not adjacent in some cases.

In some implementations, the item adjacency map is generated by a combination of the MSD and the CCS 104. In some examples, the CCS 104 generates the item adjacency map in a similar manner as described herein with reference to the MSD, and transmits the item adjacency map to the MSD. For example, the MSD may transmit, to the CCS 104, information indicating that the first and second items are adjacent and/or the first and second scan times. In this example, the CCS 104 may generate the item adjacency map based on the first and second scan times. In other examples, the CCS 104 and the MSD jointly generate the item adjacency map based on the first and second scan times. In these examples, upon generating and/or receiving the item adjacency map, the MSD uses the map to display a list of items located on racks of a store.

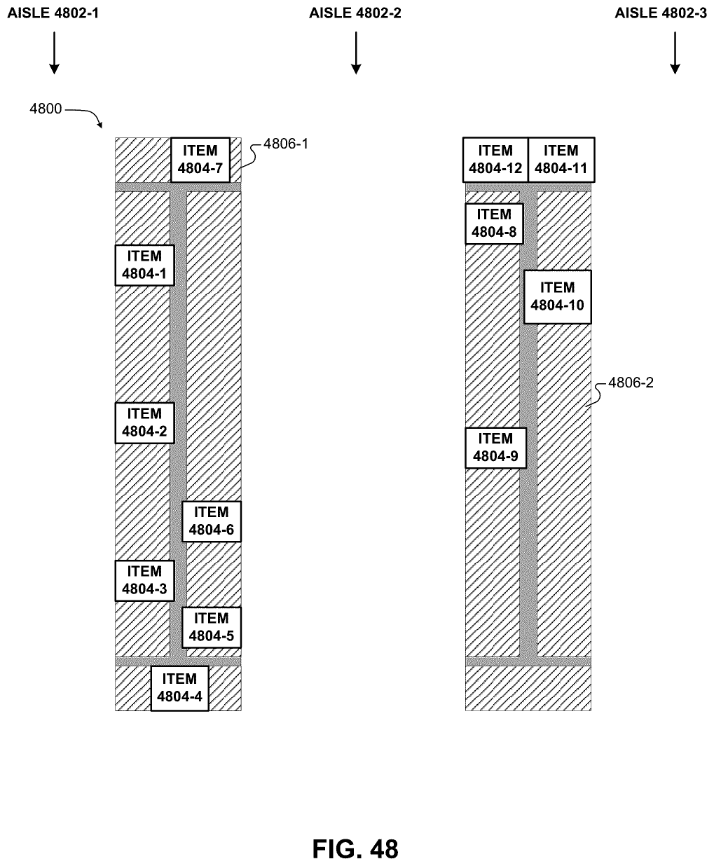

FIG. 48 depicts an example store 4800 including a plurality of items 4804 (e.g., including item indicators 4804) placed on racks 4806. Example store 4800 also includes aisles 4802. In FIG. 48, one or more of the MSDs and/or the CCS have generated an item adjacency map including items 4804. The MSDs and/or the CCS have also determined scan times between items 4804 and determined whether the scan times satisfy an item adjacency criterion (e.g., a predetermined threshold amount of time). In the event the scan times satisfied the item adjacency criterion, the MSDs and/or CCS have further determined that the items are adjacent to one another and have updated the item adjacency map to indicate this determination.

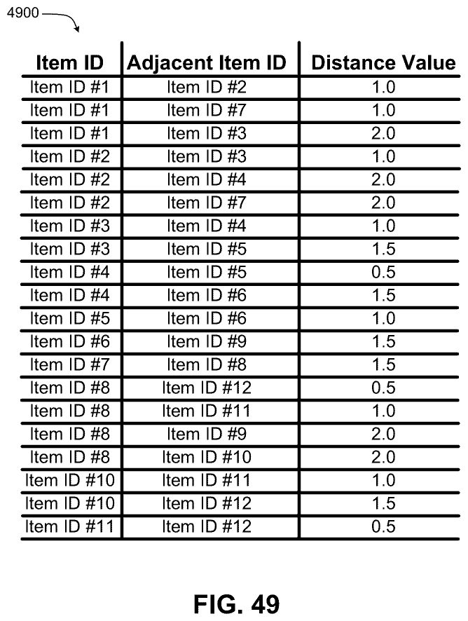

FIG. 49 depicts an example item adjacency map 4900 generated based on item scan times acquired for items 4804 in FIG. 48. As shown in FIG. 49, item adjacency map 4900 includes a table including items 4804-1 to 4804-12. The item adjacency map 4900 includes, for each of the plurality of items 4804, an item identification (ID) number that identifies the item. The item adjacency map 4900 also indicates, for each item, which other items are adjacent to the item. The item adjacency map 4900 also includes, for each item, an indication of a distance between the item and the adjacent item. As shown in FIG. 49, in some implementations, an indication of a distance between adjacent items is represented in numeric form (e.g., in a nominal or real value). In other implementations, the item adjacency map may indicate an amount of time between adjacent items (e.g., an average scan time). The item adjacency map in FIG. 49 may be updated over time to include additional adjacencies, remove existing adjacencies, and/or modify distance values and scan times. The item adjacency map of FIG. 49 is only one example item adjacency map that may be generated for the items of FIG. 48.

An MSD may use the item adjacency map of FIG. 49 in order to pick the items of FIG. 48. In some cases, the MSD may have the item adjacency map included in memory. In other cases, the MSD may retrieve the item adjacency map from the CCS. The MSD may select an initial item included in the customer order using any of a variety of techniques described herein. The MSD may display items in the customer order based on the selected initial item and the item adjacency map. In some examples, the MSD determines a distance and/or a time required for a user to move between the initial item and one or more other items included in the customer order based on the item adjacency map. In these examples, the MSD then arranges some/all of the items on the display based on the determined distance and/or time. For example, the MSD may display the initial item at the top of a list and display the other items lower on the list based on the relative distances and/or times associated with the items and the initial item. The MSD may further indicate that a specific one of the items is currently adjacent to the user.

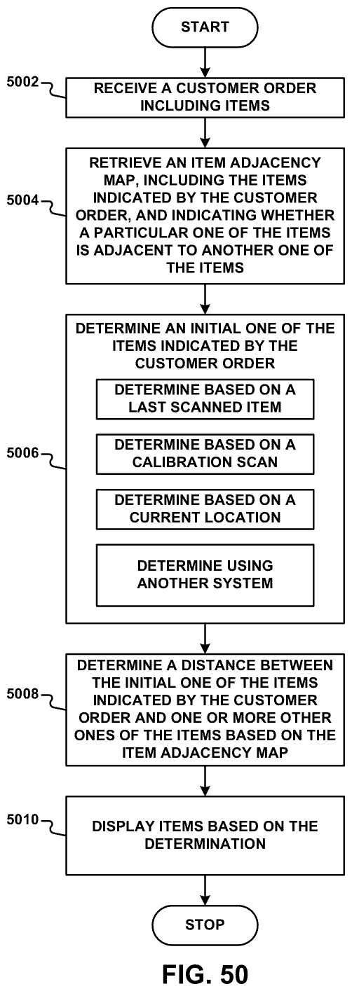

FIG. 50 depicts a method describing operation of an MSD that displays items based on an item adjacency map. In block 5002, the MSD receives a customer order including a plurality of items from the CCS. In block 5004, the MSD retrieves an item adjacency map (e.g., from MSD memory or the CCS) that includes the items of the customer order and indicates whether any items are adjacent to one another.

In block 5006, the MSD selects an initial one of the items in the customer order. In some implementations, the MSD selects the initial one of the items based on a last-scanned item. For example, the MSD may select the item in the customer order that the MSD most recently scanned as the initial one of the items, or items near the last scanned item. In other implementations, the MSD may select one of the items that is most proximate to the item that the MSD most recently scanned as the initial one of the items. For example, the MSD may determine that a particular one of the items included in the customer order is proximate to the item that the MSD most recently scanned using an item adjacency map. In other examples, the MSD may determine that a particular one of the items is proximate to the item that the MSD most recently scanned using one or more received location signals and location values determined based on the received location signals. In still other examples, the MSD may determine that a given one of the items is proximate to the most recently scanned item using other techniques (e.g., GPS/Wi-Fi location information). In other implementations, the MSD determines the initial one of the items based on a calibration scan. For example, the MSD may determine the initial one of the items based on a scan of one or more items located on one or more racks included in the store that are each proximate to the MSD. In other implementations, the MSD determines the initial one of the items based on a current location. For example, the MSD may determine the initial one of the items using one or more received location signals and location values determined based on the received location signals and/or using other techniques (e.g., GPS/Wi-Fi location information), in a similar manner as described herein.

In block 5008, the MSD determines a distance between the initially selected item and the other items in the customer order using the item adjacency map. For example, the MSD may determine whether the initially selected item is closer to a particular item in the customer order based on the item adjacency map. In other words, the MSD may determine a relative distance between the initially selected item and the other items in the customer order using the item adjacency map. In some implementations, the MSD may determine the relative distance based on single distance values and/or a sum of distance values.

In block 5010, the MSD displays the items of the customer order based on the distance determination described with reference to block 5008. As one example, the MSD may display the initially selected item at the top of a list presented to a user. In this example, the MSD may further display additional items lower within the same list based on the relative distances between the items and the initially selected item. In particular, the MSD may arrange items that are relatively closer to the initially selected item higher within the list. In a specific example, with respect to FIG. 48, an MSD near item 4804-5 may display items 4804-3, 4804-4, 4804-5, and 4804-6 higher on the display to prompt the user to pick those items due to their adjacency. Due to the item adjacency map, this may even be the case if items 4804-3 and/or 4804-4 are in different zones (e.g., associated with different location values) than item 4804-5.

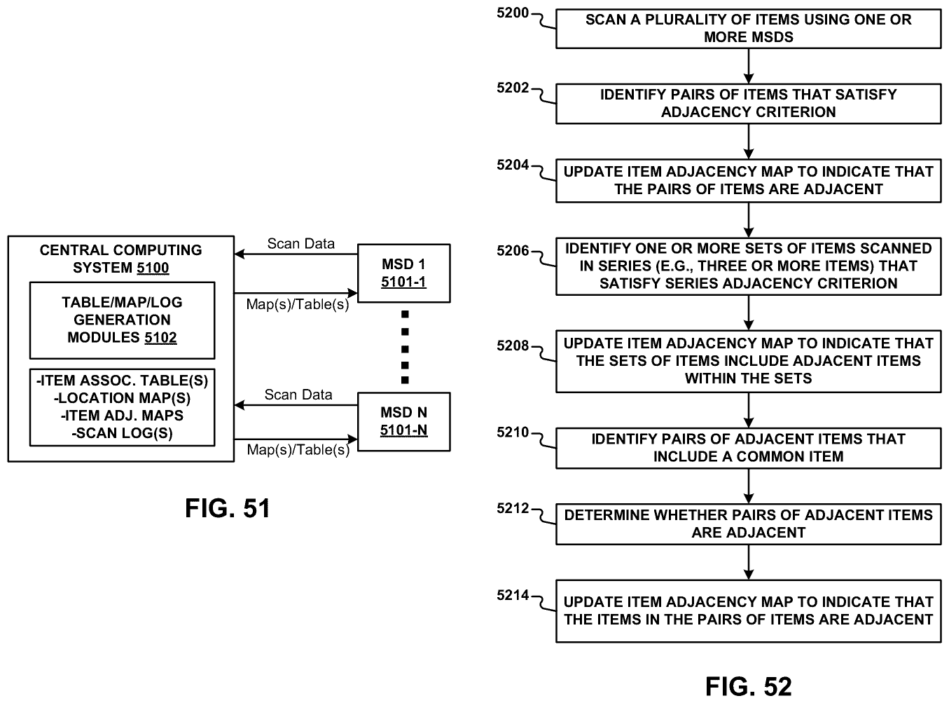

FIG. 51 illustrates an example CCS 5100 that includes data described herein. For example, the CCS 5100 may include one or more item association tables, one or more location maps, one or more item adjacency maps, and one or more scan logs. As described herein, the CCS 5100 may generate the data included in the CCS 5100 based on data (e.g., item IDs, location signals, etc.) acquired from one or more MSDs (e.g., MSDs 5101-1 to 5101-N).

The CCS 5100 may include modules 5102 that generate the tables, maps, and logs stored at the CCS 5100. For example, the CCS 5100 may include table generation modules (e.g., item association table generation modules), map generation modules (e.g., location/adjacency map modules), and/or log generation modules (e.g., scan log generation modules) that generate the tables, maps, and logs stored at the CCS 5100. The modules and data included in the CCS 5100 represent features that may be included in the CCS 5100 of the present disclosure. The modules and data described herein may be embodied by electronic hardware, software, firmware, or any combination thereof.

FIG. 51 illustrates N MSDs 5101 that provide data to the CCS 5100 that may be used to generate the item adjacency maps and scan logs. For example, each of the N MSDs provide scan data to the CCS 5100. The scan data may include, but is not limited to, item IDs, timestamps, and location values. The CCS 5100 may generate and update the scan logs and/or the item adjacency maps based on the received scan data from the N MSDs 5101. The CCS 5100 may also generate and update other data structures described herein based on the scan data, such as item association tables and location maps.

FIG. 52 illustrates an example method that describes multiple ways the CCS may determine that items are adjacent. In block 5200, one or more MSDs scan a plurality of items. For example, the MSDs may scan items for a plurality of customer orders over time (e.g., hours, days, weeks, or more). The method of FIG. 52 may be implemented in real time and/or or may be implemented using item scan data stored in a scan log. In block 5202, the CCS identifies pairs of items that satisfy adjacency criterion (e.g., scanned within a threshold time). In block 5204, the CCS updates the item adjacency map to indicate that the pairs of items are adjacent.

Blocks 5206-5208 are directed to identifying a situation where a series of scanned items are determined to be adjacent to one another. In block 5206, the CCS identifies one or more sets of items that were scanned in series. For example, the CCS may identify a series of items (e.g., 3 or more items) that were scanned in series by a single MSD. Furthermore, in block 5206, the CCS identifies one or more sets of the items scanned in series that satisfy a series adjacency criterion. An example series adjacency criterion may include a requirement that the series of items be scanned within less than a threshold period of time (e.g., a series threshold time). In this example, if multiple items (e.g., 3 or more) are scanned in less than the threshold period of time, the multiple items may be considered as adjacent to one another. For example, each of the items may be considered as adjacent to the other items. In block 5208, the CCS updates the item adjacency map to indicate that the items in the sets of items are adjacent to one another. In an example case where a set of items includes three items, the first item may be updated as adjacent to the second item and the third item, the second item may be updated as adjacent to the first and third item, and the third item may be updated as adjacent to the first and second item.

Blocks 5210-5212 are directed to identifying a situation in which items in two pairs of adjacent items that include a common item may be determined to be adjacent. This situation may arise when a single MSD scans the pairs of items at different times (e.g., different times of day, week, etc.) for different customer orders. This situation may also arise when a first MSD scans a first pair of items and a second MSD scans a second pair of items, where the first and second pairs of items include the same item. In block 5210, the CCS identifies pairs of adjacent items that include a common item. In block 5212, the CCS determines whether items in the pairs are adjacent. In one example, the CCS may determine that all items in the two pairs of items are adjacent when the sum of the scan times is less than a threshold value. For example, the CCS may determine that the three items in two pairs of adjacent items are adjacent if the sum of the scan times between the first pair of items and the second pair of items is less than a threshold value. The CCS may make the determination in block 5212 using various scan times associated with the pairs, such as the most recent scan times, average scan times, etc. In block 5214, the CCS updates the item adjacency map to indicate the items in the pairs of items are adjacent if the criteria in block 5212 are satisfied.

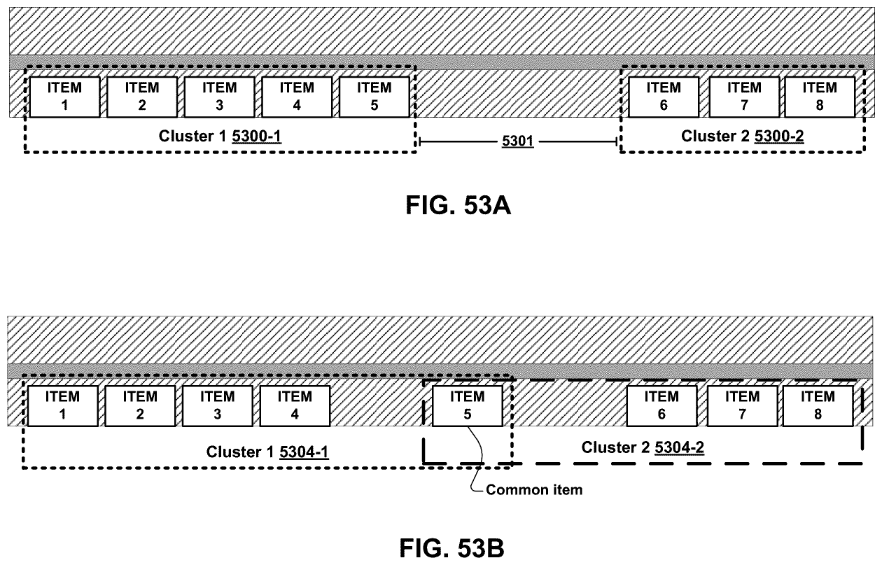

FIGS. 53A-53B illustrate example clusters of adjacent items. FIG. 53A includes a first cluster 5300-1 and a second cluster 5300-2. The first cluster 5300-1 includes five adjacent items. The second cluster 5300-2 includes three adjacent items. The two clusters 5300 are separated by some distance indicated at 5301. In some cases, the two clusters 5300 may not be considered as adjacent. In other cases, the two clusters 5300 may be considered adjacent if one of the items from the second cluster 5300-2 is scanned within a threshold amount of time after scanning an item from the first cluster 5300-1. In this case, an item adjacency map may be updated to indicate that the two clusters are adjacent (e.g., cluster identifiers may be indicated as adjacent). In some cases, when two clusters are adjacent, each item from both clusters may be considered as adjacent to one another (e.g., in a single combined cluster).

FIG. 53B illustrates an example in which two clusters 5304-1, 5304-2 include a common item (e.g., item 5). The inclusion of a common item in two clusters may indicate that the two clusters are adjacent. This scenario may arise when two previously separate clusters each add the common item at a later time. The CCS may leave the two clusters as separate data structures in some cases, but indicate that the two clusters are adjacent based on the common item. In other cases, the CCS may combine the clusters and consider the items in the clusters as being adjacent to one another (e.g., in a single cluster).

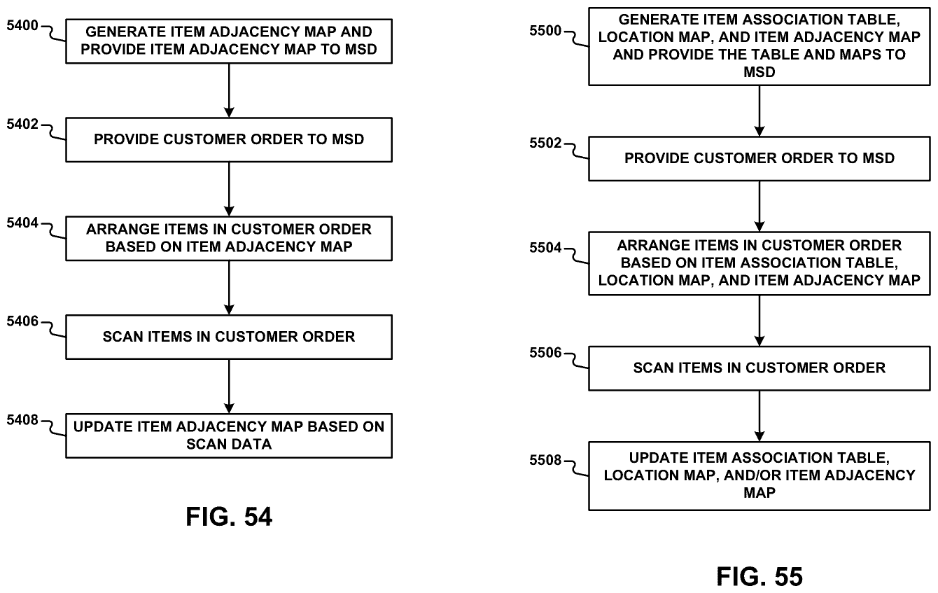

FIG. 54 illustrates a method that describes using an item adjacency map for mapping and picking items from the store. In block 5400, the CCS generates an item adjacency map for the store and provides the item adjacency map to an MSD. In block 5402, the CCS provides a customer order to the MSD for picking.

In block 5404, the MSD arranges the items in the customer order on the display based on the item adjacency map. For example, the MSD may arrange the items in a picking order that minimizes picking time by generating the picking sequence for the items based on the items' location relative to one another. In a specific example, the MSD may arrange the items so the user is mostly picking items that are subsequently adjacent to one another until the order is picked.

In some implementations, the MSD may initially arrange the items based on an assumed starting point for picking. For example, the MSD may arrange items relative to a specific/general picking starting point, such as the entry to the store, a first aisle location, or other location. In these implementations, the MSD may rearrange the items as the user moves throughout the store and/or scans items. In other cases, the MSD may not rearrange the items. Instead, the MSD may maintain the initial arrangement of items on the display, such that the customer order is presented as a fixed sequential list of items. The MSD may also initially arrange and/or rearrange items based on a determined location.

In block 5406, the user moves through the store picking and scanning items in the customer order. In block 5408, the CCS may update the item adjacency map based on scan data received from the MSD. In some cases, the MSD or other scanning device may scan items on the shelf that are not included in the customer order. For example, an MSD or other scanning device (e.g., robotic, attached to the cart or user, etc.) may scan items, scan readable location indicators, and/or pick up location signals for the purposes of updating the item association table, location map, and/or item adjacency map.

FIG. 55 illustrates a method that describes using an item association table, location map, and item adjacency map for mapping and picking items from the store. In block 5500, the CCS generates an item association table, location map, and item adjacency map for the store, and then provides the table and maps to an MSD. In block 5502, the CCS provides a customer order to the MSD for picking.

In block 5504, the MSD arranges the items in the customer order on the display based on the item association table, location map, and item adjacency map. In some implementations, the MSD may be configured to determine an initial arrangement of items based on the user's location, as determined by the location map and/or item association table. The MSD may then further arrange the items within the location using the item adjacency map. The additional arrangement based on item adjacency may arrange the items for more efficient picking in the case that a location indicator/signal covers a large number of items. For example, if a location indicator covers an entire aisle of items, the item adjacency map may define more granular arrangements of items on the display. Alternatively, in some cases, the MSD may arrange items based on item adjacency first and then based on location.

In block 5506, the user moves through the store picking and scanning items in the customer order. In block 5508, the CCS may update the item association table, the location map, and/or the item adjacency map based on scan data received from the MSD. As described herein, an MSD may generate an initial arrangement of items for one or more customer orders upon receiving the one or more customer orders. Subsequently, the MSD may rearrange the items on the display based on user movement/picking. Although an MSD may rearrange items based on a current location (or other data), in some implementations, the MSD may maintain the initial arrangement of items on the display (e.g., not rearrange the items). For example, the MSD may present the customer orders as a fixed sequential list of items.

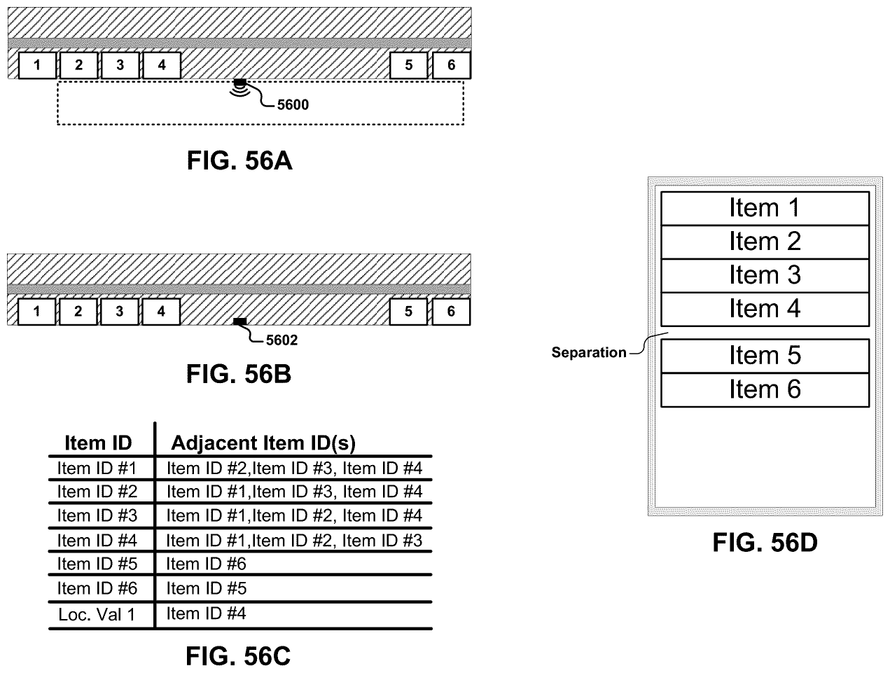

FIGS. 56A-56D illustrate examples of a store that implements both location indicators and item adjacency mapping. FIGS. 56A-56B both include six items (e.g., items 1-6). FIG. 56C illustrates an item adjacency map that indicates items 1-4 are adjacent to one another and items 5-6 are adjacent to each other. The item adjacency map also includes a location value (Loc. Val 1) associated with a location indicator 5600 that emits a location signal (e.g., FIG. 56A) or a readable location indicator 5602 (e.g., FIG. 56B).

FIG. 56A illustrates how location indicators and item adjacency may be implemented to better arrange items for picking. In FIG. 56A, the location indicator 5600 emits a location signal that covers items 2-6, but not item 1. Accordingly, item 1 may not be associated with a location value in some cases. However, if item adjacency is used, the MSD may determine that item 1 is near items 2-4. Also, using item adjacency, the MSD may determine that items 1-4 are grouped together and items 5-6 are grouped together.

FIG. 56B illustrates how a readable location indicator 5602 and item adjacency may be implemented to better arrange items for picking. In FIG. 56B, the readable location indicator 5602 may be associated with items 1-6, or some of items 1-6. In this case, however, if item adjacency is used, the MSD may also determine that items 1-4 are grouped together and that items 5-6 are grouped together.

FIG. 56D illustrates how item adjacency can be used to arrange customer items on a display. The MSD displays adjacent items as being grouped. For example, items 1-4 and items 5-6 are grouped. The groups of items are also separated on the display to indicate that the physical groups of items are separated from one another (e.g., determined based on adjacency). The separation is illustrated as a gap between the item groups. In some implementations, the MSD may display the groupings in a different manner. For example, the groupings may be rendered in different colors, text (e.g., font/bold/underlining), etc. In cases where item adjacency is not used, the MSD may group items together that are associated with the same locations.

Note that the item adjacency map of FIG. 56C includes data that indicates the adjacency of a location indicator (e.g., location value) to an item. The adjacency of a location indicator relative to items may be determined in a variety of ways, depending on the type of location indicator used. With respect to readable location indicators, the CCS may generate the item association table by treating the readable location indicator as though the readable location indicator is an item ID for purposes of the item adjacency map. With respect to a location indicator that emits a location signal, the MSD may generate the adjacency map based on a location of the location indicator relative to the items. The MSD may make the determination of proximity to the location indicator in a variety of ways, depending on the type of location indicator. In some implementations, the MSD may determine the proximity based on the strength of the location signal.

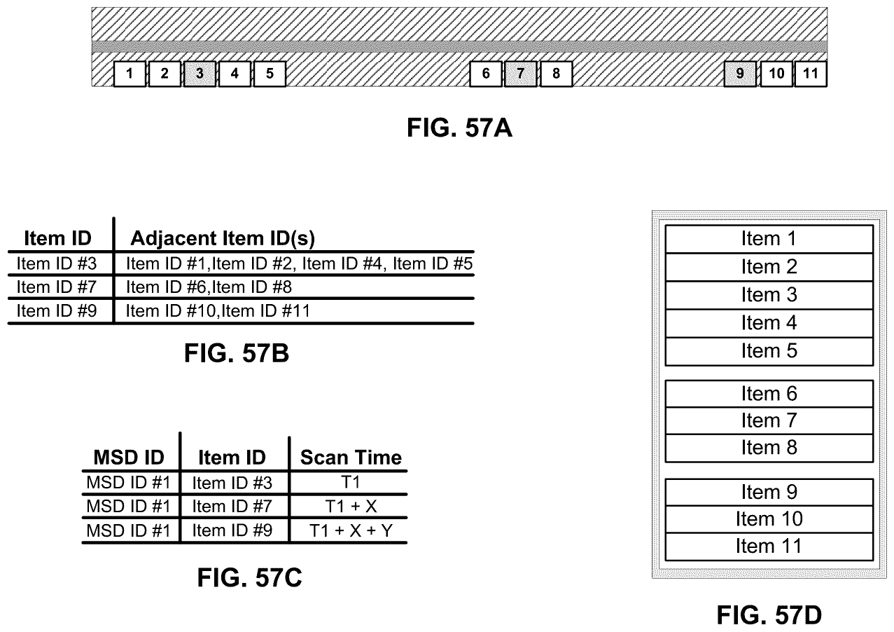

FIGS. 57A-57D illustrate the use of a scan log to determine item adjacency and directionality in a store. The item adjacency and directionality may be used to map items in a store. The maps based on item adjacency and directionality may allow the MSD to provide the user with a more efficient picking route. In FIG. 57A, items 1-5 are adjacent, items 6-8 are adjacent, and items 9-11 are adjacent. The three separate clusters in FIG. 57A are not adjacent to one another. The adjacency between the items may have been determined based on scan logs provided by one or more MSDs that picked one or more customer orders. FIG. 57B illustrates a partial item adjacency map that indicates the adjacencies in FIG. 57A.

FIG. 57C illustrates example scan log data that indicates a single MSD had scanned items 3, 7, and 9 in sequence. Specifically, the items were scanned at time T1, subsequent time T1+X (e.g., X seconds after T1), and further subsequent time T1+X+Y (e.g., Y seconds after T1+X). Although the sequential scan of items 3, 7, and 9 may not indicate adjacency of the items, the sequential scan times may indicate a physical location (e.g., arrangement) of items 3, 7, and 9 relative to one another. For example, the sequential scan times may indicate that items 3, 7, and 9 may be picked in a sequence (e.g., a linear sequence where item 7 is in the middle). Although a sequence of only 3 items are shown in the scan log, a scan log may include a much longer sequence of items (e.g., greater than 3 items) that indicate the relative location of a sequence of items to one another. Note that items 3, 7, and 9 are shaded for illustration purposes in FIG. 57A.

In FIG. 57D, it may be assumed that the MSD has received a customer order including items 1-11 of FIG. 57A. The MSD groups the adjacent items into different groups on the display based on adjacency. Additionally, the MSD arranges the groups of items based on the sequence data, with the items adjacent to item 7 displayed in the middle of the groups. The arrangement of the groups in FIG. 57D may be determined based on an assumed or determined starting point of the picker (e.g., near items 1-5) in a variety of ways described herein. If the picker were to start picking from the group of items 9-11, the groups may be rearranged on the display such that the bottom group of items 9-11 is switched with the top group of items 1-5.

Although the data used to generate the item association tables, location maps, and item adjacency maps may be acquired from MSDs, in some implementations, the data may be acquired by other computing devices, such as an automatic scanning and/or picking device (e.g., a robotic device that moves throughout the store). For example, a robotic device may scan items, acquire location signals, and/or scan location indicators. In some implementations, the robotic device may send the acquired data to the CCS for processing. The robotic device and/or the CCS may generate the tables and maps described herein based on the acquired data. The maps may then be used to arrange items for picking by MSDs and/or CCDs.

The CCS may include one or more store maps. The CCS may generate different types of maps in a variety of different ways. In some implementations, the CCS may generate a location map that includes a plurality of zones that are associated with location indicators, such as readable location indicators and/or location indicators that transmit location signals. In some implementations, the CCS may generate item adjacency maps that include a list of items and indicate which items are adjacent to one another.

In some implementations, the CCS may generate store maps based on images acquired by one or more image capture devices (e.g., cameras). For example, the CCS may generate store maps based on images acquired by cameras that are included on, or interface with, store MSDs, third-party MSDs, and/or CCDs. The cameras may also be included on other objects, such as shopping carts, baskets, or other item carriers. Additionally, or alternatively, the CCS may generate store maps based on images acquired from robotic devices that are configured to move throughout the store and acquire images.

In some implementations, as described above, the CCS may generate store maps based on images including readable codes (e.g., readable location indicators). For example, the MSDs may include a camera and associated image processing electronics/software for interpreting the readable codes. In this example, the CCS/MSDs may acquire images and identify one or more readable codes in the images. The CCS may generate a store map based on the location of the readable codes relative to one another. Example store maps including readable codes are included in FIGS. 20A-20B.

In some implementations, the CCS may generate item adjacency maps based on images captured by MSDs and/or other devices. For example, the CCS may identify items in the images based on item IDs (e.g., barcodes) on the items and/or by identifying other item properties in the images, such as text, size, shape, colors, etc.

In some implementations, the CCS may generate maps that include store objects or other acquired image data. Example store objects may include, but are not limited to, signs, text, racks, floor patterns, etc. In these implementations, the CCS may generate maps that indicate the location of store objects in the store. For example, a map may indicate the relative locations of different store objects to one another and/or other location indicators/items. In some implementations, maps generated using images may be referred to herein as “image-based maps.”

In some implementations, the CCS may generate maps that include GPS location values (e.g., GPS coordinates). For example, MSDs/CCDs may include GPS receivers that determine a current GPS location associated with the MSD/CCD. As another example, the CCS may generate maps that include Wi-Fi-based location values determined by the MSD/CCD (e.g., a Wi-Fi radio receiver) based on Wi-Fi signals acquired inside/outside the store.

The CCS may generate one or more maps based on any of the mapping technologies described herein. In some implementations, the CCS may generate and use different types of maps that each include different types of locations. For example, the CCS may generate and use different types of maps independently from one another. In a specific example, a CCS may include separate maps for readable location indicators, location indicators that transmit signals, and store objects. In some implementations, the CCS may generate one or more maps that include a mix of different location types. For example, the CCS may merge one or more maps. In a specific example, the CCS may include a map that includes locations based on readable location indicators, location indicators that transmit signals, and store objects. In another specific example, item adjacency maps based on item scan times may be merged with item adjacency maps generated based on images.

The CCS may store item association data (e.g., item association tables) that associates items with locations (e.g., items with nearby locations). For example, an item association table may include items and their associated zones determined based on readable location indicators. As another example, an item association table may include items and their associated zones determined based on location indicators that transmit location signals. As another example, an item association table may include items and one or more associated store objects.

In some implementations, the CCS may store different item association tables for different types of mapping technologies. For example, the CCS may store different item association tables for item associations between readable location indicators and store objects. In some implementations, the CCS may merge item association data for different mapping technologies. For example, an item association table may include each location associated with an item. In a specific example, for a single item, an item association table may include location values for a readable location indicator associated with the single item and a store object associated with a single item.

The maps described herein may indicate a physical layout of the store with respect to the mapping technology used by the store. For example, a map may indicate the relative location of different location indicators, store objects, and/or items (e.g., item adjacencies). The item association data may indicate a location of an item relative to a map location (e.g., a location indicator, store object, etc.). For example, an item association table may indicate a location of an item relative to one or more location indicators and/or one or more store objects.

In some implementations, the item association data may be separate from map data. Although the maps and item association data may be described as separate data structures, in some implementations, the item association data may be merged with map data to different extents. Using different types of map data and/or item association data acquired in a variety of different manners may provide the CCS with a more complete picture of the store layout and/or item locations. For example, using one or more maps and one or more item association tables, the CCS may determine the location of items relative to one or more locations and/or one or more other items.

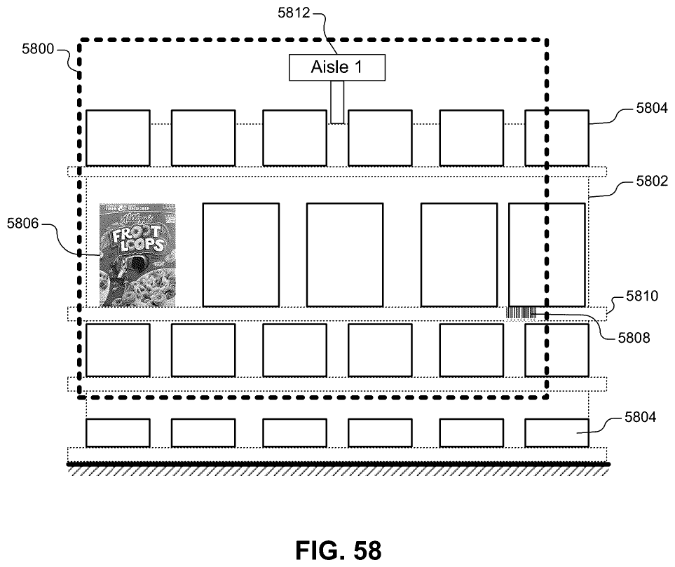

FIGS. 58-70C describe acquiring images (e.g., using one or more MSDs), processing the images (e.g., at the MSDs and/or the CCS), and using the images in a variety of ways, such as mapping the store, assisting a user/customer in picking items using MSD(s), generating store inventory, and/or generating advertisements to customers. In some implementations, the systems and methods of FIGS. 58-68B can be used to strengthen other types of location mapping (e.g., using location indicators) and/or item adjacency mapping. In some implementations, the systems and methods of FIGS. 58-68B may be used in place of other types of location mapping and item adjacency mapping. For example, the OFS may generate maps based on the images (e.g., image-based maps) and use the generated maps for subsequent picking.

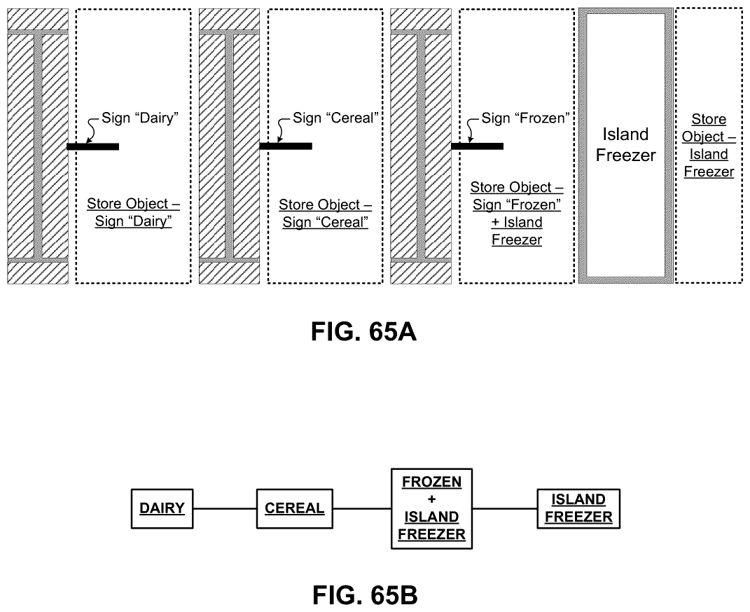

Images may include readable location indicators, item indicators, items (e.g., text/graphics on item packages), and store objects (e.g., signs, racks, aisles, checkout areas, etc.) that may be detected by the OFS. Using the images, the OFS of the present disclosure can generate and/or update tables/maps, such as item association tables, location maps, and item adjacency maps. Additionally, the OFS of the present disclosure can generate image-based maps/tables. Image-based maps may include similar data as other tables/maps described above, although the data for the maps may be acquired in a different manner (e.g., using image analysis). Additionally, or alternatively, image-based maps may include maps based on the location of store objects relative to items (e.g., see FIG. 58 and FIG. 65A).

The maps generated by the OFS can be used for arranging items during picking. For example, the MSDs may use the tables/maps described above for arranging items (e.g., according to distance from the MSD). In some implementations, an MSD may acquire images during picking and arrange items on the display based on the acquired images. For example, an MSD may acquire an image including item/location indicators and/or store objects, determine a location based on the image (e.g., a current location), and arrange items on the display based on the determined location. In some implementations, the MSD or CCS may arrange the items on the display based on the determined location and the locations of the items relative to the determined location.

In some implementations, a store can be mapped using only image-based maps. In these cases, the MSDs may arrange items during picking based on images acquired by the MSDs, location indicators, and/or other technologies described herein. In some implementations, a store can be mapped using image-based maps and other maps/tables. In these cases, MSDs may arrange items during picking based on images acquired by the MSDs, location indicators, and/or other technologies described herein. In some implementations, maps and tables described herein may include similar information regarding the locations of items relative to one another and relative to other location indicators, store objects, etc. As such, in some implementations, one or more maps and tables described herein may be generated based on data included in one or more other maps and tables.

An MSD (or other device) may include and/or interface with one or more image capture devices, referred to herein as cameras. The cameras may acquire images/video inside or outside of the store. In some implementations, a video may include a time series of images that may be analyzed (e.g., frame-by-frame or at different points in time) as described herein.

In some implementations, an MSD can include one or more cameras. For example, cameras can be included as part of the MSD (e.g., enclosed within or fixed to the MSD housing). Additionally, or alternatively, the cameras can be connected to the MSD in another manner, such as connected via a cord (e.g., a cord that provides communication with other components of the MSD). In some implementations, the one or more cameras may be separate from the MSDs. In these implementations, the cameras may be in wireless communication with the MSD (e.g., via Wi-Fi or BLUETOOTH) and/or the CCS.

In some implementations, the MSDs may process the images locally. Additionally, or alternatively, the MSDs may transmit images/videos to the CCS for processing. In some implementations, the cameras (e.g., separate from the MSD) can send images/video to the CCS for processing. Processing the images may include a variety of operations, including, but not limited to, identifying items in images (e.g., text, graphics, colors, etc.), identifying readable location indicators, and/or identifying store objects. The CCS and/or MSDs can update one or more maps based on the processed images. The CCS and/or MSDs may also determine their location in the store based on the processed images.

The acquired images/video along with additional data associated with the images/video may be referred to herein generally as “image data.” Image data can include images/video along with additional data (e.g., image metadata). Example additional data may include image timing data indicating when the image/video was acquired. For example, image timing data may include a timestamp indicating a time when the image was captured and/or may indicate a relative time that indicates a time when the image was captured in relation to other images captured by the camera over a logical period of time (e.g., during a pick). Additional data may also include image location data that indicates a location where the image/video was acquired, such as a location of the camera and/or MSD when the image was acquired. Example image location data may include a GPS location, Wi-Fi location (e.g., triangulated location), location indicator values, and/or a list of nearby items. Additional data may also include image orientation data that indicates the orientation of the camera that acquired the image/video, such as the height of the camera and/or the angle of the camera (e.g., relative to the floor/ground). The additional data may also include image identification data, such as an MSD identifier (i.e., MSD ID) (e.g., that uniquely identifies the MSD) and/or a camera ID (e.g., that uniquely identifies the camera). Note that an MSD may include one or more cameras. As such, a single MSD ID may be associated with multiple camera IDs. In some implementations, cameras may be operated independently from MSDs. For example, cameras may be included on shopping carts, a robotic mapping device (e.g., a robot that roams the store and maps the store by taking images), or in fixed locations. In these implementations, the camera IDs may not be associated with MSD IDs.

Image data may also include data generated as a result of processing the image/video. For example, image data may include a list of one or more items included in the image/video (e.g., items that are captured/depicted in the image/video). As another example, the image data may include data associated with items, such as data extracted from images of the items, such as text on a box, graphics on a box, barcodes on a box, etc. As another example, the image data may include one or more store objects and associated store object names (e.g., depicted in an image). For example, the image data may indicate a store object type (e.g., sign, cooler, and/or floor pattern) and associated data (e.g., a sign name, cooler type, and/or floor pattern color/material). In some implementations, the store image data may also include a store object ID number determined for, or associated with, the store object. The image data may include relative item location data in the image, such as whether the item is next to another item (e.g., left/right/above/below). In some implementations, the images and/or additional image data may be stored along with image-based maps and item association tables generated based on the images.

In some implementations, the MSDs/cameras may transmit image data to the CCS for processing. For example, the MSDs may transmit images to the CCS, which may then identify items, item indicators, store objects, etc., in the images. In some implementations the MSDs may process images and send image data to the CCS for further processing and/or storage.

FIG. 58 illustrates an example of an image 5800 taken of a rack 5802 that includes a plurality of items 5804. The image may have been acquired by a camera in any manner described herein (e.g., attached to an MSD, cart, robotic device, or other object). The captured image is illustrated as a rectangular broken line. The captured image depicts a plurality of items 5804 (e.g., boxes) that are included on a rack 5802. For example, the image depicts, inter alia, a box of FROOT LOOPS 5806, a location indicator 5808 (e.g., a barcode) attached to a shelf 5810, and an aisle sign 5812 including text (e.g., an aisle name and/or number). The example aisle sign text in FIG. 58 is “Aisle 1.” In some implementations, the CCS/MSD may identify the aisle sign and/or text as a store object for mapping and/or location determination. For example, the CCS/MSD may process the image to identify the aisle sign and may further process the sign text to determine that the image was captured in “Aisle 1.” In this example, the CCS/MSD may then associate the image with Aisle 1 and may further associate a location of the cereal box with the location of “Aisle 1.” Although the aisle sign 5812 is illustrated as above the rack 5802 and facing across an aisle, the aisle sign may be located in a variety of locations (e.g., overhanging the aisle, in the aisle, at the end cap of the aisle, etc.) and oriented in a variety of other orientations (e.g., facing down the aisle).

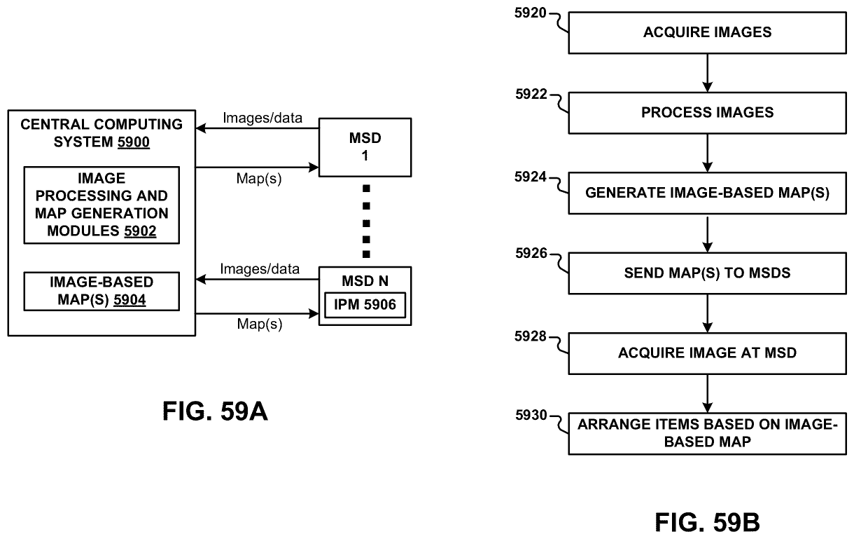

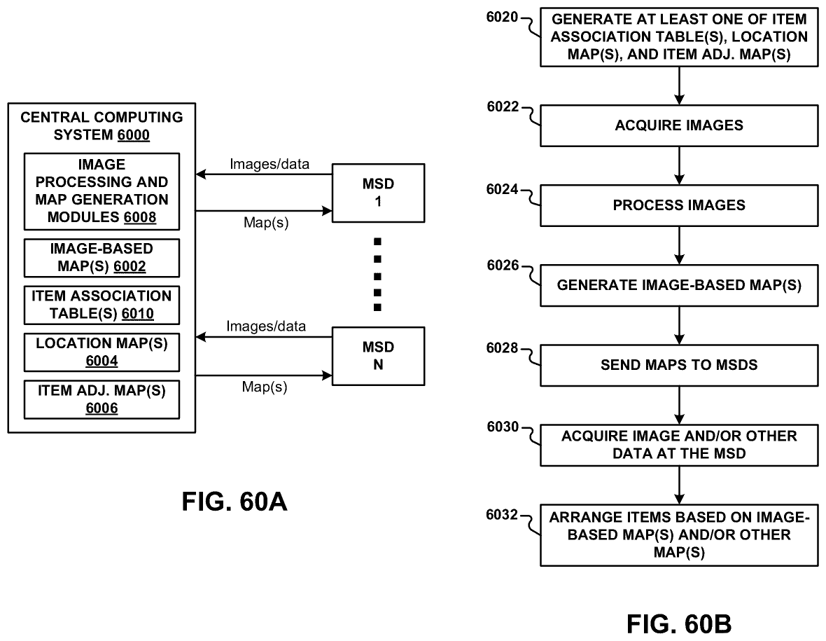

FIGS. 59A-60B describe communication between MSDs and the CCS with respect to generating image-based maps and/or picking items based on acquired images, according to some implementations of the present disclosure. In the example implementation of FIG. 59A, a plurality of MSDs (1-N) may acquire and, in some implementations, may process images. The MSDs transmit the images and/or image data to the CCS 5900. The CCS 5900 may include an image processing system, which may include image processing and map generation modules 5902 that generate the image-based maps 5904. The CCS 5900 may then transmit the image-based map(s) to the MSDs for use in picking. Although a CCS may include an image processing system, the image processing system may be operated by other parties as a service to the CCS (e.g., as a remote server).

In the example of FIG. 59A, an image processing module 5902 may receive an image and may execute one or more image processing techniques to identify and classify one or more objects depicted in the image. In some implementations, an image processing module 5902 may identify one or more blobs (which may or may not be specific shapes) in the image and may extract a set of features of the extracted blobs from the image. The image processing module 5902 may feed the set of features to one or more machine-learned image classification models, which respectively output a classification of the blob based on the set of features. In some implementations, the image classification models may be trained in a supervised, unsupervised, or semi-supervised manner. In some implementations, the machine-learned image classification models may be trained using labeled training images of items (e.g., images that are used to depict an available inventory on a consumer facing application that is accessed using a CCD) or other objects that appear in a store. In these implementations, the images may include one or more labels that respectively indicate items and/or objects depicted in the image. Additionally, or alternatively, a human user may capture images of a store and may apply labels to any items or other objects that are identified in the image. For example, the user may be prompted to apply a label to an object that is identified in an image and/or may be prompted to confirm or deny a classification of the object. In these example implementations, the image classification model(s) may be trained to classify objects that appear in store settings, such as items that are sold in stores, location indicators (e.g., bar codes or QR-codes), and/or store objects commonly seen in stores (e.g., freezers, aisle signs, deli counters, and the like). Image classification models may be trained in additional or alternative manners.

In some implementations, a machine learned image classification model may be trained to identify objects in images regardless of the store or environment in which images are captured. For example, image classification models may be trained to identify specific types or brands of items in a store and/or other commonly observed objects in different stores. Additionally, or alternatively, image classification models may be trained to identify objects in a specific store or set of stores. For example, image classification models may be trained to classify specific signages that appear in a store or set of stores, items that are only stocked in the specific store or set of stores (e.g., generic store brands), or the like.

In some implementations, MSDs/CCDs may include image processing modules (e.g., IPM 5906) that process images. An image processing module of an MSD (or of a CCS processing an image on behalf of an MSD) may leverage store-specific image classification models and/or store-agnostic image classification models to classify objects depicted in one or more images when operating in a mapping mode and/or a picking/scanning mode. For example, in some implementations an image processing module 5902, 5906 may receive a captured image and may identify one or more objects in the image (e.g., using blob detection techniques). The image processing module 5902, 5906 may then extract features of the detected object(s) and may attempt to obtain a classification of the object(s) based on the features thereof. Assuming the image processing module classifies at least one object (e.g., with a sufficient confidence score in a classification of the object), the image classifications of the one or more objects may be output to a map generation module 5902, depending on whether the image processing module is being used in connection with a mapping mode or a picking/scanning mode.

In some implementations, the image processing module 5902, 5906 may be configured to perform optical character recognition (OCR). In these implementations, the image processing module may identify objects of interest containing text, such as signs or stocked items, and may perform OCR on the image in the objects of interest.

In some implementations, the image processing module may be configured to process an image to identify scannable location indicators (e.g., bar codes and/or QR codes). In these implementations, the image processing module may identify and classify a scannable location indicator. In response to classifying a scannable location indicator, the image processing module may read the scannable location indicator, which may be used to determine an approximate location of the MSD (e.g., as described above).

In some implementations, a map generation module 5902 receives one or more classifications of one or more respective items identified in an image and/or additional image data (or “image metadata”) and generates/updates an image-based map 5904 based on the image classifications. In some implementations, the additional image data includes location data that indicates a location at which the image was captured. For example, the location data may include geocoordinates (e.g., GPS coordinates) of the MSD when the image was captured or a relative location defined with respect to the store in which the image was captured. In the latter scenarios, the location data may be determined by the MSD using any suitable techniques. For example, in some implementations, the MSD may detect one or more location indicators (e.g., RFID signals, BLUETOOTH signals, barcodes, QR-codes, or the like) that are in the vicinity of the MSD when the image was captured and may determine the location data based on the location indicators that were detected by the MSD when the image was captured. In response to receiving the image classification(s) and/or the corresponding location data, the map generation module 5902 may associate the image classification(s) with a location indicated by the location data in an image-based map. In some implementations, the map generation module 5902 may generate the image-based map to indicate locations of items and/or store objects with respect to one another. For example, if a first brand of cereal and a second brand of cereal are classified in the same image (e.g., they are both on the same rack), the map generation module may indicate an adjacency between the first and second brand of cereal in the image-based map. In this example, the next image captured by the MSD may include an image of the second brand of cereal and a third brand of cereal, but not the first brand. In this example, the map generation module may indicate an adjacency between the second and third brand of cereal and may further infer that the second brand of cereal is found in between the first and third brand of cereal.

In some implementations, an MSD may include an image processing module 5906 that classifies images. In these implementations, the MSD may implement a set of machine-learned image classification models stored thereon that the MSD uses to perform image classification. In these implementations, the MSD may classify objects depicted in images captured by the MSD without any input from the CCS. In these implementations, the MSD may capture an image and may identify and classify one or more objects in the image based on the image classification model(s). The MSD may then determine a relative location of the MSD in the store based on the identified object and a map of the store. In some implementations, the image classification models may be occasionally updated (e.g., by the CCS). For example, the image classification model(s) of an MSD may be updated when new items or objects are identified. In some implementations, the image classification models used by the MSD when the MSD is in a “picking” mode may be trained to identify a reduced subset of the items in the store. For example, instead of being trained to classify all different brands of cereal boxes, the MSD may receive one or more image classification models that are trained to identify four or five bands of cereal boxes. Similarly, instead of being trained to classify all fruits and vegetables, the MSD may receive one or more image classification models that are trained to identify certain objects in the fruits and vegetable section of a store. In these examples, the locations of the reduced subset of items may be defined in a location index (e.g., a map and/or an item association table).

In some implementations, the user of the MSD is assigned to pick items in a certain area or section of the store. In some of these implementations, the MSD may receive one or more image classification models that are trained to classify objects appearing in the certain area or section, rather than image classification models that collectively classify objects appearing across the entire store. In some of these implementations, the image classification models may be partitioned according to areas/sections of the store (e.g., according to a layout of the store), such that an image processing module of the MSD only receives and/or leverages partitions of an image classification model corresponding to the area/section of the store in which the user is picking. For example, in some implementations, an MSD may request an image classification model from the CCS that indicates a section of a store in which the MSD is used to pick items, such that the request may indicate one or more sections of the store and/or a set of items that are to be picked using the MSD. In these example implementations, the CCS may identify the partitions of the image classification model corresponding to the sections of the store indicated by the request and may provide the retrieved partitions of the image classification model (or identifiers thereof) to the requesting MSD, such that the requesting MSD uses the partitions of the image classification model to perform image-based location services with respect to the store while picking the set of items that are to be picked. In this way, the computational resources required to perform image classification may be reduced, as image classification that leverages only some partitions of an image classification model requires fewer processing operations than image classification that leverages the entire image classification model. As the MSD may perform image classification many times during a pick, this reduction in computational resources may extend the battery life of the MSDs.

In some implementations, an MSD does not include image classification capabilities. In these implementations, the MSD may capture an image and may transmit the image and any suitable metadata to the CCS. In response, the CCS may perform the image classification on behalf of the MSD to classify the object(s) appearing in the image. In some implementations, the CCS may provide the MSD with an updated map of a store. For example, the CCS may provide an updated map when the location of one or more items is changed and/or when a new item is added to the map.

FIG. 59B illustrates an example method that describes the generation and usage of image-based maps. It is appreciated that in different implementations, the method may be performed by the CCS, one or more MSDs, or a combination thereof. Although the method includes both generation of image-based maps and usage of image-based maps (e.g., for picking), in some implementations, image-maps may be generated and used at separate times and by separate parties (e.g., customers, third-party pickers, etc.).

In block 5920, one or more MSDs acquire images in the store. In some implementations, the MSDs may be configured to operate in a mapping mode, whereby the MSDs are capturing images specifically for purposes of generating image-based maps. In block 5922, the one or more MSDs and/or the CCS process the images. In block 5924, the CCS generates one or more image-based maps. In block 5926, the CCS sends the image-based map(s) to the MSDs. In block 5928, an MSD used to pick orders acquires an image in the store. In block 5930, the MSD arranges ordered items on the display based on the acquired image and the image-based map(s). As described above, the acquisition of images and generation of maps in blocks 5920-5924 may be implemented while the MSDs are in a mapping-specific mode and/or while picking items for customer orders.

FIGS. 60A-60B illustrate a CCS 6000 that generates image-based maps 6002 along with other types of maps 6004, 6006. In FIG. 60A, the MSDs (1-N) may acquire and process images. Although not illustrated, the MSDs may also acquire other data used to generate tables/maps described herein. The MSDs transmit the images and/or image data to the CCS. The CCS may include image processing and map generation modules 6008 that generate the maps/tables described herein, such as image-based maps 6002, item association tables 6010, location maps 6004, and item adjacency maps 6006. The CCS 6000 sends the generated maps/tables to the MSDs for picking or other operations.

FIG. 60B illustrates an example method that describes the generation and usage of a plurality of maps. In block 6020, the CCS generates one or more item association tables, one or more location maps, and one or more item adjacency maps (e.g., based on data received from a plurality of MSDs). In block 6022, one or more MSDs acquire images in the store. In block 6024, the one or more MSDs and/or the CCS process the images. In block 6026, the CCS generates one or more image-based maps. In block 6028, the CCS sends the generated maps to the MSDs. In block 6030, an MSD picking items acquires an image and/or other data (e.g., location signals, recently scanned items, etc.) that may be used to identify a location in any of the maps/tables. In block 6032, the MSD arranges ordered items on the display based on one or more image-based maps and/or other maps.

The MSD may have a handheld form factor. In some implementations, the user can carry the MSD and/or wear the MSD. In some implementations, the user can carry and/or wear the cameras that are additional to the MSD. In these implementations, the MSD may include multiple separate components (e.g., cameras separated from the display and other components). In the case of a wearable device, such as a head mounted display, the camera can capture images in the direction the user is looking.

The one or more cameras can acquire images while being moved throughout the store. In some cases, the cameras can automatically acquire images (e.g., constantly, intermittently, or upon detecting movement via GPS, acceleration, or other detected parameter). In some implementations, the cameras may be configured to capture images/video in response to user input, such as a user powering on the camera and/or interacting with a manual input (e.g., on/off button or trigger) to acquire the images/video.

In some implementations, the MSD and/or the camera(s) can be connected to a cart (e.g., shopping cart or other type of cart) and moved around the store by the user (e.g., an employee or customer). For example, if the camera(s) are included as part of the MSD, the MSD and cameras may be attached to the cart as a single unit. In some implementations, the MSD/cameras may be attachable and removable from the cart. For example, the MSD may clamp to the cart or hang on the cart. In these implementations, the user may attach/remove the MSD from the cart by hand (e.g., by manipulating a mechanism, such as a clamp or set screw).

In other implementations, the MSD and camera(s) may be more permanently attached to the cart. For example, the MSD and/or cameras may be screwed/bolted to the cart and/or integrated into portions of the cart. In these implementations, the MSD and/or cameras may not be easily removable by hand. In some implementations, the user may carry a portion of the MSD/camera(s) and a portion of the MSD/camera(s) may be attached to the cart. For example, the user may carry a portion of the MSD including a display and item scanner (e.g., scanning module), while one or more cameras and other portions of the MSD (e.g., a location detection module) are attached to the cart. Accordingly, as described herein, the user may carry/wear the MSD/camera(s) and/or attach the MSD/camera(s) to the cart in a variety of different configurations. In some implementations, cameras may be attached to carts that are moved throughout the store by store customers. In these implementations, the CCS may acquire image data while customers shop.

The camera properties can be selected and configured for operation in the appropriate environment (e.g., a grocery store, factory, warehouse, etc.). For example, the camera field of view, focus/autofocus, resolution, and image capture rate (e.g., framerate) can be selected according to the environment. If the cameras are implemented in a store, the cameras can be configured to capture images of items in a store with a field of view and focus/autofocus that captures items on the racks. For example, the cameras can be configured to capture images including multiple shelves of racks at a usual distance from the racks (e.g., on the order of inches or feet). In some implementations, cameras can include distance determination features, such as software distance detection (e.g., based on location indicator sizes) and/or range finding hardware (e.g., Lidar) for determining the distance of cameras from items/racks/location indicators. The distance detection can be used for focus and/or to determine whether the user is close to the items/racks in the image. The cameras may have similar functionality (e.g., field of view, resolution) or different functionality. In some implementations, cameras may be configured to capture one or more spectrums of light (e.g., the visible spectrum, infrared spectrum, etc.). In some implementations, cameras may scan an area (e.g., by rotating on one or more axis, such as 180-360 degrees).

The cameras can be configured to acquire images of the items on the racks. The one or more cameras can be configured to acquire images in one or more directions. For example, the cameras can be arranged to acquire images at different angles around the user and cart, such as to the left, right, and/or front of the user/cart. As another example, the cameras may be arranged to acquire images at different angles relative to the floor/cart, such as toward the floor, parallel to the floor, and/or away from the floor (e.g., toward the ceiling). In some implementations, some cameras can be configured to have overlapping fields of view so that portions of images from each camera include similar items. In some implementations, some cameras can be configured to have fields of view that do not overlap (e.g., do not include the same items at the same time). For example, the cameras attached to the MSD, user, and/or the cart can be pointed outward toward the items as the user moves throughout the store. In a specific example, if the MSD is attached to the cart, the display may face the user while the camera(s) point toward items when the cart is being pushed around the store. In this specific example, the camera(s) may point away from the user and toward the items, such as to the left/right/front of the cart as the cart is being pushed throughout the store.

Although the cameras may be configured to point towards items and location indicators on racks, the cameras may be pointed in different directions at different portions of the store, such as the floor and/or the ceiling. In these implementations, the cameras may capture location indicators on the floor, above the items, and/or positioned above the users (e.g., attached to the ceiling). The cameras may also capture images of store objects.

A camera can be configured to acquire distinct images (e.g., separated in time) and/or acquire images from a video feed. The timing between distinct images/captures may be set or configured by the MSD operator. In implementations where multiple cameras are used, the multiple cameras may be configured to acquire images at the same time, or at different times. Images can be taken in sequence as a video and/or with set time divisions (e.g., fractions of a second up to seconds).

As described herein, in some implementations, the MSDs can include one or more components (“MSD components”) that may be attached to a cart and/or carried/worn by the user. In some implementations, carts may include hardware/software for mapping stores and/or determining locations. For example, carts may include location signal detection components, one or more barcode scanners for scanning item IDs and location indicators, and/or one or more cameras. The carts may also include communication components, such as wired (e.g., USB) and/or wireless communication components (e.g., BLUETOOTH) that may communicate with various computing devices. For example, the components included on the cart may communicate with MSDs used by store employees and/or third-party pickers. In these cases, the carried/worn MSDs may include components other than those on the cart (e.g., a display, user interface, etc.). The employee can use the MSD in communication with the cart components to map the store and/or pick items. In another example, a user (e.g., customer) may bring their computing device (e.g., phone, tablet, wearable, or laptop) into the store. The user device can communicate with the cart to determine the user's location. In this case, a user can use their user device to pick orders and receive advertisements, as described herein (e.g., based on location). Also, the MSD components on the cart can monitor user movement, user traffic (e.g., density of users), and map the store while the user is pushing the cart around the store.

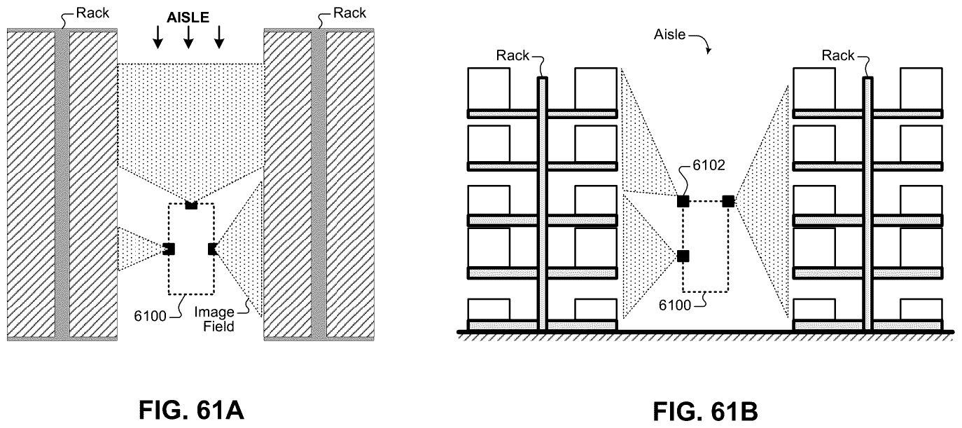

FIGS. 61A-61B illustrate example camera directions, orientations, and fields of view. FIG. 61A illustrates a top down view of multiple example cameras 6102 aimed in different directions and having different field of views. The cameras are illustrated as attached to a cart 6100 (broken outline), although the cameras may be attached to or included in another object, or included in an MSD carried by the user. The illustration of multiple cameras in a single figure illustrates how one or more cameras having different properties may be implemented in the OFS. In FIG. 61A, a front camera captures an image down the aisle along with items on both sides of the aisle. In FIG. 61A, two other cameras having different fields of view capture images on opposite sides of the cart.

FIG. 61B illustrates a view down the aisle, such as from a user's perspective. The cameras are illustrated as being aimed in different directions and having different fields of view. The cameras are illustrated as attached to a cart, although the cameras may be attached to or included in another object, or included in an MSD carried by the user. In FIG. 61B, two cameras capture the left side of the aisle, while a wider field of view camera captures images of the right side of the aisle. If the cart were moved to the right side of the aisle, the two cameras on the same side of the cart would begin to acquire images having overlapping items.

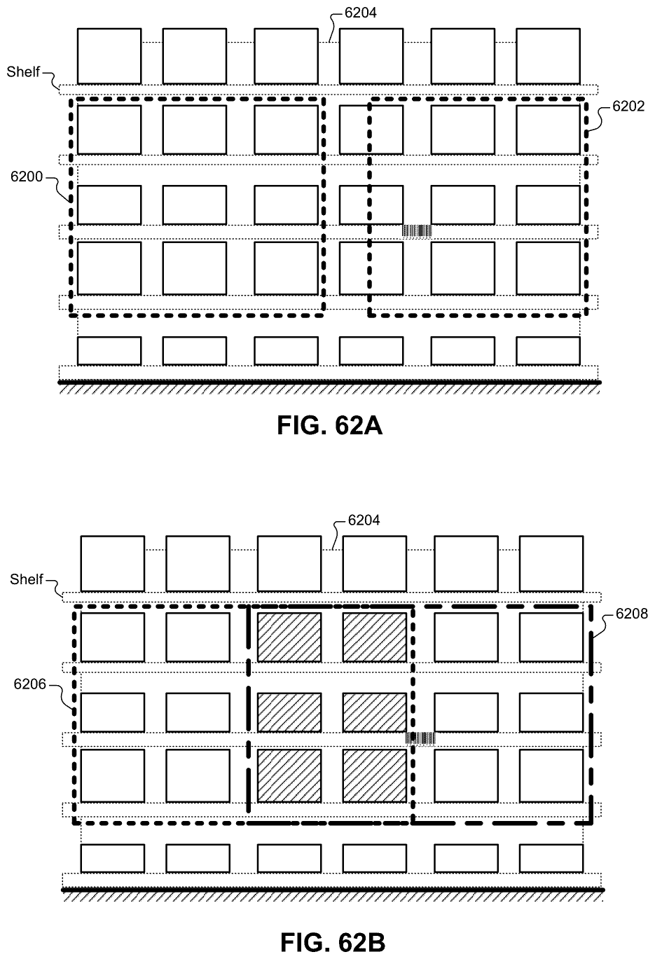

FIGS. 62A-62B illustrate examples of multiple images taken of items on the same rack. FIG. 62A illustrates images 6200, 6202 that include different portions of the rack 6204 and different items. FIG. 62B illustrates images 6206, 6208 that overlap and include the same portion of the rack 6204 and some of the same items. In the example of FIG. 62A, the first image 6200 and the second image 6202 may have been acquired at the same time by two separate cameras. Alternatively, the images 6200, 6202 may have been acquired at different times by the same camera. For example, the same camera may have acquired the first image 6200, and then acquired the second image 6202 at a later time (e.g., after the cart was moved). The acquisition of items in subsequent images (e.g., in less than a threshold time) may indicate that the items are adjacent.

In the example of FIG. 62B, the first image 6206 and the second image 6208 overlap. The first image 6206 is represented by a bold broken-line rectangle. The second image 6208 is illustrated by a bold rectangle with fewer breaks. As described with respect to FIG. 62A, the first image 6206 and the second image 6208 may have been acquired at the same time by two separate cameras. Alternatively, the images may have been acquired at different times by the same camera. For example, the same camera may have acquired the first image, and then acquired the second image at a later time (e.g., after the cart was moved). The two images in FIG. 62B include 6 of the same items, illustrated as shaded boxes. The acquisition of images including common items may indicate that the items in both images are adjacent to one another. Further generation of tables and maps according to the capture of simultaneous/subsequent images is described herein.

The MSDs and/or the CCS can process the images to determine the content of the images. For example, the MSD and/or the CCS can process the images in real-time as the images are acquired and/or process the images at a later time (e.g., in a batch of stored images). In some implementations, the MSDs can transmit images to the CCS (e.g., wirelessly) for remote processing and remote decision making (e.g., map generation and item arrangement for picking).

Images can include a variety of content. For example, the images may include one or more items, one or more location indicators (e.g., readable location indicators), and other store objects. Store objects may refer to objects in the store other than the items. For example, store objects may include movable objects and immovable portions of the store (e.g., signs, refrigerators, rafters, and floor tiles). Images can include any arrangement of items, location indicators, and store objects. For example, in some cases, a single image can include one or more items and no location indicators or store objects. In other cases, a single image can include multiple items and one or more location indicators. In other cases, a single image may include store objects without location indicators or items.

In some implementations, a single camera may capture a sequence of images, each of which may include different arrangements of items, location indicators, and store objects. In some implementations, multiple images may be taken at the same time by different cameras. For example, the cameras may acquire images in opposite directions or in other orientations. The multiple images from different cameras may also be taken at different times (e.g., asynchronously).

In some implementations, the MSD and/or CCS can timestamp the images to indicate when the images were captured. The MSD and/or the CCS can determine which images were acquired at the same time and/or in sequence based on the timestamps and/or MSD/camera IDs associated with the images. In some implementations, the images may include data that indicates the relative locations and/or orientations of the images. The location/orientation data can be used to determine the relative location of items, location indicators, and store objects in the images. The images may also include MSD IDs and/or camera IDs that indicate the MSD/camera that acquired the images.

The MSDs and/or CCS can identify readable location indicators in the acquired images. For example, the MSDs and/or CCS can identify barcodes or other readable location indicators described above. The readable location indicators may be located in a variety of locations described herein.

The MSDs and/or CCS can identify items in the acquired images. The MSDs and/or the CCS can identify items in a variety of ways. For example, the MSDs and/or CCS can identify items based on an item indicator associated with the item (e.g., a product barcode on a box or sticker on an item). As another example, the MSDs and/or CCS can identify packaging associated with the item. For example, the MSDs and/or CCS can identify an item by identifying words on the packaging, graphics (e.g., logos) on the packaging, the shape/size of the packaging, the color of the packaging, and other packaging properties. Example words that identify an item may include brand names, product names, and descriptive text. In some cases, the MSDs and/or CCS may identify items without packaging, such as fruits and vegetables. The CCS and/or MSDs may use a variety of image processing techniques to identify the items, such as text recognition (e.g., OCR), object detection, object classification, etc.

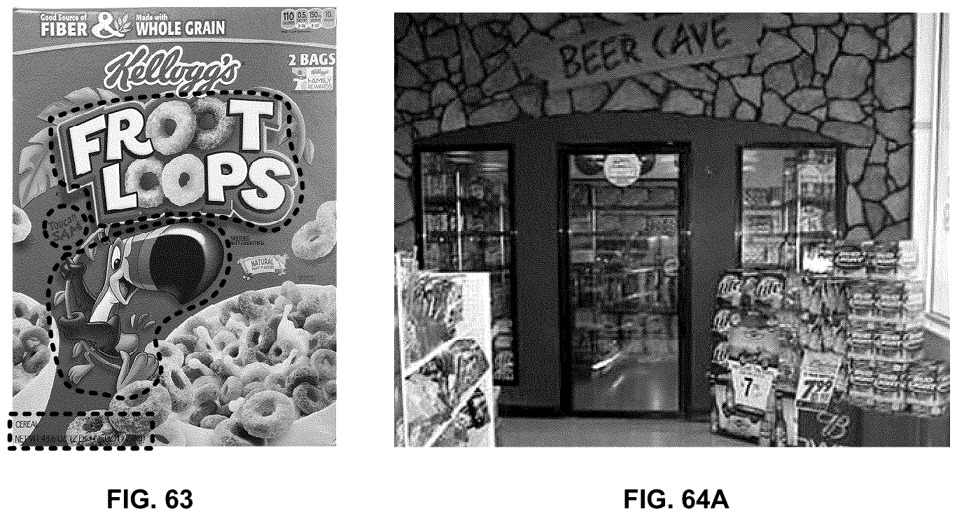

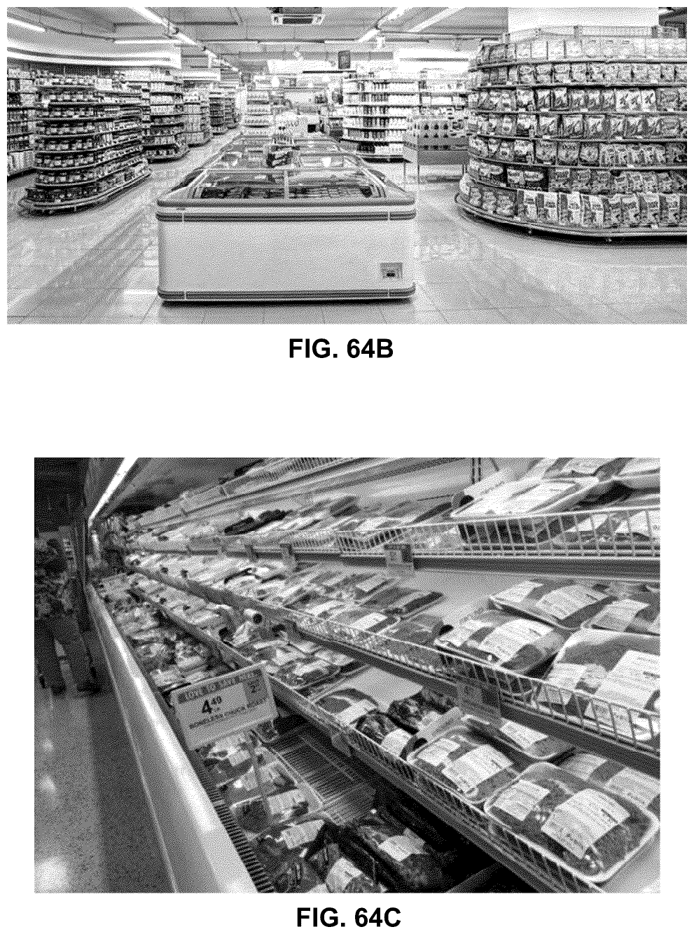

FIG. 63 illustrates an image (or a portion of an image) depicting a box of KELLOGG'S FROOT LOOPS cereal. In some cases, the image of the cereal box may be identified in a larger image (e.g., using object detection techniques) and may be further processed to classify the identified object. Portions of the package that may be used to identify the item are surrounded by bold broken lines. For example, any of the following, cither alone or in combination, may be used to uniquely identify the item: 1) the name “Froot Loops”, 2) the “Toucan Sam” text, 3) the graphic of Toucan Sam, and 4) the listed weight (e.g., 43.6 OZ). A barcode on the item is not shown, although the barcode may also uniquely identify the product. It is appreciated that image/object classification can be performed in a number of different manners, as discussed throughout the disclosure. For example, image/object classification techniques may include object detection, feature extraction, and classification processes. Furthermore, image classification models (e.g., machine learned models, neural networks, or the like) may be used to classify identified objects.

In some implementations, the CCS and/or the MSDs may be configured to identify objects other than readable location indicators and items in the store. The other types of objects may be referred to as store objects. For example, store objects may include numbers, words, and symbols in the store, such as words on aisle signs (e.g., including aisle numbers, categories, products, etc.), words and symbols on bathroom signs, words on the wall (e.g., department signs and advertisements), words on support beams, and words on racks. Store objects may also include racks, such as open freezers, freezer/cooler doors, and merchandising displays with products. Store objects may also include portions of the floor, such as floor materials and patterns (e.g., concrete, tile, mats). Store objects may also include portions of the ceiling, such as different types of lighting, rafters, sprinklers, and piping.

In one example, the CCS and/or MSDs can identify one or more words in the store. For example, the CCS and/or MSDs can identify text on signs and posters, such as aisle signs that indicate item categories or other item information. In a specific example, the CCS and/or MSDs can identify text on aisle signs that indicate an aisle number and/or item category/type, such as frozen food, frozen pizzas, frozen dinners, etc. In another specific example, the CCS and/or MSDs can identify words included on advertisements, floor displays, pillars, the ceiling, and walls in the store. Similarly, the CCS and/or MSDs can identify images (e.g., line drawings, graphics, logos, etc.) included on signs, floor displays, pillars, the ceiling, and walls in the store. In some implementations, the CCS and/or MSDs may also identify the store object that includes the words, numbers, and/or symbols. For example, the CCS and/or MSDs may identify that the words are included on an aisle sign, the wall, support beam, or rack.

In some implementations, the CCS and/or MSDs can identify other store objects in images, such as racks described herein. For example, the racks may include freezers, refrigeration units, and/or shelving associated with a specific area of the store. In some implementations, the CCS and/or MSDs may identify flooring properties, such as floor materials (e.g., carpet or tile) and floor patterns/transitions (e.g., carpet/tile patterns) that indicate specific areas in the store. In some implementations, the CCS and/or MSDs may identify ceiling properties, such as ceiling rafters, ceiling colors, and ceiling materials/transitions (e.g., insulation, metals, etc.) that indicate specific areas in the store. In some implementations, the CCS and/or MSDs may identify wall properties, such as wall colors, wall materials, and transitions in the wall patterns (e.g., tile to drywall) that indicate specific areas in the store.

FIGS. 64A-64C shows example store objects that the CCS and/or MSDs may identify. For example, FIG. 64A shows a sign that includes the name “BEER CAVE.” Additionally, FIG. 64A includes a cooler door in combination with a stone patterned wall that may be unique to the store (i.e., indicate a unique location). FIGS. 64B-64C show example refrigeration units that may indicate a specific area of the store. For example, specific products may be associated with the areas. In FIG. 64B, specific frozen/chilled foods may be stored in the floor refrigeration unit. In FIG. 64B, the cooler type may be associated with packaged meats. Additionally, in FIG. 64C, the color of the products (e.g., red) may indicate that the location of the store is in the meat department, especially when the red color is combined with the cooler.

In some cases, some acquired images may not include any identified items, location indicators, or store objects. For example, some acquired images may be obscured (e.g., by people, the cart, or other objects). In these cases, the CCS and/or MSDs may discard the images or rely on other images for generating maps and determining a user's location. Multiple cameras, cameras with wider fields of view, and more frequent image acquisition may help ensure acquisition of images that include items, location indicators, and/or store objects.

The MSDs and/or the CCS can generate and/or update various data structures based on the acquired images. For example, the MSDs and/or the CCS can generate/update the location map, item association table, and/or the item adjacency map based on the images. As another example, the MSDs and/or the CCS can generate and update one or more image-based maps based on the acquired images.

As described above, in some implementations, the CCS and/or MSDs can generate/update a location map based on readable codes identified in the images. For example, the CCS and/or MSDs can generate/update a location map to indicate that two zones are adjacent if readable codes associated with the zones are in the same image from a single camera. In another example, the CCS and/or MSDs can generate/update a location map to indicate that two zones are adjacent if readable codes associated with the zones are in different images from different cameras that captured the images at approximately the same time (e.g., within a threshold period of time).

In some implementations, the CCS and/or MSDs can generate/update a location map to indicate that two zones are adjacent if the readable codes associated with the zones are in separate images from the same camera. For example, two zones may be considered adjacent if the readable codes are in two images (e.g., from one or more cameras) that are captured close in time (e.g., within a threshold period of time) or close in distance (e.g., as judged by similar items in the images or other location determination techniques, such as GPS).

The CCS and/or MSDs can generate an item association table and/or update an item association table based on the acquired images. For example, if an MSD acquires an image including one or more items while also detecting a location signal (e.g., contemporaneously or within a short period of time), the CCS and/or the MSD can update the item association table by associating the detected items with the detected location signal. As another example described above, if the image includes a readable location indicator along with one or more identified items, the CCS and/or the MSD can update the item association table by associating the detected items with the readable location indicator. Additionally, if item images are acquired shortly before/after (e.g., less than a threshold period of time) detecting a location indicator, the items may be associated with the detected location indicator (e.g., readable location indicator and/or location signal). In some cases, the CCS and/or MSDs can generate/update an item association table by adding items to a location value if the items are adjacent to one or more items associated with the location value.

The CCS and/or the MSDs can generate and/or update an item adjacency map based on acquired images. In some implementations, the CCS and/or MSDs can set items as adjacent when the items are included in the same image. Items in sequential images can be set as adjacent if the sequential images include one or more of the same items (e.g., a threshold number of common items) (e.g., see FIG. 62B). In some implementations, items in sequential images may also be set as adjacent if the images are acquired in less than a threshold amount of time and/or the items are a threshold distance from one another (e.g., based on MSD location and/or rate of movement). In some implementations, items may be set as adjacent if the items are separated by fewer than a threshold number of intervening items.

In implementations using multiple cameras, items in separate camera images that are captured contemporaneously (e.g., at the same time or within a threshold amount of time) can be set as adjacent. For example, if two images are captured contemporaneously and the orientation of the cameras with respect to one another is known (e.g., side-by-side or opposite facing), then adjacencies between items may be determined based on classified items captured in the respective images and the orientation of the cameras with respect to one another. Additionally, items in separate camera images that are sequential images may be set as adjacent if the separate images are acquired in less than a threshold amount of time and/or the items are a threshold distance from one another (e.g., based on location and/or rate of movement). In these examples, two images captured sequentially and a first item classified in a first captured image and a second item classified in a second captured image can be related as being adjacent based on the respective order in which the items were captured.

In some implementations, the CCS and/or MSDs may generate image-based maps based on the acquired images. For example, the image-based maps/tables may be generated as described above. In some implementations, the image-based maps may be generated and used in addition to, or as an alternative to, the other maps described above (e.g., location maps and item adjacency maps). Accordingly, the image-based maps may be used as stand-alone maps for arranging items or as additional maps that can be used in addition to other maps for arranging items. Example image-based maps may include an image-based adjacency map, an image-based location map, and/or a store object map.

In some implementations, the CCS and/or MSDs can generate the image-based item-association tables and image-based location maps using location indicators, as described above. The CCS and/or MSDs can also generate image-based item adjacency maps based on acquired images, as described above. The image-based item association tables, image-based location maps, store object maps, and image-based adjacency maps can be used together/independently for arranging items during picking. Accordingly, the CCS and/or MSDs may generate and use any combination of tables/maps including, but not limited to, location maps, item adjacency maps, item association tables, image-based location maps, image-based adjacency maps, image-based item association tables, and store object maps. In some implementations, the maps and item association tables for each mapping technique may be separate. In other implementations, the maps and item association tables may be combined (e.g., so that items may be mapped to one or more location signals, readable location signals, and store objects).

In some implementations, the CCS and/or MSDs can generate image-based maps that include object-based zones/areas (hereinafter object-based zones). The object-based zones may refer to zones that are associated with store objects that may be acquired in images. The CCS and/or MSDs can assign a unique identifier to a zone associated with an identified store object. The unique identifier assigned to the zone may uniquely identify the zone. The unique identifier assigned to a zone may be referred to as an object-based ID. An object-based ID may include numbers, letters, symbols and/or punctuation marks that uniquely identify a zone.

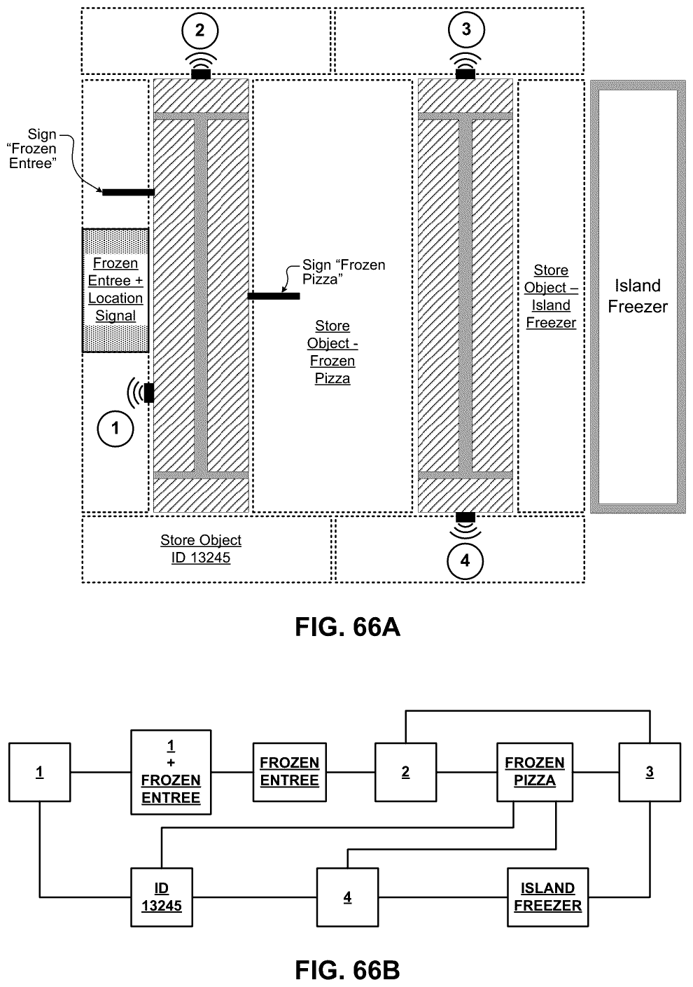

FIGS. 65A-66B illustrate portions of stores that include object-based zones. FIG. 65A illustrates a portion of a store that includes only object-based zones. FIG. 66A illustrates a portion of a store that includes object-based zones and other zones defined by location signals. In some implementations, a store may be mapped using only object-based zones. In other implementations, a store may be mapped using a mix of object-based zones and other mapping technologies, including mapping using location indicators and/or item adjacency mapping.

Referring to FIG. 65A, four different zones are each defined by one or more store objects. In FIG. 65A, two zones are defined by words included on signs. For example, the leftmost zone may be associated with the term “Dairy” that may be detected on a sign (e.g., a food category sign). The object-based ID may be the term “Dairy,” which may be combined in the ID with an indicator that the term “Dairy” is included on a sign. In some implementations, the object-based ID associated with the zone may be a random ID associated with the Dairy sign. The cereal aisle may also be identified and assigned a unique object-based ID as well.

FIG. 65A includes a zone that is defined by the identification of an island freezer (e.g., a floor reach-in freezer). FIG. 65A also includes a zone defined by the combination of the island freezer and a sign included in an aisle. FIG. 65B illustrates an example image-based map that may be generated based on the detection of store objects.

FIG. 66A illustrates a store that includes location indicators that emit location signals. The CCS and/or MSDs may also map the store using detected store objects. In FIG. 66A, the location indicators/signals define zones 1, 2, 3, and 4. Other zones are defined by the store objects detected in the zones. For example, two signs including the terms “Frozen Entree” and “Frozen Pizza” define two zones. Another zone is defined by detection of an island freezer. Another zone, defined by a store object number 13245 (e.g., randomly assigned), may be assigned based on detection of a rack or other store object in an image. One zone is defined by both a location signal and a detected store object. Specifically, one zone is defined by an area in which location signal 1 can be detected along with the sign including the text “Frozen Entree.” FIG. 66B illustrates an example map that includes zones defined by store objects and/or location signals. The map in FIG. 66B is similar to the map illustrated in FIG. 22B. Although the store in FIG. 66A includes location indicators that transmit location signals, the store may additionally/alternatively include readable location indicators that define locations.

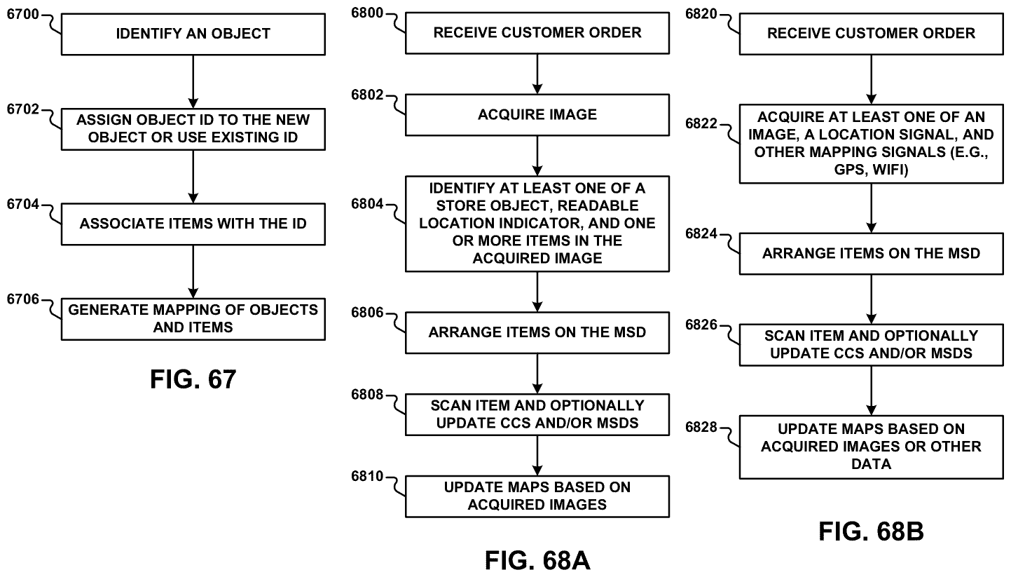

FIG. 67 illustrates an example method for making maps including object-based zones. In FIG. 67, the method includes: 1) identifying an object (e.g., block 6700), 2) assigning an object ID to a new object or using an existing ID (e.g., block 6702), 3) associating items with the ID (e.g., block 6704), and 4) generating a mapping of objects and items (e.g., block 6706). The method of FIG. 67 is described with respect to a single MSD, although multiple MSDs may be used to generate the store maps and/or item association tables.

Initially, in block 6700, the MSD and/or CCS identifies a store object in an image. Different store objects may be identified in different ways. For example, objects including text (e.g., aisle signs) may be identified based on identification of the text. In some cases, the object including the text may also be identified. For example, the CCS and/or MSD may determine that the text is attached to a hanging sign or a wall. As another example, a refrigerator unit including text (e.g., a brand name and/or model number) can be identified based on the text.

In some cases, the identified store object in block 6700 may be a store object that has already been identified previously and included as part of a map (e.g., an object-based map). If the store object had been previously identified, the object-based ID may already be associated with items. Additionally, the object-based zone may already be part of a map of the store zones. In some cases, the identified store object may be a newly identified store object.

In block 6702, the CCS and/or the MSD may assign an object-based ID to the identified store object if the store object is a newly identified store object. Otherwise, the MSD and/or CCS may identify the already existing object-based ID associated with the store object. The IDs can be automatically generated in some cases, such as randomly or in sequence of a next available ID (e.g., by incrementing values). In some cases, the system can assign an ID based on the text acquired in an image, such as assigning a sign name to a zone. In some cases, a human may manually assign object-based IDs (e.g., in a user interface on an MSD and/or another computing device).

In some implementations, the object-based IDs may be human readable descriptors, such as descriptors that are descriptive of the object-based zone. Such human readable descriptors may be assigned automatically (e.g., based on text acquired in one or more images) or manually. In one example, a human readable descriptor may include “frozen entrees” for a zone in which an image is acquired of a sign including the text “frozen entrees.” In another example, a user (e.g., employee/manager) can assign a descriptor “frozen pizzas” to a zone in which frozen pizzas are stocked and/or a sign indicates “frozen pizzas.”

Although readable descriptors may be assigned to object-based zones, in some implementations, location descriptors can be assigned to other zones, such as one or more zones associated with location indicators or any other mapping technology described herein. For example, aisle numbers may be assigned to some location values. As another example, department names may be assigned to one or more location values. One or more descriptors may be assigned to a zone. For example, a zone near frozen pizzas may be associated with descriptors “grocery,” “frozen foods,” and “frozen pizzas,” which may indicate that the zone is included in a grocery department in the store, in a frozen foods section of the grocery department, and near the frozen pizzas on the racks. In some implementations, the types of items detected along with the assigned IDs may be configured by the owner/operator of the OFS (e.g., using a GUI).

In block 6704, the MSD may scan one or more items and the MSD and/or CCS may associate the one or more scanned items with the recently determined object-based ID. For example, the MSD and/or the CCS may generate/update an item association table that associates object-based IDs with items. Although the scanned items may be associated with previously determined object-based IDs, in some cases, the MSD and/or the CCS may be configured to associate a scanned item with a later determined object-based ID, such as when the later determined object-based ID is determined closer in time to the scanned item than a previously determined object-based ID. The association between object-based IDs and items may be updated over time.

In block 6706, the CCS and/or MSD may update an object-based map. The object-based map may indicate the location of object-based zones relative to one another. If the store is mapped using other techniques (e.g., using location indicators) along with object-based zones, the map may include a mix of object-based zones and other zones. The object-based map, or other map, may be similar to maps illustrated in FIGS. 65A-66B. For example, the object-based map, or other map, may include a plurality of zones that are connected with junctions that indicate the relative location of the object-based zones to other zones.

The CCS and/or MSD may update the object-based map, or other map, to include object-based zones according to one or more update criteria. For example, the CCS and/or MSD may indicate that an object-based zone is adjacent to another zone when a store object is detected within a threshold period of time relative to another zone (e.g., detection of a location signal or other store object). In some implementations, as described with respect to location signals, the CCS and/or MSD may generate a map in which a single zone includes multiple identifiers, such as one or more object-based IDs, one or more readable location indicators, and one or more location signals (e.g., see FIGS. 66A-66B).

In some implementations, the CCS and/or MSD may remove object-based zones from the maps. For example, the CCS and/or MSD may remove object-based zones according to removal criteria. In one example, the CCS and/or MSD may remove object-based zones if the store objects associated with the object-based zones have not been detected within a period of time. In another example, the CCS and/or MSD may remove object-based zones if the store objects are not detected along with other location indicators/signals (e.g., a threshold number of times), if such store objects have previously been mapped to the location indicators/signals.

FIG. 68A illustrates an example method for generating maps and picking items. In the method of FIG. 68A, an MSD acquires one or more images used to arrange currently ordered items on the MSD and/or update one or more image-based maps. Initially, in block 6800, the MSD receives a customer order including a plurality of items. In block 6802, the MSD acquires an image. In block 6804, the MSD (or CCS) identifies at least one of a store object, a readable location indicator, and one or more items in the acquired image. In block 6806, the MSD arranges items on the display based on analysis of the image (e.g., a determined zone) and one or more image-based maps. In block 6808, the MSD may scan items and optionally update the CCS and/or other MSDs indicating that the items have been scanned. In block 6810, the MSD and/or CCS may update tables and/or maps based on the acquired image and scanned items.

FIG. 68B illustrates an example method for generating maps and picking items. In the method of FIG. 68B, an MSD acquires one or more images, location signals, and/other mapping signals, and uses the signals to arrange items and/or update one or more maps (e.g., image-based maps and/or other maps). Initially, in block 6820, the MSD receives a customer order including a plurality of items. In block 6822, the MSD acquires at least one of an image, a location signal, and other mapping signals (e.g., GPS, Wi-Fi). In block 6824, the MSD arranges items based on the acquired image/signals and one or more maps/tables (e.g., image-based maps, location maps, item-adjacency maps, etc.). In block 6826, the MSD scans one or more items and may optionally update the CCS and/or MSDs indicating that the items have been scanned. In block 6828, the CCS and/or MSD may update one or more maps/tables (e.g., image-based maps or other maps/tables) based on the acquired image(s), location signals, other signals, and/or scanned items.

MSDs can use any of the generated tables/maps described herein to arrange items from customer orders during picking. In some implementations, the MSDs and/or CCS can determine a location based on a recently scanned item. For example, the MSD and/or CCS can determine the location based on the item association table or other map that associates the recently scanned item to a location and other items. In some implementations, the store may be mapped using a different set of technologies than are used to pick. For example, the store may be mapped using image-based mapping and subsequently picked using other technology for arranging items. In one example, MSDs can use the item association tables, location maps, item adjacency maps, and/or image-based maps to arrange items from customer orders on the MSDs, even if the MSDs do not include cameras for capturing images. Also note that the MSDs and/or CCS may perform mapping while picking and/or perform mapping at a separate time. For example, the MSDs may be set into an image mapping mode in which the MSDs are transported throughout the store to acquire images and generate item association tables and maps.

In some implementations, the MSDs and/or CCS can be configured to use the maps separately. For example, the maps used may depend on the data that is being acquired. In one example, at one time, an MSD may determine location based on a location signal if a location signal is detected. At a later time, the MSD may determine location from an image if no location signal is detected. In these case, different maps may be used to fill in location gaps in the store and improve reliability and usability of the OFS. In some implementations, different location detection techniques may have different priorities. For example, detection of a location signal or location indicator may take priority over an adjacency map. In some implementations, the CCS can fuse data from different maps and location detection techniques to determine the location of items in the store and determine the user's location.

In some implementations, the OFS may include an inventory system that uses the images to determine store inventory. For example, the OFS may determine whether items are in stock based on the images (e.g., whether the items have been detected in the images within a threshold period of time). As another example, the OFS may determine the number of items in stock based on the images.

As described herein, in some implementations, the maps/tables and other hardware and software described herein may be used by customer devices for picking items. Additionally, in some implementations, the maps/tables can be used to advertise to a customer. For example, the OFS may include an advertisement system that determines the location of the customer device and advertises to the customer based on the customer device location. Example advertisements may include text and/or images sent to the customer device in a GUI, such as in a shopping application and/or as a notification (e.g., in an application, as a text message, email, etc.). In some implementations, the advertisement system may advertise based on the items that are nearby a customer. For example, the advertisement system may advertise items near the customer. In a more specific example, the advertisement system may advertise items that are near the customer and also included on a customer's shopping list. In some implementations, the advertisement system may arrange advertisements based on the customer's location. For example, the advertisement system may arrange a list of advertisements for items (e.g., on the customer's list or not) based on the location of the items relative to the customer. For example, the advertisement system may arrange items that are closer to the customer in a priority order (e.g., on the display and/or at the top of the display) to persuade the customer to purchase the items. As another example, the advertisement system may show advertisements to a user that are farther away from the customer in order to persuade the customer to move farther through the store and pick more items.

The technology described herein may be implemented in an automatic scanning and/or picking device, such as a robotic device that moves throughout the store. For example, the robotic device may scan items, acquire location signals, scan location indicators, acquire images, and/or determine a location based on any mapping technologies described herein. In some implementations, the robotic device may send the acquired data to the CCS for processing. The robotic device and/or CCS may generate the maps described herein based on the acquired data. The maps may then be used to arrange items for picking.

In some implementations, the OFS may include an inventory system that determines store inventory. For example, the inventory system may determine store inventory based on images acquired by a plurality of different devices (e.g., MSDs, CCDs, cameras, etc.) that are moved throughout the store by users (e.g., customers, pickers, store employees, etc.). The inventory system may generate inventory data based on the acquired images. Example store inventory data may include, but is not limited to, a list of items (e.g., item IDs) and associated inventory status. Inventory status may indicate whether the item is in-stock (e.g., currently stocked in the store) or out-of-stock (e.g., not currently stocked in the store). In some implementations, the inventory status may indicate a number of items in stock. In addition to image-based inventory acquisition, the inventory system of the present disclosure may acquire inventory in other manners, such as via item scanning with MSDs/CCDs, manual user entry, robotic inventory acquisition, or other inventory generation techniques.

In some implementations, the inventory data may be automatically generated as images are acquired by devices being moved throughout the store. For example, pickers and/or consumers may move devices throughout the store that may acquire images for inventory data generation while the pickers and/or consumers are picking items. In some implementations, the devices may be set into an inventory generation mode that places the devices in a mode for acquiring images used to generate inventory data.

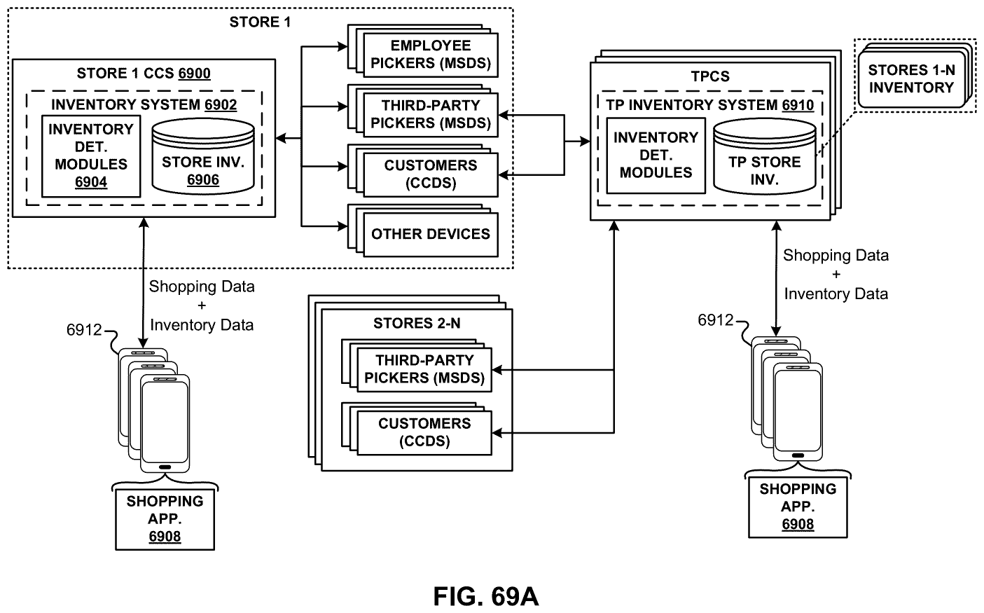

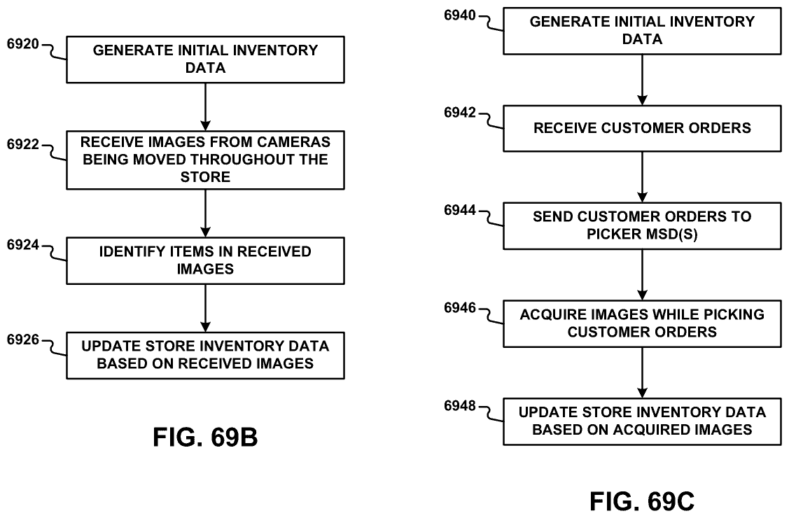

FIG. 69A illustrates an example environment that includes a plurality of stores and third-party computing systems. In FIG. 69A, store 1 includes a CCS 6900. The store 1 CCS 6900 includes an example inventory system 6902. The inventory system 6902 includes inventory determination modules 6904 and an inventory data store 6906. The inventory determination modules 6904 may determine store inventory data based on acquired images. For example, the inventory determination modules 6904 may determine whether items are in stock at the store based on received images. The inventory determination modules 6904 may also determine a number of specific items included in the store. Although the inventory system 6902 is illustrated as included in the CCS 6900, the inventory system 6902 may be a separate system operated by one or more stores or other parties.

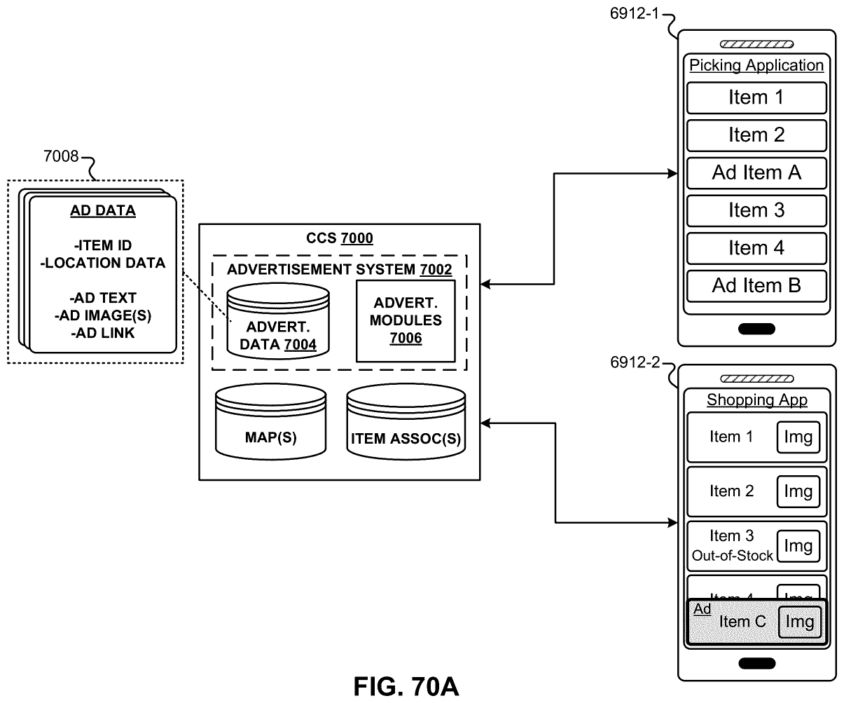

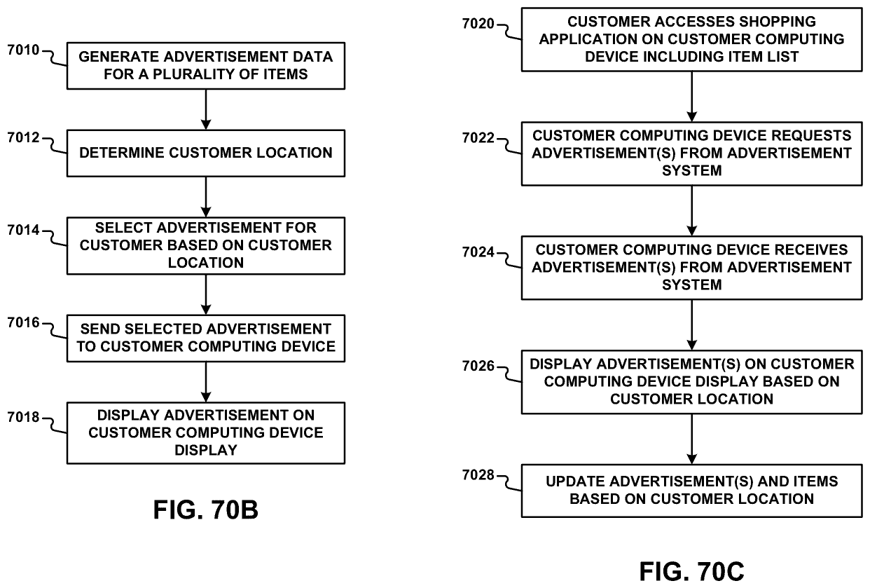

The store inventory data may be stored in an inventory data store 6906. The inventory data may include a list of items (e.g., item IDs) and associated inventory status. The store inventory data may be accessed by a plurality of different devices. For example, inventory data may be used in a shopping application 6908 to indicate whether an item is in-stock and/or a number of items in stock (e.g., FIG. 70A includes an “out-of-stock” indicator for an item in the shopping application). As another example, inventory data may be used in a picking application to indicate whether an item is in-stock or if a substitution/replacement item should be picked for a customer.

In FIG. 69A, store 1 includes a plurality of devices that may be used to map the store and/or pick items from the store. The inventory system 6902 (e.g., inventory determination modules 6904) may determine inventory data based on images and/or other data acquired from the various devices. In some implementations, the CCS 6900 (e.g., inventory determination modules 6904) may process the received images and determine in-stock indicators and/or in-stock numbers based on the processed images. Additionally, or alternatively, the devices (e.g., MSDs) may generate the inventory data locally (e.g., an item ID and associated in-stock indicator/number) and then transmit the inventory data to the CCS.

The inventory system 6902 may generate/update inventory data based on image data and/or other data acquired from one or more sources. For example, the inventory system 6902 may determine inventory data based on images/data acquired by MSDs used by store employees to map the store and/or pick items from the store. As another example, the inventory system 6902 may determine inventory data based on images/data acquired by third-party MSDs used by third-party pickers in the store. As another example, the inventory system 6902 may determine inventory data based on images/data acquired by CCDs used by customers in the store. As another example, the inventory system 6902 may determine inventory based on images/data acquired by other devices (e.g., robotic devices).

The inventory system 6902 may generate and update inventory data based on images acquired from devices over time. For example, the inventory system 6902 may add new items to inventory when the items are detected in one or more images. As another example, the inventory system 6902 may update a number of an item in inventory if the images include multiple detected items of the same type. In some implementations, the inventory data may include time stamps indicating the time at which the inventory data was determined based on images. In these implementations, the inventory system 6902 may determine that an item is currently in stock if the item was acquired in one or more images within less than a threshold period of time from when the one or more images were acquired.

In some implementations, the inventory system 6902 may update the number of a specific item in stock if the number changes in other images (e.g., increase/decrease an in-stock number). In some implementations, the inventory system 6902 may indicate that an item is out-of-stock if the item is not detected in the item's defined location (e.g., over a threshold period of time). In some cases, the inventory system 6902 may indicate an item may be currently out-of-stock when the item has not been detected in an image after a threshold period of time. Put another way, the absence of the item in acquired images may indicate that the item is out of stock.

Store 1 may include an inventory system 6902 that acquires inventory data for store 1. FIG. 69A includes an additional plurality of stores 2-N, each of which may implement their own inventory system in a manner similar to store 1. In some implementations, an inventory system may generate and/or store inventory data for multiple stores. For example, a company that owns/operates multiple stores may include an inventory system that stores inventory data for the multiple stores.

FIG. 69A includes third-party computing systems (TPCSs). A TPCS includes a third-party (TP) inventory system 6910 that may operate in a similar manner as the inventory system described with respect to Store 1. A third-party inventory system 6910 may determine inventory data for one or more stores based on image data and/or other data acquired from one or more sources. For example, the third-party inventory system 6910 may determine inventory data based on images/data acquired by third-party MSDs used by third-party pickers in the store(s). As another example, the third-party inventory system 6910 may determine inventory data based on images/data acquired by customer computing devices (CCDs) used by customers in the store (e.g., while customers are shopping using a third-party shopping application).

In some implementations, the third-party inventory system 6910 may receive inventory data from one or more stores. For example, the third-party inventory system 6910 may request inventory data for the one or more stores. In this example, the third-party company may partner with the owner/operator of the store(s) and receive inventory data as a part of the partnership. In some implementations, the third-party inventory system 6910 may generate inventory data and provide the inventory data to the store inventory system 6902. In these implementations, the store inventory system 6902 may generate and/or update the store inventory data received by one or more third-party inventory systems. The environment of FIG. 69A illustrates a plurality of third-party computing systems that may be operated by different third parties. Each of the TPCSs may operate in a similar manner.

FIG. 69A illustrates a plurality of CCDs 6912 in communication with the store 1 CCS. For example, the CCDs 6912 may include installed shopping applications and/or access web-based shopping sites that allow the customers to purchase items in the store using the CCDs. The CCS 6900 may indicate inventory data (e.g., in-stock/out-of-stock status and/or item numbers) to the CCDs 6912 in the shopping application/website. In some implementations, the shopping application 6908 may provide a shopping GUI that renders the in-stock data and allows the customer to select the item for a customer order if the item is in stock (e.g., see FIG. 70A). The TPCSs may also provide inventory data to their respective shopping applications in a similar manner. The CCS/TPCS may provide inventory data to store MSDs and third-party MSDs in picking applications in a similar manner.

FIG. 69B illustrates a method that describes example inventory data generation operations. In block 6920, the inventory system 6902 generates initial inventory data using one or more techniques, such as using image-based inventory data, item scans, manual user entry, robotic inventory generation, etc. In block 6922, the inventory system 6902 receives images from cameras being moved throughout the store. For example, the cameras may be standalone cameras and/or cameras included in other devices, such as MSDs and/or CCDs. In block 6924, the CCS 6900 (e.g., inventory determination modules 6904) may identify items included in the received images. In block 6926, the CCS 6900 (e.g., inventory determination modules 6904) may update the store inventory data based on the items identified in the images.

FIG. 69C illustrates a method that describes example inventory data generation operations based on images acquired by MSDs being used to pick customer orders. In block 6940, the inventory system 6902 generates initial inventory data using one or more techniques. In block 6942, the CCS 6900 receives customer orders. In block 6944, the CCS 6900 sends customer orders to one or more picker MSDs. In block 6946, the MSDs acquire images in the store (e.g., including stocked items). In block 6948, the CCS 6900 (e.g., inventory determination modules 6904) may identify stocked items in the images and update store inventory data based on the identified stocked items.

FIGS. 70A-70C illustrate and describe advertisement functionality that may be provided by an advertisement system 7002 and a shopping application (e.g., 6908) on a CCD (e.g., a customer's smartphone). In FIG. 70A, a CCS 7000 includes an advertisement system 7002. The advertisement system 7002 includes an advertisement data store 7004 that stores advertisement data for a plurality of items. The advertisement system 7002 includes advertisement modules 7006 (e.g., hardware/software) that provide the advertisement functionality attributed to the advertisement system 7002. For example, the advertisement modules 7006 may determine a customer's location (e.g., inside/outside of the store), select one or more advertisements for a CCD based on the user's location, and send the one or more selected advertisements to the CCD.

Advertisement data 7008 for an item (i.e., item advertisement data) may include data associated with the item and data used to select and render an item advertisement for the item. For example, item advertisement data 7008 may include an item ID and location data. The location data may be in terms of any location technology described herein, such as locations specified relative to location indicators, store objects, and/or one or more other items. In some implementations, the location data may indicate the location of the item to be advertised relative to a location. For example, the location data may indicate a zone that includes the item to be advertised. In some implementations, the location data may indicate a location in which a user should be located in order to select/render an advertisement. For example, if the location data in the advertisement data indicates that the user should be located in a first location, the advertisement system 7002 may select the item advertisement when the user is in the specified first location.

The advertisement data may include rendering data that a shopping application may use to render the item advertisement. Example rendering data may include, but is not limited to, text and/or images (e.g., Img in FIG. 70A) associated with the item. For example, advertisement text may include an item name, an item description, item price, and/or item type. Example images may include images of the item or other images that are descriptive of the item. In some implementations, the advertisement text/images may include text/images indicating that the item is being advertised. For example, advertisement text/images may include a word “Ad” (e.g., see FIG. 70A) and/or include advertisement text promoting the purchase of the item (e.g., “Buy Now!”). In some implementations, the item advertisements may include link data that links to a page of a shopping website/application in which the user can add the item to their digital shopping cart for purchase. In some implementations, a user may scan the advertised item in the store, which may cause the item advertisement to be removed from the GUI.

The advertisement links may be rendered on a user device in a variety of ways. In some implementations, the advertisement links may be rendered as textual/graphical advertisements in the application. In these implementations, the advertisement links may be selectable (e.g., by touching the link). In some implementations, the item advertisements may be overlaid onto application pages or webpages (e.g., as banners over top of an application page or webpage) (e.g., see Item C of FIG. 70A). In some implementations, the item advertisements may be integrated into a list a user is using while picking items (e.g., see Ad Item A and Ad Item B of FIG. 70A).

The advertisement system 7002 may select one or more item advertisements for a CCD. For example, the advertisement system 7002 may select the one or more item advertisements based on a user location. In some implementations, advertisement data for an item may include item location data that indicates the location of the item to be advertised. In these implementations, the advertisement system 7002 may be configured to select the item advertisement when the user is in the location specified in the advertisement data or located within a threshold distance of the item, such as a threshold number of zones and/or a distance defined by item adjacencies. In some implementations, the advertisement data may include location data associated with one or more locations other than the location including the item. In these implementations, the advertisement system 7002 may be configured to advertise to a user when the user is in a location other than where the item is included. In a specific example, the advertisement data may include some item advertisements for common items in locations that are located away from the user's current location, which may cause the user to move to the location in response to the advertisement. The location data used to trigger selection of an item advertisement may be in terms of any of the one or more types of locations described herein, such as areas/zones defined by location indicators, store objects, and/or item adjacencies.

FIG. 70A illustrates two example application GUIs. The upper GUI on CCD 6912-1 illustrates an application that the user may use to pick items from their own customer order. As such, the upper GUI may be referred to as a “picking application.” In the picking application, the user is picking a customer order including items 1, 2, 3, and 4. The picking application also has rendered advertisements for Ad Item A and Ad Item B. Note that the picking application has intermixed the advertised items in with the customer ordered items. As described herein, the items in the customer order may be arranged based on the location of the customer/CCD. In some implementations, the advertised items may also be arranged based on their location relative to the customer/CCD. For example, in FIG. 70A, Items 1-2 may be closest to the customer, followed by advertised Item A and Items 3-4. Advertised item B may be the farthest from the customer at the time the picking application GUI in FIG. 70A was rendered.

In some implementations, the advertisement system 7002 may select item advertisements based on the items included in the customer's current order (e.g., the current list of items being picked). For example, the advertisement system 7002 may select item advertisements for items that are near/within the locations (e.g., zones) including items on the current customer picking list. In a specific example, the advertisement system 7002 may select item advertisements for items that are within locations (e.g., zones) of items on the current customer picking list or within a threshold distance (e.g., threshold number of zones) from items included on the current customer picking list. In some implementations, the advertisement system 7002 may select item advertisements for items based on item adjacency. For example, the advertisement system 7002 may select item advertisements for items that are adjacent to items on the current customer picking list.

In some implementations, the advertisement system 7002 may select item advertisements for items based on the location of the customer/CCD and the items included in the current customer picking list. For example, the advertisement system 7002 may select an item advertisement for an item that is currently near the customer (e.g., less than a threshold distance) and also near one or more other items on the current customer picking list.

In some implementations, the CCD (e.g., picking/shopping application) may send an advertisement request for an advertisement to the advertisement system 7002. The advertisement request may include a variety of data, such as location data indicating the location of the CCD and/or items included in the customer's current list. In response to receiving the advertisement request, the advertisement system 7002 may select one or more item advertisements to send to the CCD as described herein.

In some implementations, the picking application GUI may rearrange the ordered items and/or the advertised items when the customer moves to a new location. For example, the application may rearrange the ordered items and the advertised items based on the location of the items relative to the customer's location. In a specific example, ordered items and advertised items closer to the customer may be arranged closer to the top of the display. In some cases, rearrangement of the ordered items and/or the advertised items may cause some ordered items and/or advertised items to be removed from the display. In these cases, other ordered items and/or advertised items may be displayed to the customer. The previously displayed ordered items and/or advertised items may be placed back on the display as the customer moves throughout the store (e.g., to a previous location) and/or scans items (e.g., thereby removing ads/items).

Scanning ordered items may cause the items to be removed from the GUI. Similarly, scanning advertised items (e.g., using a barcode scanner or other image acquisition device) may cause the advertised items to be removed from the GUI. In some implementations, the advertisements may be removed from the GUI after a threshold period of time has passed. In some implementations, the picking application may remove the advertised items from the list after the user has moved on from the advertised items, such as when the customer passes by the items and/or moves a threshold distance (e.g., number of zones) from the advertised items. In some implementations, the advertisement system 7002 may send additional item advertisements to the CCD for display after the advertised items have been scanned or otherwise removed from the list.

The lower GUI on the CCD 6912-2 in FIG. 70A illustrates an example shopping application interface. A shopping application interface may show items available for purchase, provide item descriptions, and provide item images (e.g., Img in FIG. 70A). A shopping application may also provide a customer interface in which a user may search for items, add the items to their digital shopping cart, and purchase the items. In the shopping application GUI, Item C is advertised to the customer as overlaid on a list of items for purchase in the store. Note that Item 3 has an “Out-of-Stock” indicator that may be generated based on inventory data acquired from the inventory system 6902 of FIG. 69A. Although an item advertisement may be shown in a shopping application (e.g., FIG. 70A), an advertisement may be sent to the customer in another manner. For example, the item advertisement may be shown to the customer while the customer is using a different application or website than the shopping application/website for the store. Additionally, or alternatively, the advertisement system 7002 may send item advertisements to the CCD as a notification or text message (e.g., short message service) that is displayed by the CCD (e.g., on a launcher application screen).

The GUIs illustrated in FIG. 70A are only example GUIs that illustrate different features of an example shopping application. As such, additional/alternative features may be implemented in the shopping application than those explicitly illustrated and described with respect to FIG. 70A. Although the advertisement system 7002 may be implemented locally in the store and/or as a remote advertisement system (e.g., remote server) for the store, the advertisement system 7002 may be operated in other manners. For example, the advertisement system may be implemented for a plurality of stores. In some implementations, a third party (e.g., other than the store owners) or other party may operate the advertisement system. Although a CCD (e.g., smartphone) is illustrated in FIG. 70A, other devices may provide advertisements to customers, such as a shopping cart or basket with an integrated computing device.

FIGS. 70B-70C illustrate example methods that describe operation of the advertisement system 7002 and the shopping application. In FIG. 70B, an advertisement system 7002 provides an item advertisement to a CCD based on customer location. In block 7010, the advertisement system 7002 generates advertisement data for a plurality of items. The advertisement system 7002 may generate the advertisement data in a variety of ways. In some implementations, the advertisement system 7002 may automatically generate advertisements for items based on inventory data. In some implementations, store employees, advertisers, or other parties may generate the advertisements for the advertisement system 7002 using an advertisement generation interface provided by the advertisement system 7002.

In block 7012, the advertisement system 7002 (e.g., the CCS 7000) determines a customer location using any location technique described herein. In block 7014, the advertisement system 7002 selects an item advertisement based on the customer's location. In block 7016, the advertisement system 7002 sends the selected item advertisement to the CCD. In block 7018, the CCD (e.g., shopping/picking application) displays the item advertisement to the customer.

FIG. 70C illustrates a method in which the advertisement system 7002 provides one or more advertisements to a CCD for integration into a shopping/picking application (e.g., into a picking list or as an overlaid advertisement). In block 7020, the customer accesses a shopping application on a CCD including a list of items (e.g., for purchase and/or picking). In block 7022, the CCD requests one or more item advertisements from the advertisement system 7002. The advertisement request may include a customer location and/or items in the picking list. In block 7024, the CCD receives one or more item advertisements from the advertisement system 7002. In block 7026, the CCD displays the advertisement(s) based on customer location. For example, the CCD (e.g., shopping application) may display the advertisements based on the location of the customer relative to the advertised item location. In block 7028, the customer moves throughout the store and the arrangement of the item advertisement(s) and items in the list are updated. For example, the item advertisement(s) and items in the list may be updated based on a new location and/or newly received item advertisement(s).

The shopping/picking application may be provided to the CCDs by a party (e.g., a business) that owns/operates one or more stores, third-party services, or other services. For example, the party may develop the shopping/picking application and upload the application to a digital distribution platform. A customer may download and install the shopping/picking application on the CCD. For example, the customer may download the shopping/picking application from a digital distribution platform, such as the GOOGLE PLAY digital distribution platform by Google, Inc. or the APP STORE digital distribution platform by Apple, Inc. The shopping/picking application may include computer-executable instructions that cause a processing unit of a CCD to provide the functionality attributed to the shopping/picking application and the CCD herein.

Although some aspects of the OFS described herein may be implemented based on the location of one or more MSDs, in some implementations, the OFS of the present disclosure may implement features described herein without using the location-based technologies described herein (e.g., location indicators, item adjacency, etc.). For example, the OFS may receive customer orders, assign the customer orders to MSDs, monitor the picking of customer orders, and generate routes for MSDs without regard to the location of one or more MSDs.

Each customer order may be assigned an order ID number. Each item of the customer order can also be associated with the order ID number. Accordingly, each item of a customer order may be defined by a customer order ID number and an item ID code. Associating items of a customer order with a customer order ID number may allow the CCS, MSDs, and/or other computing devices to determine when the items of the customer order have been picked from the racks (e.g., scanned), taken to a collection/packing area, and/or packed. Knowledge of the items that have been picked may allow the CCS and/or MSDs to optimize item picking based on a variety of factors described herein. For example, knowledge of which items have been picked for different orders, and the user(s) that picked the items, may allow routing of MSDs to pick items that will quickly complete pending customer orders (e.g., orders that have not been completely picked). As another example, the CCS may use knowledge of the picked items to determine when customer orders have been completely picked. In this example, the CCS may determine that one or more pickers should return items of a completed customer order to the packing area. Additionally, or alternatively, the CCS may determine that one or more additional customer orders should be generated and/or assigned (e.g., to the picker completing the order) in order to maintain efficient flow of picking/packing customer orders.

Customer orders may be associated with additional customer order data. Additional customer order data may include, but is not limited to, the time the order was placed (e.g., day of week and/or time of day), the time the order should be filled (e.g., day of week and/or time of day), the time a third-party picker should pick the order (e.g., for delivery), whether the order is for pickup or delivery, the time a customer intends on picking up the packed order, the time an order should be ready to be taken for delivery by a store employee or third party, and the time the order should arrive at a customer's location (e.g., a customer's house or other specified location). Additional customer order data may also include the total number of items in the order (e.g., total number of different items and number of each individual item), the types of items in the order (e.g., frozen, refrigerated, room temperature), a priority level of the order (e.g., indicating whether the order is to be immediately filled for an approaching/waiting customer). The customer order data may change over time for an order in response to a variety of activities. For example, the customer order data may change in response to item picking/packing. As another example, the customer order data may change based on modifications by the customer (e.g., modifications to the order and/or pickup time).

Locations of MSDs and items inside/outside of the store may be defined in a variety of ways. In one example, locations of MSDs and items may be defined in terms of zones that are defined by location indicators, as described above. For example, items may be mapped to zones that are defined by readable location indicators and/or location indicators that emit location signals. As described herein, MSD location may also be defined by readable location indicators and/or location indicators that emit location signals. For example, an MSD may determine its location by reading a readable location indicator and/or acquiring a location signal. As another example, an MSD may determine its location by scanning an item and determining the zone associated with the item (e.g., in an item association table). The MSD may then send its determined location to the CCS.

MSDs may transmit their locations determined based on any of the location determination techniques described herein. For example, MSDs may wirelessly transmit their locations to the CCS and/or MSDs at different times, such as at predetermined times, at predetermined intervals, in response to identifying a new location in any manner described herein, in response to picking a new item, and/or in response to a request for location from the CCS and/or other MSDs. The CCS and/or other MSDs may determine the locations of one or more MSDs in this manner. As described herein, in some implementations, the CCS may determine the location of one or more MSDs in other manners (e.g., other than by receiving a location from an MSD). A TPCS may also determine the locations of third-party MSDs/pickers at one or more stores using any of the location determination techniques described herein with respect to the CCS.

In some implementations, locations of MSDs and items may be defined in terms of items, such as locations relative to one or more items. For example, the locations of MSDs and items may be defined using item adjacency. In a specific example, items may be defined relative to one another in an item adjacency map. In another specific example, the location of an MSD may be determined based on a last scanned item. In this specific example, the location of the MSD relative to items may be determined using the item adjacency table by looking up the recently scanned item in the item adjacency table. In some implementations, the MSDs may be configured to scan/identify items (e.g., using a barcode scanner, acquired image, or in another manner) that are not included in the customer order as the MSDs are moved throughout the store. For example, the MSDs may be configured to continuously/intermittently scan for items and/or readable location indicators while being moved throughout the store by the user. In these implementations, an MSD may send its location to the CCS/MSDs as the MSD scans/identifies items and/or location indicators. Additionally, or alternatively, the location of the MSD may be defined by the zone including the recently scanned item.

In some implementations, locations of the MSDs and items may be defined in terms of geolocation values (e.g., latitude/longitude values using GPS). For example, the items may be mapped according to GPS geolocations as described above. In a specific example, each item may be associated with a geolocation value and/or range of geolocation values (e.g., latitude/longitude values), such as a geolocation value and/or range of values associated with an MSD when scanning the item in the past. In some implementations, racks and/or aisles may also be associated with geolocation values and/or ranges of geolocation values that allow the CCS/MSDs to determine a location (e.g., an aisle/rack location) with respect to different portions of the store, such as a geolocation value of the MSD when scanning the item. The MSDs may include a geolocation receiver (e.g., GPS receiver) that determines the current geolocation of the MSD, which may be transmitted to the CCS. In some implementations, the maps may indicate the geo-location of the zones (e.g., the size/length of the zones) and/or the locations of the zones relative to one another (e.g., a distance between zones).

In some implementations, locations of the MSDs and items may be defined using Wi-Fi-based positioning systems, or similar positioning systems. For example, the items may be mapped according to Wi-Fi-based positions. In a specific example, each item may be associated with a Wi-Fi-based position determined by the MSD and/or CCS when scanning the items. In some implementations, the MSDs may transmit their Wi-Fi-based position to the CCS. In some implementations, racks and/or aisles may also be associated with Wi-Fi-based positions/ranges that allow the CCS/MSD to determine a location (e.g., an aisle/rack location) with respect to different portions of the store.

In some implementations, the location of the MSDs may be determined based on motion data associated with the MSDs. For example, the MSDs may include motion sensors, such as one or more accelerometers and/or gyros that determine an amount of motion associated with the MSDs. Using one or more motion sensors may provide the MSD with motion information that the MSD can use to determine movement/location of the MSD. For example, the CCS/MSDs may determine an amount of movement (e.g., distance moved) since a location has been detected and/or an item has been scanned. In these examples, the CCS/MSDs may use the motion sensor data to determine location of the MSD relative to one or more items/zones in the store.

In some implementations, the locations of the items and the MSDs can be defined using store location descriptors (e.g., associated with store objects). The location descriptors may be assigned by the store employees (e.g., store managers) in some cases. In other cases, the location descriptors may be automatically assigned (e.g., automatically assigned to zones) based on image analysis/mapping. In some implementations, location indicators may be configured to transmit location descriptor data. For example, a location indicator may transmit a location signal that also includes location descriptor data (e.g., an aisle name, department name, item type, etc.). In some implementations, a readable location indicator may also include location descriptor data in the readable code. Example location descriptors may include aisle names and/or numbers. Additional example location descriptors may also include aisle descriptors, such as first/second aisle ends, aisle middle, and/or shelf location (e.g., bottom shelf, top shelf). Additional example location descriptors may include store department names and/or item types that describe the items in the store department (e.g., one or more aisles of the store). Example store department names may include, but are not limited to, grocery, dried goods, frozen foods, pharmacy, toys, and clothes.

In some implementations, the store employees, or other party, may manually associate items with the store location descriptors. In other implementations, the CCS/MSDs may associate items with the store location descriptors. For example, the CCS/MSDs may acquire images of the store including store location descriptors (e.g., aisle numbers and/or department names) and associate items with store location descriptors based on the proximity of items to location descriptors and/or where the images were acquired. In some implementations, the CCS/MSDs may determine a location in terms of a store location descriptor based on the item type of a detected item (e.g., a scanned item). In this manner, items/zones can be manually/automatically associated with location descriptors. The location descriptors can also be associated with other types of locations described herein, such as locations defined by location indicators, item adjacency, geolocation, and/or Wi-Fi positioning. The CCS may determine the location of the MSDs in terms of store location descriptors. For example, the MSDs may transmit their current location to the CCS in terms of store location descriptors, or the CCS can determine the location of the MSDs in terms of store location descriptors based on other types of locations and/or using other techniques described herein.

In some implementations, the store may include other technologies that determine the location of the MSDs without communication from the MSDs. For example, in some implementations, the CCS may determine the location of MSDs. In one example, the store may be instrumented with cameras that identify the location of users inside/outside of the store. In these implementations, the CCS may identify store employees based on store uniforms, facial recognition, or other image processing techniques. In some cases, MSDs may transmit location signals to the central computing system. In other cases, the CCS may passively pick up the location of the handhelds, such as by using sensors (e.g., antenna, light-based, and/or sound-based sensors) in the store that pick up signals emitted by the handhelds. In some implementations, a user may wear a device (e.g., a tag) and/or an MSD may include a device (e.g., a tag) that transmits signals that indicate the location of the device. Accordingly, although the MSDs may report their locations to the CCS, the store/users may include additional/alternative location detection/reporting devices that report the location of the MSDs (e.g., based on images, RFID, Wi-Fi, light, or other techniques). In some cases, the CCS can determine the location of MSDs based on the location of the last item(s) scanned. The OFS may use the CCS determined locations for mapping the store, picking items, and routing as described herein.

The store can be mapped using one or more of the location technologies described herein. The CCS/MSDs may also use any of these location technologies to determine location of the MSDs within the store (e.g., their locations relative to items/zones) when picking items. Accordingly, any of the location technologies described herein may be used to arrange items for picking and for routing.

This disclosure describes a variety of ways to determine the location of MSDs, users, and/or items inside and outside of a store. For example, the CCS/MSDs may determine the areas/zones in which the MSDs, items, and/or employees are located. A location of an MSD (e.g., an area/zone) may be generally referred to herein as a “location,” an “MSD location,” or zone. Similarly, a location of an item/user (e.g., an area/zone) may be generally referred to herein as a “location,” an “item/user location,” or zone. Although the CCS/MSDs may use various technologies for mapping, picking, and routing, some features of the OFS do not require the use the MSD/user/item locations.

The CCS/MSDs may generate routes described herein using any of the location technologies described herein. For example, the CCS/MSDs may generate routes using location maps, adjacency maps, and/or image-based maps. As another example, the CCS/MSDs may generate routes using other location technologies described herein, such as geolocation mapping and store location descriptor mapping. For example, using location descriptor mapping, the CCS/MSDs may generate routes using department names, aisle names/numbers, and/or specific aisle locations (e.g., ends or middle of the aisle).

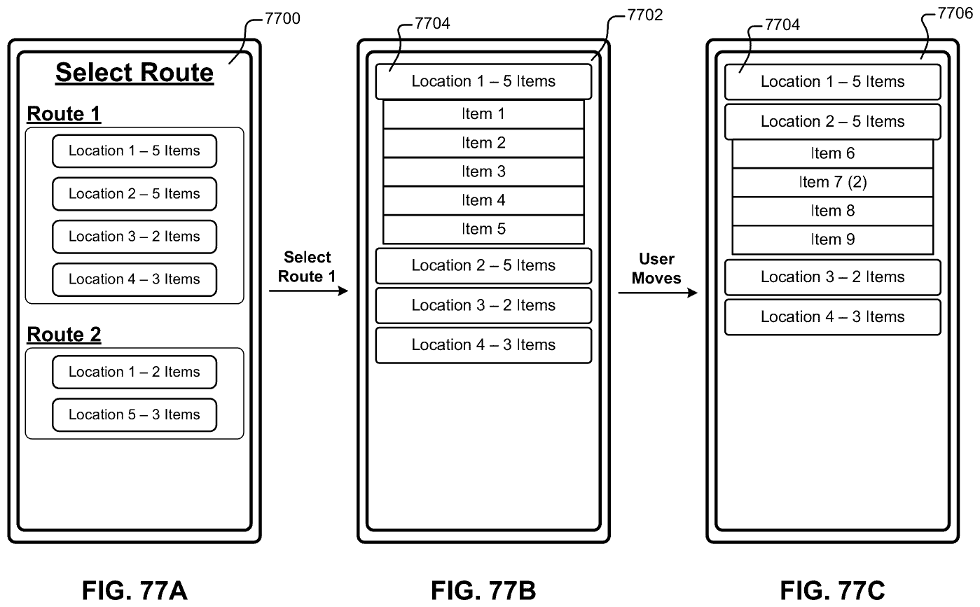

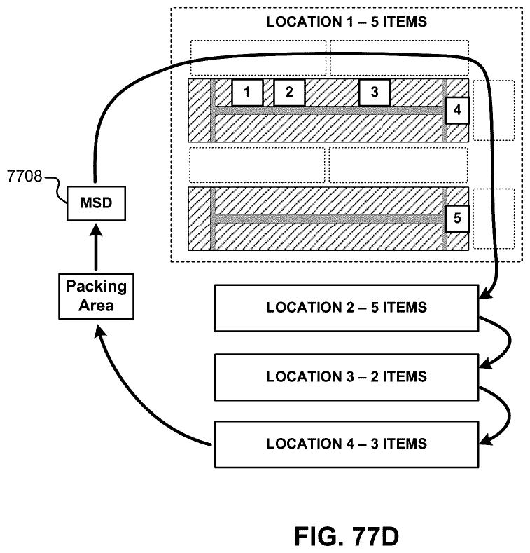

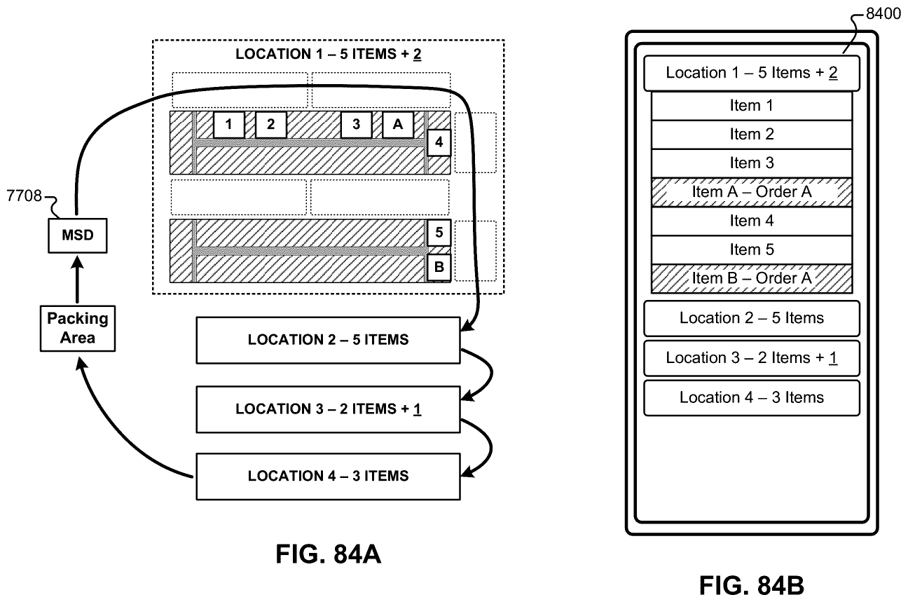

The CCS/MSDs may generate routes that include a series of locations defined by location descriptors. The locations defined by location descriptors may include one or more zones associated with the location descriptors. For example, a plurality of zones may each be associated with a single store department or aisle (e.g., see FIG. 77D). In this case, a route may include a series of locations defined by store location descriptors (e.g., store departments or aisles), where each location defined by a store location descriptor includes a plurality of zones through which the route may be traversed. FIG. 77D and FIG. 84A illustrate example zones associated with locations that may be defined by location descriptors, such as store department location descriptors (e.g., frozen department, meat department, produce department, etc.), aisle name/number descriptors, aisle location descriptors (e.g., end or middle), and/or item type descriptors associated with the zones (e.g., frozen, cereal, meat, seafood, etc.). In FIG. 77D and FIG. 84A, the route defines a series of locations in terms of store descriptors and zones associated with the store descriptors. In these examples, the zones may be viewed as groups of zones (e.g., groups of sub-zones), each group being under a common location descriptor. For example, in FIG. 77D and FIG. 84A, Location 1 (e.g., a store department name) includes 6 illustrated zones (e.g., illustrated by broken line rectangles).

In some cases, the CCS may be described herein as generating the routes for the one or more MSDs. Although the CCS may be described and illustrated herein as generating routes, the routes may be generated by one or more MSDs (e.g., store MSDs, third-party MSDs, customer devices, etc.), a TPCS, and/or other computing devices.

The CCS/MSDs may store data that identifies the users and MSDs. For example, the MSDs may be associated with a user ID that identifies the user using the MSD. In some implementations, the user may enter their user ID (e.g., a name, number, login, etc.) into an MSD before picking with the MSD. The user IDs may allow the CCS/MSDs to know the picking and movement history of the user. The CCS/MSDs may also know the picking and movement history associated with the MSDs based on the associated MSD IDs. In some implementations, the CCS may generate routes for MSDs based on the user (e.g., user ID) that is using the MSD. In some implementations, the CCS may generate routes for MSDs based on the MSD being used. For example, in some cases, a store may use the same MSDs for picking in the same locations. In a specific example, a store may have specific MSDs for picking specific departments and/or item types. MSDs may be associated with specific locations, departments, and/or item types in response to user input (e.g., selection of locations/departments/item types in a menu) and/or the MSDs may have preprogrammed associations (e.g., programmed before being used to pick new customer orders).

The CCS/MSDs may store current data and historical data associated with ordered items, picked items, and movement of the MSDs. For example, the CCS/MSDs may determine current picking data and current location data. The current picking data may include outstanding order/item data, such as a list of items currently out for picking and a list of one or more MSDs assigned to the pick the items. The current picking data may also indicate a total number of items to be picked and the total number of outstanding orders. The current picking data may also include a current picking rate (e.g., number of items picked over time) for each MSD and/or all MSDs. The current picking data may also indicate the total number of items being transported by the user based on the number of items scanned by the MSD prior to drop off at a collection/packing area or transfer to another user (e.g., to another user's cart). The total number of held items by a user may be used for determining a route for the user (e.g., to prevent assigning too many items to a user). In a specific example, the CCS may be configured to generate routes that cause a picker to pick fewer than a maximum threshold number of items (e.g., to prevent overburdening the user). Additionally, or alternatively, the CCS may be configured to generate routes that cause a picker to pick greater than a minimum threshold number of items (e.g., to sufficiently utilize the picker).

The current location data may indicate the current location of the MSDs. The current location data may also indicate the distance between the MSDs in terms of physical distances and/or number of zones. The current location data may also indicate the movement rate of the MSDs in terms of physical distances and/or in terms of zones (e.g., zones per minute). The CCS/MSDs may use the current picking data and current location data to trigger/generate/update/stop routes, along with other operations described herein.

The CCS/MSDs can store historical picking data, such as logs of the items picked by different users and MSDs over time. The historical picking data may include items picked, timestamps of when the items were picked, MSD IDs associated with the picked items, and/or user IDs associated with the picked items. In some examples, historical user picking data may include user/MSD specific historical data that indicates the items picked by the user and the time at which the items were picked. Historical user picking data may also include processed data, such as the number of each item picked, the frequency at which items were picked, and the sequence in which the items were picked. The CCS/MSDs may also store historical aggregate picking data related to picking of items by a plurality of users/MSDs. The aggregate picking data used for routing may include a summation of data from current active pickers in some cases.

The CCS/MSDs may also store historical user/MSD location data, such as logs of the user/MSD location over time. The historical user/MSD location data may indicate the user/MSD location in the store over time, such as time spent in zones, zone traversal patterns for users, and which routes were followed by the users. The historical user/MSD location data may use any of the location technologies described herein. For example, the historical user/MSD location data may define locations in terms of location values, location descriptors, and/or other location definitions. The CCS/MSDs may also store historical aggregate location data related to a plurality of user/MSD locations, such as where users/MSDs are located over time.

The CCS/MSDs may learn how one or more users pick items and move throughout the store based on the historical picking data and historical movement data. For example, the CCS/MSDs may learn which items the users pick and/or which areas of the store the users pick from. For example, the CCS/MSDs may learn that some users may typically be assigned to specific locations in the store. As another example, the CCS/MSDs may learn that once a user picks a set of items within a set of locations, the user may tend to be assigned to the area for picking. In a specific example, the CCS/MSDs may determine that users picking frozen items are assigned to a frozen foods department, which may be used by the CCS/MSDs to assign items at a later time to the users (e.g., the CCS may assign items that are typically picked by the users). The CCS/MSDs may also determine metrics for different users, such as their movement rate and picking rate (e.g., items per minute) to determine how efficient they are at filling orders. Knowledge of a user's picking rate and movement rate may be used to intelligently assign items to users in various locations of the store (e.g., the CCS may assign more items to a user that has a higher picking rate).

The CCS and/or MSDs may generate routes for MSDs to follow through the store. A route for an MSD may indicate a path through the store for the MSD. In some implementations, a route for an MSD may indicate zones through which the user should travel when picking items. In some implementations, a route may indicate items for the user to pick. The items assigned in a route may be selected from one or more customer orders. For example, the items may be for a single complete customer order, multiple complete customer orders, a portion of one or more customer orders, or one or more complete orders and one or more portions of other orders.

A route for a specific MSD may be referred to as an MSD route, an MSD routing plan, or an MSD-specific route. In some implementations, the CCS may generate a global routing plan that includes a plurality of individual MSD routes. The individual MSD routes and global routing plan may be stored by the CCS and/or the MSDs. The CCS and/or MSDs can generate and update the routes over time in response to a variety of factors. An update may be a small modification to items/zones in the route or may be an entirely different route with new items and/or zones. Routing one or more MSDs in the store may optimize picking in a variety of ways described herein. For example, routing may reduce order picking time, optimize the assignment of items to pickers, and minimize the amount of picker movement (e.g., based on the location of MSDs/items).

The MSD routes and global routing plan can be generated in a variety of manners, depending on the type of mapping technology used in the store. In some implementations, the MSD routes may be defined in terms of store zones (e.g., using location indicators). In some implementations, the MSD routes may be defined in terms of items (e.g., using item adjacency). In some implementations, the MSD routes may be defined in terms of other mapping technologies, such as GPS, Wi-Fi, or other technology. The MSD routes may also be defined as a combination of any of the above described mapping technologies.

A route may include a data structure that includes a set of zones through which the user should move and/or a set of items for the user to pick. As such, routes may be implemented to direct the movement of users and/or picking of items. Directing the movement of users and/or picking of items via a single MSD route and/or global routing plan may help ensure that user movement and/or picking time are reduced.

An MSD may have an MSD route that is assigned by the CCS, determined by the MSD, and/or assigned by another MSD (e.g., a primary/manager MSD may assign routes to secondary/employee MSDs). In some cases, an MSD may not have an MSD route. In these cases, the MSD may be in a free-roaming mode (i.e., an un-routed mode or roaming mode). In the free-roaming mode, a user may move the MSD throughout the store without a route. For example, the user may move the MSD throughout the store and the ordered items may be arranged on the MSD display without regard to a route (e.g., without regard to a fixed sequence of items/locations for picking).

The CCS may generate and assign routes (e.g., locations/items) to MSDs. Generation of a route may refer to generating a route data structure that includes one or more locations and/or one or more items to be assigned to an MSD. Assignment of a route to an MSD may refer to determining which MSD should be used to pick the route and/or sending the generated route to an MSD for picking according to the route. In some cases, the CCS may generate a route and store the route at the CCS prior to assigning the route to an MSD. For example, the CCS may generate a queue of routes that may be assigned to MSDs at a later time. In some cases, the MSD may receive a route and immediately begin implementing the route (e.g., adding items to the display for picking). In some cases, an MSD may store a queue of routes and implement the routes in sequence. For example, the MSD may display a first route that requires completion before beginning a second route.

A single MSD may operate in a roaming mode or operate according to a route. For example, an MSD may operate in a roaming mode until the MSD receives a route from the CCS, another MSD, or generates its own route. As another example, an MSD may allow a user to select whether the MSD operates according to a route (e.g., using a GUI selection menu button). In this example, a user may request a route from the CCS (e.g., using a GUI route request button), another MSD, or the generation of a route locally on the MSD. In some implementations, in the roaming mode, an MSD may not be explicitly instructed to pick specific items and/or traverse specific locations. Instead, in the roaming mode, a user may roam throughout the store and pick items in a flexible manner. In the roaming mode, items (e.g., all or any subset of currently ordered items) may be rearranged on the display as the user moves throughout the store. In some implementations, an MSD GUI may separate items that are on a route and items that may be picked while roaming. In some implementations, an MSD GUI may show items in a route until the route is completely picked, and then display items that may be picked while roaming (e.g., while heading to the packing area).

An MSD may operate according to a route in response to a variety of triggers, such as the satisfaction of route generation conditions/criteria (e.g., a small subset of items are near the MSD) detected by the MSD/CCS and/or in response to receiving a route from another computing device, such as the CCS or another MSD. The MSD may transition to a roaming mode after the route has been completed (e.g., according to route completion criteria, such as the picking of all items and/or the traversing of all zones). In another example, an MSD may allow a user to transition the device to a roaming mode (e.g., via selection of a GUI element). Transitioning an MSD between a roaming mode and a route may allow the user to be flexible in their picking. For example, it may allow the user to select whether they would like a route or whether they would benefit from flexibility not provided by a route.

In the case where multiple MSDs are being used to pick in a store, the MSDs may be in roaming mode and/or picking according to routes. For example, some of the multiple MSDs may be in the roaming mode while one or more other MSDs may be picking according to routes. As another example, all of the MSDs may be picking according to routes.

The number of zones and items included in one or more routes may vary. In some cases, different MSDs may be assigned routes (e.g., different routes or the same routes), such that each of the zones in the store and/or items in the customer orders are covered. In these cases, after picking according to the routes, all items of a customer order may have been picked. In some cases, a subset of zones and/or items may be covered by routes. In these cases, after picking according to the routes, some items may not have been picked. The remaining items may be picked with additionally assigned routes or by the roaming MSDs.

In some implementations, routes may include set zones and/or items, and may not be modified until completed. In other implementations, routes may be updated over time. For example, new items for picking according to new customer orders may cause modification of the routes. In a specific example, the CCS may update a route to include one or more items from newly received customer orders. As another example, deviation of an MSD from a route may cause updating of one or more of the routes. In a specific example, the CCS may update a route to include additional/alternative locations and/or sequences of locations in response to a user deviating from a route. In general, modification of routes may include addition/removal of items, addition/removal of zones, and/or modification of the sequence in which zones and/or items are to be picked.

The CCS/MSDs or other computing devices may generate the routes described herein. In some implementations, the CCS can generate the routes and assign the routes to one or more MSDs. In some implementations, an MSD may generate its own route. The MSD may communicate its generated route with the CCS and/or other MSDs. If multiple MSDs are used in the OFS, the other MSDs may determine their own routes (e.g., based on already generated routes) and communicate their routes with the CCS and/or one another.

In some implementations, an MSD may display items on the MSD route. For example, the items displayed on the MSD may be limited to those items on the MSD route. In this example, the route may cause a user to focus on picking the items on the route in the sequence (e.g., zone or item sequence) specified by the route. In these examples, certain items for the route may be sent to the MSDs from the CCS for picking, while other currently ordered items are not shown to the user on the MSD. In this case, the items that are not on the route may be unviewable by the user on the MSD. In some examples, the MSD may display additional items that are not on the route, but may still give preference to showing items that are on the route (e.g., arranging items off-route lower on the display). In this case, items that are not on the route may still be displayed for picking if the user deviates from the route (e.g., based on location). In some examples, items that are not included in an MSD route may be removed from the MSD display, thereby focusing a picker on the specific items in the route. The CCS/MSDs can arrange the items according to the route through the zones (e.g., closer zones have items that show higher/first on the display).

In some implementations, the MSD may start a route off in a set sequence of items and/or zones that are optimized (e.g., by the CCS), but then diverge from the route as the user moves. In these cases, the zones/items may be rearranged relative to the user's location, as described herein (e.g., closer items higher on the display).

The route(s) can be generated based on any item that is not yet picked, regardless of which items belong to the same customer orders. For example, the CCS/MSDs may generate a route that includes any of the items that have not yet been picked, whether those items are included in the same customer order or in different customer orders.

The route(s) may be generated on a customer order basis in which entire customer orders are assigned to each route. For example, each route may be assigned a single customer order. In some implementations, a single route may include multiple customer orders.

The route(s) may include any of the store's zones in any order. For example, a route may include all of the zones. As another example, different routes for different MSDs may include different subsets of zones. As another example, an MSD may receive different routes in sequence, where each of the assigned routes may include different sets of zones.

The CCS/MSDs may generate one or more routes that may be assigned to multiple MSDs (e.g., in parallel or in sequence to one or more MSDs). In some cases, different routes may include the same items (e.g., the same items from different orders). In some cases, different routes may include the same set of items (e.g., from the same orders), such as when multiple MSDs pick the same customer order. In other cases, different routes may include some items that are the same (e.g., from the same or different orders) and some items that are different. In other cases, different routes may be assigned different items that do not overlap with one another. The CCS/MSDs may be configured to generate routes with any amount of overlap in items, or no overlap at all.

Even though the arrangement of items/zones may be specified by a route, in some implementations, items may be rearranged on the MSDs based on the location of the MSD and/or the location of the items. For example, a subset of the items on the route may be rearranged on the MSD display based on the location of the MSD and/or the items. In a specific example, if a user moves through a zone on a route, the items within the zone may be rearranged on the MSD based on the proximity of the items to the user (e.g., based on adjacency), as described herein.

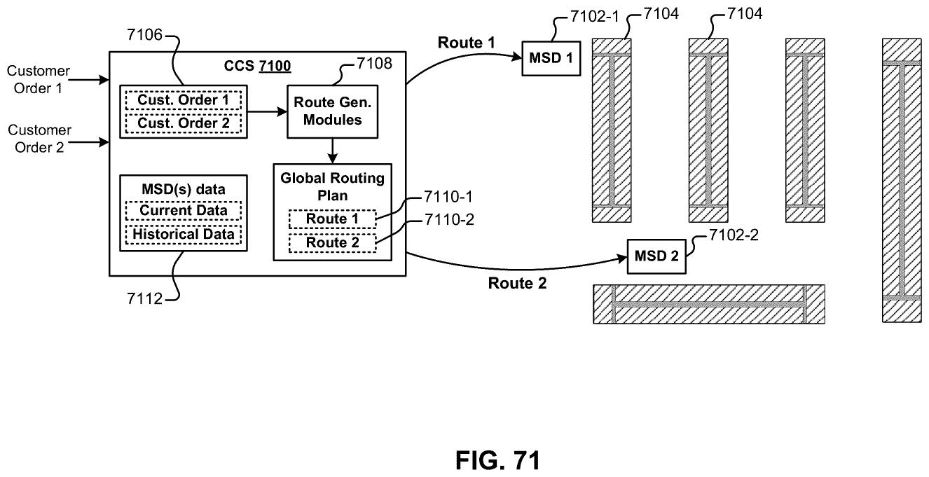

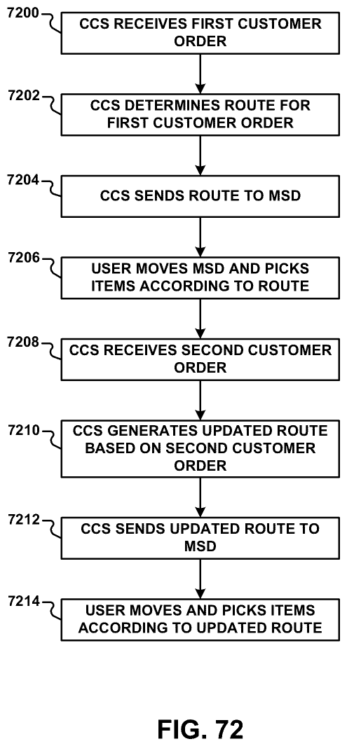

FIG. 71 illustrates an example CCS 7100, two MSDs 7102-1, 7102-2, and a portion of a store (e.g., a plurality of racks 7104). In FIG. 71, the CCS 7100 receives two customer orders, illustrated as customer order 1 and customer order 2. The CCS 7100 may store customer orders (e.g., in a customer order queue 7106). The CCS 7100 includes route generation modules 7108 that may generate one or more routes based on received customer orders. In FIG. 72, the CCS 7100 generates two routes 7110-1, 7110-2 (route 1 and route 2) based on the received customer orders. In some implementations, the CCS 7100 may generate routes based on historical and current MSD data 7112. The CCS 7100 sends the routes 7110 to the two MSDs 7102. Specifically, the CCS 7100 sends route 1 and route 2 to MSD 1 and MSD 2, respectively. As described herein, the routes may include any mix of items from the two customer orders.

The route generation modules 7108 may represent components of the CCS 7100 that implement some features attributed to the CCS 7100 herein. For example, the route generation modules 7108 may include computing devices/components (e.g., hardware/software) that implement some features attributed to the CCS 7100 herein. In one example, the route generation modules 7108 may generate routes for one or more MSDs, monitor the MSDs, and provide route updates. Although the CCS 7100 may implement the various features attributed to the route generation modules 7108 (e.g., route generation, route updates, etc.), in some implementations, route generation/updating features may be performed by a TPCS or other party. In some implementations, a TPCS may generate routes for third-party MSDs, monitor third-party MSDs, update routes for third-party MSDs, and perform other routing functionality described herein. In these implementations, the TPCS may generate/update routes for a plurality of MSDs in a plurality of different stores.

As described herein, the CCS 7100 (e.g., route generation modules 7108) may implement a variety of different algorithms to generate/update routes. For example, the CCS 7100 may generate routes using rule-based operations, such as a set of one or more rules to follow when generating a route (e.g., rules indicating which route generation factors to use). In some implementations, the CCS/MSDs may also implement one or more traversal algorithms in which the location maps (e.g., zones) or other maps are traversed according to various rules in order to determine routes (e.g., sufficient/optimal routes). In a specific example, the CCS/MSDs may implement tree/graph traversal algorithms on the location maps to determine routes. The CCS 7100 may also use optimization techniques that may be subject to constraints described herein. In some implementations, the CCS 7100 may implement scoring models to generate the routes, where one or more routes may be scored in order to identify the optimal route. In some implementations, the CCS 7100 may implement machine learning algorithms in order to identify routes. The route generation and update techniques described herein are only example techniques. As such, additional/alternative techniques may be implemented by the CCS to generate the routes.

FIG. 72 illustrates an example method that describes operation of the OFS in response to receipt of sequential customer orders. In the method of FIG. 72, the OFS includes a CCS and a single MSD. The method of FIG. 72 describes a scenario in which the MSD receives an initial route and then subsequently receives an update to the route based on a newly received customer order. In block 7200, the CCS receives a first customer order. In block 7202, the CCS determines a route for the first customer order. In block 7204, the CCS transmits (e.g., assigns) the route to the MSD. In block 7206, a user moves the MSD throughout the store and picks items according to the route. In block 7208, the CCS receives a second customer order (e.g., while the user is picking the first customer order). In block 7210, the CCS generates an updated route based on the second customer order. For example, the CCS may generate the updated route based on the second customer order, currently unpicked items from the first customer (e.g., unpicked items that are currently assigned to the first route), and/or other parameters described herein. In block 7212, the CCS sends (e.g., assigns) the updated route to the MSD. In block 7214, the MSD receives the route and the user may move throughout the store and pick items according to the route. The update to the route may include any types of updates described herein, such as a modification to zones and/or items on the route. For example, the updated route may include modification of the included zones/items and sequence of zones/items. In some implementations, the CCS may send the additional items/locations (e.g., modifications to the route) to the MSD for integration into the existing route. In some implementations, the CCS may generate a completely new route data structure (e.g., including already assigned items and new items) that the MSD may use as a replacement for the existing route. Although the route can be updated in real time when a second customer order is received, in some implementations, the CCS may hold the second customer order and assign the newly received order after the first route is completed (e.g., after all items of the first customer order are picked).

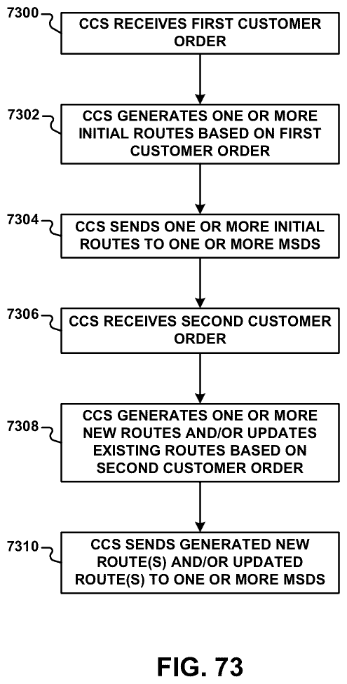

FIG. 73 illustrates an example method that describes operation of the OFS in response to receipt of sequential orders. In the method of FIG. 73, the OFS includes a CCS and two MSDs. In block 7300, the CCS receives a first customer order. In block 7302, the CCS generates one or more initial routes based on the first customer order. In one example, the CCS may generate one route including all items from the customer order. In another example, the CCS may generate two routes, each of which includes all items from the customer order. In another example, the CCS may generate two routes, each of which includes a subset (e.g., less than all) of the items from the first customer order. In block 7304, the CCS sends the one or more initial routes to one or more MSDs. In block 7306, the CCS receives a second customer order. In block 7308, the CCS generates one or more new routes and/or updates existing routes based on the second customer order. For example, the CCS may generate a new route for later assignment to one or more of the MSDs. As another example, the CCS may update routes for the MSDs. In block 7310, the CCS sends the generated new routes and/or updated routes to one or more MSDs.

An MSD route data structure may be implemented in a variety of ways. In some implementations, an MSD route may define one or more zones through which a user should move. In the case an MSD route includes a single zone, the zone may be a zone that the user is currently within, an adjacent zone, or another zone in the store. In the case an MSD route includes multiple zones, the zones may be contiguous or may include separations. For example, an MSD route that includes contiguous zones may include a route through a plurality of zones that are sequentially adjacent to one another. As another example, an MSD route that includes separations may include zones that are not adjacent to one another. In some cases, a route may include zones that are contiguous zones (e.g., adjacent) along with some zones that are separated.

In some examples, the plurality of zones may be ordered in a manner that causes the user to move according to the route. For example, the MSD route may include directional data that indicates a recommended or set direction through the zones. In a specific example, a route data structure may include numbers indicating the order through which the zones should be traversed. In another specific example data structure, the order of the zones in the data structure may imply the order through which the zones should be traversed.

In some implementations, an MSD route may indicate a zone at which to start. Similarly, an MSD route may indicate a zone at which to end. In one example, the MSD route may start at a user's current location. In another example, the starting zone may be adjacent to the user's location or farther away.

In some implementations, the routes may be fixed routes (i.e., set routes). Fixed routes may include a fixed set of zones to be traversed in order. In these examples, the items associated with the zones may be set in order for the user to pick. Additionally, in these examples, movement of the user in a direction that is out of order may not cause a change in the arrangement of items on the display. In some implementations, the routes may be recommended (e.g., suggested) routes. If the route is a recommended route, the user may deviate from the route and cause the items on the display to be updated according to their location (e.g., near items may be arranged higher on the display). In some cases, the items that are arranged on a display for a recommended route may be those items that are included on the recommended route. In these cases, the items on the recommended route may be rearranged on the display. In other cases, items other than those on the recommended route may be displayed based on their location from the user when the user deviates from the recommended route. In some implementations, some zones may be required to be traversed in sequence, while other zones may not be required to be traversed in sequence. For example, a final set of zones may be set, while the earlier zones may not be in a set sequence.

The CCS/MSDs may choose the starting location of a route in a variety of ways. For example, the starting location may be set to a fixed location in the store, such as near the entry of the store, near a shopping cart corral, near the packing area, or other location that the store has configured for starting a route. As another example, the starting location may be set to the picker's current location (e.g., a current MSD location). As another example, the starting location may be another location, such as a location of a first item of a route. As another example, a starting point may be set to a zone that is currently near a user.

The CCS/MSDs may choose the stopping location (i.e., ending location) of a route in a variety of ways. For example, the stopping location may be set to a fixed location in the store, such as near/in a collection/packing area for the items, near a checkout register, near a customer pickup area, or other location that the store has configured for stopping a route. As another example, the stopping location may be set to a location of the final item on the route. As another example, the stopping location may be set to a zone that includes the final item of the route. As another example, the stopping location may be based on the number of items picked (e.g., a predetermined number of items causes a stop in the route generation).

The CCS/MSDs may choose the locations between the starting location and the stopping location in a variety of ways described herein. In some implementations, the routes may include set locations to traverse between the starting and stopping locations. The set locations may be in a fixed order or the user may have flexibility in the route. For example, a user may have flexibility in the route where the route includes a set of zones for traversal, but allows for traversal in more than one way.

A route may include any number of zones. In some cases, a route may include a single zone (e.g., including the user, adjacent to the user, or any distance from the user). In other cases, a route may include a plurality of zones, such as a starting zone to a stopping zone (e.g., in a packing zone). In some cases, a route may be a short burst of zones (e.g., a few zones) that are near the user. After picking items from the route, the user may continue to pick in a roaming mode or receive another route, as described herein.

In some implementations, an MSD may be configured to display a variety of information associated with routing a user. In some implementations, an MSD may display the current route to a user. For example, the MSD may display racks, items, and/or zones on the display. The MSD may render the route based on the mapping data along with other maps that describe the locations of the racks in the store. In some implementations, items that are to be picked for the route may be indicated in a GUI (e.g., using text, a symbol, color, and/or a label). In these implementations, the CCS may restrict the picker to picking the indicated items on the route before receiving another route. The GUI may also notify a user when the MSD has scanned an item that deviates from an item assigned on the route. In some implementations, the GUI may indicate to the user when the user has deviated from a route. For example, the GUI may indicate (e.g., using text, color, symbols) when the user has traversed through zones out of sequence and/or when the user has moved to a zone that is not included in the route.

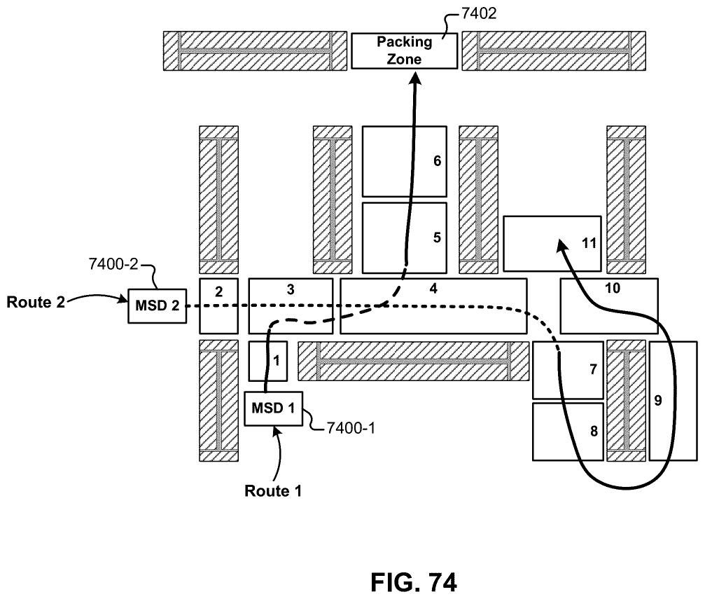

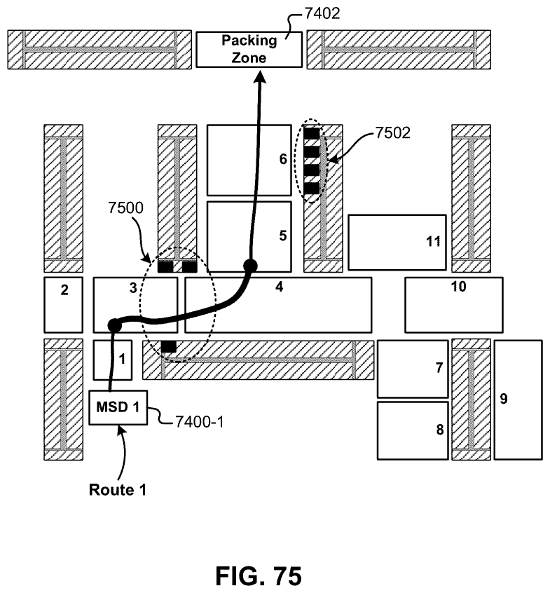

FIGS. 74-75 illustrate an example store that includes 2 MSDs 7400-1, 7400-2 that each pick according to different routes. For example, in FIG. 74, MSD 1 7400-1 and MSD 2 7400-2 pick according to received route 1 and route 2, respectively. The locations (e.g., zones) are illustrated as numbered rectangles (e.g., zones 1-11). The store in FIGS. 74-75 include a packing zone 7402, which may be a zone in which store employees pack items that are picked by the users. For example, pickers using MSDs to pick orders, or other users, may pack items in the packing zone 7402 for customer pickup or delivery. Although 11 zones and a packing zone 7402 are illustrated, the store may include other zones. Although the store may include a “packing zone,” in some cases, the users may be packing the items as they are picked. In this case, the zone may refer to a location in the store in which items are collected for pickup/delivery. Note that the location at which items may be packed and/or collected for pickup/delivery may be described herein generally as a packing/collection location. The packing/collection location may also be referred to as a “packing/collection area” or a “packing/collection zone.” The packing/collection area may be defined using any of the location mapping technologies described herein.

In FIG. 74, MSD 1 7400-1 receives route 1 from the CCS. Route 1 starts in zone 1, which is adjacent to MSD 1 7400-1 when route 1 was assigned. Route 1 includes zones 5-6 and terminates at the packing zone. An example path taken by MSD 1 7400-1 is illustrated by a line that is partially solid and partially broken. The solid line may indicate assigned zones that may include items for picking by the user of MSD 1 7400-1. The broken line may indicate a path taken by MSD 1 on the way to zone 5. As described herein, the CCS may generate a route for MSD 1 including zone 1 due to the proximity of MSD 1 to zone 1. The CCS may also generate a stopping point for MSD 1 as the packing zone so that the user of MSD 1 can drop off the picked items. Zones 5-6 may have been assigned to MSD 1 due to the location of the zones 5-6 between a starting zone 1 and a terminal packing zone.

In FIG. 74, MSD 2 7400-2 receives route 2 from the CCS. Route 2 starts in zone 7, which is distant from MSD 2 7400-2 when route 2 is generated. Route 2 includes zones 7-11. Route 2 terminates in zone 11. In some cases, MSD 2 7400-2 may continue picking (e.g., in a roaming mode) at the end of the route. In other cases, MSD 2 7400-2 may be assigned a new route after the end of the route in zone 11. In other cases, the user may drop the picked items off at the packing zone 7402, even though the packing zone 7402 is not on route 2. In some implementations, route 2 may have been generated after route 1 (e.g., in a case in which the CCS assigns routes sequentially), which may have resulted in route 2 being a route that does not start local to MSD 2 7400-2, as route 1 had been assigned items near MSD 2.

Note that route 1 and route 2 of FIG. 74 illustrates a case in which routes may start near MSDs or distant from MSDs. FIG. 74 also illustrates how some zones in a route may be contiguous, or may be separated. FIG. 74 also illustrates how a route may end at a packing zone or at another zone (e.g., zone 11) that is distant from the packing zone (e.g., not adjacent to the packing zone).

FIG. 75 illustrates example updates received by MSD 1 7400-1 during route 1. MSD 2 and route 2 have been removed to simplify the illustration (e.g., relative to FIG. 74). For example, in FIG. 75, route 1 received an update to include new zones 3-4, as illustrated by the thick line over top of zones 3-4. It may be assumed that MSD 1 7400-1 received the updated route shortly after receiving route 1 illustrated in FIG. 74. For example, MSD 1 7400-1 may have received the updated route while picking in zone 1. The updated route includes new items (dark boxes on racks) 7500 from a new customer order in zones 3-4, which are new zones assigned to the route. The new zones (e.g., a burst of zones) may have been added to the updated route based on the proximity to other zones/items already on route 1. For example, the new zones may have been added to route 1 because the new zones are in between zone 1 and zone 5 such that the zones were on a probable path between existing zones in the route. In the specific example illustrated in FIG. 75, the CCS may have added the new zones because 1) the zones are near other zones on the existing route, 2) the zones were on a probable path to be traversed by the user, and/or 3) the addition of the zones caused the formation of a contiguous path in the route. The new zones may have also been added based on a proximity of MSD 1 7400-1 to the zones. Also note that the updated route includes new items 7502 associated with zone 6, which was already on route 1 before the update. The new items may have been assigned to the updated route based on inclusion of zone 6 in the already assigned route 1.

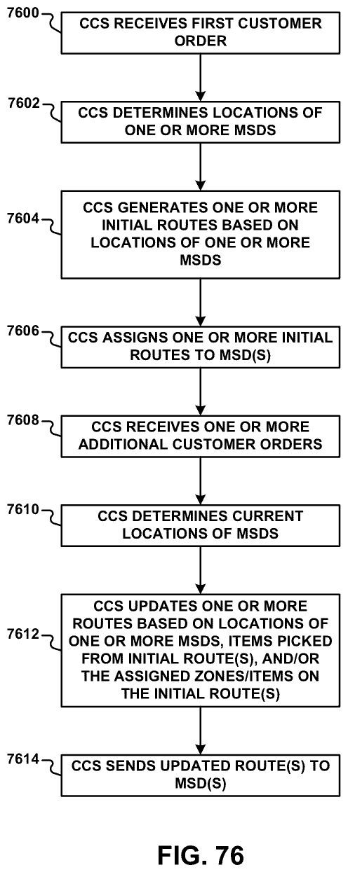

FIG. 76 illustrates an example method for generating and updating routes based on a variety of factors, such as the locations of one or more MSDs, items picked by the MSDs from the initial routes, and/or assigned zones/items in the initial route(s). In block 7600, the CCS receives a first customer order. In block 7602, the CCS determines the locations of one or more MSD(s). In block 7604, the CCS generates one or more initial routes based on the locations of the one or more MSDs. For example, with respect to FIG. 74, the CCS may have generated route 1 based on the initial location of MSD 1 7400-1. In block 7606, the CCS assigns the one or more initial routes to the MSD(s).

In block 7608, the CCS receives one or more additional customer orders. In block 7610, the CCS determines the current locations of the one or more MSDs. In block 7612, the CCS updates one or more routes based on at least one of 1) the locations of the one or more MSDs, 2) items that have been picked from the initial routes, and 3) the zones/items that have been assigned in the initial routes. For example, with respect to FIG. 75, route 1 may have been updated to include additional zones and items based on one or more of the factors in block 7612. In block 7614, the CCS sends the updated route(s) to the MSD(s).

FIGS. 77A-77C illustrate example MSD GUIs. In FIGS. 77A-77C, a user selects a route and then moves throughout the store. The MSD modifies the GUI in response to the user movement. The GUIs illustrated in FIGS. 77A-77C are only example GUIs. As such, the MSDs may generate additional/alternative GUIs than those explicitly illustrated herein.

In FIG. 77A, the CCS has generated route 1 and route 2. The CCS has also provided the routes to the MSD for selection by the user. For example, the GUI 7700 in FIG. 77A prompts the user to select one of two routes. The GUI 7700 includes a summary of the routes including the locations in the routes and the number of items in each location. The summary may also indicate the order of the locations through which the route will traverse. For example, route 1 may proceed from a starting Location 1 to an ending Location 4. The GUI summary information presented to the user may help the user decide which route to select. As described herein, the routes presented to the user for selection may be presented based on user device location (e.g., relative to items/zones), user historical preferences (e.g., for picking items and/or moving in zones), a user request for a set of routes, and/or other factors.

The user may interact with the GUI 7700 to select a route. For example, a user may touch/click a route on a touchscreen display to select the route. In FIG. 77A, the user selects (e.g., touches) route 1. In response to selecting route 1, the MSD may render the GUI 7702 illustrated in FIG. 77B. The GUI 7702 in FIG. 77B may convey a variety of types of route information. The arrangement of the locations (e.g., Location 1-4) from top to bottom may indicate the sequence of locations through which the user will travel while picking items. For example, while picking route 1, the user may travel through Locations 1-4 in sequence. The items associated with a single location (e.g., a location descriptor, such as a store department, aisle number, aisle name, etc.) may be grouped together with a location tab (e.g., 7704) indicating the location (e.g., location descriptor) with which the items are associated. In one example, the locations listed in the location tabs (e.g., location tab 7704) may be location descriptors. For example, Location 1 tab 7704 may be the name of an aisle, department, or other location in the store. In FIGS. 77A-77C, it may be assumed that the listed locations (e.g., Location 1-4) are in terms of location descriptors. Although the GUIs may include groupings of items according to location descriptors, the items may be grouped according to locations using any of the location technologies described herein.

FIG. 77D illustrates an example route (e.g., illustrated by arrows) that may correspond to the route 1 GUIs 7702, 7706 illustrated in FIGS. 77B-77C. For example, FIG. 77D illustrates an MSD 7708 that may have selected route 1 while leaving the packing area (e.g., after dropping off previously picked items). In FIG. 77D, the MSD 7708 follows route 1 through Locations 1-4 and picks items on the route (e.g., items 1-5). After picking all items, route 1 may lead back to the packing area (e.g., a route stopping point) so that the user can drop off the picked items. Such a route as illustrated in FIG. 77D may be used for efficient picking and packing of customer orders because a user may immediately begin picking upon dropping off items and leaving the packing area. Additionally, the user may be routed in a manner that leads them back to the packing area for packing the newly picked route. The CCS may generate such a route by constraining the starting and stopping points to the packing area or other locations near the packing area.

In FIG. 77D, Location 1 and items 1-5 are illustrated in detail. Location 1 (e.g., a store department, aisle number, etc.) may include a plurality of zones, which are illustrated as broken line rectangles. The zones may be defined according to any location technique described herein. In FIG. 77D, each of the Locations 1-4 may include a plurality of zones that may act as “sub-locations” or “sub-zones” in an overall route.

In FIG. 77B, the GUI 7702 includes the items arranged in the route based on the locations associated with the items, as described herein. For example, items 1-5 may be assigned to be picked in order on the route (e.g., see FIG. 77D). In some implementations, the GUI may rearrange the items based on the location of the MSD relative to the items. For example, while maintaining the location tabs as illustrated in FIG. 77B, the GUI may rearrange items 1-5 as the user moves throughout Location 1. In a specific example, with respect to FIG. 77D, if the user moves near item 5, the GUI may rearrange the items to list item 5 at the top of the GUI. In this specific example, the GUI may also rearrange items 4-1 in descending order based on distance from the MSD. Although the GUI may rearrange items within the location tab 7704 as the user moves within Location 1, in some implementations, the GUI may maintain the arrangement of items within the location tab (e.g., as a fixed route) as the user moves within the location.

FIG. 77C illustrates an example GUI 7706 generated based on user movement while picking route 1. In FIG. 77C, the user has moved into Location 2 (e.g., a new store department, store aisle, etc.). In response to entering Location 2 (e.g., a zone in Location 2), the GUI 7706 renders items included on the route in Location 2. Specifically, in FIG. 77C, the GUI renders items 6-9 as a list that may be arranged with the closest items near the top of the list. Item 7 includes a (2) indicator that indicates two of item 7 should be picked on the route. Although the location tabs indicate a total number of items to be picked (e.g., Location 2 has 5 items total), in some implementations, the GUI may indicate a total number of different items to be picked in a location. In these implementations, the GUI (e.g., a location tab) may indicate the number of repeat items in the route. In a specific example of these implementations, the Location 2 tab may indicate “Location 2-4 Items (1)” to indicate that there are 4 different items to pick, where one of the items is to be picked multiple times.

Note that the items for Location 1 may be collapsed back into the Location 1 tab upon a user entering Location 2. In the example of FIGS. 77B-77C, the user may not have picked items from Location 1 prior to entering Location 2, as the Location 1 tab still indicates 5 items are remaining. Although the list of items associated with Location 1 have collapsed in FIG. 77C, the MSD may generate GUIs that do not expand/collapse depending on user location. In these cases, the location tabs and items may be fully listed in the GUI and may or may not rearrange in response to user movement.

Note that the location tabs in FIGS. 77B-77C remain in the same arrangement as the user moves throughout the store. Although the location tabs may be stationary in the GUI during user movement, in some implementations, the MSD may rearrange the location tabs and groups of associated items based on the user's location relative to the Locations 1-4. For example, in other implementations, in FIG. 77C, Location 2 may be rearranged at the top of the display to indicate that the user is closest to Location 2 (e.g., inside Location 2).

The user may interact with the GUIs of FIGS. 77B-77C in a variety of ways. In some implementations, the user may scroll through the locations and items. For example, the user may swipe the display (e.g., a touchscreen) to move the list of locations and items up and down the screen. Swiping the screen to view the locations/items may provide a preview of the route for the user, which may help the user fully understand their future picking strategy. Note that the locations and items illustrated in FIGS. 77B-77C do not fill the screen. As such, swiping may not be required to view all locations/items in the route, whereas a longer list of locations/items may not be completely viewable on the screen without swiping. In some implementations, the user may select (e.g., touch/click) the location tabs to expand/collapse the list of items associated with the location. For example, a user may select (e.g., touch) the Location 1 tab 7704 in FIG. 77B to collapse the items back into the Location 1 tab 7704 (e.g., as illustrated in FIG. 77C). As another example, a user may select (e.g., touch) the collapsed Location 2 tab in FIG. 77B to expand the list of items under the Location 2 tab (e.g., as illustrated in FIG. 77C).

As described herein, the items may be removed from list as the user picks and scans the items. The location tabs may also be removed from the GUI after all items have been scanned for the location. After completion of the route, the GUI may display a route completion GUI element, such as text indicating that “Route 1 is complete.” If route 1 included a complete customer order, upon completion of the route, the GUI may display an order completion GUI element, such as text indicating “Order completed” or “Order completed. Return to packing area.”

Although not illustrated in FIGS. 77B-77C, in some implementations, the GUI may include additional items that a user may pick, such as items that are not on the route and/or items that have not been ordered by a customer (e.g., non-ordered items described herein). The additional items may be rendered as a list under the other items on the route. The additional items may be arranged based on user location in a manner that is similar to the items in FIGS. 77B-77C. In scenarios without an assigned route (e.g., roaming), the MSD may also arrange items as illustrated in FIGS. 77B-77C. For example, if the MSD is operating in a roaming mode (e.g., based on user selection of a roaming GUI element), the items may be arranged by location as illustrated in FIGS. 77B-77C.

In some implementations, the user may choose to quit picking the route. For example, the user may select a route ending GUI element, such as a “Stop Route” GUI button that causes the route to end. In this example, the route may be removed from the GUI. Additionally, the items in the route may be included in another route and reassigned to another user, or the same user at a later time.

In some implementations, an MSD route may define one or more items to be picked by the MSD. For example, the MSD route data structure may include a plurality of items. The MSD route may also indicate an order in which the items should be picked. The items in the route may be associated with zones in some cases, which may allow the items to be rearranged on the display when a user moves through the store and/or rearranged based on item adjacency of user-scanned items or automatically scanned items. In other cases, the item sequence may be set, such that the item arrangement on the screen does not change when a user moves throughout the store. In these cases, the MSD route data structure may include items, but does not require associated zone data. In some implementations, the MSD and/or CCS may arrange the items in the route based on maps or using other techniques.

In some implementations, an MSD route (e.g., route data structure) may specify that some items must be picked before other items and/or that some items may be picked at any time. For example, frozen/cooled items may be associated with a restriction that they are picked last before packing. In this example, the frozen/cooled items may be located farther down on the picking list to promote later picking. In some cases, the items that are required to be picked at a later time may be shown to the user after (e.g., only after) the prior items are picked. For example, the frozen/cooled items may be included in the GUI in response to picking other items that are not frozen/cooled. In some implementations, the MSD may limit the display of items to just the items being picked on the route (e.g., not display other items).

In some implementations, an MSD route may include a fixed set of items. In these implementations, the items included in the MSD route may not change, except to be removed from the display when the user picks the items. In other implementations, an MSD route may add items to the route as new items are received for customer orders. For example, items that are near to the route (e.g., adjacent items and/or items in nearby zones) may be added to the route. As another example, the CCS may assign newly received items to a route that already includes the items. In this example, items that are already on the route may have their numbers incremented in the MSD GUI if new customer orders including the items are received.

In some implementations, an MSD route may indicate an item at which to start picking. Similarly, an MSD route may indicate an item at which to end. For example, the MSD route may start with a nearby item and end with an item that is farther away. In other examples, the starting item may be an item that is farther away (e.g., not adjacent or in the same/adjacent zone). In other examples, such as when a user is leaving a packing zone after dropping off items, the first item(s) may be near the user as they exit the packing zone and the last items on the route may also be near the packing zone (e.g., on the return path to the packing zone). In some cases, the items along the route may be adjacent to one another. In other cases, the items in a route may be farther away from one another (e.g., not adjacent or in the same/adjacent zone). In some implementations, the MSD GUI may indicate the starting and/or stopping items/locations when the route is assigned in order to give the user a sense of the picking path. Similarly, in some implementations, the MSD GUI may indicate the route to the user in a manner that provides the user with the general route in between the start and stop, such as a list of zones and/or items. For example, the MSD GUI may present a selected group of items and/or aisles that will be picked in order to provide the user a sense of the path for picking. In some implementations, the user may scroll down the MSD GUI to preview the entire route items/locations in order to learn the route before starting.

A route may include any number of items. In some cases, a route may include a single item (e.g., near the user or at any distance from the user). In other cases, a route may include a plurality of items, such as a starting item and a stopping item (e.g., near a packing zone). In some cases, a route may be a short burst of items (e.g., a few items) that are near the user. After picking items from the route, the user may continue to pick in a roaming mode or receive another route, as described herein. Although a route may be a short burst of items, in some implementations, the route (e.g., a route modification) may be generated as a short burst of locations (e.g., near the user/route) to which items are added (e.g., items in the short burst of new locations).

In some implementations, an MSD route may be based on a sequence of items for the user to pick. For example, the CCS may generate an MSD route based on a single customer order, which may include all of the items from the customer order or only a subset of the customer order. As another example, the CCS may generate an MSD route based on a plurality of items from different customer orders (e.g., complete customer orders and/or portions of different orders). In some cases, an MSD route may be generated for a specific set of items that the user is supposed to pick without an update. In other cases, items from newly received customer orders may be sent to the MSD as the user is picking according to the route (e.g., new adjacent items or items in the same zones).

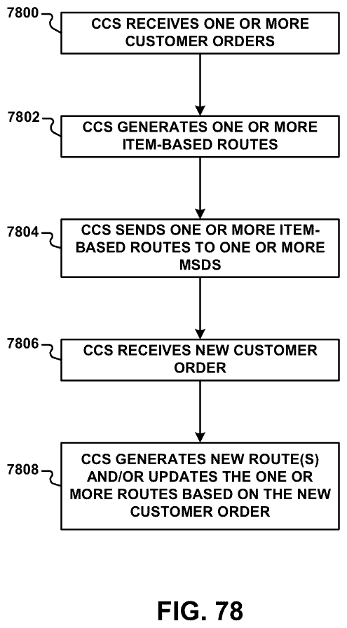

FIG. 78 illustrates an example method that describes generation of one or more routes in which at least some routes are item-based routes in which the sequence of items in the routes may be set. In block 7800, the CCS receives one or more customer orders. In block 7802, the CCS generates one or more item-based routes based on the received customer orders. In some implementations, the item-based routes may include a sequence of items that do not change based on the location of the MSDs. Additionally, the CCS may generate one or more other routes that may be more flexible (e.g., change based on location). In block 7804, the CCS sends the one or more item-based routes and other routes to one or more MSDs. In block 7806, the CCS receives a new customer order. In block 7808, the CCS generates new routes and/or updates the one or more previously sent routes based on the new customer order. In some cases, an item-based route may be updated to include new items, remove items, and/or increment the number of items to be picked in the route.

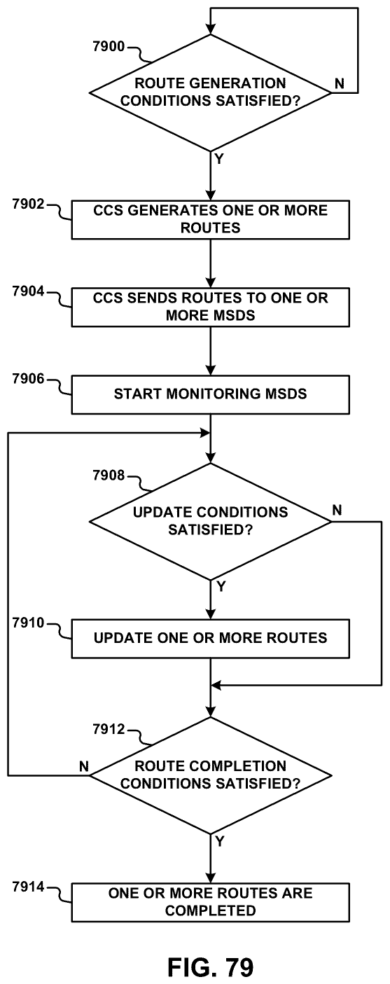

FIG. 79 illustrates an example method that describes operations associated with generating routes, monitoring routes, updating routes, and ending routes. The operations described in FIG. 79 are only example operations that may be performed by the CCS. Although FIG. 79 describes a scenario where the CCS performs the route generation, monitoring, and update operations, one or more MSDs may also perform the operations.

In block 7900, the CCS determines whether route generation conditions are satisfied. Route generation conditions may refer to conditions that, when satisfied, cause the CCS to generate a route for one or more MSDs. Example route generation conditions may include, but are not limited to: 1) receipt of a customer order, 2) receipt of a threshold number of items, 3) request for a route from an MSD, 4) completion of a currently assigned route, and 5) other conditions described herein. In block 7902, the CCS generates one or more routes in response to satisfaction of the route generation conditions. The CCS may generate an MSD route based on a variety of factors described herein.

In block 7904, the CCS sends the generated routes to one or more MSDs. In block 7906, the CCS starts monitoring the routes sent to the MSDs. For example, the CCS may determine the locations of the MSDs and determine which items have been picked by the MSDs. The CCS may also monitor the location and picking by MSDs that do not have assigned routes (e.g., roaming MSDs). The CCS may monitor the MSDs to determine whether it is time to generate/update routes.

In block 7908, the CCS determines whether route update conditions are satisfied for one or more routes. Route update conditions may refer to conditions that, when satisfied, cause the CCS to generate one or more route updates (e.g., route modifications to existing routes). In some cases, the CCS may determine whether route update conditions are satisfied based on monitoring the MSD(s) (e.g., MSD locations and/or items picked). Route update conditions may include other factors, such as receipt of new customer orders.

In block 7910, the CCS generates updates to one or more routes in response to satisfaction of update conditions. If update conditions are not satisfied, the CCS may determine whether route completion conditions (e.g., route ending conditions) are satisfied in block 7912. Route completion conditions may refer to conditions that, when satisfied, indicate that an MSD route has ended, or otherwise is completed. Example route completion conditions for a route may include, but are not limited to, having all items picked in the route, having all zones traversed in the route, and other route completion conditions described herein. In block 7914, the CCS may determine that one or more assigned routes have ended in response to satisfaction of the route completion conditions. After one or more routes are completed, the method may continue in block 7900, where the CCS determines whether to generate one or more new routes. In some cases, the MSD may operate in roaming mode after a route has ended. In other cases, the MSD may be taken offline (e.g., turned off or disconnected from the CCS) or wait for a new route after completion of a route. Although the method of FIG. 79 is illustrated as sequential operations including route generation, monitoring, and updating, the CCS may perform the route generation, monitoring, and updating operations for one or more MSDs in parallel.

Route generation conditions may include conditions associated with receiving a new customer order. For example, the receipt of one or more new customer orders may cause the CCS to generate a new route. In a specific example, each customer order may trigger generation of a single new route. In other cases, a threshold number of customer orders may be required to generate a new route. In some implementations, a route generation condition may indicate that a threshold number of items (e.g., from one or more customer orders) should trigger the generation of a route.

In some implementations, route generation conditions may include conditions associated with activity of the MSD. For example, a route generation condition may be satisfied when a user uses an MSD to indicate that they are picking by turning on the MSD or entering their user credentials (e.g., name/login/employee ID). In some implementations, the MSD may provide a GUI for the user to request a route (e.g., a graphical/manual route request button). In some implementations, the MSD may automatically request a route, such as when the MSD is turned on and/or when the MSD has completed a currently assigned route. For example, completion of an already assigned route (e.g., the picking of items or movement through all zones) can cause another route to be requested by the MSD.

In some implementations, the route generation conditions may include conditions associated with historical/current locations of a user. For example, a route may be generated in response to a user entering, or being near (e.g., within a threshold number of zones), a zone/items associated with an outstanding customer order. In another example, a route may be generated in response to a user moving toward a zone/item associated with an outstanding customer order. In another example, a route may be generated and assigned to an MSD in response to an MSD being located in a specified location, such as a location that indicates that the user is ready to pick a route (e.g., a typical/assigned starting location within the store). In this example, the user may enter the location and have a route assigned automatically.

In some implementations, the route generation conditions may include conditions associated with one or more recently picked items. For example, a route may be generated in response to a user picking one or more items from a current outstanding customer order (e.g., while roaming). In this example, the route may be generated to include items from the customer order. In another example, a route may be generated in response to a user picking items that are near items (e.g., adjacent items) in the customer order. In this example, picking of the items near items in an outstanding customer order (e.g., a newly received order) may cause the CCS to generate a route including items from the outstanding customer order. In another example, if a roaming MSD has picked items that are included in an outstanding customer order, the CCS may generate a route for the MSD to pick remaining items in the customer order (e.g., the complete order).

In some implementations, routes may be generated for a first MSD based on conditions associated with one or more other MSDs. For example, a route may be generated for a first MSD based on the locations of one or more other MSDs. In a specific example, a route generation condition may indicate that a route should be generated for a first MSD when one or more other MSDs are located near a packing zone (e.g., near the end of their routes). As another specific example, a route generation condition may indicate that a route should be generated for a first MSD when one or more other MSDs are already picking their routes, such as when the other MSDs are sufficiently into their routes (e.g., based on the locations/items they have picked).

One or more of any of the route generation conditions, or other conditions, may cause the generation of a route. In some implementations, the route generation conditions described herein may be set by the operator of the OFS. In some implementations, the route generation conditions may also cause an assignment of the generated route. In some implementations, the OFS may also implement separate route assignment conditions, which may include similar/different conditions than the route generation conditions.

Routes can be generated according to a variety of different route generation operations described herein. The route generation operations may generate the routes based on a variety of different route generation factors. Although specific route generation operations/factors are described herein, different route generation operations/factors may be combined in ways not explicitly described herein. In some cases, the CCS and/or MSDs may generate routes using the same route generation operations/factors for each route. In other cases, the CCS and/or MSDs may generate routes using different route generation operations/factors. For example, some routes may be set, while other routes may be generated based on the location of one or more MSDs.

Multiple route generation operations/factors are described herein. In some implementations, routes may be generated based on a single factor (e.g., based on the location of the MSD). In other implementations, routes may be generated based on multiple factors, such as the location of MSDs, the contents of customer orders, the routes assigned to other MSDs, the ability of an MSD to complete a customer order, and other factors. As such, route generation may be a multifactor operation based on any factors described herein. In some implementations, the CCS/MSDs may generate routes using rule-based operations, such as a set of one or more rules to follow when generating a route (e.g., rules indicating which factors to use). In some implementations, the CCS/MSDs may prioritize some factors over other factors (e.g., according to rules). For example, the CCS/MSDs may prioritize the current location of MSDs over the historical location of MSDs when generating routes. In some implementations, the CCS/MSDs may implement a scoring model in which different possible routes for an MSD are scored, and the highest scoring route is assigned (e.g., highest scoring indicates a best route). For example, a scoring module (e.g., in the route generation modules 7108) at the CCS/MSDs may apply different weights and scores to different aspects of a route (e.g., route length, item number, distance from MSD, etc.). In some implementations, the CCS/MSDs may implement a machine learned model for generating routes/scores, where the machine learned model receives different routing factors as inputs. The machine learned model may be trained on historic picking/movement data. In some cases, the CCS can generate multiple possible routes and calculate the optimized route for one or more MSDs before sending out the final routes to the MSDs.

Although routes may be generated based on the location of one or more MSDs, in some implementations, the OFS of the present disclosure may generate routes without knowledge of MSD location. Furthermore, in some implementations, the OFS of the present disclosure may not implement the location-based techniques described herein. As such, some implementations of the OFS may implement techniques described herein without location-based technologies (e.g., location indicators, item adjacency, etc.).

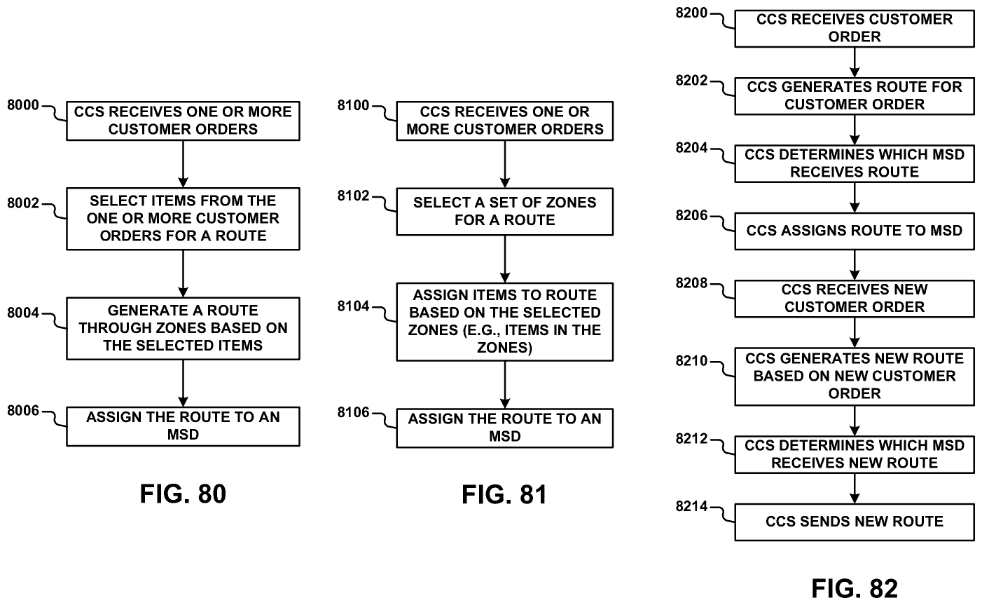

FIG. 80 illustrates an example method for generating a route. The method of FIG. 80 may be referred to as an item-first technique for generating routes. In FIG. 80, the CCS first selects the items to be included in a route (e.g., in one or more customer orders), and then defines locations (e.g., zones and zone sequence) that should be traversed for the user. In some cases, the CCS/MSD generates a list of items for the route (e.g., based on one or more customer orders) and sends the list of items to the MSD without location information, such that the MSD does not use the zone data. For example, the MSD may receive a static list of items that is arranged in a set manner, which may not be modified, unless an update is sent to the MSD and/or the MSD uses item adjacency to arrange the items.

Referring to FIG. 80, in block 8000, the CCS receives one or more customer orders. In block 8002, the CCS selects items from the one or more customer orders for a route. In block 8004, the CCS generates a route through a set of zones based on the selected items. In block 8006, the CCS assigns the route to an MSD. After assigning zones to the route, additional items/zones may be added or removed based on other factors.

FIG. 81 illustrates an example method for generating a route. The method of FIG. 81 may be referred to as a location-first technique for generating routes. In FIG. 81, the CCS first picks the locations (e.g., zones) to be included in a route for the MSD, and then defines the items that should be picked for the route. For example, the CCS may select items for the route that are included in, or near, the selected zones. In the case where location data isn't included in the route, the list of items may just be sent to the MSD as a static list of items, or as a list of items that may be modified/rearranged.

Referring to FIG. 81, in block 8100, the CCS receives one or more customer orders. In block 8102, the CCS selects a set of zones for a route (e.g., one or more zones). For example, the CCS may select a set of zones based on the current location of an MSD, a path for an MSD to the packing zone, and/or based on other MSD locations. In block 8104, the CCS assigns items to a route based on the selected zones. For example, the CCS may select items that are included in the selected zones and/or near the selected zones. In block 8106, the CCS assigns the route to an MSD. Although routes may be generated in an item-first manner or a location-first manner, other route generation techniques described herein may be used.

In some implementations, the CCS may generate routes on a customer order basis. For example, the CCS may be configured to generate a new route for each received customer order. In some implementations, the CCS may be configured to generate updates to one or more assigned routes in response to a newly received customer order. In some cases, the CCS may be configured to wait for an MSD to complete a prior route prior to assigning a new route.

In some implementations, the CCS may assign customer orders to MSDs in a sequence on a per-order basis. For example, the CCS may assign single customer orders to different MSDs (e.g., regardless of item or MSD location). In a specific example, if three customer orders are received and there are three MSDs actively picking items, the CCS may assign one customer order to each device. In some examples, the CCS may assign customer orders to the MSDs according to an assignment sequence that indicates which MSDs are to receive routes before other MSDs.

In some implementations, the CCS may maintain a queue of customer orders and/or routes. For example, if customer orders are received faster than they are fulfilled, customer orders may be placed into a customer order queue. Similarly, if routes are generated faster than routes are completed, then the routes may be placed into a route queue for assignment. In this case, the CCS may store a list of routes and then assign the routes to MSDs (e.g., in an assignment order or other manner).

In some implementations, the CCS may generate and assign routes based on when the customer orders are received. In one example, the CCS may generate a route for each customer order as the customer orders are received. In another example, the CCS may generate a route based on when customer orders are received. For example, the CCS may be configured to generate a route in response to passage of a threshold period of time. In this case, the CCS may generate a single route for a plurality of customer orders if the plurality of customer orders were received within the threshold period of time (e.g., a time window). In some implementations, the CCS may generate and/or assign a route based on when customer orders are due to be picked up by the customer or a delivery driver. For example, the CCS may generate and/or assign a route a period of time prior to the time the customer order is scheduled to be picked up (e.g., an earliest potential pickup time). The period of time may be a set period of time (e.g., an average picking time for a route) or the period of time may be based on the size of the order (e.g., a number of items in the order) or the length of the route (e.g., a number of zones and/or a physical route length).

In some implementations, the CCS may be configured to generate routes based on a number of items. In one example, the CCS may be configured to generate a route when the number of ordered items is greater than a threshold number. In this example, the CCS may generate a route for a single customer order when the single customer order includes greater than a threshold number of items. In another example, the CCS may refrain from generating a route for a customer order that includes less than the threshold number of items. Instead, the CCS may wait to receive one or more additional customer orders, and then generate a route when multiple received customer orders in combination include greater than the threshold number of items. In some implementations, the CCS may refrain from including greater than a maximum number of items in a route in order to limit the total picking burden on a single MSD. Imposing minimum and maximum item counts in a route may help optimize user workload. Similarly, imposing total item picking counts on the MSDs may help optimize user workload.

In some implementations, the CCS may impose timing constraints on route generation. For example, the CCS may be configured to generate a route for customer orders within a period of time (e.g., regardless of item counts). In some implementations, the CCS may be configured to generate and assign routes for customer orders based on the sequence in which they were received. Forcing the generation of a route based on the age of the customer orders (e.g., regardless of other constraints) may help ensure that customer orders are picked in a timely manner.

In some implementations, the CCS may generate routes based on the number of MSDs. For example, the CCS may split items (e.g., equally) from a single customer order among one or more MSDs if one or more MSDs are not currently picking. The CCS may also split the items of a customer order based on the location of the MSDs. In some implementations, the CCS may split a customer order based on when the order is needed for pickup/delivery. For example, if the order is needed in a short period of time (e.g., immediately for a waiting customer or for an approaching customer to arrive within less than a threshold amount of time), the CCS may split the order among two or more MSDs to increase the rate of picking and decrease customer wait time.

FIG. 82 illustrates an example method that describes assignment of routes to MSDs on a per-customer order basis. In block 8200, the CCS receives a customer order. In block 8202, the CCS generates a route that includes the customer order. In block 8204, the CCS may determine which MSD receives the generated route. For example, the CCS may determine which MSD receives the generated route based on the location of the MSD. In some examples, the CCS may also determine which MSD receives a route based on whether the MSD is currently being used to pick a route. In one specific example, the CCS may choose to assign new routes to MSDs that are not currently picking a route or have the fewest number of routes/items assigned to them. In block 8206, the CCS assigns the route to the selected MSD.

In block 8208, the CCS receives a new customer order. In block 8210, the CCS generates a new route based on the new customer order. In block 8212, the CCS determines which MSD receives the new route. In block 8214, the CCS sends the new route to the selected MSD. For example, if a first MSD received the first route, a second MSD may receive the second route. If only a single MSD is picking, the single MSD may receive both routes and pick them in sequence.

In some implementations, the CCS may include sets of predetermined routes that may be selected and then assigned to the MSDs. A predetermined route may include a sequence of zones through which a user should travel. Additionally, or alternatively, a predetermined route may include a sequence of items that a user should pick, where items in received customer orders are arranged according to the sequence of items. For example, a store may include a sequence of items (e.g., based on adjacency or manually entered) that define how the items in a store are arranged. In one example, the CCS may use item adjacency maps to determine the sequence of items to be picked. In another example, a store may have a defined item sequence (e.g., based on item location in an aisle, aisle arrangement in the store, item type, and other factors) that may be automatically or manually generated. In the case a store includes a sequence of items that defines the layout of the store, items in received customer orders can be mapped to items in the sequence in order to generate a route for the MSD.

Predetermined routes may cover the entire store or portions of the store. As such, the predetermined route may cause a user to traverse the whole store (e.g., all zones) or just one or more portions of the store. In one specific example, a first route may have a user traverse all zones in a certain order, and a second route may have another MSD (or the same MSD) traverse the store in another order, such as an order determined based on factors described herein.

In some implementations, the starting points for the predetermined routes may be set. In some implementations, the stopping points for the predetermined routes may be set (e.g., at the packing zone). For example, a route may include a set starting point (e.g., location/item) and/or a stopping point (e.g., location/item). The route may be predetermined between the start/end points and/or may be modified as described herein.

In some implementations, the predetermined routes may be assigned to the same MSDs/users so that users become accustomed to their routes. In these implementations, the predetermined routes may be generated and/or assigned based on MSD ID and/or user ID. In one example, predetermined routes may be used through one or more store aisles, such as a predetermined sequence of aisles through one or more store departments. In these cases, users may become accustomed to walking the route (e.g., through the same aisles/departments) and picking items on the route. In another example, predetermined routes may be defined at a higher level, such as through predetermined sequences of store departments. In these cases, users may become accustomed to walking through the same departments while picking. One or more MSDs can use predetermined routes, dynamic routes (e.g., generated in any manner described herein), and/or roam at any time or at different times.

In some implementations, the CCS may receive one or more customer orders and generate a plurality of routes in sequence, where later routes may be generated based on previously generated routes. For example, the CCS may initially generate a first route based on the one or more customer orders. The CCS may then generate a second route based on the one or more customer orders and the previously generated first route. The CCS may also generate additional routes based on the one or more customer orders and one or more previously generated routes.

The CCS may generate subsequent routes based on the items included in previous routes. For example, the CCS may be configured to filter out items (e.g., not assign items) in subsequent routes that have been assigned in previous routes. Although already assigned items may be removed from subsequent routes, in some implementations, the CCS may assign the same item(s) to subsequent routes. For example, the CCS may assign the same item(s) a threshold number of times (e.g., to ensure reliable picking of the item(s)). Picking of the item(s) by one user may remove the items from the other routes (e.g., remove the items from the MSD displays). In some implementations, the CCS may update an existing route by incrementing items already on the route, instead of, or in addition to, assigning the items to another.

The CCS may generate subsequent routes based on the locations (e.g., zones) included in previous routes. For example, the CCS may be configured to filter out locations (e.g., not assign zones) in subsequent routes that have been assigned in previous routes. Although already assigned locations (e.g., zones) may be removed from subsequent routes, in some implementations, the CCS may assign the same location(s) to subsequent routes. For example, the CCS may assign the same location(s) a threshold number of times. Assigning different zones to different routes may help ensure that users do not overlap in the same locations. In some implementations, the CCS may assign zones to a route that are not currently assigned. For example, if some zones are not included on previous routes, the CCS may prioritize the generation of a route that includes the zones that are not included on previous routes.

The CCS may generate two sequential routes for a single user in a manner that places a subsequent route starting point at, or near (e.g., within a threshold number of locations and/or distance), the previous route stopping point. In a sense, the subsequent route is “tacked on” to the previous route. In some implementations, the CCS may generate the subsequent route while the user is picking the previous route. For example, the CCS may determine that a subsequent route may be started at the stopping point of the user's previous route, then assign the subsequent route to the user. In some cases, the subsequent route may have been generated independently of the user's previous route, location, and/or items picked. Although the route may have been generated independently of such considerations, in these cases, the CCS may assign the route based on the current location or stopping location of the user, since a tacked-on route may provide an efficient picking path for the user. In other cases, the CCS may generate the subsequent route while the user is picking by using knowledge of the user's stopping point on the route. In these cases, the subsequent route may be tailored to the previous route, and may therefore be optimized for the particular user. The sequential routes may each include single customer orders, or may include items mixed from multiple customer orders. In some cases, the second route may be generated and/or assigned subject to various constraints, such as a total number of items (e.g., maintain less than a maximum number of items in the combined routes) and/or a total length of the route (e.g., maintain less than a maximum number of zones and/or distance in the combined routes).

In some cases where the CCS assigns sequential routes to an MSD, the MSD may store the routes locally and load a new route after completion of a previous route. In these cases, the CCS may not be required to monitor an MSD to determine when to assign a route. As such, handling of the routes may be up to the MSD after assignment by the CCS. Local storage and handling of routes by the MSD may remove some burden from the CCS associated with monitoring one or more MSDs. In some implementations, the MSD may notify the user in a GUI that another route has been received and/or appended to the current route.

The CCS may generate routes based on the current location of one or more MSDs. For example, the CCS may generate a route for an MSD based on the location of ordered items relative to an MSD at the time of route creation. The CCS may then generate an additional route based on the location of another MSD relative to other items (e.g., remaining items). For example, the CCS may generate the additional route based on a number of items near the MSD, the distance of the items from the MSD, and/or the priority level of the items (e.g., priority items may be assigned without regard to location). The CCS may generate one or more additional routes for one or more additional MSDs in this manner.

In some implementations, the CCS may generate a first route for an MSD that includes items close to the MSD (e.g., within a threshold number of zones and/or distance). The CCS may then add items to the first route that lead the MSD to a specific location, such as a last item to be picked and/or the packing zone. The CCS may then generate additional routes to pick the remaining items. In these implementations, the initial selected item(s) may act as seeding items that define a starting point for the route.

In some implementations, the CCS may generate a first route for an MSD that includes a complete customer order. For example, the CCS may generate the first route for an MSD that can most easily pick the customer order. In a specific example, the CCS may generate the first route for an MSD that can pick the customer order by traversing the shortest distance (e.g., fewest zones) before reaching the packing zone. In another specific example, the CCS may generate the first route for an MSD in response to an MSD being within a threshold distance (e.g., number of zones and/or physical distance) of picking an entire customer order.

In some implementations, the CCS may generate a route for an MSD based on the location of the MSD relative to other locations (e.g., zones) within the store. For example, the CCS may generate a route for an MSD based on the locations (e.g., zones) associated with ordered items relative to the location of an MSD at the time of route creation. For example, the CCS may generate a first route for an MSD that includes zones close to the MSD (e.g., zones that seed route creation). The CCS may then add zones to the route that lead the MSD to a specific location, such as a final zone (e.g., the packing zone). The CCS may then generate additional routes to pick the remaining items.

In some implementations, the CCS may generate portions of a route and/or update a route based on the location of items relative to a partially calculated route and/or an already calculated route. For example, if the CCS has already generated a route, the CCS may add on items and/or locations (e.g., zones) to the route based on the proximity of the items/locations to be added to the route. In a specific example, the CCS may add items to a route that are included in zones that are already part of the route. In another specific example, the CCS may add items to an already created route that are near the already created route (e.g., in adjacent zones or nearby zones within less than a threshold distance).

As described herein, MSDs may operate according to a route or operate in a roaming mode. In some cases, the CCS may generate a route for a user that includes a group of nearby items. For example, based on the user's location, the CCS can generate a route that includes items near the user's location. After picking according to the route, the MSD may enter into a roaming mode. In some implementations, the CCS may generate a route that includes an entire customer order near the user's location (e.g., within a threshold number of zones). In some implementations, the user's location near items and/or complete customer orders may trigger the generation and assignment of the route by the CCS. Such a short burst of items may be assigned as a new route to a roaming MSD and/or assigned as an update to an existing route.

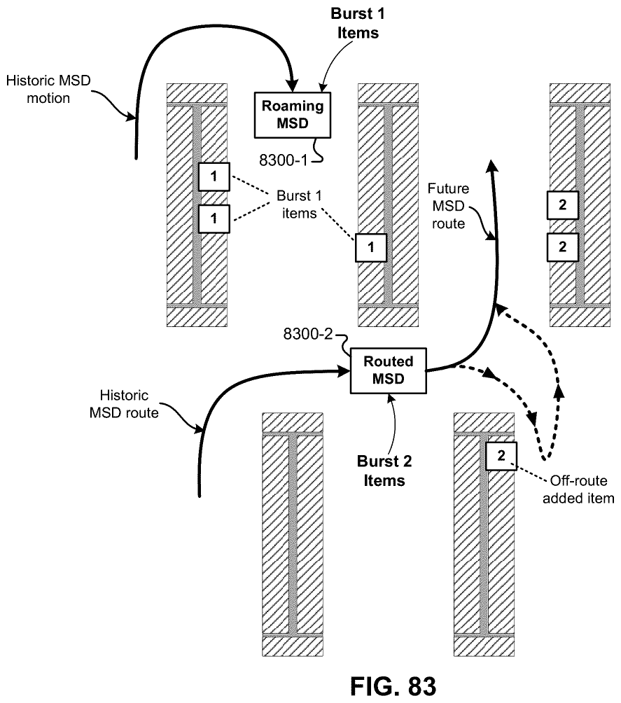

FIG. 83 illustrates an example store that includes two MSDs 8300-1, 8300-2. One MSD 8300-1 is a roaming MSD. The other MSD 8300-2 is picking according to a route. A historic location/motion of the roaming MSD 8300-1 is illustrated. The historic/future portions of the routed MSD are also illustrated. In FIG. 83, the roaming MSD 8300-1 receives a set of items (e.g., a “burst” of items) that the CCS assigned to the roaming MSD 8300-1. The CCS may have assigned the burst of items to the roaming MSD 8300-1 based on the current and/or historic location of the roaming MSD. For example, the CCS may have determined the current location of the roaming MSD and decided to send the burst of items to the roaming MSD based on the proximity of the items to the roaming MSD. As another example, the CCS may have determined the trajectory (e.g., predicted future path) of the roaming MSD based on the current/historic location of the MSD, and then assigned the items to the roaming MSD based on the future path of the roaming MSD. In FIG. 83, the CCS may have purposefully refrained from assigning items in the historic path of the roaming MSD.

In FIG. 83, the routed MSD 8300-2 has picked from the historic route and is currently working toward finishing the future route. While picking the route, the CCS adds a burst of items (Burst 2 items) to the route. For example, the CCS may assign the burst of items based on the historic/current location of the MSD 8300-2 and/or the assumed future location of the routed MSD 8300-2 according to the current route. Two items are added which are on the current route. Additionally, one item is added that is off the route. The CCS may have added the off-route item to the updated route due to the current location of the MSD and/or the proximity of the off-route item to the currently assigned route. The broken line indicates how the routed MSD may be diverted based on the newly generated route. In some cases, the CCS may refrain from adding items that have already been passed on the route (e.g., as determined based on the historical picking/movement of the routed MSD). Adding small local bursts of items to roaming and/or routed MSDs may allow small orders to be completed in as little time as possible.

FIGS. 84A-84B illustrate a scenario in which additional items are added to a route (e.g., from another customer order). FIG. 84A illustrates the example route 1 described with respect to FIG. 77D. In FIG. 84A however, the CCS has assigned three new items to the MSD 7708. The three new items are from another customer order. For example, the items may be part of a small customer order (e.g., customer order A) including only three items (e.g., item A, item B, and another item in Location 3). Although the three items may be the complete additional customer order, in other cases, the items may be just a part of a new customer order. In some cases, the items may be items from multiple new customer orders.

The new items from the new customer order may be added to the route at a variety of times. In some cases, the new items may have been added after the route was generated, but before the route was assigned to the MSD 7708. In some cases, the new items may have been added after route 1 was generated and assigned to the MSD, as is the case in FIGS. 84A-84B. In FIGS. 84A-84B, the new items were assigned to the route prior to the user picking the items on the route (e.g., since items 1-5 are still in the list). In some cases, the CCS may be configured to assign items to the route after the user has begun picking items from the route.

The GUI 8400 may insert the received items into the assigned route. For example, the GUI 8400 may insert the received new items into the route based on the location of the items relative to the MSD 7708 and/or other items, as described herein. In FIGS. 84A-84B, two new items are located in Location 1. For example, new items A and B are located near items 3-4 and 5. In FIG. 84B, the new items are inserted into the list in a corresponding manner relative to items 3, 4, and 5. For example, the items are arranged based on their distance from the MSD 7708. In FIG. 84B, a third new item is not illustrated, as it is collapsed into the Location 3 tab. Note that the location tabs indicate the number of newly added items (e.g., as underlined numbers). For example, the location tabs indicate the number of newly added items separately from the number of items on the original route.

Although the new items may be inserted into an existing list, in other implementations (not illustrated in FIG. 84B), the new items may be added to the GUI in other manners. For example, the new items may be added as a separate list under the original list, such as in the area under Location 4 in FIG. 84B. Similarly, if two sequential routes are assigned to an MSD, the GUI may include the two routes sequentially on the display, such that the first route is located above the second route.

The new items may be rendered in a manner that differentiates the new items from the original items. For example, the new items may include additional text, modified text (e.g., font, size, color, etc.), and/or modified graphical elements (e.g., color, shading, etc.). In FIG. 84B, the new item GUI elements include additional text that indicates that the items are from new “Order A,” whereas the original items do not include an order designation. If new items were included from additional new orders, the items may include additional different order designations (e.g., Order B, Order C, etc.). The new items in the list are also rendered in a manner that is different than the original items. For example, the new items in FIG. 84B are shaded in the list to indicate that the items are newly added from a new order. Different shading and/or coloring may be used to indicate additional items from additional new orders after Order A, if such new orders are placed.

In some implementations, the CCS may generate a route and/or update a route based on whether an MSD has items that have completed an order. For example, if a user has picked items that complete a customer order, the CCS may generate a route that leads the user to a packing zone. In one example, the route may lead the user directly to a packing zone without picking additional items. In another example, the route may include items to be picked before the user enters the packing zone. In some implementations, the MSD may be configured to indicate to the user that they should return to the packing zone because they have items that complete an order. For example, the MSD GUI may indicate that they have completed an order by showing text/graphics to the user (e.g., “Order 1 is completed, return to packing zone.”). In some implementations, the CCS may assign items to the MSD that can be picked on the way back to the packing area after completion of the route. For example, the CCS may assign items included in locations (e.g., zones) that the user will traverse on the way back to the packing area with a completed order. The MSD may assign the items/zones in this case: 1) at the same time the items from the completed order were assigned, 2) while the items from the completed order were being picked, 3) in response to near completion of the order (e.g., within a threshold number of items and/or route distance remaining), or 4) in response to completion of the order.

In some implementations, the CCS may generate a route based on the ability of a user to finish a customer order. For example, the CCS may generate a route that picks items that complete a customer order. In these implementations, the CCS may generate the route when a customer order is nearly completed, such as when less than a threshold number of items are to be picked for a completed customer order. In another example, the CCS may generate the route when the customer order has been out for picking greater than a threshold period of time (e.g., the customer order is a threshold age and/or the customer has been waiting for a threshold amount of time). In one example, the CCS may assign the items of the customer order to an MSD in response to a customer order having been out for picking for greater than a threshold amount of time. In this example, the CCS may also remove the newly assigned items from other MSDs to focus a single picker on the order. Alternatively, the CCS may assign the same items to multiple MSDs to assure that the items are picked as quickly as possible. In some cases, the route for completing a customer order may be generated to lead a user to the packing zone (e.g., via a minimum distance). In some implementations, the presence of items that will complete a customer order (e.g., remaining items or an entire order) may trigger generation and assignment of the items to an MSD. For example, if the items that complete a customer order are near an MSD (e.g., within a threshold number of zones and/or physical distance) or near the MSD route (e.g., within the route or within a threshold distance), the CCS may be triggered to generate and assign the items to the MSD.

In some implementations, the CCS may generate one or more routes based on the current locations and/or future locations of the MSDs relative to one another. For example, the CCS may generate customer routes that diverge from one another. For example, the CCS may generate routes that cause users to separate from one another during picking and/or end at different locations apart from one another. Causing the users to diverge may provide better coverage over the store and more efficient picking in the case additional items are ordered while the users are picking according to the routes. In some implementations, routes for close MSDs (e.g., adjacent MSDs) may be generated to separate the close MSDs by a threshold distance (e.g., a threshold number of zones). In some implementations, the CCS may attempt to maintain a threshold distance between the users during picking and at the end of picking (e.g., a threshold number of zones).

In some implementations, zones may be associated with zone size values that indicate the relative sizes of the zones. In these implementations, the CCS may consider the number of zones traversed in a route and/or the size of the zones being traversed in a route. The inclusion of zone numbers into route calculations may provide data that may be used to generate routes that are optimized based on the distance to be traveled in the route. The zone size may be manually and/or automatically calculated. For example, users may enter the size of the zones manually. As another example, the size of the zones may be determined based on any location technology described herein, such as GPS, Wi-Fi, time to traverse a zone, etc.

In some implementations, the CCS may generate one or more routes that are configured to traverse users through busier locations within the store. For example, the CCS may be configured to take into account the number of items typically picked within locations of the store, determine the locations associated with commonly picked items, and generate routes that traverse locations near the commonly picked items. Commonly picked items may be determined based on the rate at which the items have been ordered/picked (e.g., per hour/day). The commonly picked items may be defined with respect to days of the week (e.g., common weekend items), hours of the day (e.g., common morning/evening items), etc.

In some implementations, the CCS may generate one or more routes based on the amount of customer traffic in the store and/or other traffic in the store (e.g., employee foot traffic and/or vehicle traffic). For example, the CCS may be configured to generate routes that do not pass through currently/historically busier portions of the store. In some implementations, the CCS may determine the amount of traffic in the store based on image analysis of current/historical camera footage of the locations. In other implementations, the CCS may estimate the current/historical traffic in a location based on the number of items purchased/picked in the locations (e.g., items picked by employees and/or customers). In some implementations, the CCS may be configured to minimize a number of total pickers in a busy location in order to minimize crowding. For example, the CCS may assign more items in a busy location (e.g., all currently ordered items in the location) to a single MSD to prevent crowding of the location by employee and/or third-party pickers.

In some implementations, the CCS may generate a route and/or assign an already generated route in response to an MSD entering a location. For example, the location of an MSD may trigger generation of a route, where the route may be based on any of the factors described herein. In one example, an MSD may trigger the generation of a route when the MSD moves near a group of items (e.g., a threshold number of ordered items). In another example, an MSD may trigger generation of a route when the MSD moves to a starting location, such as entering a specified starting location. A specified starting location may be a location where pickers are instructed to move in order to start picking, such as an entry point to a store for a picker/customer or a location near the packing area where pickers leave after dropping off items. In a case where the picking device is a store-owned picking device or customer device, the route can be generated upon entry to the store.

In some implementations, the CCS may generate a route and then wait to assign the route based on the location of an MSD. For example, the CCS may generate a route including one or more customer orders and then send the route to an MSD when the MSD passes a specified location associated with the generated route. In one example, the CCS may generate a route for a group of items that are near one another (e.g., within a threshold number of zones), and then wait to assign the route as a new route or a route update to an MSD when the MSD enters a location near the group of items. Generating and/or assigning routes in response to the location of an MSD may help ensure efficient routing of the MSDs based on the location of the MSDs.

In some implementations, the CCS may be configured to generate a route and/or assign a route based on the location of the customer (or third-party picker) relative to the store (e.g., a geolocation relative to the store). For example, the CCS may generate a route for the customer order and/or assign a generated route to one or more MSDs when the customer is on the way to pick up the order or when the customer has arrived to pick up the order. In some implementations, the CCS may trigger route generation/assignment when the customer is within a threshold distance and/or time from arriving at the store. The location of the customer may be automatically acquired (e.g., via a shopping application for the store) or be manually indicated by the customer (e.g., using a shopping application for the store, text message, and/or phone call). In some implementations, the CCS may generate/assign a route for a customer order based on a time the order should be packed and/or delivered. For example, the CCS may generate/assign a route for a customer order a threshold amount of time before the order is scheduled to be picked and/or delivered.

In some implementations, the CCS may estimate a picking time for picking a customer order and/or an entire route. For example, the CCS may estimate the picking time based on the number of items in the order, the location of the items (e.g., distance between items), the location of one or more MSDs that are picking the route, and/or the historical picking speed of the one or more users picking the route(s). In some implementations, time to completion may be determined based on the time that elapsed for picking the same/similar route in the past (e.g., by the same user in some cases). Based on the estimated picking time, the CCS may also estimate when a customer order and/or route will be finished for pick up or delivery.

In some implementations, the CCS may take into account the number of items that should be included in a route when generating a route. For example, in some implementations, the CCS may attempt to assign a number of items that are greater than a threshold minimum number of items in order to prevent routing a user through a store without picking items along the route. In some implementations, the CCS may attempt to assign less than a maximum threshold number of items to prevent a route from being too time consuming to pick (e.g., greater than a threshold estimated time) and/or requiring too much space for the picked items in the user's cart.

In some implementations, the CCS may be configured to calculate routes according to a hierarchy of operations. For example, the CCS may be configured to generate routes by customer order initially. Then, the CCS may be configured to generate/update routes by adding items to existing routes (e.g., if there are no MSDs without routes), as adding items to existing routes may be more efficient than starting completely new routes.

As described herein, items and/or complete customer orders may be merged with existing routes, such as routes that have been generated and assigned to an MSD. The items and/or complete customer order may be merged with the routes prior to the start of picking and/or after picking has commenced on the route(s). In some implementations, if newly ordered items are already part of one or more routes, then the CCS may add the newly ordered items by incrementing the items on the route (e.g., on the MSD display). In some implementations, if newly ordered items are included in locations on current routes, the CCS may add the newly ordered items to the current routes. In some implementations, if newly ordered items are included in locations that are near locations on current routes (e.g., within a threshold number of zones and/or distance), the CCS may add the newly ordered items to the current routes.

In some cases, the CCS/MSD may be configured to merge a complete customer order with an existing route. In some implementations, the new order may be merged based on the number of items in common. For example, the CCS/MSD may merge an order with a route that has the most items in common with the new order. In some implementations, the new order may be merged based on the number of locations in common. For example, the CCS/MSD may merge an order with a route that has the most locations in common. In some implementations, the CCS/MSD may merge an order with a route if the route is diverted less than a threshold amount (e.g., less than a threshold distance or number of zones) by the addition of the order.

In some implementations, the CCS/MSD may be configured to merge a complete order with an existing route based on the minimal amount of deviation that will be caused to an existing route when picking the order. The amount of deviation may be calculated based on the total distance (e.g., number of zones or actual distance) of the route after merging, a number of additional zones to be traversed, or other factors described herein. Any items from one or more orders may be assigned in a similar manner with respect to minimizing deviation. Similarly, any routing decision may be based on such optimizations. For example, any route may be created based on an attempt to minimize user movement, while at the same time maximizing the number of items picked. Such optimizations may also be subject to constraints described herein, such as item maximums, location traversal maximums, and other constraints, filters, and/or optimizations described herein.

Example optimization techniques may include assigning items to an MSD based on the location of the items. For example, the CCS may assign items from different orders in a single zone to a single MSD to minimize movement of the MSD. In some cases, the CCS can assign a first customer order to an MSD and then assign subsequent items that are located in the same/close locations as the items of the first order. In some implementations, the CCS can generate a global routing plan based on the locations of one or more MSDs. For example, the CCS can generate a global routing plan that minimizes the amount of time/movement (e.g., minimize traversed zones) for picking the ordered items by a plurality of MSDs. Additionally, the CCS may generate a global routing plan that attempts to maximize the rate at which items are picked. In some implementations, the CCS can generate a route and/or a global routing plan without regard to the current location of the one or more MSDs.

After sending one or more routes to the MSDs, the CCS may monitor the users' picking and movement progress. For example, with respect to picking, the CCS may be notified by the MSDs as each item is scanned by the MSDs, as described herein. As another example, with respect to a user's movement, the MSDs may notify the CCS of their location and/or the CCS may determine MSD locations using the techniques described herein.

Although the CCS may monitor a user's location and movement progress, in some cases, the CCS may assign one or more routes and not continuously monitor user movement and picking progress. In these cases, the MSDs may store the routes locally. Local storage and handling of routes by the MSD may remove some burden from the CCS associated with monitoring one or more MSDs. In these implementations, the CCS may assign routes without monitoring one or more MSDs and/or the MSDs may notify the CCS when the routes are completed, at which time the CCS may make routing decisions.

The CCS may make routing decisions based on the monitored picking/movement of one or more MSDs, as well as other factors described herein. For example, the CCS may update routes based on the monitoring. A route update may be an update/modification to one or more routes that one or more MSDs are currently using or may be assigned. The updates may modify (e.g., add/subtract) the items and/or locations in the current routes.

In some implementations, the CCS may modify (e.g., update) the items assigned to routes based on the monitoring. For example, the CCS may add new items and/or remove items from the routes based on any factors described herein in response to monitoring the users' location and/or picking. In some implementations, the CCS may modify the locations included in routes and/or the order through which a user should traverse the locations based on the monitoring. For example, the CCS may add new locations, remove locations, and/or change the sequence of locations included in the routes in response to the users' locations and/or picking. In some implementations, the CCS may modify the items assigned to users and also modify the locations.

In some implementations, the CCS may cancel one or more routes based on the monitoring. For example, the CCS may cancel one or more routes based on the picking and/or movement of one or more users. Route cancellation may result in the items being removed from the user's MSD and assigned to other users (e.g., as a route). Route cancellation may also cause the MSD to enter a free roaming mode, without removing items from the MSD. Entry into roaming mode may cause rearrangement of items on the display. In some implementations, the CCS may generate one or more new routes based on the monitoring. For example, the CCS may generate one or more new routes and assign the new routes to one or more users, such as a new user MSD (e.g., without a current route). The new route may also be assigned to users with a current route, such that the route replaces a current route or is a route that is started after their current route ends.

In some implementations, the CCS may make routing decisions based on newly received customer orders. For example, the CCS may update routes, cancel routes, and/or generate new routes based on a newly received customer order. In some implementations, the CCS may update routes, cancel routes, and/or generate new routes based on a combination of newly received orders along with users' picking and/or movement. Newly received orders may include new items. The new items may be added to existing routes, which may be done by incrementing an item count if someone has ordered the same item. In some implementations, a customer may cancel an order after a route is assigned (e.g., before or during picking). In this case, the canceled items may be removed from the routes (e.g., items removed from the MSD). In some implementations, receipt of a new customer order or new items may cause generation of a route that may pick existing items (e.g., items already assigned to an existing route) in a more efficient fashion. For example, if a new customer order is assigned to a new route that includes other items/locations in already existing routes, or items being picked by roaming MSDs, some items may be removed from the existing routes and assigned to the new route.

In some cases, a customer may make a modification (e.g., addition/subtraction) to their order. For example, the customer may make a modification after a route is generated for their order. The modification may be made after generation of the route, but prior to picking the first item. The modification may also be made after the user has picked some items from the route. The CCS/MSDs may modify one or more routes based on the customer modification. For example, the CCS/MSDs may update routes as described herein, such as by adding items to a route, subtracting items from a route, and/or generating one or more new routes. In some cases, if a customer orders an item and then cancels, the item may still be picked on a route. The picked item can then be used for another customer order that is currently being picked (e.g., the same item from another customer order). In this case, the item may remain on one or more routes. In some cases, the CCS/MSD may instruct the user that the picked item was canceled and should be placed in the packing zone for later use (e.g., in a designated area or tub). In some cases, the CCS/MSD may generate such an indication if the CCS/MSD predicts that the item will be picked soon, such as when the item is currently in a customer's pending list (e.g., for pickup at a later time). The CCS/MSD may also generate such an indication if the item is commonly picked (e.g., based on a number of times the item is picked within a period of time).

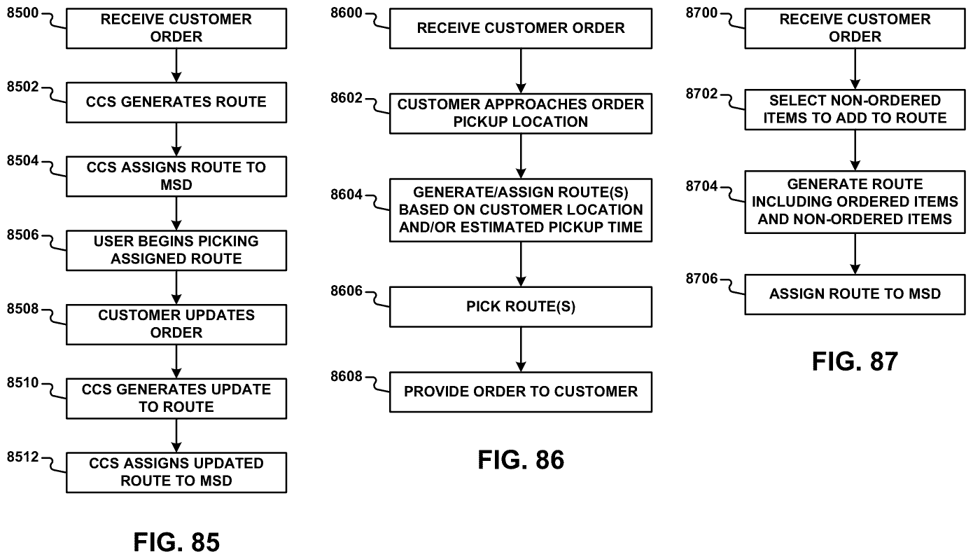

FIG. 85 illustrates an example method for updating routes based on customer modifications to a customer order while the order is being picked. In block 8500, the CCS receives a customer order. In blocks 8502-8504, the CCS generates a route for the customer order and assigns the route to an MSD. Although the CCS may generate/update a single route for an MSD based on the customer order in the method of FIG. 85, in other implementations the CCS may generate/update one or more routes for one or more MSDs based on the customer order.

In block 8506, the user begins picking items from the assigned route. While picking items from the assigned route, the customer updates the customer order in block 8508. For example, the customer may add and/or remove items from the customer order while the user is picking the assigned route. In blocks 8510-8512, the CCS generates an update to the route based on the updates to the customer order and assigns the updated route to the MSD. Example updates may include addition and/or removal of items. For example, if the customer adds items to the customer order, the CCS may add the new items to the route. Although a store employee or third-party picker may receive an updated route based on a customer order modification in the method of FIG. 85, in some cases, a customer may modify their own route that they are picking. For example, a customer may add/subtract items from their own route, which may cause modifications to the route. As another example, a first customer may modify their shopping list while another customer (e.g., a spouse, family member, friend, etc.) is picking the route.

The CCS may handle an added item in a variety of ways. In some implementations, the CCS may assign the added item to the picker that is picking the original route. For example, the CCS may assign the added item to the same picker if the newly added item is on the route, such as when the added item is an incremented item addition (e.g., an additional item that was previously ordered). As another example, the CCS may assign the added item to the same picker if the new item is in/near future locations (e.g., zones) on the route. In the case that the item is not in/near future locations on the same picker's route, the CCS may assign the new item to another picker's route, such as another picker that is currently near the new item or will be near the new item on their current route.

As another example, if the customer removes items from the customer order, the CCS may remove the items from the route if the picker has not yet picked the items. The CCS may handle removal of already picked items from a customer order in a variety of ways. In some implementations, the CCS may notify the picker via an MSD GUI that one or more picked items have been removed from a customer order. For example, the MSD GUI may generate a GUI message indicating the removed item is no longer needed for the customer order. In some cases, the MSD GUI may provide further instructions, such as instructing the user to replace the item back in its original location from where it was picked, or place the item in a different location, such as a location dedicated to picked items that are not needed (e.g., a location in the packing area). In some cases, a packer may handle the removed item by removing the item from the customer order during packing. In some cases, a packer MSD GUI may instruct the packer to remove the item.

A variety of example route modification/update triggers are now described. In some implementations, picking of an item may trigger a route modification. For example, one user may pick an item that is on another user's route. This may happen in a case where one picker is roaming and ends up picking items on another route. In this case, the item may be removed from the original pickers route. Additionally, or alternatively, the route (or part of the route) including the item may be assigned to the roaming picker. In some implementations, user movement may trigger an update. For example, if a user deviates from a route (e.g., for a threshold amount of time and/or distance), a route modification for the user (or other user) may be triggered. For example, items near the deviating MSD may be reassigned in a new route to the deviating MSD. Locations/items from which the user deviated may be assigned to another user on a new route.

In some implementations, the MSD may generate a GUI that notifies the user that they are off route and the items are being reassigned. The MSD may also generate a GUI that notifies a user that they have picked an item that is not on their route. The user may interact with the GUI (e.g., GUI buttons) to confirm that they are off the route and/or they have picked an item that is not on their route. For example, the user may indicate that they know they are off the route and plan on returning to the route. The user may move off their route for any number of reasons (e.g., to help a customer or clean a spill). In another example, the user may pick an item that is off their route intentionally. For example, the user may pick an item they know is needed (e.g., based on a verbal request by another user/customer), but has not been entered into the CCS (e.g., by a customer or other party). The user may confirm in the GUI that they are intentionally picking and scanning the item that is not on their route.

In some implementations, the CCS/MSDs may modify/generate/cancel routes in response to time-based triggers. For example, the CCS/MSDs may modify routes at certain times, such as periodically, or after a period of time after a previous assignment. In some implementations, the CCS/MSDs may cancel a route that has been assigned if the route has not been started and/or completed by a threshold period of time after assignment. In some implementations, the CCS can modify a route if a user is not responsive, as indicated by a lack in picking, a lack in movement, and/or incorrect movement according to a route (e.g., deviation).

In some implementations, completion of a route may trigger generation of a new route and/or modification of other routes. For example, the CCS/MSDs may generate a new route after a user has finished picking the last item in a current route, or otherwise indicated that a route is complete (e.g., based on a manual entry in a GUI). In some implementations, the CCS/MSDs may generate a new route and/or modify other routes after the completion of a route. For example, items/locations in previous routes may be assigned to an MSD that has just finished the route, thereby redistributing the work among a plurality of pickers to increase efficiency. Any of the updates/modifications/cancellations described herein can be based on one or more MSD's movements and/or pickings. Any of the updates/modification/cancellations can be modifications to one or more routes that are sent to one or more MSDs.

In some implementations, the OFS may be configured to automatically assign routes to users and/or update/cancel routes. For example, the user may not have an input as to whether a route is assigned to them (e.g., their MSD) and/or which route is assigned to them. In some implementations, the user may have input as to whether a route is assigned to them and/or which route is assigned to them. For example, the CCS may send a suggested route to an MSD and the user can be prompted to accept or decline the route in the MSD GUI. In this example, the MSD may generate a GUI that includes a notification that a route is being suggested for the user. The MSD may also display the route path and/or items on the route in the GUI in some implementations. The GUI may receive input from the user, such as touch input indicating whether a route is accepted or denied. The GUI may also display multiple suggested routes to the user and allow the user to accept/deny one or more of the routes (e.g., via a touchscreen selection). The CCS/MSDs may also suggest modifications/cancellations of routes to the users in some cases.

In some implementations, the CCS may be configured to reassign items from existing routes in order to minimize picking time. For example, in order to minimize time for picking a customer order, the CCS may reassign items from the customer order to one or more other MSD routes. The reassignment may be based on any of the factors described herein. In one example, the CCS may be configured to split a single customer order to multiple routes to minimize picking time. For example, if picking time is a priority, the CCS may split items from a single customer order into two or more routes to different MSDs so that the MSDs can pick the same order together. In some cases, the CCS may split the order prior to assigning the routes. In other cases, the CCS may split a customer order while the order is already being picked.

The CCS/MSDs may end a route for a variety of reasons. In some implementations, the CCS/MSDs may end a route when all of the locations in the route have been traversed. In some implementations, the CCS/MSDs may end a route when all the items have been picked in the route. In some implementations, the CCS/MSDs may end a route when all the items have been picked and all the zones are traversed in the route. In some implementations, the CCS/MSDs may end a route when the user enters a specific location, such as moving into a packing zone. In some implementations, ending a route may cause remaining items to be passed on to other MSDs (e.g., in routes and/or roaming).

The route cancellation can be manual or automatic. For example, the MSD may automatically determine that a route has ended for any of the reasons descried herein. In some implementations, the user may be prompted by the MSD GUI to confirm that the route has ended. In other implementations, the user may be required to manually indicate that the route has ended (e.g., without prompting). In some implementations, the CCS may cancel a route in response to a customer cancelling a customer order for the route. Similarly, the CCS may modify a route in response to a customer modifying a customer order (e.g., adding/removing items) for the route.

In some implementations, the MSD GUI may provide a user with an interface element (e.g., a selection button) to indicate that they are stopping the route. The user may interact with the interface element (e.g., touch/click the button) to indicate to the CCS/MSDs that they are done picking the route. Any remaining items may be reassigned to other MSDs.

The CCS may generate a route for customer items at any time. In some implementations, the CCS may generate a route in response to receiving the customer order, such as when the customer order is placed and the customer is charged (e.g., a customer credit card is charged). In some implementations, the CCS may generate a route that includes items that are part of a customer order that has not yet been finalized (e.g., submitted and/or paid for), such as when the customer is adding items to a shopping cart on a store web/application. Similarly, the CCS may generate a route that includes items that are part of a customer order that is stored at the CCS and not yet finalized. In some implementations, the CCS may generate a route in response to a customer indicating that they will be picking up the order (e.g., an indication by an application). In some implementations, the CCS may generate a route in response to a customer arriving at the store. The CCS may assign the generated route for picking any time after generation. For example, the CCS may assign a generated route in response to any of the following occurrences: 1) a customer placing a final order, 2) a customer adding items to a shopping cart, 3) a customer indicating that they will be picking up the order, and 4) a customer arriving at the store to pick up the placed order. In some implementations, a customer shopping application may provide the customer with a GUI in which the customer may explicitly request that the customer order be picked. In some cases, the customer may request that an order be picked when they arrive at the store and plan on picking up the order after performing other tasks, such as picking their own fruit/vegetables or other items a customer may want to pick for themselves.

FIG. 86 illustrates an example method for generating and/or assigning routes based on the location of a customer and/or an estimated time of arrival for a customer. In block 8600, the CCS receives a customer order. In block 8602, the customer approaches the order pickup location at the store. In block 8604, the CCS may generate one or more routes including items from the customer order based on the customer location and/or an estimated pickup time for the order. In block 8604, the CCS may also assign the generated route(s) based on the customer location and/or the estimated pickup time for the order. In block 8606, one or more MSDs may pick the assigned route(s). In block 8608, the customer order is provided to the customer.

In block 8604, the route generation and/or assignment may be triggered in response to the customer location and/or estimated pickup time. In some implementations, the CCS may determine the customer location via a shopping application used by the customer to place the order. The CCS may be configured to trigger generation and/or assignment of a route in response to a variety of conditions described herein. In one example, if the customer places a customer order from their home address (or other location), the CCS may generate/assign a route in response to the customer leaving their home address (e.g., as specified in the application), or the other location, and/or traveling to the store to pick up the order. In another example, the CCS may generate/assign a route in response to customer arrival at the store from another location (e.g., home). In another example, if the customer places the customer order while at the store, the CCS may generate/assign the route in response to the customer being present in the store while placing the customer order. Such a scenario may allow the customer to shop at the store, or in a location near the store (e.g., another nearby store), and decide to pick up some items after they are finished shopping in the store for other items, such as produce or other items they would like to personally handle. In some implementations, the CCS may generate/assign a route in response to a customer making a request in the shopping application GUI. For example, using the shopping application, a customer may select (e.g., touch/click) a GUI element that requests that the order be picked and presented to the customer. The customer may interact with the shopping application to indicate that they will be arriving at the store according to any of the above scenarios described with respect to block 8604.

In some implementations, the CCS may determine an estimated pickup time for a customer order. For example, the CCS may determine an estimated pickup time based on a current customer location relative to the store. In this example, the CCS may estimate the customer time of arrival using server-side or client mapping/driving applications. In some implementations, the CCS may determine an estimated pickup time based on a time entered by the customer. In some implementations, the CCS may determine an estimated pickup time based on a prearranged time window (e.g., selected by the customer in the shopping application). The CCS may generate and/or assign one or more routes based on any of the one or more customer location determinations and estimated pickup time techniques described herein.

In some implementations, the location of a third-party delivery driver and/or the estimated pickup time for a third-party delivery driver may trigger the generation/assignment of one or more routes in a similar manner as described herein with respect to customer location and/or estimated pickup time. For example, the location of a delivery driver relative to the store may trigger generation/assignment of one or more routes for the order(s) to be delivered by the driver. As another example, an estimated time at which the third-party delivery driver will arrive at the store may trigger generation/assignment of one or more routes for the orders(s) to be delivered by the driver.

In some implementations, routes generated before a customer is set to arrive at the store may be placed in a collection/packing area. For example, complete customer orders can be stored in the collection/packing area for later customer pickup/delivery. The scheduled pickup/delivery need not be immediate. Instead, the items may be stored in the collection/packing area for any amount of time. In some implementations, the CCS may generate routes that include items not currently ordered by customers (“non-ordered items”). In these cases, the items may be stored in the collection/packing area and used for later received customer orders. The CCS may generate routes that include items not currently ordered in the case that the items are frequently ordered by customers and are likely to be ordered within a short period of time. Example commonly ordered items may include milk, soda, and bread.

FIG. 87 illustrates an example method for generating routes that include non-ordered items. In block 8700, the CCS receives a customer order including a plurality of items. In block 8702, the CCS selects non-ordered items to add to a route along with one or more of the ordered items in the received customer order. In some implementations, the CCS may maintain a list of non-ordered items for picking (e.g., commonly picked items). In these implementations, the CCS may select non-ordered items from the list to assign to routes. In block 8704, the CCS may generate a route that includes ordered items and non-ordered items. In block 8706, the CCS assigns the route to an MSD. In some implementations, the CCS may further assign additional non-ordered items to a route while the user is picking the route.

The CCS may select non-ordered items for routes in a variety of ways in block 8702. In some implementations, the CCS may select non-ordered items for routes that include the same ordered items or are included in the same locations (e.g., same zones) that are already included in the routes. In some implementations, the CCS may select non-ordered items for routes that deviate from the ordered items on the routes (e.g., by less than a threshold distance). In some implementations, the CCS may assign non-ordered items to an MSD based on the location of the MSD prior to assigning a route to the MSD. For example, the CCS may assign non-ordered items to an MSD that are currently near an MSD, or will be near an MSD on the way to the starting point of the upcoming route. Although the CCS may take into account the route and/or location of the MSD to receive the route, in some implementations, the CCS may assign non-ordered items to the MSD without regard to routes or locations. Although the non-ordered items may be added to routes with customer orders, the non-ordered items may also be used to make up entire routes of non-ordered items.

The MSD GUI may render non-ordered items in a variety of ways. In some implementations, the MSD GUI may render non-ordered items in the same manner as ordered items. In some implementations, the MSD GUI may render non-ordered items in a manner that differentiates the non-ordered items from ordered items. For example, the MSD GUI may include additional text (e.g., “non-ordered item”) along with the item, modified formatting (e.g., text font, color, etc.), and/or additional rendering modifications (e.g., color/shading). In some examples, the MSD GUI may include the non-ordered items in a different list (e.g., a list under the route being picked). In some implementations, the MSD GUI may allow the user to request that non-ordered items be added to the route.

In some implementations, the CCS may generate routes based on historical picking by the MSDs and/or historical movement by the MSDs. Historical picking/movement may refer to picking/movement that recently occurred (e.g., within seconds/minutes) or has occurred over a longer period of time (e.g., hours, days, weeks, etc.). Historical picking/movement may refer to picking (e.g., scanning) of one or more items and/or movement through one or more zones within a recent time and/or over a longer period of time. The recency of the picking/movement data may be defined in a variety of ways. In some implementations, the recency of the picking/movement data may be defined in terms of time (e.g., one or more time thresholds). In some implementations, the recency of the picking/movement data may be defined in terms of the number of items picked (e.g., scanned). For example, historic picking/movement data may be analyzed for a threshold number of recently picked items (e.g., a last 5, 20, or 100 items) as well as picked items over a longer period (e.g., 200, 500, or 1000 items). In some implementations, the recency of the picking/movement data may be defined in terms of the distance moved by the user. For example, recent historic picking/movement data may be defined in terms of a short distance of user movement in terms of any location technology described herein (e.g., 1 meter, 10 meters, 1 zone, 3 zones, etc.). In this example, more long-term historic picking/movement data may include longer distances of user movement and/or more zones traversed (e.g., 100 meters, 1000 meters, 10 zones, 100 zones, etc.). In some implementations, the CCS may use the same threshold to determine recent vs. long term data. In other implementations, the CCS may use a first threshold to determine recent data and a second threshold that is different than the first threshold to determine long term data. Although the scan log data may be generated based on picked items, in some implementations, the scan log data may be acquired passively as an MSD scans items while a user moves throughout the store.

In some implementations, the CCS may be configured to assign items/locations to MSDs based on items that were recently picked (e.g., within less than a threshold amount of time) by the MSDs. In one example, the CCS may be configured to assign an item to an MSD if the user is about to pick the item (e.g., on a route or based on proximity). The CCS may determine that the user is about to pick the item based on the arrangement of items on the MSD (e.g., display) and/or the order in which items have been picked leading up to the item. In a specific example, the CCS may determine that the user is about to pick the item when the item is a next item on the user's MSD. In some implementations, the CCS may determine that the user is about to pick an item when the item is adjacent to other items being picked.

In some implementations, the CCS may be configured to assign items to an MSD that just picked the item. For example, the CCS may assign an item from a new customer order to an MSD if the MSD has just picked the item within less than a threshold amount of time (e.g., within seconds), since the user may be near the item. In some implementations, in order to prevent backtracking by the user, and to move the user along the route, the CCS may be configured to refrain from assigning items to the user that the user has recently picked. For example, the CCS may refrain from assigning items to the user when the user has moved on from the item and scanned other items. In one example, the CCS may determine that the user has moved on from the item after the user has been detected picking one or more additional items on the list subsequent to the item. Additionally, or alternatively, the CCS may determine that the user has moved on from the item after a period of time has elapsed (e.g., greater than a threshold period of time). In some implementations, the CCS may determine that the user is near an item (e.g., a recently picked item) based on item adjacency or other location technology. In some implementations, the CCS may determine an item picking trajectory through the store (e.g., a sequence of one or more items/locations), which may be used to predict which items are about to be picked. For example, the CCS may determine the trajectory based on past items picked, past movements, item adjacency and/or locations associated with the items (e.g., as described herein).

In some implementations, the CCS may be configured to assign items/locations to MSDs based on locations that were recently traversed (e.g., within less than a threshold amount of time) by the user. For example, the CCS may be configured to assign items to an MSD if the MSD is about to move to a location including the items (e.g., based on a route or trajectory). The CCS may determine that the user is about to move to the location when the user is near the location and/or moving toward the location. In a specific example, the CCS may determine that the user is about to move to the location when the location is a subsequent location (e.g., next location) on the user's route.

In some implementations, the CCS may determine a trajectory of the user through the store based on two or more traversed locations (e.g., a historical path) that indicate one or more future locations that may be traversed (e.g., one or more adjacent locations when roaming or on a route). The trajectory may be used to predict which locations are about to be visited by the user. The CCS may determine a trajectory for one or more MSDs in the store. The CCS may also predict one or more future locations of the users based on the trajectory. The CCS may generate routes for one or more MSDs based on the trajectory and/or predicted future location(s) of the user. For example, the CCS may assign items on (e.g., in a predicted location), or near (e.g., in an adjacent or near location), the predicted future location of the user.

In some implementations, the CCS may be configured to assign items to an MSD if the MSD is in the location or near the location of the items. For example, the CCS may assign an item from a new customer order to an MSD if the MSD is located within the location of the item or has just left the location within less than a threshold amount of time. In some implementations, in order to prevent backtracking by the user, and to move the user along the route, the CCS may be configured to refrain from assigning items in locations that the user has recently traversed. For example, the CCS may refrain from assigning items to the user when the user has moved on from the location including the item. In one example, the CCS may determine that the user has moved on from the location after the user has been detected in other locations, such as an adjacent location, a threshold number locations from the location, and/or a specified distance from the location. Additionally, or alternatively, the CCS may determine that the user has moved on from the location after a period of time has elapsed after the user has left the location.

In some implementations, the CCS may be configured to assign items/locations to MSDs based on locations that were recently traversed and/or items that were recently picked, as described herein. Additionally, or alternatively, the CCS may be configured to assign items/locations to an MSD that just picked the item and/or traversed a zone, as described herein. Additionally, or alternatively, in order to prevent backtracking by the user, and to move the user along the route, the CCS may be configured to refrain from assigning items/locations to the user that the user has recently picked/traversed, as described herein. The CCS may also take into account a user's trajectory for picking items and traversing locations to predict future items/locations for route assignment.

In some implementations, the CCS may learn which items a user commonly picks (e.g., specific items or types/categories of items). The CCS may learn the items over a short period of time, such as items picked within the last hour or day. The CCS may also learn the items over a longer period of time, such as over a week or more. The CCS may determine which items the user picks in a variety of ways. For example, the CCS may determine that the user commonly picks items based on the number of times the user has picked the item (e.g., a total number of times the item was picked). In one example, the CCS may determine that the user commonly picks items based on a variety of factors, such as 1) the number of times the items were picked within a period of time, 2) the most picked items by the user, 3) the ratio of picks for a specific item relative to total numbers of items picked, and/or 4) other statistical distributions indicating a number of different items that the user commonly picks. The commonly picked items may be associated with an MSD (e.g., an MSD ID) and/or user (e.g., a user ID) at the CCS. In some implementations, the CCS may rank the items (e.g., individual items, item types, etc.) picked by the user based on a variety of factors, such as the most common items/types for the user.

In some implementations, the CCS may assign items to the user/MSD that the user commonly picks. For example, the CCS may preferentially assign items to the user/MSD (e.g., over another user/route). Learning commonly picked items for a user/MSD and subsequently assigning those items to the user/MSD may allow the CCS to automatically adjust to picking habits/assignments of users/MSDs. For example, if a specific user/MSD is typically used to pick specific items (e.g., specific item categories/departments), or if a store uses specific users/MSDs to pick specific items (e.g., specific item categories/departments), the CCS may learn which specific items should be associated with the users/MSDs. In a specific example, a store may employ specific users or MSDs to pick specific grocery departments. The CCS in this case may determine which items are typically picked by the users/MSDs.

In some implementations, the CCS/MSDs may store a log of the locations traversed by users/MSDs (e.g., movement/location logs). For example, the CCS may store the locations (e.g., zones) along with time data that indicates when the user entered/exited the zones and/or the amount of time spent in the zones. The CCS may generate routes and/or assign items to users/MSDs based on the movement logs. Movement logs may include movement data (e.g., locations) that is separate from scan log data (e.g., the locations of scanned items), but may include some of the data from scan log data. For example, movement log data may align with scan log data at times when the user scans items. The movement data may indicate a user's location over time using any of the location techniques described herein (e.g., location indicators, GPS, etc.). The movement data may be analyzed to determine common locations including the user, common sequences of locations traversed, time spent in locations (e.g., time spent in individual locations, sections, groups of locations, etc.), and other movement parameters.

In some implementations, the CCS may learn which locations a user commonly traverses. The CCS may learn the locations over a short period of time (e.g., within a short threshold period of time before the current time), such as locations traversed within the last hour or day. The CCS may also learn the locations over a longer period of time (e.g., within a longer threshold period of time before the current time), such as over a week or more. The CCS may determine which locations the user traverses in a variety of ways. For example, the CCS may determine that the user commonly traverses locations based on the number of times the user has traversed a location, the amount of time the user has spent in the locations, the number of items a user has picked from a location, and/or based on statistical distributions that indicate the user's presence in a location relative to other locations (e.g., a ratio of time spent in the location relative to all locations). The commonly traversed locations may be associated with an MSD (e.g., an MSD ID) and/or user (e.g., a user ID). In some implementations, the CCS may rank the locations or groups of locations based on a variety of factors, such as the most common locations for the user, the amount of time spent by the user in the locations, etc.

In some implementations, the CCS may assign locations to the user/MSD that the user commonly traverses. The CCS may also assign items in the locations that the user/MSD commonly traverses. For example, the CCS may preferentially assign locations to the user/MSD (e.g., over another user/route). Learning commonly traversed locations for a user/MSD and subsequently assigning those locations to the user/MSD may allow the CCS to automatically adjust to picking habits/assignments of users/MSDs. For example, if a specific user/MSD is typically used to pick in specific locations (e.g., specific departments), or if a store uses specific users/MSDs to pick specific locations, the CCS may learn which specific locations should be associated with the users/MSDs. In a specific example, a store may employ specific users or MSDs to pick specific grocery departments.

In some implementations, the CCS may learn common sequences of locations traversed by the users/MSDs and/or items picked by the users/MSDs. The CCS may use these sequences to generate routes in some cases. For example, the CCS may generate routes that include common sequences of locations. In some implementations, common item/location sequences from a plurality of past orders may indicate the sequence in which locations should be traversed and/or the sequence in which newly ordered items should be picked. For example, common item/location sequences may be used by the CCS to determine the arrangement in which items/locations should be arranged for picking a new customer order. In a specific example, if a series of items are typically picked in a location (e.g., an aisle) in a specific sequence, the CCS/MSD may arrange the series of items in the typically picked sequence for future routes. In some implementations, the CCS/MSDs may learn minimum times for picking two or more items in sequence based on historical picking times (e.g., in scan logs). The CCS may arrange items/locations in a route in a matter than minimizes time for picking the sequence of two or more items. The common sequences of locations/items and the generation of routes based on the common sequences may be user-specific or used across different users.

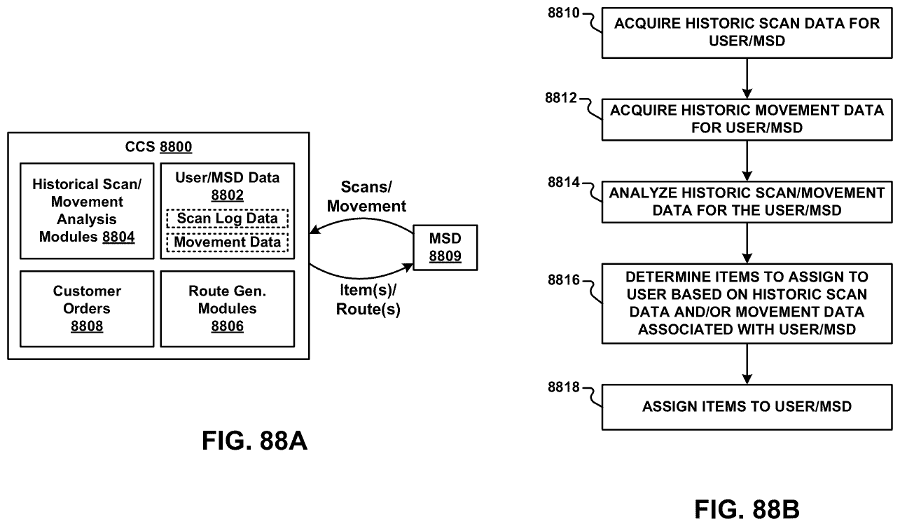

FIGS. 88A-88B are directed to an example CCS 8800 that analyzes historical picking and movement data to determine which items/locations to assign to a user/MSD. The CCS 8800 includes historical user/MSD data 8802 that indicates historical user/MSD behavior. The historical user/MSD behavior is included in scan log data that indicates historical item scans over a period of time for the user. The historical user/MSD behavior is also included in user movement data (e.g., user movement logs) that indicates historical movement for the user over time. The CCS 8800 also includes historical scan/movement analysis modules 8804 that may analyze the historical user scan data and movement data to make the determinations described herein with respect to historical user movement data and scan data. The historical scan/movement analysis modules 8804 may predict future user movement (e.g., trajectory) and scans based on the historical user movement and scan data. The historical scan/movement analysis modules 8804 may also perform analysis on recent user movement data and scan data in order to determine which items should be assigned to a user at the present time. The historical scan/movement analysis modules 8804 may also perform more long term analysis on the user movement data and scan data to learn various patterns associated with the user, such as the locations in which the user typically moves and the items that the user typically picks. The CCS 8800 (e.g., route generation modules 8806) may use the raw historical scan data, raw historical movement data, and/or the analyzed movement/scan data to assign items to users for current customer orders 8808.

FIG. 88B illustrates an example method that describes item/location assignment to users based on historical scan/movement data. In block 8810, the CCS 8800 acquires historical scan data for a user/MSD 8809. In block 8812, the CCS 8800 acquires historical movement data for the user/MSD 8809. Note that the data acquisition performed in blocks 8810-8812 may be performed at the same time for the user/MSD 8809. In block 8814, the historical scan/movement analysis modules 8804 may analyze the historical data to determine the various values used to make the decisions described herein regarding historical data, such as user trajectory, user preferred locations/items, and/or whether to backtrack to pick additional items. In block 8816, the route generation modules 8806 determine items to assign to the user/MSD 8809 based on the historical scan data and/or movement data associated with the user/MSD 8809. In block 8818, the CCS 8800 assigns the items determined in block 8816 to the user/MSD 8809.

In some implementations, the CCS may be configured to assign items/locations to a user/MSD according to one or more item constraint parameters. Item constraint parameters may be associated with a number of items (e.g., min/max number), size of the items (e.g., max size per item and/or total), weight of the items (e.g., max weight per item and/or total), and/or other item parameters. In some implementations, the CCS may be configured to assign items/locations to a user/MSD according to one or more location constraint parameters. Location constraint parameters may be associated with the number of locations (e.g., min/max number), distance traveled (e.g., min/max distance), and/or other location parameters. In some implementations, the item and location constraint parameters may include various threshold values described herein. In some implementations, the CCS may be configured to assign items/locations to a user/MSD according to filters described herein (e.g., blacklists) that may be included in the item and location constraint parameters, or in addition to the constraint parameters.

In some implementations, the constraint parameters may be applied across a plurality of users/MSDs. In some implementations, the constraint parameters may be specific for a user/MSD. In some implementations, users (e.g., managers) may set the constraint parameters across one or more users/MSDs. In some implementations, the CCS may determine the constraint parameters for users (e.g., groups of users or for specific users) based on historical movement and picking data (e.g., data for groups of users or user-specific data).

In some implementations, the CCS can be configured to assign items according to item threshold values. For example, the CCS may be configured to assign fewer than a maximum threshold number of items to an MSD. Limiting the number of items assigned to an MSD may prevent overburdening the user with too many items. As another example, the CCS may be configured to assign greater than a minimum threshold number of items to an MSD. In some implementations, the threshold numbers may be configured by the owner/operator of the OFS. In some implementations, the threshold numbers may be MSD/user specific. In some implementations, the threshold numbers may be automatically determined based on the speed at which the user picks. In some implementations, the threshold numbers may be assigned based on the locations in which the user picks (e.g., based on item size/weight and frozen/unfrozen status). The total number of items may be used as a limiting factor for generating a route (e.g., the route generation ends when a total number of items is assigned).

In some implementations, the CCS can be configured to assign items on a route based on item size limits (e.g., volume limits) and/or item weight limits. For example, the CCS may be configured to assign a group of items that together are less than a threshold size limit (e.g., a volume limit). As another example, the CCS may be configured to assign a group of items that together weigh less than a maximum weight limit. Limiting the total size and weight of items assigned to an MSD may prevent a user from being burdened with too large of a volume/weight of items. The total size/weight of items may be used as a limiting factor for generating a route (e.g., the route generation ends when a total size/weight of assigned items is reached).

The CCS can be configured to assign locations according to location threshold values. For example, the CCS may be configured to assign fewer than a maximum threshold number of locations (e.g., zones) to an MSD. Limiting the number of locations (e.g., zones) assigned to an MSD may prevent overburdening the user with a route that is too long. As another example, the CCS may be configured to assign greater than a minimum threshold number of locations (e.g., zones) to an MSD so that a user receives a sufficiently long route. In some implementations, the threshold number of locations may be configured by the owner/operator of the OFS. In some implementations, the threshold number of locations may be MSD/user specific. In some implementations, the threshold numbers may be automatically determined based on the speed at which the user moves (e.g., zones per minute). In some implementations, the threshold numbers may be assigned based on the locations in which the user picks. For example, an MSD used to pick from the entire store may be assigned a greater number of locations than an MSD that is limited to a subset of zones (e.g., one or more sections). The total number of locations (e.g., zones) may be used as a limiting factor for generating a route (e.g., the route generation ends when a threshold number of zones is assigned).

In some implementations, the CCS may take into account the physical length of the route when assigning locations/items to users. The CCS may determine a physical distance of the route based on location sizes associated with the locations in the route. Example location sizes described herein may include zone values that indicate the sizes of zones. In some implementations, the location sizes may be values that indicate relative size or actual physical sizes (e.g., in meters or feet). In some implementations, the CCS may be configured to assign a route that is shorter than a maximum length. The CCS may also be configured to assign a route that is greater than a minimum length.

In some implementations, the CCS/MSDs may implement item filter rules. In these implementations, the CCS may assign items to MSDs according to item filter rules. Additionally, or alternatively, the MSDs may arrange/display items based on item filter rules. In some implementations, item filter rules may indicate items that should and/or should not be assigned to users/MSDs. For example, when assigning items to users/MSDs, the CCS may filter out specific items for the users/MSDs based on filtering rules that indicate specific items that should and/or should not be assigned to specific users/MSDs. In a specific example, the CCS may include blacklists (denylists) for items that should not be assigned to specific users/MSDs. In another specific example, the CCS may include whitelists (allowlists) that indicate items that should be assigned to specific users/MSDs. In some implementations, the CCS may preferentially assign items in a whitelist to specific MSDs/users. In some implementations, the whitelisting/blacklisting may be set based on item category/type. For example, if a picker is tasked to pick specific item categories, the CCS may assign items included in the item categories to the picker and refrain from assigning items in other item categories. As another example, if a picker is tasked to pick one or more specific store departments, the CCS may assign items included in the specific store departments and refrain from assigning items in other store departments. In some implementations, the whitelisting/blacklisting may be set based on item size and/or weight. For example, heavy items may be assigned to specific users, such as stronger users or fork truck drivers.

In some implementations, item filter rules may filter out specific items based on other items in the order and/or items that are already assigned to a user. For example, the CCS may be configured to separate items that should not be picked together into different routes for different MSDs. In a specific example, with respect to item type, the CCS may be configured to separate frozen items from other items that are not temperature sensitive when assigning items to MSDs. In this specific example, if a picker has already been assigned cooled/frozen items, the CCS may continue to assign cooled/frozen items to the picker in order to ensure that the picker can focus on picking the cooled/frozen items and get the cooled/frozen items to a freezer in the collection/packing area. This scenario may prevent unwanted heating/melting of already-picked frozen items that may occur if the picker is routed away to pick items that are not temperature sensitive. In another example, the CCS may be configured to assign specific items to users that are not handling food products. For example, the CCS may be configured to refrain from assigning food items to pickers that have been assigned various chemicals (e.g., fertilizers).

In some implementations, the CCS/MSDs may implement location filter rules. In these implementations, the CCS may assign locations (e.g., zones) to MSDs according to location filter rules. Additionally, or alternatively, the MSDs may arrange/display items based on location filter rules. Although some users/MSDs may be constrained to pick specific items/locations based on filter rules, some users/MSDs may not be subject to the item/location filter rules.

In some implementations, location filter rules may indicate locations that should and/or should not be assigned to users/MSDs. For example, when assigning locations to users/MSDs, the CCS may filter out specific locations for the users/MSDs based on filter rules that indicate specific locations that should and/or should not be assigned to specific users/MSDs. In a specific example, the CCS may include blacklists (denylists) for locations that should not be assigned to specific users/MSDs. In another specific example, the CCS may include whitelists (allowlists) that indicate locations that should be assigned to specific users/MSDs. In some implementations, the CCS may preferentially assign locations in a whitelist to specific MSDs/users. In some implementations, the whitelisting/blacklisting may be set based on other data associated with the locations, such as the types of items included in the location and/or the department associated with the location.

In some implementations, location filter rules may filter out specific locations based on other locations in the route and/or locations that are already assigned to a user. For example, the CCS may be configured to separate locations that should not be picked together into different routes for different MSDs. In a specific example, the CCS may be configured to separate locations for frozen items from other locations that do not include temperature sensitive items. In another specific example, the CCS may be configured to separate locations for various chemicals (e.g., fertilizers) from other locations including food products.

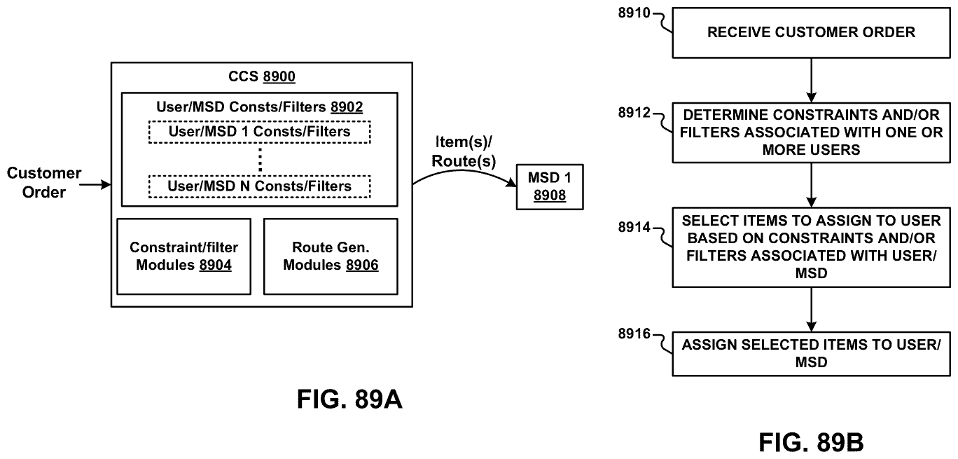

FIG. 89A illustrates an example CCS 8900 that may implement various item/location constraints and filters when assigning items and/or generating routes. The CCS 8900 includes specific constraints and filters for different users/MSDs. For example, the CCS 8900 stores N sets of constraints and filters 8902 associated with N different users/MSDs. The CCS 8900 includes constraint/filter modules 8904 that may generate the constraints/filters for the users/MSDs as described herein. The constraint/filter modules 8904 may also retrieve and apply constraints/filters for users/MSDs when the route generation modules 8906 assign items/locations to the pickers (e.g., in a route).

FIG. 89B illustrates an example method that describes operation of the CCS 8900 in FIG. 89A that may implement item/location constraints and filters for a received customer order. In block 8910, the CCS 8900 receives a customer order. In block 8912, the CCS 8900 (e.g., constraint/filter modules 8904) determines constraints/filters associated with one or more users/MSDs that may pick the customer order. The constraints/filters may limit which items/locations can be assigned to the users/MSDs. In some implementations, some users/MSDs may not have associated constraints/filters. In block 8914, the route generation modules 8906 select items from the customer order to assign to the MSD 8908 (e.g., in a route) based on the constraints/filters associated with the MSD 8908. In block 8916, the CCS 8900 assigns the selected items to the MSD 8908. Although the method of FIG. 89B is illustrated for a single customer order, constraints/filters maybe applied for users/MSDs when assigning items from a queue of different customer orders.

In some implementations, locations in the store may be described herein as “sections.” A section may refer to a set of one or more locations (e.g., a plurality of locations). Put another way, a section may refer to a set of one or more sub-locations (e.g., zones), where each sub-location may make up a portion of the section. For example, a section may include a set of one or more zones. In some implementations, a section may include a plurality of locations (e.g., a plurality of zones). The plurality of locations (e.g., zones) in a section may be connected in some examples. In these examples, the set of locations in a section may be connected together such that a user can walk throughout the set of locations without entering another section. In other examples, the plurality of locations assigned to a section may include some locations that are not connected to one another. Although a section may include a plurality of locations (e.g., zones), in some implementations, a section may include a single location (e.g., a single zone).

Sections may be defined using any of the mapping techniques described herein. For example, sections may be defined by readable location indicators, location indicators that transmit location signals, and/or using any other mapping technique. Accordingly, sections that are illustrated and described as including one or more zones (e.g., defined by location indicators) are only example sections.

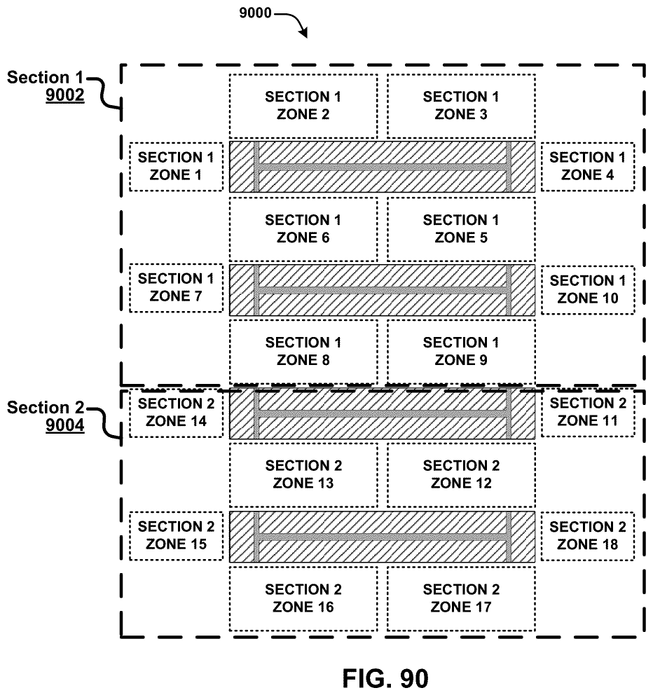

FIGS. 90-94B illustrate implementations of example sections. FIG. 90 illustrates a portion of an example store 9000 that includes two sections (Section 1 9002 and Section 2 9004). Each of the sections 9002, 9004 includes a plurality of zones. For example, section 1 9002 and section 2 9004 include 10 zones and 8 zones, respectively. In implementations of the OFS that include sections, the different locations (e.g., zones) within a section may be identified by a location ID (e.g., a zone 1D) as well as a section ID (e.g., a number, name, or other ID) indicating the section including the location (e.g., zone). For example, a single location (e.g., zone) in the store may be identified by a section ID and another location ID within the section (e.g., a sub-location ID). The locations (e.g., zones) and sections may also be associated with metadata that describe the location/section, such as associated physical locations (e.g., departments, aisle numbers, etc.).

The sections illustrated in FIG. 90 may be defined in a variety of ways. In some implementations, the sections may be defined by location indicators. For example, in some implementations, where zones are defined by readable location indicators, the readable location indicators may include a readable section ID. In some cases, a readable location indicator may include a section ID and another location ID (e.g., the sub-location zone 1D), such that the location indicator explicitly indicates both the section and the sub-location within the section. In other cases, the readable location indicator may include a location ID that is later interpreted/assigned as a sub-location within a specific section. For example, if a zone is associated with a location ID, such as a random number sequence, the location ID may not explicitly indicate a section ID and a sub-location ID, but the CCS may later associate the random number sequence to a specific sub-location in a specific section. In some implementations, a readable location indicator may have separate readable codes for section and sub-location.

In some implementations, where zones are defined by location indicators that transmit location signals, the location signals may indicate the section ID. In some cases, a location indicator may transmit one or more signals (e.g., a single code or multiple codes) that indicate a section ID and another location ID (e.g., the sub-location zone 1D), such that the location indicator explicitly indicates both the section and the sub-location within the section. In other cases, the location indicator may transmit a location ID that is later interpreted/assigned as a sub-location within a specific section. For example, if a zone is associated with a location ID, such as a random number sequence, the location ID may not explicitly indicate a section ID and a sub-location ID, but the CCS may later associate the random number sequence to a specific sub-location in a specific section. In some implementations, a location indicator may transmit separate location IDs indicating section and sub-location.

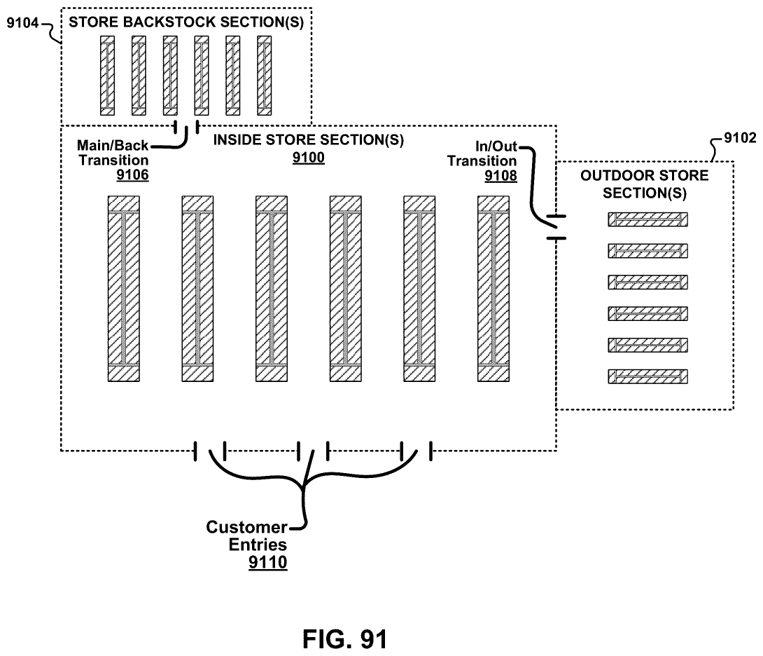

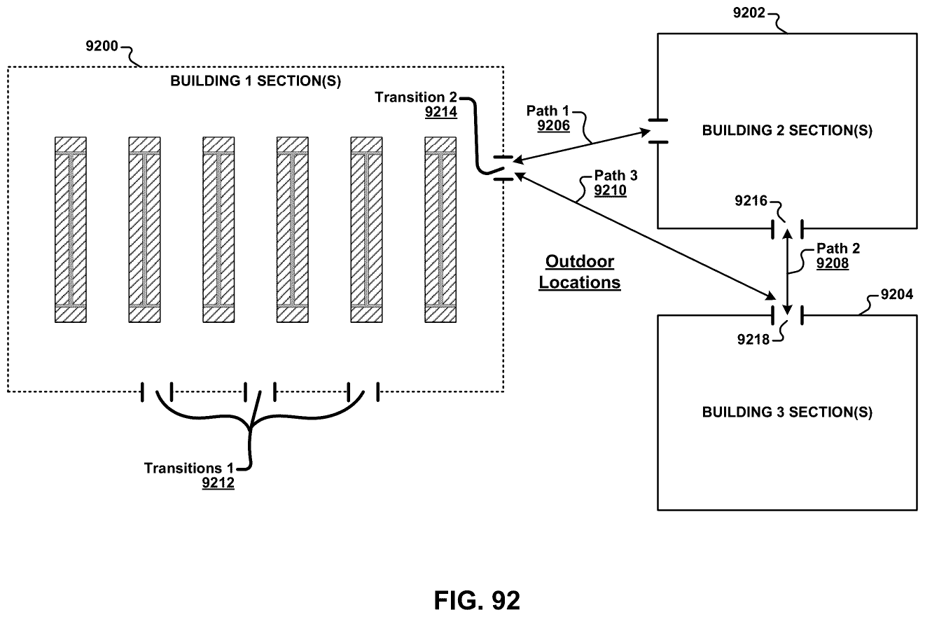

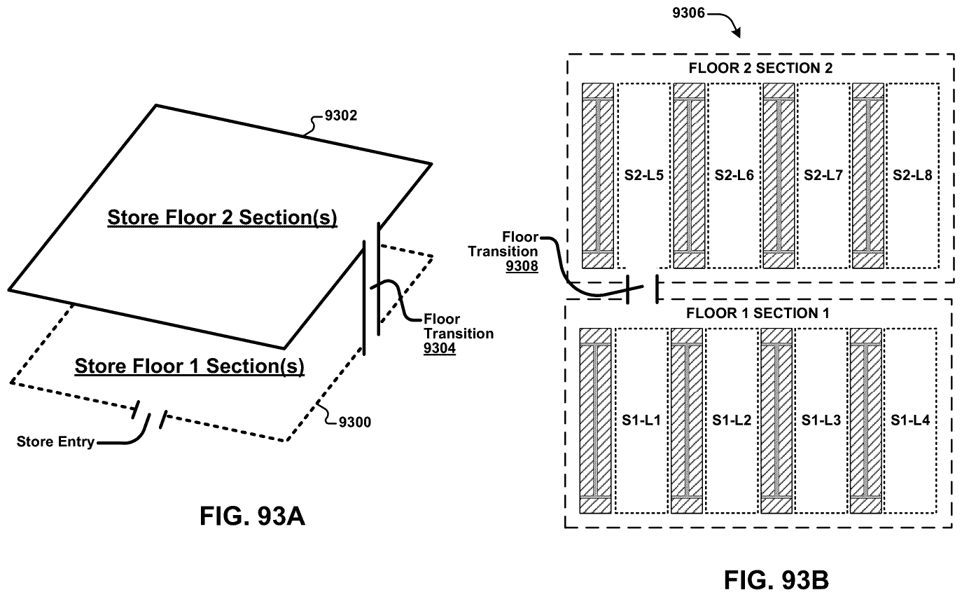

In some implementations, a section may be associated with physical locations that are meaningful to the users. For example, different sections may be associated with different departments of a store (e.g., one or more sections to a department), such as a dry goods department, a frozen department, a fresh fruit department, an electronics department, a grocery department, etc. Similarly, different sections may be associated with different item types, such as cereals, frozen pizzas, frozen entrees, fruit, etc. In this example, different item types may be grouped by section. As another example, different sections may be associated with different aisle numbers. The sections may also be defined according to different types of physical locations, such as different floors of a store (e.g., see FIG. 93A), different areas of a store (e.g., see FIG. 91), and/or different buildings of a complex (e.g., see FIG. 92). In a similar manner as grocery stores, different sections for a factory complex may be associated with different factory locations/buildings.

Sections (e.g., section IDs) may be manually and/or automatically assigned. In some implementations, the sections may be manually assigned by an employee of the store (e.g., manager/administrator). In one example, the sections may be explicitly defined by the location indicator as a section ID that is readable or transmitted by the location indicator. In another example, the sections may be defined in software at the CCS. For example, the sections may be manually assigned to existing locations (e.g., according to department, floor number, item type, aisle number, or other physical description).

In some implementations, the CCS may provide a user interface in which a user (e.g., employee, manager, and/or administrator) may define the sections manually. A user interface for defining sections may include lists of locations for the user to select and group into a section. The user interface may be used to define sections before and/or after a location map including the sub-locations has been generated. The user interface may also provide GUI elements (e.g., text entry elements or menus) that receive user-defined section names (e.g., aisle names, department names, floor names, etc.). In some implementations, a user interface for defining sections may include lists of items for the user to select and group into a section. In these implementations, the CCS may group together locations including the items into a section.

In implementations where location indicators provide location IDs that explicitly define section and sub-location, placement of the location indicators by the users (e.g., store employees) may define the sections as the store location map is generated according to the techniques of the present disclosure (e.g., see FIGS. 40-44B). For example, if a readable location indicator includes a section ID and a sub-location ID (e.g., as separate codes or a concatenated code), a user may place the location indicators according to their desired section layout. In a specific example, if the user wants to define different floors as different sections, the user may place location indicators with the same first section ID, but different sub-location IDs, on a first floor. In this specific example, the user may place location indicators having a second section ID, but different sub-location IDs, on a second floor. Such an arrangement of location indicators with first section IDs and second section IDs may indicate locations on the first floor and the section floor, respectively. In a similar manner, a user may place location indicators that define different store departments, aisles, rooms, etc.

In some implementations, sections may be automatically defined by the CCS/MSDs. In one example, items can be associated with locations (e.g., zones), as described herein. Locations including items of a defined item type may then be associated with a defined section. For example, locations including frozen entrees may have a section ID of “Frozen Entrees” assigned to the zones. In some implementations, sections may be defined based on the number of items picked from the section, such as the rate at which items are picked. For example, the CCS/MSDs may define sections such that the sections have similar numbers of items picked, then assign sections to different pickers. In this example, the picking workload may be spread across a number of users. Additionally, in this example, the section definitions may be redefined over time (e.g., over hours) to adjust the number of items assigned to the pickers. In some implementations, the sections may be defined by the size of the locations (e.g., zone sizes) included in the section. For example, sections may be assigned to locations in a manner that produces sections of similar size. Producing sections of similar size may spread movement out evenly across multiple users.

In some implementations, sections may be automatically defined based on acquired images. For example, a section may be defined based on images of an aisle number associated with a set of zones. As another example, a section may be defined based on images of a department name associated with a set of zones. Images of other physical locations may also be used to automatically define sections. In some implementations, the CCS/MSDs may be operated in a section/location mapping mode that automatically generates the section ID and metadata. Additionally, or alternatively, the section IDs and metadata may be manually assigned. Additionally, or alternatively, the section IDs and metadata may be generated while the users are picking.

In some implementations, the CCS may be configured to automatically generate location maps including sections while users (e.g., customers, employees, third parties, etc.) are picking, as described herein. For example, the CCS may generate a location map including sections while users are moving MSDs throughout the store while picking items for customer orders. In some implementations, the CCS may also be configured to update location maps to include new sections and/or remove old sections automatically. For example, detection of new section IDs over time may result in the addition of section IDs to the location map. As another example, lack of acquired section IDs over time (e.g., after a threshold period of time) may result in the CCS removing the sections from the location map.

In some implementations, a user may place an MSD into a mapping mode to generate a location map including sections and/or sub-locations. For example, a user may place an MSD into a mapping mode and manually enter a section name into the MSD (e.g., by typing or in a selection menu). The user may then proceed to walk through the section they wish to define and scan location indicators (e.g., read location indicators, pickup location signals, etc.), acquire images, and/or use any other mapping technology described herein. In the mapping mode, the CCS/MSD may associate the locations with the defined section (e.g., the entered section name). In a specific example, the user may enter the section name “First Floor” and then proceed to generate a location map of the first floor, as described herein. The result of this specific example would be a location map of the first floor, as described herein, where the locations on the first floor are associated with the section named “First Floor.”

In some implementations, location indicators that define sections may be different than location indicators that define sub-locations. For example, additional location indicators may be added to the store to define sections. In a first specific example, different readable codes for sections may be placed near readable codes for the store sub-locations. In this specific example, a user (e.g., store employee) may place readable location indicators in a first set of locations and then place additional readable location indicators that specify sections (e.g., section indicators) in areas of the store where they wish to define a section. In this case, the section indicators for the same section may include the same readable codes. The CCS may determine that the section indicators adjacent to the location indicators indicate that the location indicators are sub-locations within the section. In some implementations, sections may be defined by different location technology than the sub-locations. For example, sections may be defined by readable location indicators and/or images, while sub-locations may be defined by location indicators that transmit location signals.

The number and size of sections in a store may vary, depending on the implementation. Additionally, the number and sizes of zones within a section may vary. For example, a single section may cover an entire floor with a plurality of sub-locations. In another example, a single floor may include a plurality of sections for different departments on the floor, where each of the sections includes a plurality of sub-locations. As another example, a single store department may include a plurality of sections, each of which includes a plurality of sub-locations. The CCS/MSDs may generate location maps including any number of sections and sub-locations as described herein. In some implementations, the CCS/MSDs may determine that sections are adjacent to one another based on adjacency of sub-locations of the sections. In implementations using separate section indicators, the CCS/MSDs may determine that sections are adjacent to each other in a manner similar to determining that two locations are adjacent to each other (e.g., based on reading/scanning section indicators within a threshold period of time).

FIG. 91 illustrates an implementation in which different portions of the store each include one or more sections. In this implementation, the different sections may represent different physical aspects of the store. For example, a main portion of the store (e.g., inside of the store 9100) that is visited by customers may include one or more sections. Additionally, an outdoor portion of the store 9102, which may include specific types of items, may include one or more sections. For example, an outdoor portion of the store may include lawn and garden items. The store of FIG. 91 also includes a backstock area 9104 that may include one or more backstock sections. A backstock section of the store may include additional items (e.g., refrigerated/frozen and/or non-refrigerated) that may also be included in the inside/outdoor sections of the store. In some implementations, a backstock section may include a walk-in refrigerator/freezer. In some cases, the backstock section of the store may not be accessible by the customers. Instead, the backstock sections of the store may be used by employees of the store and/or other third parties that are granted access. In some implementations, the backstock section of the store may be used to house items for filling customer orders that were placed remotely (e.g., online customer orders). In these implementations, the backstock section may be used as an alternative picking area for the store in order to maximize picking speed and minimize movement in customer occupied areas. Additionally, the backstock section may be used along with other sections of the store for picking customer orders. Note that the different areas of the store may be different rooms of the store. For example, the inside store sections may be included in a single room that is separate from one or more rooms of the backstock section(s).

FIG. 91 includes illustrated transitions between different portions of the store. For example, there is a physical transition 9106 between the inside store portion and the backstock store portion. Additionally, there is an indoor/outdoor transition 9108 between the inside store portion and the outdoor store portion. Transitions illustrated in the figures may be physical locations in the store that separate other physical locations (e.g., rooms, floors, buildings, etc.). For example, transitions may include, but are not limited to: 1) physical separations between indoor/outdoor areas, 2) separations between customer/backstock areas, 3) separation between outside/customer areas (e.g., customer entries 9110), 4) separation between multiple floors (e.g., ramps, stairs, escalators, ladders, etc.), 5) separations (e.g., paths) between different buildings, and 6) doorways.

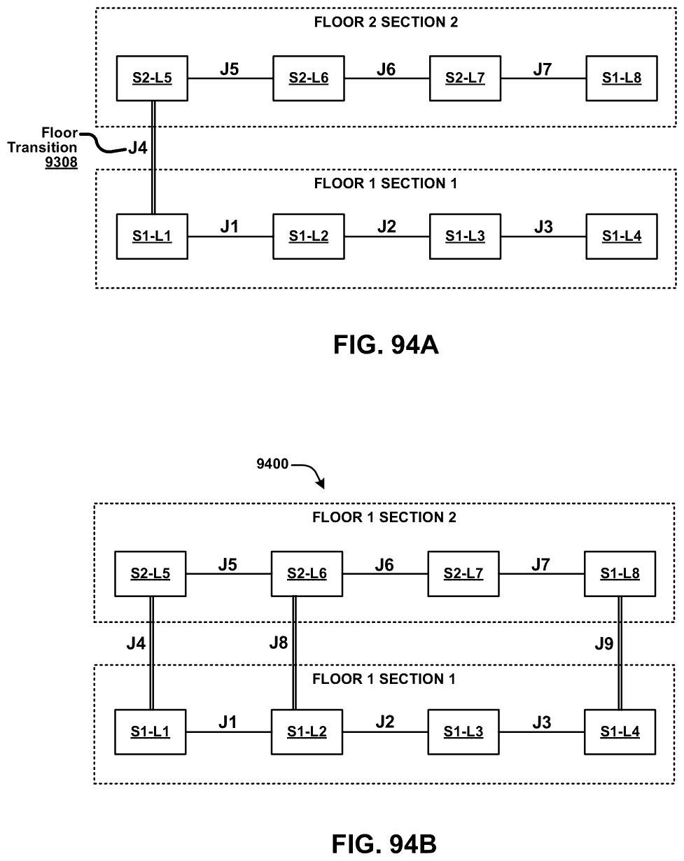

In some implementations, the physical separation between different portions of the store (or building complex) may be represented by data at the CCS, although such transitions are not required to be represented by data. The transitions may be represented in a variety of different manners. For example, the transitions may be separated by locations in a location map (e.g., zones). In this example, the transitions may not include items in some cases. When transitions are represented by mapped locations (e.g., zones), the transitions may be represented by any of the mapping techniques described herein, such as location indicators and/or images. In some implementations, the transitions may be represented by junctions between locations (e.g., see FIGS. 94A-94B).

FIG. 92 illustrates an implementation in which different buildings (e.g., 3 buildings 9200, 9202, 9204) of a complex each include one or more sections. Example multi-building complexes may include, but are not limited to, a multi-building store, a plurality of different stores (e.g., a strip of stores and/or an outdoor/indoor market), a multi-building warehouse, and a multi-building factory. Users may traverse paths (e.g., paths 1-3 9206, 9208, 9210) between the buildings. Users may enter and exit the buildings through the illustrated transitions (e.g., building entries 9212, 9214, 9216, 9218). The paths and transitions may be represented in data as different junctions and/or locations (e.g., zones), as described herein.

FIGS. 93A-93B illustrate an implementation in which different floors 9300, 9302 of a building each include one or more sections. Users may move from one floor 9300 to another 9302 via one or more floor transitions 9304, such as stairs, ramps, ladders, elevators, escalators, etc. The floor transitions may be represented in data as different junctions and/or locations (e.g., zones), as described herein. FIG. 93B illustrates an example store 9306 having four locations on each floor (S1-L1, . . . , S1-L4 and S2-L5, . . . , S2-L8). The floor transition 9308 is located between locations S1-L1 and S2-L5.

FIG. 94A illustrates an example map of the multi-level building (e.g., store, warehouse, etc.) of FIG. 93B including a junction J4 that represents the floor transition 9308. FIG. 94B illustrates another example multi-level building 9400. The multi-level building 9400 of FIG. 94B includes additional junctions J8 and J9 that may represent additional floor transitions (e.g., ramps, stairs, elevators, etc.). Note that the junctions representing transitions are illustrated with double lines in FIGS. 94A-94B. Also note that the transitions may be represented in data as additional locations (e.g., in place of the junctions).

In some implementations, transitions may be associated with items that are located higher on racks, such as racks that may be out of reach to users without additional equipment (e.g., a movable staircase, pallet stacker, forklift, etc.). For example, the items on higher racks may be higher than 7 ft high (e.g., from 8-20 ft high on upper racks). Items located higher on racks may be associated with different location values than those items located beneath them and within a user's reach. The locations located higher up on the racks may be connected by junctions/zones to the locations associated with the items beneath them. In some cases, the locations associated with items located higher on racks may be assigned to specific users/MSDs that may use the proper equipment for picking the items. Associating higher items may also allow the OFS to efficiently route users when customer orders include items located at different heights.

Some transitions may be more time consuming for a user to traverse. As one example, stairs between floors may take longer to traverse than doorways between parts of a building or moving between adjacent departments. As another example, long paths between buildings may take longer to traverse than other types of transitions. The potential inefficiency of travelling between different sections (e.g., via transitions) may be handled by the OFS in a variety of ways. In some implementations, the estimated size and/or traversal time associated with a transition may be represented in data. For example, in a manner similar to zone size values indicating a size or traversal time for a zone, transitions may be associated with transition size/time numbers that indicate their size or traversal time. In one specific example, a transition may be represented as a junction with an associated junction value that indicates the size or traversal time associated with the transition. In another specific example, a transition may be represented as a location (e.g., zone) with an associated zone size value that indicates the size or traversal time associated with the transition. Although transition size/time numbers may be used in generating maps and picking items, the OFS may be implemented without using such numbers.

The CCS/MSDs may store data associated with the locations (e.g., zones), sections, and junctions in order to assign items/locations to MSDs for mapping and picking as described herein. Additionally, the CCS/MSDs may use data associated with ordered items to assign items/locations, such as data that indicates a customer order number, a priority (e.g., if the item is required immediately), an order time at which the order was placed or will be picked, etc.

In some implementations, the CCS/MSDs may store location data (e.g., zone data), such as a location ID/name, location values (e.g., associated traversal times/sizes), and whether/which MSDs/users may pick the items from the locations or traverse the locations. In some implementations, the CCS/MSDs may store section data, such as section name/ID and whether/which users can pick from the sections or traverse the sections. The CCS/MSDs may also store junction data, such as junction name/ID, junction type (e.g., transition type, such as stairs, path, upper item, etc.), junction values (e.g., indicating traversal times), and whether/which MSDs can cross the junctions.

As described herein, the CCS/MSDs may store a variety of data associated with customer orders and items. For example, an item and/or customer order may have a priority value associated with the item and/or customer order that indicates a level of picking priority. In a specific example, a 0 value may indicate no/low priority (e.g., the item is not needed immediately) and a value greater than 0 (e.g., 1 or a larger integer) may indicate a higher priority (e.g., a 1 or greater value may indicate the item should be picked as soon as possible). The CCS/MSDs may use the priority values to prioritize items for routes that are needed immediately. In some implementations, an item may have one or more picking time values, such as a time the item's order was placed and/or a time the item should be picked. The CCS/MSDs may use the time values to determine whether/when to add items to a route. For example, the CCS/MSDs may add items to a route if the item should be picked soon (e.g., based on a scheduled pickup time). In some implementations, an item may have an item type assigned (e.g., frozen or not frozen). In some implementations, an MSD may be assigned to pick specific item types for a route, such as items that are frozen or not frozen. In a specific example, an MSD may be restricted to picking frozen items on a route when an order is nearly ready for pickup/delivery to prevent melting.

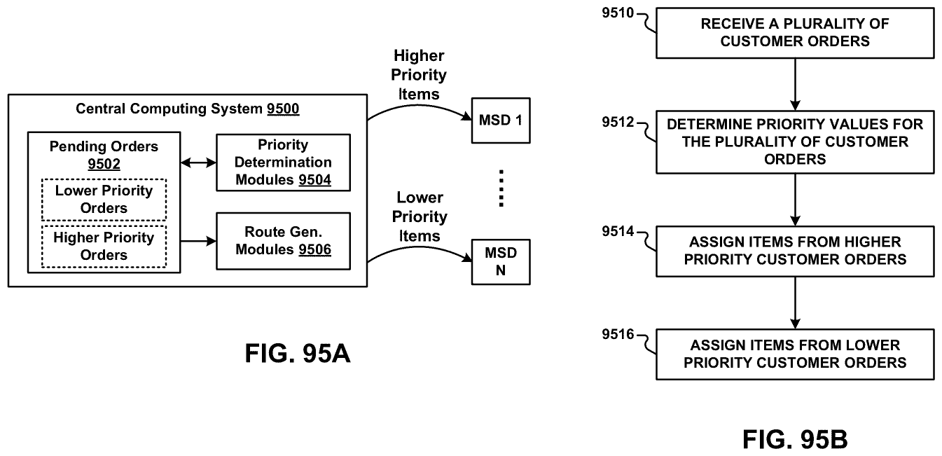

FIG. 95A illustrates an example CCS 9500 that may determine priority data associated with customer orders/items. The CCS 9500 in FIG. 95A receives a plurality of customer orders 9502 and determines priority data (e.g., priority values) associated with the customer orders. For example, the CCS 9500 includes priority determination modules 9504 that determine priority values for pending customer orders 9502, as described herein. The CCS 9500 (e.g., route generation modules 9506) may assign items/routes to users/MSDs based on the priority data.

In some implementations, the CCS 9500 may assign priority values at the customer order level. In these cases, the items included in the customer order may be associated with the same level of priority as the customer order. In some cases, the CCS 9500 may assign different priority levels to items. For example, if some items are not yet picked/packed for a customer order, the CCS 9500 may increase the priority level associated with the items.

In some implementations, the CCS 9500 may implement two priority values (e.g., 0/1), which may be referred to as a higher priority level and a lower priority level. In these implementations, the higher priority level orders/items (e.g., associated with a first priority value) may be assigned in a manner that provides for more immediate picking relative to lower priority level orders/items (e.g., items associated with a second priority value). For example, as described herein, the CCS 9500 may first assign the high priority orders/items to MSDs before assigning the lower priority orders/items (e.g., assign all or most high priority orders/items first).

In some implementations, the CCS 9500 may implement additional priority levels to further prioritize the picking of some orders/items. For example, the CCS 9500 may increase priority levels for orders/items that are deemed more urgent at the time. In a specific example, a higher priority item may become an even higher priority (e.g., by incrementing the priority value) if a customer has arrived at the store and is waiting for the order. In some implementations, a higher priority level (e.g., larger priority value) may indicate that an item is a relatively greater priority for picking than an item associated with a lower priority level (e.g., smaller priority value).

In some implementations, the CCS 9500 may determine priority values based on timing factors. For example, the CCS 9500 may determine priority values based on at least one of: 1) the time the order was placed (e.g., age of the order), 2) the amount of time the items/order have been assigned to pickers, 3) the time the order is needed for pickup by a customer at the store, and 4) the time the order is needed for pickup by a delivery driver at the store.

In examples where the CCS 9500 determines priority values for orders/items based on the time the order was placed (e.g., the age of the order), the CCS may assign a higher priority to orders/items that were placed earlier (e.g., older orders). In some implementations, the CCS 9500 may use a threshold time value to determine which items are higher priority and which are lower priority. For example, orders that were placed greater than a threshold time before the present time (e.g., greater than a threshold age) may be given a higher priority value than more recently placed orders (e.g., orders less than a threshold age). In some implementations, the CCS 9500 may include multiple thresholds that define multiple time ranges, each associated with different priority values, where higher priority levels are associated with older time ranges.

In examples where the CCS 9500 determines priority values for orders/items based on when the orders/items were assigned to pickers, the CCS 9500 may assign a higher priority to orders/items that have been assigned for a longer period of time. For example, the CCS 9500 may use a threshold time to determine which orders/items are higher in priority. In a specific example, orders/items that have been assigned to pickers for greater than a threshold amount of time may be given a higher priority value than more recently assigned orders/items. In some implementations, the CCS 9500 may include multiple thresholds that define multiple time ranges associated with assigned orders. Each of the time ranges may be associated with different priority values, where higher priority levels are associated with orders/items that were assigned for longer periods of time.

In examples where the CCS 9500 determines priority values for orders/items based on when orders/items are needed for pickup by a customer or delivery driver, the CCS 9500 may assign a higher priority to orders/items that are needed for pickup sooner. For example, the CCS 9500 may use a threshold time to determine which orders/items are higher in priority. In a specific example, orders/items that are needed for pickup within less than a threshold amount of time may be assigned a higher priority than orders/items that are needed later. In this specific example, if the customer order is needed immediately (e.g., is needed now or has been needed), the CCS 9500 may assign a higher priority value to the order. Assigning a higher priority in this case may assure that a customer/driver is not held up waiting for an order at the store. In some implementations, the CCS 9500 may include multiple thresholds that define multiple time ranges associated with a time the order is needed for pickup. Each of the time ranges may be associated with different priority values, where higher priority levels are associated with orders/items that are needed sooner.

In some implementations, the CCS 9500 may determine priority values based on location factors. For example, the CCS 9500 may determine priority values based on the location of the customer or delivery driver (e.g., locations determined based on GPS data from customer/driver computing devices). In examples where the CCS 9500 determines priority values based on the location of the customer, the CCS 9500 may assign a higher priority to orders/items for customers that are at, or near, the store. For example, the CCS 9500 may assign highest priority to orders/items for customers waiting at the store. In this example, the CCS 9500 may assign lower priority to orders/items for customers that are farther away from the store. In another specific example, the CCS 9500 may assign higher priority to orders/items that are associated with customers based on their distance from the store. In this specific example, customers within a threshold distance may have the highest priority orders/items. The CCS 9500 may assign multiple different priority values to the customer orders/items based on different threshold locations (e.g., at home, approaching the store within X miles of the store, at the store waiting, etc.).

In a manner similar to assigning priority based on customer location, the CCS 9500 may assign priority levels to orders/items based on the location of a delivery driver that is tasked with delivering the items. For example, the CCS 9500 may assign higher priority to drivers that are nearer to the store. In one example, the CCS 9500 may assign the highest priority to drivers that are at, or near (e.g., approaching), the store. Similar to priority values associated with customer location, the CCS 9500 may assign two or more priority values to the customer orders/items based on different threshold locations of the delivery driver. In some implementations, the highest priority value may be assigned for a delivery driver that is waiting at the store. Assigning highest priority to customers/drivers at the store waiting for orders may prevent the customers/drivers from being held up waiting at the store.

The CCS 9500 may assign priority values to orders/items based on one or more of the factors described herein. For example, the CCS 9500 may assign priority values based on one or more timing factors and/or one or more location factors. In a specific example, the CCS 9500 may assign the highest priority value to a customer that is located at the store and has been waiting for greater than a threshold period of time. In this case, the customers that are at the store waiting the longest (e.g., greater than a threshold period of time) may be served first. Note that the CCS 9500 may assign orders/items to pickers based on priority level and/or other assignment/routing factors described herein.

As described herein, the priority values may be determined for entire orders and/or individual items. In one example, an initial priority value may be assigned to an entire customer order. In this example, a first portion of the order may be picked according to the priority level. After time has elapsed and/or customers/drivers have changed location (e.g., nearer the store or arrived at the store), the CCS 9500 may assign higher priority values to the remaining items in the second portion of the customer order according the timing and locations factors described herein.

The CCS 9500 may implement a variety of assignment/routing decisions based on priority levels associated with the orders/items. In some implementations, the CCS 9500 may be configured to assign the highest priority orders/items prior to assigning the lower priority orders/items. For example, the CCS may be configured to assign higher priority orders/items to pickers until there are no more higher priority orders/items. After assigning all higher priority orders/items, the CCS may begin assigning lower priority orders/items.

In some implementations, the CCS 9500 may be configured to split higher priority orders to different pickers in order to maximize the picking speed of the overall order. For example, the CCS 9500 may be configured to split a high priority order in a manner that increases the picking speed based on the current location of the pickers. In a specific example, the CCS 9500 may split a high priority order to pickers that are near items in the order. In some implementations, lower priority orders may be assigned at a later time and/or entirely assigned to pickers that are provided with more time to pick the orders.

FIG. 95B illustrates an example method that describes operation of a CCS 9500 that may determine priority values and assign orders/items to pickers based on the determined priority values. In block 9510, the CCS 9500 receives a plurality of customer orders. In block 9512, the CCS 9500 determines priority values for the plurality of customer orders. In block 9514, the CCS 9500 assigns items from higher priority customer orders to one or more pickers. In block 9516, the CCS 9500 assigns items from lower priority customer orders to one or more pickers. In FIG. 95B, the higher priority orders are assigned first (e.g., to MSD 1), and the lower priority orders are assigned later (e.g., MSD N).

In some implementations, the MSDs may store the assigned customer orders and prompt the user to pick the customer orders in order of priority. For example, an MSD may store a high priority order and a low priority order. In this case, the MSD may generate an interface for picking the high priority order first. After the high priority order is picked, the MSD may generate an interface for picking the low priority order.

In some implementations, the CCS/MSDs may store MSD/user specific values for items, such as values that indicate whether the item is allowed to be picked by an MSD/user, whether a zone may be entered by the MSD/user, and whether a section may be entered/assigned to the MSD/user or is off limits. The junction data may also be MSD/user specific, such as whether MSDs/users should cross junctions and/or whether the MSDs/users are disincentivized from crossing the junctions.

In some implementations, the CCS/MSDs may implement filters for users. For example, specific locations (e.g., sections/zones) and junctions may be filtered out for specific pickers/MSDs. In a specific example, one MSD may be prohibited from having specific sections/zones and/or items in the specific sections/zones assigned to the MSD. In a specific example with respect to a junction, an MSD may have junction traversal prohibited in order to prevent generation of a route for the picker that crosses the junction. A junction filter may be useful in implementations where crossing a junction is inefficient, such as moving upstairs or walking to a new building.

As described herein, instead of using hard filters for junctions, in some implementations, the CCS/MSDs may disincentivize movement across a junction by assigning a junction value that represents the inefficiency of traversing the junction. Assigning hard filters and/or values to junctions and sections/zones may optimize picker efficiency since it may disincentivize inefficient movements for pickers. In the case of multiple floors, there may be one junction/zone for a transition separating the two sections or zones between floors. In this case, the junction/zone may represent stairs, a ramp, escalator, or other structure for accessing the multiple floors. Such structures may be inefficient for pickers to traverse, especially if another picker is picking items on the other side of the junction (e.g., other floor or building). Division of locations (e.g., sections/zones) into multiple floors may provide for efficient picking in compact footprint multi-floor stores, such as grocery stores with multiple floors or a multi-story warehouse.

The CCS/MSDs may generate location maps that include sections in a similar manner as described with respect to zones. For example, the CCS/MSDs may generate location maps for the store that include sections along with junctions that define the adjacency of sections (e.g., see FIGS. 94A-94B). Location maps that include sections may also include data for the different zones within the sections (e.g., zone size data, junction data, and zone adjacency data). FIGS. 94A-94B graphically illustrate example map data that may be stored by the CCS/MSDs in stores that implement sections and zones. In the examples of FIGS. 94A-94B, each location in the store may be mapped by zone and section. In some implementations, the locations (e.g., sections/zones) may include names/IDs that identify the locations (e.g., sections/zones). In some cases, a section name can be human readable. For example, a section may be named dairy, dry goods, frozen, pets, first floor, second floor, etc., in order to indicate where the sections are located.

Although items may be mapped in the store, in some implementations, some items may not be mapped (i.e., unmapped items). In some implementations, the MSDs may display the unmapped items in a different manner to the user, such as in a separate section of the display (e.g., grouped in a separate section of the display).

The CCS/MSDs may generate routes for sections in a similar manner as the CCS/MSDs generate routes for other locations described herein. For example, the CCS/MSDs may generate routes for sections according to any of the factors described above. In a specific example, sections may be assigned to users based on historical/current/future locations of the MSD/user, historical/current/future items associated with an MSD/user, and/or location/item filters associated with the MSD/user. In some implementations, the CCS/MSDs may generate routes based on sections and then determine the routes within the section(s) (e.g., section sub-routes). For example, the CCS/MSDs may select a section for a route and then generate a route through the section (e.g., a sequence of zones through the section). As another example, the CCS/MSDs may select a sequence of one or more sections for a route and then generate sub-routes through the zones of each section. Additional mapping and routing techniques using sections/zones are described hereinafter.

In some implementations, the MSDs may arrange sections on their displays based on user location and/or based on an assigned route. In one example, if the MSD is assigned a route, the MSD may group items by section within the route for display. In this example, the MSD may arrange the sections in the order in which the route should be picked. The MSD may also arrange the items on the display based on the order in which items should be picked. If a user is picking items without a fixed route, the MSD may group items by section and arrange the sections based on their relative location to the user. The MSD may also arrange items on the display within the section based on their location relative to the user, as described herein.

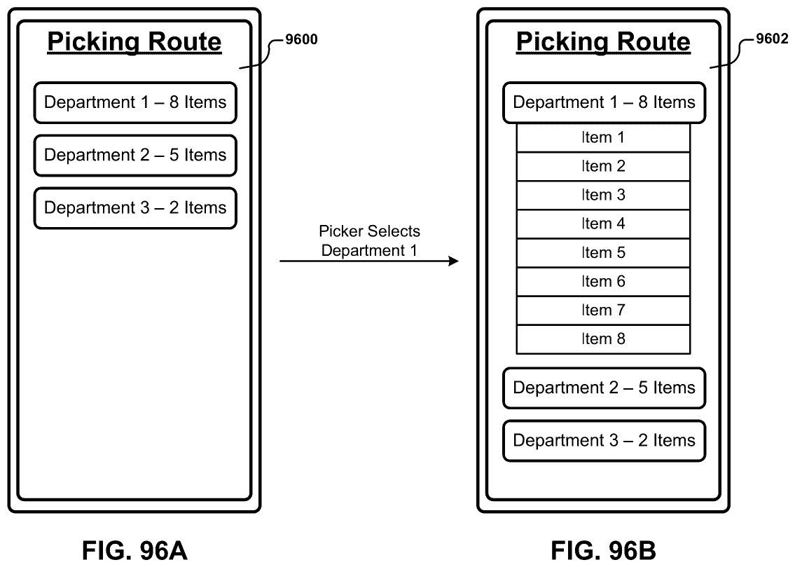

FIGS. 96A-96B illustrate an example MSD interface for an MSD that is assigned a route including items in three sections, which are referred to as Department 1, Department 2, and Department 3. Department 1, Department 2, and Department 3 include 8 items, 5 items, and 2 items, respectively. In FIG. 96A, the MSD GUI 9600 arranges sections (e.g., Departments 1-3) in the order in which the sections should be picked. Specifically, the MSD indicates to the user that they will be picking Department 1, 2, and 3 in order. In some implementations, the sections may remain in a fixed order (e.g., for a fixed route). In other implementations, the sections may rearrange when the user moves throughout the store. For example, the sections may rearrange on the display based on their relative location to the user. In this example, a section including the user, or most near the user, may be arranged at the top of the display. Sections farther from the user may be arranged in order of distance under the top section, as described herein with respect to locations.

In FIG. 96A, the user (e.g., picker) selects the Department 1 GUI element (e.g., button). For example, a user may select the Department 1 GUI element by touching the GUI element. Referring to the GUI 9602 of FIG. 96B, selecting the Department 1 GUI element expands the list of items 1-8 included in the route in the Department 1 section. Items 1-8 may be arranged according to the route (e.g., if the route is fixed). In some implementations, items 1-8 may be arranged according to their relative location to the user. In some implementations, movement of the user throughout the store may cause the items to be reorganized under the Department GUI element. In addition to rearranging the items during user movement, the department GUI elements of FIG. 96B may also be rearranged based on location relative to the user. The user may select the Department 1 GUI element to collapse the GUI back to the state illustrated in FIG. 96A. The user may also select other Department GUI elements to expand the item lists, which may rearrange based on user location or be fixed based on a fixed route. Although the GUIs of FIGS. 96A-96B illustrate groupings by department, any other type of section grouping described herein may be implemented, such as floor groupings, building groupings, room groupings, store groupings, etc.

In some implementations, MSDs may be subjected to filtering based on section. In this case, one or more sections (e.g., items/zones in the section) may be assigned to specific MSDs/users and prohibited for other MSDs/users. In some cases, the filters may be assigned at the MSD level and/or the user level. For example, the CCS may filter out items that are not included in the section for the MSD (e.g., based on an MSD ID, user ID, and/or section ID). In some implementations, the CCS may include blacklists/whitelists for sections for MSDs (e.g., MSD IDs and/or user IDs). In some implementations, filtering may be based on the past, current, or future location of the user. For example, if a user enters a second floor, the user may not be shown items on the first floor, or preferentially shown items on the second floor, unless picking items on the first floor is more efficient. Filtered-out items may be removed from the MSD displays and/or moved to a portion of the MSD display that indicates the items are inefficient to pick (e.g., arranged at the end of a list on the display). For example, items that are inefficient to pick may be grouped lower in the display (e.g., farther down the screen).

In some implementations, the CCS may assign sections to MSDs based on the number of available MSDs. For example, if a single MSD is being used for picking, the single MSD may pick from all sections. In the case one or more additional MSDs are available, the CCS may assign different sections to one or more of the available MSDs (e.g., based on the volume of items and/or size of the section). In one specific example, if a single user is assigned to pick a first floor, a second user may be subsequently assigned to pick a second floor. In this specific example, if there are 2 users in a two-floor store, each user may be assigned to a different floor. If a third picker is added, the third picker may be assigned to pick the floor based on the need for the picker (e.g., assign the picker to the floor with more items and/or higher priority items).

In some implementations, the number of users assigned to a section may depend on the current number of ordered items in the section, where additional MSDs may be assigned to a section that includes a large/larger number of items (e.g., greater than a threshold number of items). In some implementations, the number of MSDs assigned to a section may depend on the size of the section (e.g., based on the zone sizes for the section) and/or the number of stocked items in the section that may be ordered for picking (e.g., a total number of items in the section and/or a rate at which the items have been ordered historically). For example, a greater number of MSDs may be assigned to pick sections that include more items, are larger in size, and/or have more outstanding items.

In some implementations, the MSD may generate GUIs associated with locations (e.g., sections/zones) and items. For example, the MSD may generate a GUI that allows the picker to manually select a section/zone on the display (e.g., a list menu or graphic shown at startup or in a settings section of the MSD). The MSD may also generate a GUI that allows the picker to select the types of items they will pick. The CCS/MSDs may generate routes based on the user selections of locations/items in the interface.

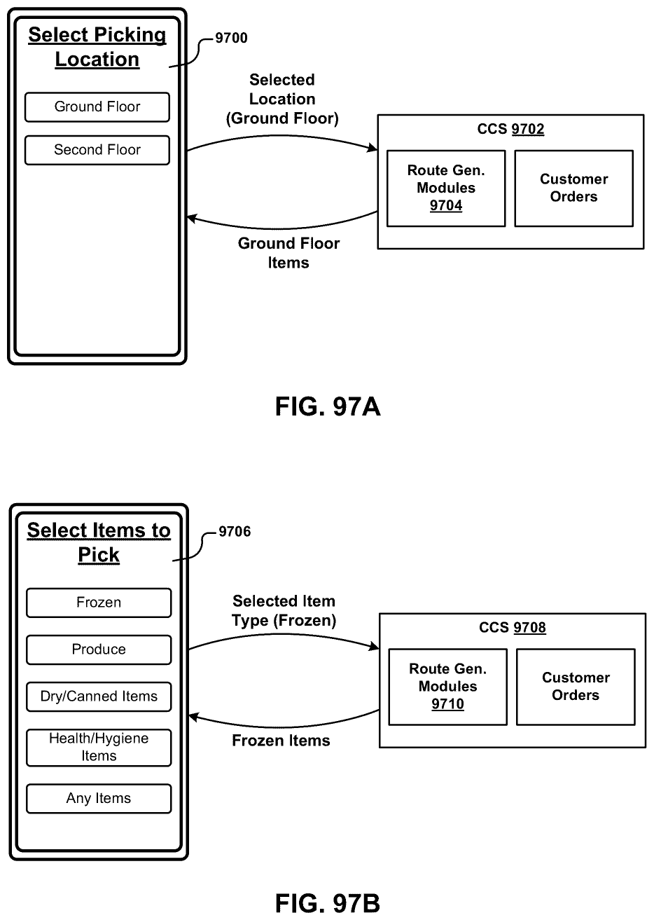

FIG. 97A illustrates an example MSD GUI 9700 that allow pickers to manually select a picking location. In FIG. 97A, the MSD generates a GUI 9700 that includes multiple location selection GUI elements that a user may select (e.g., touch). Specifically, in FIG. 97A, the user may select either a Ground Floor location or a Second Floor location. The CCS 9702 may take into account the selected location when assigning items, orders, and/or routes to the user/MSD. For example, the selected location may act as a location-based filter. In one example, the CCS 9700 may assign items associated with the selected location. In this example, the CCS 9700 may also refrain from assigning items outside of the location. A location selection GUI (e.g., as illustrated in FIG. 97A) may provide pickers in the OFS with picking location flexibility.

In FIG. 97A, the user can select from one of two optional locations. The locations in FIG. 97A are for a store that includes at least 2 floors. For example, the store may include a lower Ground Floor and an upper Second Floor. In FIG. 97A, the user selects the Ground Floor selection GUI element. In response to the selection, the CCS 9700 (e.g., routing generation modules 9704) may assign items to the user that are on the Ground Floor. As described herein, the Ground Floor may include one or more zones and one or more sections. For example, the Ground Floor may be covered by a single section that includes a plurality of zones. As another example, the Ground Floor may include a single zone (e.g., in the case the floor is not separated into multiple zones).

Although the user-selectable locations included in FIG. 97A are floors of a store, any of the locations described herein may be selectable. For example, any sections/zones defined in any manner may be selected by a user. Example other locations that may be selected may include, but are not limited to, store departments, buildings, rooms, aisles, stores, and other locations described herein.

In some implementations, the location selection GUI may include location selection GUI elements that specify locations and sub-locations. For example, a location selection GUI element may indicate “Floor 1, Aisles 5-10.” As another example, a location selection GUI element may indicate “Floor 2, Department 2.” Although a single location selection GUI may be rendered, multiple different location selection GUIs may be rendered for specifying locations. For example, sequential location selection GUIs may be rendered that each allow a user to specify a location for picking. In a specific example, a first GUI may include a plurality of floors from which to select. In this specific example, a second GUI may specify one or more aisles that may be selected by the user. In some implementations, a user may select multiple locations to indicate their desire to pick in multiple different locations. In these implementations, the CCS may filter according to the multiple locations.

FIG. 97B illustrates an example MSD GUI 9706 that allow pickers to manually select item types for picking. In FIG. 97B, the MSD generates a GUI 9706 that includes multiple item type selection GUI elements that a user may select (e.g., touch). Specifically, in FIG. 97B, the user may select from frozen items, produce items, dry/canned items, health/hygiene items, and “Any Items.” The “Any Items” button may indicate to the CCS 9708 that the user is open to pick any type of items. The CCS 9708 may take into account the selected item types when assigning items, orders, and/or routes to the user/MSD. For example, the selected item type may act as an item type filter. In one example, the CCS 9708 (e.g., route generation modules 9710) may assign items associated with the selected item type. In this example, the CCS 9708 may also refrain from assigning items that are not associated with the selected item type. An item type selection GUI (e.g., as illustrated in FIG. 97B) may provide pickers in the OFS with item picking flexibility.

In FIG. 97B, the user can select from one of five item type options. The item types in FIG. 97B may be for a store that includes the listed item types along with other possible item types (e.g., accessible by scrolling down in the GUI of FIG. 97B). In FIG. 97B, the user selects the Frozen selection GUI element. In response to the selection, the CCS 9708 may assign items to the user that are associated with the type “frozen.” A selection of “Any Items” may indicate to the CCS 9708 that the CCS 9708 should not be restrained to assigning items based on item type. The item types listed in FIG. 97B are only a set of example item types. As such, additional/alternative item types may be provided for user selection in an MSD GUI. Each item type selection GUI element may include one or more item types. In some implementations, a user may select multiple item type selection GUI elements to indicate their desire to pick multiple types of items.

An MSD may provide one or more selection GUIs (e.g., as illustrated in FIGS. 97A-97B) described herein. For example, in some implementations, an MSD may provide selection GUIS for both location(s) and item type(s). As described herein, the CCS may filter locations and/or item types for users based on the user selections. Additionally, or alternatively, the CCS may implement preferences for assigning the locations and/or item types selected by the user. When making item assignments/routes for users based on manually selected locations and/or item types, the CCS may also take into account any other item assignment/routing considerations described herein (e.g., relative location to a user, priority, etc.). Selection of the location and/or item type by the user may simplify routing considerations/calculations by the CCS.

In some implementations, the selection GUI elements in FIGS. 97A-97B may be dynamic. For example, the selection GUI elements displayed may depend on whether there are items available to pick associated with the selection GUI elements. With respect to FIG. 97A, it may be assumed that the Ground Floor and the Second Floor include items for picking. Note that the store may have additional floors or sections in FIG. 97A, but may not have items for picking in those sections. In one example, if there are no items on the second floor at the current time, the GUI of FIG. 97A may not show the second floor selection option. In the case there is only one option for a selection menu, the CCS/MSD may not provide the selection GUI, and instead automatically assign the user to the section. The item type selection GUI element may also be rendered in a different manner if there are no items of a specific item type for picking. For example, if there are no frozen items for picking, the GUI of FIG. 97B may remove the Frozen selection GUI element.

As described herein, junctions and/or locations (e.g., sections/zones) may include data (e.g., size data, junction values, etc.) that may be used by the CCS/MSDs to determine routes. For example, in some cases, a transition across a junction between two zones/sections may be penalized and/or prohibited in order to separate the sections/zones for different users. In some implementations, the CCS/MSDs may make exceptions to the penalization/prohibition, such as in circumstances when traversing into the section(s) is beneficial. In one example, the CCS/MSDs may make an exception in the case there is only one picker for multiple sections and/or the items are closer to a picker that is typically penalized for entering the section/zone. Using junction values and zone values that indicate the size/desirability of traversal may help maintain picking efficiency by preventing users from unnecessarily traversing zones/junctions that lead to inefficient picking. Additionally, or alternatively, using junction, section, and/or zone filters along with item filters may efficiently distribute picking across a plurality of users. In some implementations, the CCS/MSDs can determine which locations (e.g., sections/zones) are preferred/prohibited automatically. For example, the CCS may automatically assign one or more sections to a user and/or prohibit a user from picking in one or more other sections (e.g., based on items in a section, based on other route assignments, etc.).

Example hard filters for sections, zones, items, and junctions are described herein. For example, the CCS/MSDs may include filters that define sections, zones, and items that may not be assigned to specific MSDs. With respect to junctions, the CCS/MSDs may define junctions as prohibited. In these examples, the CCS/MSDs may refrain from generating routes that traverse the junction from one section/zone to another section/zone. This may prevent/dissuade movement of specific MSDs from one section/zone to another section/zone, such as moving upstairs, to another building, or from one store department to another (e.g., from frozen goods to dry goods).

In addition to hard filters, or as an alternative to hard filters, the locations and/or junctions may have assigned preferences for specific MSDs (e.g., levels of priority for the MSDs). For example, an MSD may be routed through preferred sections/zones/junctions. As another example, an MSD may be routed to pick preferred items. An MSD may be routed through preferred locations or to preferred items until the preferred locations/items have been traversed or picked. Then, the CCS/MSDs may generate routes to other non-preferred items. Preferences may cause MSDs to pick within specific preferred areas until other conditions are met. For example, MSDs may pick preferred locations/items until the preferred locations/items are not associated with any ordered items and/or other locations/items take priority. At that time, the MSDs may be assigned to typically less preferred locations/items.

Rules for movement and item picking may be implemented by the CCS/MSDs. For example, rules may be generated based on any routing factors described herein, such as number of pickers, a location of pickers, the number of items to be picked, the locations of items, the types of items, a priority level of the orders/items, etc. In a specific example, in some implementations, the CCS/MSDs may implement zone/section rules for picking, such as rules that instruct an MSD to: 1) only pick in a specific location when other locations have already been picked, 2) only pick in a specific location when it is required to pick a current order, 3) only pick in a specific zone when it includes items that have been pending picking for greater than a threshold period of time, 4) not pick a section if another MSD is assigned to the section, and/or 5) only pick a section if there are greater than a threshold number of items in the section (e.g., in pending customer orders).

In addition to filters/preferences, or as an alternative to filters/preferences, the CCS/MSDs may implement various values for locations (e.g., zones/sections/junctions) that indicate properties of the locations. For example, the CCS/MSDs may assign zone values to zones that indicate the relative sizes of the zones and/or the actual zone sizes (e.g., in feet or meters). In some implementations, the zone sizes may be automatically determined based on an amount of time spent within the zones and/or an amount of movement (e.g., GPS-based and/or acceleration based) by users while in the zones (e.g., an amount of motion while detecting a location signal for the zone). In some implementations, the zone sizes may be manually entered by users.

The CCS/MSDs may assign junction values that indicate a level of desirability for traversing the junction. The junction values may be used in addition to, or as an alternative to, the location values. In some implementations, the junction values may indicate a distance. For example, junctions between adjacent zones may have a zero value or a small value (e.g., 1) to indicate the zones are close together. In this example, other junctions, such as those that are between buildings or floors, may have larger assigned values. For example, a long junction between two buildings may have a large junction value relative to other junctions in the store. Although zones and junctions may be assigned values that disincentivize traversal, in some implementations, the zones and/or junctions may be assigned values that incentivize traversal. Such values may be used in various optimization/traversal algorithms that generate routes.

In some implementations, the CCS/MSDs may take into account zone values and/or junction values when generating routes. For example, the CCS/MSDs may attempt to generate routes that are less than a threshold size, as indicated by the sum of the location values through which a user traverses. As another example, the CCS/MSDs may attempt to generate routes in which larger junction values are avoided. For example, the CCS/MSDs may attempt to generate routes that minimize the sum of traversed junction values, or eliminate junction values entirely. In this example, larger junction numbers may disincentivize traversal via the junction. In some implementations, the CCS/MSDs may also attempt to generate routes that maximize the number of items picked. In some implementations, the CCS/MSDs may generate routes that attempt to optimize multiple factors, such as total zone size traversed (e.g., sum of zone values), total junction values traversed (e.g., sum of junction values), and total items picked (e.g., the sum of the total items in the route). In some implementations, the CCS may assign initial customer orders and/or routes, and the MSDs may individually optimize the routes based on the user's past/current location or items picked.

The various filtering rules (e.g., location/item filtering), preference rules, optimization rules, and other rules described herein may be implemented by the CCS/MSDs in order to optimize routing for one or more MSDs in a variety of different stores. The various rules may be implemented in a variety of ways. In some implementations, the rules may be implemented as one or more optimization problems. For example, the CCS/MSDs may determine routes using one or more objective functions and one or more constraints (e.g., inequality constraints). In some implementations, the CCS/MSDs may implement weighting functions that are based on a number of items, number of junctions, and/or zone sizes traversed. In these implementations, the functions may incentivize maximal picking and minimal zone/junction traversal. In some implementations, the CCS/MSDs may implement one or more traversal algorithms in which the location maps (e.g., sections/zones/junctions) are traversed according to various rules in order to determine routes (e.g., sufficient/optimal routes). In a specific example, the CCS/MSDs may implement tree/graph traversal algorithms on the location maps to determine routes. In some implementations, the optimization/traversal algorithms may be simplified by the filters associated with MSDs that may limit the total location space and item space assigned to the MSDs. In some implementations, the optimization/traversal algorithms may be simplified by defining a start point (e.g., a current location or preset location) and stopping point (e.g., a packing/collection area) for a route. The routing algorithms may be implemented for one or more MSDs independently, or as a group. For example, the CCS/MSDs may optimize the routes for each MSD alone, or attempt to optimize routing of a plurality of MSDs (e.g., a portion or all MSDs) as a whole.

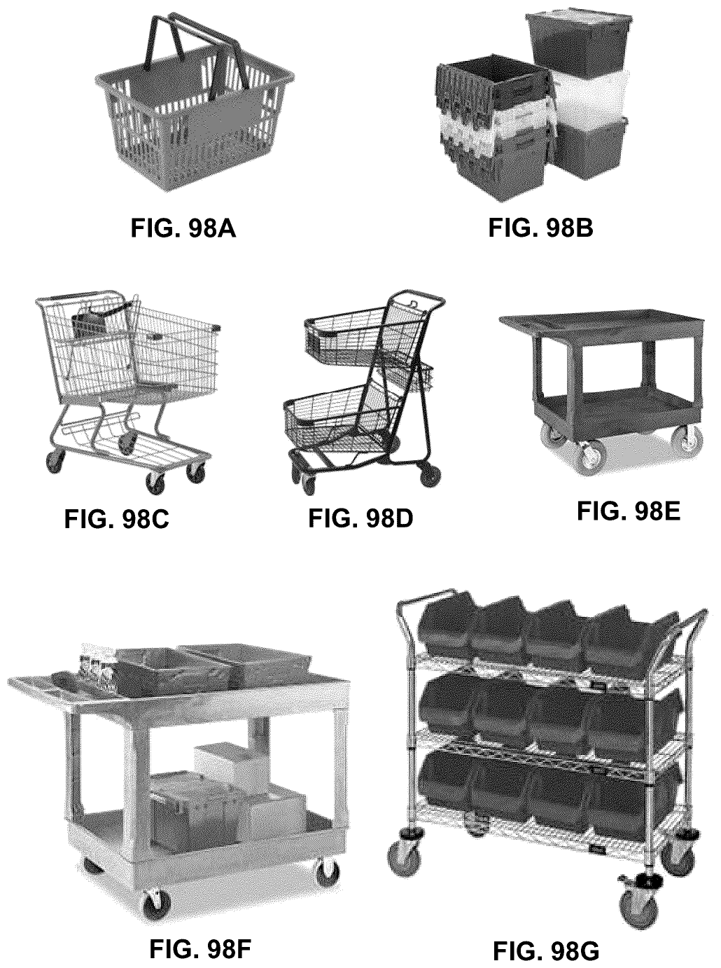

FIGS. 98A-98G illustrate example item carriers and item sub-carriers. FIG. 98A illustrates an example basket (e.g., a hand-held shopping basket). In some implementations, a single basket may be treated as a single carrier. In some implementations, a basket may have one or more dividers that define basket compartments that may be treated as sub-carriers. FIG. 98B illustrates a plurality of plastic totes with opened/closed lids. In FIG. 98B, empty totes are stacked next to closed stacked totes. In some implementations, each tote may be treated as a single carrier. In some implementations, totes may have dividers that define tote compartments that may be treated as sub-carriers.

FIGS. 98C-98G illustrate example carts. FIG. 98C is an example shopping cart. In some implementations, a shopping cart may be treated as a single carrier. In other implementations, different compartments in the shopping cart may be treated as sub-carriers. FIG. 98D illustrates an example shopping cart including three compartments (e.g., upper, lower, and rear baskets), which may be treated as multiple sub-carriers or as a single carrier. FIGS. 98E-98F illustrate example pushcarts with multiple shelves. The multiple shelves may be treated as multiple sub-carriers or as a single carrier. In FIG. 98F, the pushcart includes multiple totes and boxes and other objects. In FIG. 98F, the multiple totes and boxes may be considered as sub-carriers. Alternatively, the pushcart of FIG. 98F may be treated as a single carrier. FIG. 98G illustrates another example cart (e.g., a wheeled rack) that includes multiple shelves, each of which includes multiple bins. In some implementations, the cart may be identified as a single carrier. In other implementations, the shelves and/or bins in FIG. 98G may be identified as separate sub-carriers. In some implementations, bins may be removable from a cart, as illustrated in FIG. 98G. In some implementations, bins may be built-in to the cart. In some implementations, carts may include dividers (e.g., fixed and/or adjustable dividers).

Users (e.g., employees) can have a variety of roles in the OFS. For example, users may pick items, pack items, and/or have different roles. Users (e.g., pickers) may pick items from the racks and move items throughout the store to a packing area or other area. The users can move the items throughout the store in a variety of ways. In some cases, the users can carry the items by hand. For example, if the user picks a few items, the user can carry the items by hand to a packing area, other location (e.g., a cart, aisle, or other location), or to another user, such as another user (e.g., picker, packer, customer, or other user) that requested the items be brought to them (e.g., via a computing device, such as an MSD or smartphone).

In some cases, a user can pick items and place them onto (or inside of) one or more item carriers/sub-carriers. For example, a user can pick items and place the items onto a cart. If the cart has different sub-carriers (e.g., plastic totes and/or compartments), the user can pick items and place them into the different sub-carriers (e.g., plastic totes). The user may transport the items throughout the store in the one or more carriers/sub-carriers. For example, the user may transport the items in the one or more carriers/sub-carriers to a packing area, other location, or to another user, such as another picker, customer, or other person that may have requested the items be brought to them.

Users (e.g., packers) may perform packing roles in the OFS. Packing may refer to preparing items for pickup by a customer, delivery driver, or other party. Packing may include organizing picked items and placing the picked items into totes, bags, boxes, or other carriers for customers, delivery drivers, or other parties. In one example, pickers may pick items that are then packed by packers for customer pickup or delivery.

A store may include a packing area in which users may collect, sort, and pack items. A packing area may include a drop-off area for picked items (“item drop-off area”), a sorting area where items from multiple orders are sorted into a single order, and/or other defined areas. A packing area may include computing devices and other hardware that are used for packing items. For example, the packing area may include any of the racks described herein, tables, conveyors, displays, item scanners, MSDs, payment systems, checkout systems, and other devices. The packing areas described herein are only example packing areas. As such, other packing areas may include different defined areas, features, and devices (e.g., displays, MSDs, item scanners, etc.) than described herein.

Picking and packing may occur in a variety of different manners. Picking and packing may also incorporate one or more users. In one example, a single user may pack a customer order that was picked by a single picker. In another example, a single user may pack a customer order that was picked by multiple pickers. In another example, multiple packers may pack a customer order that was picked by one or more pickers. In another example, a single user acting as a picker/packer may pack one or more orders they completely picked for themselves or partially picked for themselves. In another example, items may be picked and/or packed using automation devices (e.g., robotic devices), such as automated picking devices, sorting devices, and/or packing devices. In stores using automation devices, human pickers and/or packers may pick and/or pack along with the automation devices. For example, some items may be automatically picked for a customer order by an automation device (e.g., a robot, dispenser, etc.). In this example, one or more human pickers may pick the remaining items and pack the complete order.

Picking and packing roles may be performed by different users in some cases. For example, a first set of users (e.g., employees) and a second set of users (e.g., employees) may be assigned as pickers and packers, respectively. In some cases, a single user may perform both picking and packing roles. The users may change their roles, depending on the amount of picking/packing resources required.

A single user may perform both picking and packing roles. In some cases, a user may pick a customer order and then pack the customer order. For example, a user may pick items from a customer order and then pack the customer order in the packing area. In some cases, picking and packing may be done at the same time. For example, a user may bag items while picking the items. The user (or another user) may then present the bagged items, as picked, to a customer. In this scenario, a separate collection/packing step may not be required.

In some examples, multiple pickers may pick the same customer order. In these examples, one of the multiple pickers may collect items from the customer order after the other pickers have finished picking their portion of the customer order. For example, one picker may pick a majority of the customer order while another picker picks a smaller portion of the customer order. The picker that picks the smaller portion may put the items somewhere in the store for the other picker. For example, the picker that picks the smaller portion may place the items in a packing/collection area, another area (e.g., an aisle or other location), or transfer the picked items (e.g., cart) to the other picker. The picker that picked the majority of the customer order may then have a complete order to present to the customer or delivery driver.

In some implementations, the MSDs may be used for packing in a manner similar to picking. For example, an MSD may present a customer order to a packer for the packer to collect and scan the items in the packing area (e.g., in a similar manner as items are presented to a picker, such as based on location and/or other data). The packer may then put the customer order together for pickup or delivery. In some implementations described herein, the MSD may present items to the packer based on the location of the items in the packing area. In some implementations, an MSD may have different picking and packing modes that suit the different roles. In some implementations, the store may have dedicated picking/packing MSDs. In some implementations (e.g., a smartphone MSD), the MSD may have different applications and/or web interfaces for picking/packing roles. In a case where a single user picks and packs while others are picking part of the order, the same interface for picking may be used for collecting items originally picked by others. For example, items picked by others may be grouped together in the GUI separately from the items being picked by the main picker.

Users may perform other roles associated with the OFS. For example, users may be delivery drivers that deliver customer orders to customers (e.g., a customer home or business). The delivery drivers may also pick and/or pack customer orders. Other example roles in the OFS may include managers/supervisors, employees, third-parties, and others described herein.

Although a store employee may pack orders that were picked by store pickers, in some implementations, a third-party packer/driver may pack orders that were picked by store employee pickers. Such an arrangement may allow store employee pickers to focus on picking and allow third-party packers/drivers to focus on providing the orders to customers (e.g., via delivery).

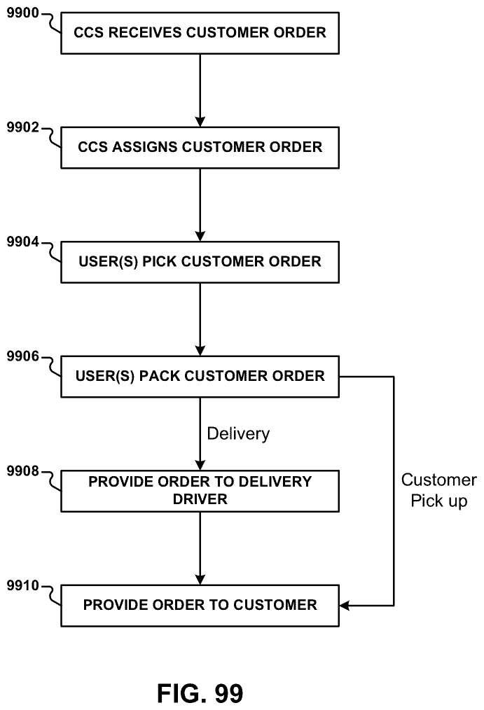

FIG. 99 illustrates an example method that describes customer order assignment, customer order picking, and customer order packing. In block 9900, the CCS receives a customer order. In block 9902, the CCS assigns the customer order to one or more pickers. The CCS may assign customer orders based on any factors described herein, or based on other factors. In some implementations, the CCS may add items, withdraw assigned items, or reassign items from pickers while the customer order is being picked. In block 9904, the picker(s) pick the customer order. As described herein, the CCS/MSDs may track the picker(s)′ locations, the items picked, the statuses of the picker(s), the carriers used for picking, and other picking/packing related data. In block 9906, the user(s) (e.g., pickers/packers) pack the picked customer order. In some implementations, as described herein, the locations of the items in the packing area may be tracked for efficient packing. If the customer order is for delivery, in block 9908, the packed customer order may be presented to a delivery driver that provides the customer order to the customer in block 9910 (e.g., at a user's home or other location). If the customer order is for customer pickup, the packed customer order may be provided to the customer at the store.

The CCS, TPCS, or other system, may track picked items, MSDs, carriers/sub-carriers, and users. In some implementations, the CCS/TPCS may track associations between any combination of picked items, customer orders, MSDs, carriers/sub-carriers, and/or users. Associations between items, customer orders, MSDs, carriers/sub-carriers, and/or users may refer to relationships between the objects/parties, such as which party has control of which items, orders (or partial orders), MSDs, and/or carriers/sub-carriers. In general, the associations between the items, orders (or partial orders), MSDs, carriers/sub-carriers, and/or users are indicated herein by hyphenation. For example, an association between a user and an item may be referred to as a “user-item” association or an “item-user” association. As another example, an association between a carrier and an item included in the carrier may be referred to as an “item-carrier” association or a “carrier-item” association.

In some examples, an association between a picked item and a user may indicate that the items were picked by the user and may be currently under control of the user. As another example, an association between an MSD and a user may indicate that the user is using the MSD to scan picked items. As another example, an association between a user and a carrier/sub-carrier may indicate that the user has control of the carrier/sub-carrier and is using, or has used, the carrier/sub-carrier to hold picked items for movement throughout the store.

As another example, an MSD-item association may indicate an MSD that scanned the item. This association may indicate that a user has the MSD and is in control of the scanned item. As another example, an MSD-carrier association may indicate that a user is using an MSD to scan items and place the items into the associated carrier/sub-carrier. As another example, a carrier/sub-carrier association may indicate one or more sub-carriers that are associated with the carrier. An example carrier/sub-carrier association may include a cart that is associated with one or more totes being transported on the cart. In a specific example, during the course of picking items using an MSD, multiple MSD-item associations may be made between the picked items and the MSD used for scanning the picked items.

Associations between picked items and users/carriers may indicate which users have picked the items and which carriers may include the items.

Maintaining association data between picked items, carriers, MSDs, and/or users may provide the CCS with awareness as to the user/carrier that has current control of the picked items. For example, the CCS may use association data to determine, in real-time, the user that has control over the items and/or the carrier/sub-carrier that includes the items. The associations may be stored and updated at the CCS/MSDs. Association data may include the various IDs used to identify the items, MSDs, carriers/sub-carriers, and/or users. Although multiple associations are described herein, the OFS may be implemented using fewer associations, or without association data.

In some implementations, the CCS, TPCS, or other system, may track the locations of picked items, MSDs, carriers/sub-carriers, and/or users. For example, the MSDs may report location data to the CCS as described herein. In some cases, picked items may be associated with a user/MSD. In these cases, the picked items associated with the user/MSD may be assigned the location of the user/MSD. Put another way, it may be assumed that the picked items are in the location of the user/MSD. Similarly, carriers/sub-carriers associated with a user/MSD may also be assigned a current location of the user/MSD. In some implementations, a user may drop off picked items (e.g., items in one or more carriers) at different locations in the store (e.g., a packing area or other area). In these implementations, the picked items may be associated with a new location, such as a location of the carrier/sub-carrier in the packing area or elsewhere. In some implementations, the store may be instrumented (e.g., using cameras, RFID readers, or other technology) to determine the location of picked items, MSDs, carriers/sub-carriers, and/or users. Additional location determination technology is also described herein. Maintaining location data for users, MSDs, picked items, and carriers/sub-carriers may provide the CCS with awareness (e.g., real-time awareness) of picked item locations and other locations that can be used to improve picking efficiency. The tracked associations/locations data related to picked items, packed items, and/or users may be used for triggering route generation, generating routes, and/or assigning routes.

The OFS may track associations between picked items, users, MSDs, and carriers in a variety of ways. In some implementations, users may have user IDs that identify the users. User IDs may include user names (e.g., first and last name), user login names (e.g., entered into a computing device), printed user IDs (e.g., barcodes), and/or electronically readable user IDs (e.g., RFIDs and magnetic strips). In some implementations, a camera (e.g., on an MSD, carrier, or mounted in the store) may identify a user based on their appearance (e.g., facial recognition) and/or an attached form of identification (e.g., an ID card, barcode, etc.).

The user IDs may be acquired by the CCS in a variety of ways. In the case of a user's name and/or user login, the user may enter it into a computing device, such as an MSD or other device (e.g., smartphone or terminal). In the case of a printed user ID (e.g., a barcode or number), the MSD, or other scanning device (e.g., a camera) can scan the user's printed ID. In the case of an electronically readable user ID, the MSD or other computing device may read the electronically readable user ID. For example, the MSD or other computing device may read an RFID, magnetic strip, or other electronically readable ID. In implementations where the store includes cameras for tracking users (e.g., on racks, the ceiling, or other locations), the CCS may identify users based on their appearance and/or based on an image on the user's printed ID.

MSDs may have associated MSD IDs. In some implementations, an MSD may have a hardware ID and/or software ID. In some implementations, an MSD may have an attached ID, such as a barcode, number, RFID, or other object. The user may scan the attached ID (e.g., before placement on the MSD) and/or the MSD may read the MSD ID (e.g., read an RFID tag). In some implementations, a user may enter the MSD ID into the MSD. In some implementations, the MSD ID may be a set value. In other implementations, a user (e.g., picker/packer/manager) may set the MSD ID (e.g., via manual entry). An MSD may transmit the MSD ID to the CCS or other computing system for tracking. In some cases, a user may enter/scan a user ID using the MSD or other computing device. In these examples, the MSD or other computing device may transmit the user ID to the CCS or other computing system, which may identify the user and associated MSD using the entered user ID. In a specific example, a user may enter a user name or scan a user badge that is used to track the user and associated MSD.

In some implementations, carriers may be associated with carrier IDs. For example, a carrier may have a printed ID or stamped ID (e.g., printed or stamped onto or into the carrier material). As another example, a carrier may include an electronic ID (e.g., a magnetic strip, RFID, or other type of ID) that is attached to the carrier (e.g., removably or permanently attached) or placed into the carrier (e.g., placed into the carrier by a picker). Example carrier IDs may include RFIDs (e.g., embedded or removable), magnetic strips, barcodes, or other readable codes. In some implementations, the codes may be included on a permanent/removable sticker, such as a sticker with customer information. Sub-carriers may include similar IDs as carriers. In a specific example, a carrier ID for a cart may include a barcode, RFID tag, or other wirelessly readable ID that may be fixed to the cart or removable (e.g., clamped on, thrown in, or magnetized to the cart). In another specific example, a carrier ID for a tote may include a barcode, RFID tag, or other wirelessly readable ID that may be fixed to the tote or removable (e.g., clamped on or thrown into the tote). In some implementations, IDs may be set (e.g., permanent for the carrier). In other implementations, removable IDs (e.g., removable barcodes or RFID tags) may be moved to different carriers (e.g., thrown in different carts for the duration of picking). In some implementations, a carrier ID may be associated with a customer. For example, the carrier ID may be a removable sticker with customer/order information (e.g., customer name, pickup date/time, and additional information). As another example, the carrier ID(s) may be associated with the customer that placed the order for items in the carriers. The associations between the customers/orders and the carriers may be stored at the CCS.

The carrier IDs may be automatically read (e.g., by an MSD), manually scanned (e.g., by an MSD), or entered manually by a user. For example, if the carrier ID is an RFID, the carrier ID may be automatically read (e.g., passively) by an RFID reader (e.g., in the MSD or in another store location). In some cases, a user may manually scan an RFID included with a carrier. A printed ID may include a barcode or alphanumeric code that is scannable by a barcode reader (e.g., on an MSD) or similar image-based reader (e.g., in the MSD or other store location). In some cases, the carrier ID may be manually input into an MSD interface or other computing device. In some implementations, the store may be instrumented to automatically acquire carrier IDs. For example, the store may include RFID readers and/or barcode readers on racks (e.g., in the packing/collection area) that can read RFIDs and/or barcodes on the carriers. As another example, the store may be instrumented with cameras (e.g., on racks, in the packing area, or other area) that can acquire images of carriers and/or carrier IDs and recognize carriers in the store (e.g., being carried or resting on a rack) based on the acquired images (e.g., based on codes, colors, object recognition, or other technique).

In some implementations, the CCS may assign items based on the type and/or number of carrier(s) used by a picker/packer. For example, the CCS may limit the number of assigned items, weight of assigned items, and/or volume of assigned items based on the carrier type. In a specific example, if the picker is using a small carrier (e.g., a basket), the CCS may limit the number/volume of items to those that may fit into the small carrier. As another specific example, if a user is carrying items by hand, the CCS may limit the number to a few items (e.g., 3 items) that may be carried by hand. As another specific example, if a picker is using a larger carrier (e.g., a cart), the CCS may assign a greater number, size, and/or weight of items to the picker. In some implementations, different carriers may have different item limits, such as item number limits, item volume limits (e.g., single item volume and/or aggregate volume), item dimension limits (e.g., max length, width, and/or height), item weight limits, or other limits. In some implementations, different carriers may be specified to hold different types of items, such as cold items, hot items, fresh food (e.g., fruits, vegetables, meats, etc.), outdoor items (e.g., blocks, bricks, soil, etc.), or other types of items.

Example associations with users may include, but are not limited to: 1) user-MSD associations, 2) user-item associations, and 3) user-carrier associations. A user-MSD association (or MSD-user association) may refer to data that indicates an MSD being used by a specific user. For example, a user-MSD association may indicate a pairing between a user ID and an MSD ID, such as a pairing between a user login name/number and an MSD name/number. A user-MSD association may be generated if a user logs in to an MSD (e.g., by manually entering a user name/ID). A user-MSD association may also be generated by a user scanning their user ID badge (e.g., a barcode, RFID, or magnetic strip) using the MSD.

A user-item association may indicate an association between a user ID and a picked item ID. For example, the user-item association may indicate that the user has picked the item and may be transporting the item throughout the store (e.g., toward a packing area). A user-item association may be generated in a variety of ways. In some implementations, a user may be assigned to pick an item via a picking command, such as a command over an intercom system, a user computing device (e.g., a smartphone, pager, or other device), and/or an MSD interface. In some cases, a user may be assigned to pick an item even though the user does not have an MSD to scan the item. In these cases, assignment of the item (e.g., via an intercom command or other device) may form the association at the CCS/TPCS between the user and the item under the assumption that the user is picking the item. Such a command and assignment may be efficient in the case one item, or a few items, need to be picked near a user, and the user has availability to bring the few items by hand to the packing area. In a specific example, such a command may be made in the case the CCS determines the user is near the item(s) (e.g., within a threshold distance). In some implementations, a user-item association may be generated when the user scans the item using an MSD that is associated with the user. For example, if a user-MSD association is generated prior to scanning an item, the scanned item may be associated with the user via the MSD used to scan the item. User-item associations may be generated for each item picked by the user.

A user-carrier association may indicate an association between a user ID and a carrier ID. A user-carrier association may indicate that the user is using, or has used, the carrier to transport picked items through the store. For example, a user-carrier association may indicate the user is in control of the associated carrier (e.g., a user is in control of a cart). A user-carrier association may be made in a variety of ways. In some implementations, a user may manually scan a carrier using an MSD. For example, a user may scan a carrier ID (e.g., barcode, RFID, or other ID) on the carrier (e.g., removably/permanently attached to the carrier). In some implementations, an MSD may be configured to automatically read one or more carrier IDs in proximity to the carrier. For example, and MSD may automatically scan an RFID or other code attached to the carrier when a user brings the MSD in proximity to the carrier and/or places the MSD in the carrier (e.g., places a handheld MSD near/in a cart). The user may be associated with one or more carriers via the manual/automatic scanning by the MSD. A user may be associated with one or more carriers at a time. For example, a user may be associated with multiple carriers (e.g., carts) and/or a single carrier with multiple sub-carriers (e.g., a cart with multiple totes).

In some implementations, a carrier may include some/all of the MSD functionality described herein. For example, the MSD functionality may be built into the carrier. In a specific example, a shopping cart may include electronic devices for scanning items, determining location, and/or displaying items to a user for picking. In these implementations, a carrier may provide a user login functionality in which the user can provide their user ID to the carrier, such as by manually entering the user ID or scanning the user ID using the carrier functionality (e.g., a barcode or RFID scanner).

In some implementations, a user may acquire a plurality of carriers prior to picking one or more customer orders. The user may then attach (e.g., clamp, stick, etc.) carrier IDs to the carriers/sub-carriers or place carrier IDs on/in the carriers/sub-carriers. For example, a user may attach barcodes, RFIDs, and/or other IDs to the carriers, such as barcodes that indicate the customer order being picked (e.g., a customer name, order number, etc.). In some cases, the user may have the carrier IDs (e.g., barcodes and other information) printed out for the customer order prior to picking and attachment to the cart. In these implementations, the user-carrier association may be generated when the user generates the carrier ID(s) and/or attaches the carrier ID(s) to the carrier(s).

Example additional associations may include MSD-item associations and MSD-carrier associations. An MSD-item association may indicate the MSD that scanned the picked item. An MSD-item association may be generated using any item scanning technology described herein, such as scanning a barcode, scanning an RFID, and/or manually entering an item ID into an MSD. During picking, the MSD may generate a plurality of MSD-item associations (e.g., a single MSD-item association per picked item).

MSD-carrier associations may be generated in a variety of ways. An MSD-carrier association may indicate an MSD and one or more carriers that the user is using to pick one or more customer orders. As described herein, an MSD-carrier association may be generated when a user uses an MSD to scan a carrier manually. As another example, an MSD may scan one or more carriers automatically. In some implementations, a carrier may include MSD functionality (e.g., a “smart shopping cart”), such that the MSD ID and carrier ID are implicitly associated with one another. In some implementations, a carrier with MSD functionality may also automatically determine other sub-carriers associated with the carrier (e.g., via readable codes, RFIDs, or other technology). For example, a carrier may automatically detect other sub-carriers. In a specific example, a smart shopping cart (e.g., a pushcart) may detect sub-carrier IDs of totes included on/within the smart shopping cart.

Another example association is a carrier-carrier association. A carrier-carrier association may indicate one or more carriers being used for a customer order. A carrier-carrier association may be between two separate carriers or a carrier with multiple sub-carriers. Carrier-carrier associations may be generated as described herein, such as by scanning multiple carriers, manual input of the carriers by a user, or automatic detection. In some implementations, carrier/sub-carrier associations may be preset, such as when a carrier includes preset sub-carriers. For example, a cart may include preset sub-carrier divisions or sub-carrier totes. In some implementations, the sub-carrier IDs may indicate that they are sub-carriers on another carrier. For example, the subcarriers may have carrier IDs followed by a sub-carrier specific ID. As described herein, some carriers (e.g., including MSD functionality) may automatically scan for other carriers (e.g., carrier RFIDs).

In some implementations, all carriers/sub-carriers do not need to be associated with a main carrier. For example, picking may be performed under the assumption that sub-carriers are related on a main carrier. In these implementations, a first sub-carrier may be associated with a subset of items from a customer order, but not associated with a main carrier or any other sub-carriers. In this example, any items included on the main carrier having the first-sub carrier may be assumed to include other items from the customer order, such as items that complete the customer order. In a specific example, a user may scan a single sub-carrier on a cart that includes a plurality of sub-carriers. The items on the cart may then be assumed to be associated with the same customer order associated with the single sub-carrier (e.g., assuming that the picker/packer is picking/packing one order).

Another example association is a carrier-item association. A carrier-item association may indicate that the carrier includes the associated item. Carrier-item associations may be generated in a variety of ways described herein. In some implementations, carrier-item associations may be generated via MSD scans of the carrier and the items. In some implementations, a carrier may include computing devices that automatically scan items transported by the carrier. For example, a carrier may include a scanner, camera, RFID reader, or other device that can automatically detect items included in/with the carrier. For example, a smart shopping cart may include a camera that acquires images of items placed into the cart. As another example, a smart shopping cart may include an RFID reader that reads RFIDs on items placed into the cart. Carriers that automatically scan items may also report the contents of the carrier (e.g., to the CCS/MSDs). For example, the carriers may report the contents of the carriers in response to interrogation by the CCS/MSDs.

In some implementations, the OFS may track associations between customer orders and other users/objects in a manner similar to associations between items and users/objects. For example, a user picking/packing items for a customer order may be associated with the customer order. The OFS may store data indicating the association between the customer order and the user (e.g., a user-order association). As another example, a carrier including items from one or more customer orders may be associated with the one or more customer orders. The OFS may store data indicating the association between the carrier and the one or more customer orders (e.g., via one or more carrier-order associations).

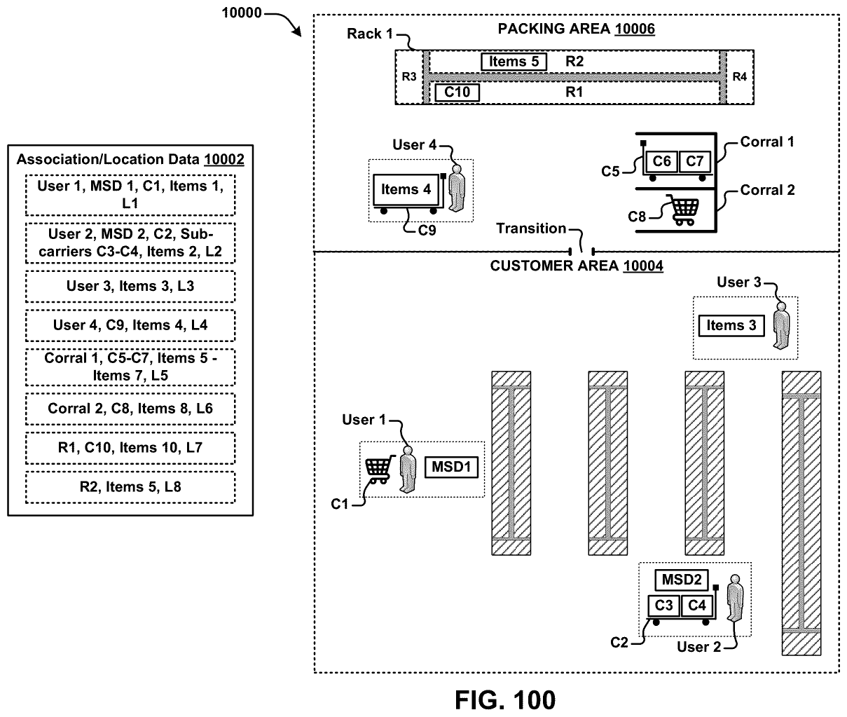

FIG. 100 illustrates an example store 10000 and association/location data 10002. The store 10000 includes a customer area 10004 and a packing area 10006. The customer area 10004 may be an area in which the customers typically shop. The packing area 10006 may be an area in which customers are not typically allowed. In FIG. 100, the packing area 10006 includes racks and corrals that may be used for holding carriers (e.g., carts, totes, etc.) and/or picked items for packing. The association/location data structure 10002 in FIG. 100 includes associations and locations between users, MSDs, carriers, and items. Different types of associations and locations are illustrated in FIG. 100.

A first set of associations includes associations between User 1, MSD 1, and carrier C1 (a shopping cart) including items 1. User 1, MSD 1, C1, and Items 1 (e.g., a first group of one or more items) are currently located at location L1. A second set of associations include associations between User 2, MSD 2, carrier C2 (a pushcart) with (sub) carriers C3-C4 (e.g., totes on the pushcart) including Items 2, which may be associated with carrier C2 and/or individual subcarriers C3-C4. User 2, MSD 2, C2-C4, and Items 2 are currently located at location L2. A third set of associations includes associations between User 3 and Items 3. For example, User 3 may be manually carrying Items 3. User 3 and Items 3 are located at location L3. A fourth set of associations includes associations between User 4, carrier C9 (e.g., a pushcart), and Items 4. User 4, C9, and Items 4 are located at location L4.

Additional associations between corrals, racks, carriers, and items are illustrated in the packing area 10006. For example, Corral 1 is associated with carriers C5 (a pushcart) and C6-C7 (e.g., totes on the pushcart). The location of Corral 1 may be referred to as location L5, although the corral may also be referred to as Corral 1 (e.g., in a more human readable form). In implementations where there are a limited number of corrals, a corral number may be used as an additional/alternative location (e.g., in cases where the corral may include other location indicators). Note that carriers C5-C7 may include items (Items 5-7) that may also be associated with the carriers C5-C7, Corral 1, and location L5. Corral 2 includes carrier C8 (a shopping cart) that may include Items 8. Corral 2 may be referred to as location L6, although the corral may also be referred to as Corral 2 (e.g., in a more human readable form). Note that carrier C8 may include items that may be associated with C8 and Corral 2. In some implementations, the carriers C5 and C8 included in Corrals 1-2 may have been placed there by pickers that used the carriers and/or subcarriers C5-C8 to store items while picking. For example, a picker may have used C8 to hold Items 8 while picking, and then pushed the cart including Items 8 into Corral 2 for later access by a packer.

The packing area 10006 may include a plurality of racks. An example Rack 1 is illustrated in FIG. 100. Rack 1 includes a plurality of different locations that may be defined by location indicators, other location technology, or manually labeled according to another location definition scheme. In FIG. 100, Rack 1 includes rack locations R1-R4. In FIG. 100, there is an association between carrier C10 and rack location R1. Note that C10 may also include Items 10. The association between carrier C10 and rack R1 may occur in the case that a user drops off a carrier including items on a rack in the packing area 10006. For example, a picker may store Items 10 in carrier C10 (e.g., a handheld basket) while picking, and then subsequently drop off the carrier C10 on rack location R1. The rack location R1 may be at location L7. In some implementations, the rack location R1 may be a human readable location used in the OFS (e.g., human readable rack number and shelf location). Additionally, or alternatively, the location on the rack L7 may be defined by location indicators or other location technology. In FIG. 100, there is an association between rack location R2 and Items 5. This may occur in the case where individual items are dropped off by a picker on a rack in the packing area 10006. Note that, in some cases, carriers may be partially emptied when items are dropped off after picking. In other cases, the whole carrier may be dropped off or emptied of all items.

The CCS/TPCS/MSDs may track the location of the users, MSDs, carriers, and picked items in a variety of ways. The CCS may determine the location of MSDs using any location technique described herein. In some implementations, an MSD may detect its location and transmit the location to the CCS/MSDs. For example, as described herein, the MSDs may report their location to the CCS/TPCS/MSDs (e.g., in terms of zones or other location descriptions). In some cases, it may be assumed that the location of the users, carriers, and picked items associated with the MSDs are in the same location as the MSDs. Additionally, as described herein, the CCS can determine the location of MSDs, users, carriers, and/or picked items based on the location of the last item(s) scanned.

As described herein, the store may also be instrumented with devices that determine the location of users, MSDs, carriers, and/or picked items (e.g., without communication from MSDs). For example, in some implementations, the store may be instrumented with cameras that identify the location of users, carriers, and/or items that are inside/outside of the store. In these implementations, the CCS may identify users (e.g., store employees) based on store uniforms, facial recognition, or other image processing techniques. In one specific example, the store may include one or more cameras in a packing area (e.g., racks, corrals, shelves) that acquire images used to identify the location of picked items placed on/in shelves/corrals in the packing area. For example, images from a camera may be used to determine the items that are placed on a shelf in the packing area. In another specific example, aisles may include cameras that detect user location.

In some implementations, the store may have devices (e.g., sensors) for determining locations of RFID tags, printed tags, light emitters, acoustic devices, or other objects carried by, or attached to, MSDs, users, carriers, and/or picked items. In some implementations, the CCS may pick up the location of the MSDs and/or devices (e.g., RFID, BLUETOOTH, or other emitting devices) on the users/carriers/items, such as by using sensors (e.g., antenna-based, light-based, and/or sound-based sensors) in the store that pick up signals emitted by the MSDs and/or devices. In a specific example, the store may include instrumented racks, instrumented cart corrals, or other instrumented objects in the packing area that detect carriers (e.g., a tote or cart) and/or items. In this specific example, the packing area (e.g., racks or cart corrals) may include RFID readers, barcode readers, or other types of readers that may read corresponding carrier IDs (e.g., cart ID, tote ID, basket ID, etc.).

In some implementations, the MSDs, users, carriers, and/or picked items may be equipped with electronic hardware that transmits their locations to the CCS/MSDs. For example, an MSD, a user, a carrier, and/or picked items may include GPS receivers or other location detection electronics that determine their location and transmit their location to the CCS/MSDs. In one example, a user may have an MSD or other computing device (e.g., a smartphone or other device) that transmits a current location to the CCS. In another example, a cart may include an MSD (e.g., attached or embedded MSD) or other electronic device that transmits a location to the CCS (e.g., in terms of location values or other location type).

In some implementations, users may manually report associations and/or locations of themselves, MSDs, carriers, and/or picked items. For example, the user may manually input locations/associations into the MSDs or other computing devices. In some implementations, the CCS/MSDs may prompt the user to select/confirm associations/locations (e.g., in a GUI). For example, an MSD may ask for a user ID and carrier ID. In another example, the user may manually indicate (e.g., in the MSD or other computing device) that the user had dropped off picked items in the packing area (e.g., a rack, shelf, or corral) or another area.

A user may scan items using an MSD while picking. Additionally, the user may place the items into one or more carriers while picking. The CCS, TPCS, and/or other MSDs may track the location of users, carriers, and picked items during picking, as described herein.

A user may drop off items and/or carriers including items during or after picking. A user may also pick up items and/or carriers including items during picking. For example, a user may pick up items/carriers that other users have dropped off. In general, a user may drop off or pick up items/carriers at any location in the store. For example, a user may drop off items/carriers in a designated packing area, another preset drop off area (e.g., inside/outside the store), or any other area in the store.

In one example, a user may drop off items in a packing area for packing by one or more packers. The packed orders may be picked up by the customer or provided to a delivery driver or automated delivery vehicle. A user may give up associations (e.g., ownership) of the items/carriers when dropping off the items/carriers. For example, association data may be deleted or amended to indicate that a user has given up the items/carriers (e.g., placed the items/carriers in a location or handed them over to another user). In some implementations, a new association between packers and items/carriers may be generated for packing.

In some implementations, picked items may be generally dropped off in the packing area (e.g., without regard to location). For example, a store may include a general drop off area in the packing area in which the pickers place the items/carriers. In these implementations, the OFS may determine which items are dropped off in the packing area and when the items were dropped off. In some implementations, a packing area may include a drop off area that is associated with specific locations, such as specific areas that may include racks/corrals for items/carriers.

Data associated with items in the packing area may include, but is not limited to: 1) which items are placed in the packing area, 2) when the items were placed in the packing area, 3) when the items are ready for packing (e.g., when a complete order is in the packing area), and 4) where the items are located in the packing area (e.g., specific racks, corrals, etc.).

The packing area may include racks or other objects that may hold/organize carriers and/or picked items that are dropped off in the packing area. The items dropped off in the packing area may be referred to as “packing area items.” The packing area may be configured with racks/objects that hold/organize any type of carrier used in the store. In some implementations, the packing area may include one or more cart corrals used to hold/organize carts (e.g., shopping carts, push carts, etc.). Cart corrals may receive one or more carts used to hold picked items. An example cart corral may hold one or more carts. The packing area may also use one or more tote racks/organizers for holding totes, such as specific totes used by the store for holding picked items.

The racks/objects used to hold and organize carriers and items in the packing area may be in a fixed location or mobile. For example, some shelves and cart corrals may be in a fixed location. As another example, some racks/objects, such as wheeled racks or carts, may be moved to different locations in the packing area. The location of the movable racks/objects and associated items may be tracked by the CCS.

In some implementations, the packing area may include automated sorting, picking, and/or packing devices that automatically sort, pick, and/or pack items in the packing area, such as items stocked in the packing area or picked and placed in the packing area. For example, the packing area may include conveyor belts (e.g., automated conveyor belts), sorting devices, item dispensers, and/or robotic devices (e.g., automated pallet movers and/or automated carts) that sort, pick, and/or pack items. The OFS may maintain tracking data (e.g., associations and locations) for the automatically sorted items, picked items, and packed items.

The CCS/TPCS/MSDs may determine when and where items are dropped off in the packing area. In some implementations, detection of item drop off and determination of item location may be separate operations. In other implementations, detection of item drop off and determination of item location may be performed in the same operation. For example, a user may manually indicate that they are dropping off picked items in a specific location. In another example, a device (e.g., an RFID reader) may detect that an item/carrier (e.g., an RFID) has been placed in the packing area.

Users may drop off carriers and/or individual items in the packing area. In some cases, users may drop off carriers/items for packers to pack. In some cases, users may drop off carriers/items for another picker to add to their order. Item/carrier drop off may include, but is not limited to, 1) leaving one or more carriers in the packing area, such as a whole cart with one or more sub-carriers in a corral or other location, 2) dropping off one or more sub carriers, and/or 3) pulling out items from a carrier and dropping them off on racks, conveyor belts, etc. The OFS may determine 1) which carriers/items have been dropped off, 2) when the items were dropped off, and/or 3) where the items were dropped off in the packing area. For example, the MSDs and/or devices in the packing area can detect the presence and/or location of the carriers/sub-carriers and/or items. The OFS may make these determinations automatically and/or based on manual user input.

In some implementations, the users may manually indicate that they have dropped off items in the packing area. For example, the users may interact with an MSD GUI that allows the user to indicate that they are dropping off picked items (e.g., some/all picked items). In a specific example, the MSD may provide a GUI in which the user can select items/orders (e.g., GUI buttons) that they are dropping off. In some implementations, a user may manually bring up the MSD GUI interface. In other implementations, the MSD or other devices in the packing area (e.g., RFID readers, cameras, etc.) may determine that the user has entered the packing area with picked items. In these implementations, the MSD may prompt the user with a GUI that allows the user to select items to be dropped off.

In some implementations, a user may indicate the location of the carriers/items they are dropping off. For example, the user may indicate, in the MSD GUI, a rack and/or specific location on a rack (e.g., shelf, bin, etc.) that includes the dropped off items. As another example, the user may indicate, in the MSD GUI, a corral number in which a cart is placed. In some implementations, a user may use the MSD to scan a specific location in which items are placed (e.g., a specific rack location, bin number, corral number, etc.) in order to indicate to the CCS where the dropped off items are located. In some implementations, the MSD may pick up location signals and/or read location indicators to automatically indicate where the items are dropped off (e.g., in the case racks/corrals or other objects include location indicators).

In some implementations, the packing area may include computing devices (e.g., terminals) that provide users (e.g., pickers/packers) with various functionality related to picking/packing. For example, the computing devices (e.g., a terminal) may allow a picker to indicate that they are dropping items off in the packing area. The other computing devices' GUIs may operate in a similar manner as the MSDs described herein. For example, the other computing devices may provide GUI input/output and/or manual input that allows the user to indicate they are dropping items off in the packing area.

The packing area may be instrumented with devices that detect the drop off and location of carriers and/or items. For example, the packing area may include cameras that identify carriers and/or items, such as carrier/item IDs or other features of the carriers/items (e.g., using object recognition). The cameras may monitor carrier, item, and user entry into the packing area (e.g., after picking). The cameras may also monitor specific locations in the packing area, such as specific racks, corrals, or other areas. By detecting the presence of carriers/items in images, the CCS/TPCS may determine when carriers/items were dropped off and where the carriers/items are located. The cameras may be included in a variety of locations, such as near the entry to the packing area, near racks/corrals, on racks (e.g., on shelves), or in any location that allows the camera to acquire images of dropped off items. In some implementations, the CCS/TPCS may send a confirmation to pickers/packers (e.g., in the store or outside of the store) when items are detected (e.g., when single items and/or whole orders are detected). In some implementations, the CCS/TPCS may instruct pickers/packers to pack items and/or provide the items to a customer in response to detection of the items/carriers in the packing area.

Additionally, or alternatively, the packing area may include devices that can scan codes on carriers and/or items, such as printed codes (e.g., barcodes). In a specific example, the packing area may include barcode scanners that scan barcodes on the carriers and/or items. Additionally, or alternatively, the packing area may include RFID readers that can read RFID tags attached to the carriers/items. Although the packing area may include cameras, barcode scanners, and/or RFID readers, the packing area may include additional/alternative carrier/item detection devices that detect when items/carriers are dropped off and where the items/carriers are located. The barcode scanners and/or RFID readers may be included in a variety of locations, such as near the entry to the packing area, near racks/corrals, on racks/corrals, or in any location that allows the barcode scanners and RFID readers to detect the items/carriers.

The packing area may be instrumented with additional/alternative sensors for detecting item/carrier drop off and/or item/carrier location. For example, the packing area may include proximity sensors, motion sensors, or other sensors that detect items, carriers, and/or users. Although devices in the packing area may determine when and where a plurality of items/carriers are dropped off in the packing area, in some cases, the devices may only detect when a subset of items/carriers are dropped off and/or where a subset of items/carriers are located. In these cases, the CCS/TPCS may infer that other picked items (e.g., associated with the user/carrier) have been dropped off and/or that the other items are located in the same/similar location. Although the packing area may include a variety of devices that may detect item and carrier drop off and/or location, the packing area may be implemented without the use of devices that detect item/carrier drop off or location.

The CCS/MSDs may move the dropped off items into a packing queue (e.g., in memory). The CCS/MSDs may wait for complete customer orders to be dropped off in the packing area. In some implementations, the CCS/MSDs may automatically determine that a complete order is in the packing area based on the detection of one or more items/carriers associated with the customer order. In a specific example, if a customer order is assigned to a single picker and the CCS/MSDs detect that a specific carrier and/or item (e.g., a unique carrier/item) is in the packing area, the CCS/MSDs may determine that the complete customer order is in the packing area. In another specific example, if a customer order is assigned to two pickers and the CCS/MSDs detect specific carriers/items from the two pickers, the CCS/MSDs may determine that the customer order is in the packing area. In some implementations, one or more pickers/packers may indicate to the CCS/MSDs that the customer order(s) are in the packing area and ready for packing (e.g., using MSDs or other computing devices).

The CCS/MSDs may notify pickers, packers, and/or drivers when a complete customer order is in the packing area. For example, the CCS/MSDs may notify packers/pickers when items that complete a customer order have been dropped off in the packing area. In some implementations, the CCS may send a message to a packer device (e.g., a packer MSD) that indicates when a complete order is ready to be packed in the packing area. In a specific example, an MSD (e.g., a packer MSD) may generate a GUI that indicates when one or more orders are ready for packing. In the packer GUI, the packer may select (e.g., touch/click) a GUI element (e.g., a button) corresponding to the complete customer order. The packer may then assemble the complete customer order. In some implementations, a packer may scan carriers and/or items of a customer order when packing the customer order for pick up or delivery. In some implementations, the packer GUI may include features described herein with respect to the picking GUI (e.g., arrangements of items based on location). In some implementations, the CCS may notify drivers (e.g., drivers waiting for orders and/or out delivering orders) in a GUI that may also allow the driver to select which order to deliver.

Packing items for customer pickup or delivery can be performed using MSDs (e.g., different MSD modes) and/or packing-specific devices. In some implementations, picking and packing may be performed at the same time. For example, a single picker may pick an entire customer order using an MSD. The picked customer order may be provided (e.g., with no/minimal changes) for customer pickup or delivery. In this example, the MSD may provide the user with a GUI that allows the user to finalize the customer order for customer pickup or delivery. For example, the MSD may provide a GUI for receiving picker input indicating that the order is picked and ready for a customer. In this case, another party may present/deliver the customer order to the customer. The picker may also interface with the MSD or other computing device to finalize the customer order. For example, the picker may print a customer receipt, receive payment, print delivery instructions, or print other instructions for pickup or delivery.

In some implementations, the MSDs may include one or more modes for picking/packing. For example, an MSD may include a picking mode that is used while picking orders. The MSD may also have a packing mode (e.g., manually or automatically accessed mode) for packing items. In some implementations, the packing mode may include similar functionality as the picking mode. For example, the packing mode may display items/carriers for a customer order in the packing area. The packing mode may also arrange the carriers/items on the display based on the location (e.g., relative location) of the carriers/items to the MSD, as described with respect to stocked items. Using the MSD in the packing mode, a user (e.g., packer) may scan carriers/items for a customer order while collecting the carriers/items for presentation/delivery to a customer. In a specific example, an MSD in the packing mode may: 1) indicate to a packer that a customer order is ready for packing, 2) receive packer selection of a customer order for packing or automatically assign a customer order for packing, 3) display carriers/items of a customer order (e.g., arranged based on location of items relative to the packer), 4) scan carriers/items (e.g., barcodes/RFIDs) of the customer order, and 5) indicate that the carriers/items of the complete customer order have been scanned and are ready for the customer. In some implementations, a single packer may pack a single customer order. In some implementations, multiple packers may pack the same customer order. In implementations where multiple packers pack the same customer order, the MSDs may assign carriers/items to the packers, display carriers/items to the packers, and allow packers to scan the carriers/items of the customer order in a similar manner described with respect to picking stocked items.

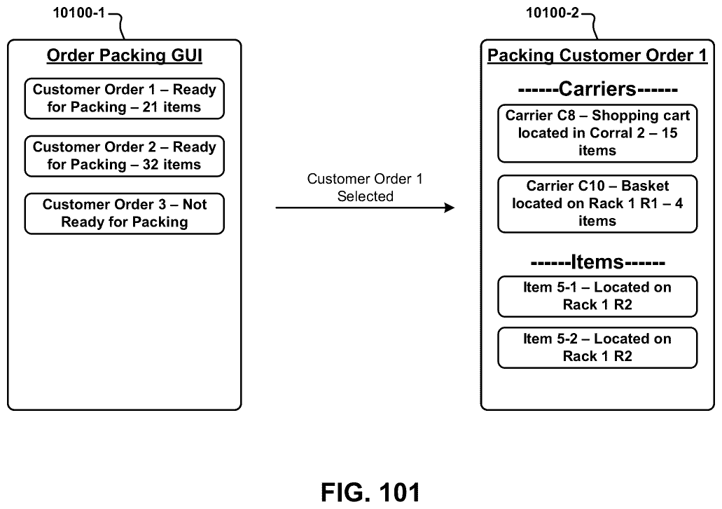

FIG. 101 illustrates example packing GUIs 10100-1, 10100-2 that may be used by packers in the packing area, or by other parties that may pack customer orders. In FIG. 101, an initial packing GUI 10100-1 includes statuses for customer orders that indicate whether the orders are ready to be packed. For example, the packing GUI 10100-1 indicates that Customer Order 1 and Customer Order 2 are ready for packing, while Customer Order 3 is not ready for packing. Note that the packing GUI may also provide customer order data, such as a number of items to be packed. It may be assumed that the packer has selected (e.g., touched/clicked) Customer Order 1 in GUI 10100-1. Selecting Customer Order 1 causes the packing device to generate a packing GUI 10100-2 for packing Customer Order 1. The packing GUI 10100-2 for Customer Order 1 includes a list of items and carriers along with their corresponding locations in the packing area. For example, assuming the carrier/item configuration of FIG. 100, Customer Order 1 includes items in carrier C8 in Corral 2, carrier C10 in location R1, and Items 5-1 and 5-2 in location R2. The packer may further select the carriers and items in the packing GUI in order to see more information, such as the specific items and/or item details for the customer order. The packer may collect/pack the carriers and items in the packing GUI, scan the items to confirm collection, and present the customer order to the customer or delivery driver.

The packing GUIs of FIG. 101 are only example packing GUIs. As such, additional/alternative packing GUIs may be implemented in the OFS. In general, packing GUIs may indicate any of the data associated with pickers, packers, orders, items, MSDs, and carriers described herein. In some implementations, the packing GUI may indicate statuses associated with customer orders, such as the pickers/MSDs being used to pick the orders, items that have been picked (e.g., on a whole or per picker basis), items remaining to be picked (e.g., on a whole or per picker basis), an estimated time for picking the complete order (e.g., on a whole or per picker basis), and/or an estimated time at which items may be dropped off in the packing area for packing (e.g., on a whole or per picker basis). The data indicated in the packing GUIs may also be displayed and organized in a different manner than illustrated in FIG. 101. For example, items and carriers for an order may be intermixed in the GUI. As another example, the packing GUIs may indicate the contents of specific carriers. In these cases, the packing GUIs may indicate which items to pick, and not pick, from specific carriers while packing the customer order.

The example picking GUIs illustrated herein are only example picking GUIs. As such, additional/alternative picking GUIs may be implemented in the OFS. For example, picking GUIs may indicate any of the data associated with pickers, MSDs, orders, items, and carriers described herein.

The packing area may include other devices (e.g., other than MSDs) for packing carriers/items. For example, the packing area may include other handheld scanners (e.g., item/carrier scanners, such as barcode scanners, RFID scanners, etc.) or other scanners (e.g., in-counter scanners) that include some MSD functionality. The handheld/other scanners may include displays in some implementations. The packing area may also include standalone displays or displays that are part of one or more other devices. The packing area may also include other devices, such as point of sale terminals, invoice/receipt printers, cash registers or electronic payment systems (e.g., credit card payment when needed), scales for weighing items, conveyor belts, dispensers, robotic picking systems, etc. The packers may scan and pack customer orders using MSDs and/or any of the other scanners/devices in the packing area.

In some implementations, a store may include multiple preset locations for dropping off picked items. As described herein, a store may include a designated packing area. In some implementations, a store may include multiple designated packing areas. In these implementations, customer orders may be packed in the multiple different packing areas in a similar manner. The different packing areas may be located in different parts of the store. In some cases, different packing areas may be associated with different customer pickup/delivery locations. For example, a first packing area and a second packing area may be associated with a customer pickup location and a delivery location, respectively. In some cases, different packing areas may be associated with different item types, such as grocery, electronics, online orders, etc. In some implementations, the CCS may generate routes based on which packing area is to be used (e.g., based on customer preference or other procedures). In one example, the CCS may generate a route that terminates at the selected packing area. For example, the CCS may generate a shortest route that terminates at the selected packing area.

The MSDs (e.g., MSD GUIs) may indicate to the users which packing area to use when dropping off carriers/items for packing. In some implementations, the MSDs may route based on the locations of the one or more packing areas. For example, routes may be generated that terminate at the one or more packing areas based on item type, picking efficiency (e.g., minimizing movement and/or maximizing picking rate), or other routing considerations.

In some implementations, the preset drop off locations may include other defined areas in the store, such as racks in the store, corrals in the store, or other objects/areas. The preset drop off locations may be used by a picker for a variety of reasons. In some implementations, the picker may be instructed to drop off carriers/items at a preset area on a route. In these implementations, another picker may be instructed to pick up the carriers/items that have been dropped off (e.g., according to a route on an MSD). In other implementations, customers or other parties (e.g., third-party pickers) may pick up the items/carriers that were dropped off at the preset locations. In other cases, a user may drop off items at a preset location in order to perform some other service, such as helping a customer or cleaning the store. In some implementations, the user that drops off the items may resume their route at a later time and pick the items/carriers back up. Example preset locations may include different areas throughout the store, such as areas near the front of the store (e.g., near customer checkout), areas of the store with a high volume of picking (e.g., where many items may be picked and dropped off for easy pickup later), areas outside of the store for pickup/delivery, or other areas that may act as a temporary drop off point.

In some implementations, the preset locations may be instrumented with devices that automatically detect when items are dropped off and/or which items have been dropped off. In some implementations, users may manually indicate when items are dropped at a preset location. The CCS may indicate to the users (e.g., via MSDs) which items are included at the preset locations along with location data (e.g., a location value, aisle number, location name, etc.) indicating which preset location includes the items.

In some implementations, the OFS may implement dynamic carrier/item drop off in the store. In a dynamic drop off scenario, a user may leave carriers/items in any location, such as a location other than the packing area or any other preset location (e.g., a preset defined location for drop offs). For example, a user may drop off carriers/items in an aisle or other location that is not a preset location. Another user may take control of the dropped off carriers/items. Alternatively, the same user may retake control of the dropped off carriers/items at a later time. A location where items may be dropped off that is not preset (e.g., in a packing area or other preset area) may be referred to as a “dynamic drop off location.” A user may drop off items for a variety of reasons. For example, a user may be required to perform another service, such as helping a customer, cleaning up a spill, or some other unexpected service. Additionally, a user's work shift may end during picking. The dynamic drop off location may provide a user with flexibility. In some cases, customers may also drop off items while shopping for later pickup by themselves or a partner customer (e.g., in the case 2 customers are shopping for a customer order).

In some implementations, a user may drop off items in a preset or dynamic location and indicate the preset/dynamic location in their MSD. Users may indicate the location in the MSD by manual entry, selection of enumerated locations, by scanning a nearby location indicator, or in another manner. Locations may be indicated in any manner described herein, such as a department name, aisle name/number, location in an aisle (e.g., near an end cap), and/or in another manner. In some implementations, the user may also request that another user (e.g., any user or a specific user) pick up the items in the indicated location. For example, the user may interact with the MSD to send a request out to other MSDs (e.g., via the CCS) that the items be picked up.

In some implementations, the user may indicate that the items are being dropped off in the MSD. The MSD may automatically determine the location of the items in the store. The MSD may communicate the automatically determined location to other MSDs (e.g., via the CCS).

In some implementations, the CCS may automatically determine that the user has dropped off items. For example, the CCS may determine that items have been dropped off based on a lack of movement associated with the items, MSD, and/or user over a period of time. As another example, the CCS may determine that items have been dropped off if the user and/or MSD location deviates from the item location. As another example, the CCS may determine that items have been dropped off if the MSD determines that it has gone out of range of the items/carriers, such as a distance at which RFID signals associated with the items/carriers are not sufficiently acquired. In some implementations, the CCS may prompt the user via the MSD to indicate/confirm that the items have been dropped off and/or indicate the location of the dropped off items. In some implementations, the CCS may automatically assign a new picker to pick up the dropped off items (e.g., based on proximity and/or other routing considerations).

In some implementations, users may transfer items directly between each other. For example, a first user and a second user may meet and transfer items between one another. Users may transfer some of their items or all of their items to other users. In some implementations, the MSDs may include an item transfer function (e.g., a transfer mode). In these implementations, a first user may indicate that they are acquiring items from a second user. The second user may then hand over the items to the first user. In some implementations, the transfer may be performed manually in the MSDs (e.g., in a menu). In other implementations, a user may scan the items to make the transfer. In any case, the items may be reassociated with a new user once transferred. The item transfer functionality may be performed by pickers, packers, or other parties. In some implementations, the users may transfer carriers/sub-carriers in a similar manner. In some implementations, a user that is carrying items without a carrier or MSD may transfer items to another user that indicates the transfer on the receiving end by scanning the items and/or entering the items manually into the MSD GUI.

The transfer of items between users can be performed in a variety of scenarios. In some cases, a user may transfer items from one carrier to another. For example, users may transfer items from a first cart to a second cart or a first basket to a second basket. In some cases, a user may pick one or more items by hand and transfer the items to another user's carrier. For example, the CCS may assign a first user one or more items to pick by hand. The user may pick the assigned items by hand and take them to another user for transfer to the other user's cart. Assigning one item (or a few items) to a first user to pick and transfer may ensure efficient picking of customer orders in scenarios where some items may be more efficiently picked by different users (e.g., based on proximity of items and/or availability of pickers).

In some implementations, a first user may make a general request (e.g., a transfer request) via MSD that another user (e.g., an unspecified user) takes their items from them. In some implementations, the first user may specify their location, or the CCS may indicate the location automatically in the request. In some implementations, the first user may specify a location at which the transfer should occur (e.g., a preset location or dynamic location).

In some implementations, a user may make a request that specific items be dropped off in a specific location (e.g., a preset location or dynamic location). In these implementations, a user that drops off the items may indicate manually that the items are in the location. Additionally, or alternatively, the CCS may automatically determine that the items are in the location and confirm that the items are in the location to the requesting user.

Transferred or dropped off items/carriers may change associations (e.g., user and/or MSD associations) when the new user picks up the items. The dropped off items/carriers may also be disassociated from the older user (e.g., by removal of the associations in memory). In some implementations, users may interact with the MSD (e.g., an MSD GUI) to cause the updated associations/disassociations. For example, a first user can transfer the items to the second user (e.g., when dropped off or handed off) in software by selecting a user and items to be transferred. In this example, the CCS may change the associations. In some implementations, the receiving user may indicate and/or confirm the transfer in the MSD GUI.

In some implementations, one or more of the transferring users may scan items/carriers to change associations. In some implementations, the user that drops off the items/carriers may scan the items/carriers to indicate that they are dropping the items/carriers off at a location. In some implementations, the user that picks up the items/carriers may scan the items/carriers to indicate they are picking up the items. In some implementations, the CCS/MSDs may automatically detect when items are dropped off, picked up, and/or transferred (e.g., using one or more cameras, RFID readers, barcode scanners, or other devices described herein). In some implementations, the transfer of items may include a transfer of a carrier ID, such as an RFID or other location indicating device.

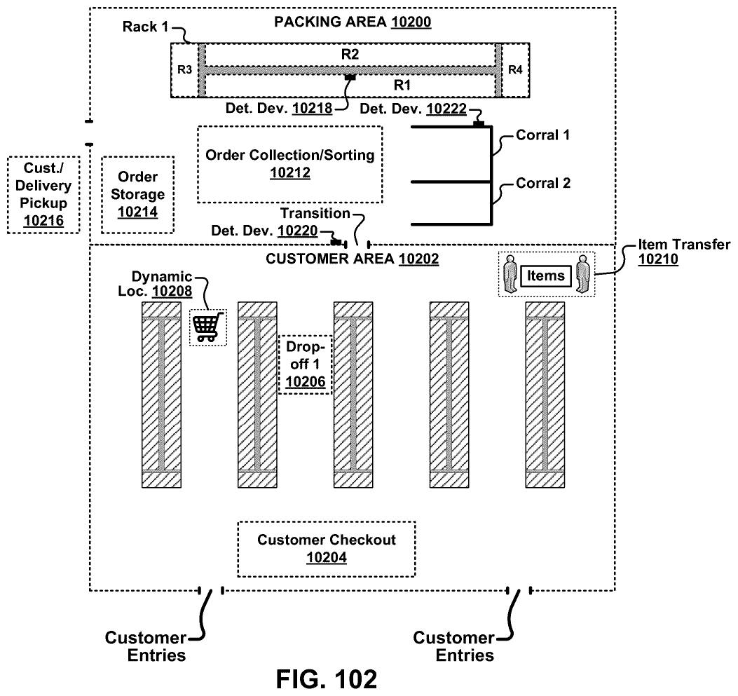

FIG. 102 illustrates an example packing area 10200 and customer area 10202 of a store. The store in FIG. 102 includes different locations described herein. The customer area 10202 includes some preset locations, such as a customer checkout location 10204 and a preset drop off location (Drop-off 1 10206). The customer area 10202 also includes a cart that has been dropped off at a dynamic location 10208. Additionally, two users are performing an item transfer at 10210.

FIG. 102 includes a packing area 10200 with an example rack (Rack 1) and corrals (corral 1 and corral 2) described herein. Additionally, the packing area 10200 includes an order collection/sorting area 10212 in which users may collect items and sort items of customer orders to prepare the items for customer pickup or delivery. The packing area 10200 also includes an order storage area 10214. The order storage area 10214 may be an area in which finished/packed customer orders are placed. The finished/packed customer orders may be taken out to customers for pickup. The finished/packed customer orders may also be taken out to delivery drivers. There is an area 10216 outside of the store labeled as the customer/delivery pickup area. Customers and/or delivery drivers may pull up to this area to receive customer orders (e.g., finished/packed customer orders in the order storage area). A store may include a plurality of order storage areas and corresponding customer/delivery pickup areas.

A picker may drop off items at one or more drop-off locations while picking a customer order (e.g., picking a customer order according to a route). In some implementations, item drop-off locations may be referred to as “endpoint drop-off locations” or “route endpoint drop-off locations.” For example, an endpoint drop-off location may refer to a location at the end of a route and/or a location at which the picker drops off their picked items (e.g., drops off a customer order and/or all picked items). In some cases, an endpoint drop-off location may be in the packing area, although other endpoint drop-off locations for a route may be used, such as endpoint drop-off in the customer area (e.g., a preset drop off point or dynamic drop-off point). In some implementations, item drop-off locations may be referred to as “midpoint drop-off locations” or “mid-route drop-off locations.” For example, a midpoint drop-off location may be a location (e.g., location within a route) at which a picker drops off some of their items. In some cases, a mid-point drop-off location may be in a customer area of the store, such as a preset drop-off location or a dynamic drop-off location. In other cases, a packing area location may serve as a midpoint drop-off location, such as when a picker drops off a first set of items at a first packing area, and then subsequently drops off a second set of items at a different packing area.

As described herein, users, devices, carriers, sub-carriers, items, and orders may be associated with various IDs. For example, users, MSDs, carriers, sub-carriers, items, and orders may be associated with user IDs, MSD IDs, carrier IDs, sub-carrier IDs, item IDs, and order IDs, respectively. In some implementations, users, devices, carriers, sub-carriers, items, and orders may be associated with various indicators that may indicate the IDs. A variety of types of indicators may be used. For example, the indicators may be readable indicators, such as barcodes, QR codes, or other codes. The readable indicators may also include visually identifiable indicators, such as color codes, reflectors, names on badges (e.g., identifiable by camera), or other visible indicators. In some implementations, indicators may be visually identifiable using feature/object recognition processes. For example, the OFS may identify users, MSDs, carriers, sub-carriers, and items by analyzing images acquired by cameras in the store. In some implementations, indicators may include devices (e.g., RFID, BLUETOOTH, optical transmitter, or other indicator) that transmit signals and/or may be interrogated by devices in the store. The transmitted signals may indicate the IDs associated with the indicators.

Different indicators and their associated IDs may be named herein according to their associated user, MSD, carrier, sub-carrier, item, and order. In one example, a user may be associated with a user indicator (e.g., a badge, RFID, or other indicator) that indicates a user ID. In another example, an MSD may be associated with an MSD indicator (e.g., an RFID or other internal MSD component) that indicates an MSD ID. In another example, a carrier/sub-carrier may be associated with a carrier/sub-carrier indicator (e.g., a barcode, RFID, or other device) that indicates a carrier/sub-carrier ID. Different users, devices (e.g., MSDs), and carriers/sub-carriers may also be referred to according to their respective roles. For example, a picker and picker MSD may be associated with a picker indicator/ID and picker MSD indicator/ID. As another example, a packer and packer MSD may be associated with a packer indicator/ID and packer MSD indicator/ID.

As described herein, in some implementations, the store (e.g., customer area, packing area, and/or outside) may include detection devices/sensors that may detect a variety of users and objects, such as MSDs, carriers, sub-carriers, and items. The OFS (e.g., CCS/TPCS) may receive and process data and signals generated by the detection devices/sensors. The OFS (e.g., CCS/TPCS) may make determinations described herein based on the data and signals received from the detection devices/sensors. For example, the CCS/TPCS may detect the presence/location of users, MSDs, carriers, sub-carriers, and/or items based on data/signals received from detection devices. Example detection devices 10218, 10220, 10222 are illustrated in FIG. 102. For example, detection devices 10218, 10220, 10222 in the packing area 10200 may be attached to cart corrals (e.g., corral 1), racks (e.g., at R1), and/or near the transition between the packing area and the customer area.

A variety of different detection devices/sensors may be included in the store. In some implementations, detection devices may include devices that read readable indicators (e.g., barcodes, QR codes, and/or other codes). These devices may include cameras, barcode scanners, or other scanners. In some implementations, detection devices may acquire images of users, MSDs, carriers, sub-carriers, and/or items in the store. In these implementations, the OFS (e.g., CCS/TPCS) may analyze images acquired by the detection devices to detect users, MSDs, carriers, sub-carriers, and/or items in the store. In some implementations, detection devices may include devices that acquire signals transmitted in the store by indicators (e.g., RFID, BLUETOOTH, Wi-Fi, optical transmitters, or other devices) associated with users, MSDs, carriers, sub-carriers, and items. Detection of users, MSDs, carriers/sub-carriers, and items in the store by the detection devices may supplement other location determination techniques described herein and/or may be independent of the other location determination techniques described herein.

Detection devices may be named herein according to the user/objects detected by the detection devices. For example, a user detection device may detect a user (e.g., a user indicator). As another example, an MSD detection device may detect an MSD (e.g., an indicator that is attached or is internal to the MSD). As another example, a carrier/sub-carrier detection device may detect carriers/sub-carriers (e.g., carrier/sub-carrier indicators). As another example, an item detection device may detect an item (e.g., an item indicator). Detection devices may also be named herein according to the technology implemented by the detection devices and/or the types of indicators detected by the detection devices. For example, detection devices may include, but are not limited to, barcode scanners, optical detection devices (e.g., cameras, IR receivers, etc.), BLUETOOTH detection devices, Wi-Fi detection devices, RFID detection devices, distance sensors, and user proximity detection devices/sensors. Note that some detection devices can detect combinations of users, MSDs, carriers, sub-carriers, and items, depending on the technology that is implemented. For example, users and carriers may use RFIDs that are detected by the same detection devices. In some cases, different detection devices may be used to detect users and other objects.

The detection devices may be placed in a variety of locations in the store. For example, in some implementations, the detection devices may be placed on racks (e.g., shelves), the floor, or in other locations. In some implementations, the detection devices may be mounted to locations in the store, such as racks, the ceiling, walls, the floor, store objects (e.g., cart corrals), doors, door jambs, and/or other locations.

In some implementations, the CCS/TPCS may detect the presence of users, MSDS, carriers, sub-carriers, and items based on data/signals generated by the detection devices. In some implementations, the CCS/TPCS may determine the location of users, MSDs, carriers, sub-carriers, and items based on data/signals generated by the detection devices. For example, the CCS/TPCS may determine when users enter/leave the packing area after picking and dropping off items based on signals/data from user detection devices. In a specific example, the store may include user detection devices at/near the transition between the packing area and customer area. In this specific example, the user detection devices may determine when a user enters the packing area after picking.

In some implementations, the detection devices may indicate the location of users, MSDs, carriers/sub-carriers, and/or items based on the location at which the detection devices are mounted. For example, if the detection device is a camera that is mounted in a manner facing a rack location, detection of carriers/sub-carriers and/or items in the camera image may indicate that the carriers/sub-carriers and/or items are located at the rack location. In another example, if the detection device is an RFID scanner that is mounted near a rack location, detection of RFID tags on carriers/sub-carriers/items by the RFID scanner may indicate that the carriers/sub-carriers/items are located on/near the rack. In some implementations, the CCS/TPCS may determine the locations of users, MSDs, carriers/sub-carriers, and/or items relative to the detection devices in a more granular/precise manner. For example, in the case indicators transmit signals to the detection devices (e.g., radio signals, light signals, sound signals, etc.), the detection devices may process the signals to determine a relative location (e.g., distance and/or direction) of the indicators to the detection devices. As another example, in the case where a detection device captures images (e.g., a camera) that covers a number of locations, the CCS/TPCS may determine the locations of users, MSDs, carriers/sub-carriers, and/or items based on their specific locations in the images. In a specific example, a mounted camera facing a rack may cover multiple shelves on the rack, and the detection of carriers/items in different locations of the images may indicate the shelves on which the carriers/items are located.

In some implementations, the CCS/TPCS may infer that associated items/carriers are located in an area of the store based on the detection of a subset of the items/carriers (e.g., one or more items/carriers), a user associated with the items/carriers, and/or an MSD associated with the items/carriers. For example, detection of a single carrier associated with a customer order picked by a single picker may allow the CCS/TPCS to infer that the other items/carriers associated with the order/picker are in the same location. In another specific example, detection of a picker entering a packing area may allow the CCS/TPCS to infer that the customer order associated with the picker is in the packing area.

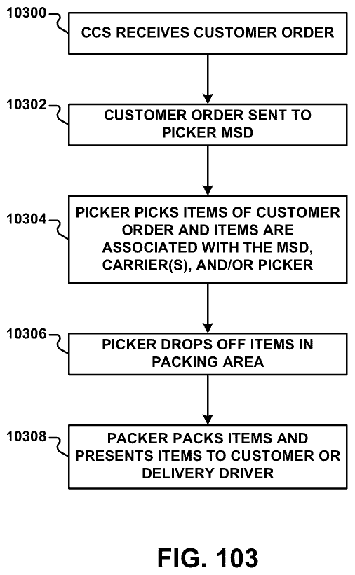

FIGS. 103-107 illustrate methods that describe example operations of the OFS. FIG. 103 illustrates an example method that describes a single picker picking all items of a single customer order. In block 10300, the CCS receives a customer order. In block 10302, the customer order is assigned to a single picker MSD. In block 10304, the picker picks the items of the customer order. The items may be associated with the MSD, one or more carriers, and/or the picker. In block 10306, the picker drops off the customer order in the packing area. In block 10308, a packer packs the customer order and presents the customer order to the customer or delivery driver. Note that in some cases, the picked items may not require packing by a packer. Instead, the picked items may be presented to the customer/driver as picked.

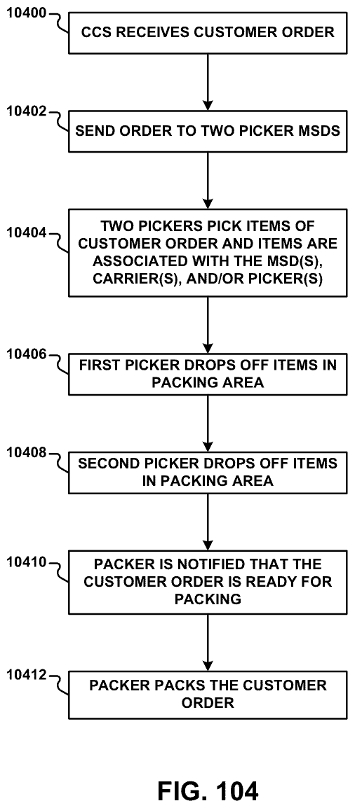

FIG. 104 illustrates an example method that describes multiple pickers picking a single customer order followed by a single packer packing the customer order. In block 10400, the CCS receives the customer order. In block 10402, the CCS sends the customer order to two pickers. Note that the items may be sent to picker MSDs, other devices, and/or announced over the intercom for hand picking. In block 10404, the two pickers pick items from the customer order. The items may be associated with the MSDs, one or more carriers, and/or the pickers. In block 10406, the first picker drops off picked items in a packing area. In block 10408, the second picker drops off picked items in the packing area. In blocks 10406-10408, the pickers may manually indicate (e.g., in an MSD GUI) that the items are dropped off. Additionally, or alternatively, the dropped off items may be automatically detected.

In block 10410, a packer is notified that the customer order is ready for packing. For example, the packer may be notified on a packer MSD or other device. In a specific example, the CCS may notify the packer based on manual/automatic notifications from the pickers that the items are in the packing area. The CCS may also determine independently from the pickers and picker MSDs that the items are in the packing area. For example, the CCS may detect the items/carriers for the customer order in the packing area using one or more packing area devices described herein (e.g., cameras, RFID scanners, barcode scanners, etc.). In block 10412, the packer may pack the customer order by collecting the items picked by the first and second picker.

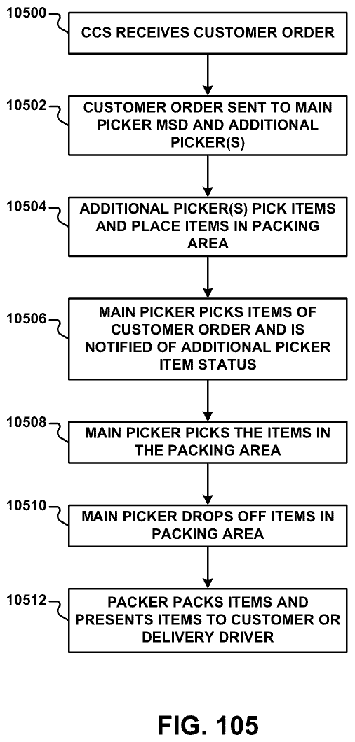

FIG. 105 illustrates an example method that describes multiple pickers picking a single customer order followed by a single packer packing the customer order. In the method of FIG. 105, one of the pickers (e.g., a “main picker”) is responsible for collecting items placed in the packing area by the additional pickers. A packer then packs the order.

In block 10500, the CCS receives a customer order. In block 10502, the CCS sends the customer order to a main picker and one or more additional pickers. For example, the CCS may send a first portion of the customer order to a main picker. The CCS may send a second portion of the customer order to one or more of the additional pickers. The main picker may be responsible for picking items from the customer order and also collecting items picked by other additional pickers.

In block 10504, the additional pickers pick their respective items and place the items in a packing area. The CCS/MSDs may determine associations between the additional pickers, their items picked, their carriers, and/or their MSDs for reporting to the main picker. In block 10506, which may occur after block 10504 or at the same time as block 10504, the main picker picks items of the customer order and is notified of additional picker item status. For example, the main picker may be notified on their MSD of which items have been picked, which items will be picked, and/or whether the additional pickers have picked items needed to complete the order.

In block 10508, the main picker picks (e.g., collects) the items in the packing area left by the additional pickers. In some implementations, the main picker MSD may provide a GUI that lists the items to be picked and their locations (e.g., as manually entered by additional pickers and/or automatically detected). In block 10510, the main picker drops off the items (e.g., the items picked by the main picker and/or the items picked by the additional pickers) in the packing area for packing. In block 10512, a packer packs the items and presents the items to the customer or a delivery driver.

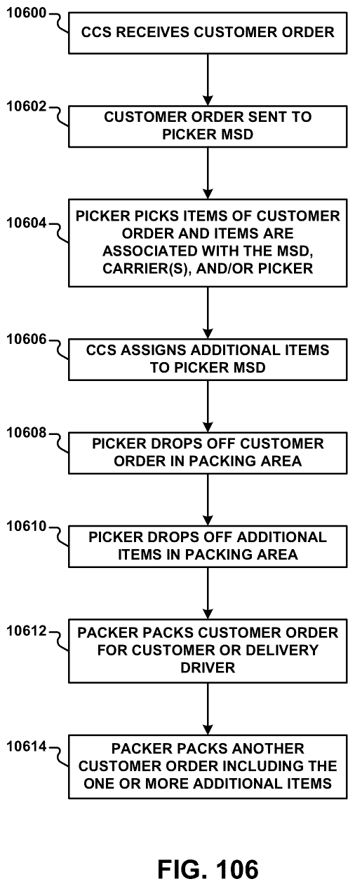

FIG. 106 illustrates an example method that describes a scenario in which a single picker picks a customer order along with additional items assigned while picking the customer order. In block 10600, the CCS receives a customer order. In block 10602, the CCS assigns a main customer order to the picker. In block 10604, the picker starts picking the main customer order. Picked items may be associated with the MSD, carrier(s), and/or the picker. While picking the main customer order, in block 10606, the CCS assigns additional items from one or more additional customer orders to the picker. In block 10608, the picker drops off the items from the main customer order in the packing area. In block 10610 (e.g., while dropping off items from the main customer order), the picker drops off the additional items in the packing area. In block 10612, a packer packs the main customer order for the customer or delivery driver. In block 10614, a packer (e.g., the same packer or another packer) packs the additional items from the one or more of the additional customer orders for other customers/drivers.

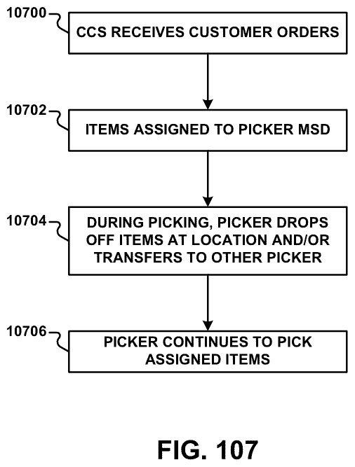

FIG. 107 illustrates an example method in which a picker drops off or transfers items to another picker. In block 10700, the CCS receives customer orders. In block 10702, the CCS assigns items to a picker from the one or more customer orders. In block 10704, while the picker is picking items, the picker drops off items at a location (e.g., a preset/dynamic location) and/or transfers picked items to another picker. For example, the picker may drop off items based on a request from another picker, instructions from the CCS, or for other reasons. In block 10706, the picker continues to pick assigned items.

As described herein, the CCS may determine the location of items based on one or more location technologies and/or one or more associations between items and carriers, MSDs, and/or users. In some implementations, as described herein, the CCS may generate/modify routes based on the location of items picked by a user. In some implementations, the CCS may generate/modify routes to acquire one or more items that have been dropped off in a preset/dynamic location. In some implementations, the CCS may generate a route that includes instructions to drop off items in a preset/dynamic location. For example, the CCS may instruct a picker to drop off items needed to finish an order based on the location of the user/items. In a specific example, if a picker has items that are needed to finish an order, the CCS may instruct the picker to drop off the items in a location for another picker. As another specific example, if a picker has items that are needed to finish an order and the picker is near the packing area, the CCS may instruct the picker to drop off the needed items in the packing area during the route. In some implementations, the CCS may instruct pickers to transfer items if the items are needed and the pickers are near one another.

In some implementations, the CCS may generate a route that instructs a user to pick items and drop the items off at another location. In these implementations, the CCS may generate additional routes for other pickers to pick up the dropped off items.

As described herein, users may include pickers, packers, delivery drivers, and other parties. In some implementations, the users may be employed by the store. In some implementations, the users may be employed by another party (e.g., a third party). In some implementations, the users may be the customers. As such, the pickers, packers, delivery drivers, and other parties may include store employees, third parties, and/or customers. Any combination of these roles may implement the techniques described herein. For example, pickers may include store employees and packers may include third-party delivery drivers. In this example, the store employee pickers may pick items and place the items in the packing area. Further, in this example, a third-party delivery driver may pack the orders in the packing area for delivery. As another example, one or more third-party pickers may pick an order for packing by one or more additional third-party delivery drivers.

A variety of different users are described herein. Example users may include, but are not limited to, pickers (e.g., store pickers and third-party pickers), packers, delivery drivers (e.g., store drivers and third-party drivers), customers, and other users or user designations (e.g., manager, employee, etc.). The CCS/TPCS may store data associated with users. The data associated with users may be referred to as “user data.” The CCS/TPCS may use the user data for making a variety of decisions, such as whether to assign orders/items to the user, a number of orders/items to assign to the user, how to route the users (e.g., pickers/packers), and/or other decisions.

The CCS and/or TPCS may store a variety of types of data for different users. In some implementations, different types of users may be associated with different data fields. For example, picker user data may have different data fields than packer user data. As another example, picker user data may have different data fields than driver user data. A variety of types of data that may be included in user data is described herein. The user data described herein is only example user data. As such, additional/alternative user data may be used by an OFS. For example, additional/alternative user data may be used to convey the same/similar information or different information regarding users.

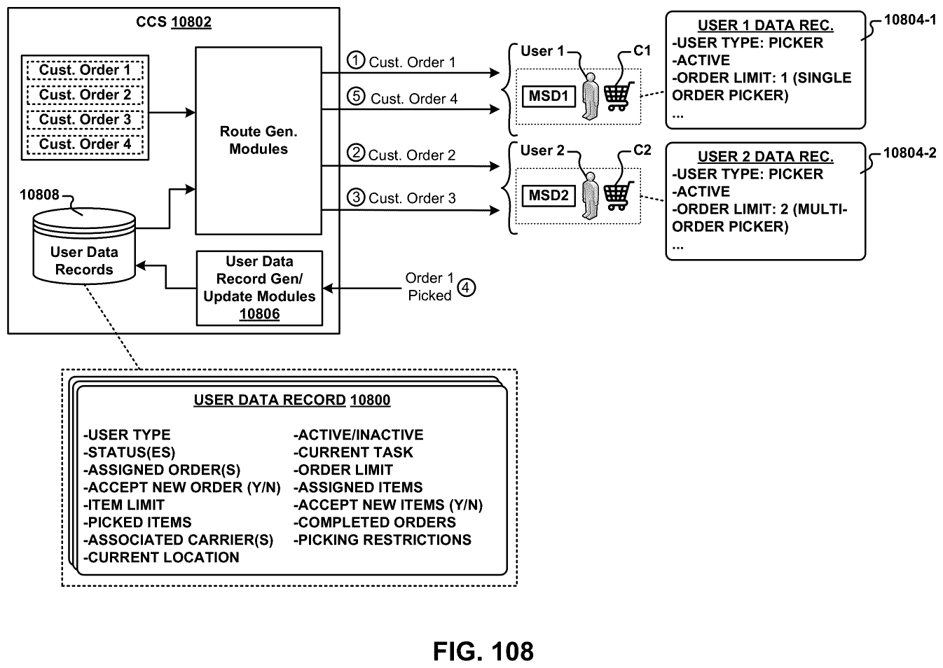

Example user data may be illustrated and described herein as included in a user data record (e.g., see user data record 10800 of FIG. 108). Each user (e.g., unique user ID) may be associated with a user data record that stores data for the user. A user data record may include user data fields (e.g., user type, status, current location, etc.) that define the type of data associated with the user.

A user data record may include a user type data field. The user type data field may indicate a user type associated with the user data record. Example user types may include, but are not limited to, picker, packer, delivery driver, customer, and other types. In some cases, the user type may indicate whether the picker and/or driver are associated with the store (e.g., a store employee) or a third-party service. In some cases, a user data record may be referred to herein according to the user type. For example, a user data record for a picker may be referred to as a “picker data record.”

A user data record may include a current task data field. A current task data field may indicate a current task that is assigned to the user or is being performed by the user. In some implementations, the current task data may indicate whether the user is active or inactive, which may indicate whether the user is currently performing a task at the present time. For example, a data field indicating that the user is active may indicate that the user is performing tasks associated with their user type. In a specific example, a user that is active as a picker may be performing tasks associated with a picker, such as receiving customer orders/items, traversing routes, picking items, and/or other tasks. In another example, a picker that is inactive may not be currently receiving customer orders/items, may not be assigned customer orders/items, or performing other tasks. In some cases, an inactive picker may transition to an active picker and begin receiving customer orders, picking items, and performing other tasks. Similarly, a once active picker may transition to an inactive picker.

A current status of active/inactive may also be applied to other types of users. For example, a currently active packer may be currently packing orders for customer pickup. As another example, a currently active driver may be currently delivering items to customers.

Current task data may also be indicated in manners other than active/inactive. For example, current task data for a picker may indicate that the picker is “picking” when the picker is actively picking items from assigned orders. As another example, current task data for a picker may indicate that the picker is “waiting for order” when a picker is waiting for an assigned order/route. As another example, current task data for a packer may indicate that the packer is “packing an order” or “waiting for an order to be completely picked.” If the user is a driver, the driver may be “delivering orders” while the driver is on a delivery route. As another example, a driver may be “waiting for pickup” when the driver is waiting for a packed order to be handed off to them.

Other current tasks may also be assigned to users, such as “assisting customer,” “supervising,” “cleaning,” or another task. In some implementations, users may set their own current task (e.g., in an MSD interface or other computing device interface), such as by using a menu to indicate their current task and/or using voice to indicate their task to the MSD/CCS. In some implementations, managers may assign tasks to users (e.g., using an MSD or other device).

In some implementations, user types and current task data may be changed automatically by the CCS/MSDs. For example, a picker's current task may be changed from “waiting for order” to “picking” after receiving a route from the CCS. As another example, the CCS/MSD may determine that a user is a packer, picker, or delivery driver based on a location in/outside the store.

The user data may indicate the number of different customer orders that may be assigned to a picker. For example, an “Order Limit” data field may indicate a maximum number of orders (e.g., partial or complete orders) that may be assigned to a picker at one time. In some implementations, a picker may be limited to picking a single order at a time. For example, the “Order Limit” data field may be set to a value of ‘1’. A picker that is limited to picking items from a single order may be referred to as a “single order picker.” A single order picker may handle/control one or more carriers that can be packed for a single customer. If the order limit is set to 1, a partial customer order or a complete customer order may be assigned to the picker. In some implementations, the user data may indicate whether the assigned order should be a complete order or a partial order (e.g., optionally partial). In one example, the user data for a single order picker may indicate that only a complete customer order be assigned. In another example, the user data for a single order picker may indicate that a partial customer order may be assigned.

In some implementations, a picker may be assigned multiple customer orders. A picker that may be assigned multiple customer orders may be referred to herein as a “multi-order picker.” User data for a multi-order picker may have the “Order Limit” data field set to a value of 2 or more. Each of the two or more orders may be any combination of complete orders or partial orders. In some implementations, the user data may indicate whether the customer orders should be complete customer orders or partial customer orders (e.g., optionally partial). For example, the user data may indicate that each customer order assigned to the picker should be a complete customer order. As another example, the user data may indicate that one customer order should be a complete customer order and another customer order be a partial customer order or a complete customer order. The user data may indicate any number of complete customer orders and optionally partial orders.

In some cases, a multi-order picker may have the “Order Limit” set to an unlimited value. In these cases, the user data may also indicate that complete orders or optionally partial orders may be picked. If unlimited partial orders may be picked, the multi-order picker may be freely assigned items without regard to the number of orders they have already been assigned. A multi-order picker with these parameters can be used to rapidly pick a number of items in the store and provide the items to the packing area for later organization. A multi-order picker with these parameters may also be effective when the store is receiving a large number of small orders that are urgently needed for pickup or delivery.

In some implementations, the user data record may include an “Item Limit” data field that indicates a limit on the number of items that should be assigned to the user. The item limit may be set in a variety of ways. In some implementations, the item limit may be a set number for a picker. In some implementations, the item limit number may be based on the carrier(s) being used by the picker. For example, some carriers may have item limits due to size constraints. In some implementations, item limits may include additional/alternative data that defines the item limits. For example, the item limit may include an item volume limit and/or item weight limit. In some implementations, a user may scan one or more carriers (e.g., using an MSD) being used to pick items. In these implementations, the CCS/MSD may set the item limit based on the number and type of carriers scanned (e.g., in cases where carriers have associated item limits). In some implementations, the CCS may instruct the user to use specific carriers to pick an order and then set the item limits based on the carriers the user was instructed to use. In some implementations, the store may use the same default carriers for pickers (e.g., the same carts with the same bins). In these implementations, the CCS may determine the item limits based on the default carrier.

In some implementations, the user data record may include data fields indicating whether the user may be assigned new items and/or customer orders (i.e., whether the user is available to pick additional customer orders). This data field may be determined by the CCS/MSDs based on the currently picked items and other user data (e.g., order limit number, item limit number, max item volume, max item weight, and/or other factors). In one example, a single order picker may accept new items so long as they are not over their item limit and the items are for the same customer order (e.g., the items were previously assigned to another picker and withdrawn to be reassigned and/or the customer added items to the existing order while picking). In another example, a multi-order picker may accept new orders/items if they have not exceeded their order limit and item limit.

In some implementations, the CCS/MSD may set a user to pick an unlimited number of items and/or customer orders. In these implementations, the user may continuously pick items until they decide to drop off the picked items in the packing area. In these implementations, the CCS may continuously assign items to the user (e.g., based on location and/or other factors). Configuring a user in this manner may allow the user freedom to continually work through picking lists until all items are picked. Additionally, the CCS may simplify determinations of which items to assign to such a user, as the CCS may not be concerned with item/order limits.

The user data record can include additional data fields that store data used to implement the techniques of the present disclosure. Example data fields may include, but are not limited to: 1) picked item data fields indicating which items have been picked and not yet dropped off for packing, 2) completed order(s) data fields indicating which orders have been completely picked, 3) picking restrictions indicating which items may be picked or not picked by the user (e.g., based on item type), 4) associated carrier(s), 5) an associated MSD being used by the user, 6) a current location (e.g., specified according to one or more location techniques described herein, such as zone number, section number, GPS, last item scanned, etc.), 7) location restrictions, and/or other data associated with users described herein.

In some implementations, a user may set their associated user data. For example, a user may set their order limit number (e.g., in an MSD GUI). In some implementations, the CCS may set user data. For example, the CCS may set the order limit number for a picker. In this example, the CCS may instruct users to be single order pickers or multi-order pickers. The CCS may also instruct the pickers to acquire single order carriers and/or multi-order carriers for picking items. The CCS may instruct users to be single order pickers or multi-order pickers based on a variety of factors, such as a current number of pickers, a current number of outstanding items, a current number of outstanding orders, and/or other factors. In one example, if a single picker is available to pick a plurality of outstanding orders, the CCS may set the picker as a multi-order picker. If additional pickers come online to pick, the additional pickers may be set as single order pickers for picking outstanding orders. The CCS may update picker order limits over time according to the variety of factors described herein (e.g., available pickers, outstanding items/orders, etc.).

As described herein, different user types may have different data fields. For example, a packer can have an indication of what order(s) and item(s) they are packing and/or have collected. Drivers may have a destination location field (e.g., a sequence of destination locations), a current location (e.g., GPS location and/or derived location, such as at the store, out for delivery, at first drop-off location, etc.), orders on the vehicle, estimated delivery times per order, last order delivered time, etc.

FIG. 108 illustrates assignment of customer orders to users (e.g., pickers) based on user data associated with the pickers, such as 1) whether the pickers are actively picking and 2) an order limit associated with the pickers. In FIG. 108, the CCS 10802 receives four customer orders. The CCS 10802 assigns customer orders to two users (pickers) based on user data included in user data records 10804-1, 10804-2 associated with the users. For example, the CCS 10802 may generate/update routes for the two users based on the user data associated with the users. The CCS 10802 may store and update user data records before, during, and after assignment of orders/items to the users. The CCS 10802 may include user data record generation and update modules 10806 that manage the user data (e.g., generate/update user data) associated with the users. User data is illustrated in FIG. 108 as included in a user data records data store 10808.

In FIG. 108, the four customer orders may be stored in an order queue and/or received in sequence. Initially, the CCS 10802 assigns customer order 1 to user 1, a single order picker. After assigning customer order 1 to user 1, user 1 may not be assigned additional customer orders because the order limit of 1 has been reached for the single order picker. The CCS 10802 may then assign customer order 2 and customer order 3 to user 2, a multi-order picker with an order limit of 2. In this case, the CCS 10802 may not assign additional orders to user 1 and user 2, as the users have reached their order limits. User 1 completes picking of customer order 1 while user 2 is still picking customer order 2 and customer order 3. Completing the picking of customer order 1 opens up user 1 to pick another order. In FIG. 108, user 1 is assigned customer order 4 after user 1 has picked customer order 1.

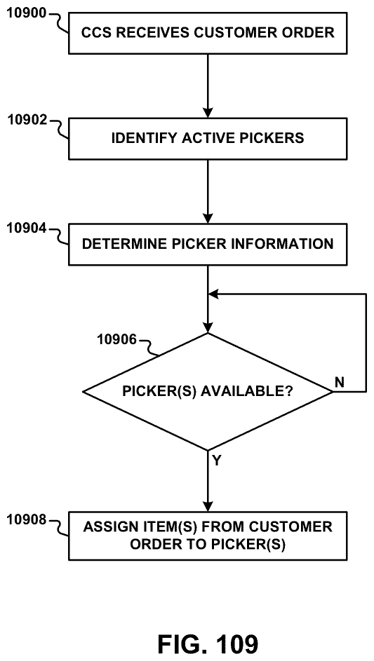

FIG. 109 illustrates an example method that describes selection of a picker according to their availability to pick customer orders (e.g., based on an order limit parameter). In block 10900, the CCS receives a customer order. In block 10902, the CCS identifies active pickers that may be available to pick the customer order. In block 10904, the CCS determines information associated with the pickers, such as the order limits associated with the pickers as well as the number of orders currently assigned to each picker. In block 10906, the CCS determines whether any pickers are available to receive the customer order. For example, a picker that has not yet reached an order limit may be assigned the customer order. The CCS may make the determination of whether there are available pickers based on any of the user data described herein. For example, the CCS may determine whether the picker may be assigned the customer order based also on the item limit, such as whether the new customer order may cause a user to be assigned greater than the item limit. If there is an available picker in block 10906, the CCS may assign the customer order to the available picker (e.g., assign the customer order to the picker MSD) in block 10908. Otherwise, the CCS may wait until one or more pickers are available. As described herein, the availability of pickers and the suitability of pickers to pick orders may change over time as items are picked and pickers move throughout the store.

In some cases, the CCS may identify a set of candidate pickers in block 10906 (e.g., a set of one or more available pickers). In the case a plurality of candidate pickers are available for picking customer orders, the CCS may select one or more of the candidate pickers to pick items from the customer orders based on additional factors. For example, the CCS may select one or more of the candidate pickers based on the location of the pickers, item limits associated with the pickers, and/or other factors described herein.

Although the method of FIG. 109 is described as assigning a received order in real time (e.g., as the order is received), the method of FIG. 109 may also be used to select pickers for a queue of scheduled customer orders to be picked up at a later time. Although a single picker is assigned the customer order in FIG. 109, the received customer order may be split among two or more available pickers. Additionally, note that the CCS may determine which items to assign to pickers based on other factors, such as picker location, expected completion time, and/or other factors described herein. In some implementations, the CCS may select from one or more available pickers based on additional factors (e.g., location, completion time, picking speed, etc.). In these implementations, some pickers may be favored based on the additional factors.

In some implementations, items in the store may be associated with item data structures. For example, stocked items may have stocked item data structures (e.g., stocked item records stored/modified at the CCS/TPCS) that include data associated with the stocked items. A stocked item data structure for a specific item (e.g., per item ID) may specify the item ID, the item type, one or more stocked item locations, and the number the stocked items in inventory (e.g., the number in each location). The one or more locations may be specified according to any location technology described herein.

In some implementations, items that have been picked in the store may be associated with picked item data structures (e.g., picked item records stored/modified at the CCS/TPCS). The picked item record may include an item ID associated with the picked item. In some implementations, the picked item may have a unique picked item ID in order to differentiate the picked item from other picked items with the same item ID. The unique picked item ID may be generated in a variety of ways, such as a combination of the item ID and other IDs, such as the user ID, customer order ID, carrier ID including the item, MSD ID that scanned the item, or in another manner (e.g., a randomly generated ID).

In some implementations, the picked item record may indicate the location from which the item was picked and the time at which the item was picked/scanned. The picked item record may indicate current associations, such as the order ID including the item, the user ID of the user responsible for the item, an MSD ID of the MSD that scanned the item, and/or a carrier/sub-carrier ID including the item.

Items may be associated with a variety of item statuses that may indicate where the item is at in the picking, packing, and/or delivery process. Example item statuses may include, but are not limited to, “picked” (e.g., after an item is picked, scanned, and/or being carried throughout the store), “waiting for packing” (e.g., after an item is placed in the packing area), “being collected/packed” (e.g., when the order is being collected/packed and/or after a packing scanning device scans the item), “being delivered” (e.g., when the driver has packed the item in the delivery vehicle and/or is on the way to a customer location), “given to customer” (e.g., after dropping off the order and/or handing it off to a customer), and “being transferred to picker” (e.g., if the item is at a preset or dynamic drop off point in the store). The example item statuses described herein are only example statuses. As such, additional/alternative statuses may be used in an OFS.

In some implementations, customer orders may be associated with order data structures. For example, each order may be associated with an order record stored/updated at the CCS/TPCS. The order record may include an order ID and other data associated with the order. For example, the order record may indicate a time/date the order was placed, a time/date the order should be packed for pickup/delivery, and/or a time/date at which the order should be delivered to a customer location.

In some implementations, an order record may include additional data associated with picking the order. For example, the order record may include a list of items that have been picked, when the items were picked (e.g., time stamps), a location from which the items were picked, and a current location of the items. In some implementations, the order record may include data indicating multiple current locations for the order, such as when multiple pickers pick the same order, the same picker picks different parts of the order at different times, and/or different parts of the order are placed in different areas of the store (e.g., preset areas, dynamic areas, packing area locations, etc.). The order record may also include association data, such as the associated user(s) ID(s), associated carrier/sub-carrier ID(s), and/or associated MSD ID(s).

In some implementations, an order record may indicate one or more statuses associated with the order. Example statuses may include, but are not limited to, “waiting for assignment” (e.g., prior to being assigned to a picker), “assigned for picking” (e.g., after the order has been assigned to one or more pickers), “completely picked” (e.g., after all items have been picked), “waiting for packing” (e.g., when the order is in the packing area for final packing), “being packed” (e.g., when a picker/packer is collecting items to be packed for the customer), and “packed” (e.g., when the order is packed and ready for customer pickup/delivery).

In some implementations, the CCS/TPCS may include data structures for MSDs. The data structures associated with MSDs may be referred to as MSD data records. The MSD data records may indicate a variety of information associated with MSDs. For example, an MSD data record may include an MSD ID indicating the specific MSD associated with the MSD data record. An MSD data record may also indicate a current location of the MSD. In some implementations, an MSD data record may indicate associations with the MSD, such as a user ID, one or more carrier/sub-carrier IDs, and/or one or more item IDs of items that the MSD has recently scanned during picking/packing.

In some implementations, an MSD data record may include one or more statuses associated with the MSD. An example status may include active or inactive. An active status associated with a picking MSD (e.g., an “active picking MSD”) may indicate that the picking MSD is accepting assigned items/routes and/or is currently being used for picking. An active status associated with a packing MSD (e.g., an “active packing MSD”) may indicate that the packing MSD is accepting orders for packing and/or is being currently used to pack orders. An inactive MSD status may indicate that the MSD is not currently being used for picking or packing. In some implementations, an inactive MSD may be in a standby mode waiting to be activated. In some cases, an inactive MSD may be on a user's person (e.g., being carried or worn), near a user (e.g., placed by the user nearby), or otherwise under control of the user (e.g., on/in a carrier, such as a carrier equipped with MSD functionality). In some cases, an inactive MSD may be in a docking device configured to charge the MSD and/or transfer information (e.g., via a wireless connection or wired connection, such as a USB). In some implementations, the CCS/MSDs may track the location of an inactive MSD.

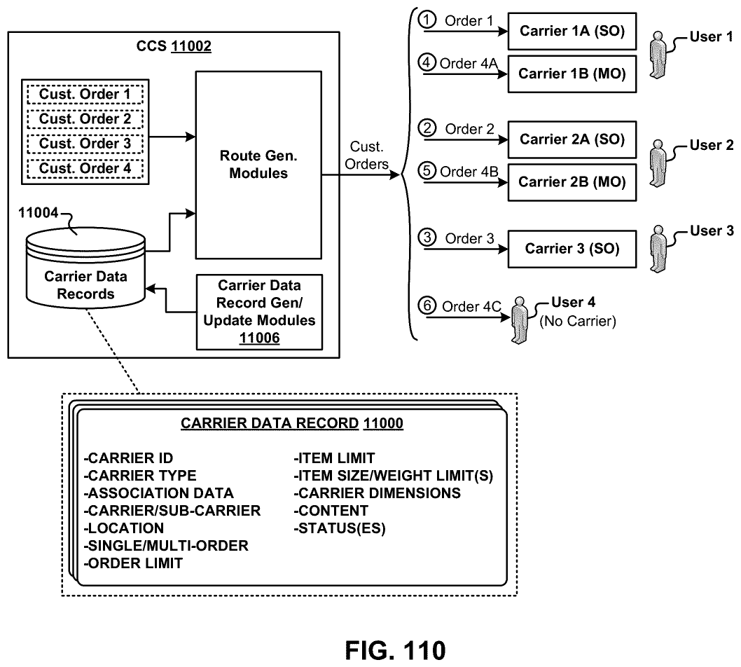

In some implementations, carriers may be associated with carrier data structures. For example, carriers may have carrier data records (e.g., see carrier data record 11000 if FIG. 110) that are stored/updated by the CCS/TPCS. The carrier data records may include data associated with carriers that are being used for picking and/or packing.

Carrier data records may include carrier IDs that identify the carrier. In some implementations, the carrier IDs may be unique IDs that uniquely identify the carriers. In some implementations, carrier records may include a carrier type data field that indicates the type of carrier. Example carrier types described herein may include, but are not limited to, carts, tubs, bins, boxes, packs, bags, cart shelves, etc. In some implementations, the carrier data records may include association data that indicates associated users, MSDs, other carriers, or other association data described herein. In some implementations, the carrier data record may indicate whether the carrier is a main carrier or a sub-carrier.

In some implementations, carrier data records may include location data. For example, the carrier data records may indicate the current location of the carrier in terms of any of the location descriptions described herein (e.g., GPS, location value, last item scanned, etc.). In one example, the carrier location may be specified in terms of location values (e.g., determined based on location indicators). In another example, carrier location may be specified in terms of GPS coordinates (e.g., inside/outside of the store or out for delivery). In some implementations, the location of the carrier may be defined in terms of storage locations, such as a location (e.g., a rack or corral) used to store carriers in the store (e.g., in the customer area or packing area). Carrier location data may also include additional data indicating whether the carrier is in a storage location, moving, or at a destination location in the packing area or a drop-off location.

In some implementations, carriers may be used to hold items for a single customer order (e.g., a complete/partial customer order). In some implementations, carriers may be used to hold items for multiple customer orders (e.g., multiple complete/partial orders). A carrier that is used for a single customer order (e.g., complete/partial order) may be referred to as a “single-order carrier.” A carrier that is used for multiple customer orders (e.g., complete/partial orders) may be referred to as a “multi-order carrier.” In some implementations, the order limits associated with carriers may be modified during/after picking customer orders. For example, a single-order carrier may be transitioned to a multi-order carrier during/after picking the initial single order.

In some implementations, the carrier data records may include an order limit number that indicates the number of different customer orders that may be placed into the carrier. If the carrier is a single-order carrier, the carrier data record may include a value of ‘1.’ If the carrier is a multi-order carrier, the carrier data record may include a value of ‘2’ or greater. In some implementations, a carrier may not include an order limit, such as when an unlimited number of orders may be placed in the carrier.

In some implementations, the carrier data records may include an item limit value that indicates the number of items that may be placed into the carrier. In some implementations, the carrier data records may include item size and/or weight limits that indicate the size and/or weight limits of the carrier. Example size limits may include item dimension limits and/or volume limits. In some implementations, the carrier record data may include carrier dimensions. In some implementations, the CCS may include item size/weight data for stocked items. In some cases, the CCS may be configured to limit the assignment of items based on the item number and/or item size/weight limits. For example, the CCS may refrain from assigning too many items for a user's carriers and/or assigning items that are individually or collectively greater than the item size/weight limits for the carriers.

In some implementations, the carrier data records may include carrier content data. The carrier content data may indicate the items included in the carrier. The carrier content data may also indicate the customer orders (e.g., order IDs) included in the carrier and whether the customer orders are partial or complete.

In some implementations, the carrier data records may include additional data that defines the status of the carriers. For example, a carrier record may indicate that the carrier is “out of use” if the carrier is resting in a location and waiting to be picked up and used for picking/packing. As another example, a carrier record may indicate that the carrier is “in transit with a picker” if the carrier is currently being used by a picker. As another example, a carrier record may indicate that the carrier is being “used for packing” to indicate that the carrier is being used for packing. As another example, a carrier record may indicate that the carrier is “in transit with a driver” to indicate that the carrier is with a driver being delivered. As another example, a carrier record may indicate that the carrier is “waiting for packing” (e.g., in a packing area) in order to indicate that the carrier has items to be packed.

The data structures and records described herein are only example data structures and records. As such, the example data structures and records described herein may vary, depending on the implementation of the OFS.

In some implementations, a store and/or third party may use specific carriers for specific purposes. For example, a store may use specific carrier types, sizes, and/or colors for picking specific types of orders, such as large orders, small orders, urgently needed orders, etc. The specific carrier attributes (e.g., item limits, order limits, etc.) may be represented in data at the CCS.

In some implementations, specific carriers may be used for specific purposes according to store policies. In these implementations, the specific carriers may be associated with carrier data (e.g., in a carrier data record) or may not be associated with carrier data. In these implementations, the CCS/TPCS may make assumptions regarding store policies and carrier usage (e.g., based on preset data included in the CCS, such as data entered by the operator of the CCS). For example, the CCS/TPCS may make assumptions regarding the type, size, and number of carriers used by a user. In a specific example, the CCS/TPCS may make assumptions regarding the number of items/orders a user may pick (e.g., according to a store policy). In one example, a picker may use a default carrier (e.g., a cart) for picking. In this example, the CCS/TPCS may make assumptions regarding the number of items/orders a user may pick using the default carrier. In one example, the store may use carts with a single large compartment for picking. As another example, a store may use a cart with a plurality of tubs for picking.

In some implementations, specific carriers with specific intended uses may be visually identifiable by users. For example, specific carriers with specific uses may be identified visually by carrier type (e.g., cart, tub, basket, backpack), size, color, attached labels/tags, colored tape, written text/symbols (e.g., text indicating carrier use and item/order limit), and/or other visual identifiers. In a specific example, a main order carrier (e.g., a shopping cart) may be used for picking single customer orders. In this example, another type of carrier (e.g., a smaller basket) may be used for picking one or more smaller orders according to store policies. In some implementations, the GUIs (e.g., picking GUI, packing GUI, etc.) may indicate the visually identifiable nature of the carriers. For example, the carriers in a carrier selection GUI may include colors/highlights corresponding to a carrier color. As another example, picking and packing GUIs may include colors/highlights that match the carrier colors.

In some implementations, users may modify the carriers according to their intended use. For example, a user may add a marker to the carrier, such as a tag, flag, sticker, or other object that indicates the carrier is a single-order carrier or multi-order carrier. In some implementations, a user may add a modification that includes a barcode, RFID, or other indicator that indicates specific properties of the carrier, such as whether the carrier is a single-order carrier, multi-order carrier, etc.

In some implementations, single-order carriers and multi-order carriers may be visibly identifiable by users, as described herein. For example, single-order carriers and multi-order carriers may be identifiable as different carrier types, different sizes, different colors, different attached labels/tags, different written text/symbols, and/or other visual identifiers. In one example, a single-order carrier may have a first label that indicates the carrier is a single-order carrier. In this example, a multi-order carrier may have a second label that is different than the first label, where the second label indicates that the carrier is a multi-order carrier. In some implementations, a user (e.g., a picker) may label the carrier before use. In other implementations, the store may have preconfigured carriers that indicate whether they are single-order carriers or multi-order carriers. For example, single-order carriers and multi-order carriers may have different colors, labels, and/or tags that indicate the number of orders they may include. In some implementations, the store may have preconfigured carriers and/or other carrier modifications that indicate any of the carrier properties described herein, such as order limits, item limits, and other carrier properties.

Using visibly identifiable carriers may help pickers immediately identify the carriers they should use for picking orders. For example, if the picker has been assigned a specific order, the picker may easily identify the proper number and size of carriers to use. Additionally, visibly identifiable carriers may indicate relevant information to packers. For example, the visually identifiable carriers may indicate whether a carrier includes a single order or multiple orders. There may be special places in the packing area for the different carriers with different properties, such as a designated place for single-order carriers and multi-order carriers.

In some implementations, the store may include one or more empty carrier storage areas that store carriers for use by pickers. The empty carrier storage areas may include racks, corrals, and other objects for holding the empty storage carriers. In some implementations, the empty carrier storage area(s) may include areas of the store floor in which carriers are placed and/or stacked. Users may acquire the empty carriers prior to picking customer orders.

In some implementations, the carriers may be stored based on expected carrier usage. For example, single-order carriers may be stored in the same area. In this example, multi-order carriers may be stored in another area (e.g., another floor space or cart corral), such as an area next to the single-order carriers.

In some implementations, the packing area may include specific areas for specific carriers. For example, the packing area may include a specific single-order carrier area for placement of single-order carriers after being used for picking. In this example, the packing area may include a separate area for placement of multi-order carriers after being used for picking. Having preset locations for carriers may assist the pickers in easily placing the carriers after picking orders. Having preset locations for carriers may assist the packers in easily identifying the general location of carriers/orders when packing orders.

In some implementations, a user may take empty carriers for picking according to store policy and/or their own estimated picking needs (e.g., for an assigned order). For example, a store policy may dictate that the user takes one or more specific types of carriers to pick orders, such as a cart and/or one or more tubs. In another example, the user may receive a customer order and determine the type and number of carriers they should take for picking the order.

In some implementations, the CCS may recommend the type and number of carriers that the picker should take with them to pick one or more orders (e.g., in an MSD GUI). For example, if the CCS assigns a single complete/partial order to the picker, the CCS may recommend to the picker that they take one or more carriers capable of carrying the entire complete/partial order. In another example, if the CCS assigns multiple orders to the picker, the CCS may be configured to recommend that the user take one or more separate carriers for each of the orders. In another example, the CCS may determine whether the picker should take one or more single-order carriers and/or one or more multi-order carriers based on a number of different customer orders being assigned to the picker. In some implementations, the CCS may instruct the picker to take a single-order carrier for a single customer order along with one or more multi-order carriers in case additional items are assigned while picking the single customer order. In these implementations, the CCS may instruct the picker to take additional carriers based on a variety of factors, such as a number of outstanding orders, a number of expected incoming orders (e.g., based on historic order volume at the time of day), a number of outstanding items (e.g., unpicked items in current customer orders), etc. The CCS may determine which carriers should be used based on the number of items in one or more orders to be assigned to the picker, the size of the items, the size of the largest items, and other factors.

In some implementations, a picker may indicate carrier(s) they are using to the CCS. In one example, the user may confirm that they are selecting the carrier(s) instructed by the CCS. In another example, the user may manually enter and/or scan carriers to indicate the carrier(s) they are using to the CCS. Indicating an incorrect carrier may result in the CCS correcting the user with a message (e.g., “incorrect carrier”) and/or (“incorrect number/type of carrier for the order”).

In some implementations, a user may manually input the number and type of carriers into an MSD GUI and indicate whether they are single or multi-order carriers. For example, the GUI may include a selection menu for selecting carrier types, numbers, single/multi order, and other carrier parameters. In some implementations, a carrier ID can be scanned on a carrier that indicates properties of the carrier, such as carrier type, single/multi order, etc. In some implementations, the MSD may include a camera that can acquire an image of a carrier and recognize the carrier type and other carrier data. In some implementations, the store may be instrumented with cameras or other devices that automatically detect the carrier(s) being used and the properties associated with the carriers. In some implementations, the user may control which carriers are single order or multi-order (e.g., in an MSD GUI).

FIG. 110 illustrates an example CCS 11002 that may assign items/orders to pickers (e.g., picker MSDs) based on the one or more carriers associated with the pickers. In FIG. 110, carriers may be single-order carriers (SO) or multi-order carriers (MO). User 1 and user 2 are each using a single-order carrier and a multi-order carrier. User 3 is using a single-order carrier. User 4 does not have a carrier. The CCS 11002 includes a carrier data record data store 11004 that includes carrier data records. The carrier data records may include the carrier data described herein, such as carrier ID, carrier type, carrier contents, whether the carrier is a single-order carrier or a multi-order carrier, etc. The CCS 11002 may include carrier data record generation/update modules 11006 that generate and update the carrier data records.

In FIG. 110, the CCS 11002 receives four customer orders. The CCS 11002 (e.g., route generation modules) may assign complete/partial customer orders to the pickers based on the carriers associated with the pickers. In FIG. 110, the CCS 11002 may be configured to assign complete customer orders to users that have single order carriers. For example, the CCS 11002 assigns customer order 1 to user 1 that is associated with single-order carrier 1A. As another example, the CCS 11002 assigns customer order 2 to user 2 that is associated with single-order carrier 2A. As another example, the CCS 11002 assigns customer order 3 to user 3 that is associated with single-order carrier 3.

After assignment of customer orders 1-3, the CCS 11002 has a remaining customer order 4 to assign. There are no single-order carriers available for items from order 4 because the single-order carriers already include items from other orders. Accordingly, the CCS 11002 may choose to assign items from order 4 to other pickers/carriers. The CCS 11002 may split order 4 in a variety of ways. In some implementations, the CCS 11004 sends portions of order 4 to available carriers up to the item number/size limit of the carriers. For example, the CCS 11004 may assign items from order 4 to carrier 1B until carrier 1B is full. Then, the CCS 11004 may assign items to carrier 2B until carrier 2B is full. The CCS 11004 may then assign items from order 4 to user 4 (e.g., a few hand-held items) if needed. In some cases, the CCS 11004 may increase picking efficiency by splitting items from customer order 4 to the multi-order carriers based on the location of the carriers (e.g., MSD/user location). For example, the CCS 11004 may assign items to multi-order carriers that are near the multi-order carrier users and/or on, or near, a route being traversed by the users while picking currently assigned orders. In a specific example, the CCS 11004 may assign items from customer order 4 to user 1 if user 1 is currently, or will be, near the items from customer order 4 while picking order 1.

Although the complete customer orders 1-3 are assigned to single-order carriers in FIG. 110, in some implementations, single-order carriers may not receive a complete (i.e., entire) customer order. For example, a complete customer order may be too large for single-order carrier(s) associated with a single user. As another example, it may be inefficient for a single user to pick all items from a complete customer order, especially in the case that the items in the complete customer order are dispersed throughout the store. In this example, it may be more efficient for the CCS to assign a first set of items from a customer order to a single picker, and then assign the remaining items to other pickers based on other factors described herein (e.g., item locations). As such, a single customer order may be split among a plurality of single-order and/or multi-order carriers in some cases (e.g., for large orders and/or other efficiency-based factors, such as item locations).

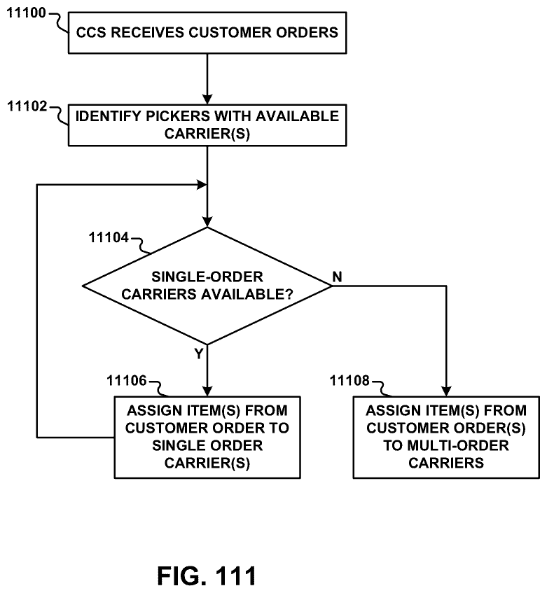

FIG. 111 illustrates an example method that describes features of a CCS that may assign items to pickers (e.g., picker MSDs) based on the carriers associated with the pickers. The CCS of FIG. 111 may prioritize assigning complete customer orders to single-order carriers first. The CCS may then split up other orders into multi-order carriers. In the case of FIG. 111, the CCS may also be configured to assign as many items (e.g., all items) as possible to pickers. The example CCS described in FIG. 111 is only an example CCS. As such, other CCSs may be configured to assign items based on other factors.

In block 11100, the CCS receives a plurality of customer orders. In block 11102, the CCS identifies a set of candidate pickers with one or more carriers that are available for new item assignments. In block 11104, the CCS determines whether there are any single-order carriers available for the received customer orders. If one or more single-order carriers are available, the CCS may assign one or more items from one or more of the received customer orders to the single-order carrier(s) in block 11106 (e.g., the CCS may assign items to the MSDs associated with the carriers). For example, the CCS may assign a complete/partial customer order to each of the single-order carriers. If single-order carriers are not available (e.g., each is being used for a customer order), the CCS may assign items from the customer orders to multi-order carriers in block 11108. In block 11108, the assignment of items to the carriers may also be performed according to other constraints associated with the carriers, such as item number limits, item size/weight limits, and order limits.

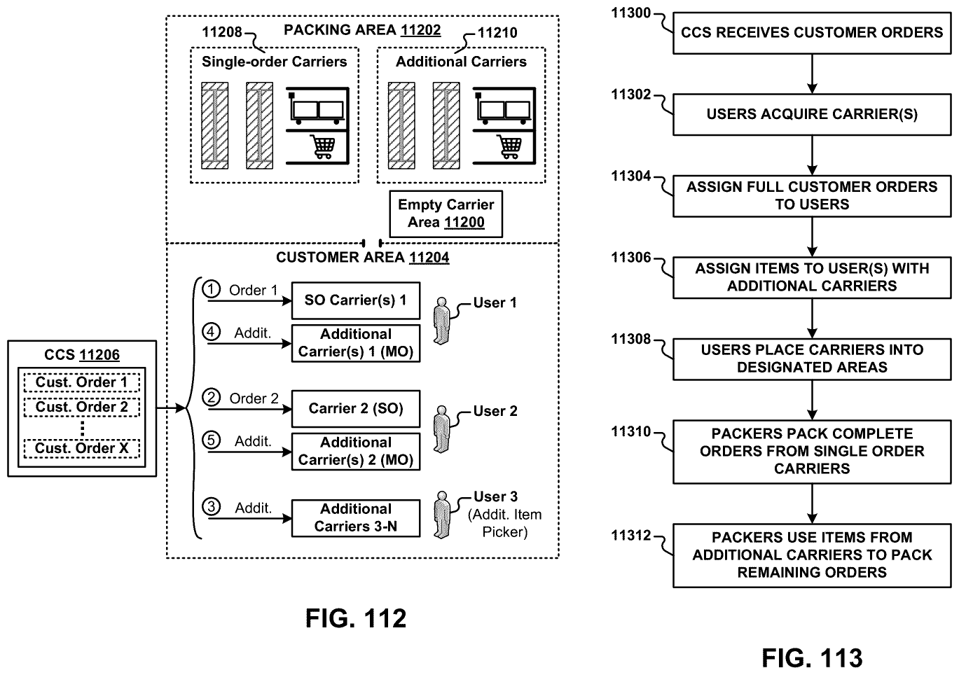

FIG. 112 illustrates an example implementation of an order filling system using picker data and/or carrier data described with respect to FIGS. 108-111. In FIG. 112, users 1-3 (e.g., pickers) acquire carriers from an empty-carrier area 11200, which may be included in a packing area 11202 or other area(s) of the store (e.g., one or more areas where pickers start routes, such as in the customer area 11204). In some implementations, the empty-carrier area 11200 may include stacks of empty carriers (e.g., stacks of baskets, tubs, etc.), corrals of empty carts, or other groups of empty carriers. The pickers may acquire empty carriers from the empty carrier area 11200 before picking.

The acquisition of carriers may be implemented in a variety of ways. In some implementations, store policy/procedures may be used by a picker to decide which carriers to take for picking. In one example, pickers may use a specific set of one or more carriers to pick orders according to store policy. In a specific example, pickers may use a cart provided by the store to pick orders. In another specific example, pickers may use a push cart with one or more tubs to pick orders according to store policy. The pickers may be trained to use one or more different configurations of carriers when picking items. For example, pickers may be trained to use a cart for picking large orders (e.g., greater than a threshold order size) and use a small basket for picking smaller orders (e.g., less than a threshold order size).

In some cases (e.g., in FIG. 112), some users may use larger single-order carriers (e.g., carts with tubs) to hold main orders. In this example in FIG. 112, the users may also take one or more other additional carriers to pick up small numbers of items (e.g., small orders and/or portions of other orders) that they are able to efficiently pick because of their path/trajectory while picking the larger order.

In some implementations, a picker may take carriers according to the customer order(s) to be picked. In some cases, an MSD may display a number of items in a customer order to be picked so that the picker can decide which carriers to take. Additionally, the CCS may calculate, and the MSD may display, the size/weight of the items in the customer order to the picker. The picker may take one or more carriers based on the item number, size, weight, and/or other properties, which may be displayed to the user in the MSD interface prior to picking the order. In some implementations, the picker may use their knowledge of the carriers to determine their needs for a customer order. For example, the picker may select the proper carrier types and sizes to pick the customer order. In some cases, a picker may take additional carriers to accommodate additional items that may be assigned while picking the currently assigned customer order(s).

In some implementations, the CCS may determine the carriers that were taken by the picker. In some examples, the picker may enter the carriers into the MSD interface to indicate which carriers are being used for picking. For example, the picker may indicate the carrier type and number of carriers being used for picking. In some cases, the MSD may generate a menu that lists carriers (e.g., types/numbers) for manual selection by the picker. In some implementations, the picker may use the MSD to scan the carriers they are taking for picking. For example, the picker may use the MSD to scan a carrier ID (e.g., barcode or RFID) they are taking for picking items. In another example, the picker may scan a carrier in another manner to indicate they are taking the carrier. In a specific example, the MSD may include a camera that acquires an image/video of one or more carriers for automatic carrier type detection via image processing at the MSD/CCS. Although a picker may scan the carriers upon taking the carriers from the empty carrier area, the picker may also take carriers with them for picking and scan them while picking items.

In some implementations, the store may be instrumented to detect the carriers taken by the picker. For example, the empty carrier area 11200 may detect the removal of carriers (e.g., from stacks, corrals, etc.). As another example, the store may include carrier scanners (e.g., image acquisition devices, barcode scanners, RFID scanners, etc.) that scan carrier IDs and/or other carrier properties to determine the carriers being used by pickers. The CCS may learn from devices in the store (e.g., empty carrier area or other areas) which carriers are being used by a picker at the time the carriers are taken from the empty carrier area or after (e.g., while being moved along a route and being used for picking).

In some implementations, some carriers (e.g., smart carriers, such as smart carts) may be configured to indicate to the CCS/MSDs that they are being used for picking. For example, a carrier that is moved throughout the store may include onboard electronic devices that determine that it is being used for picking. Example devices may include devices that detect movement (e.g., accelerometers) or a change in location using any of the technologies described herein. Detecting a change in location at the carrier may indicate that the carrier is currently being used for picking. A smart carrier (e.g., a carrier implemented with devices to detect location and communicate) may report movement and the carrier ID to the CCS to indicate to the CCS that the carrier is being used for picking. In some implementations, carriers may include MSD functionality, such as user interface devices, that can receive user input indicating that the carriers are being used for picking. For example, a user may acquire a carrier (e.g., a smart cart) for picking and interact with a user interface (e.g., a touchscreen, on button, and/or other interface) to indicate that the user will be using the carrier for picking. In some implementations, a carrier may also include devices that detect other carriers (e.g., sub-carriers) being used to pick. For example, a cart carrier may include electronic devices that may scan other sub-carriers on/in the cart (e.g., barcodes, RFIDS, etc. on the sub-carriers) to identify the associated sub-carriers. In some implementations, carriers may also detect the user automatically. For example, the carriers may detect a user RFID/readable code, acquire an image of the user (e.g., an image for facial recognition), acquire a user biometric reading (e.g., a fingerprint reading), and/or automatically identify the user in another manner. The carriers may also automatically detect the items being placed into the carriers (e.g., using cameras, RFID readers, barcode scanners, and/or other item detection technology).

In some implementations, the CCS/MSDs may intelligently display the customer order(s) to be picked in a manner that allows the picker to make an informed decision as to which carriers to take. For example, the MSDs may provide a preview of the customer order to be picked on the MSD display. Example preview data that may be used by the picker may include, but is not limited to, number of items, sizes of items (e.g., general size ranges and number of items in the ranges), weight of the items (e.g., general weight ranges and number of items in the weight ranges), size of the largest items in the customer order, maximum lengths/widths/heights of the items, and other data.

In some implementations, the CCS/MSDs may provide suggestions to the picker regarding the carrier(s) they should take for picking an order. Recommendations may be based on: 1) largest item dimensions (e.g., largest dimensions may determine minimum size carrier dimensions), 2) total volume of items (e.g., indicates a minimum volume of all carriers), 3) weight of items (e.g., heavier items may require different carriers, such as wheeled carts instead of hand held baskets), 4) specific items may require the use of specific carriers (e.g., lumber sizes may require specific carriers, such as a special cart for plywood), 5) there may be a limited set of carriers a picker may use, which may cause the CCS/MSDs to instruct the user to take carriers based on a threshold decision (e.g., if there is a large carrier cart and a small handheld basket for picking, the CCS may instruct the picker to use the basket for small sized orders in number/dimensions/weight, otherwise use a cart), and 6) a specific CCS-determined set of carriers for carrying specific corresponding items in a customer order (e.g., the CCS may instruct the picker to place specific items into specific carriers).

The store in FIG. 112 may operate according to some policies/procedures regarding the number of orders pickers may pick, how the pickers use carriers, how the pickers place carriers in the packing area 11202, and how the packers pack the customer orders. The store procedures of FIG. 112 may simplify the picking and packing process, as described hereinafter. The CCS/MSDs may be configured to implement the store procedures described with respect to FIG. 112.

In FIG. 112, pickers may take single-order carriers for picking a single main customer order. A main customer order may refer to a customer order that is the focus of picking. For example, a picker may focus on picking most/all of the main customer order. In some cases, a majority of the items picked may be for the main customer order.

The pickers may also take one or more additional carriers for use in picking items that are not included in the main order. The additional items may refer to portions of one or more additional customer orders that a picker may pick while focusing on the main customer order. For example, the picker may occasionally pick items for one or more additional customer orders while focusing on the main order.

User 1 and user 2 may each have one or more single-order carriers and one or more additional carriers. User 1 and user 2 may each receive a main customer order to pick. In addition, the CCS 11206 may assign additional items to user 1 and user 2 before, while, and/or after picking the main orders. For example, user 1 may receive a first main customer order to pick. While picking the first main customer order, the CCS 11206 may assign additional items to user 1 (e.g., items from other orders). For example, the CCS 11206 may assign a smaller number of items that user 1 may easily pick because the items are on/near the route for user 1 while picking the first main customer order. In this example, user 2 may be assigned a second main customer order along with additional items. User 1 and user 2 may pick their assigned main customer orders and place the orders into their single-order carriers. User 1 and user 2 may place the additional items from one or more customer orders into their additional carrier(s).

In FIG. 112, user 1 and user 2 may prioritize picking their main customer orders and occasionally pick additional items. This may allow user 1 and user 2 to focus on properly picking the main customer orders while also increasing picking efficiency by occasionally being only slightly burdened with the additional items.

User 1 and user 2 may have one or more additional carriers that the users may use to hold additional items on/near their routes. In some implementations, the one or more additional carriers may be visibly different than the carriers for the main orders. For example, the additional carriers may be different types of carriers, have different colors (e.g., solid colors, color patterns, etc.), have different labels, flags, badges, or be visibly distinguishable from the main order carriers in other manners. The visibly different carriers for additional orders may simplify the picking process for user 1 and user 2 when picking orders. For example, user 1 and user 2 may only need to focus on placing a single main customer order in their single-order carrier(s) while less frequently placing additional items into the visibly different additional carriers. In some cases, specific types of carriers (e.g., single-order carriers or multi-order carriers) may have specific IDs that indicate their properties. In one specific example, a picker may have a first set of tubs for a main order and a second set of tubs for additional orders. In this specific example, the first set of tubs may have a first color and the second set of tubs may have a second color, where the colors clearly indicate which tubs are associated with main/additional orders. In another specific example, a picker may have a shopping cart for the main order. In this specific example, one or more smaller baskets may attach to the cart and be used for additional items.

In FIG. 112, user 3 may pick items from a plurality of different orders. For example, user 3 may pick portions of customer orders that are the main customer orders assigned to user 1 and user 2 in the case that the portions of the main customer orders for user 1 and user 2 may not be efficiently picked by user 1 and user 2. This may be the case if the items are not easily integrated into routes for user 1 and user 2. User 3 may also pick small orders (e.g., less than a threshold number of items). For example, user 3 may pick orders of less than a few items.

The CCS 11206 may be configured to assign small portions of different orders to user 3. Additionally, or alternatively, the CCS 11206 may also be configured to assign small customer orders to user 3 (e.g., orders having less than a threshold number of items). User 3 may act as an additional item picker and/or small order picker. User 3 may carry additional carriers (e.g., carriers 3-N), which may be multi-order carriers or, in some cases, small single-order carriers. User 3 may focus on quickly and efficiently picking items for placement in the packing area 11202. In some cases, assigning small portions of orders to user 3 may help more efficiently finish off larger orders outside of the routes of user 1 and user 2. Additionally, user 3 may pick one or more small orders on their route, where such orders may not be large enough to act as the focus of an entire picking route.

In some implementations, the CCS/MSDs may instruct user 3 to place specific items in specific carriers. For example, the CCS/MSDs may be configured to separate some items in different orders from one another. As another example, the CCS/MSDs may be configured to separate the small orders into their own carriers (e.g., small baskets). In some implementations, the additional item picker (user 3) may not be restricted to the use of specific carriers (e.g., specific carrier IDs) for specific items. For example, user 3 may have a single large cart (e.g., a shopping cart) that user 3 uses for all of the picked items. As another example, user 3 may have multiple bins that user 3 may use for any of the items. The picking task for user 3 may be simplified by allowing user 3 to use any of the additional carriers while picking. However, packing items in the packing area 11202 that were picked by user 3 may require more searching within the specific carriers. The picking task for user 3 may be slightly more complicated if user 3 is required to place items in specific carriers. However, in this case, packing items in the packing area 11202 that were picked by user 3 would be simplified, as the packer may not be required to search through items that are not relevant to their order to be packed. In some implementations, additional pickers (e.g., user 3) may use specific MSDs that are reserved for picking additional items.

FIG. 113 illustrates a method that describes example operation of the OFS illustrated and described with respect to FIG. 112. In block 11300, the CCS 11206 receives a plurality of customer orders. In block 11302, users acquire carriers for the orders. For example, users 1-3 may acquire carriers according to the techniques described herein. In block 11304, the CCS 11206 may assign full customer orders to user 1 and user 2 for the single-order carriers. In block 11306, the CCS 11206 may assign additional items to one or more of the users for the additional carriers, as described herein. In block 11308, the users may pick the assigned items and place the carriers into designated areas in the packing area 11202. For example, the users may place the single-order carriers into a single-order carrier area 11208 in the packing area 11202. As another example, the users may place the additional carriers in an additional carrier area 11210 in the packing area 11202. In block 11310, packers may pack complete customer orders from single-order carriers. In some cases, the packers may need to acquire a few items from the additional carriers. In block 11312, the packers may also use items from one or more additional carriers to pack the remaining complete orders. Some items may remain in the packing area (e.g., in the additional carriers) in the case that the items will be used for future packed orders that have not yet been fully picked or that are not needed at the present time for customer/driver pickup.

In addition to store policy as to the usage of specific carriers for single or multiple orders (e.g., specific colors, sizes, etc.), some users may scan items and carriers while picking items to indicate which carriers include specific items. For example, a user may scan an item and then scan a carrier, or vice versa, to make the association between the item and the carrier. In some cases, an MSD may indicate in a GUI that the user should scan a carrier and/or item to indicate the association while picking.

In some implementations, the CCS may assign customer orders to pickers according to assignment rules that are based on a picker/carrier order limit. For example, the CCS may preferentially assign customer orders first to pickers that have availability for accepting the complete customer order, or nearly complete customer order (e.g., within a threshold number of items for completion). Preferentially assigning a complete customer order, or a nearly complete customer order, to a single picker may help maintain more organized picking and packing of the customer order because the single picker may focus on the customer order while picking. Additionally, the picker may place an entire customer order in a single location for easy identification and packing by the packer. If a nearly complete customer order is assigned (e.g., less a few items) to a picker, the picker may still focus on picking the single order. In this case, the packer may be required to collect a few additional items in the packing area. In cases where single order carriers are larger than multi-order carriers, the CCS may preferentially assign customer orders to single order carriers first, followed by multi-order carriers. In some implementations, the CCS may be configured to restrict the assignment of customer orders to pickers that are available to pick the entire customer order (e.g., based on order limits and/or item limits).

In some implementations, the CCS may be configured to preferentially assign smaller orders (e.g., less than a threshold number of items) in a variety of ways. For example, the CCS may preferentially assign smaller orders to pickers that have additional carriers. In a specific example, the CCS may preferentially assign the smaller orders by assigning them first to pickers with available additional carriers (e.g., carriers not used for a main larger order).

In some implementations, the CCS may be configured to minimize the number of items from a customer order that are assigned as additional items to additional carriers (e.g., after the main portion of the customer order is assigned). For example, the CCS may be configured to assign as many items of a customer order as possible to a single-order picker with availability. In a specific example, the CCS may be configured to assign the largest customer order (e.g., most items and/or largest volume) to the picker that may have the most availability to pick the largest customer order (e.g., a picker with larger/more carriers). Additionally, or alternatively, the CCS may also be configured to split a customer order between the fewest number of pickers.

Item assignments to single-order and multi-order pickers/carriers may also be influenced by any other factors described herein. For example, the CCS may take into account picker location when assigning orders to a single-order picker. In a specific example, if multiple single-order pickers are available to receive a complete customer order, the CCS may assign the complete customer order to the picker that may pick the customer order most efficiently with the least amount of movement (e.g., based on their current location). Similarly, the CCS may assign partial orders (e.g., remaining items) to multi-order pickers/carriers that may most efficiently pick the partial order (e.g., based on their current location). In some cases, the CCS may prioritize the location of the picker first, then assign items to the picker that maximize the picker's availability (e.g., assign a maximum number of orders and/or items).

In some implementations, the CCS may use picker data and/or carrier data as one factor in a multi-factor decision process when assigning orders and generating routes for pickers. For example, the CCS/MSDs may be configured to generate routes based on any of the picker data and carrier data described herein, such as: 1) item limits, 2) order limits, 3) picking restrictions, etc. In addition to any of the picker data and carrier data, the CCS/MSDs may generate routes based on other factors described herein, such as the location of items relative to the picker and/or the future picker's path.

In some implementations, the CCS may be configured to split customer orders based on the timing of when a customer order is needed for customer/driver pickup and/or other priority factors (e.g., split an order if splitting will reduce picking time to meet customer/driver pickup requirements). In some implementations, the CCS may prioritize the assignment of additional items to pickers based on an estimated time at which the picker will reach the packing area. For example, the CCS may assign items to a picker that will likely reach the packing area first.

In some implementations, the CCS may be configured to limit the number of items/orders assigned to a user without a carrier. For example, the CCS may limit the assignment of items to an amount that can be carried by hand. In some implementations, the CCS may limit a total number of assigned items (e.g., 5 or less). Additionally, or alternatively, the CCS may be configured to limit the sizes of the items and/or the weight of the items to an amount that can be carried by a person (e.g., limit the item max dimensions, volume, and/or weight).

In some implementations, the CCS may be configured to assign items to a picker based on current carrier contents, such as the item types of the current contents. For example, the CCS may be configured to assign frozen/refrigerated items to a picker that has already picked frozen/refrigerated items. Similarly, the CCS may be configured to assign non-frozen/non-refrigerated items to a picker that has not picked frozen/refrigerated items.

Pickers may place carriers with different properties in the packing area. For example, pickers may place different types of carriers in the packing area that are either single-order carriers or multi-order carriers. Single-order carriers may include partial/complete single orders. Multi-order carriers may include one or more partial/complete orders. In some implementations, pickers may place individual items in the packing area (e.g., without carriers).

In some implementations, the packing area may include designated areas for single-order carriers and multi-order carriers. In some implementations, the packing area may include different designated areas for different types of carriers (e.g., carts, bins, etc.). For example, a single-order carrier area may have different areas for different types of carriers (e.g., bins, carts, etc.). As another example, a specific area for a single type of carrier (e.g., carts) may have different sub-areas for single-order carriers and multi-order carriers. In some implementations, the different areas may be associated with different data (e.g., location values) that indicate (e.g., explicitly indicate) the types of carriers, whether the carriers are single-order or multi-order carriers, along with other carrier properties. The different types of areas may be visibly marked (e.g., with text, colors, etc.) to indicate the use for the different areas to pickers and packers. The different areas described herein may be referenced in the MSD GUIs (e.g., indicated to pickers, packers, and/or drivers in MSDs).

In some implementations, pickers may indicate the location of the items/carriers being placed in the packing area. For example, the pickers may scan location indicators associated with the locations before placing items/carriers in the locations. As another example, the pickers may indicate the locations of the items/carriers in an MSD GUI. In a specific example, the picker may enter the items/carriers and their locations in an MSD menu, such as a menu that allows the picker to select locations (e.g., in a menu that allows the selection of racks, shelves, and specific spots, such as rack 1, shelf 2, spot 3).

In some implementations, the store may be instrumented with devices that automatically detect the location of the items/carriers placed in the packing area. For example, the store may include devices (e.g., cameras, scanners, etc.) that detect carrier barcodes/RFIDs, item barcodes/IDs, etc. The CCS may detect the placement of items and carriers on a per-item and per-carrier basis. In some implementations, the store may be configured so that the CCS may determine which locations in the packing area are empty. For example, the CCS may assume that a location in the packing area is empty if the CCS does not detect items/carriers in the location. As another example, the CCS may assume that a location is empty if the CCS has not instructed items/carriers to be placed in the location. As another example, the CCS may assume that the location is empty if the CCS has instructed a picker to place items in the location and the items/carriers have been subsequently removed for packing and/or customer pickup.

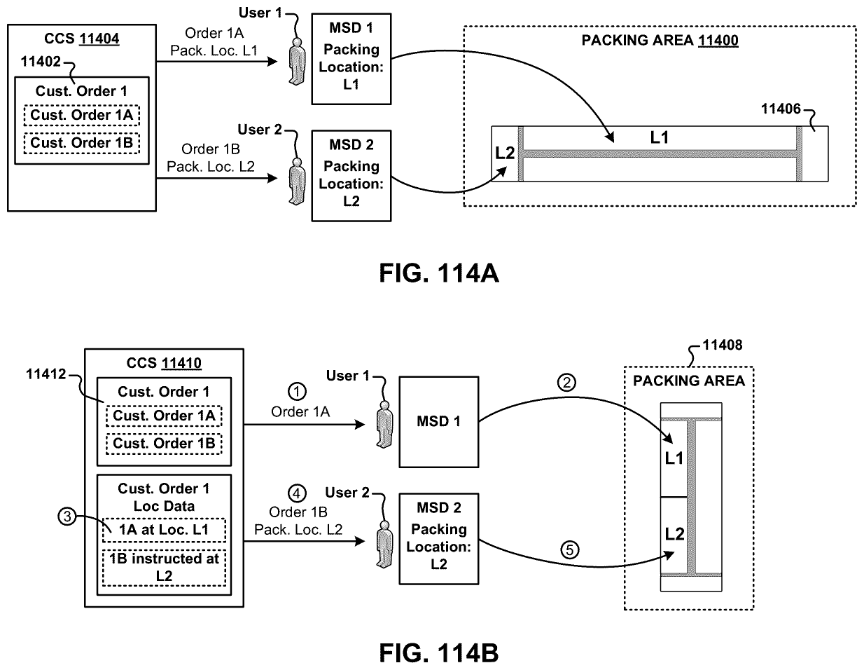

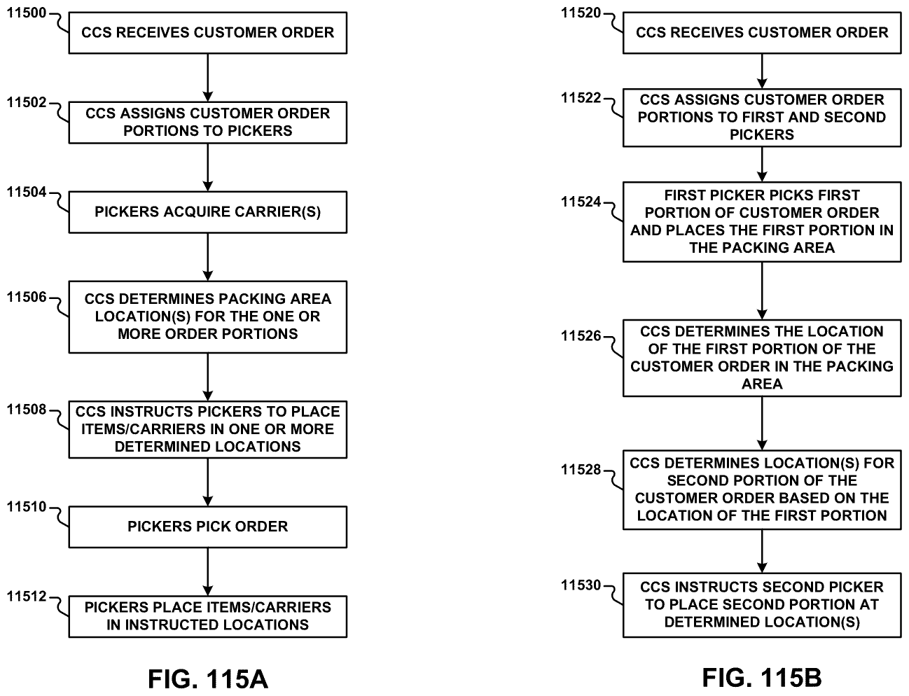

In some implementations, the CCS/MSDs may control the location of items/carriers in the packing area. For example, the CCS/MSDs may instruct the pickers to place items/carriers in specific locations in the packing area. FIGS. 114A-115B illustrate example techniques for instructing pickers where to place items in a packing area.

In some implementations, the locations in the packing area may be specified by description, such as names, numbers, letters, etc. For example, the locations may be specified by packing area aisle name/number, rack number, shelf number, corral number, bin number, etc. In some implementations, some locations may be associated with location indicators (e.g., location values). In some implementations, the locations may be specified relative to other items/carriers. For example, the CCS/MSDs may instruct a picker to place items/carriers near other items/carriers that are already placed in the packing area. In some implementations, the locations for the picked items may be specified as one or more carriers already placed in the packing area. For example, the CCS/MSDs may instruct pickers to place picked items into one or more carriers that are already placed in the packing area. The CCS/MSDs may instruct the pickers to place items in the packing area using one or more types of locations described herein. For example, the CCS/MSDs may instruct pickers to place a picked item/carrier into an already placed carrier in a specific packing area aisle name and rack number.

Dropping off items/carriers into suggested locations in the packing area may include dropping them onto bare locations (e.g., without items/carriers) or locations that already have items/carriers. For example, the user may place the items/carriers into another carrier already placed in the location. As another example, the user may place items/carriers among other items/carriers on a rack (e.g., in the same location). In some implementations, a picker may place items and/or carriers next to existing items and/or carriers in the same enumerated location (e.g., having the same location value) or a different enumerated location. Different locations in the packing area may be defined in terms of a single empty space on a shelf, in a bin, in a corral, or other location. In some cases, a single location (e.g., a single location defined by name and/or location indicator) may have one or more shelves, one or more bins, and/or one or more corrals. Different stores may be configured to implement different packing areas with different location schemes. In cases where a second picker is instructed to place items/carriers into another carrier (e.g., by a GUI), the second picker can confirm the item/carrier placement, such as by manually entering it in a GUI and/or by scanning the carrier into which the new items/carriers are placed. Note that the instructions to drop off items in the packing area may be updated in a GUI to include additional/different locations, such as in the case that items/carriers already in the packing area are moved or provided to a customer.

The CCS/MSDs may determine location suggestions/instructions for pickers before, during, and/or at the end of picking. The CCS/MSDs may instruct the pickers to place items/carriers in specific locations before, during, and/or at the end of picking. In some implementations, the CCS/MSDs may change the instructed/suggested locations for placement of items/carriers in the packing area based on a variety of factors described herein, such as a reorganization of the items/carriers in the packing area, additions/subtractions associated with an order, etc.

In implementations where a single order uses two pickers, the picker that will likely place items in the packing area first may be referred to as the “first picker.” One or more additional pickers for the same order that may place items into the packing area after the first picker may be referred to as “subsequent pickers” and/or according to their sequence (e.g., second picker, third picker, etc.).

In some implementations, the CCS/MSDs may instruct pickers to drop off carriers/items based on the current availability of space, such as available shelf space, available bins, available cart corrals, etc. The CCS/MSDs may determine available space automatically based on the CCS's knowledge of which locations in the packing area are currently occupied/unoccupied with items and/or carriers. For example, detection by the CCS of items/carriers in specific locations may indicate that the locations are not available. As another example, a lack of detection of items/carriers (e.g., a lack of items in images/scans) in a specific location may indicate to the CCS/MSDs that the location is open in the packing area. In some implementations, the CCS/MSDs may also determine that items/carriers are occupying locations in the packing area based on previous instructions to previous pickers indicating that the pickers should use the specific locations. In some cases, previous pickers may use picker MSDs to confirm when items are placed in the instructed locations. In some implementations, a lack of pending instructions to place items/carriers in specific areas may indicate that the specific areas are available for drop off. In some implementations, the CCS/MSDs may determine that a location is available in the packing area if a packer has packed the customer order in the area and provided it to the customer or delivery driver for pickup.

In some implementations, the CCS/MSDs may instruct pickers to drop off carriers/items based on the future availability of space. For example, the CCS/MSDs may determine that space will be available in the packing area as a result of an order being packed and/or provided to the customer/driver before the picker drops off the items/carriers. In a specific example, the CCS/MSDs may determine that currently unavailable space (e.g., space that currently includes items/carriers) will be available in the near future after the items/carriers are removed from the space (e.g., by a picker/packer).

In some implementations, the CCS/MSDs may instruct pickers to drop off carriers/items based on item/carrier dimensions and/or weights. For example, the CCS/MSDs may instruct pickers to drop off carriers/items in locations that have large enough dimensions and/or weight capacities to hold the items/carriers. In a specific example, some carriers may be reserved for specific types of locations (e.g., carts may be limited to corrals). In some cases, the CCS/MSDs may instruct pickers to drop off items/carriers based on item type (e.g., placing frozen items in a freezer location). As another example, food items may be separated from other item types (e.g., cleaning supplies, lawn chemicals, etc.). Separation by item type may result in some customer orders being split into two or more locations in the packing area. In some implementations, the GUIs may explicitly indicate to the pickers/packers the reason for splitting locations in the packing area. For example, the picking GUI may indicate that a first portion of the order be placed in a different location than a second portion because the portions are different types of items (e.g., refrigerated vs. non-refrigerated). Similarly, a packing GUI may indicate to a packer that a first portion of an order is in a different location than a second portion of an order because the first portion and the second portion include different item types.

In some implementations, the CCS/MSDs may be configured to place items in preferred locations. Subsequently, items may be placed in less preferred locations after the preferred locations are taken. For example, the CCS/MSDs may be configured to instruct pickers to place items near a location in which packers are typically located. For example, if packers typically begin packing locations near a specific location (e.g., near a specific rack or end caps of racks), the CCS/MSDs may instruct the pickers to place items in those preferred locations. As another example, if it is typically more efficient to pack items that are placed near a customer pickup location, the CCS/MSDs may instruct the pickers to place items/carriers near a customer pickup location.

In some implementations, different packing area locations may be assigned different levels of preference for item/carrier dropoff. For example, different packing areas may be associated with different preference levels (e.g., preference may be indicated by integers). In these implementations, the CCS/MSDs may assign drop-off locations first by preference. In some cases, the CCS/MSDs may split a single order if there is not room for all items/carriers in the same preferred location. In some implementations, the CCS/MSDs may attempt to group items from a customer order to the same/adjacent locations. In these cases, the CCS/MSDs may attempt to identify a single open space (and adjacent spaces if needed) for the complete customer order, and then select the highest preference area that can hold the complete customer order. In some implementations, the CCS/MSDs may instruct pickers to place higher priority orders in specific areas reserved for high priority orders. In some cases, areas for high priority orders may include preferred areas.

The CCS/MSDs may attempt to keep the items/carriers for a single customer order in a single location in the packing area. If a single location is not available for the items/carriers, the CCS/MSDs may attempt to identify multiple locations that are near one another (e.g., as near as possible). If multiple locations near one another are not available (e.g., within a threshold distance), the CCS/MSDs may then select locations that are as near as possible to one another in the packing area.

For a first picker picking a customer order, available space in the packing area may refer to a single location that can hold all of the items/carriers picked by the first picker for the customer order. As another example, available space in the packing area may refer to a plurality of locations in the packing area that are grouped together (e.g., contiguously) and that can hold the items/carriers for the customer order. As another example, for a first picker, available space may refer to a plurality of locations, some of which are separated from one another, but are nearby one another (e.g., within a threshold distance) to minimize effort required to pack the customer order.

For a subsequent picker (e.g., a second picker), available space in the packing area may refer to a single location that already includes picked items/carriers for the customer order. As another example, for a subsequent picker, available space in the packing area may refer to an already placed carrier into which the subsequent picker can place picked items and/or carriers. As another example, for a subsequent picker, available space in the packing area may be chosen as one or more locations next to (e.g., adjacent to) the location used by the first picker. In some implementations, the CCS/MSDs may be configured to identify one or more locations as near as possible to the items/carriers placed in the packing area.

The CCS/MSDs may modify the locations for items/carriers in the packing area in response to a variety of different scenarios. In some cases, the CCS/MSDs may modify the instructed/suggested location in response to new orders being received from additional customers that may more optimally use already instructed locations. In some cases, the CCS/MSDs may modify the instructed/suggested location(s) in response to additions to the customer order that may require additional space and/or additional carriers. In some cases, the CCS/MSDs may modify the instructed/suggested location in response to deletions from the current customer order. For example, if a customer removes items from the customer order, this may reduce the number of carriers and/or pickers used to pick the customer order, which may in turn reduce the amount of space and/or number of locations needed in the packing area. In cases where the CCS/MSDs monitor the availability of locations in the packing area, the CCS/MSDs may modify the instructed/suggested location in response to a picker/packer placing items in a previously open space selected by the CCS/MSDs for the customer order. For example, the CCS/MSDs may be required to change the location of the items/carriers for a customer order being currently picked.

In some implementations, the CCS may reserve locations in the packing area for items/carriers (e.g., next to an earlier picked portion of a customer order). In these cases, the CCS/MSDs may indicate to a picker that the spots are reserved for other items/carriers. In some implementations, the CCS/MSDs may correct a picker (e.g., in a GUI) that improperly places items/carriers in the wrong location, such as a location that was not suggested/instructed for the items/carriers or a location reserved for other items/carriers.

FIG. 114A illustrates an example OFS that instructs pickers to place items in the packing area 11400 in specific locations. In FIG. 114A, a single customer order 11402 is received by the CCS 11404. The CCS 11404 splits the customer order assignment into two parts (e.g., customer order 1A and 1B). The CCS 11404 assigns portion 1A and portion 1B to user 1 and user 2, respectively. The CCS 11404 may also provide packing location instructions to user 1 and user 2 for their picked portions. In FIG. 114A, the CCS 11404 assigns locations L1 and L2 to user 1 and user 2 (e.g., in MSD interface instructions) to indicate that user 1 and user 2 should place portions 1A and 1B in locations L1 and L2, respectively. In FIG. 114A, locations L1 and L2 are adjacent locations on a rack 11406 in the packing area 11400. Placing portions of customer order 1 in adjacent locations in FIG. 114A may simplify the collection and packing of the customer order. In some cases, user 1 or user 2 may collect and pack the customer order. In some cases, a packer may collect and pack the customer order.

The CCS 11404 may split the customer order in FIG. 114A and assign the portions to user 1 and user 2 according to any of the techniques described herein. The CCS 11404 may also instruct the users to place the items in locations L1 and L2 according to one or more of the factors described herein. For example, the CCS 11404 may assign the locations based on current/future availability of space, item type, etc. The CCS 11404 may assign the locations at a variety of times, such as before, during, or after picking. In some implementations, the CCS 11404 may determine the locations at different times. In some cases, the CCS 11404 may determine one of the locations first, then subsequently determine the second location. For example, the CCS 11404 may determine a first location for a user that will likely finish picking their portion first. Then, the CCS 11404 may determine the second location at a later time before, during, or after picking by user 2.

Although FIG. 114A illustrates user 1 and user 2 receiving the customer order portions and locations at the same time, the users may receive the customer order portions and locations at different times. For example, user 2 may be assigned portion 1B shortly after user 1 is assigned portion 1A. As another example, user 2 may be assigned portion 1B after user 1 is done picking portion 1A and placing the portion in the packing area. Also note that user 1 and user 2 may pick other customer orders for other locations while picking portions 1A and 1B.

Although the CCS/MSDs may indicate packing area locations for a split customer order to two separate users, as illustrated in FIG. 114A, in some implementations, the CCS may assign two portions of a single customer order to a single user at different times. In these implementations, the CCS may provide a first location (e.g., L1) to a first user for a first portion of the customer order. Furthermore, the CCS may provide a second location (e.g., L2) to the first user for a second portion of the customer order at a later time (e.g., after dropping off the first portion of the customer order). Although FIG. 114A illustrates two users, the CCS may split the customer order into greater than two portions and also assign greater than two locations in the packing area.

FIG. 115A illustrates an example method in which the CCS is configured to assign packing area locations to different pickers for a single customer order (e.g., as illustrated in FIG. 114A). In the method of FIG. 115A, the CCS may assign the packing area locations for the customer order portions prior to picking (e.g., at the time the order portions are assigned). In block 11500, the CCS receives a customer order. In block 11502, the CCS assigns portions of the customer order to different pickers. In block 11504, the pickers each acquire one or more carriers. In block 11506, the CCS determines one or more packing area locations for the items/carriers associated with the pickers. In block 11508, the CCS instructs the pickers to place their items/carriers in the one or more determined packing area locations. In block 11510, the pickers pick the customer order. In block 11512, the pickers place the carriers in the instructed packing area locations.

FIG. 114B illustrates an example OFS in which user 1 may place items/carriers in the packing area 11408 in any location, as user 1 sees fit. In FIG. 114B, the CCS 11410 instructs user 2 to place items/carriers based on the location of items/carriers placed by user 1. In FIG. 114B, a single customer order 11412 is received by the CCS 11410. The CCS 11410 splits the customer order assignment into two parts (e.g., customer order 1A and 1B). The CCS 11410 assigns portion 1A and portion 1B to user 1 and user 2, respectively.

In FIG. 114B, user 1 places portion 1A in location L1. The CCS 11410 determines the location of portion 1A. For example, the store may be instrumented to automatically detect placement of portion 1A. Additionally, or alternatively, user 1 may scan the location and/or manually enter the location into MSD 1 in order to notify the CCS of the location of portion 1A. In FIG. 114B, the CCS 11410 may determine a location for portion 1B based on the location of portion 1A, as described herein. The CCS 11410 may instruct user 2 to place the items/carriers of portion 1B in the same location and/or in one or more nearby locations, subject to available space in the packing area 11408. As illustrated in FIG. 114B, the CCS 11410 instructs user 2 to place portion 1B in location L2 adjacent to portion 1A in location L1. Allowing user 1 to place the order portion 1A freely in the packing area 11408 may simplify the workflow of user 1.

Although FIG. 114B illustrates the customer order being separated into two portions for two users, in some cases, the CCS may split a single order and assign the portions to a single user. In these cases, the CCS may instruct user 1 to place portion 1B based on where user 1 had placed portion 1A. Although FIG. 114B illustrates a scenario with 2 users, the CCS may determine locations in the packing area for additional subsequent users assigned items from the customer order. Although pickers may be instructed to place items in specific locations, in some implementations, the CCS/MSDs may give users options of multiple locations to select when placing the items/carriers in the packing area. For example, an MSD GUI may provide a set of enumerated optional locations (e.g., racks, bins, etc.) or a more general location that may include a plurality of sublocations (e.g., a packing area aisle number).

FIG. 115B illustrates an example method in which the CCS is configured to determine where a first portion of a customer order has been placed. In the method of FIG. 115B, the CCS subsequently instructs a second picker where to place their portion of the customer order based on the determined location of the first portion. In block 11520, the CCS receives a customer order. In block 11522, the CCS assigns portions of the customer order to a first picker and a second picker. In block 11524, the first picker picks the first portion of the customer order and places the first portion in the packing area. In block 11526, the CCS determines the location of the first portion of the customer order. In block 11528, the CCS determines the location(s) for the second portion of the customer order based on the location(s) of the first portion. For example, the CCS may determine the location(s) for the second portion based on the availability of spaces at/near the location(s) of the first portion. In block 11530, the CCS instructs the second picker to place the second portion at the determined location(s).

Although the second portion may be placed in a single second location in the packing area, in some cases, the second portion may be placed in more than one location. For example, different items/carriers that may not fit into the first location may be placed in one or more locations (e.g., adjacent/near the first location). Although the first portion of the customer order may be placed in a first single location, in some cases, the first order may be placed in more than one location, such as when a single location will not completely hold the first portion or when the first portion includes items that should be stored in separate locations (e.g., room temperature items, hot items, and/or cold items). In these cases, the CCS may determine multiple locations for the second portion, each of which may be located in/near the different locations associated with the first portion.

In some implementations, the CCS/MSDs may instruct pickers/packers to move carriers and/or items from a first location in the packing area to a second location in the packing area. For example, an MSD may render a GUI (e.g., picker or packer GUI) that instructs a picker/packer to move items/carriers within the packing area. Carriers and/or items may be moved to new locations. In some cases, items may be moved from one location to another. For example, items may be moved from a carrier/location to another carrier/location. As another example, carriers may be moved from a carrier/location to another carrier/location. Note that item/carrier movement in the packing area may be performed at any time, and is not necessarily associated with a customer order being currently picked/packed.

The CCS/MSDs may instruct pickers/packers (e.g., in an MSD GUI) to move items/carriers for a variety of reasons. In some implementations, the CCS/MSDs may instruct pickers/packers to move items/carriers in response to newly open space, such as open space near another set of items/carriers in the same customer order that makes packing the order more efficient. As another example, moving items/carriers closer to a customer pickup point may save time and help organize the packing area by placing orders for immediate pickup nearer to the pickup point.

In some implementations, the CCS/MSDs may instruct pickers/packers to move items/carriers closer to one another for easier packing. This may happen when the items in the packing area were not initially placed near each other (e.g., too many carriers in the area, some items were picked too early, etc.). In some implementations, the CCS/MSDs may instruct pickers/packers to move items/carriers in order to make space for incoming items/carriers. For example, if space is needed near a first portion of a customer order and there is a second incoming portion of the customer order, the picker/packer can be instructed to move items near the first portion of the customer order to a different location to make room for the incoming second portion. In some implementations, the CCS/MSDs may instruct the pickers/packers to move items/carriers based on item type. For example, frozen or heated items may be moved from their storage location (e.g., temperature controlled spaces) to a customer pickup location at customer arrival and/or just prior to customer pickup.

In some implementations, an MSD may provide a GUI that a user may use when moving items/carriers in the packing area from one location to another location. For example, the user may enter confirmation that they have moved the order. In some implementations, the user may scan items/carriers and/or the locations to indicate when they pick up an item/carrier in the packing area and when they place the item/carrier in a new location in the packing area. In some implementations, the packing area may include devices that automatically confirm the movement of items/carriers in the packing area.

The MSDs may provide GUIs for any of the picking and packing techniques described herein. For example, the GUIs may display any of the items, carriers, instructions, and data described herein with respect to picking and packing items. Example GUIs may include, but are not limited to: 1) picker GUIS associated with selecting carriers to be used for picking (e.g., single/multi-order carriers), 2) GUIs used while picking (e.g., to determine which carriers to use for items), 3) GUIs indicating where to place items/carriers in the packing area, and 4) GUIs used by packers to pack customer orders. Although picking GUIs and packing GUIs are illustrated and described herein, other types of interfaces may be used, such as manual buttons, track pads, analog sticks, acceleration/gyro controls, etc.

An MSD may provide a plurality of GUIs associated with selecting carriers to be used for picking, as described herein. In some implementations, an MSD may present item/order parameters to the user that may make it easy for the user to determine which carriers to take. For example, GUIs may list a number of orders, number of items in the order(s), max size of items, item types, and other parameters in a pre-picking interface (e.g., a carrier selection interface). In some implementations, a GUI may include suggested carriers for picking the order. For example, the GUI may specify carrier type, IDs, locations, and/or other carrier parameters (e.g., main order carrier and/or additional carriers).

In some implementations, a user may specify picking parameters on an MSD (e.g., an MSD GUI). For example, the picker may specify whether they are a single-order picker or a multi-order picker in a GUI. In some implementations, a user may indicate which carriers they are using to pick an order. For example, a user may manually confirm that they are taking the suggested carriers. As another example, the user may manually enter the carriers into the GUI and/or scan carriers being used to pick. The CCS may determine what items/orders to assign based on the indicated carriers.

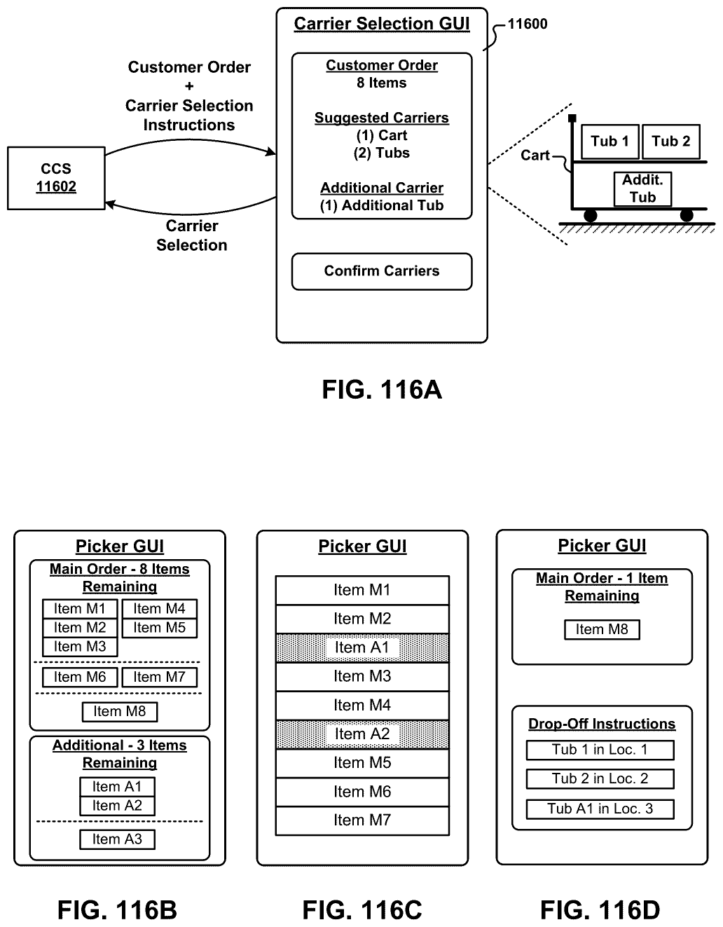

FIG. 116A illustrates an example in which the CCS 11602 assigns a customer order and associated carrier selection instructions to a user device. In FIG. 116A, the user device (e.g., MSD) renders an example carrier selection GUI 11600 that displays customer order parameters for a single customer order. For example, the carrier selection GUI 11600 indicates that the customer order includes 8 items. In some cases, the GUI 11600 may include additional data associated with the items, such as item type (e.g., refrigerated, room temperature, etc.), item size, item weights, etc. In some cases, a user may expand the customer order parameters (e.g., by touching the customer order) to indicate additional data for the customer order and individual items (e.g., specific item names, locations, etc.).

The carrier selection GUI 11600 in FIG. 116A also includes a list of suggested carriers for picking the customer order (e.g., 1 cart, tub 1, and tub 2). The carrier selection GUI 11600 also suggests that the user take an additional tub, which may be used to pick additional items (e.g., items assigned while picking the customer order). The user may confirm in the carrier selection GUI 11600 that they have taken, or will take, the suggested carriers and the additional carrier. In some implementations, as illustrated in FIG. 116A, the user may touch a “Confirm Carriers” button to confirm that they are taking the suggested carriers and the additional carrier. In some implementations, a user may scan the carriers (e.g., scan barcodes on the carriers or acquire images of the carriers) to confirm carrier selection. As described herein, the user may confirm carrier selection in other manners. The example carriers are illustrated in FIG. 116A as 1 cart with 2 tubs for the main order of 8 items and an additional tub for orders that may be received while picking the main order. Although carrier selection instructions are illustrated as being generated at the CCS 11602 in FIG. 116A, an MSD may generate the carrier selection instructions.

The CCS/MSDs may generate instructions for taking additional carriers based on a variety of factors. In one example, the CCS/MSDs may generate instructions for taking additional carriers based on store policy. In another example, the instructions may be generated based on the ability of a user to take the carriers, such as an amount of room on a cart for additional carriers. The amount of room may depend on the number of carriers used for the main order and/or the total capacity of a cart or other carrier used to carry the additional carriers. In another example, the instructions may be generated based on a number of items outstanding to be picked (e.g., at the present time or scheduled within a short period of time from the present time), where a greater number of items may indicate a higher likelihood of assigning items for the additional carrier(s). In this example, a greater number of outstanding items (e.g., greater than a threshold number) may cause the CCS/MSDs to suggest a greater number of additional carriers. In some implementations, the suggested additional carriers may depend on the size of the outstanding items to be picked, where dimensionally larger items may cause the suggestion to take larger additional carriers for potentially handling the items. Other example factors for suggesting additional carriers may include the number of items at the store usually picked at the current time of day and/or the ability of pickers to pick (e.g., picking rates associated with current pickers). Other example factors for suggesting additional carriers may include the number of items for each of the pickers. For example, if other pickers are picking large orders, it may be more likely to send additional items to a new picker, as the other pickers may not have additional time/room. Another example factor may include the amount of time the picker may have to pick a main order. For example, if the picker has a lot of time (e.g., greater than a threshold amount of time) to pick the main order because the main order is not needed immediately, the CCS/MSD may assign a larger number of additional carriers, as the picker may have additional time to pick additional items.

An MSD may render a GUI (e.g., a picking GUI) that indicates a variety of data described herein while picking customer orders. For example, picking GUIs may indicate data associated with the customer order(s) being picked, items included in the order(s), and/or the carrier(s) being used to hold the items.

In some implementations, the picking GUI may group items based on their associated customer order. For example (e.g., see FIG. 116B), a picking GUI may group items from a main order into a first group. In this example, the picking GUI may group additional items into another group (e.g., see FIG. 116B). The separate groupings may include headers that indicate the meaning of the grouping. For example, a main order may have a main order grouping header. In this example, the additional items may have an additional items header.

As described herein, the items may also be arranged based on location relative to the picker. For example, items within a main order section of the picking GUI may be arranged independently from items within an additional order section of the picking GUI (e.g., see FIG. 116B). In some implementations, the picking GUI may group items based on location. For example, the picking GUI may group items together that are near one another, such as in the same location or in adjacent locations (e.g., within a threshold distance). In FIG. 116B, main items M1-M5 may be grouped together because they are near one another. The picking GUI may separate the groups of items to indicate that they are in different locations. For example, in FIG. 116B, the different groups of items are separated by broken lines to indicate that the different groups of items are located in different locations. In some cases, separation between items may indicate that the items are greater than a threshold distance apart. For example, in FIG. 116B, items M6-M7 may be near one another, but a distance apart from items M1-M5 and item M8. Separation of items and graphical indication to the user that the items are separated may provide the user with some additional context when picking. For example, the groupings and separations may give the user a general feeling for the number of items to be picked in the local area before moving on to another location in the store that is farther away.

Although broken lines are used to graphically separate items (e.g., groups of items) in the GUI of FIG. 116B, additional/alternative separation GUI elements may be used to indicate that items are physically separated from one another in the store. For example, the GUI may include text between items (e.g., text in addition to, or in place of, the broken lines) to indicate that there is a distance separating the items in the store (e.g., text may indicate “Separation between items”). In some implementations, the text may indicate the distance between the items (e.g., in terms of feet, meters, number of aisles, etc.). The rendered item size (e.g., text size, item image size, etc.) and the number of items illustrated in FIG. 116B are only example renderings of a picking interface. The number of items displayed, as well as the size of the items displayed (e.g., text size, item image size, etc.) may depend on a variety of factors, such as display screen size for the MSD and the amount of information being displayed for each item (e.g., an item name, an image, and/or additional item information used to identify an item to pick). In other examples, fewer items may be displayed, such as the items nearest to the user. For example, fewer items from the main order (e.g., just items M1-M5 and item M6) may be displayed with fewer additional items (e.g., just items A1 and A2) if the rendered items do not fit onto the display. In the case where the full main order and/or the additional order items can't be displayed, the user may scroll through the items in the main order and/or the additional items. For example, the user may independently scroll items in the main order without moving the additional items section. In this example, the user may also independently scroll items in the additional items section without moving the items in the main order section.

In FIG. 116B, other types of rendering may also be used to indicate the location of the user relative to the groups of items. For example, the picking GUI may render items near the user in a manner that is different than items that are farther away from the user. In a specific example, the picking GUI may render groups of items closer to the user in a position that is higher on the picking GUI (e.g., closer groups near to the top of the screen). In another specific example, the picking GUI of FIG. 116B may highlight items that are near the user. In this specific example, if the group of items M1-M5 are near the user, the picking GUI may highlight items M1-M5. In this specific example of FIG. 116B, additional items A1-A2 may be close to one another and also closer to the user than additional item A3. If items A1-A2 are near enough to the user, the picking GUI may highlight items A1-A2 to indicate to the user that items A1-A2 are near to the user and should be picked soon.

In some implementations (e.g., FIG. 116C), items from main orders and additional orders may be intermixed. For example, in FIG. 116C, additional items A1 and A2 are intermixed with main items instead of separated as in FIG. 116B. In FIG. 116C, the additional items and main items may be differentiated from one another using any of the rendering techniques described herein, such as font size, font color, highlighting, explicit naming (e.g., Item A1-“additional item”), etc.

In some cases, the picking GUI may also indicate locations of individual items and/or groups of items. For example, the picking GUI may include a header associated with a group of items that indicates the location(s) of the items in the group. The locations may also be indicated at a per item level. For example, individual items may have a location indicated next to the item name or inside the item name box.

The picking GUI may be modified as a user moves throughout the store, picks/scans items, and/or receives updates (e.g., new items, canceled items, a route modification, etc.). Modification of the picking GUI may include changes in the groupings of items or individual items rendered in the picking GUI. For example, groups of items and/or individual items may move in the picking GUI, be added to the picking GUI, and/or be removed from the GUI for a variety of reasons.

Items in the picking GUI may be removed after the items are scanned. An item in the picking GUI may also be removed in the scenario a user moves away from the item and/or other closer items are placed on the screen in place of the removed items, such as when a user moves toward already assigned items and/or items are newly assigned close to the user. In some cases, items may be removed if the CCS withdraws the items from the user due to assignment to another user and/or customer cancellation. Items may be added to the picking GUI as the user moves throughout the store and comes in proximity with items. Newly ordered items may also be added to the picking GUI.

In some implementations, scanning an item may result in a scan confirmation. For example, in response to scanning Item M1, a notice may be displayed on the picking GUI indicating “Item M1 has been scanned.” As another example, a scan confirmation may include a modification to the item rendering in the picking GUI, such as a highlight, coloring, or other emphasis/de-emphasis. In some implementations, a scan may result in other feedback, such as audible feedback (e.g., a beep that confirms an item was properly scanned, or another different beep that indicates the item was scanned incorrectly). Another type of feedback may include tactile feedback, such a first type of vibration for a correct scan and a second type of vibration for an incorrect scan. The visual, audible, and/or tactile feedback may provide reassurances to the user that the items are being scanned correctly.

In some implementations, a group of items may disappear from the picking GUI in response to scanning all items in the group and/or user movement that results in the user being located farther from the group. For example, the additional items section in FIG. 116B may be removed after all additional items (e.g., Items A1-A3 and optional items offscreen) have been scanned. Removing the additional items section may make more room for display of the items associated with the main order (e.g., in the case that a larger number of items are included offscreen in the main order). In another example associated with FIG. 116B, a user may move a distance away from the additional items, which may cause the additional items section to be removed (e.g., if the user is outside the proximity of any additional items). Groups of items (e.g., additional items or main items) may be rendered back on the GUI in the case that a user moves back into proximity of one or more items in the group and/or the user has scanned a sufficiently large number of items that the only remaining items can all be displayed on the picking GUI. In some cases, the receipt of additional items or another main order may cause a new section of items to be rendered on the picking GUI.

In some implementations, the groups of items may be rearranged on the picking GUI as the user moves throughout the store. For example, if a first group of items near a user is displayed higher on the display than a second group of items farther from the user, the first group may move to a position below the second group if the user moves closer to the second group and farther from the first group. With respect to FIG. 116B, it may be assumed that items A1-A2 are closer to the user than item A3 in the illustrated picking GUI. If the user moves closer to item A3 and farther from items A1-A2, item A3 may move to a position above items A1-A2.

The items illustrated in the picking GUI of FIG. 116C may also be added, deleted, and moved on the picking GUI for the reasons described herein. Also note that additional items may be assigned to the user in the picking GUI of FIG. 116C. In the picking GUI of FIG. 116C, newly assigned items may pop onto the picking GUI list based on the location of the item relative to the other items being displayed, where the newly assigned item may be off the list in the case the newly assigned item is farther from the user.

In some implementations, newly assigned items that are not added to the current onscreen picking GUI (e.g., offscreen items) may be indicated to the user in a notification on the picking GUI. For example, a newly assigned item may be indicated in a temporarily provided notification GUI at the top of the picking GUI or over the picking GUI. In a specific example, a temporary notification may indicate “Item X has been assigned in Location Y (Not displayed),” where the “not displayed” indicator may indicate to the user that the item has been assigned, but is currently off the main screen. In some implementations, the picking GUI may provide notifications if items are removed (e.g., removed from the main order or additional items). For example, a notification may indicate that “Item X has been removed from Additional items (Not displayed).” Notifying the user of changes in the items to be picked may provide situational awareness for the user while picking. The notifications (e.g., new items, removed items, etc.) may also be shown in the picking GUI even when the consequences of the addition/removal affects the current display. For example, a notification may be provided for new items that are also newly displayed. As another example, a notification for removal of an item that is currently displayed may be provided. As another example, a notification for the addition of a new item that moves a currently displayed item offscreen may be provided.

In some implementations, the picking GUI may indicate a carrier to use for the picked items. For example, the picking GUI may include a carrier indicator next to the item. Example carrier indicators may indicate carrier type, such as tub, bin, bag, single-order carrier, multi-order carrier, main order carriers, additional item carriers, and/or a specific carrier ID. As another example, the picking GUI may indicate that some items should be placed into a specific carrier for placement in a refrigerated area. In one example, the indicator may indicate a specific color of carrier or other visible indication associated with the carriers, such as when the store uses colored carriers for specific items (e.g., refrigerated items or items in addition to a main order). In another example, the picking GUI may include text indicating the type of carrier to use for specific items. The indications of which carrier to use may be for a group of items and/or indicated for specific items (e.g., using text, colors, etc.). In cases where the store uses specific carriers for specific item types, such as different color tubs for refrigerated items or different color tubs for additional items, the GUI may render the items as specific colors that may match the specific carrier colors according to item type.

In some implementations, a user may scan the carrier or manually indicate the carrier (e.g., in the picking GUI) before/after scanning the item to be placed in the carrier. The picking GUI may indicate to the user that the proper item and carrier scan has been made (e.g., in cases specific items are to be placed in specific carriers). In other implementations, the user may place items into any of the proper carriers. For example, the picker may have the flexibility to use any of the main order carriers for main order items. As another example, the picker may have the flexibility to use any of the additional carriers for the additional items. In these examples, the OFS may keep track of the location of the carriers and instruct packers to find the items accordingly during packing.

In some implementations, the picking GUI may provide drop-off instructions. For example, the picking GUI may provide drop-off instructions to a user when the user starts picking (e.g., upon assignment of the customer order to the picker). As another example, the picking GUI may provide drop-off instructions to a user while the user is picking the order (e.g., prior to the final item being scanned). As another example, the picking GUI may provide drop-off instructions to a user after the items are picked (e.g., in a separate dedicated drop-off GUI).

The drop-off instructions may specify one or more carriers used to pick the customer order along with one or more corresponding locations for the carriers. In some implementations, the drop-off instructions may indicate specific locations for each of the one or more carriers used to hold the picked customer order. For example, in FIG. 116D, each of the carriers have different instructed locations. Specifically, the user is instructed to drop off tub 1, tub 2, and tub A1 in location 1, location 2, and location 3, respectively. In some implementations, the instructions may indicate that the user drop off multiple carriers in a single location (e.g., tub 1 and tub 2 in location 1).

In some implementations, the drop-off instructions may be specified on a per order basis (e.g., a specific group of instructions for each order). In some cases, a single order may be placed in a single location. In other cases, a single order may be split among multiple locations (e.g., see FIG. 116D). In some implementations, the drop-off instructions may be specified according to whether an order is a main order picked by the user or additional partial orders. For example, all carriers from a main order may have a single instructed location. In this example, one or more additional carriers may have one or more specified locations. In some implementations, the drop-off instructions may be specified on a per-item basis. For example, a single item may have a single instructed location (e.g., a single rack location, an already-placed carrier location, etc.). As another example, a plurality of items may have a single instructed location (e.g., a single rack location, a specific already-placed carrier location, etc.).

In some implementations, display of the drop-off instructions may be triggered by one or more events. For example, the drop-off instructions may be displayed in response to a threshold number of items remaining for picking (e.g., a last one or more items remaining). As another example, the drop-off instructions may be displayed in response to a user entering a drop-off area, such as a packing area of the store. As another example, the user may manually request the drop-off instructions (e.g., using a drop-off instruction request GUI element). As another example, the user may manually scan an indicator (e.g., a barcode or RFID tag) in the packing area to indicate that the user is in the packing area and ready to drop off the picked items. In response to scanning the indicator, the MSD may provide the drop-off instructions.

In some implementations, as described herein, the picking GUI may transition to a packing GUI for packing items. In other implementations, specific users may act as packers for items/carriers placed in the packing area. In some implementations, the packing GUI may include groupings for items and their associated location(s) in the packing area in a manner similar to the picking GUIs described herein. In some implementations, the packing GUIs may list the locations of carriers and individual items. In some implementations, the packing GUIs may indicate locations of groups of items or groups of carriers associated with a customer order. In some implementations, there may be multiple locations associated with a single customer order, such as when carriers are dispersed and/or individual items were picked.

In some implementations, the carriers/items in the packing GUI may include data indicating why the carriers/items are separate from one another. For example, the packing GUI may indicate item types that may cause separation, such as for refrigerated and non-refrigerated items. In a specific example, the packing GUI may indicate a first item type (e.g., refrigerated) and a first location in a header for a first group of items. In this specific example, the packing GUI may indicate a second item type (e.g., non-refrigerated) and a second location for a second group of items in the customer order. The item type header along with the location may help provide context to the packer regarding the customer order. Other types of context that may be included in the packing GUI for items/carriers that are located in different locations may include, but are not limited to, a picker that picked the groups of items/carriers, a time the groups of items/carriers were placed, a time the groups of items/carriers will be picked up, and/or other customer order and picking data described herein.

In some implementations, individual items or groups of items in the packing GUI may be associated with one or more GUI indicators that provide context to the packer (e.g., in a manner similar to picking items). For example, a packing GUI may indicate the location of individual items, individual carriers, portions of orders picked by multiple pickers, main order carrier locations, additional carriers, etc. In some implementations, the packing GUI may include different renderings to indicate information to the packers, such as which carriers include items to be packed. For example, the packing GUI may indicate carriers using explicit naming, coloring, highlighting, etc. In a specific example, the packing GUI may color some items to have a similar color as the carriers including the items, such as in the case that the store uses multiple different color carriers to indicate whether the carrier is a single-order carrier, multi-order carrier, refrigerated carrier, etc.

In some implementations, the packing GUI may indicate the number of items in each carrier and/or the specific items in the carrier. The packing GUI may indicate if the items included in the carrier are a complete order. In this case, the packer may know that they just need to acquire the complete carrier to pack the customer order. In another case, the packing GUI may indicate whether the items included in the carrier are part of the customer order being packed and whether the carrier is a single-order carrier or a multi-order carrier. In the case a single-order carrier includes part of a customer order, the packer may integrate the entire carrier into the customer order being packed. In the case a multi-order carrier includes part of a customer order, the packer may pull individual items from the carrier to integrate into the customer order being packed.

In some implementations, the carriers/items in the packing GUI can be arranged based on location relative to the packer. For example, carriers/items closer to the packer may be rendered higher in the GUI, in a different font/format, or in another manner described herein with respect to a picking GUI. The carriers/items can be rearranged in the picking GUI as the packer moves throughout the packing area. Carriers and/or items may be removed from the packing GUI after the packer collects the items (e.g., scans the items to indicate they are packed or manually touches the carrier/item in the packing GUI). In some implementations, carriers and/or items may be added to the packing GUI, such as when pickers place items/carriers in the packing area while the packer is packing the customer order. The packing GUI may also provide additional information, such as notifications when all of the items of a customer order arrive in the packing area for packing. For example, a dedicated packer may receive the notification. As another example, a picker that transitions to a packer can receive the notification in the MSD GUI.

In some implementations, the CCS/MSDs may generate a packing route through the packing area for collecting the items in the packing area. The packing route may use any of the routing techniques described herein with respect to pickers. For example, in some implementations, the packing route may be a set route. In other implementations, the packing route may be suggested/optional (e.g., the route may be adjusted if the packer strays from the suggested route).

In some implementations, customer orders may be associated with a pickup time or pickup time slot that indicates when a customer is expected to pick up the packed customer order. A pickup time or pickup time slot associated with a customer may be referred to as a “customer pickup time” or a “customer pickup time slot,” respectively. Customer orders associated with pickup times/slots for customers may be referred to herein as “scheduled customer orders” or “scheduled orders.”

A customer may schedule an order in a variety of ways. In some implementations, the customer shopping application or shopping website may provide a suggested time or time slot for picking up the customer order. The OFS may assign orders to be picked based on the time or time slot associated with the orders. For example, the OFS may assign an order to be picked prior to the expected customer pickup time or the beginning of the customer pickup time slot. In some implementations, the OFS may prioritize the picking of orders based on the time slot, where orders that are due at earlier times are assigned first. The OFS may notify the customer via the customer shopping application when the customer order has been packed and is ready for customer pickup.

Pickers that pick scheduled orders may have a sense of order and pace to their picking, which may be dictated by when customer orders are scheduled for pickup. The picking pace for scheduled orders may vary based on incoming order volume at the store.

Order volume may fluctuate predictably or unpredictably, depending on the day of the week, time of day, local events (e.g., sporting events and holidays), and/or other factors. The store may control the picking pace for scheduled orders by changing a number of pickup times available to customers and/or varying the number of pickers/packers working at the store.

In some implementations, the OFS may be configured to handle customer orders placed for a more immediate pickup than a typical scheduled order. The customer orders placed for a more immediate pickup than a typical scheduled order may be referred to herein as “unscheduled customer orders,” “unscheduled orders,” or “immediate orders.” In some cases, unscheduled orders may be thought of as orders that are not scheduled with a threshold amount of advanced notice, whereas scheduled orders are scheduled with a more substantial advanced notice. For example, an unscheduled order may have little or no advanced notice. In one example, an unscheduled order may have less than a threshold amount of time between order placement and customer expectation of pickup. In this example, a scheduled order may be required (e.g., by the CCS) to be placed for pickup/delivery within an expected time slot and/or at, or after, a time in the future (e.g., a time that is greater than a threshold amount of time in the future). Whereas a scheduled order may have an associated time/slot for pickup/delivery (e.g., in an order data record), in some cases, an unscheduled order may not include an associated time/slot and/or may indicate that the time/slot is “immediate.”

Example unscheduled orders may include orders placed while the customer is in the store (e.g., inside the store on foot), parked outside the store, on the way to the store (e.g., driving), or a threshold distance from the store (e.g., close enough to pick up items quickly). When placing an unscheduled order, the customers may expect that the order is fulfilled in a timely manner, such as a matter of minutes. For example, a customer at the store (e.g., on foot or parked) may expect the order to be filled in minutes. As another example, a customer outside the store (e.g., on their way) may expect the order to be ready when they arrive at the store or very shortly after.

A variety of parameters (e.g., eligibility parameters/conditions) are described herein that may be used by the CCS/TPCS to define scheduled and unscheduled orders. For example, an order may be placed as an unscheduled order for immediate pickup in response to satisfaction of one or more eligibility parameters. The parameters that define unscheduled orders may be defined at the CCS/TPCS by one or more parties that implement the OFS (e.g., a store or third party). As such, the parameters for defining an order as scheduled or unscheduled may vary, depending on the store implementation. Additionally, the parameters may vary for the same store at different times (e.g., depending on available picking/packing resources).

The CCS/MSDs may be configured to receive scheduled and unscheduled orders. For example, the CCS/MSDs may be configured to implement the parameters associated with scheduled and unscheduled orders described herein. The CCS may be configured to receive unscheduled orders and assign the unscheduled orders to picker/packer MSDs. A store, or third party, that implements scheduled and unscheduled orders may also be configured to use techniques described herein in order to fulfill unscheduled orders. For example, the store, or third party, may use specific pickers/packers, MSDs, and/or user interfaces for unscheduled orders. As another example, a store, or third party, may use specific carriers, carrier storage locations, and/or packing area locations for scheduled and unscheduled orders. As another example, the customer pickup locations may be different for scheduled and unscheduled orders. A variety of different implementations for filling scheduled and unscheduled orders are described herein.

The techniques associated with submission of unscheduled/scheduled orders by customers (e.g., using a customer application) and the handling of unscheduled/scheduled customer orders may apply to customer orders that are picked up by the customer at the store and/or delivered to the customer at a delivery location outside of the store (e.g., a customer's home, a customer's current location, or other location). Accordingly, the techniques associated with fulfilling unscheduled/scheduled customer orders for pickup may apply to fulfilling unscheduled/scheduled orders for delivery. Although similar techniques may be used to fulfill unscheduled/scheduled orders for delivery, additional/alternative techniques may be used for pickup and delivery, such as different eligibility conditions. Note also that the methods described herein for unscheduled/scheduled pickup may also apply to unscheduled/scheduled delivery.

A variety of customer-facing application features are described herein. For example, a customer shopping application (e.g., referred to as a customer application or shopping application) may provide shopping functionality and/or picking functionality (e.g., shopping/picking GUIs). As described herein, the customer shopping application may be provided to a digital distribution platform by the store, a third party, or other developer. As also described herein, the customer shopping application may be provided as a website. Packing functionality may also be provided as an application on an MSD. For example, the packing functionality may be integrated with picking MSD functionality and/or provided as a separate application.

As described herein, a customer may place a customer order using a customer application installed on a customer device. Additionally, or alternatively, the customer may access a webpage for placing the customer order using a customer device (e.g., a desktop or mobile device including a web browser application). Features attributed to the customer application (e.g., customer application GUI) may also be provided by a website, such as a store website or third-party website hosted on one or more server computing devices and controlled by the store or third parties. The customer application/website may provide a customer application/website GUI (e.g., a shopping interface) for the customer. The customer may view items for sale, search for items, and/or perform other operations provided by the customer application/website GUI. The customer may select items in the customer application GUI for inclusion in an application/online shopping cart. For example, a customer may select (e.g., touch/click) a GUI element to add the item to their application/website shopping cart. The application/website shopping cart may include a plurality of items that may be added during a single session (e.g., during one application open, one website login, one short period of continuous usage by the customer, etc.). The application/website shopping cart may also be stored by the application and/or online server, which may allow the customer to update the shopping cart over time using different computing devices in different locations. For example, the user may access the customer application/website multiple times over the course of a day, week, month, etc. Updates may include deleting items from the cart, adding items to the cart, changing an order from scheduled to unscheduled, and other features described herein. After a customer is satisfied with the items included in their application/website shopping cart, a customer may finalize/submit the order (e.g., to the CCS, TPCS, etc.). For example, the customer may finalize/submit the customer order by interacting with a GUI element that indicates the customer's intent to pay for the order and have the order picked, packed, and/or delivered. In some cases herein, “placing” a customer order may include one or more of: 1) adding items to the customer order, 2) removing items, 3) finalizing/submitting the order, and 4) other actions in the customer application/website GUI described herein. In some implementations, placing a customer order may include sending a request to the CCS/TPCS to have the customer order picked/packed immediately or according to a scheduled time/slot.

A customer may place an unscheduled order in a variety of scenarios. In some examples, a customer may place an unscheduled order while at the store (e.g., on foot in the store). For example, the customer may place an unscheduled order while at the store for the purpose of picking up the unscheduled order (e.g., at any location in the store or a designated unscheduled pickup area, such as an unscheduled pickup counter). As another example, the customer may place the unscheduled order while in the store using other store products or store services. In a specific example, the customer may place an unscheduled order while shopping in the store for items (e.g., items not included in the unscheduled order, such as electronics or magazines). As another example, a customer may place an unscheduled order while waiting for food or eating food at a restaurant located in the store. As another example, a customer may place an unscheduled order while waiting at the store for another service provided at the store, such as waiting for meat, cheese, or bread at the deli, bakery, etc. As another example, a customer may place an unscheduled order while waiting for their car to be serviced at a service center, waiting at an eye appointment for an in-store optometrist, waiting at an in-store bank, picking up flowers from a florist at the store, or for another reason.

In some examples, a customer may place an unscheduled order while outside of the store. For example, a customer may park at the store (e.g., in an unscheduled pickup parking area) and place an unscheduled order. As another example, a customer may walk up to the store (e.g., to an outdoor unscheduled pickup foot traffic area) and place an unscheduled order on their customer device. As another example, a customer may place an unscheduled order from a business near a store, such as a restaurant that is a short distance from the store and accessible outside the store in a separate building or in a strip of stores and restaurants. As another example, a customer may place an unscheduled order from a gas station provided by the store or near the store.

In some implementations, a customer may place an unscheduled order while approaching the store. For example, a customer may place an unscheduled order while approaching the store in/on a vehicle, such as public transport, a car (e.g., their car or a taxi), or their bicycle. As another example, the customer may place an unscheduled order while en route to the store on foot. In some implementations, the customer may place an unscheduled order while less than a threshold distance and/or amount of time from the store.

The customer application/website may indicate whether an order is eligible to be an unscheduled order. For example, the customer application may provide a customer the option of placing a scheduled or unscheduled order prior to adding items to the customer order. Additionally, or alternatively, the customer application may provide the option of specifying that a customer order is unscheduled or scheduled while adding items to the customer order and/or after the items have all been added.

In some implementations of the OFS, the ability to timely fulfill an unscheduled order may be limited in some circumstances. In these implementations of the OFS, the OFS (e.g., CCS/TPCS) and/or a customer application may implement one or more unscheduled order eligibility conditions to determine whether a customer order is eligible to be an unscheduled order (e.g., picked up immediately).

The CCS and/or an installed customer application may classify orders as scheduled or unscheduled. In cases where unscheduled orders are required to meet one or more eligibility conditions to be classified as an unscheduled order, the CCS and/or an installed customer application may determine whether the customer order can be eligible to be an unscheduled order. For example, the CCS may include modules (e.g., an “order classification module” or an “eligibility determination module”) that classify the customer orders as scheduled or unscheduled (e.g., based on the satisfaction of one or more eligibility criteria). Additionally, or alternatively, a customer application may classify a customer order as scheduled or unscheduled (e.g., a local customer order classification module or eligibility determination module may determine unscheduled order eligibility). In some implementations, the CCS and/or the customer application may communicate with one another in order to make the determination of whether an order is eligible to be an unscheduled order. The eligibility determination operations described herein may be made by the customer application and/or the CCS/TPCS to different extents, depending on the implementation. As such, operations associated with the CCS/TPCS or customer application described herein may be performed by either the CCS/TPCS or customer application. The operations may also be performed by other devices, such as a store computing device (e.g., a provided kiosk for placing unscheduled orders).

In some implementations, a customer may manually indicate their intention of placing an unscheduled order for immediate pickup or a scheduled order for pickup at a future day/time. In some implementations, the customer application may provide the customer with one or more scheduled/unscheduled order selection GUI elements. For example, the customer application may provide one or more buttons for selecting whether the customer order will be scheduled or unscheduled. In a specific example, the customer application can include a button that indicates the order is for “Immediate pickup (Pickup Now)” or “Scheduled Pickup.” The selection GUI elements may be provided to the customer in the application before the customer begins selecting items in the application (e.g., adding items to the online shopping cart), during a time period when the customer is selecting items, and/or after the customer has selected all items for their order. In the case the customer selects a scheduled order, the customer application may provide an interface including GUI elements for selecting times and/or time slots for pickup (e.g., based on time/slot availability). In the case a customer selects an unscheduled order, the customer application GUI may confirm that the unscheduled order is submitted. The customer application GUI may also indicate that the unscheduled order is being picked, when the order will be ready, and/or when the order is ready for the customer.

The CCS and/or customer application may determine whether a customer is eligible to make an unscheduled order. If the customer is eligible to make an unscheduled order, the customer application may indicate to the customer that the customer may place an order for immediate pickup. If the customer is not eligible to make an unscheduled order, the customer application may default the order to a scheduled order in the customer application and notify the customer that the order should be scheduled in a scheduling interface (e.g., an interface including scheduling time slots for customer selection).

In some implementations, if a customer is eligible for placing an unscheduled order (e.g., as determined by the CCS and/or customer application), the customer application may present a manual selection GUI element that allows the customer to manually indicate that the customer order is an unscheduled order (e.g., a “Pickup now” button or a “Deliver now” button). In some implementations, the customer application may default to an unscheduled order for the customer if the customer is eligible. For example, the order type may default to an unscheduled order unless the customer indicates otherwise in the customer application. If the customer is not eligible for an unscheduled order, the order may default to a scheduled order.

The CCS may determine whether the customer order is eligible to be an unscheduled order based on a variety of eligibility conditions. Example eligibility conditions may include, but are not limited to, location conditions, order size conditions, store-based conditions (e.g., picker availability), and membership program availability. The CCS and/or customer application may require the satisfaction of one or more of the eligibility conditions for the customer to place an unscheduled order. The eligibility conditions may be put in place to ensure the store can fill the order immediately and/or the customer can be at the store to pick up the order, thereby justifying the immediate fulfillment of the order. Placing restrictions on unscheduled orders using eligibility conditions may make such a short turnaround possible for the store pickers/packers and also temper a customer's expectations associated with placing an order that can be immediately filled.

In some implementations, the CCS and/or customer application may determine that a customer order is eligible to be an unscheduled order based on the location of the customer (e.g., a current location of the customer). For example, the CCS may determine that a customer order is eligible to be an unscheduled order if the customer is at the store or within a threshold distance of the store (e.g., at the store, outside of the store, and/or within a threshold number of miles from the store). In some implementations, the customer order may be eligible to be an unscheduled order if the CCS determines that the customer may be at the store to pick up the order within a threshold period of time (e.g., less than a threshold number of minutes, such as 5-15 minutes, 30 minutes, 1 hour, etc.).

The CCS and/or customer application may determine the location of the customer in a variety of ways. In some implementations, the customer application may acquire the customer GPS location (e.g., from a GPS receiver included in the customer device, using WiFi, or in another manner). In some implementations, the customer may manually enter their location into the customer application. For example, a customer may select their location from a store menu, such as a menu that indicates their parking spot, a customer pickup location (e.g., an unscheduled order pickup location), a store department (e.g., the deli department), and/or another store location (e.g., a restaurant located in the store).

In some implementations, the store may include objects and/or scannable codes that indicate the customer location, such as a barcode and/or QR code that a user may scan with their customer device to indicate their location. For example, a customer pickup location (e.g., a parking location, in-store location, or other location described herein) may have a barcode or QR code that a customer may scan (e.g., using their customer device) to indicate their location at the customer pickup location. As another example, the customer may use their customer device to acquire an image of an object (e.g., a sign or other object with a location name/number) that indicates their location inside/outside the store.

In some implementations, the CCS (e.g., a local wireless communication system) may indicate the location of the customer based on communication with the customer device (e.g., via a WiFi and/or Bluetooth connection). In these implementations, the wireless communication system may be a store communication system or another nearby business communication system (e.g., a restaurant's WiFi). In another example, if the customer is using an MSD to pick part of their own order (e.g., a store provided MSD and/or customer device), the CCS may determine the location of the customer inside the store (e.g., based on scanned items, location indicators, etc.), as described herein. In some implementations, a customer may use a store computing device, such as a kiosk, in the store to place an order. In these implementations, the CCS may determine the customer location based on the use of the store computing device (e.g., a kiosk or other device). In some implementations, the CCS may determine that the customer is at the store based on a purchase at the store (e.g., at the cash/card register), such as a very recent purchase (e.g., within minutes).

In some implementations, a location eligibility condition may include a customer location in the store (e.g., a specific unscheduled order pickup location or other location). For example, the CCS may require a customer to be located in the store. The location inside the store may be determined in a variety of different ways. In some implementations, the customer may indicate their location in the customer application. In some implementations, the customer application may acquire GPS data that indicates the customer is located in the store. In some implementations, the customer device may acquire a local signal (e.g., a local WiFi signal) that indicates the customer is located in the store. In some implementations, store devices (e.g., a router) may connect with the customer device to determine the customer location. In some implementations, use of a store device, such as an MSD or store kiosk for placing orders, may indicate that the customer is located in the store. Other example location determination techniques may also be used to determine that the customer is located in the store (e.g., a scanned credit card paying for a transaction, a scanned barcode or QR code, an acquired Bluetooth signal, etc.).

In some implementations, a location eligibility condition may include a customer location outside of the store, such as a location on store property. For example, a location eligibility condition may include a customer location on foot outside of the store. The CCS may determine whether the customer is located on foot outside of the store using similar techniques as used to determine whether the customer is located inside the store (e.g., automatic location detection and/or customer-indicated location via scan or manual entry).

In some implementations, a location eligibility condition may include a customer location in a parking lot or other space reserved for unscheduled orders outside of the store. The CCS may determine whether a customer is located in the store parking lot or other unscheduled order space outside of the store in a manner similar to determining that the customer is located inside the store. In some implementations, a parked customer outside of the store may also input other data, such as a parking spot or other location associated with unscheduled order pickup.

In some implementations, a location eligibility condition may include a customer location within a threshold distance from the store. For example, the location eligibility condition may specify that a customer should be less than a threshold distance from the store, such as within a number of miles from the store or closer. In some implementations, a location eligibility condition may include a customer trajectory condition that may specify that a customer should be approaching the store in order to place an unscheduled order. In these implementations, a customer trajectory condition may be satisfied if two or more recent customer locations (e.g., outside the store) indicate that the customer is approaching the store (e.g., a distance between the customer and the store is decreasing).

In some implementations, a customer may be located at another business outside of the store, such as an adjacent store (e.g., retail, restaurant, etc.). In these implementations, the CCS may determine the customer location in a manner as described herein with respect to other location conditions. Additionally, or alternatively, the CCS may determine the customer location based on other location technology that indicates the customer is in an adjacent business, such as a connection between the customer device and the business WiFi (e.g., an IP address) and/or store WiFi. In another example, the customer may scan a readable code at the adjacent business and/or pick up a local location signal at the adjacent business. Such readable codes and/or local location signals may be set up by the adjacent business (e.g., in partnership with the store).

In some implementations, an eligibility condition may be defined in terms of an estimated customer time of arrival at the store (e.g., a time of arrival eligibility condition). For example, a time of arrival eligibility condition may be satisfied if the estimated time of arrival will occur within less than a threshold amount of time. Put another way, the time of arrival eligibility condition may be satisfied if the customer is able and/or likely to reach the store within less than a threshold amount of time.

The CCS may estimate a customer time of arrival at the store (e.g., a travel time to the store) in a variety of ways. In some implementations, the customer application and/or CCS may determine a customer distance from the store as well as a rate of travel towards the store. In some implementations, the customer application and/or CCS may determine a type of transportation currently being used by the customer to travel to the store. Example types of transportation may include a car or bicycle. In these cases, the customer application and/or CCS may estimate a time of arrival based on the type of transportation, estimated rate of travel, and/or the distance from the store. In cases where the customer is on foot, the customer application and/or CCS may estimate a time of arrival based on a customer's rate of travel by foot. In some cases, such as in the case of public transport, the customer application and/or CCS may estimate the customer time of arrival based on a public transport schedule (e.g., a bus schedule, train schedule, etc.) that is available via an application, website, API, etc. In some implementations, the customer application and/or CCS may acquire the estimated time of arrival from another application installed on the customer device or other service (e.g., a remote server providing public transportation schedules and/or a mapping application, such as Google Maps).

In some implementations, the CCS and/or customer application may determine that a customer order is eligible to be an unscheduled order based on the size of the customer order. For example, an order size eligibility condition may specify that an order must be fewer than a threshold number of items to be classified as an unscheduled order. In some implementations, the CCS and/or customer application may determine that a customer order is eligible to be an unscheduled order based on the items included in the customer order. For example, some items and/or item types may not qualify for an unscheduled order. In a specific example, items that require long preparation (e.g., meals, baked goods, fresh breads, etc.) may not qualify for an unscheduled order. In another specific example, items of a certain size (e.g., specified maximum dimensions and/or weight) may not qualify for an unscheduled order, as such items may be difficult to pick and pack easily along with a number of other smaller items, especially in cases where multiple large items are requested in a customer order. For example, items that are larger than a set of specified dimensions and/or weight may not be included in an unscheduled order. In some implementations, the CCS may include a specific list of items that are not eligible for unscheduled orders.

In some implementations, the CCS and/or customer application may determine that a customer order is eligible to be an unscheduled order based on one or more store conditions. For example, in some implementations, the CCS may determine that a customer order is eligible to be an unscheduled order based on current picking/packing bandwidth, such as a number of pickers/packers that may pick/pack unscheduled orders, a current number of outstanding orders (e.g., unscheduled orders and/or current/upcoming scheduled orders), and/or a current number of outstanding items (e.g., items in unscheduled orders and/or items in current/upcoming scheduled orders). In a specific example, an unscheduled order may be provided if a ratio of pickers to orders/items is greater than a threshold ratio. An example ratio of pickers to orders/items may be less than 1, as one picker may be assigned multiple orders/items. In this case, a greater ratio (e.g., pickers divided by items) may indicate that the pickers are less burdened, and are therefore able to pick more unscheduled orders. Although such a ratio may be used to determine whether pickers are capable of picking unscheduled orders, other values may be used, such as the number of pickers, a picking rate of the pickers, a length of a route for an unscheduled order (e.g., distance for picking the route), and/or other values. In some implementations, store conditions may also include the location(s) of one or more pickers, such as a number of pickers picking within specific locations/sections of the store. The CCS may use similar eligibility conditions with regards to packers, such as a number of packers, ratio of packers to orders/items, packing rate, estimated time for packing, etc. Store conditions may also include conditions associated with delivery drivers, as described herein. Although picker eligibility conditions, packer eligibility conditions, and driver eligibility conditions are described herein, a store may also implement additional/alternative eligibility conditions for other types of employees in the order fulfillment process, such as cashiers, stockers, and/or others.

In some implementations, the CCS and/or customer application may determine that a customer order is eligible to be an unscheduled order based on a time of day and/or day of the week. For example, the CCS may be configured to accept unscheduled orders during specific days of the week and/or time slots during the day/night. In a specific example, the CCS may be configured to accept unscheduled orders during typical work hours (e.g., 9 AM-5 PM) when store traffic is lower than outside of work hours. In another specific example, the store may provide a larger staff for unscheduled orders after work hours and the CCS may be configured to accept unscheduled orders just after work hours based on the larger staffing that can handle more unscheduled orders.

In some implementations, the CCS and/or customer application may determine whether a customer order is eligible to be an unscheduled order based on the current performance of the store with respect to fulfilling unscheduled orders. For example, the CCS may track whether the unscheduled orders are being picked and packed fast enough (e.g., a rate of items/orders picked and packed). In a specific example, the CCS may track the average time between receiving an unscheduled order and having the unscheduled order ready for the customer. In this specific example, if the average time is greater than a threshold acceptable time for having a customer order ready for an unscheduled pickup, the CCS may disable the unscheduled order feature until the average time is reduced to less than the threshold acceptable time. The CCS may also determine an average waiting time for a customer to receive an unscheduled customer order. The customer waiting time and the time required to pick and pack the order may vary, depending on whether the customer is at the store when placing the order or on the way to pick up the order while placing it. If the average waiting time is greater than an acceptable waiting time, the CCS may disable the unscheduled order feature until the customer waiting time can be reduced to less than the acceptable waiting time. Although the CCS may use average times to determine eligibility for unscheduled orders, other metrics may be used, such as median times, maximum times (e.g., too many long customer waits disables unscheduled orders), and/or minimum times (e.g., a threshold number of short times per unit time may indicate the unscheduled orders are being filled properly).

In implementations in which the CCS can determine a number of customers in the store, the CCS may determine whether customer orders are eligible to be classified as unscheduled orders based on the number of customers in the store. For example, if there are greater than a threshold number of customers in the store, the CCS may disable classification of unscheduled orders, as the store may be too busy to provide the unscheduled orders without in-store customer interference and inconvenience.

In some implementations, customers may be required to satisfy payment eligibility conditions to place an unscheduled order. For example, a customer may be required to pay a flat fee to place an unscheduled order. In another example, the fee required to place an unscheduled customer order may depend on the size of the order (e.g., a greater number of items may require a larger payment), a number of currently placed scheduled and/or unscheduled orders (e.g., more outstanding items/orders may require a larger payment), and/or other imposed fees (e.g., fees for time of day, day of week, specific holidays, etc.). In some implementations, a customer may be required to pay a membership fee (e.g., monthly/yearly fee) to have the privilege of placing an unscheduled order. In some implementations, a customer may be required to purchase a threshold number of items over time at the store (e.g., as a repeat customer) to unlock the privilege of unscheduled orders.

The eligibility status of a customer order may change at any time based on a change in any of the conditions described herein. The change in eligibility may occur at any time before a customer starts to add items to an order, while adding items to the order, and/or after the items have been added to the order. In one example, adding additional items to an order may result in the order becoming ineligible as an unscheduled order. In this example, removing the additional items may cause the order to become eligible as an unscheduled order. In another example, an initially unscheduled order may become ineligible based on a customer's movement away from the store, such as movement out of the parking lot, outside of a threshold distance from the store, or other type of movement that changes eligibility. In another example, the CCS may terminate eligibility to customer orders based on time of day, number of pickers, or other factors. In another example, a customer that allows their membership to lapse and/or reduces their spending in the store may have their unscheduled order privileges revoked. In another example, failure to pick up an unscheduled order (e.g., one or more times) may result in revoking a customer's privilege to place future unscheduled orders.

The change in eligibility may be reflected in the customer application GUI. For example, the GUI element(s) that indicate whether the customer order is eligible/ineligible to be an unscheduled order may change. In some implementations, the GUI may indicate to the customer why the change was made. For example, the GUI may indicate that the customer has added too many items to qualify as an unscheduled customer order. As another example, the GUI may indicate that the customer has moved within range of the store to now be eligible to place an unscheduled order.

In some implementations, the CCS and/or customer application can determine eligibility for unscheduled orders automatically based on configuration data associated with unscheduled orders. The configuration data may include eligibility conditions described herein. In some implementations, a store operator/manager may set the configuration data associated with unscheduled orders. In some implementations, the store operator/manager may change the configuration data based on observed performance of the OFS. For example, the CCS may provide an operator/manager interface that displays the configuration data as well as parameters that indicate performance of the OFS with respect to filling unscheduled orders, such as any data associated with unscheduled orders described herein (e.g., customer wait times, number/rate of unscheduled orders, current scheduled/unscheduled eligibility, etc.). In some implementations, the CCS may provide an operator/manager interface including one or more interface elements (e.g., GUI elements) that allow the operator/manager to manually enable and/or disable unscheduled orders for customers.

The CCS may determine the customer's pickup location for a customer order in a variety of ways. In some implementations, the customer may manually enter their location into the customer application. Example locations that may be entered by the customer may include any of the locations described herein for placing an unscheduled customer order. For example, the customer may specify a location outside of the store (e.g., a parking spot) or a location inside of the store (e.g., one or more of the inside designated pickup locations).

In some implementations, the CCS may automatically determine the location of the customer for use as a pickup location of the unscheduled order. For example, the CCS and/or customer application may automatically determine the location of the customer when the unscheduled order is placed by the customer. The customer application may indicate the location being used for the unscheduled pickup to the customer in the customer GUI. In some implementations, the customer may change location after placing an unscheduled order. For example, a customer inside of the store may place the order at a first location (e.g., a deli location, restaurant, etc.) and move to a second location (e.g., another available pickup location) to pick up the unscheduled order. In these cases, the CCS and/or customer application may determine that the customer has changed locations and update the location of the customer for picking up the unscheduled order. In some implementations, the CCS and/or the customer application may select a location for the customer to pick up the customer order and indicate that selected location to the customer in the customer application. The picker/packer MSDs may also update their GUIs to indicate the appropriate location for providing the unscheduled order to the customer.

In some implementations, pickers may be designated as being available to pick unscheduled orders (e.g., “unscheduled order pickers”). In these implementations, pickers may also be designated to pick scheduled orders (e.g., “scheduled order pickers”). In some implementations, unscheduled order pickers may be allowed to only pick unscheduled orders (e.g., the CCS may only assign unscheduled orders to unscheduled order pickers). Similarly, scheduled pickers may be allowed to pick only scheduled orders (e.g., the CCS may only assign scheduled orders to scheduled order pickers). Although unscheduled/scheduled order pickers may be assigned only unscheduled/scheduled orders in some implementations, in other implementations, an unscheduled order picker may also be assigned scheduled orders, and vice versa. In some implementations, unscheduled/scheduled pickers may be assigned scheduled/unscheduled items and orders in specific circumstances (e.g., when items can be efficiently picked and/or are needed due to time constraints). In some cases, designating specific pickers as unscheduled pickers or scheduled pickers may provide context to the picker as to their duties and goals regarding customer orders. For example, an unscheduled order picker may have the expectation of receiving orders that require quick fulfillment, whereas a scheduled order picker may have the expectation of fulfilling orders according to a set schedule. As described herein, a user data record (e.g., a picker data record) may indicate whether a picker is an unscheduled picker or a scheduled picker. Similarly, the attributes of other users with respect to unscheduled/scheduled order fulfillment may be included in user data records. As also described herein, a user data record may be referred to herein according to the user type. For example, a user data record for a picker, packer, and driver may be referred to as a picker data record, packer data record, and driver data record, respectively.

As described above, in some implementations, a scheduled order picker may sometimes be assigned unscheduled order items, such as when the items can be efficiently picked according to factors described herein (e.g., without much/any deviation from the scheduled route, if no unscheduled pickers are near the items, and/or other factors). For example, the CCS may assign one or more items from an unscheduled order to a scheduled order picker in the case the items are on the scheduled order picker's route. In cases such as these, the CCS may require that the scheduled order picker's route is estimated to be completed in a relatively short period of time (e.g., less than an amount of time that is acceptable for providing the unscheduled order). In some implementations, a scheduled order picker may be assigned unscheduled order items as a fallback case, such as when there are many unscheduled items needed immediately (e.g., a need for a threshold number of items and/or a need for items within a threshold period of time), when substitution items are needed quickly, or in another case. Such a fallback case may occur due to a rapid uptick in unscheduled items. An example rapid uptick in unscheduled items may occur at a time when customers are leaving work and plan to pick up some items on the way home, for example.

In some implementations, an unscheduled picker may also be assigned items from scheduled orders, such as when the items can be picked efficiently (e.g., when the items are near the unscheduled order picker). For example, an unscheduled picker may be assigned items for a scheduled order that are recently added by the customer. In a specific example, the customer may add items to a scheduled order just prior to leaving for the store, as they are approaching the store, and/or while they are at the store. In this specific example, the item may be needed immediately in a manner similar to unscheduled orders.

Assignments of items/orders to the unscheduled order pickers and scheduled order pickers may also be subject to other constraints. For example, there may be order and/or item limit numbers associated with each type of order. In one example, an unscheduled order picker may be limited to picking a threshold number of orders/items from unscheduled orders. As another example, a scheduled order picker may be limited to picking a threshold number of scheduled orders/items. In cases where scheduled pickers and unscheduled pickers can be asked to pick additional items from unscheduled orders and scheduled orders, respectively, a limit on the newly assigned items/orders may be enforced (e.g., a scheduled order picker may only be assigned a few items from unscheduled orders). Other types of constraints described herein may also apply to scheduled order pickers and/or unscheduled order pickers, such as total item/order limits, single-order limits, multi-order limits, item type constraints, etc.

The CCS may receive and classify customer orders as scheduled orders and unscheduled orders. The CCS may assign the customer orders to the pickers based on a variety of different factors described herein. For example, with respect to unscheduled orders, the CCS may be configured to assign partial/complete unscheduled orders to pickers that are eligible to receive unscheduled items/orders. At any time during store operation, there may be a candidate set of unscheduled order pickers available to pick unscheduled orders. The CCS may select one or more of the available unscheduled order pickers based on factors described herein. For example, the CCS may first determine which unscheduled order pickers are available for picking unscheduled items/orders (e.g., based on factors described herein, such as order/item limits). In the case there are multiple potential unscheduled pickers available to pick unscheduled items, the CCS may use additional rules/preferences to determine which of the one or more potential unscheduled pickers receives the item assignment. For example, preferences may take into account current picker location, minimum deviations from current routes, minimum deviations from expected routes to be traversed based on current item assignments, and other factors.

In some implementations, unscheduled pickers may also pack unscheduled orders, such as unscheduled orders they have picked or others have picked. In these implementations, the unscheduled order picking GUI may transition into an unscheduled order packing GUI that indicates the locations and items included in unscheduled orders, as described herein with respect to packing other orders. In some implementations, the store may use separate packers for unscheduled orders. In some implementations, packers may pack both unscheduled orders and scheduled orders. In other implementations, some packers may be dedicated to packing unscheduled orders (e.g., “unscheduled order packers”). In these implementations, some packers may be dedicated to packing scheduled orders (e.g., “scheduled order packers”).

In some implementations, different carriers may be used for scheduled orders and unscheduled orders. For example, different types of carriers and/or colors of carriers may be used for scheduled and unscheduled orders (e.g., in a manner similar to multi-order and single order carriers described herein). Using different carriers for unscheduled orders and scheduled orders may assist pickers and packers in readily identifying the carriers and understanding the context of the items included in the carriers. In some implementations, the picker GUIs may indicate which carriers to use for different items. For example, the picker GUIs may be rendered to reflect the different types of carriers used. In one example, the picker GUIs may color code items for scheduled orders in a manner that is different than unscheduled orders. In this example, the color coding in the picker GUIs may match the color coding of the physical carriers. The packing GUIs may include similar color coding, or other types of rendering, that match the physical carriers used to hold the items.

In some implementations, the different carriers for scheduled and unscheduled orders may be stored in different locations in the store, such as in different empty carrier areas for selection by a picker when starting a route. The picker GUIs may instruct the pickers to select scheduled carriers and unscheduled carriers for picking orders (e.g., based on factors described herein with respect to carrier selection).

In some implementations, the packing area may include different designated drop-off areas for placing unscheduled orders/items and scheduled orders/items. In some implementations, the packing area may also include different designated areas for completely packed unscheduled orders and completely packed scheduled orders (e.g., holding areas prior to providing packed orders to customers and/or delivery drivers). The different drop-off areas and holding areas may be indicated to the scheduled/unscheduled pickers and packers (e.g., physically in the store and/or in a GUI).

In some implementations, the store may include different packing areas that may be used for different customer/driver pickup locations. In these cases, the pickers may drop off items to different packing areas based on the location of the customer. For example, the store may have a first packing area for customer pickup by car. In this example, the store may have a second packing area for customer pickup at a designated indoor unscheduled pickup area. The picking/packing GUIs may indicate which packing area to use for drop-off and packing. In some implementations, the CCS/MSDs may automatically determine which of the packing areas to use based on the location of the customer, such as the location of a customer picking up an unscheduled order, where the location may be manually indicated by the customer and/or automatically detected.

The CCS/MSDs may receive a plurality of unscheduled orders that may be assigned for picking at the same time to one or more pickers. In some implementations, the CCS may include a queue of unscheduled orders. In some cases, the CCS may be able to assign all pending unscheduled orders in the queue to pickers that may efficiently pick all orders at the same time. In some implementations, the CCS may prioritize the assignment of unscheduled orders/items to pickers in order to manage a larger/growing unscheduled order queue that may not all be assigned at the same time to available pickers.

The CCS may implement a variety of unscheduled order prioritization factors that determine which of the unscheduled orders are assigned to available pickers (e.g., in sequence). In some implementations, the CCS may be configured to assign unscheduled orders/items using a first come, first serve operation (e.g., a first in first out (FIFO) operation). In these implementations, the CCS may be configured to assign the unscheduled orders/items to pickers as they are received from customers (e.g., as they are placed by customers), subject to other constraints, such as a total number of available pickers, a total number of orders/items already assigned, etc. In some cases, the first come, first serve operation may provide a visibly fair system to customers placing unscheduled orders because the unscheduled orders may be typically placed while the customer is at the store or nearby the store.

In some implementations, the CCS may be configured to assign unscheduled orders/items based on how long the customer has been waiting at the store for the unscheduled order, where customers waiting longer at the store may have their unscheduled orders prioritized for assignment more than customers that are just arriving or on their way to the store. In some implementations, the CCS may be configured to prioritize unscheduled order assignment based on the location of the customers, where customers that are located at the store are prioritized over customers that are not at the store. In some implementations, customers closer to the store (e.g., by distance and/or time) may be prioritized over customers that are farther from the store.

In some implementations, the CCS may be configured to assign unscheduled items based on the expected picking efficiency associated with the unscheduled items. For example, if unscheduled items are located on/near existing routes for unscheduled or scheduled pickers, the CCS may assign the items even in the case the items are for unscheduled orders that were placed more recently. In some implementations, the CCS may be configured to deviate a picker further from their current location or route when a complete unscheduled order may be picked (e.g., a few items near each other, but off the route), as picking a complete unscheduled order may be classified as a higher priority than partial unscheduled orders.

In some implementations, the CCS may be configured to assign complete unscheduled orders to the same picker. This may prove effective if the unscheduled orders are limited in size and include items that are near one another. In some implementations, the CCS may be configured to split unscheduled orders among multiple pickers for efficiency. For example, the CCS may be configured to split an unscheduled order in the case items from the unscheduled order are greater than a threshold distance apart. In another example, the CCS may be configured to split an unscheduled order if the split results in a threshold level of efficient picking, such as no deviation, or a threshold deviation, from current routes/trajectories by other pickers.

In some implementations described herein, a scheduled order may take priority over an unscheduled order. For example, as a matter of fairness to a scheduled order customer, the CCS may prioritize and assign a scheduled order that is due for pickup at the present time. In some implementations, priority may be determined based on customer payment. For example, customers that pay for immediate pickup (e.g., per pickup and/or with paid memberships) may take priority over customers that do not pay for the service.

The CCS/MSDs may generate routes including unscheduled items. For example, as described herein, unscheduled items may be used to generate new routes, merged into existing routes, and/or tacked on to the ends of existing routes (e.g., existing routes including scheduled items and/or unscheduled items).

In some implementations, the CCS may generate routes for prioritized orders first, then add additional lower priority items to the routes, subject to other constraints described herein. In some implementations, the CCS may refrain from assigning unscheduled items to a picker in response to a variety of conditions. For example, a CCS may refrain from assigning unscheduled items in the case the picker has picked items that are needed immediately by a customer (e.g., to minimize customer wait time). In some implementations, the CCS may refrain from assigning additional items in the case the picker has one or more complete customer orders that are needed. The CCS may also refrain from assigning items for other reasons described herein, such as item/order limits.

The CCS may implement one or more of the unscheduled order prioritization factors described herein. For example, the CCS may implement the factors according to rules, weighted functions, machine learned models/outputs, and/or using other techniques. As such, the example factors and decisions described herein with respect to prioritizing unscheduled orders are only example factors and decisions. Although the CCS may implement unscheduled order prioritization, MSDs may also implement unscheduled order prioritization.

The scheduled orders/items may be represented in different manners in the picking GUIs and/or packing GUIs. For example, items from scheduled and unscheduled orders may be placed into their own groupings in the picking/packing GUIs (e.g., similar to groupings in FIG. 116B). In this example, different orders may also be grouped into separate groups. In some implementations, items from different scheduled and unscheduled orders may be intermixed (e.g., similar to groupings in FIG. 116C). In these implementations, the items may include other indicators that indicate the order type associated with the item. For example, items for unscheduled and scheduled orders may be rendered/labeled in a manner that indicates the type of order that includes the items. As described herein, unscheduled/scheduled items may be rendered or labeled using different text, numbers, words, symbols, colors, or in any other manner that indicates their order type.

In some implementations, the store may use different carriers (e.g., types, colors, labels, etc.) to indicate the carriers are associated with unscheduled/scheduled orders. For example, unscheduled orders may use a specified type of carrier, a different color carrier, a different size of carrier, or have other visibly noticeable differences. In some implementations, the CCS may instruct the picker to take specific carriers (e.g., number of carriers, types, etc.) for unscheduled and scheduled orders. For example, as described herein, the picking GUI may make suggestions as to which carriers should be selected by the picker prior to picking (e.g., based on current and/or predicted orders). The picking GUI may also render the items/orders according to the carriers used. For example, if unscheduled carriers are a specific color in the store, the picking GUI may render the unscheduled items/orders in the specific color. As another example, if unscheduled carriers are a specific type, the picking GUI may render the unscheduled items/orders along with a GUI element that indicates the carrier type (e.g., a cart, basket, etc.).

As described herein, the carriers used for picking orders may vary, depending on a variety of factors. In some implementations, the picking GUI may render items/orders and carriers according to preset rules as to which carriers should be used for picking specific types of orders (e.g., unscheduled orders, scheduled orders, single orders, multi-orders, etc.). In implementations where pickers can pick their own carrier types and indicate the carrier types to the CCS (e.g., manually, by scanning, etc.), the picking GUI may render the items/orders according to the carrier selected by the picker. In a specific example, a picker may scan a shopping cart and a blue basket for picking a scheduled order and any possible additional items, respectively. In this specific example, the picking GUI may render a shopping cart icon on the scheduled order items and a blue basket on the unscheduled additional items (e.g., if any are received). The packing GUI may include similar features as the picking GUI with respect to rendering items, orders, carriers, etc.

The picking/packing GUIs may indicate a variety of additional information described herein with respect to unscheduled and scheduled orders. For example, the picking/packing GUIs may indicate whether the customer (or delivery driver) picking up the order is at the store. As another example, the picking/packing GUIs may indicate the location of the customer (e.g., any location described herein, a distance from the store, and/or potential arrival time to the store). As another example, the picking/packing GUIs may indicate the relative priority of the unscheduled order in a queue (e.g., a number from 1-X, where 1 is the highest priority and larger numbers are lower priority). As another example, the picking/packing GUIs may indicate one or more of the following: 1) the amount of time elapsed since the unscheduled order was placed, 2) an expected time the unscheduled order should be picked, packed, and/or handed to the customer, 3) an amount of time by which the unscheduled order is late (e.g., after the order should have been handed to the customer), 4) a time/slot associated with the scheduled order, and 5) other timing data described herein. In some implementations, a manager or other user may have an interface (e.g., on a manger device) that indicates all the parameters described with respect to unscheduled orders, current picking/packing data, etc.

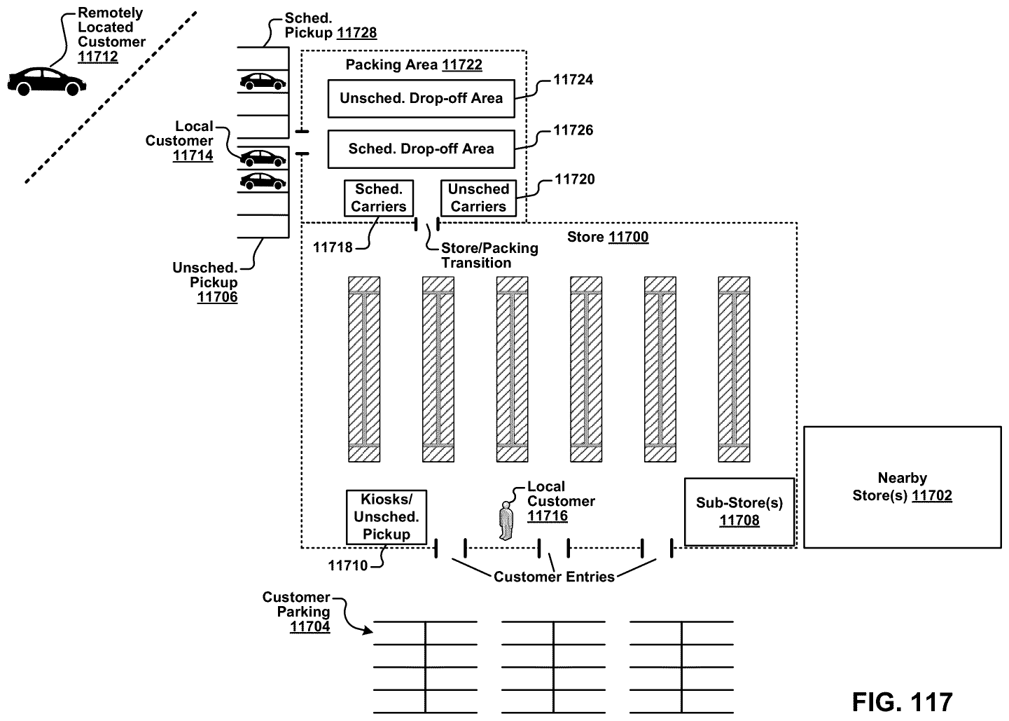

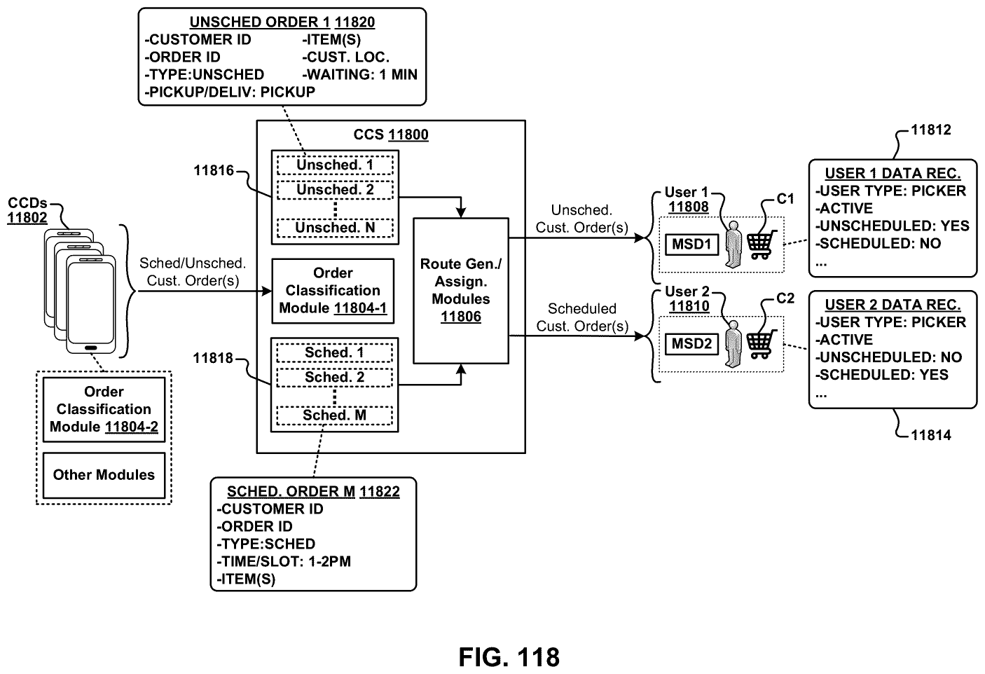

FIGS. 117-118 illustrate example aspects of an OFS that may fulfill scheduled and unscheduled orders. FIG. 117 illustrates an example store 11700 that may provide scheduled orders and unscheduled orders to customers. In FIG. 117, a plurality of customers may place unscheduled orders with the store 11700, assuming the unscheduled orders satisfy eligibility conditions. For example, a customer may place an unscheduled order when they are located outside of the store 11700, such as at home, in their car (e.g., on their way), at a nearby store (e.g., Nearby Store(s) 11702 of FIG. 117), in a customer parking location (e.g., Customer Parking 11704 of FIG. 117), or in an unscheduled pickup location (e.g., Unsched. Pickup 11706 of FIG. 117). As another example, a customer may place an unscheduled order when they are located inside of the store 11700, such as in a sub-store 11708 (e.g., restaurant, bank, etc.) within the store 11700, at a kiosk 11710 placing the unscheduled order, at one or more designated unscheduled pickup locations in the store 11700, or at another location in the store. FIG. 117 illustrates an example remotely located customer 11712 in a car that may place an unscheduled order. FIG. 117 also indicates local customers 11714 parked in cars that may place unscheduled orders from unscheduled pickup locations. FIG. 117 also illustrates a local customer 11716 that may place an unscheduled order in the store 11700 (e.g., using a customer computing device or kiosk).

FIG. 117 illustrates example features that may be included in a store to handle picking and packing of unscheduled orders. For example, the store 11700 in FIG. 117 may use different carriers for scheduled orders and unscheduled orders. In FIG. 117, the store includes locations for storing scheduled order carriers 11718 and unscheduled order carriers 11720 (e.g., in the packing area 11722). The store 11700 in FIG. 117 also includes designated areas in the packing area 11722 for dropping off items/carriers for unscheduled orders 11724 and scheduled orders 11726. In FIG. 117, the store 11700 also provides different outdoor parking areas for picking up unscheduled orders 11706 and scheduled orders 11728. In some cases, a local customer may park their car in the unscheduled order pickup area 11706 and place an unscheduled order to be filled immediately.

FIG. 118 illustrates the placement of unscheduled orders and scheduled orders with a CCS 11800. For example, customers may use customer computing devices (CCDs 11802) to place the scheduled and unscheduled orders with the CCS 11800. The CCS 11800 and/or customer application may include an order classification module 11804-1, 11804-2 that determines whether the customer order is eligible to be classified as an unscheduled order. After classifying the orders as scheduled or unscheduled, the CCS 11800 (e.g., a route generation/assignment module 11806) may assign the orders/items to one or more pickers. For example, the CCS 11800 may assign the orders/items to pickers based on whether the pickers are designated as scheduled order pickers or unscheduled order pickers. FIG. 118 illustrates example user data for user 1 11808 and user 2 11810 (e.g., user 1 data record 11812 and user 2 data record 11814). The example user data indicates that user 1 and user 2 are active pickers. User 1 may receive unscheduled orders. User 2 may receive scheduled orders. The CCS 11800 may include additional/alternative modules and data structures (e.g., other than those illustrated herein) that provide functionalities associated with fulfilling scheduled/unscheduled orders.

The received customer orders may be stored at the CCS 11800. The CCS 11800 in FIG. 118 includes N unscheduled orders 11816 and M scheduled orders 11818 to be assigned. In some implementations, the unscheduled orders 1-N may be prioritized in a queue. The unscheduled orders and scheduled orders may have associated order data described herein (e.g., unscheduled order data and scheduled order data). For example, the unscheduled order data (e.g., unscheduled order data record 1 11820) may include an associated customer ID, order ID, an order type (e.g., unscheduled), and a list of ordered items. The unscheduled order data in FIG. 118 also includes a pickup/delivery indicator that indicates whether the order is for pickup or delivery (e.g., unscheduled order 1 in FIG. 118 is for pickup). The unscheduled order data 1 in FIG. 118 also indicates a customer location, such as a current location of the customer and/or an expected pickup location for the order. The unscheduled order data 1 also indicates that the customer has been waiting 1 minute for the order. Scheduled order M (e.g., scheduled order M data record 11822) includes a customer ID, order ID, an order type indicator (e.g., scheduled), an expected time slot of 1-2 PM for customer pickup, and a list of items. The example order data records in FIG. 118 include a subset of example order data described herein. As such, order records may include additional/alternative data other than illustrated in FIG. 118. The order records may be updated by the CCS in real time in response to changing conditions (e.g., customer location, wait times, etc.).

The customer application includes a customer GUI that may allow the customer to place scheduled orders or unscheduled orders. As described herein, the user may indicate that the order is to be unscheduled or scheduled prior to adding items to the order, while adding items, and/or after the items have all been added. In some implementations, the customer application may include GUI elements the customer may use to manually select scheduled or unscheduled. For example, the customer application may include an unscheduled order selection button (e.g., an “Immediate Pickup” button) and a scheduled order selection button that the user may select to indicate whether they want to place an unscheduled order or a scheduled order.

In some implementations, the CCS and/or the customer application may automatically determine whether the user is eligible to place an unscheduled order. The customer application may indicate a user's eligibility to place the unscheduled order at any time before, during, or after the items have all been added. The customer application may also provide information to the user regarding their eligibility (e.g., in a GUI), such as indicating the customer is not eligible to place the order due to their item count and/or their distance from the store.

In some implementations, the customer may select the option of putting together an unscheduled order prior to adding items to the order. For example, the customer application GUI may initially provide the customer with GUI elements for selecting “For immediate pickup” or “Schedule an order for later pickup.” In one example, the customer application may present the user with such a GUI prior to showing the user items for selection. In another example, the customer application may present the user with the unscheduled/scheduled order selection GUI button while the customer is selecting items for their order.

Selecting an unscheduled order button may cause the customer device to perform an eligibility determination locally and/or via communication with the CCS, depending on whether the customer application and/or the CCS determine eligibility. The CCS and/or customer application may then determine that the customer is eligible or ineligible to place an unscheduled order. The customer application may begin receiving additional items in the unscheduled customer order if the customer is eligible to place the unscheduled order. If the customer is ineligible to place the unscheduled customer order, the CCS and/or customer application may notify the customer that they are not eligible. In some cases, instead of allowing the customer to select the GUI button for placing an unscheduled order, if the customer is ineligible, the customer application GUI may remove the unscheduled order button from the customer GUI, gray out and inactivate the unscheduled order button, or otherwise make an unscheduled order un-selectable by the customer. In some implementations, if the customer is ineligible to place an unscheduled order, the customer application may automatically send the customer into an interface for placing a scheduled order. Similarly, if the customer is eligible to place the unscheduled order and is at/near the store (e.g., within a threshold distance/time from the store), the customer application may automatically put the customer into the unscheduled order interface under the assumption that the customer may wish to place an order for immediate pickup. The customer may exit an unscheduled/scheduled order interface and later select a scheduled/unscheduled order at any time.

In some implementations, the customer application may open to an interface for placing a scheduled order or an unscheduled order, depending on eligibility. For example, the customer application may immediately open to an unscheduled pickup interface if the customer is located at/near the store (e.g., within a threshold distance/time of the store). In a specific example, the customer application may open to the interface in response to a customer executing the customer application (e.g., by selecting a customer application icon on a device screen).

In some implementations, the customer application may provide additional information along with the selection GUI elements. For example, the customer application GUI may indicate the eligibility parameters for placing an immediate order. In a specific example, a customer application GUI may indicate that the unscheduled order may be placed if the item number is limited to a threshold number of items (e.g., 10 or fewer items). In some implementations, the customer application GUI may indicate why the customer is not eligible (e.g., “You are located too far from the store”). In these implementations, the customer application GUI may indicate how the customer may become eligible (e.g., “You need to be at the store to place an immediate order.”).

In some implementations, the customer application may receive customer selection of one or more items after providing the customer with the option to select a scheduled or unscheduled order. The customer application may update the option for a scheduled or unscheduled order based on the addition of one or more items to the user's online shopping list. For example, if the addition of the item(s) negates eligibility for an unscheduled order, the customer application may remove the option of an unscheduled order. In the case the customer had previously selected an unscheduled order, the order may transition to a scheduled order. In some implementations, the customer application GUI may indicate which customer behaviors (e.g., item additions) will negate eligibility for an unscheduled order. In some implementations, the customer application GUI may notify the customer that a specific action negates eligibility (e.g., after item selection, the GUI may indicate that “Adding this item will require a scheduled order”). The customer application may provide the customer with the option to manually select unscheduled or scheduled order status at any time prior to, during, or after selecting items, assuming the current order being put together by the customer is eligible. In some implementations, the customer application may present a GUI for finalizing the customer order after adding all items. The GUI for finalizing the order can include the option to place the order as a scheduled or unscheduled order.

In some implementations, the CCS and customer application may communicate with one another to determine and/or indicate eligibility to the customer in the customer application. For example, in some implementations, the customer application may make an eligibility request to the CCS to determine whether the customer order is eligible to be an unscheduled order. The customer application may make an eligibility request at any time the customer application is open and/or while operating in the background. The CCS may determine eligibility and send an eligibility response to the customer application indicating the determined eligibility status. One or more response/request cycles may be performed before, during, and/or after the customer adds items to their shopping list. In some implementations, the customer application may make a determination locally on the customer device without making a request to the CCS, such as when the customer application may determine eligibility (e.g., based on item number, customer location, etc.). The requests/responses may be triggered by various events, such as a change in location of the customer and/or a change in the items added to the customer's shopping list. In some implementations, the requests/responses may occur at set time periods (e.g., every X seconds). FIG. 120 illustrates example requests/responses between a customer device and a CCS.

In some implementations, the customer application GUI may indicate a location for pickup of the unscheduled/scheduled order. In some implementations, the customer application GUI may indicate an amount of time that will be required to have the order ready for pickup. The CCS may determine a time at which the unscheduled order will be complete and provide it to the customer application. The CCS may estimate the time to complete picking the customer order based on at least one of 1) a length of a route being used to pick the order, 2) a number of items in the order, 3) past picker times for completing a route, 4) when the order will be assigned according to priority, 5) a number of pickers available, and/or 6) other factors described herein. The CCS and/or customer application may estimate and present the time for order completion in a variety of ways, such as an estimated time of day and/or an estimated wait time (e.g., in terms of minutes and seconds). The estimated wait time may be presented to the customer regardless of location. For example, an estimated wait time may be presented to the customer at home so they can determine whether to drive to the store and place an unscheduled order. In some implementations, the customer application GUI, based on data generated by the CCS, may show how quick (e.g., on average) unscheduled orders have been picked recently.

In some implementations, the customer application GUI may indicate one or more statuses associated with unscheduled orders. For example, the customer application GUI may indicate aggregate data associated with unscheduled orders. In a specific example, the customer application and/or CCS may determine whether unscheduled orders will likely remain open based on factors associated with unscheduled order eligibility parameters. For example, the customer application GUI may show an available picking capacity for picking the orders (e.g., as a percentage of available pickers), an estimate of whether unscheduled orders will remain available, and/or an estimate of how long unscheduled orders may remain available.

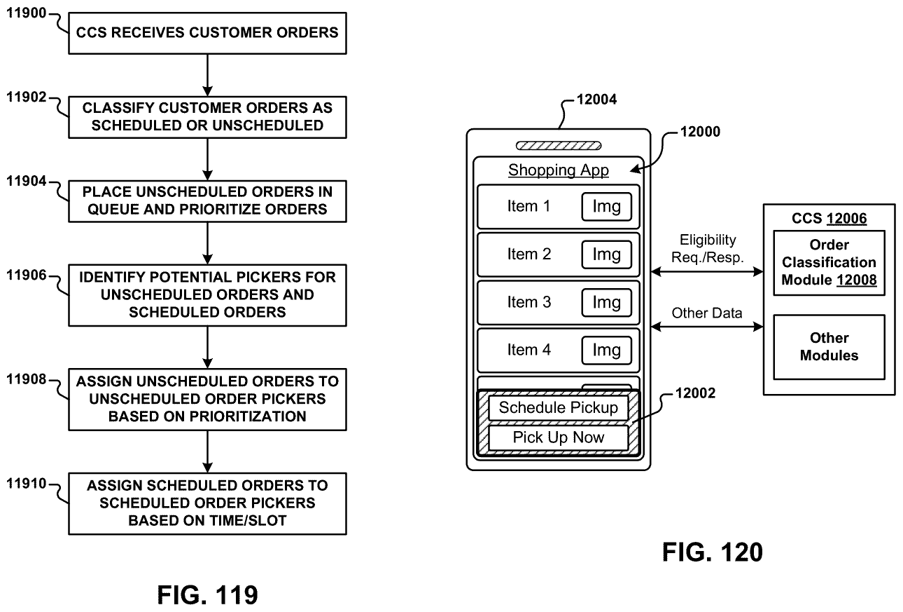

FIG. 119 illustrates an example method that describes handling of scheduled orders and unscheduled orders. In block 11900, the CCS receives customer orders. In block 11902, the CCS (e.g., the order classification module 11804-1) may classify customer orders as scheduled orders or unscheduled orders. In block 11904, the CCS (e.g., the order classification module 11804-1) may place the unscheduled orders in a queue and determine a priority level of the unscheduled orders in the queue, as described herein. In block 11906, the CCS (e.g., route generation and assignment modules 11806) identifies potential pickers for the unscheduled orders and scheduled orders. In block 11908, the CCS assigns unscheduled orders to unscheduled pickers based on prioritization of the unscheduled orders (e.g., higher priority orders assigned first). In block 11910, the CCS assigns scheduled orders to scheduled order pickers based on the times/slots associated with the scheduled orders. In some implementations, as described herein, the CCS may assign scheduled/unscheduled orders to unscheduled/scheduled pickers under some circumstances.

FIG. 120 illustrates an example customer application GUI 12000 showing a plurality of items (e.g., items 1-4 and possible additional items offscreen). FIG. 120 illustrates an example GUI 12000 in which a user may select items for addition to their online shopping cart. The GUI 12000 in FIG. 120 may also represent a GUI in which a customer is reviewing items already in their online shopping cart.

In FIG. 120, the customer application GUI 12000 indicates at 12002 that the user may “Schedule Pickup” or “Pick Up Now.” As described herein, selecting the Schedule Pickup GUI element may provide the user with an option of scheduling an order. Selecting the Pick Up Now GUI element may place an unscheduled order for immediate pickup. As described herein, a change in eligibility (e.g., due to customer movement, additional items, etc.) may cause the GUI 12000 to change. For example, the Pick Up Now GUI element may be grayed out or removed in the case the customer becomes ineligible to place an unscheduled order.

The customer computing device 12004 in FIG. 120 (e.g., the customer application) may communicate with the CCS 12006 before, during, or after the customer has finished adding items to their online shopping cart. For example, the customer computing device 12004 may provide a variety of data to the CCS 12006, such as a customer ID, selected items, geo data, and other data described herein that the CCS 12006 may use to determine whether the customer is eligible to place an unscheduled order.

In some implementations, the customer device 12004 (e.g., customer application) may make eligibility requests to the CCS 12006 requesting an indication from the CCS 12006 as to whether the customer is eligible to place an unscheduled order. In some implementations, the eligibility requests may include some/all of the data used by the CCS 12006 to determine eligibility to place an unscheduled order. In some implementations, the CCS 12006 (e.g., order classification module 12008) may provide a response to the customer device 12004 that indicates whether the customer may place an unscheduled order. In some implementations, the CCS 12006 may provide the response data in response to receiving the request. In some implementations, the CCS 12006 may indicate to the customer device 12004 (e.g., customer application) whether an unscheduled order may be placed in response to other factors (e.g., other than an explicit eligibility request).

As described herein, a customer application GUI may include additional/alternative information not illustrated in FIG. 120, such as factors that may cause the order to be ineligible as an unscheduled order, factors that may make the order eligible to be an unscheduled order, notifications to the customer of when the items are being picked, an estimated completion time, and other information.

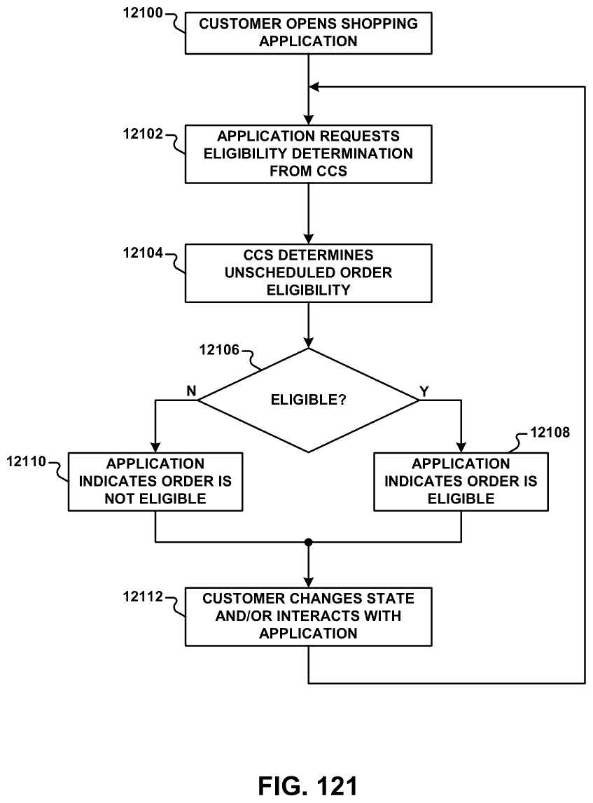

FIG. 121 illustrates a method that describes example operations of the customer application and the CCS with respect to scheduled and unscheduled orders. In block 12100, the customer opens the customer shopping application. In block 12102, the customer application requests an unscheduled order eligibility determination from the CCS. Although the customer application may request an eligibility determination upon opening, the customer application may request an eligibility determination at additional/alternative times, as described herein. Additionally, or alternatively, the customer application may make a local eligibility determination in some implementations.

In block 12104, the CCS determines whether the customer order is, or will be, eligible to be an unscheduled order. If the customer order is eligible to be an unscheduled order in block 12106, the CCS may indicate eligibility to the customer application, which in turn may indicate it to the user in the customer application GUI in block 12108. If the customer order is not eligible to be an unscheduled order in block 12106, the CCS may indicate ineligibility to the customer application, which in turn may indicate it to the user in the customer application GUI in block 12110.

In block 12112, the customer may change their state and/or interact with the application after the eligibility determination. For example, a customer may change their state by changing their location, direction of travel, or other parameter that determines eligibility (e.g., paying a fee for unscheduled orders). The customer may interact with the customer application by adding items or deleting items, for example. A change in customer state and/or interaction with the customer application may cause the application/CCS to perform another eligibility determination. The new eligibility determination may be the same as the previous determination or eligibility may change. As described herein, other factors may affect eligibility, such as store factors outside of the customer's control (e.g., a number of pickers, current unscheduled orders, etc.).

In some implementations, a scheduled order may be transitioned to an unscheduled order. For example, a user may interact with the customer application GUI to change a scheduled order to an unscheduled order (e.g., assuming the order is eligible). In some implementations, the customer application GUI may provide a GUI element (e.g., a button) to transition a scheduled order to an unscheduled order. The customer may perform such an action if they have a scheduled order that is pending for a future pickup (e.g., hours or days away), but would like to pick up the items immediately. For example, if the customer is close to the store (e.g., driving by), the customer may transition their originally scheduled order to an unscheduled order for immediate pickup.

In some implementations, an unscheduled order may be transitioned to a scheduled order. For example, a user may interact with the customer application GUI to change an unscheduled order to a scheduled order. In some implementations, the customer application GUI may provide a GUI element (e.g., a button) to transition an unscheduled order to a scheduled order. The customer may perform such an action if they have an unscheduled order placed, but change their mind regarding placing the unscheduled order. In some implementations, if items from the unscheduled order are picked, the picked items may be dropped off in the packing area and stored for later integration into the scheduled order.

In some implementations, the CCS/TPCS may classify some customer orders as scheduled customer orders for delivery (“scheduled delivery orders”). The CCS/TPCS may also classify some customer orders as unscheduled customer orders for delivery (“unscheduled delivery orders” or “immediate delivery orders”). To differentiate scheduled/unscheduled customer orders for customer pickup from scheduled/unscheduled customer orders for delivery, unscheduled customer orders for pickup and scheduled customer orders for pickup may be referred to as “unscheduled/immediate pickup orders” and “scheduled pickup orders,” respectively.

In some implementations, the techniques associated with submission and handling of unscheduled/scheduled pickup orders may apply to submission and handling of unscheduled/scheduled delivery orders. For example, pickers and/or packers may be designated for scheduled/unscheduled delivery orders. As another example, the store may use specific carriers for scheduled/unscheduled delivery orders. As another example, the store may have dedicated areas for storing empty and used carriers. As another example, the picker and packer interfaces may indicate that orders/items are for scheduled/unscheduled delivery orders. As another example, some of the same eligibility conditions, or similar eligibility conditions, may be used to determine whether a customer order is eligible to be an unscheduled delivery. Although similar techniques may be used to fulfill unscheduled/scheduled pickup and delivery orders, additional/alternative techniques may be used for pickup and delivery, such as different eligibility conditions.

An unscheduled delivery order may refer to a customer order that will be immediately picked, packed, and delivered. For example, an unscheduled delivery order may be a customer order that may be picked, packed, and provided to a delivery driver within less than a threshold amount of time. Delivery times for an unscheduled delivery order may vary (e.g., due to traffic, delivery distance, number of deliveries, etc.). In some implementations, unscheduled delivery orders may also be expected to be delivered within less than a threshold amount of time from customer placement of the order. After placing an unscheduled delivery order, the customer may have an expectation that the order be picked, packed, and immediately sent out for delivery. The customer may also have an expectation that the order be delivered within a threshold period of time, which may vary depending on the customer's location, traffic conditions, current store order volume, and/or other factors.

A scheduled delivery order may refer to a customer order that will be associated with picking, packing, and/or delivery at a time that is farther out in the future than an unscheduled order, such as later in the day, week, month, etc. For example, a scheduled delivery order may be a customer order that is picked, packed, provided to a delivery driver, and/or delivered to a customer's home according to one or more scheduled times (e.g., scheduled times specified by the customer). A scheduled delivery order may be picked, packed, presented to the delivery driver, and/or delivered at a time that is greater than a threshold amount of time from the present time. For example, whereas an unscheduled (i.e., immediate) delivery order may be picked, packed, and handed off for delivery immediately (e.g., within less than a threshold period of time after the customer places the order), a scheduled order may be picked, packed, and handed off for delivery based on a future scheduled delivery time (e.g., greater than a threshold period of time in the future) at a customer's location. For a scheduled delivery order, the picking (e.g., start of picking) and/or packing may also be scheduled based on the specified delivery time.

In some implementations, a customer may set a schedule for a scheduled delivery order. For example, the customer may set a time and/or time window for receipt of the scheduled delivery order in the customer application GUI. In this example, the customer may specify a time/window for delivery and or select one of a set of times/windows provided by the customer application GUI (e.g., as determined based on availability by the CCS). The customer may also select a location for receipt of the scheduled delivery order in the customer application GUI. For example, the customer may select a previously used location (e.g., a home address, business address, or other address), a current customer location (e.g., using GPS location), or another location (e.g., a specified future location using an address and/or GPS). The customer may expect that the customer order arrive at their location (e.g., home or other specified location) at the specified time, or within a specified time window, such as a window that is before/after the expected time within a threshold amount (e.g., a 15 minute window from within a scheduled time, or within a 30 minute defined window).

In some implementations, the CCS/TPCS may determine the time at which a scheduled delivery order should be picked, packed, and presented to a driver for delivery based on the customer-specified scheduled delivery time. For example, based on the scheduled delivery time window, the CCS may subtract an expected transit time for the customer order from the store to the delivery location (e.g., a customer's home) to determine when the customer order should be packed and ready for a delivery driver. The CCS may determine the expected transit time based on at least one of: 1) a transit distance from the store to the delivery location, 2) an expected amount of traffic at the time of delivery, 3) the sequence of preceding orders (e.g., if any other orders are to be delivered on the route), and 4) an amount of time associated with delivering any prior orders (e.g., if prior orders are to be delivered).

Based on a determined time at which the scheduled delivery order should be ready for delivery, the CCS may determine a time by which the scheduled delivery order should be packed. For example, the latest time at which the scheduled delivery order should be packed should be at the latest time the scheduled delivery order should be ready for delivery. In this example, the CCS may be configured to estimate a picking and packing time associated with the scheduled delivery order. The CCS may then subtract the estimated picking and packing time from the time at which the scheduled delivery order should be packed and ready for delivery in order to determine a latest assignment time for the scheduled delivery order. In the case of a scheduled delivery order, the CCS may assign the scheduled delivery order at any point prior to the latest assignment time.

Although scheduled delivery orders are described herein as being scheduled and calculated for a specified delivery at the customer's desired location, in other implementations, other scheduled delivery times may be specified. For example, a customer may specify a time at which the driver should leave the store (e.g., under the assumption that the customer expects some transit time). In another implementation, the customer may schedule a scheduled delivery order by specifying a time that the order should be picked, packed, and delivered. Although customer orders may be associated with times/slots for pickup by a customer, in some implementations, customer orders may be associated with a pickup time or pickup time slot that indicates when a delivery driver is expected to pick up the packed customer order (i.e., a driver pickup time/slot).

Unscheduled delivery orders may be associated with an order data record that includes data associated with unscheduled delivery orders described herein. For example, an unscheduled delivery order data record may include at least one of: 1) data indicating that the customer order is an unscheduled delivery order, 2) a priority value (e.g., a sequence value in a queue), 3) a customer location for delivery, and other data.

Scheduled delivery orders may be associated with an order data record that includes data associated with scheduled delivery orders described herein. For example, a scheduled delivery order data record may include at least one of: 1) data indicating that the customer order is a scheduled delivery order, 2) a customer location for delivery, 3) a customer-specified delivery time/window for the delivery, 4) estimated picking and/or packing times associated with picking/packing the order prior to delivery, and other data.

The CCS/TPCS and/or the customer application may determine whether a customer order is eligible to be classified as an unscheduled delivery order based on satisfaction of one or more eligibility conditions (i.e., “unscheduled delivery eligibility conditions” or “unscheduled delivery conditions”). The picking, packing, and delivery services may be performed by one or more users that may be associated with one or more parties (e.g., the store and/or one or more third parties). In a first example, in some implementations, one or more store employees may pick, pack, and deliver a customer order. In a second example, in some implementations, one or more store employees may pick and pack the order. In the second example, another party (e.g., a third party) may deliver the order to the customer. In a third example, in some implementations, one or more third party pickers may pick the customer order and deliver the customer order. In a fourth example, one or more third party pickers may pick the customer order and the store employee(s) may deliver the order. In some implementations, the picking and packing may be shared by multiple parties, such as a combination of store employee pickers and third-party pickers. The CCS and/or TPCS may make unscheduled delivery eligibility determinations described herein, depending on which parties pick, pack, and deliver the customer orders. In some implementations, if the store and a third party are involved with picking, packing, and delivery, the CCS and TPCS may share data with one another to make the eligibility determinations described herein.

The unscheduled delivery eligibility conditions may be satisfied in cases when the customer order can be picked, packed, and sent out for delivery immediately (e.g., within less than a threshold period of time). Example unscheduled delivery eligibility conditions that may help ensure quick picking, packing, and delivery departure described herein may include, but are not limited to, store conditions indicating picking eligibility, packing eligibility, and driver eligibility (e.g., driver availability conditions). In some implementations, the unscheduled delivery eligibility conditions may include some eligibility conditions described herein with respect to unscheduled pickup orders (e.g., item limits, restrictions based on time of day, current store performance, store busyness, payment eligibility, etc.), as satisfaction of some of the unscheduled pickup eligibility conditions may ensure that the customer order can be provided to a driver at the store (e.g., instead of a customer at the store) within a short period of time. In these implementations, the driver eligibility conditions for unscheduled delivery may be viewed as a set of one or more additional conditions associated with driver availability which may be required for an immediate delivery to the customer. In some implementations, unscheduled delivery eligibility conditions may also require that the route from the store to the delivery location is short enough to satisfy the customer's expectations (e.g., the delivery time is estimated to be less than a threshold acceptable delivery time). Example unscheduled delivery eligibility conditions that may help ensure a quick delivery may be referred to herein as route eligibility conditions.

The unscheduled delivery conditions may include store conditions indicating whether pickers and packers are available to pick and pack the orders. Example store conditions described herein may include, but are not limited to, a number of available pickers (e.g., pickers available to pick unscheduled delivery orders), a number of available packers (e.g., packers available to pack unscheduled delivery orders), current picking bandwidth, and other store conditions described herein.

The unscheduled delivery conditions may include one or more driver eligibility conditions that may apply to employee drivers for the store and/or third-party delivery drivers. In one example, a driver eligibility condition may be satisfied based on the location of a driver relative to the store. For example, a driver eligibility condition may be satisfied if a driver is located at the store and waiting for a customer order to deliver. In another example, a driver eligibility condition may be satisfied if an available delivery driver is within a threshold distance/time from the store, such that the delivery driver can be at the store to deliver the unscheduled delivery order when it is packed or within a threshold amount of time after it is packed. In some implementations, drivers may confirm their availability to deliver the customer order (e.g., using a driver computing device, such as a smartphone).

In some implementations, driver eligibility conditions may be based on a number of drivers and a number of pending customer orders for delivery. For example, in some implementations, driver eligibility conditions may be based on a number of pending customer orders that require delivery (e.g., scheduled and unscheduled) and the number of drivers required to deliver the pending customer orders. If the number of pending orders are greater than a number of orders that may be handled by available drivers, the customer order may be ineligible to be placed as an unscheduled delivery order.

In some implementations, the customer application GUI may indicate to the user that the customer will no longer be eligible to place the unscheduled delivery order when the driver leaves the store. In these implementations, the customer application GUI may provide an estimated time at which unscheduled order delivery will likely become unavailable. The time at which the unscheduled delivery order will become unavailable may be estimated by the CCS based on an estimated amount of time needed to pick and pack orders. The time at which the unscheduled delivery order will become unavailable may also be set by the driver and/or the CCS.

In some implementations, the CCS/TPCS and/or customer application may determine eligibility for unscheduled delivery for a new order based on current or near future delivery routes for other scheduled and/or unscheduled orders. For example, if one or more scheduled delivery orders are due to be delivered at the present time (e.g., within a threshold amount of time), the CCS may be configured to accept unscheduled delivery orders that may be added to the current route(s) for the scheduled delivery orders. In a specific example, if three orders are scheduled for delivery in the very near future, the CCS may accept one or more unscheduled delivery orders that may be delivered along with the scheduled delivery orders (e.g., delivered within less than a threshold deviation in distance and/or time of the scheduled orders). Adding unscheduled delivery orders to current delivery routes (e.g., pre-set delivery routes and/or other routes created in response to recently received orders) may improve sales and driver efficiencies.

In some implementations, the CCS/TPCS may limit the placement of unscheduled delivery orders based on the location of the customer relative to the current/upcoming route(s). For example, the CCS/TPCS may require that unscheduled delivery orders should be on/near an existing route to be eligible for unscheduled delivery. Example eligibility conditions for adding an unscheduled delivery order to an existing route may include, but are not limited to: 1) the addition of the new delivery location should not deviate greater than a threshold distance from the current route, 2) the new delivery location should not deviate greater than a threshold amount of time from the current route, 3) the new delivery location should not add greater than a threshold distance to the total route, 4) the new delivery location should not add greater than a threshold expected time for delivery to the current route, and 5) the new unscheduled delivery order and other orders on the current route can be delivered to the customers within acceptable time limits to meet expectations of the customers (e.g., scheduled orders should be within an expected window and the unscheduled delivery order should be delivered within a threshold amount of time).

In some implementations, the CCS/TPCS and/or customer application may include delivery location eligibility conditions for unscheduled delivery orders. For example, an unscheduled delivery order may be limited to a location that is a threshold distance from the store and/or a threshold amount of time from the store. The location eligibility conditions may be specified in distance, time, and/or in another manner (e.g., city name, street name, etc.). In some cases, an operator of the OFS (e.g., a store manager) may specify the location eligibility conditions. In some implementations, if a customer order is not eligible to be classified as an unscheduled delivery order for one store, the CCS may be configured to recommend another store for which the customer order could be classified as an unscheduled delivery order (e.g., based on store location and/or other delivery eligibility conditions). Similarly, if a customer order is not eligible to be classified as an unscheduled delivery order by one party (e.g., a store or third party operator), the CCS/TPCS may recommend another party that may provide services that can complete the unscheduled delivery order (e.g., a store may recommend a third party delivery service or vice versa).

In some implementations, the location eligibility conditions may include specific locations that are eligible for unscheduled delivery. Example specific locations may include specific drop-off locations, such as containers (e.g., locked containers) arranged throughout a city for package dropoff. Other example specific locations may include specific businesses (e.g., nearby businesses).

A TPCS may use similar or different eligibility conditions than the CCS. For example, in some cases, a TPCS may use additional eligibility conditions associated with the TPCS business model. In a specific example, an eligibility condition may include a third-party picker condition that is satisfied if the third-party picker is able to arrive at the store in time to pick the order and subsequently deliver the order, whereas a picker employed by the store may remain in the store. The CCS and TPCS may share data with one another in order to make the unscheduled order determinations described herein (e.g., unscheduled orders for pickup and/or delivery). In some implementations, eligibility conditions may include conditions from both the store and the third party. For example, the conditions for delivery may be based on both the store and third-party determinations, such as first eligibility conditions for store picking and second eligibility conditions for third party delivery.

In some implementations, as described with respect to unscheduled pickup orders, the store (or third party) may have pickers, packers, and/or drivers that are designated for handling unscheduled delivery orders (i.e., “unscheduled delivery pickers,” “unscheduled delivery packers,” and/or “unscheduled delivery drivers”). In other implementations, the store may not have specific pickers, packers, and drivers for unscheduled deliveries. In some implementations, as described with respect to unscheduled pickup orders, the MSDs used by the pickers and packers may indicate that items are for unscheduled delivery orders (e.g., using text, color, or other rendering).

In some implementations, as described with respect to unscheduled pickup orders, the store may use specific carriers for unscheduled delivery orders. Such carriers may differ from carriers used for scheduled delivery orders. For example, the carriers may differ in type, size, color, or in another visible manner (e.g., markings, tags, etc.). The unscheduled delivery carriers may be indicated/rendered differently in the MSD GUIs for picking, packing, and/or delivery. In some implementations, as described herein with respect to unscheduled pickup orders, the store may have specific locations for storing empty unscheduled delivery carriers. The store may also have specific areas for placing unscheduled delivery carriers including items (e.g., designated locations in the packing area).

In some implementations, unscheduled delivery orders may be placed into a queue (i.e., an “unscheduled delivery order queue”). In some implementations, the unscheduled delivery orders may be handled on a first come, first serve basis. In some implementations, the unscheduled delivery orders may be handled in another manner. For example, the unscheduled delivery orders may be prioritized using similar prioritization factors described herein with respect to unscheduled pickup orders. In some implementations, a scheduled delivery order may be prioritized over an unscheduled delivery in the case that the time/slot associated with the scheduled delivery is upcoming or at the present time.

In some implementations, an unscheduled delivery may be prioritized to a greater extent if the order can be delivered efficiently with another scheduled or unscheduled delivery. For example, a newer lower priority unscheduled delivery order may be prioritized for picking and delivery with another scheduled or unscheduled delivery when the newer unscheduled delivery order is along the same route (e.g., on or within a threshold distance/time) as prior orders. In a specific example, the CCS may generate a first route for a first set of deliveries. In this specific example, a newly received customer order may be prioritized for picking if the newly received customer order can be delivered on the first route or with a minimum deviation from the first route (e.g., less than a threshold deviation, total distance, and/or time).

The customer application may provide GUI elements for selecting an unscheduled delivery or a scheduled delivery. For example, the unscheduled delivery text (e.g., “Deliver Now” or “Deliver now to your door!”) may be different from the scheduled delivery text (e.g., “Schedule a Delivery” or “Set up a delivery time”). In some implementations, the customer application GUI may provide GUI elements for scheduled and unscheduled pickup and deliveries (e.g., 4 separate GUI buttons). In some implementations, the customer application GUI may make some of the pickup/delivery options unavailable, such as when the customer is not eligible to place unscheduled pickup and/or delivery orders. In some implementations, the customer application GUI may provide the customer with a bifurcated selection for unscheduled/scheduled and pickup/delivery. For example, a first GUI may request the customer to indicate whether they would like pickup or delivery. In the second GUI (e.g., a subsequent GUI), the customer may select whether they would like their order scheduled or immediate. Similarly, a first GUI may request the customer to indicate whether they would like an order to be immediate or scheduled. In this example, a second GUI may indicate whether the order is pickup or delivery.

In some implementations, the customer application may automatically select unscheduled/scheduled and pickup/delivery. For example, if the user is at the store or on their way to the store, the CCS and/or customer application may automatically present a GUI element for selecting an unscheduled pickup and/or automatically place the customer into a page for adding items to an unscheduled pickup order. In another example, if the user is at home, which is near the store, the customer application GUI may automatically present a GUI element for selecting unscheduled delivery and/or automatically place the customer into a page for adding items to an unscheduled delivery.

In some implementations, the CCS and/or customer application may provide the user with pickup and delivery options based on previously placed orders and other factors (e.g., customer location). For example, the customer application may default to the previous order type (e.g., scheduled/unscheduled pickup/delivery). As another example, the customer application may automatically select the order type based on the customer's previous order type(s) and location(s) associated with the previous order types. For example, if the customer placed one or more unscheduled delivery orders at home, the customer application may automatically select an unscheduled delivery order for the customer if the customer is currently at home. As described with respect to scheduled/unscheduled pickup orders, eligibility and associated GUIs for scheduled/unscheduled delivery orders may change based on changes in conditions.

In some implementations, the CCS/TPCS may suggest that the customer use a different store to fulfill an unscheduled pickup/delivery order. The suggestion may be reflected in the customer application GUI. For example, if the customer is ineligible to place an unscheduled pickup/delivery at a selected store, the CCS/TPCS may determine that the customer would be eligible to place the unscheduled pickup/delivery at another store (e.g., another nearby store). The CCS/TPCS may use shared/collected data for other stores in order to make an eligibility determination for another store.

The OFS may implement multiple different order fulfillment procedures (i.e., “fulfillment procedures”). The different fulfillment procedures may include different workflows for the users (e.g., pickers and/or packers). For example, the OFS may implement multiple different procedures for picking items, scanning items, packing items, and/or providing items/orders to customers. In one example, the different fulfillment procedures may include a different number of item scans for fulfilling a customer order from when the items are picked until the items are presented to the customers. Item scans, or manual item entries, may also have different meanings within the context of the different fulfillment procedures.

The different fulfillment procedures may also provide different customer experiences. For example, some orders may be picked, packed, and then presented completely to the customer at their pickup location (e.g., in their car). In another example, some items may be picked in the store and scanned at the customer pickup location (e.g., at the customer's car), such as when the item was requested for rapid fulfillment or when the item may require customer approval. In some implementations, the different order fulfillment procedures may use specific pickers/packers, specific carriers (e.g., carrier type, color, etc.), specific MSDS, and/or specific GUIs.

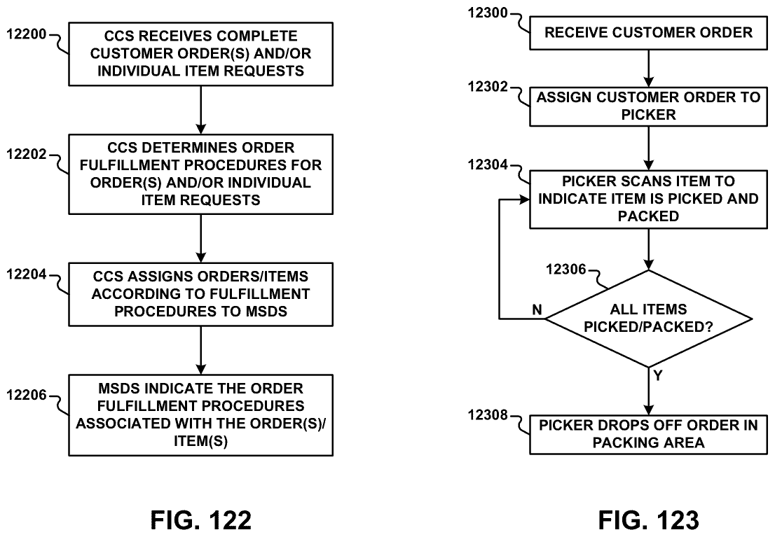

The different fulfillment procedures may be used for different scenarios, such as different sizes of orders, different types of orders (e.g., scheduled/unscheduled, newly added items, substitutions, etc.), and/or different types of items (e.g., customer hand-selected items). For example, the OFS may use a first fulfillment procedure and a second fulfillment procedure for a first type of order (e.g., a scheduled order) and a second type of order (e.g., an unscheduled order), respectively. A variety of different scenarios and order fulfillment procedures are described herein (e.g., see FIGS. 122-128). The different fulfillment procedures may provide flexibility and efficiency for a variety of customer order options at the store.

A variety of types of item scans and manual item entries are described herein. In one example, a user may scan an item before, while, or immediately after removing the item from a rack. In this example, an item scan may indicate that the item has been picked from the rack and that a user (e.g., a picker) is in possession of the item. In another example, a user (e.g., a packer) may scan an item in the packing area. An item scan in the packing area may indicate that the item has been packed into an appropriate order. For example, a packer may scan an item to indicate that they have merged the item into another order, or otherwise integrated the item into the customer order for presentation to the customer.

Other types of item scans may also be implemented. For example, a user may scan an item to indicate that they have dropped off the item in a location (e.g., a packing area, dynamic location, pre-set location, etc.). As another example, a user may scan an item to indicate that they have acquired a dropped-off item or received an item from another user.

In some implementations, the user may scan a carrier (e.g., scan a barcode, RFID, and/or acquire an image of a carrier) or manually enter a carrier ID into an MSD. A variety of types of carrier scans are described herein. In one example, a user (e.g., picker/packer) may scan a carrier to indicate that the user is placing an item into the carrier (e.g., an item being picked or packed). In one example, a user (e.g., picker/packer) may scan a carrier to indicate that the user is pulling one or more items out of the carrier (e.g., an item being picked or packed). In another example, a user may scan a carrier to indicate that the user has dropped off the carrier in a location. In another example, a user may scan a carrier to indicate that the user has picked up the carrier. In this example, the CCS may determine that the user is in control of the carrier and the item(s) included in the carrier. In one example, if multiple carriers are in the packing area for a single order, a user (e.g., picker/packer) may scan the one or more carriers as the user is collecting items for the customer order. Each scan may indicate to the CCS that the carriers are being collected together into a customer order.

In some implementations, a user may make order-level scans or manual entries into an MSD that indicate actions with respect to an entire customer order. For example, an order ID (e.g., barcode, RFID, or other ID) may be scanned by a user to indicate that the user has taken control of the carriers/items for a customer order. As another example, a user may make an order-level scan to indicate that the user is transferring, or has transferred, the customer order to the customer.

In some implementations, users may scan items at a customer pickup location and/or make manual entries for items at a customer pickup location. For example, a user may scan items in the presence of the customer (e.g., in front of the customer) before handing the items over to the customer. Scanning an item in front of the customer (e.g., in view of the customer) may be referred to herein as “in-person scanning” or an “in-person scan.” Items that are scanned in the presence of the customer may be referred to as “in-person items.” In-person scans may differ from other scans in that other types of scans may be performed in the absence of a customer, such as when the items are scanned while picking and/or packing. Scans that are performed in the absence of a customer may be referred to as “in absentia scans.” A fulfillment procedure used for in-person items may be referred to as an “in-person order fulfillment procedure.”

In-person scans may be used in a variety of scenarios described herein. For example, in-person scans may be performed for items that are needed immediately by the customer, replacement items (e.g., for damaged items), customer-selectable items (e.g., fruits/vegetables to be inspected by the customer), and for items in other scenarios. In some cases, a customer may be waiting for items while in their car at a customer pickup location. In these cases, the pickup and scans at the pickup location may be referred to as “carside pickup” and “carside scans,” respectively. The in-person scans, which may include scanning a small number of items and/or items that are needed immediately, in front of the customer may provide a positive customer experience because the customer will have confidence that the correct items have been quickly provided.

In some implementations, in-person scans/items may include items that are inspected by the customer at the pickup location. In-person items that are inspected by the customer at the pickup location may be referred to as “customer-selectable items” or “customer-selected items.” In one example, a customer-selected item may be brought to the customer at the pickup location and require customer approval before the item can be transferred to the customer. In some implementations, a user may bring a group of items to the customer for customer selection. The customer may then select an item from the group of items. For example, fruits, vegetables, or other items may require customer approval before handing the items over to the customer. In this example, a user may use an MSD to scan customer selected items, or manually indicate the customer's approval, before handing the items over to the customer. Additionally, or alternatively, the customer may use their customer device/application to scan their approved item(s) and/or manually indicate they have acquired their approved items.

The customer may indicate their intention to hand select items in a variety of ways. In some implementations, a customer may indicate their intent in the customer application. For example, the customer may select the option in the customer application GUI using a GUI element (e.g., a button). In some examples, the customer application may notify the customer of the option to hand-select the items (e.g., by presenting a GUI button for the item(s)). In some examples, the customer application may default some items to be customer-selectable. In some implementations, there may be a fee associated with providing customer-selectable items (e.g., a fee per item and/or a membership fee). In some implementations, a customer application GUI may provide an estimated time at which they will receive the in-person items.

Although a user may scan items and carriers, in some cases, the user may manually enter data into the MSD to make similar indications described herein. For example, the user may press a GUI button or use another type of GUI interface to indicate they are picking an item, handing an item over to the customer, etc. Although the user may scan items/carriers to indicate that the items/carriers are being handed over to the customer, in some implementations, a user may scan items to indicate that the user is taking the items back from the customer. For example, a customer may remove items from their order and hand the items back to the user for restocking. In some implementations, the customer may scan or manually indicate the items they are removing from their order.

The CCS/TPCS may select the fulfillment procedure to use for customer orders/items. The CCS may be configured to use different fulfillment procedures based on a variety of factors. Example factors may include, but are not limited to: 1) number of items needed by the customer (e.g., for a new customer order or a modification of the customer order), 2) whether the item is a substitution, 3) whether the item is a new added item to the customer order (e.g., a new item added to the current customer order), 4) the location of the customer (e.g., whether the customer is at the store, where items may be rushed to customers at the store), 5) whether the items are specific items (e.g., fruits/vegetables may be hand selected), and 6) whether the customer has made a specific request in the customer application (e.g., a customer may pay more to request their own fruit to pick).

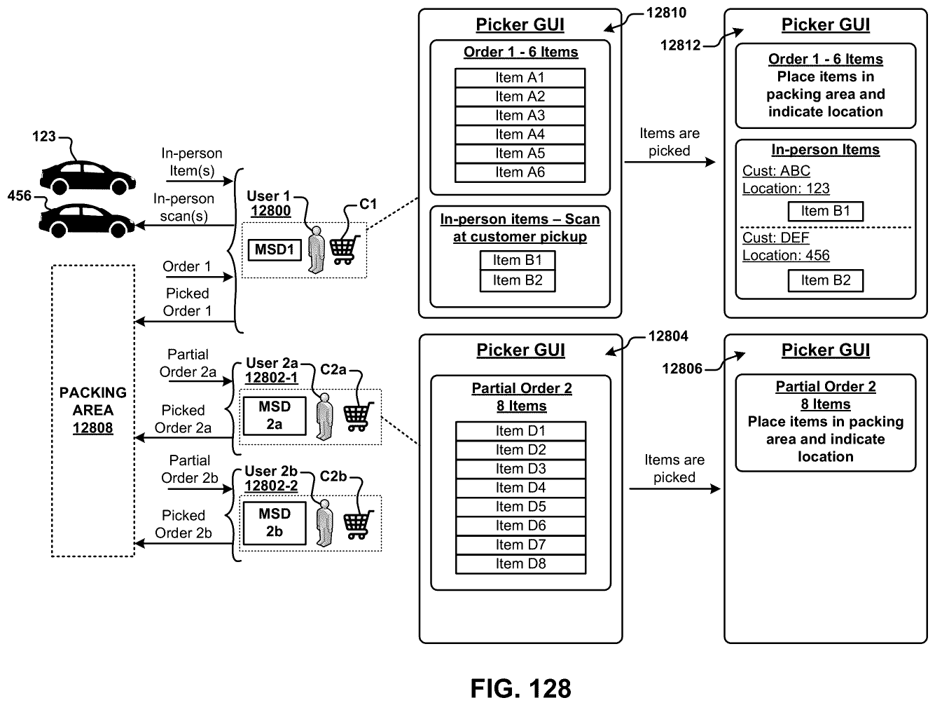

In some implementations, pickers/packers may be designated to pick according to specific order fulfillment procedures. For example, a first picker may be designated to pick according to a first order fulfillment procedure. In this example, a second picker may be designated to pick according to a second order fulfillment procedure. In some implementations, pickers may pick according to the order fulfillment procedure assigned by the CCS. For example, a single picker may pick according to a single fulfillment procedure for a first order. In this example, the single picker may receive multiple orders/items and pick the different orders/items according to multiple different order fulfillment procedures (e.g., see FIG. 128 GUI).

FIGS. 122-127 illustrate example order fulfillment procedures that may be implemented by the OFS. A store may implement the different fulfillment procedures in different scenarios to provide accurate orders to customers in a timely manner. The different order fulfillment procedures may also allow employees flexibility to efficiently fulfill orders in different scenarios.

FIG. 122 illustrates a method that describes an OFS that may use different order fulfillment procedures for different customer orders and individual items. In block 12200, the CCS receives complete customer order(s) and/or individual item requests. In some cases, a complete customer order may include a plurality of ordered items. In some cases, a complete customer order may include an individual item. Individual items may include items that are newly requested by the customer after placing the order. For example, the customer may add an item to be included in an already placed customer order (e.g., while the customer is at the store). In another example, a customer may request a substitution item for an item that was already included in their previous order, such as when the customer changes their mind or would like to replace an item (e.g., due to condition of the item). In another example, a user may damage an item (e.g., drop an item in front of the customer), which may cause the customer to request a new item. Other reasons may also exist for a customer/user to request additional items for a pending customer order.

In block 12202, the CCS may determine order fulfillment procedures to use for the customer order(s) and/or individual items. In some implementations, the OFS may implement a set of different fulfillment procedures from which the CCS may select for different orders/items. Example fulfillment procedures are illustrated and described with respect to FIGS. 123-127. The CCS may implement fulfillment procedure selection criteria to determine which procedures to use. Example selection criteria may include item type. For example, temperature-sensitive items (e.g., heated/cooled/frozen items) may use different procedures than items that are not temperature sensitive. Additional/alternative example selection criteria may include whether the item is immediately needed. For example, items that are needed immediately may use a different order fulfillment procedure that may provide quicker order fulfillment. Additional/alternative example selection criteria may include whether the item has a specified fulfillment procedure. For example, temperature-sensitive items may have specific fulfillment procedures that are different than other items. Additional/alternative example selection criteria may include whether a customer wants to inspect and hand-select the item(s). Additional/alternative selection criteria may include the location of the customer. For example, customers already at the store may have their orders picked using a different procedure than a customer that is not at the store.

Additional/alternative selection criteria may include order status, such as whether the order is scheduled or unscheduled. Additional/alternative selection criteria may include the size of the orders. For example, very small orders (e.g., a few items) may be fulfilled using a different fulfillment procedure than larger orders with more items. Additional/alternative selection criteria may include a time of day (e.g., different procedures may be available during different times of day). Additional/alternative selection criteria may include a busyness level of the store (e.g., a number of pending orders and/or a current number of available pickers/packers). Different example selection criteria are described herein with respect to each of the fulfillment procedures. The example selection criteria associated with the fulfillment procedures herein are only examples. As such, additional/alternative selection criteria may be implemented by the OFS.

The CCS may use one or more of the fulfillment procedures for customer orders and items. In some implementations, the CCS may use a single fulfillment procedure across an entire customer order. In some implementations, the CCS may use different fulfillment procedures for a single customer order, such as a first procedure for a first set of items and a second procedure for a second set of items. In a specific example, non-cooled/non-frozen items may be picked using a first procedure that allows the items to be placed in the packing area for a period of time. In this specific example, cooled/frozen items may be picked according to another procedure in which the items are picked and handed over to the customer as soon as possible after picking. In another specific example, items requiring customer approval, such as fruits, vegetables, breads, and/or meats may be provided to the customer using a different order fulfillment procedure in which the items are scanned carside after customer approval.

In block 12204, the CCS assigns orders/items to pickers/packers (e.g., picker/packer MSDs) according to the selected fulfillment procedures. The assignments of complete orders and individual items may also include fulfillment procedure data/instructions that indicate the procedures that should be used when picking items, packing items, and/or providing the items to the customers. Example fulfilment procedure data/instructions may indicate the procedure to use, the types of scans to make (e.g., picking scans, packing scans, etc.), the number of scans to make, and/or other data described herein related to the different fulfillment procedures (e.g., FIGS. 123-127).

In block 12206, the MSDs (e.g., picker/packer MSDs) may indicate the order fulfillment procedures associated with the assigned orders/items. For example, the MSDs may generate GUIs including the assigned orders/items along with an indication of the fulfillment procedure to use while picking the orders/items, packing the orders/items, and/or providing the orders/items to the customer. For example, the MSDs may generate GUIs that indicate steps to take while fulfilling the customer orders. In a specific example, if items are to be provided as in-person items to a customer waiting outside, an MSD may generate a GUI that includes a list of items to pick along with instructions to scan the items in the presence of the customer.

FIG. 123 illustrates a method that describes an example fulfillment procedure where a single picker picks and packs a complete customer order. In FIG. 123, the picker may pick an item and scan the item to indicate that the item has been picked and packed in a manner that is ready for customer pickup. For example, the picker may pick the item from a rack, scan the item, and then place the item into a carrier that will eventually be presented to a customer. The carrier may be a bag that is placed into another carrier, such as a cart, basket, and/or tub. Although a single customer order is picked and packed in FIG. 123, a picker may be assigned multiple customer orders that they are able to pick and pack at the same time while traversing the store according to the method of FIG. 123.

In block 12300, the CCS receives a customer order. In block 12302, the CCS assigns the customer order to a picker. In block 12304, the picker scans an item from the customer order to indicate that the item is picked and packed. In block 12306, the CCS/MSD determines whether all items have been picked and packed. If all items have not been picked and packed, the picker may continue scanning items from the customer order in block 12304. If all items have been packed in block 12306, the picker may drop off the customer order in the packing area in block 12308. The dropped off items may be presented to the customer as picked and packed. In some cases, the picker may present the items directly to the customer. In some cases, the customer order may be associated with an order ID that may be scanned or manually input to indicate when the customer order has been handed to the customer.

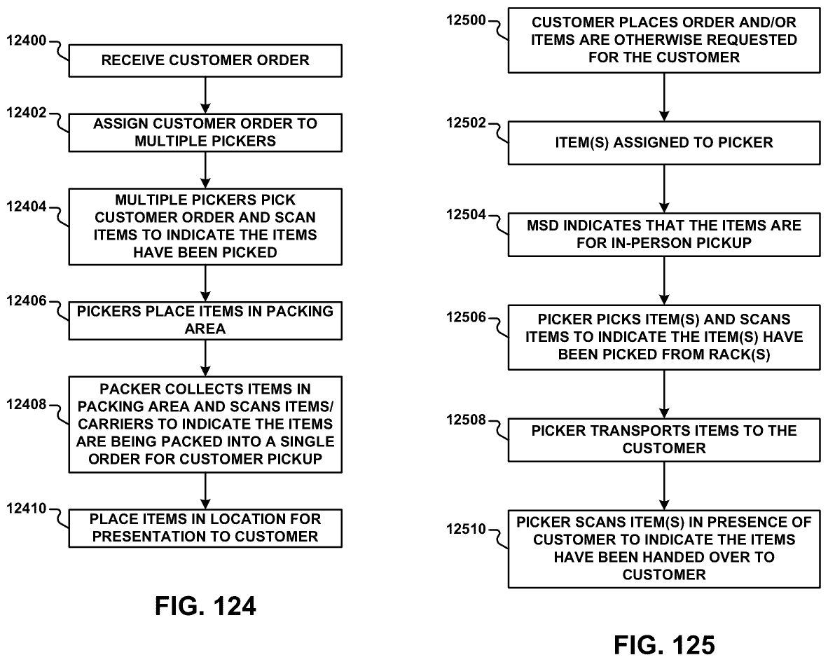

FIG. 124 illustrates a method that describes an example order fulfillment procedure in which a customer order is split between two or more pickers. Splitting the order among two or more pickers may reduce the overall amount of effort in picking the customer order. For example, splitting the order among pickers that are near different portions of the order may reduce the overall amount of picker travel distance and time. Splitting the order among multiple pickers may also reduce the picking time for the order, which may be beneficial in cases where the customer order is needed immediately for customer pickup/delivery. In the fulfillment procedure of FIG. 124, the portions of the order may be collected and presented to the user (e.g., in a packing area or other location). Although the portions may be collected and presented to the customer by a single user, in some implementations, the portions may be presented to the customer by separate users (e.g., the users that picked the portions).

In block 12400, the CCS receives a customer order. In block 12402, the CCS assigns the customer order to multiple pickers. In block 12404, the multiple pickers pick the customer order and scan items to indicate that the items have been picked. In block 12406, the pickers place the picked items in the packing area. In some implementations, the picker GUIs may instruct the pickers to place the items/carriers in the packing area. In some implementations, the pickers may scan a location in the packing area to indicate a drop off location. In block 12408, a packer collects the carriers/items in the packing area and scans the carriers/items to indicate that the items are being packed into a single customer order for customer pickup. In block 12410, the packer places the items in a location for presentation to the customer. The packer, or another user, may present the entire customer order to the customer. In some cases, the entire order may be associated with an order ID that can be scanned by the user to indicate they are handing over the entire order to the customer.

FIG. 125 illustrates a method that describes an example fulfillment procedure using an in-person scan. In the method of FIG. 125, one or more items for a customer order are scanned when picked in order to indicate that the items have been taken from a rack and are in the possession of the picker. Subsequently, the one or more items are scanned in the presence of the customer to indicate that the items are being handed over to the customer. The method of FIG. 125 may be used in a variety of scenarios. For example, the method of FIG. 125 may be used for small customer orders (e.g., a few items) and/or items that are otherwise requested by a customer, such as a replacement item, a new item for an order, a substitute item, and/or a group of customer-selectable items.

In block 12500, the customer places a customer order and/or otherwise requests other items. For example, a customer may request a replacement item, a new item, a substitute item, and/or a group of selectable items (e.g., fruits for hand selection). In some examples, the customer may place the order and/or request the items in block 12500 while located at the store (e.g., at a customer pickup location). In some examples, a customer may first place a customer order with a plurality of items that are fulfilled according to a first fulfillment procedure. The customer may then arrive at the store to pick up the customer order. While at the store, the customer may request the additional one or more items (e.g., substitutions, replacements, additional items, etc.). The additional one or more items may then be provided to the customer according to the method of FIG. 125. Although a customer may place the order and/or otherwise request items, in some cases, a user may use an MSD to request items to be picked for the customer.

In block 12502, the CCS assigns one or more items to a picker. In block 12504, the MSD indicates to the picker that the assigned one or more items are for in-person pickup. In block 12506, the picker picks the one or more items and scans the one or more items to indicate that the one or more items have been picked from racks in the store and that the items are ready to be presented to the customer in person. In block 12508, the picker transports the items to the customer. For example, the picker may place the items into a carrier and/or carry the items by hand to the customer. In block 12510, the picker scans the one or more items (or a carrier including the item(s)) in the presence of the customer to indicate that the items have been handed over to the customer.

In some implementations, the method of FIG. 125 may be used for providing customer-selectable items to a customer. For customer-selectable items, a first scan, or set of scans, may indicate that the picker has acquired the items. The second scan in the presence of the customer may indicate that the customer has selected the item. As described herein, customer-selectable items may be selected by a customer from a group of items presented to the customer (e.g., at a pickup location). In some implementations, a picker may scan a code indicating that they have acquired a group of items (e.g., a group of apples, oranges, etc.). For example, a picker may scan a code attached to a basket, or other carrier, that includes a group of apples for customer selection. In some implementations, a picker may scan each of the items individually to indicate that the items have been picked for customer selection. For example, a picker may scan codes for different brands/quality of items for in-person customer selection.

Note that in-person items may be scanned by a user MSD or entered manually by a user into the MSD. In some implementations, the customer may verify that they have acquired the in-person items. For example, a customer may use their customer device to scan an item that they have acquired. In some implementations, the customer device may scan a barcode or other code to indicate that the customer has acquired the item. In some implementations, the customer device may acquire one or more images of the item and determine that the item has been acquired based on the one or more images (e.g., using image processing at the customer device and/or CCS).

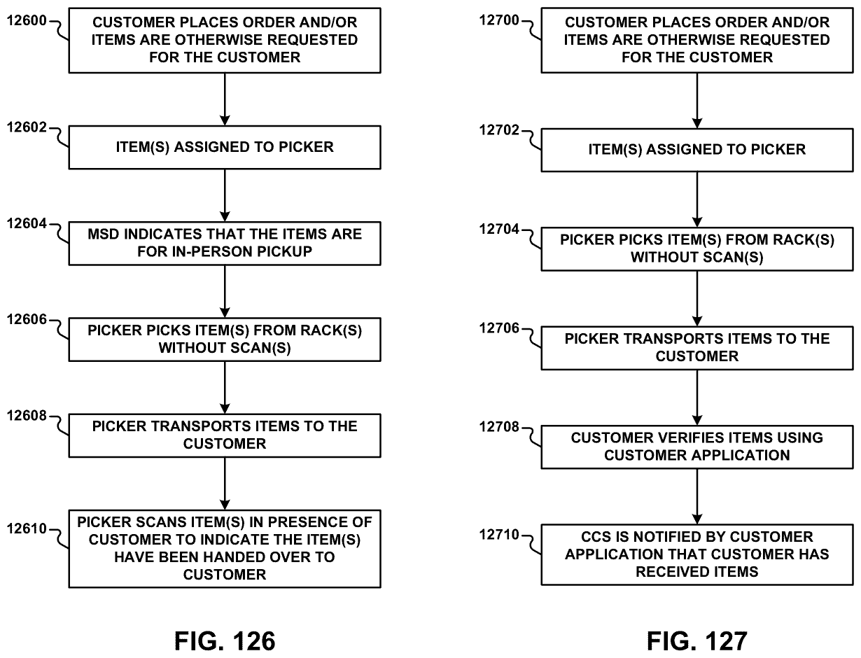

FIG. 126 illustrates a method that describes an example fulfillment procedure using an in-person scan. In the method of FIG. 126, one or more items for a customer order are picked without a scan. The one or more items are scanned in the presence of a customer to indicate that the customer has acquired the one or more items. The fulfillment procedure of FIG. 126 may be used in a variety of scenarios. In one scenario, a store employee without an MSD may be instructed to pick one or more in-person items (e.g., via a store intercom, a portable computing device on their person, and/or via another computing device). The lack of an MSD may be a trigger for the CCS assigning this type of fulfillment procedure to a picker. In this scenario, the store employee may not be able to scan a picked item (e.g., as in the method of FIG. 125) until they pick up an MSD on their way to a customer. In other scenarios, an employee may be currently picking items using an MSD. In these scenarios, the MSD may instruct the employee to pick the item and scan it only in the presence of the customer.

In block 12600, the customer places a customer order and/or otherwise requests other items, as described with respect to block 12500 in FIG. 125. In block 12602, the CCS assigns one or more items to a picker (e.g., via a store intercom, a portable computing device on their person, and/or via another computing device). In some cases, a store employee may assign the item by word of mouth to the picker and indicate the assignment in a computing device operated by the store employee. In block 12604, the MSD indicates to the picker that the assigned one or more items are for in-person pickup. In block 12606, the picker picks the one or more items without scanning the one or more items. In block 12608, the picker transports the items to the customer. For example, the picker may place the items into a carrier and/or carry the items by hand to the customer. In some implementations, the picker may drop the items off in the packing area for pickup by another user. In some implementations, the picker may hand the items off to another user for presentation to the customer. In block 12610, the picker scans the one or more items (or a carrier including the item(s)) in the presence of the customer to indicate that the items have been handed over to the customer. In some implementations, the customer may verify that they have acquired the in-person items, as described herein.

FIG. 127 illustrates a method that describes an example fulfillment procedure in which store employees do not scan items. Instead, a customer may use their customer device/application to verify that they have received the items. The procedure of FIG. 127 may be used in a variety of scenarios, such as a scenario where a store employee is instructed to provide one or more items to a customer, but the employee does not have an MSD to scan the items. The procedure may also be used when other procedures are deemed to be too cumbersome for providing items to a customer. For example, if a customer requests a replacement item for an item in their order that was damaged, a store employee may find a replacement item and hand it over to the customer at the pickup location without first scanning the item.

In block 12700, the customer places a customer order and/or otherwise requests other items. In block 12702, the CCS assigns one or more items to a picker. In some cases, the CCS may assign items to a picker using a device that is not an MSD. For example, the CCS may assign items via a store intercom, a portable computing device on their person, and/or via another computing device. In some cases, a store employee may assign the item by word of mouth to the picker and indicate the assignment in a computing device operated by the store employee. In block 12704, the picker picks the item(s) from one or more racks without scanning the items. In some cases, an MSD may indicate the items to pick, but may not require a scan. In block 12706, the picker transports the items to the customer. In some implementations, the picker may drop the items off in the packing area for pickup by another user. In some implementations, the picker may hand the items off to another user for presentation to the customer. In block 12708, the customer verifies that they have received the items using the customer application. For example, the customer may make a manual entry into the customer application. Example manual entries may include, but are not limited to, selecting one or more confirmation buttons for each item or selecting a confirmation button for a plurality of items. In other examples, the customer may use their customer device to scan the one or more items/carriers to confirm receipt of the items (e.g., by scanning a barcode, acquiring an image including the items/carriers, etc.). In block 12710, the customer application notifies the CCS that the customer has received the items. The CCS may then determine that the customer order has been successfully fulfilled.

In some implementations, the packing area, which may be close to customer pickup locations, may have designated areas for placing specific items, such as items that are commonly ordered, in-person items (e.g., customer-selectable items and/or other picked items), and/or other types of items. In some implementations, a user (e.g., store employee) may acquire the items from the designated area to fulfill customer orders according to any of the procedures described herein. For example, in some implementations, a user may fulfill in-person orders according to any of the methods described herein using in-person items in designated areas.

In some implementations, customer pickup may include additional order fulfillment operations. Example operations may include, but are not limited to, entering customer information into an MSD and/or customer computing device, scanning a customer license plate, or otherwise confirming the identity of the customer before handing items over to the customer. After confirming the identity of the customer (e.g., verbally, in the MSD, etc.), the user may hand over in-person items to the customer. Handing over in-person items may include, but is not limited to, handing over each item individually, handing over a carrier (e.g., bag) including the items, and/or placing the items in carriers (e.g., bags) already possessed by the customer (e.g., bags of items already in the trunk).

In some implementations, in-person scans may use additional hardware that is located at the customer pickup location. For example, customer pickup locations may include dedicated MSDs or other computing devices for completing in-person transactions. Example additional devices for in-person scans may include other mobile/stationary scanning devices, displays, point of sale systems, etc. In cases where additional devices are located in the customer pickup location, the users may use the additional devices to scan the items or manually indicate in-person item transfer. In some implementations, specific carriers may be used for in-person items. In some implementations, in-person items may be picked and/or brought out to customers in carriers that include bags (e.g., a bag dispenser). In these implementations, the users may bag the in-person items in the presence of the customer.

Any of the methods described herein (e.g., FIGS. 122-127) may include additional/alternative scans that are not explicitly described herein with respect to the methods. For example, in some implementations, methods may include carrier scans that indicate items have been placed into carriers or removed from carriers. Additionally, carriers may be scanned to indicate that the user has taken possession of a carrier and any included items. In some implementations, the methods described herein (e.g., the fulfillment methods of FIGS. 122-127) may be implemented by two or more persons, each of which may be involved with any of the operations (e.g., blocks) described herein. In these implementations, each of the persons may generate zero or more scans described with respect to the fulfillment procedures. In some implementations, the methods described herein (e.g., FIGS. 122-127) may be implemented by a CCS, a TPCS, or any combination of a CCS/TPCS. Similarly, the methods described herein (e.g., FIGS. 122-127) may be performed by store employees, third party pickers/packers, or any combination of store and third-party users.

FIG. 128 illustrates an example store that may implement multiple fulfillment procedures. For example, FIG. 128 illustrates a first procedure in which a single user (User 1 12800) picks a complete customer order (Order 1). As another example, FIG. 128 illustrates a second procedure in which two pickers (User 2a 12802-1 and User 2b 12802-2) pick a single customer order (Order 2). As another example, FIG. 128 illustrates a third procedure in which a picker (User 1 12800) picks in-person items. FIG. 128 also includes example picking GUIs for the different users that may be picking according to different fulfillment procedures.

In FIG. 128, user 1 12800 is assigned to pick complete customer order 1. User 1 12800 uses MSD1 and carrier 1 to pick customer order 1. In FIG. 128, the CCS splits customer order 2 into partial order 2a and partial order 2b. The CCS assigns the partial orders to user 2a 12802-1 and user 2b 12802-2. User 2a 12802-1 and user 2b 12802-2 use MSD 2a and MSD 2b, respectively. User 2a 12802-1 and user 2b 12802-2 use carriers C2a and C2b, respectively. The CCS may assign customer order 1 and customer order 2 to user 1, user 2a, and user 2b for any of the reasons described herein (e.g., item locations, user locations, item numbers, rule-based assignments, etc.).

In FIG. 128, user 1 12800 is assigned in-person items. The CCS may assign in-person items to user 1 for a variety of reasons described herein. For example, the CCS may be configured to assign in-person items for one or more of the following circumstances: 1) the customer being located at the store or estimated to arrive at the store within a period of time, 2) the order size is small (e.g., less than a threshold number of items, such as less than 3 items), 3) if the item is needed immediately, such as an item addition, substitution, or replacement for a customer at the store, and/or 4) if the item(s) are customer-selectable items, which may be indicated by the customer in the customer application. Although user 1 was assigned the in-person items, user 2a and/or user 2b may have been assigned the in-person items in other circumstances.

FIG. 128 illustrates example GUIS. The MSD GUIs 12804, 12806 for user 2a 12802-1 illustrate that user 2a has been assigned to pick a partial order of 8 items (items D1-D8). Note that the Picker GUI 12804 for user 2a indicates that the items being picked are part of a partial order, which may give context to user 2a while picking the partial order. For example, user 2a may understand that after picking the partial order, they will place the partial order in a packing area 12808 to be combined with one or more other partially picked portions of the order. In FIG. 128, after picking items, the picker GUI 12806 for MSD 2a instructs user 2a to place the picked items into the packing area 12808 and indicate a location (e.g., by scanning a location, manual entry, or in another manner). As described herein, the location may also be automatically determined (e.g., without user 2a input). In some cases, the GUI may instruct user 2a to pack the remaining items for the customer order (e.g., by collecting picked items from partial order 2b picked by user 2b).

The MSD GUI 12810 for user 1 12800 illustrates that user 1 has been assigned a complete order 1 along with in-person items. The complete order 1 includes 6 items (A1-A6). Note that the indication that order 1 is a complete order (e.g., based on a lack of partial order indication) may provide context to user 1 as to the picking procedure for order 1. After picking the items for the complete order 1, the picker GUI 12812 may instruct user 1 to place the items in the packing area 12808 and indicate the location of the items. In some cases, another user may present the items to a customer or delivery driver for pickup. In some cases, the picker GUI may instruct user 1 to prepare the items for customer pickup, such as by packing the items in such a manner that they will be easily transferred to the customer.

The MSD GUIs 12810, 12812 for user 1 include GUIs for an in-person order fulfillment procedure. The in-person items may have been assigned at any time. In some implementations, the CCS may assign orders and in-person items as the orders are received and the in-person items are requested. For example, user 1 may have been assigned order 1 first. In this example, while picking order 1, user 1 may have been assigned the in-person items. In another example, user 1 may have been assigned the in-person items first and then assigned order 1 while picking the in-person items. The in-person items may have been assigned individually or at different times. In some implementations, the CCS may prioritize assigning complete orders first and then assign the in-person items as the in-person items are needed. In these implementations, the CCS may treat in-person items as additional items to assign to users that are already picking items. In some implementations (not illustrated), the in-person items may be items for a customer that has already placed a complete customer order. For example, a customer at the store to pick up a previously placed order may add items (e.g., in-person items) to their order while waiting for the order, or just after receiving their order. Such items added at the last minute may be treated as in-person items.

The in-person GUI elements in GUI 12812 indicate to user 1 that the items B1-B2 are in-person items to be scanned at the customer pickup location. In some implementations, user 1 may scan items B1-B2 after picking. In some implementations, the picker may use a specific carrier to hold the in-person items. In other implementations, the picker may just place the items into any carrier or on top of other bagged items that have been picked. Since the number of in-person items may be small, the picker may not require a specific protocol for transporting the items.

The in-person items (and the order 1 items) may be rearranged in the GUI 12810 as the user moves throughout the store. For example, the in-person items nearer to user 1 may be displayed higher in the list. As described herein, in some implementations, rendering of the item GUI elements may change when the user is near the items for picking. For example, the items may change in color, font size, font type, and/or another manner to indicate that the items are in proximity to the picker. In some implementations, the in-person items B1-B2 and complete order items A1-A6 may be intermixed. In these implementations, the items may include other indicators that indicate the order filling procedures to the picker. For example, item color, font size/type, or other indicator may indicate the fulfillment procedure to use for specific items.

In FIG. 128, after scanning the in-person items, the picker GUI 12812 indicates which customers receive the items, along with the locations of the customers. For example, customer ABC and DEF receive item B1 and item B2, respectively. Customer ABC and DEF are located at location 123 and location 456, respectively. Although customer name and location are displayed after picking in FIG. 128, such data may be displayed in the picking GUI while picking in order to provide context to the picker regarding how many customers are receiving items, as well as the locations of the customers. The customer name may include a customer's first/last name and/or other types of identifying information, such as car make, model, color, etc. The customer location may be indicated in any manner described herein, such as by parking location, GPS location, etc.

User 1 may transport items B1 and B2 to customers in a pickup location. User 1 may scan the in-person items in the presence of the customers and then transfer the in-person items over to the customers. For example, user 1 may scan item B1 in front of customer ABC and then transfer item B1 over to customer ABC (e.g., transfer by hand, placement in the vehicle, in a bag including other customer items, etc.). User 1 may then scan item B2 in the presence of customer DEF and then transfer item B2 to customer DEF. After scanning the in-person items, the in-person GUI elements may be removed from the MSD GUI 12812. In some implementations, the MSD GUI may confirm that the items have been handed over to the customer. Although 2 sets of instructions for 2 in-person items B1-B2 are illustrated in FIG. 128, any number of in-person items may be handled in the same manner. For example, in implementations where a picker is dedicated to picking in-person items, the MSD GUI may include more in-person items for more than 2 customers. Although the picker GUIs 12810, 12812 for user 1 include GUI elements for 2 types of fulfillment procedures, a picker GUI may include GUI elements for more than 2 types of fulfillment procedures.

In some implementations, the CCS/MSDs may prioritize some in-person items over others with regard to handing the items off to the customers. For example, the CCS/MSDs may indicate to the user, or instruct the user, in the MSD GUI to provide in-person items to users in a sequence. The sequence may indicate which items should be handed over first in a variety of ways. In some implementations, the sequence may indicate one or more in-person items to hand over before a different one or more in-person items (e.g., hand over items 1-3 before items 5-6 in any order). In some implementations, the sequence may indicate a specific order for handing over the in-person items.

The CCS/MSD may determine the sequence for handing off in-person items based on a variety of factors. In some implementations, the CCS/MSD may determine the sequence based on one or more of the following: 1) when the in-person items were requested (e.g., earlier order placements and item requests are provided first), 2) an amount of time the customer has been waiting (e.g., longer wait times may receive the items first), and 3) the type of item (e.g., temperature sensitive items, such as hot/cold items, may be provided first). Other example factors may include the location of the customer. For example, customers that are closer to the user handing over in-person items may receive the items first. In a specific example, a customer parked near an exit to the store used by the user may receive the in-person items first as the user exits the store.

The MSD GUI may indicate the sequence in which to distribute in-person items a variety of ways. In some implementations, the MSD GUI may arrange the items from top to bottom on the screen to indicate which customer receives the items first. In some implementations, the MSD GUI may limit the items shown to the user in order to force the user to provide the items in sequence. For example, the MSD GUI may show in-person items to be handed over on the display, but refrain from showing other in-person items in the user's possession until they hand over (e.g., scan) the displayed in-person items. In some implementations, the MSD GUI may arrange the items based on the location of the user relative to the customers, where closer customers may be arranged in the MSD GUI to receive the items first. In some implementations, the MSD GUI may optimize the path to provide the in-person items to customers (e.g., minimize the overall travel distance/time for distributing the in-person items).

As described herein, in some implementations, text may include instructions indicating how to fulfill the order to a varying level of detail. For example, an MSD GUI may indicate, for in-person items, that the user should “Scan items when picking and at the customer pickup location.” In some implementations, for in-person items, the GUI may instruct a user to verify the customer first and then scan their items for them. In some implementations, in-person GUIs may indicate the location of the customer and whether the customer is on foot or in a car. In some implementations, text may indicate the fulfillment procedure/instructions at a group level (e.g., a single order or multiple orders) and/or at an item level. In some implementations, MSD GUIs may indicate the type of fulfillment procedure to be used by coloring the items and/or groups of items. For example, in-person items may be colored in a different manner than other items. In some cases, extra instructions may be accessed using additional GUI elements, such as buttons (not illustrated) that cause an instruction GUI element (e.g., pop-out bubble or new page) to provide instructions to a picker. In some cases, the GUIs may include expand/collapse GUIs to expand and collapse different orders to make more GUI space for other orders while picking, packing, and/or handing off items to customers.

In some implementations, items for a customer order may be input into an MSD by a party other than the customer, such as a store employee. For example, in some implementations, in-person items may be input into an MSD by a user, such as a store employee interacting with the customer (e.g., at the pickup location). The in-person items may then be assigned to another user for immediate picking and in-person scanning. The user may input the items in a variety of ways, such as by manual entry into an MSD GUI (e.g., using an item selection GUI). In one example, a user may input in-person items for a customer, such as a needed replacement item or any item conveyed to the user by the customer (e.g., verbally conveyed at the pickup location). In some implementations, a customer may input the in-person items into the customer application (e.g., a small order and/or substitutions while at the store). Entry of in-person items by the customer may then be assigned to one or more pickers.

In some cases, a single fulfillment procedure may be used for a single customer order. For example, a single customer order may be picked according to any of the methods of FIGS. 123-127. In other cases, multiple different fulfillment procedures may be used for a single customer order. For example, a single customer order may include a first portion of the order (e.g., one or more items) that is picked according to any one of the methods of FIGS. 123-127. In this example, a second portion of the order may be picked according to any other of the methods of FIGS. 123-127. For example, a customer may place an order as a scheduled order that specifies one or more items be customer-selected items, where the customer-selected items use a first fulfillment procedure and the remaining items use a second fulfillment procedure. In some implementations, a single picker may handle the same order using different order fulfillment procedures. In some implementations, a single picker may pick multiple orders using different order fulfillment procedures (e.g., see FIG. 128).

The store may use designated pickers for picking the in-person items. For example, a designated picker may pick in-person items for one or more orders. In some implementations, the CCS may assign in-person items to pickers that are also picking other orders. For example, the CCS may assign a few in-person items to a picker that is picking a large scheduled order. In some implementations, the store may use designated carriers for in-person items. The carriers designated for in-person items may be visually identifiable (e.g., based on color, carrier type, label, etc.). In some implementations, in-person items may be placed in any carrier. In an implementation using a designated picker and a designated carrier, the picker may traverse the store picking in-person items for multiple waiting customers. In this implementation, the picker may gather in-person items quickly into the carrier and later remove the items for the waiting customers in view of the customers.

In some implementations, the store may include locations (e.g., in the packing area) for dropping off carriers including in-person items. In some implementations, the store may include items stocked in the packing area, or other designated location, that may be used for in-person pickup. For example, popular items (e.g., bread, milk, etc.) may be stocked in the packing area (e.g., when the packing area is near the pickup location). Users may pick the stocked items from the packing area for in-person scanning. In some implementations, the store may have designated pickup locations for picking up in-person items.

The MSDs may indicate the various locations associated with in-person items. For example, the MSD GUIs may indicate specific carrier pickup locations, specific drop-off locations, specific carrier types, and/or customer locations. The MSD GUIs may also indicate to a picker that items are available for picking as in-person items in a designated stocking area (e.g., in the packing area near the customer pickup location).

In some implementations, a customer may place a customer order with the store and make subsequent modifications to the customer order (e.g., item additions, item deletions, and/or item substitutions). For example, the customer may modify the order immediately after placing the order or at a later time. In some implementations of the OFS, the ability to modify an already-placed customer order may be limited in some circumstances. In these implementations of the OFS, the OFS (e.g., CCS/TPCS) and/or a customer application may implement one or more order modification eligibility conditions (i.e., “modification eligibility conditions” or “modification conditions”) to determine whether a customer is allowed to modify their order, as well as the extent to which the customer is allowed to modify their order. The CCS/TPCS and/or customer application may determine whether a customer order is eligible for modification. For example, a CCS/TPCS and/or customer application may determine that a customer order is eligible for modification when one or more modification eligibility conditions are satisfied. If the modification eligibility conditions are not satisfied, the store may refuse modifications by the customer.

Providing a customer with the ability to modify their order nearer to the time the order is being picked up by the customer provides additional convenience for the customer. For example, allowing modifications closer to pickup may allow a customer to make order changes at the last minute. Additionally, providing additional items to the customer may help increase store sales. Modification eligibility conditions may be put in place to assure that the store can handle such a modification (e.g., a last-minute rapid modification) and that the modification will be mutually beneficial to the customer and the store, such as when there are resources (e.g., ample pickers, packers, time, etc.) to pick additional items.

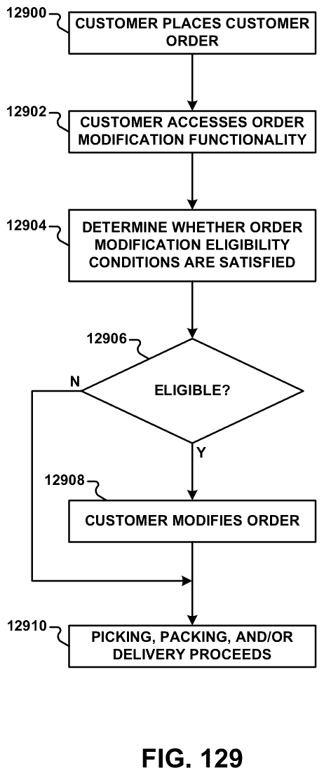

FIG. 129 illustrates an example method that describes features of an example OFS (e.g., CCS, customer application, etc.) that provides order modification functionality. In block 12900, the customer places a customer order. In some implementations, the customer application GUI may provide initial order modification statements/rules after placing the customer order. For example, the initial order modification statements/rules may indicate various modification eligibility conditions to the customer including, but not limited to, timing conditions (e.g., when modifications should be made), location conditions (e.g., where a customer may be located when modifying), and other conditions described herein. In one example, the statements presented to the customer may indicate that the customer must make modifications before a specific date and time (e.g., “Please make modifications prior to Monday at 12:30 pm”). In another example, statements presented to the customer may indicate that the customer must make modifications before driving to the store to pick up the order (e.g., “Please make modifications before leaving home to pick up the order.”).

In block 12902, the customer accesses the order modification functionality in the customer application GUI. As described herein, the customers may: 1) modify a variety of types of orders (e.g., scheduled/unscheduled orders), 2) make a variety of types of modifications (e.g., additions/deletions), and 3) make the modifications any time after they place the order, depending on how the order modification functionality is implemented.

The customers may modify any of the types of orders described herein. For example, the customers may modify scheduled pickup orders, unscheduled pickup orders, scheduled delivery orders, and unscheduled delivery orders. Modification eligibility conditions may differ, depending on the type of order.

Customers may make a variety of types of modifications. Example modifications may include, but are not limited to: 1) deleting items from the order, 2) adding items to the order, 3) a customer-initiated substitution (e.g., deleting an item and adding another similar item), and 4) accepting a store-initiated substitution (e.g., accepting a store or third party recommended item as a substitution for an item in the order).

The customer application may include modification GUI elements for making any of the types of modifications (e.g., GUI buttons on a per-item level or per-order level). For example, the modification GUI elements may include an add button that a user may select to access a shopping menu for new items. As another example, the modification GUI elements may include a delete button for deleting items. As another example, the modifications may be made by gesture in the GUI, such as a delete gesture (e.g., a swipe gesture) that a user can use to delete an item. As another example, a gesture may reveal a modification GUI element (e.g., a swipe may reveal a delete/substitute button for an item). The GUI elements may also include an interface for selecting one or more items in response to a store-initiated substitution (e.g., in the case items from the already-placed order are not currently in stock).

In general, a customer may modify their order any time after the customer order is placed, subject to satisfaction of one or more modification eligibility conditions. For example, modifications may be made to a customer order during any of the following time frames: 1) prior to the start of picking/packing of the order, 2) after picking/packing starts, 3) while picking/packing is happening, 4) after the order has been packed and is waiting for customer pickup, 5) while the customer is at home, 6) while the customer is on the way to the store to pick up the order, 7) while the customer is at the store waiting for the order to be brought to them, and/or 8) after the order has been handed over to the customer. Note that some of the time frames above may occur at separate defined times. For example, prior to the start of picking will occur prior to the assignment and first item pick for an order. Note also that some of the time frames above may occur at the same time. For example, picking may be occurring while the customer is on their way to the store or waiting at the store.

The customer application may provide order modification GUI elements to the customer. The order modification GUI elements rendered in the customer application may depend on whether the customer is allowed to modify the order (e.g., as described herein). For example, the order modification GUI elements may be displayed to the customer if the customer is allowed to modify the order. If the customer is not allowed to modify the order, the order modification GUI elements may not be provided to the customer, or may be inactive (e.g., grayed out). The order modification GUI elements may also depend on the extent to which the customer is allowed to modify the order. For example, in some implementations, the customer may be allowed to delete items from their order, but not add items to the order. In this example, the customer may be presented with deletion functionality (e.g., a delete button/gesture), but not be presented with addition functionality (e.g., an add button).

In some implementations, the order modification GUI elements may be provided to a customer automatically. For example, the order modification GUI elements may be provided automatically upon opening the customer application any time after placing an order. In another example, the customer application may automatically provide the order modification GUI elements when modification eligibility conditions are satisfied. In this example, if modification eligibility conditions are not satisfied, the application may refrain from providing order modification GUI elements.

In some implementations, the customer may be required to interact with a GUI element (e.g., a modification button) in order to access order modification GUI elements. Selection of the modification button (e.g., touching/clicking the button) may launch a GUI including additional modification GUI elements (e.g., add, delete, substitute buttons). In these implementations, the modification button may be made available when modification eligibility conditions are satisfied. If modification eligibility conditions are not satisfied, the modification button may not be made available (e.g., not shown or grayed out).

Automatically/manually displayed modification GUI elements may become unavailable if modification eligibility conditions change. For example, once available/unavailable modification GUI elements may become unavailable/available in response to changes in modification eligibility conditions. In some implementations, the customer application may provide a customer with updated order modification rules in a GUI according to changing modification conditions.

In some implementations, the CCS/TPCS and/or customer application may notify the customer of order modification eligibility outside of the customer application. For example, the CCS and/or customer application may provide notifications on a user's mobile device (e.g., pop-up notifications on a mobile device screen) indicating their eligibility to modify an order. In another example, the CCS may provide other types of notifications to the customer via other channels (e.g., via text message, emails, etc.).

In block 12904, the CCS, TPCS, and/or customer application determine whether modification eligibility conditions are satisfied. The modification eligibility conditions may include one or more of the conditions described herein. Satisfaction of the one or more modification eligibility conditions may allow order modification by the customer. In some implementations, the modification eligibility conditions may be set by operators of the OFS in an operator interface (e.g., store and/or third-party managers or other parties may access an interface to set conditions). The CCS, TPCS, and/or customer application can be configured to use any combination of one or more of the modification eligibility conditions described herein. Additionally, as described herein, the satisfaction of the modification conditions may change over time, such that a once satisfied/unsatisfied set of modification conditions may become unsatisfied/satisfied.

The modification conditions may vary based on the modification type (e.g., item deletions, item additions, or substitutions). For example, different modification types (e.g., addition, deletion, substitution) may use different modifications conditions. In this example, the OFS may implement different addition modification conditions, deletion modification conditions, and substitution modification conditions. The customer may be notified in the customer application of the different types of modification conditions. For example, the customer may be notified that they may delete X number of items, add Y number of items, and/or substitute Z number of items. Modification GUI elements (e.g., addition elements, deletion elements, and/or substitution elements) may be removed and/or grayed out from the customer application GUI if the specific type of modification is not available (e.g., due to modification-type specific conditions). In some implementations, different types of orders may have different modification conditions. For example, scheduled pickup orders, unscheduled pickup orders, scheduled delivery orders, and/or unscheduled delivery orders may use different modification conditions.

A variety of different modification eligibility conditions are described herein. In some implementations, for modifications of a pickup order, the modification eligibility conditions may be similar to, or the same as, unscheduled pickup criteria. In some implementations, for modifications of a delivery order, the modification eligibility conditions may be similar to, or the same as, unscheduled delivery criteria. The modification eligibility conditions described herein may be applied to pickup or delivery.

In some implementations, the modification conditions may be defined relative to the customer location, customer action, and/or customer membership status. For example, the modification conditions may allow the customer to modify the order (e.g., delete items) any time after the customer places the order. As another example, the modification conditions may allow the customer to modify the order before the customer leaves home to pick up the order. As another example, the modification conditions may allow the customer to modify the order while the customer is on the way to pick up the order (e.g., as indicated by GPS location and/or a customer GUI input). Alternatively, the customer may be ineligible to modify their order while on their way to pick up the order. As another example, the modification conditions may allow the customer to modify the order while the customer is at the store (e.g., on foot or in the car). Alternatively, the customer may not be eligible to modify their order while at the store. As another example, the modification conditions may allow the customer to modify the order if the customer has a membership with the store, or provides another form of payment (e.g., a payment for modification per order and/or per item).

In some implementations, modification conditions may be based on the estimated customer arrival time and/or pickup time. The estimated arrival time and/or pickup time may refer to the window of time at which a pickup is scheduled (e.g., for a scheduled order). The estimated arrival/pickup time may be more specific in some cases, such as a specific estimated time at which the customer may arrive at the store (e.g., a time calculated based on customer location, rate of movement, store location, street maps/traffic, etc.). For example, the modification conditions may allow the customer to modify the order so long as the estimated arrival time of the customer is greater than a threshold amount of time (e.g., an amount of time that may allow for picking/packing modifications). In one specific example, the modification conditions may allow the customer to modify the order if the estimated arrival time provides a sufficient amount of time for picking, as determined using picking time estimation techniques (e.g., based on picker availability, location, etc.).

In some implementations, the modification conditions may include a distance from the store. For example, a customer may be eligible to modify their pickup order so long as they are located greater than a threshold distance from the store. Similarly, a customer may be ineligible to modify their pickup order if they are less than a threshold distance from the store.

In some implementations, the modification conditions may be defined with respect to the order fulfillment pipeline. For example, the modification conditions may be defined with respect to picking, packing, and/or delivery operations associated with the customer order. In one example, the modification conditions may allow the customer to modify the order within a period of time before the scheduled order is due to be picked. As another example, the modification conditions may allow the customer to modify the order before picking has started. In this example, the customer may be ineligible to modify the order after picking has started. As another example, the modification conditions may allow the customer to modify the order while picking is happening. As another example, the modification conditions may allow the customer to modify the order after picking is done and the order is placed in the packing area. As another example, the modification conditions may allow the customer to modify the order during packing. In other cases, the customer may be ineligible to modify the customer order after the items are placed in the packing area. As another example, the modification conditions may allow the customer to modify the order after packing is done and the order is ready for customer or driver pickup. As another example, the modification conditions may allow the customer to modify their order after the order has been handed over to the customer (e.g., items may be removed from the car trunk after handing the order over). As another example, the modification conditions may allow the customer to modify the order while the order is being collected for delivery. As another example, the modification conditions may allow the customer to modify the order during delivery (e.g., with the delivery driver modifying the order before providing it to the customer). The above modification conditions defined with respect to the order fulfillment pipeline are only example modification conditions. As such, other modification conditions may be implemented (e.g., order modifications may be prohibited in some portions of the order fulfillment pipeline).

In some implementations, the modification conditions may be defined with respect to store-based conditions. Example store-based conditions may include any metrics associated with pickers, packers, drivers, store customers, and/or the current workload for the store (e.g., a number of items/orders being picked or about to be picked in the near future). In some implementations, modification conditions may include conditions associated with the availability of pickers, packers, and/or drivers. For example, modification conditions may be satisfied for a pickup order if there are sufficient employees to pick and pack the order (e.g., 1 or more employees may be sufficient). As another example, modification conditions may be satisfied for a delivery order when there is one or more available delivery drivers that may handle the modification. In some implementations, picker availability may be defined as having a picker that is not currently picking items. As another example, picker availability may be defined in terms of the number of pickers relative to the current and near future picking expectations for the pickers. In this example, one or more pickers may be available when the total number of items to be picked relative to the number of pickers is less than a threshold number (e.g., the number of items divided by the number of pickers is less than a threshold value). In some implementations, the number of pickers, packers, and/or drivers may be included as modification conditions. In some implementations, the number of outstanding items may be a modification condition. In some implementations, the ratio of outstanding items to pickers, packers, and/or delivery drivers may be a modification condition. In some implementations, a rate of item picking may be a modification condition. For example, if the rate of item picking relative to outstanding items required to be picked is greater than a threshold value, the pickers may be available to pick additional items. In some implementations, the busyness of the store (e.g., a number of customers in the store) may be included as a modification condition. For example, if greater than a threshold number of customers are in the store, orders may not be modified because picking may be inefficient and/or inconvenient for the customers. The above modification conditions defined with respect to store-based conditions are only example modification conditions. As such, other store-based modification conditions may be implemented.

In some implementations, the modification conditions may be defined with respect to item type. For example, the customer may be allowed to add, delete, and/or substitute specific item types, such as item types that can be easily acquired and handled by the pickers/packers. In a specific example, a customer may not be allowed to delete temperature sensitive items, such as refrigerated items or prepared items (e.g., heated rotisserie chickens), as the items may become unsuitable for resale after being with the customer for a period of time (e.g., in the car trunk). In some implementations, the modifications conditions may be defined for specific items. For example, specific items may be added, deleted, and/or substituted. In one example, the packing area, or other area near a customer pickup area, may include a stock of specific items that can be added to a customer order (e.g., common items, such as milk, candy, etc.).

In some implementations, the modification conditions may be defined with respect to in-person items. For example, the modification conditions may allow/deny order modifications for in-person items. For example, the customer may be allowed to add in-person items in some cases. As another example, the customer may not be allowed to add, delete, or substitute in-person items, as the customer may be responsible for choosing the in-person items, and the time required to fulfill customer-selected in-person items may be too great.

In some implementations, the modification conditions may include item stocking/availability conditions. For example, if an item was originally unavailable when the customer placed the order, the customer may be allowed to add the item to the order (e.g., at any time), since the store bears the responsibility for the out-of-stock item (or mistaken reporting of an out-of-stock item). If there was a substituted item for the originally out of stock item, the customer may also delete that item from the customer order.

In some implementations, the customer may be notified in real-time that an item is not in stock. For example, when placing an unscheduled order, the picker (or CCS) may notify the customer in real-time that the item is not in stock (e.g., using a picker GUI). The customer may then be provided with one or more alternatives for order modification (e.g., in the customer application GUI). If the customer chooses to request a substitute item for the out of stock item, the newly added substitute item may be immediately assigned to the original picker (e.g., the picker that notified the customer) if the original picker is close to the item. In other cases, the newly added substitute item may be assigned to another picker that is currently near, or will be near (e.g., on a route), the newly added substitute item. In other cases, the newly added substitute item may be assigned to the original picker at a later time (e.g., after the route has finished). In some cases, the availability of another picker and/or the original picker to pick the newly added substitute item may be used as a modification condition. For example, no substitution may be allowed if no pickers are available (e.g., no pickers available within a period of time to pick the newly added substitute item).

In some implementations, the modification conditions may be based on whether the product was advertised to the customer or otherwise recommended to the customer (e.g., by the store or third party). For example, a customer may be allowed to add an item that the store, or third party, advertised to the customer. In one example, the CCS (e.g., an advertising system) may be configured to advertise/recommend items to customers in order to entice the customer to make a last minute purchase. Exceptions for last minute modifications may be made for such advertised/recommended items. The store may advertise/recommend items in order to clear inventory, increase sales, receive advertising revenue, or for other reasons.

In block 12906, if the order is not eligible for modification, order fulfillment (e.g., picking, packing, and/or delivery) may proceed without modification. In block 12906, if the order is eligible for modification, the customer may modify the order in an order modification interface (e.g., addition interface, deletion interface, and/or substitution interface).

In block 12908, the CCD/CCS may receive order modifications from the customer. For example, the CCD/CCS may receive one or more deletions, one or more additions, and/or one or more substitutions. The CCD/CCS may update the customer order in the customer application as the customer makes modifications. For example, the CCD/CCS may indicate to the customer whether the customer may continue making modifications, as well as the types of modifications that may be made. In some implementations, the CCS and/or customer application may limit the customer's modifications in the shopping application based on changes in conditions that may limit a customer's eligibility to continue modifying the order (e.g., continue to add, delete, and/or substitute items). For example, a customer may continue to modify the order so long as modification eligibility conditions are satisfied. In some examples, a customer may become ineligible to modify the customer order after adding a threshold number of items, or after any of the eligibility conditions are not satisfied.

The CCS may provide updates to the customer that may indicate how their picking, packing, and/or delivery has changed, or will change, in response to modifications. For example, an addition/substitution may add time to picking, packing, and/or delivery of the order, which may be indicated to the customer prior to making the modification or after making the modification. In a specific example, if the customer adds an item to the order, the CCS may estimate an amount of time that may be added to picking, packing, and/or delivering the order based on the additional item. The additional estimated time may be indicated to the customer (e.g., in the customer application GUI). The amount of added time may be predicted based on a variety of factors, such as a current number of pickers, number of packers, current picker locations, current picking routes, current driver availability, and/or other factors. The CCS/CCD may determine other modification consequences for the customer as well, such as an amount of extra cost added for the modification (e.g., in the case the store charges for modifications). In some implementations, the customer may be required to agree with the updates in order to cause the modifications to be applied to the customer order.

In block 12910, the picking, packing, and/or delivery may proceed according to the original customer order or the modified customer order. Modifications may be integrated into the customer order in a variety of ways, depending on the type of modification and the status of the picking/packing process (e.g., whether picking has started, how much of the order has been picked, and other factors).

In some implementations, the CCS may be configured to assign the modifications to the same picker(s)/packer(s) that picked/packed the customer order. In these implementations, the same picker(s)/packer(s) may efficiently modify the customer order due to their familiarity with the customer order. However, assignment to the original picker(s)/packer(s) may not be efficient for a variety of reasons. For example, if the items are packed and ready for customer pickup, the original picker(s)/packer(s) may be located too far away from the packed items to efficiently remove deleted items. As another example, if the items have already been picked, the picker(s) may be located too far away from added items to pick the added items. Accordingly, in order to increase modification efficiency, the CCS may additionally/alternatively assign modifications to pickers/packers according to any of the reasons described herein (e.g., picker/packer location, availability, etc.).

In some implementations, the CCS may assign the modifications to a user based on the location of the user. For example, a user (e.g., picker, packer, driver, or other employee) that is closest in location to the modification may be assigned the modification. In a specific example, if a user is located near a customer pickup location, the user may be assigned the task of removing deleted items from customer orders (e.g., removing items from carriers, a customer's car, etc.). In another specific example, if a picker is located near a newly added item, the picker may be assigned to pick the newly added item.

In some implementations, some users may be designated as modification pickers/packers that are assigned to handle addition, deletion, and/or substitution modifications. Designating some users as modification pickers/packers that handle modifications may provide the users with context as to their role in the order filling pipeline.

In some implementations, the picker and/or packer GUIs may indicate the modification types to the pickers/packers. For example, the picker/packer GUIs may group modification items separately from customer orders. In one example, the modification items may be grouped separately from the actual order being picked. In another example, if the order is picked and packed, the GUI may list the modification items separately, but indicate that the modification items are for an existing picked/packed order. In some implementations, the modification items may be integrated into their respective picking/packing lists (e.g., intermixed into the lists or grouped). In some implementations, added items may be intermixed based on location. In some implementations, the picker/packer GUI may indicate the type of modification associated with the items in order to give the picker/packer context. The indications may be by text (e.g., “Delete item X in location/carrier Y” or “Add item X to order Y”). In some implementations, the picker/packer GUIs may instruct the user how to handle the items, such as where to retrieve and place a deleted item and/or where to place an added item (e.g., carrier, customer location, etc.). In some implementations, a picker/packer GUI for modifications may also include other information regarding the associated order, such as an order number, customer name/location, the status of the order (e.g., being picked, being packed, a number of items picked/packed, a location of items/carriers for the order, etc.).

A variety of picking/packing operations are described herein for a variety of different types of modifications. In some implementations, a store and/or third party may implement specific procedures for modifications. In some cases, the store and/or third party may train employees to operate according to the procedures. In some implementations, the MSD GUIs may instruct the user as to which procedures to follow, such as whether to scan a deleted item, where to place a deleted item, etc. In some implementations, a store may implement specific modification eligibility conditions for different types of modifications (e.g., deletion-specific modification conditions, addition-specific modification conditions, and substitution-specific modification conditions).

The CCS/MSDs may handle item deletions in a variety of ways. In some implementations, if the deleted item is not yet picked, the CCS/MSD may remove the item from the order (e.g., from CCS memory or the MSD display). This deletion may not require any additional labor, although if the item has been presented in a picker GUI, the picker may notice the item being removed. In some cases, the picker GUI may provide a notification to the picker that the item has been deleted from the customer order by the customer (e.g., text indicating the removal may be presented on the deleted item in the GUI and/or as a pop up GUI element in the picking GUI).

In some implementations, if the deleted item has already been picked, the CCS/MSD may instruct the picker to remove the item from the carrier and place the item back on the rack location if the user is close to the rack. For example, the CCS/MSD may instruct the user to place the item back on the rack if the user is within a threshold distance from the rack location and/or the user has removed the item within less than a threshold amount of time before receiving the deletion instruction. In some implementations, placing the item back on the rack may include one or more scans (e.g., an item scan and/or rack location scan) to indicate that the item has been placed back on the rack.

In some implementations, if the deleted item has already been picked, the CCS/MSD may instruct the picker to put the deleted item in a location other than the original picked location. For example, if the user has moved far away from the picking location (e.g., greater than a threshold distance) or has moved away from the picking location for greater than a threshold amount of time, the CCS/MSD may instruct the user to put the deleted item in another location, as placing the item back in the picking location would be inconvenient. The other locations may include, but are not limited to, a designated area for deleted items (e.g., in a packing area or other area of the store), a dynamic location in the store that is dictated by the CCS/MSD based on customer location (e.g., a nearby dynamic location for later stocking by another user), another user's carrier (e.g., a transfer to another user that can use the item for another order), or other location. In some implementations, the picker GUI may instruct the picker to place the deleted item in the other location. In some implementations, placing the item in the other location may include one or more scans (e.g., an item scan and/or location placement scan) to indicate that the item has been placed in the other location.

In some implementations, if the deleted item has been picked and placed in the packing area, the CCS/MSD may instruct a user (e.g., a picker/packer) to remove the item from the customer order (e.g., remove the item from the carrier). In some implementations, the CCS/MSD may instruct a user to place the item into a designated area for deleted items (e.g., a designated area in the packing area). In some implementations, removing the deleted item may include scanning the item to indicate the deleted item has been removed (e.g., removed from a carrier). In some implementations, the user may also scan the carrier when removing the deleted item. In some implementations, the MSD may generate a deletion GUI that indicates to the user the deleted item and location (e.g., carrier ID/location).

In some implementations, if the deleted item has been handed over to the customer (e.g., placed in the customer's car), the CCS/MSD may instruct a user to remove the item from the customer order (e.g., remove the item from a customer's car). For example, the CCS/MSD may instruct a user that is closest to the customer's car to remove the item. As another example, the CCS/MSD may instruct a user that handed over the items to the customer to remove the deleted item. In some implementations, this type of deletion may include one or more scans, or other user GUI input, indicating that the deleted item has been removed. In some implementations, a customer may request and/or confirm the removal of the deleted item using their CCD.

As described herein, an MSD may generate an item deletion interface that instructs a user how to handle deleted items. For example, the interface may instruct a user how to scan deleted items and where to place deleted items (e.g., back on a rack, in a designated area, etc.). In some implementations, when a user is tasked with handling multiple deleted items, the deleted items may be arranged/re-arranged in the item deletion interface based on location of the user relative to the items (e.g., closer items may be arranged higher on the MSD interface or in another manner described herein). In some implementations, multiple deleted items may be displayed to a user in a deletion interface based on the priority associated with the deletions. Deletions that are higher priority may be presented to the user first (e.g., one at a time on the interface) and/or higher on the deletion interface. Higher priority deletions may include deletions of items that have been handed over to the customer or are ready to be handed over to the customer. Lower priority deletions may be for deletions of items that are not due to be handed over to the customer until a later time.

The CCS/MSDs may handle item additions in a variety of ways. In some implementations, if the customer order has not been assigned to a picker, an additional item may be added to the customer order. In implementations where the customer order has been assigned, an item addition may be assigned to the picker that is currently picking the order if picking the additional item does not overburden the picker. For example, the CCS/MSD may instruct the picker to pick the additional item if the additional item can be included in the future movement/picking for the picker (e.g., on the route and/or within less than a threshold deviation). If the picker is overburdened by picking the additional item (e.g., required to deviate from the route a threshold amount), the additional item may be assigned to another picker (e.g., a picker that is near, or will be near, the additional item). If multiple pickers are picking a customer order, in some implementations, the picker that is least inconvenienced by picking the additional item may be assigned the item. If the customer order is in the packing area, the additional item may be added into the order in the packing area. If the order has been handed to the customer, the additional item may be provided to the customer. In some implementations, the additional items may be placed into a designated area in the store (e.g., in the packing area or other location).

In some implementations, the MSD may render an addition interface that instructs the user regarding additional items. For example, if a user is picking a customer order, the additional item could be added to the GUI for picking. In some implementations, the additional item may be intermixed with other items from the customer order. In some implementations, the additional item may be rendered in a separate portion of the GUI for additional items. In some implementations, the addition interface may indicate that the item is an additional item (e.g., via text, color, etc.) and also provide instructions for scanning the item and placing the item (e.g., in the packing area).

As described herein, an MSD may generate an item addition interface that instructs a user how to handle additional items. In some implementations, multiple additional items may be displayed to a user in an addition interface based on the priority associated with the additions. Additions that are higher priority may be presented to the user first (e.g., one at a time on the interface) and/or higher on the addition interface. Higher priority additions may include additions for waiting customers or complete orders to be handed over to customers. Lower priority additions may be for addition of items that are not due to be handed over to the customer until a later time (e.g., a later scheduled time or a later estimated customer arrival time).

The CCS/MSDs may handle item substitutions in a variety of ways. In some implementations, the CCS/MSDs may handle item substitutions as a deletion and an addition. In these implementations, the CCS/MSDs may handle the deletion according to any of the deletion techniques described herein, which may depend on when the substitution was entered by the customer. Similarly, the CCS/MSDs may handle the addition according to any of the addition techniques described herein, which may depend on when the substitution was entered by the customer. In a specific example, the CCS/MSDs may handle a substitution before picking by removing one item from an MSD and adding another (e.g., adding based on picker location). In some cases, a single user may perform the addition and deletion. In other cases, multiple users may perform the addition and deletion.

In some implementations, the CCS/CCDs may implement the order modification techniques described herein using a request/response cycle. For example, a CCD may request a modification eligibility determination from the CCS. The CCS may determine whether the order is eligible for modification. The CCS may provide a response to the CCD indicating whether the order is eligible for modification. The response may also indicate the extent to which the order may be modified, such as a number of additions, deletions, etc. The CCD and CCS may maintain communication (e.g., requests/responses) while a customer modifies the customer order.

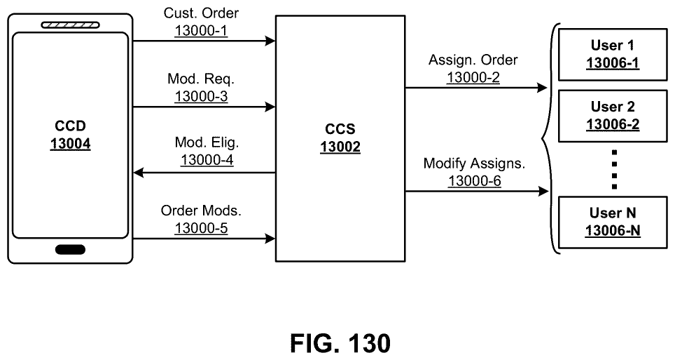

FIG. 130 illustrates an example scenario in which a customer places an order that the customer subsequently modifies. In FIG. 130, a customer places a customer order with the CCS 13002 at 13000-1 using a customer computing device 13004. The CCS 13002 assigns tasks associated with fulfilling the customer order to one or more users 13006-1, 13006-2, . . . 13006-N (e.g., one or more user devices) at 13000-2, such as one or more pickers, one or more packers, and/or one or more drivers. After placing the customer order, the customer device 13004 (e.g., the customer application) queries the CCS 13002 with a modification request at 13000-3 to determine whether the customer may modify the placed customer order.

In some implementations, a customer may interact with the customer application to generate the modification request. For example, the customer may manually select a modification GUI element to indicate that the customer wants to modify their already-placed order. In response to the manually indicated desire to modify the customer order (e.g., by selecting a modification GUI element), the customer device 13004 (e.g., customer application) may send the modification request to the CCS 13002. In some implementations, the customer device 13004 (e.g., customer application) may automatically generate modification requests in order to keep the customer application (e.g., customer GUI) up to date regarding the ability of the customer to modify their order. For example, the customer application may send a modification request to the CCS 13002 automatically in response to the customer opening the application. As another example, the customer application may send a modification request to the CCS 13002 automatically in response to other triggers, such as a customer accessing different pages of the customer application, at defined times (e.g., at predefined times while the customer is using the application or has the application backgrounded on the user device 13304), or based on other customer actions or triggers.

Although modification of an order may be performed after order assignment to users, the modification request and subsequent steps in FIG. 130 may be made prior to assignment of the order to any of the one or more users. For example, a modification request may be sent before any user has started picking. Other example times that the modification request may be sent and responded to may include, but are not limited to, after picking, after packing, or at any other time in the order fulfillment pipeline for the customer order.

The CCS 13002 responds to the customer device 13004 (e.g., customer application) indicating that the customer order may be modified at 13000-4 (e.g., items may be added, deleted, and/or substituted, as described herein). The customer modifies their customer order in the customer application and the modification is sent to the CCS 13002 at 13000-5. The CCS 13002 then modifies assignment of tasks (e.g., items to be picked, packed, and/or delivered) to one or more users 13006 at 13000-6. In some implementations (e.g., where a single user handles the complete customer order), the same user may be assigned the task of modifying the customer order. In some implementations, other users may be responsible for modifying the customer order.

In some implementations, the OFS or other systems (e.g., a TPCS), may be configured to allocate tasks in the order fulfillment pipeline to one or more business entities. For example, one or more systems (e.g., a store CCS and a TPCS) may split picking, packing, and/or delivery tasks between a store and a third party. The system(s) may allocate tasks between two business entities for a variety of reasons described herein. In some implementations, the entities may be compensated by one another for performing tasks for one another. Allocation of tasks may include requesting assistance for one or more tasks from another entity and/or assigning (e.g., commanding) tasks to another entity.

In some implementations, a first entity (e.g., a first entity computing system, such as a CCS) and a second entity (e.g., a second entity computing system, such as a TPCS) may share one or more tasks in the order fulfillment pipeline. An entity that receives the customer order may be referred to as the “order-receiving entity.” Two entities (or more) may share tasks in the order fulfillment pipeline to fulfill one or more customer orders. For example, a first entity may allocate tasks to a second entity (i.e., offload one or more tasks to a second entity). In one example, a first entity (e.g., the order-receiving entity) may assign a complete task to a second entity. In another example, a first entity (e.g., the order-receiving entity) may assign a partial task to a second entity (e.g., split/share a task with the second entity). In a specific example, the first entity may perform a partial picking task (e.g., pick a portion of the items) and assign part of the picking to a second entity. One or more entities may split a variety of tasks in a variety of ways described herein.

A variety of business entities may split tasks in the order fulfillment pipeline. Example business entities may include store entities and third-party entities. Third-party entities may refer to third parties that provide any service related to the order fulfillment pipeline, such as picking, packing, and/or delivery services. Example tasks provided by the entities may include picking tasks, packing tasks, delivery tasks, or other tasks. For example, a single order may require picking tasks, packing tasks, and/or delivery tasks by one or more business entities.

In some implementations, stores may be configured to perform all tasks for customer pickup and/or delivery. For example, a store may be configured to pick, pack, and deliver orders. In some implementations, stores may pick and pack customer orders. In these implementations, customers may pick up the orders or have the orders delivered by a third-party delivery entity. In some implementations, stores may also allow third parties to pick in the store. For example, third parties may pick entire orders or only a portion of an order. In cases where third parties pick a portion of an order, the store may pick the remaining portion of the order. In some implementations, the store and/or third party may pack orders. For example, a store may completely pick an order that is then packed (e.g., in the packing area) by a third party (e.g., a third-party delivery service). In another example, a third party may pick a first portion of an order and then pack the complete order by packing items from a second portion of the order that was picked by the store. In some implementations, the tasks may be performed by multiple third parties in the store. For example, multiple third parties may work together to pick, pack, and/or deliver one or more customer orders. In some implementations, tasks may be performed by one or more users for each of the parties.

In some implementations, tasks may be split between parties such that each task may be completed by a single party. For example, a store may completely pick and pack orders. In this example, a store may choose a third party to deliver the order. In some implementations, the tasks themselves may be split between two parties. For example, a store and a third party may pick a single customer order. In this example, one entity (e.g., a store or third party) may request/assign a portion of the task to the other entity (e.g., the store or third party). The example task splits (e.g., whole/partial tasks) among different entities described herein are only examples task splits. As such, the OFS may implement other splits that are not explicitly described herein. In some implementations, an entity's computing system (e.g., a store CCS or TPCS) may be configured to assign all tasks for a customer order to another entity's system. For example, a store may assign a complete customer order to a third party (e.g., in the case the store does not have sufficient resources to fulfill the order).

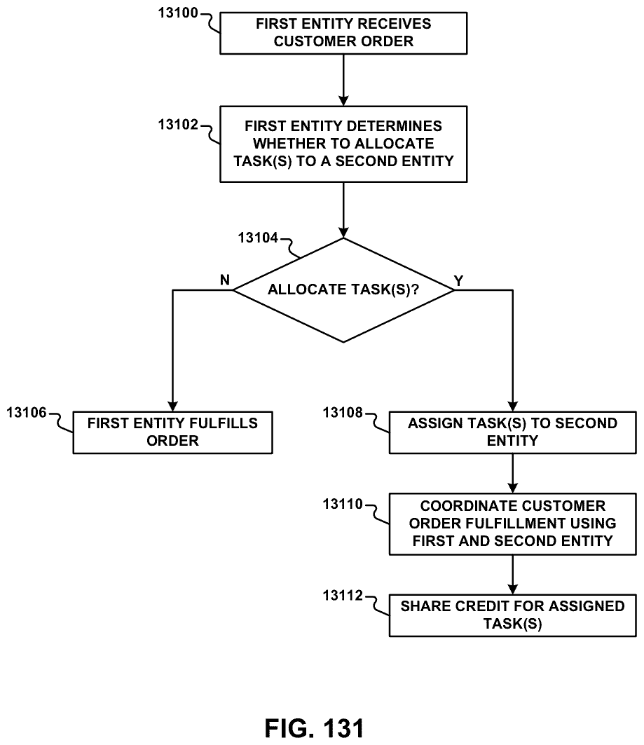

FIG. 131 illustrates an example method for allocating tasks/orders among different entities. The first and second entities of FIG. 131 may refer to a variety of different entities. For example, the first entity and second entity may be a store (e.g., a retail/grocery store) and a third-party entity (e.g., a picking and/or delivery entity), respectively. As another example, the first entity and the second entity may be a third-party entity and a store, respectively. As another example, the first entity and the second entity may both be third-party entities.

In block 13100, a first entity (e.g., a first entity computing system) receives a customer order. In block 13102, the first entity determines whether to allocate one or more tasks to a second entity. The first entity may determine whether to allocate tasks to another entity for a variety of reasons. The reasons for allocating tasks may vary, depending on the types of entities (e.g., store, third party delivery, etc.), the tasks each entity typically performs, the tasks to be allocated (e.g., picking, packing, and/or delivery), the types of allocations (e.g., a complete/partial allocation), and/or other reasons.

In some implementations, the first entity may allocate tasks based on a lack of available resources for performing the tasks sufficiently. An entity may lack resources to perform a task sufficiently in scenarios where the entity does not typically perform the task. For example, if a store does not provide delivery services, the store may request that another entity (e.g., a third-party delivery entity) provide delivery for one or more customer orders. If an entity does not perform a specific task, the entity may be configured to automatically request that the task be performed by another entity.

In some implementations, an entity may lack resources to perform a task sufficiently due to the lack of available human resources, the outstanding order/item volume, a tight timeline for fulfillment (e.g., unscheduled pickup/delivery), and/or other reasons. For example, an entity may lack resources to sufficiently pick, pack, and/or deliver, even though the entity may typically perform the tasks. For example, an entity may lack a threshold number of pickers, packers, or drivers. As another example, an entity may lack a sufficient ratio of users to the amount of work to be performed (e.g., less than a threshold number of pickers per outstanding items/orders, less than a threshold number of packers per outstanding items/orders, and/or less than a threshold number of drivers per outstanding order to be delivered). In a first specific example, if a store typically delivers customer orders picked at the store, in some scenarios, the store may lack delivery resources to deliver one or more orders (e.g., due to a temporary increase in needed deliveries, lack of delivery driver availability, etc.). In this first specific example, the store may make a request to a third-party delivery system indicating that the store could use assistance in delivering the one or more orders. In a second specific example, if a store typically picks items for customer orders, in some scenarios, the store may lack picking resources for one or more new customer orders (e.g., due to a temporary increase in order volume, lack of pickers, etc.). In this second specific example, the store may make a request to a third-party system for picking the one or more new customer orders. In a third specific example, if a third party typically picks items for customer orders and delivers the items, in some scenarios, the third party may lack picking resources for one or more new customer orders (e.g., due to a temporary increase in order volume, lack of pickers, etc.). In this third specific example, the TPCS may make a request to a store for picking the one or more new customer orders (e.g., for subsequent third party delivery).

In some implementations, a first entity may allocate one or more tasks to a second entity when the second entity may efficiently complete the one or more tasks. For example, a first entity may allocate delivery to a second entity in the case that the second entity may perform the delivery in an efficient manner, such as a more efficient manner than the first entity. In a specific example, the first entity (e.g., a store) may allocate delivery to a second entity (e.g., a third-party delivery entity) when one or more customer orders may be delivered by the second entity in a very efficient manner (e.g., on an existing third-party delivery route). In another example, a first entity may allocate partial/complete picking of a customer order to a second entity when the second entity may perform the picking in an efficient manner, such as a more efficient manner than the first entity. In a specific example, a first store entity may allocate picking of a partial/complete new customer order to a second entity if the second entity has a user in the store already picking customer orders and part/all of the new customer order may be picked by the second entity user without much/any deviation from their current route (e.g., less than a threshold deviation in time/distance). In another specific example, a third-party entity may allocate picking of a partial/complete order to a store entity if the store entity can pick the order more efficiently (e.g., on/near an existing route) or more quickly (e.g., prior to arrival of the third-party user at the store).

In cases where the first entity system (e.g., CCS or TPCS) is configured to allocate based on efficiency, the first entity system may be configured to determine efficiency using any of the picking/packing assignment factors described herein (e.g., based on picker/packer location, current picking/packing workload, current route, etc.). For example, the CCS/TPCS may be configured to treat users from the second entity in a similar manner as users from the first entity (e.g., assign tasks to the most efficient user without regard to the entity with which the user is employed). This treatment of second entity users may also be subject to some caveats, such as a second entity user being able to reject tasks assigned by the first entity (e.g., reject tasks in a third party application GUI).

In some implementations, the first entity system may make the decision to assign a task to a second entity if the second entity can complete the task faster than the first entity (e.g., a threshold period of time faster). For example, if order fulfillment time is critical to an order (e.g., for an unscheduled pickup/delivery, needed modification, high priority item, etc.), the first entity system may assign one or more tasks to a second entity if the estimated order fulfillment time using the second entity is better (e.g., faster/earlier) than the estimated order fulfillment time using the first entity.

In some implementations, the first entity system may be configured to determine efficiency using a cost calculation for the tasks. For example, if the cost to perform one or more tasks by the second entity is lower than the first entity performing the tasks, the first entity may assign the tasks to the second entity. In a specific example, for a delivery task, the first entity system may determine cost based on driving distance (e.g., mileage costs, fuel costs, etc.), driving time (e.g., driver cost), and other factors. Such a cost calculation may be used in cases where the entities are configured to share credit/payment for performing one or more tasks, as described herein.

If the first entity does not allocate tasks in block 13104, the first entity fulfills the customer order in block 13106. If the first entity decides to allocate tasks, the first entity may assign one or more tasks to the second entity in block 13108. In block 13110, fulfillment of the order is coordinated using the first and second entities. The orders may be coordinated by the entities in a variety of ways, depending on when the tasks were assigned (e.g., earlier assigned tasks may be completed first), which tasks were assigned (e.g., delivery may be performed last), the length of the assigned tasks, and/or other factors. In some cases, the first and second entity may perform the tasks at the same time. For example, the first entity may assign tasks to users from each entity at the same time. In some cases, the first entity may perform their tasks first and then the second entity may perform the assigned tasks. For example, a store CCS may assign picking/packing to store users for an order and then allocate delivery of the order to a third party. In other cases, the second entity may perform their assigned tasks first (e.g., picking a first portion of an order) and then the first entity may perform their tasks (e.g., picking a second portion of the order and packing the complete order).

In block 13112, the first and second entity systems may share credit for the assigned tasks. For example, the first and second entity systems may be configured to split credits or other financial compensation based on the assigned tasks. The credits/payments may be based on a variety of different factors, such as the number of items, number of orders, delivery times, delivery distances, estimated costs for the tasks, etc. In some implementations, the credits/payments may be determined on a per item basis, per order basis, per dollar basis, or in another manner. For example, the first and second entity systems may keep track of items, orders, dollars, etc. (e.g., in one or more stored ledgers).

In some implementations, the first and second entity systems may track credits in terms of items picked. For example, each system may determine a number of items picked for the other system. In some implementations, the first and second entity systems may track credits in terms of orders picked. For example, each system may determine a number of orders picked for the other system. In some implementations, the first and second entity systems may track credits in terms of orders delivered. For example, each system may determine a number of orders delivered for the other system. In some implementations, the first and second entity systems may track credits in terms of cost. For example, each system may determine a cost incurred when performing tasks for the other system. Example costs may include user time, resources expended (e.g., fuel, car mileage, grocery bags, etc.). The systems may track costs for picking items, packing items, and/or delivering orders. Each system may keep a running total of credits/costs over time, such as a total number of items picked, items packed, orders delivered, etc. In some implementations, the systems may use fixed costs per item picked/packed. In some implementations, the systems may determine costs in a more detailed manner, such as an estimated amount of time spent by a user performing tasks (e.g., picking, packing, and/or delivering) and an estimated amount of costs due to other factors, such as fuel costs and mileage for delivery. Each entity may compensate their respective users according to the tasks performed (e.g., according to a payment scheme decided on between the users and the entities).

The first and second entity systems may keep track of credits/dollars over time and settle up at a future time with payments and/or by performing tasks for the other party. For example, if a first entity picks X number of items for a second entity (e.g., X more items than the second entity picked), the second entity may pay for the items (e.g., at a per item cost) and/or perform the same/similar number of picks for the first entity. In another example, if a second entity delivers for a first entity, the first entity may compensate the second entity with a payment equal to the cost of the past deliveries (e.g., the total added cost to the second party in terms of user time, fuel costs, mileage, etc.). In some implementations, the first and second entities can agree on a credit/payment arrangement to be implemented by the first and second entity systems.

Although the method of FIG. 131 may be performed for a single customer order, the first and second entity system(s) may perform the method of FIG. 131 for a plurality of orders (e.g., in a batch). In some implementations, allocation features described herein may be turned on/off by the one or more systems, such that the first and second entity system(s) may or may not make requests for assistance. In some implementations, the system(s) may be configured to always consider allocation when assigning tasks. In some implementations, allocation may be configured for only some tasks.

As described herein, the first and second entity systems may share data/information with one another. The entities may share any information described herein with one another. For example, entities may share order information (e.g., order numbers, items in orders, scheduled pickup/delivery times, etc.), picking data (e.g., picker number, picker location, picking routes, etc.), packing data (e.g., packer number, packer location, items being packed, carrier locations, etc.), delivery data (e.g., delivery locations, delivery times, routes, etc.), and other data described herein. The information shared between entities may allow the entities to determine the state of one another for task allocation purposes. For example, entities may use the shared information to determine whether one entity may require assistance, could benefit from assistance, or may provide assistance for one or more tasks.

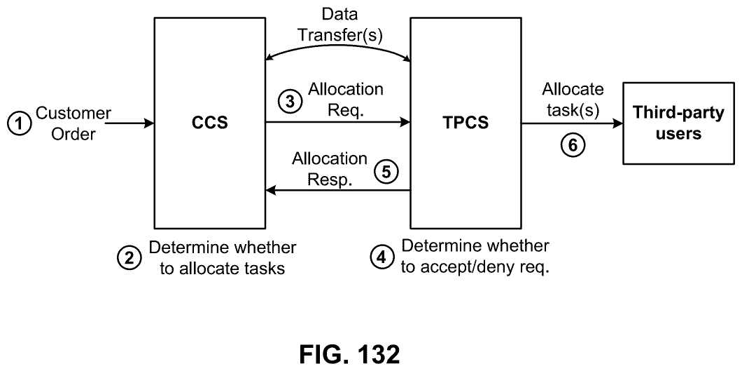

The different entity systems may communicate with one another to allocate tasks with one another. The communications between entities may be described herein as using a request/response communication protocol. For example, a first entity system may make a request to a second entity system for assistance in performing tasks. In this example, the second entity system may respond to the request by accepting/denying the request for assistance. As another example, a first entity system may make a request to a second entity system to determine whether the second entity system would like assistance with one or more tasks. In this example, the second entity system may respond with an indication that the second entity system does/doesn't want assistance with tasks. In some implementations, a first entity system may indicate to a second entity system that the first entity system has extra bandwidth to handle tasks. In these implementations, the second entity system may assign tasks to the first entity system and/or request assistance with second entity system tasks. Although a request/response communication protocol is illustrated herein, other types of communications may be implemented. Although requests/responses are illustrated between two parties (e.g., in FIG. 132), requests and responses may occur between additional parties (e.g., 3 or more parties).

FIG. 132 is a functional block diagram illustrating allocation of tasks between two entities. For example, FIG. 132 illustrates an example store entity and a third-party entity sharing tasks. Although a store and third party are illustrated, the requests/responses could be between any parties. Requests and responses between different parties may include different information. The information included in the requests and responses may be specific to the types of requests/responses (e.g., assistance request, a request asking an entity if it needs help, or an indication of more bandwidth), the parties involved in the request/response, and other factors. The example requests/responses in FIG. 132 are only examples. As such, other requests/responses may include other data described herein.

In FIG. 132, the first entity is a store (e.g., CCS) that is requesting assistance from a third party (e.g., TPCS) that may provide assistance with picking, packing, and/or delivery. The entity that requests assistance (e.g., the store in FIG. 132) may be referred to as a “requesting business entity” or a “requesting entity.” The entity that receives the request (e.g., the third party in FIG. 132) may be referred to as a “responding business entity” or a “responding entity.”

In FIG. 132, a store may provide picking, packing, and delivery services. The third party in FIG. 132 may also provide picking, packing, and delivery services. Note in FIG. 132 that the CCS and the TPCS may communicate with one another outside of requests/responses directed to allocating tasks. The communications outside of the requests/responses are illustrated as “data transfer(s).” A variety of types of data transfers may be performed between the CCS and the TPCS. In general, any of the data associated with customer orders, picking, packing, delivery, and users (e.g., locations) may be shared between the CCS and TPCS. The shared data may be used by the CCS and/or the TPCS to determine whether the store or third party may require assistance or provide assistance. Note that the requests and responses may also be formatted to include the appropriate/needed data at the time the responses and requests are sent (e.g., in addition to, or instead of, other data transfers).

In FIG. 132, the CCS receives a customer order at (1). The CCS determines whether to allocate tasks at (2). The store may generate and send the allocation request at (3). The store may send the request in response to satisfaction of a variety of conditions/rules for sending requests. For example, as described herein, the CCS may determine that tasks should be allocated if the store lacks resources for fulfilling the order and/or the third party may more efficiently fulfill some/all of the customer order. In some implementations, the CCS may also determine the type of request to make (e.g., a picking assistance request, driving request, etc.) and the extent of the request (e.g., a partial pick, complete pick, etc.). The requests may include information relevant to tasks being allocated. For example, the requests may include order information (e.g., items to be picked, required completion time for picking/packing, delivery location, etc.), an amount of credit/payment for the task(s), and/or any other order fulfillment data described herein (e.g., a route, dropoff location, etc.).

The TPCS receives the request and determines whether to accept/deny the request at (4). The TPCS may determine whether to accept the request based on available TPCS resources for fulfilling the request (e.g., picker location, driver location, current picking/driving tasks underway, etc.), the compensation associated with the request (e.g., credit/payment for the tasks indicated in the request), and/or other factors (e.g., whether a user will accept/deny the request). In some implementations, the TPCS and CCS may negotiate the compensation. For example, an entity performing a task may request greater payment for the task, while an entity paying for the task may attempt to reduce the payment.

The TPCS may respond to the CCS indicating the TPCS decision at (5). The TPCS may allocate accepted tasks to third-party users (e.g., third-party pickers, packers, and/or drivers) at (6) after accepting the request. The response to the CCS may indicate whether one or more tasks in the request are accepted or denied (e.g., automatically accepted by the TPCS and/or manually accepted by a third-party user). The response may include a variety of information associated with acceptance or denial of the request. For example, the response may include data indicating which task(s) were accepted, user(s) associated with the task(s), expected task starting/completion time, and other data. The TPCS and/or third-party user devices may also update the CCS with progress regarding the tasks, such as user locations, items being picked, items being delivered, when the tasks are completed, and other data. For example, the third-party devices may update the TPCS and/or CCS directly. In some implementations, the third-party devices may update the CCS via the TPCS.

Allocation requests may include any data relevant to the tasks being allocated. The data included in the requests may also depend on the type of task associated with the request. Allocation responses may include any data relevant to accepting and completing the tasks. As such, the data that may be included in allocation requests/responses described herein is only example data. Although a single request/response cycle is illustrated in FIG. 132, multiple requests/responses may be communicated between the CCS and TPCS. Although FIG. 132 illustrates a single response followed by a single request, any number of requests and responses may be communicated in any ratio.

In some implementations, a first entity may be configured to transfer data with a second entity and/or generate responses automatically (e.g., based on timing or other triggering factors). In some implementations, a first entity may be configured to send a request, send a response, and/or otherwise transfer data in response to manual user input (e.g., a manager, picker, driver, or other user may generate an allocation request).

In some implementations, a first entity may make requests for assistance from a specific second entity user (e.g., a specific picker or driver) based on knowledge shared with the first entity (e.g., knowledge of the user's location inside/outside the store, a delivery route, a picking route of the user, etc.). In some cases, the first entity may make more general requests for assistance (or to provide assistance) to a second entity. In these cases, the second entity may determine whether any assistance can be provided to the first entity by any of the second entity users.

In some implementations, a request may require acceptance by a user (e.g., in a user GUI). For example, a picker or driver may be provided with the option in a GUI to accept/deny the request manually. The GUIs may provide details to the user regarding the tasks being requested, the party requesting the tasks, etc. In other examples, a system (e.g., CCS/TPCS) may determine whether the tasks are to be assigned to the users automatically and then assign the tasks.

As described herein, allocation requests (e.g., requests for assistance, offers of assistance, etc.) may be triggered according to various conditions/rules implemented by the entities. The conditions/rules that define allocation requests/responses may be based on any data available to the entities (e.g., an own entity's data and/or entity data shared among entities). Example conditions/rules may include conditions/rules that indicate the entity itself may not be able to efficiently handle one or more current tasks. Determinations associated with the ability of the store and/or third party to handle the order may be based on a variety of factors, such as: 1) a number of outstanding orders/items (e.g., greater than a threshold number of orders/items may indicate an inability to handle the orders), 2) a number of orders and/or items relative to a number of users (e.g., pickers, drivers, etc.) that may provide the task (e.g., greater than a threshold number of orders/items relative to users may indicate an inability to handle the orders), 3) a picking rate (e.g., past, present, or estimated rate) relative to a required picking rate to satisfy the orders, 4) a wait time for customers (e.g., if the average current customer wait time for pickup/delivery is greater than a threshold value, then the entity may request assistance), and/or additional factors associated with picking, packing, and/or delivery.

As described herein, in some implementations, the order receiving party may determine whether to request assistance from a potential assisting party based on the ability of the assisting party to handle the customer order/items. Example conditions/rules for allocation requests in these circumstances may include conditions/rules that indicate that another entity may have the ability to efficiently handle additional tasks (e.g., tasks in general or specific tasks for specific users). Example conditions may include the presence of pickers in the vicinity of the items to be picked. For example, a store may request third-party pickers to pick if the third-party pickers are in the store, near the store, are scheduled to be at the store within a period of time, or can be at the store within a threshold period of time (e.g., in response to a request). Other example conditions may include the presence of delivery drivers in the vicinity of the items to be delivered (e.g., third-party drivers at the store or store drivers available to take third-party orders out for delivery). Other example conditions may be associated with picking routes of users in the store. For example, a store may request a third-party picker to pick items if the items are on the third-party picker route. As another example, a third party may request a store picker to pick items for a third-party order if the items are on the store picker's route. Other example conditions may be associated with delivery routes. For example, a store may request a third party to deliver if the third-party driver is on a route that includes, or is near (e.g., less than a threshold deviation in distance/time), delivery locations for store orders. As another example, a third party may request a store driver to deliver if the store driver route includes, or is near, delivery locations for third-party orders.

As described herein, determining whether to request that another entity perform tasks may be based on locations of one or more users. For example, user location may indicate whether a picker/driver can handle picking or delivery. Example locations may include, but are not limited to, current user location (e.g., current picker or driver location), future user location (e.g., a picking or driving location), and/or past user location (e.g., an entity may not allocate if it causes a user to backtrack to a previous location while picking or delivering).

An entity that takes on one or more tasks may be configured to accept the tasks manually. For example, a user may accept the task(s) manually using an MSD or other computing device. In some implementations, the entity (e.g., a system/device) may be configured to automatically accept one or more tasks for another entity. The entity may determine whether to automatically accept the task(s) based on a variety of conditions, such as conditions that indicate the entity may have the ability to efficiently handle the order. Example conditions (e.g., user location, user availability, current workloads, etc.) may include any conditions associated with task allocations described herein. In some cases, an entity may accept all of the tasks. In other cases, an entity may accept a portion of the tasks (e.g., pick and/or deliver a portion of items/orders) and deny other tasks.

An entity may allocate tasks in a variety of scenarios described herein. Example scenarios may include, but are not limited to: 1) a store using third party assistance for delivery, 2) a store using third party assistance for picking, 3) a store using third party assistance for packing, 4) a third party using a store for assistance in picking, 5) a third party using a store to deliver, 6) a third party user using another third party user (e.g., the same third party entity, but a different user) for assistance picking, packing, and/or delivering, and 7) a first third party using a second third party (e.g., a different third party business) for picking, packing, and/or delivery. Other example scenarios between one or more entities may also occur.

As described herein, in some cases, the store may request assistance in delivering one or more customer orders due to lack of store driver availability and/or due to knowledge that a third party may efficiently handle delivery. Example conditions that may trigger request for assistance from a third party driver may include when: 1) there are too few drivers for delivery (e.g., a low number of employees), 2) lack of sufficient drivers to meet delivery deadlines (e.g., estimated achievable delivery times are not sufficient), 3) drivers are scheduled to leave the store too late for other deliveries to meet a new delivery deadline, 4) drivers are currently too far from the store (e.g., greater than threshold distance), 5) drivers are not expected to be back to the store soon enough to meet a new delivery deadline (e.g., a driver is greater than threshold time from the store), 6) there are too many deliveries for drivers to handle, 7) there are outlier delivery destinations that are too far from the store or another driver route to be profitable, 8) a third party driver requests deliveries (e.g., because they are low on delivery work), and for other reasons described herein. In some cases, the store may request a specific driver (e.g., sent to the driver directly or managed through the TPCS) based on knowledge associated with the driver (e.g., driver location, delivery locations, route, etc.). In some cases, the store may make a more general request to one or more third parties for one or more drivers. In some cases, the store may make a request to a third-party picker that is picking, or will be picking, in the store to deliver one or more orders picked by the store.

In some cases, a store may request picking assistance from a third party due to lack of picking resources and/or knowledge that the third party may efficiently handle picking. The third-party picker may be requested to pick a complete customer order or a partial customer order. The third-party picker may also deliver the picked order or provide the order to a store delivery driver. Example conditions that may trigger a request for assistance from a third party picker may include when: 1) there are too few pickers to pick a current number of outstanding orders/items, 2) a third-party picker is located in the store, 3) a picking route being used, or that will be used within a threshold period of time, by a third-party picker in the store includes or is close to items in customer orders for the store, 4) a third-party picker requests orders/items to pick (e.g., because the third party is available for work), and/or other conditions described herein. A third-party picker may pick items in a partial store order before, during, or after the store picker(s) pick the other portion(s) of the customer order. In some cases, the store may request a specific picker (e.g., sent to the picker directly or managed through the TPCS) based on knowledge associated with the picker (e.g., picker location, picking route, etc.). In some cases, the store may make a more general request to one or more third parties for one or more pickers.

In some cases, a store may use third party assistance for packing. For example, a third-party picker may pack an order for the store after picking. As another example, a third-party delivery driver may pack an order that has been picked by the store or other party. For example, a third-party delivery driver may pack together multiple portions of a single customer order for delivery. Example conditions that may trigger a request for assistance in packing orders may include when: 1) there are too few packers to pack currently needed customer orders for pickup/delivery, 2) customer orders have been picked by multiple parties and the order is separated in the packing area, requiring packing prior to delivery by the third party, 3) it is store policy for third-party drivers to pack orders if needed, and/or for other reasons.

In some cases, a store may assist a third party in picking partial/complete customer orders. For example, a third party may request picking assistance from a store due to lack of picking resources and/or knowledge that the store may efficiently handle picking. In these cases, a store may pick the entire customer order or a third-party picker may pick a portion of the customer order. The third party-picker and/or store may pack the order and subsequently deliver the order. In a specific example, a store may pick a portion of the order and leave the portion in the packing area for collection by a third-party picker that will pack the order and deliver the order. The conditions for a third party requesting picking assistance from the store may be similar to the conditions described herein regarding a store that requests third party assistance.

In some cases, a third party may request assistance from a store to deliver a customer order. The third party may request assistance in delivering one or more customer orders due to lack of third-party driver availability and/or due to knowledge that a store may efficiently handle delivery. The conditions for a third party requesting assistance from the store for delivery may be similar to the conditions described herein regarding a store that requests third party assistance.

In some cases, a first third party user may request assistance from a second third party user for picking, packing, and/or delivery. In some cases, the third-party users may both work for the same third-party entity. In other cases, the third-party users may work for different third-party entities. The conditions for third-party users requesting assistance from other third-party users may be similar to the conditions described herein for other requests. In a specific example, a third-party entity may assign a partial/complete customer order to a first third-party user in a store. In this specific example, the third-party entity may assign delivery of the customer order to a second third-party user in the store. In this specific example, the second third-party user may pick other orders in the store or only serve as a delivery driver for the picked customer order.

In some implementations, stores may include designated locations for placing items/orders that are picked and/or packed by third parties. In some implementations, stores may include designated locations for placing items for third party delivery. In some implementations, users at the store and/or a third party may be designated as users that can handle allocation of items from another entity. For example, a portion of store users (e.g., store pickers) may be designated as available to be assigned items from a third party. Similarly, third party users (e.g., pickers or drivers) may be designated as available to have items assigned from a store. In some implementations, stores and/or third parties may have carriers that are designated for use in performing allocated tasks. For example, carriers may be colored, labeled, or otherwise indicate that they are to be used by third parties at the store.

Designated locations (e.g., in the packing area), designated users, and/or designated carriers may be assigned for any of the types of task allocations described herein (e.g., picking, packing, and/or delivery). In some implementations, GUIs (e.g., picking GUIs, packing GUIs, and/or delivery GUIs) may indicate to the users that items, carriers, and/or locations are associated with allocated tasks, as described herein with respect to other GUIs for other items, carriers, and locations. For example, a third-party picking GUI may indicate that specific items are store items, specific carriers are for store items, and/or specific locations should be used for the picked store items.

In some implementations, a first entity may send out requests to multiple additional entities (e.g., two or more entities). In some cases, the first entity may accept the first of the multiple additional entities that accepts the task(s). In some cases, the multiple additional entities may provide bid prices for performing the tasks. In these cases, the first entity may be configured to consider (and possibly accept) the lowest bid price for the task(s). Such a scenario may occur if there are multiple third party delivery entities, some of which can accept a delivery task at a lower bid due to location of their drivers in proximity of the store and/or a scenario in which a delivery driver is not required to deviate from an existing route (e.g., a store delivery is on an already existing route including a store customer order).

Example allocations of tasks described herein may be allocated between any of the entities described herein. Additionally, any of the tasks described herein (e.g., picking, packing, delivery, etc.) may be split among one or more entities. The allocation of tasks may be implemented using a request/response cycle, as described herein, or using other communication protocols.

Users and/or MSDs may have associated statuses. For example, users/MSDs may have an active status or an inactive status. The active/inactive status associated with a user may indicate whether the user is currently performing associated activities. Example active/inactive users described herein may include pickers, packers, and/or delivery drivers. Active users may be available to be assigned a task and/or actively performing tasks. For example, an active picker may be waiting to be assigned orders/items for picking and/or actively picking items for customer orders. As another example, an active packer may be waiting to be assigned orders/items for packing and/or actively packing customer orders. As another example an active delivery driver may be waiting to be assigned customer orders to be delivered and/or actively delivering one more customer orders (e.g., on a delivery route). Inactive users may be users that are not yet accepting tasks or are performing other tasks (e.g., a cashier is not an active picker, packer, or driver). Users may be active in more than one capacity. For example, a user may be an active picker and packer that can take new picking and packing assignments. In this example, the user may be an inactive with respect to delivery because the user is not currently delivering orders or accepting delivery tasks.

In some implementations, the CCS/TPCS may recruit/dismiss different users/MSDs. Recruiting may refer to transitioning a user/MSD from inactive to active, such as by making a request or command to a user to become active/inactive. In one example, with respect to a picker, a picker may be inactive and recruited to become active. In another example, a picker may be active and then dismissed to become inactive. Recruiting may include activating the MSDs (e.g., automatically) and/or making a request to an individual to pick up an MSD and start performing tasks. Although recruiting/dismissing may include transitions between active and inactive statuses, it may also be applied to transitioning users between different statuses, such as transitioning from a scheduled order picker to an unscheduled order picker (e.g., if more of that picker type is needed). In some implementations, the CCS may also allow users (e.g., pickers) to jump in (e.g., recruit/activate themselves) and/or jump out (e.g., dismiss/deactivate themselves) manually in addition to the automatic recruitment and/or dismissal.

The CCS/TPCS may communicate with users, MSDs, and/or other devices in order to recruit and dismiss the users. For example, the CCS/TPCS may send recruitment and dismissal communications to users/devices in order to recruit and dismiss the users. In some implementations, the users, MSDs, and/or other devices may respond to the communications in order to indicate that they accept the recruitment/dismissal. The recruitment/dismissal communications between users (e.g., MSDs or other devices) and the CCS/TPCS may be referred to herein by a variety of names. For example, the CCS/TPCS may send a recruitment request to a user to recruit the user. The recruitment request may also be referred to as a recruitment message, recruitment notice, or recruitment command, depending on the context, such as whether the user can reject the recruitment. For example, a recruitment response may reject a recruitment request, whereas a recruitment command may not be rejected. In another example, the CCS/TPCS may send a dismissal request to a user to dismiss the user. The dismissal request may also be referred to as a dismissal message, dismissal notice, or dismissal command, depending on the context, such as whether the user can reject the dismissal. For example, a dismissal response may reject a dismissal request, whereas a dismissal command may not be rejected.

As described herein, requests/dismissals may include a variety of different communications between the CCS/TPCS and devices. Communications (e.g., requests, responses, messages, commands, etc.) may include wireless communications, displayed text/numbers/images, audio (e.g., calls, intercom broadcasts, alerts, beeps, etc.), tactile communications (e.g., vibrations), and other types of communications. The communications described herein for recruiting/dismissing users are only example communications. As such, other recruiting/dismissing communications may be used other than those described herein. Recruitment/dismissal communications may also not be limited to a single request/command or a single request/response cycle. For example, recruitment/dismissal communications may include any number of communications between users/MSDs, intermediate devices, and the CCS/TPCS.

Recruiting and dismissing users may optimize the number of users performing tasks in the OFS (e.g., optimize the number of users picking, packing, and/or delivering). Optimizing the number of users performing specific tasks may also allow additional users at the store (e.g., dismissed users) to spend time performing other tasks not related to order fulfillment, such as stocking, organizing, customer service, etc.

Although recruitment/dismissal is described herein as a store that recruits/dismisses store employees, a third-party entity may also recruit/dismiss third party workers according to the techniques described herein. Additionally, a first entity may recruit/dismiss a second entity's users using the techniques described herein.

In some cases, recruitment and dismissal may include reassigning a user from one role to another. For example, recruitment and dismissal may include reassigning a user from a picker role to a packer role, a picker to a driver, a driver to a picker, etc. In some implementations, reassigning a user may be implemented as a dismissal from a first role and a recruitment to a second role. In some implementations, recruitment and dismissal may include other changes associated with a user, such as changing a picker from a scheduled order picker to an unscheduled order picker, changing a picker from a single-order picker to a multi-order picker, etc. As described herein, in some implementations, users may manually change their statuses or the CCS/TPCS may automatically change their statuses.

The CCS/TPCS may use a variety of data to determine whether to recruit and/or dismiss users/MSDs. Any data associated with the store and/or third parties described herein may be used to determine whether to recruit/dismiss users/MSDs. Example data may include, but is not limited to: 1) store-level data (e.g., store conditions), such as picker availability, packer availability, driver availability, and store busyness, 2) customer order data for customer orders that are currently being picked, packed, and/or delivered, 3) customer order data for customer orders that will soon be picked, packed, and/or delivered, 4) current data, such as current picking data, packing data, delivery data, location data (e.g., user/MSD location data), and movement data, 5) historical data, such as historical picking data, packing data, delivery data, location data, movement data, 6) picking bandwidth, 7) user data, 8) item data, 9) MSD data, 10) carrier data, and/or other data. In some implementations, the CCS/TPCS may recruit users based on similar data/conditions as described herein with respect to requesting assistance from another entity.

Recruiting and dismissing may be automatically handled by the CCS/TPCS based on any of the data described herein. In some implementations, the CCS may recruit a user for a role (e.g., picker, packer, driver, etc.) based on a current lack of available resources performing the role (e.g., a lack of sufficient pickers to pick the outstanding/upcoming orders). In some implementations, the CCS may dismiss a user from a role based on an abundance of resources performing the role (e.g., more pickers than are necessary for the outstanding/upcoming orders). A variety of data that may be used for automatically recruiting/dismissing users is described herein. As described herein, in some implementations, users may be manually recruited (e.g., by store managers or other employees). In some implementations, a user may manually activate themselves into a role and/or manually dismiss themselves. For example, a user may interact with an MSD GUI to become active/inactive. As another example, turning on/off an MSD may automatically activate/deactivate the user.

The OFS may use a variety of devices for recruiting/dismissing users. For example, the OFS may recruit/dismiss users via an MSD. In some implementations, the user may be carrying/wearing the MSD and/or using the MSD when they are recruited/dismissed. In some cases, the user may be moving the MSD throughout the store on a carrier (e.g., an MSD in a cart or attached to a cart). In some cases, the MSDs can be in a variety of different locations in the store when the MSDs are not under control by users. For example, in some implementations the store may include various locations for storing the MSDs when the MSDs are not in use. In some cases, the store may include a single location where MSDs are stored. In other cases, stores may include multiple locations where MSDs can be stored. For example, different store departments/sections may each store one or more MSDs (e.g., in holders, baskets, docking stations, etc.). In some cases, the store may include docking stations for charging the MSDs. In a specific example, a single docking station may be used to charge multiple MSDs. The docking stations may be located throughout the store (e.g., in aisles) or in a single location. In some implementations, a user may drop an MSD off in a dynamic location, which may be determined automatically by the CCS and/or indicated by the user dropping off the MSD. In some implementations, an MSD may be handed off from one user to another user.

In some cases, the OFS may recruit/dismiss users using devices other than an MSD (e.g., a user's personal device or device provided by the company). For example, the OFS may recruit/dismiss users via other computing devices, such as a user's smartphone, pager device (e.g., vibrating device that may include a small display), or wearable device (e.g., watch or other wearable). The OFS may also recruit/dismiss users via other devices, such as an intercom in store that may provide recruitment/dismissal messages via audio in the store. In some implementations, the OFS may recruit/dismiss users via displays and/or kiosks in the store that indicate a user's status as active/inactive (e.g., a viewable display may indicate to the user that they should be actively picking). In some implementations, the OFS may include devices that are specifically provided by the OFS to the users for recruitment/dismissal.

The MSDs and other devices may communicate using a variety of different communications, such as cellular communication, internet communication, local WiFi communication, Bluetooth communication, and/or wired communication (e.g., via docked devices or other wired computing devices, such as laptops, desktops, kiosks, etc.). Communications may be made through specific applications developed by the stores or third parties for the purpose of picking, packing, and/or delivery. The communications may also occur through other available channels, such as text messaging applications, other messaging applications, and/or via telephone voice calls.

In cases where another device (e.g., other than an MSD) is used to recruit/dismiss a user, the recruitment/dismissal techniques may vary, depending on the devices used. If a user can perform a task without using an MSD, the user may be recruited/dismissed using any of the devices described herein. In cases where a user uses an MSD for a task, the device other than the MSD used to recruit/dismiss the user may be referred to as an “intermediate recruiting device” or an “intermediate dismissal device.” In some implementations, the user may be notified of the recruiting/dismissing action on the intermediate device. The user may then follow through with recruiting/dismissing procedures corresponding to their task. For example, if the user is recruited via an intermediate device, the user may acquire an MSD and begin their tasks. As another example, if a user is dismissed via an intermediate device, the user may turn off their MSD and/or place the MSD in a location for later use.

In some implementations, an intermediate device may include a display (e.g., color display, numeric display, etc.) that notifies the user that they are being recruited/dismissed. For example, the display can display recruitment/dismissal decisions and/or instructions to the user. In some implementations, an intermediate device may be a device that notifies the user of recruitment/dismissal using audio (e.g., voice commands, voice message calls, alerts/beeps, or other sounds) and/or tactile outputs (e.g., vibration). For example, the audio/tactile output may notify the user of recruitment/dismissal decisions. An intermediate device may include any combination of display, audio, and/or tactile features for recruiting/dismissing users. In some implementations, an intermediate device may include an intercom that may audibly notify one or more users of recruitment/dismissal decisions. For example, an intercom may make a general request for one or more recruitments from any available users. As another example, an intercom may audibly notify a specific user that they are recruited/dismissed (e.g., “user X is dismissed from role X” or “user Y is requested to pick”).

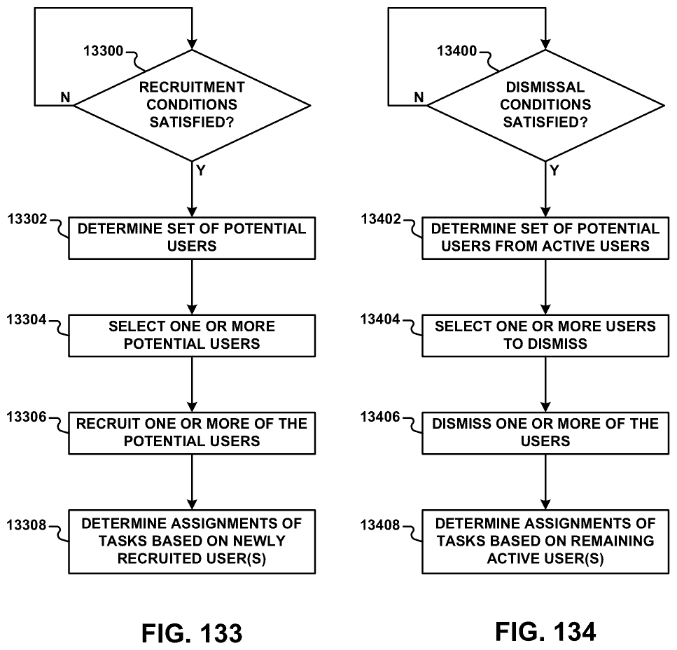

FIGS. 133-134 illustrate example recruiting and dismissing methods. The methods for recruiting and dismissing according to FIGS. 133-134 are only example methods. As such, other recruiting and dismissing methods may follow additional/alternative steps than illustrated in FIGS. 133-134. For example, steps may be performed in a different order, simultaneously, etc.

FIG. 133 illustrates an example method for a store that may recruit users (e.g., via MSDs and/or intermediate devices). In block 13300, the CCS determines whether recruitment conditions are satisfied. Satisfaction of recruitment conditions may indicate that the CCS should recruit one or more users for one or more tasks. For example, satisfaction of recruitment conditions may indicate that the CCS should recruit one or more pickers, packers, delivery drivers, or other user(s) to perform tasks, such as picking, packing, delivery, or other tasks. The recruitment conditions for different types of users (e.g., pickers, packers, drivers) and tasks may differ. As such, the recruitment conditions may be user-type specific, task-specific, etc. The recruitment conditions described herein may be applied for stores and third parties (e.g., a CCS and TPCS).

The CCS may use one or more recruitment conditions to determine whether there may be a need for a new user generally or for a specific task. The recruitment conditions may be used in a multi-factor determination, such as a rule-based determination, weighted determination, etc. As such, the following recruitment conditions/rules may be used on their own or as a factor in determining whether to recruit. In some implementations, recruitment conditions may be based on any of the reasons for requesting assistance described herein, such as a store asking for assistance from a third party for picking, packing, and/or delivery.

In some implementations, recruitment conditions may be based on a number of items, such as a number of ordered items to be picked (e.g., scheduled and/or estimated to be picked), a number of items currently assigned, the number of items that have currently been picked, packed, delivered, etc. In some implementations, if there are too many items to efficiently pick (e.g., within a threshold time and/or by customer arrival), the CCS may recruit one or more pickers. Similarly, if there are too many items to pack, the CCS may recruit one or more packers.

In some implementations, recruitment conditions may be based on the number of current users, such as the number of current pickers, packers, and/or drivers. The CCS may be configured to recruit users if the number of users is less than a threshold number. In some implementations, a target number of users (e.g., for different tasks) may be set by the store.

In some implementations, recruitment conditions may be based on the number of items relative to the number of users. For example, the CCS may recruit a picker if a number of items (e.g., ordered items, estimated items, etc.) relative to a number of active pickers is greater than a threshold value. In another example, the CCS may recruit a packer if the number of items (e.g., picked items, estimated items, etc.) relative to a number of active packers is greater than a threshold value. In another example, the CCS may recruit a driver if the number of orders for delivery (e.g., current or estimated orders) relative to the number of active drivers is greater than a threshold value or routes for the orders are not achievable by current active drivers in a timely manner (e.g., orders can't be delivered on time).

In some implementations, recruitment conditions may be based on a working rate for users (e.g., individual users or as a whole). Working rate may vary for different roles. For example, a picking rate may indicate a rate at which one or more users are picking items (e.g., items per minute). The picking rate may be determined (e.g., based on past picking rates) and/or estimated. A CCS may recruit a picker if the picking rate is low (e.g., less than a threshold picking rate). Similarly, a CCS may recruit a packer if the packing rate (e.g., number of items packed per minute) is less than a threshold rate. Similarly, a CCS may recruit a driver if the delivery rate (e.g., deliveries per hour) is less than a threshold rate. The working rates may be compared to a current/estimated amount of work to make recruitment decisions. For example, if the working rate is small relative to the current/estimated amount of work, the CCS may recruit a user to perform a task. In a specific example, if the picking rate is small relative to the current/estimated required picking rate, the CCS may recruit an additional picker to increase the picking rate.

In some implementations, recruitment conditions may be based on a number of outstanding orders. For example, the CCS may be configured to recruit users based on the number of orders. In one example, the CCS may have defined numbers of users for outstanding numbers of orders. In a specific example, the CCS may recruit a user for a particular role if the number of users for a particular role is less than a threshold number for the number of outstanding orders being filled.

In some implementations, recruitment conditions may be based on the amount of time being used to fill orders at the present time. For example, the recruitment conditions may be based on an average time for order fulfillment (e.g., over the past hour, half day, day, etc.). If orders have been requiring greater than a threshold amount of time to fulfill, the CCS may recruit a picker and/or packer in order to speed up order fulfillment time. The CCS may determine whether picking and/or packing time is slowing fulfillment of orders and recruit one or more users for the appropriate task. The CCS may evaluate the time being used to fill orders based on the order sizes, where larger orders may be allowed more time.

In some implementations, recruitment conditions may be based on the amount of time customers have been waiting for orders (e.g., waiting for scheduled/unscheduled orders at the store and/or waiting for scheduled/unscheduled delivery). For example, recruitment conditions may be based on average customer wait times. If customer wait times (e.g., average customer wait times over the past hour, half day, etc.) are greater than a defined acceptable customer wait time, the CCS may recruit a picker, packer, and/or delivery driver, depending on which portion of the order fulfillment pipeline is causing the unacceptable customer wait times.

In some implementations, recruitment conditions may be based on the presence and/or number of priority items in current customer orders. For example, the CCS may be configured to recruit one or more pickers and/or packers if customer orders include greater than a threshold number of priority items, as the priority items may require immediate picking for customer satisfaction. In another example, the CCS may be configured to recruit one or more pickers and/or packers if there are one or more priority items that are not yet assigned to pickers. In this example, the CCS may immediately assign the priority item(s) to the recruited picker/packer.

In some implementations, recruitment conditions may be based on the amount of movement (e.g., distance) needed to pick outstanding orders. For example, the CCS may be configured to recruit one or more pickers if the total amount of movement required to pick the outstanding orders is large relative to a number of available pickers (e.g., total movement divided by the number of pickers is greater than a threshold value). In some cases, the CCS may attempt to maintain a predetermined number of pickers for an aggregate distance associated with the outstanding orders being picked. In some implementations, the CCS may recruit one or more pickers to assist picking a single customer order if the order requires greater than a threshold amount of movement (e.g., greater than a threshold distance and/or number of zones). In these implementations, the CCS may attempt to maintain a specified range of movement for each picker picking each order. In some implementations, the CCS may take into account the ability of the pickers to move throughout the paths, such as an aggregate movement rate for the pickers. In these implementations, the CCS may recruit one or more pickers if the movement rate for the pickers relative to the overall movement required to fill the orders is less than a threshold value. In these implementations, the CCS may attempt to maintain a specific ratio of movement rate to required movement for picking.

In some implementations, recruitment conditions may take into account whether there are other tasks in the store that require completion. For example, if customers are waiting for cashiers, aisle cleanup, and/or other types of assistance, the CCS may refrain from recruiting other users to assist with picking/packing. In some implementations, the CCS may refrain from recruiting other users in response to any outstanding tasks. In some implementations, the CCS may prioritize tasks based on the task type and/or the amount of time the task has been outstanding. For example, the CCS may prioritize tasks that fulfill orders and tasks that have been outstanding for a longer period of time.

In some implementations, recruitment conditions may be based on a number of users per location. For example, the CCS may recruit pickers for a specific store department/section if there are no pickers assigned to the department/section. In these implementations, the CCS may attempt to maintain a specified number of pickers and packers assigned to specific locations (e.g., departments/sections). With respect to delivery, the CCS may attempt to maintain a threshold number of delivery drivers for different geographic areas outside of the store.

In block 13302, the CCS determines a set of potential users that may be recruited. The set of potential users may be role (e.g., picker, packer, driver) and/or task specific. In these cases, different pools of potential users may be available for recruitment based on different conditions.

In some implementations, the set of potential users may include specific designated users. For example, some users may be designated as potential backup users (e.g., backup pickers, backup packers, and/or backup delivery drivers). In some implementations, users may also be limited to performing specific tasks. For example, some users may be recruited to pick, but may not be recruited to deliver because the user is not qualified and/or trained for delivery. Roles/tasks that may be performed by users may be stored in their user data records.

In some implementations, potential users may include inactive users. In some implementations, potential users may include active users. In some implementations, active users may be transitioned to a different role/task (e.g., a picker may be transitioned to a driver). In some implementations, potential users may be any person in the available workforce performing other tasks, such as cashiers, managers, stockers, etc.

In some implementations, potential users may include only users with MSDs and/or other intermediate recruiting devices that may be used to recruit the users. The CCS may be aware of users with MSDs if the users have acquired the MSDs earlier in their shifts, signed into the MSDs, etc.

In some implementations, potential users may include users in specific locations, such as location within the store or on store property. In these implementations, a driver that is not at the store may not be included in the recruitment pool for picking/packing. In another example, the CCS may not recruit a user if the user is located in the wrong store department, store section, wrong floor, wrong building, etc. In some implementations, lack of user location may disqualify the user from recruitment. The CCS may determine the location of users using any of the techniques described herein (e.g., GPS, MSD location, cameras in store, etc.).

In some implementations, potential users may be determined based on the amount of time left in their shift. For example, if the user does not have greater than a threshold amount of time left in their shift, the user may be removed from the pool of potential users that may be recruited. In some implementations, a potential user may be required to have a threshold amount of time before their next break time.

In some implementations, users may indicate that they are not available for specific roles/tasks within a time slot (e.g., using an MSD GUI or other GUI). In these implementations, the users that indicate they are not available may be excluded from the group of potential users.

In some implementations, the CCS may implement other limitations on which users may be potentially recruited. For example, some users may be limited to picking specific locations, delivering to specific locations, limited to picking specific items (e.g., item types, weights, etc.), as well as other limitations.

In block 13304, the CCS selects one or more of the potential users. In some cases, the CCS may recruit a single user. In some cases, the CCS may recruit multiple users. Multiple users may be recruited to perform the same tasks (e.g., 2 pickers for a single order). In some cases, multiple users may be recruited for different tasks, such as picking two different orders or a scenario where a first recruited user picks an order and a second recruited user delivers the order.

The CCS may select a user based on one or more factors. For example, the CCS may implement rules for selecting from the potential users, such as a random selection, location-based selection, etc., as described herein. In some implementations, the CCS may select one or more of the potential users for recruitment based on any of the factors described herein regarding selecting the set of potential users (e.g., with respect to block 13302). For example, the CCS may select a user based on whether the user has an MSD, whether the user is a designated backup user (e.g., a designated backup picker, packer, or driver), a location of the user, etc.

In some implementations, the CCS may select one or more potential users based on a priority number associated with a user for recruiting (e.g., a location in a queue). The priority number for recruiting may indicate the order in which the pickers are recruited for picking (e.g., a higher priority number may indicate that the user should be recruited first). In some implementations, the CCS may show preference to designated backup users. In some implementations, the CCS may select backup users that are designated for the roles/tasks. In some implementations, the CCS may recruit based on attributes associated with the users (e.g., ability to lift specific amounts, ability to drive, etc.).

In some implementations, the CCS may select one or more potential users based on preferences that are defined either manually or automatically by the CCS for specific roles/tasks. For example, users may be designated as backup picker 1, backup picker 2, backup picker 3, etc., and may be recruited in such an order. In some implementations, the CCS may implement preferences for recruiting based on their current job role, such as seniority or job title. For example, managers may be recruited after other employees. As another example, the CCS may deprioritize recruiting employees that are working other immediate jobs or have other specific skillsets that are of value outside of order fulfillment (e.g., cleaning, maintenance, checkout, stocking, etc.). As another example, the CCS may prioritize based on a role in the organization (e.g., recruit lower seniority or lower ranking employees before more senior employees).

In some implementations, the CCS may select one or more potential users based on busyness at the store. For example, users that are working in busier areas of the store may be deprioritized for recruitment. In a specific example, if customers are checking out (e.g., based on detected cash register scans, in-store cameras, etc.), cashiers may not be recruited.

In some implementations, the CCS may prioritize selecting users that are not performing other roles/tasks (e.g., as indicated by a user data record). In some implementations, the CCS may attempt to spread work around to other users via recruitment/dismissal. For example, the CCS may recruit users that have picked, packed, and/or delivered fewer orders (e.g., worked less time) in order to spread work out. As another example, the CCS may prioritize recruiting users at the start of their shift instead of those nearer to the end of their shift.

In some implementations, the CCS may select one or more potential users based on the locations of the users/MSDs relative to the tasks. In one example, the CCS may recruit a user if the user is in a current location (e.g., a zone, section, department, floor, building, GPS location, by an item, etc.) that is near the task to be performed or otherwise in a location from which the task may be efficiently started and/or completed. In a specific example, if a user is close to a few items that need to be picked, the CCS may recruit the user to pick the items. In one example, the CCS may recruit a user if the user's future location will be near the task to be performed. The CCS may determine a user's future location based on tasks assigned to the user (e.g., tasks in specific locations) and/or user historical movement. In one example, the CCS may recruit a user based on the location of others relative to the user. For example, the CCS may recruit the closest user if other users are too far away from the task (e.g., greater than a threshold distance).

In block 13306, the CCS recruits one or more of the potential users. For example, the CCS may recruit the selected one or more users identified in block 13304. The CCS may recruit the selected user(s) via an MSD, an intermediate device, and/or another device. In some implementations, the CCS may determine specific tasks to assign to the recruited users prior to recruitment (e.g., the CCS may have selected orders in a queue for assignment upon recruitment). In these implementations, the CCS may have recruited the users for the specific tasks. In some implementations, the CCS may determine which tasks to assign the recruited users after recruitment (e.g., based on any factors described herein, such as user location).

The CCS may recruit users by sending a recruitment request to one or more devices associated with one or more users. In some implementations, the recruitment requests may be targeted to one or more specific users. In some implementations, the recruitment requests may be sent to a group of users, which may allow one or more of the users to accept the request (e.g., in an MSD GUI or using another device).

In some implementations, the recruitment requests may automatically recruit a user under the assumption that the user will begin performing the task(s) associated with the recruitment. For example, if items for picking are provided to a user's smartphone or over the intercom, it may be assumed that the user will pick the items and provide them for packing. In some implementations, users may be required to respond with a recruitment response (e.g., sent from a GUI) to indicate whether they intend on becoming active users that will accomplish the assigned tasks. In some implementations, users may reject the recruitment in a recruitment response (e.g., generated in response to user input in a GUI, such as an MSD GUI or other GUI) in order to indicate that they do not intend on being recruited for the task(s).

The CCS/TPCS may automatically generate the recruitment requests and send the requests to the MSDs and/or intermediate devices. In some implementations, the recruitment requests can be manually generated. For example, a user (e.g., manager or other employee) may use a GUI to recruit a user. In a specific example, a manager may interact with a manager GUI that includes GUI elements that the manager may select to generate the recruitment request. In some implementations, the CCS/TPCS may prompt a user (e.g., a manager) to consider recruiting one or more users for one or more tasks. In these implementations, the CCS/TPCS may require that the manager approve the recruitment of the one or more individuals before sending the recruitment request(s).

A recruitment request may include a variety of types of data that may cause a variety of different recruitment experiences. In some implementations, a recruitment request may include a recruitment message. A recruitment message may indicate a variety of types of information to a user, such as an instruction to start picking, an instruction to proceed to a location (e.g., store department, aisle, etc.), or other message. In some implementations, a recruitment message may include one or more recruitment indicators, such as audio (e.g., ringing, voice instructions, etc.) and/or vibrations. In some implementations, a recruitment request may be included in an SMS message, an email, a push notification, or other format.

In some implementations, the recruitment request may include, or trigger, a response field in the MSD or other device (e.g., a response GUI element), such as a GUI element for a user to indicate whether the user accepts or denies the request.

In some implementations, the recruitment request may include a task description. For example, the recruitment request may include a specific task instruction for a picker to pick a customer order. As another example, the recruitment request may include a specific task instruction for a delivery driver to deliver an order.

In some implementations, the recruitment request may indicate a location to pick up an MSD or a person to meet in order to receive the MSD. If the MSD is being handed off to the newly recruited user, instructions may be provided to both users associated with the handoff. For example, a first user may be instructed to hand off the MSD to a second user and the second user may be instructed to acquire the MSD from the first user. In some implementations, the recruitment request may include restrictions (e.g., location restrictions), such as indications that the user is only to work in specific locations (e.g., pick in specific locations, deliver certain routes, etc.), use only a specific delivery vehicle for specific deliveries, and/or provide other specific restrictions/indications associated with the roles/tasks for which the user was recruited.

In some implementations, the recruitment request may include order information, such as number of orders, number of items in orders, item order IDs, delivery locations, and/or any other data associated with orders and items described herein that may help provide context to the user associated with their new roles/tasks.

In some implementations, the recruitment request may include a power-on command that powers on the MSD (e.g., from a standby state). For example, an MSD that is in a standby mode or off mode may be powered on in response to receiving the recruitment request. Powering on an MSD using a recruitment request and subsequently providing a message to the user may get the user's attention and provide context as to the reasons for their recruitment.

The MSD may notify the user that they are being recruited to pick, such as via a display screen prompt (e.g., a GUI indicating recruitment for a role/task), sound (e.g., a sound indicating the user should become active), a vibration, and/or other recruitment notification. As described herein, the recruitment request may also be made via another device in a similar manner, such as by an intercom system (e.g., an intercom notice indicating a user and recruited role/task), a user's smartphone, a vibrating pager device, and/or other type of device. In some implementations, an MSD being used for a first role/task may be transitioned to another role/task. For example, a user using an MSD to take inventory may be transitioned to a picking interface in order to recruit the user for picking.

An MSD may be in a variety of different states. In some cases, an MSD may be turned off. In the off state, the MSD may be turned on by a user (e.g., using a power button). In some cases, an MSD may be in a standby state in which the device is powered, but is waiting for a recruitment request to be received before performing additional actions (e.g., vibrating or otherwise alerting a picker) or waiting for a user to power on the MSD for picking. In some cases, an MSD may be powered such that the MSD may determine its location while not being actively used. In some cases, the MSDs used after recruitment may be picked up from docking stations. The MSD may be in standby or powered on when receiving a recruitment request. The MSD may respond in a variety of manners, depending on the state of the MSD. For example, in response to a recruitment request, the MSD may turn on, display recruitment data, provide audible noises, provide haptic feedback, etc. In some cases, as described herein, a recruitment message may be displayed to the user (e.g., welcome username, start picking in the frozen department, etc.). The default screen after recruitment may depend on the recruited user's role. For example, a picker MSD may default to displaying items for picking. As another example, a packer MSD may default to displaying items to pack.

In some implementations, a user may turn on an MSD to indicate they have been recruited. In some implementations, a user may pull an MSD from a dock, or other charging cable, to indicate they have been recruited. Alternatively, a user may turn off an MSD to indicate they are dismissing themselves. As another example, a user may dock the MSD (e.g., plug the MSD into a dock) to indicate that they are dismissing themselves. In some cases, users may sign in to an MSD to indicate they have been recruited. In some cases, a user may sign out of an MSD to indicate they are being dismissed.

In some implementations, the user may confirm the recruitment in the MSD or other device. For example, a user may interact with a GUI (e.g., sign on, press an accept GUI button, etc.) to indicate that the user accepts/denies the recruitment request. As another example, a user may start using the MSD for the assigned tasks to indicate that they are accepting the recruitment requests. In a specific example, a recruited picker may start interacting with an MSD picking interface and/or start scanning items to indicate they accept recruitment as a picker.

As described herein, users may be recruited for different roles/tasks in a variety of different ways. In one example, the CCS may broadcast recruitment request audio over an intercom directed to one or more users. The audio over the intercom may be automatically generated by the CCS and/or provided by another user (e.g., a manager). In this example, the one or more users may accept the recruitment (e.g., using MSDs and/or other devices). In another example, the CCS may send a picking recruitment message to an MSD being carried by a user. In this example, the user may accept the picking recruitment on the MSD and begin picking. In another example, the CCS may send a driving recruitment message to a user device (e.g., an MSD or other device) being carried by a user. In this example, the user may accept the driving recruitment on the user device and begin acting as a delivery driver. In another example, the CCS may transition a user from a first role to a second role. For example, the CCS may dismiss a packer after the packer has finished packing an order. In this example, the CCS may recruit the user (e.g., immediately) to start delivery (e.g., to deliver the recently packed order and/or other orders). The example recruitments/dismissals described herein are only examples. As such other types of recruitments/dismissals using other device combinations may be implemented.

In some implementations, the CCS may send a recruitment request out to multiple users (e.g., simultaneously) and allow acceptance from a subset of the users (e.g., a first one or more users that accept). In some implementations, the CCS may send a recruitment request to a single user that may reject the request. In the case a user rejects the request, the CCS may send the request to another user or group of users (e.g., from the set of potential users in block 13202).

In block 13308, the CCS/MSDs determine assignments of tasks based on newly recruited user(s). For example, the CCS/MSDs may consider new item/order assignments based on a number of users, locations of users, current assignments, current routes, and/or any other data described herein that may be used to make determinations in the OFS.

In some implementations, a newly recruited user may not be assigned tasks immediately upon/after recruitment. For example, the user may be recruited because of a general need for additional users (e.g., additional pickers, packers, and/or drivers), without a specific need for completion of an immediate task (e.g., immediate need for a picker to pick specific items). In this example, a newly recruited user may be available to receive a task (e.g., picking, packing, or delivery) when a new task is available and/or a task can be reassigned from another user to the newly recruited user. The recruitment of the user may put the user on notice that they will be performing the role soon. For example, a newly recruited picker may be on notice that they may be assigned new items/orders for picking soon. The presence of a new user may affect calculations used by the OFS and future actions taken by the OFS, such as new item assignments, new routes, future recruitments, future dismissals, and other aspects of the OFS described herein.

In some implementations, a newly recruited user may be assigned tasks immediately upon recruitment or shortly after recruitment. For example, the tasks for the newly recruited user may be the reason for recruitment. In some cases, a newly recruited user may be assigned new tasks (e.g., currently unassigned tasks). For example, the newly recruited user may be assigned items/orders for picking that were just received and not yet assigned to other pickers. In some cases, a newly recruited user may be assigned tasks that were being performed by another user. For example, the newly recruited user may be assigned items to pick that were taken from another picker. As another example, the newly recruited user may be assigned orders to deliver that were taken from another driver.

The presence of a new user may affect calculations used by the OFS and future actions taken by the OFS, such as new item assignments, new routes, future recruitments, future dismissals, and other aspects of the OFS described herein. In implementations where some tasks are reassigned from existing users to a newly recruited user, the tasks associated with the existing users (e.g., items/orders to pick, picking routes, delivery routes, etc.) may be modified. For example, reassignment of items from an existing picker to a newly recruited picker may cause an immediate route modification for the existing picker.

In some implementations, a user may be recruited for one or more specific task(s). For example, a picker may be recruited to pick specific items/orders. As another example, a driver may be recruited to complete one or more specified deliveries. The specific tasks may be newly received tasks and/or tasks that were pulled from other users. In some implementations, recruitment for a specific task may include a message that indicates the recruitment is for a specific task. For example, the message may indicate: 1) the task to be completed (e.g., items to be delivered) and 2) actions to take after the task is complete (e.g., drop off the MSD in a location, return to a location, end their shift, etc.).

In some implementations, users may be recruited for tasks that will not require an MSD. For example, as described herein, the recruitment may be done by intercom message or via another device that is not an MSD. In these implementations, the user may be instructed (e.g., by intercom or other device) on how to complete the task. For example, a smartphone carried by the user may indicate that the user should pick a few items and then place the items in the packing area (e.g., in a specific location). This scenario may occur when the user is performing other tasks, such as cleaning, providing customer service, or other task not related to order fulfillment.

The CCS/TPCS may recruit users at the store (e.g., inside the store or on store property) or away from the store (e.g., off store property). In some implementations, users away from the store may be deprioritized for work at the store. In a specific example, if a user is away from the store (e.g., delivering orders), the user may only be chosen to pick items at the store if no other users are located at the store, the items to be picked are high priority, and/or other tasks away from the store are not prioritized (e.g., deliveries are not needed within a threshold period of time). In some implementations, the CCS/TPCS may recruit users based on whether they are on their working shift (e.g., during their working hours). For example, the CCS/TPCS may prioritize recruiting users that are currently working their shift at the store. In some examples, the CCS/TPCS may be configured to recruit individuals outside of their scheduled working shift. Such a request outside of the user's typical working hours may be rejectable (e.g., rejected by the user by ignoring the request and/or actively rejecting the request in a recruitment GUI).

Although a user may be recruited automatically by the CCS and/or another person (e.g., a store manager), in some implementations, a user may decide to fulfill a role and/or complete one or more tasks on their own accord and/or in response to a verbal request by another person (e.g., a manager or other employee). In this case, a user may activate themselves (e.g., using an MSD) for a role and/or one or more tasks. The consequences of a user activating themselves may be similar to if the user was recruited (e.g., recruited automatically by the CCS).

FIG. 134 illustrates an example method for a store that may dismiss users from performing a task (e.g., via MSDs and/or intermediate devices). In block 13400, the CCS determines whether dismissal conditions are satisfied. Satisfaction of dismissal conditions may indicate that the CCS should dismiss one or more users. In some cases, the one or more users that may be dismissed may be currently performing tasks (e.g., picking, packing, delivery, checkout, restocking, cleaning, inventory, etc.). In some cases, the one or more users that may be dismissed may have an assigned role (e.g., picker, packer, delivery driver), but may not be performing any specific task at the time dismissal is determined and/or ordered by the CCS. The dismissal conditions for different types of users (e.g., pickers, packers, drivers) and tasks may differ. In some implementations, the dismissal conditions may be user-type specific, task-specific, etc. The dismissal conditions described herein may be implemented by stores and third parties (e.g., a CCS and TPCS).

The CCS may use one or more dismissal conditions to determine whether there may be too many active users for specific roles and/or tasks. The dismissal conditions may be used in a multi-factor determination, such as a rule-based determination, weighted determination, etc. As such, the dismissal conditions/rules described herein may be used on their own or as a factor in determining whether to dismiss. Example dismissal conditions may include any of the factors described herein regarding recruiting a user, although the dismissal conditions may be implemented such that a situation with too many users (e.g., too many pickers) for too little available work (e.g., too few items) may result in a dismissal of one or more users.

In some implementations, dismissal conditions may be based on a number of items, such as a number of ordered items to be picked (e.g., scheduled and/or estimated to be picked), a number of items currently assigned, the number of items that have currently been picked, packed, delivered, etc. In some implementations, if there are too few items (e.g., less than a threshold number of items), the CCS may dismiss one or more pickers. Similarly, if there are too few items to pack, the CCS may dismiss one or more packers.

In some implementations, dismissal conditions may be based on the number of current users, such as the number of current pickers, packers, and/or drivers. The CCS may be configured to dismiss users if the number of users is greater than a threshold number. In some implementations, a target number of users (e.g., for different tasks) may be set by the store and managed using recruiting and dismissing techniques described herein. In some implementations, the store may be configured to maintain a minimum number of users in different roles. For example, the store may be configured to maintain 1 or more pickers for incoming orders.

In some implementations, dismissal conditions may be based on the number of items relative to the number of users. For example, the CCS may dismiss a picker if a number of items (e.g., ordered items, estimated items, etc.) relative to a number of active pickers is less than a threshold value. In another example, the CCS may dismiss a packer if the number of items (e.g., picked items, estimated items, etc.) relative to a number of active packers is less than a threshold value. In another example, the CCS may dismiss a driver if the number of orders for delivery (e.g., current or estimated orders) relative to the number of active drivers is less than a threshold value or all orders can be delivered at satisfactory times with fewer drivers.

In some implementations, dismissal conditions may be based on a working rate for users (e.g., individual users or as a whole). A CCS may dismiss a picker if the picking rate is high (e.g., greater than a threshold picking rate). Similarly, a CCS may dismiss a packer if the packing rate is greater than a threshold rate. Similarly, a CCS may dismiss a driver if the delivery rate is greater than a threshold rate. In some implementations, the CCS may be configured to maintain a desired working rate (e.g., between two threshold values) for each of the roles (e.g., picking, packing, and/or driving).

In some implementations, dismissal conditions may be based on a number of outstanding orders. For example, the CCS may be configured to dismiss users based on the number of orders. In one example, the CCS may have defined numbers of users for outstanding numbers of orders. In a specific example, the CCS may dismiss a user from a particular role if the number of users for a particular role is greater than a threshold number for the number of outstanding orders being filled.

In some implementations, dismissal conditions may be based on the amount of time being used to fill orders at the present time. For example, the dismissal conditions may be based on an average time for order fulfillment (e.g., over the past hour, half day, day, etc.). If orders have been requiring less than a threshold amount of time to fulfill, the CCS may dismiss a picker and/or packer where immediate order fulfillment is not necessary and the additional users are adding cost to the fulfillment process.

In some implementations, dismissal conditions may be based on the amount of time customers have been waiting for orders (e.g., waiting for scheduled/unscheduled orders at the store and/or waiting for scheduled/unscheduled delivery). For example, dismissal conditions may be based on average customer wait times. If customer wait times (e.g., average customer wait times over the past hour, half day, etc.) are shorter than an acceptable lower target, the CCS may dismiss a picker, packer, and/or delivery driver, depending on which portion of the order fulfillment pipeline that may be overstaffed.

In some implementations, dismissal conditions may be based on the presence and/or number of priority items in current customer orders. For example, the CCS may be configured to dismiss one or more pickers and/or packers if customer orders include less than a threshold number of priority items (e.g., no priority items), as a lack of priority items may indicate that fewer employees may be required to meet customer expectations.

In some implementations, dismissal conditions may be based on the amount of movement (e.g., distance) needed to pick outstanding orders. For example, the CCS may be configured to dismiss one or more pickers if the total amount of movement required to pick the outstanding orders is short relative to a number of available pickers (e.g., total movement divided by the number of pickers is less than a threshold value).

In some implementations, dismissal conditions may take into account whether there are other tasks in the store that require completion. For example, if customers are waiting for cashiers, aisle cleanup, and/or other types of assistance, the CCS may dismiss users from other tasks (e.g., picking, packing, and/or delivery) so that the dismissed users may assist customers.

In some implementations, dismissal conditions may be based on a number of users per location. For example, the CCS may dismiss pickers for a specific store department/section if there are too many pickers assigned to the department/section. In these implementations, the CCS may attempt to maintain a specified number of pickers and packers assigned to specific locations (e.g., departments/sections). With respect to delivery, the CCS may attempt to maintain a minimum number of delivery drivers for different geographic areas outside of the store.

In block 13402, the CCS determines a set of potential users that may be dismissed. For example, the CCS may determine the set of potential users to dismiss from the currently active users (e.g., active pickers, active packers, active delivery drivers, and other active users).

In block 13404, the CCS selects one or more of the potential users to dismiss. In some cases, the CCS may dismiss a single user. In some cases, the CCS may dismiss multiple users. In some implementations, the CCS may select a specific user to dismiss. In some implementations, the CCS may send out a dismissal request to multiple users, which may allow one or more of the users the option to be dismissed (e.g., by agreeing to the dismissal in an MSD GUI or using another device). The CCS may select one or more of the users for dismissal based on one or more factors. For example, selecting a user to dismiss may be a multi-factor determination, such as a rule-based determination, weighted determination, etc.

In some implementations, the CCS may select a user to dismiss based on any of the factors described herein regarding dismissal conditions (e.g., with respect to block 13400). In some implementations, the CCS may select a user to dismiss based on any of the factors associated with recruiting a user described herein.

In some implementations, the CCS may select a user to dismiss based on their level of productivity (e.g., dismiss users with low productivity). For example, the CCS may dismiss a picker that has a low picking rate, has not been picking for a period of time, etc. As another example, the CCS may dismiss a packer that has a low packing rate, has not been packing items for a period of time, etc. In some cases, a user may stop performing their task and the CCS may automatically dismiss the user in response to their lack of productivity.

In some implementations, the CCS may select a user to dismiss based on whether the user can perform other tasks. For example, if the user has the ability to perform other roles/tasks, the user may be dismissed and used for another role/task that may be needed currently or in the future. In some implementations, the CCS may select a user to dismiss if the user is not qualified, or potentially not qualified, for upcoming tasks. For example, the CCS may dismiss a user that is not able to operate specific equipment (e.g., a fork truck) that may be required for future order fulfillment.

In some implementations, the CCS may select a user to dismiss based on a length of time the user has been working (e.g., continuously and/or during the day). For example, the CCS may select a user to dismiss that has been working the longest out of a group of active users during the day and/or greater than a threshold amount of time. In some implementations, the CCS may select a user to dismiss based on when their shift ends. For example, the CCS may dismiss a user that has a shift ending soon (e.g., before other users and/or within a threshold period of time, such as an amount of time that is less than a task requires to accomplish). In some implementations, the CCS may select a user to dismiss based on whether the user is working on overtime. For example, the CCS may dismiss a user if the user is currently on overtime or will likely be working overtime based on their recent working hours and future work schedule. In some implementations, the CCS may select a user to dismiss based on the volume of work that the user has performed. For example, the CCS may dismiss pickers that have recently picked more than other pickers. This may spread work around to different users and prevent overworking specific users that have already picked, packed, and/or delivered a lot of customer orders.

In some implementations, the CCS may select a user to dismiss based on when the user was recruited. For example, the CCS may dismiss users in the opposite order of which they were recruited. In a specific example, if the CCS recruits users for additional support (e.g., backup users, such as backup pickers), the CCS may dismiss the newly recruited users when the volume of work decreases (e.g., number of items to pick decreases).

In some implementations, the CCS may select a user to dismiss based on a manual user entry indicating when the user will not be available for roles/tasks. For example, a user may enter into their MSD interface a period of time during which they will not be available (e.g., for specific roles/tasks). In this example, the CCS may dismiss users that have indicated they will not be available at the present time or in the near future.

In some implementations, the CCS may select a user to dismiss based on seniority and/or job role (e.g., as indicated in the user data record). For example, the CCS may dismiss more senior users before more junior users. As another example, the CCS may dismiss users with specific job roles (e.g., dismiss managers before employees).

In some implementations, the CCS may select a user to dismiss based on where customers are active/located in the store and/or the level of busyness at the store. For example, if customers are checking out at a high rate, the CCS may refrain from dismissing cashiers.

In some implementations, the CCS may select a user to dismiss based on where the user is currently located. For example, the CCS may dismiss a user that is far from the tasks to be completed (e.g., greater than a threshold distance and/or farther from the tasks than other users). As another example, the CCS may dismiss a user that has moved away from the task to be completed (e.g., moved away within the store and/or left the store property). In some implementations, the CCS may select a user to dismiss based on the future location of the user relative to the task to be performed. For example, the CCS may refrain from dismissing a user if the user's future path will be at/near the task to be performed. In some implementations, the CCS may select a user to dismiss based on the location of other users. For example, the CCS may dismiss the farthest user(s) from a task or the users that will have to move the farthest to complete the task.

In block 13406, the CCS dismisses one or more of the users. For example, the CCS may dismiss the selected one or more users identified in block 13404. The CCS may dismiss the selected user(s) via an MSD, an intermediate device, and/or another device, as described herein with respect to recruiting users.

The CCS may dismiss users by sending a dismissal command/request to one or more devices associated with one or more users. In some implementations, the dismissal requests may be targeted to one or more specific users. In some implementations, the dismissal requests may be sent to a group of users, which may allow one or more of the users to accept the request.

In some implementations, a dismissal request may act as a command that automatically dismisses a user. Automatic dismissal may include removing current tasks from a user's MSD or other device. Automatic dismissal may also prevent additional tasks from being assigned to the user in the future. In some implementations, users may be required to respond with a dismissal response (e.g., sent from a GUI) to indicate whether they intend on becoming inactive users. In some implementations, users may reject the dismissal in a dismissal response (e.g., generated in response to user input in a GUI, such as an MSD GUI or other GUI) in order to indicate that they do not intend on being immediately dismissed. This may be the case if the user knows they are able to efficiently complete an assigned task before they are dismissed (e.g., the user knows they can efficiently pick a final few items before becoming inactive).

The CCS/TPCS may automatically generate the dismissal requests and send the requests to the MSDs and/or intermediate devices. In some implementations, the dismissal requests can be manually generated. For example, a user (e.g., manager or other employee) may use a GUI to dismiss a user. In a specific example, a manager may interact with a manager GUI that includes GUI elements that the manager may select to generate the dismissal request. In some implementations, the CCS/TPCS may prompt a user (e.g., a manager) to consider dismissing one or more users. In these implementations, the CCS/TPCS may require that the manager approve the dismissal of the one or more individuals before sending the dismissal request(s).

A dismissal request may include a variety of types of data that may cause a variety of different dismissal experiences. In some implementations, a dismissal request/command may include a dismissal message. A dismissal message may indicate a variety of types of information to a user, such as an indication to the user that they are being dismissed, an instruction to stop performing a specific role/task, instructions to proceed to a location after dismissal, and/or an instruction to handoff the MSD to another user or place the MSD in a location. If the MSD is being handed off, instructions may be provided to both users associated with the handoff. For example, a first user may be instructed to hand off the MSD to a second user as well as the second user being instructed to acquire the MSD from the first user. In some implementations, a dismissal message may include one or more dismissal indicators, such as audio (e.g., ringing, voice instructions, etc.) and/or vibrations. In some implementations, a dismissal request may be included in an SMS message, an email, a push notification, or other format.

In some implementations, when the dismissal request is optional, the MSD GUI (or other GUI) may provide a response field for the user to indicate whether they accept the dismissal (e.g., a yes/no button). In some implementations, the dismissal request may include one or more final tasks for the user to complete before dismissal. For example, the dismissal request may include a final set of items to pick, orders to pack, orders to deliver, etc.

In some implementations, the dismissal request/command may power off the MSD or set the MSD into a low power standby mode. In some implementations, the MSD may be set into the power off or standby state automatically (e.g., in response to receiving the dismissal request/command). In some implementations, the MSD may present a GUI that allows the user to set the MSD into the power off or standby mode (e.g., using a GUI element).

The MSD may notify the user that they are being dismissed, such as via a display screen prompt (e.g., a GUI indicating dismissal), sound (e.g., a sound indicating the user should become inactive), a vibration, and/or other dismissal notification. As described herein, the dismissal request may also be made via another device in a similar manner, such as by an intercom system (e.g., an intercom notice indicating a user dismissal), a user's smartphone, vibrating pager device, and/or other type of device. In some implementations, an MSD being used for a first role/task may be transitioned to another role/task after dismissal.

The MSD may be in standby or powered on when receiving a dismissal request. The MSD may respond in a variety of manners, depending on the state of the MSD. For example, in response to a dismissal request, the MSD may transition from an on state to a standby state. In another example, an MSD may transition from an on/standby state to an off state. In some cases, as described herein, a dismissal message may be displayed to the user.

In some implementations, a user may turn off an MSD to indicate they have been dismissed. In some implementations, a user may place an MSD into a dock or connect the MSD to a charging cable to indicate they have been dismissed. In some cases, a user may sign out of an MSD to indicate they are being dismissed.

As described herein, users may be dismissed in a variety of different ways. In one example, the CCS may broadcast dismissal request audio over an intercom directed to one or more users. The audio over the intercom may be automatically generated by the CCS and/or provided by another user (e.g., a manager). In this example, one or more users may accept the dismissal. In another example, the CCS may send a picking dismissal message to an MSD being carried by a user. In this example, the user may accept the picking dismissal on the MSD. In another example, the CCS may send a delivery dismissal message to a user device (e.g., an MSD or other device) being carried by a user. In this example, the user may accept the delivery dismissal on the user device.

In block 13408, the CCS/MSDs determine assignments of tasks based on remaining active users. The reduced number of users may affect calculations used by the OFS and future actions taken by the OFS, such as new item assignments, new routes, future recruitments, future dismissals, and other aspects of the OFS described herein. For example, the CCS/MSDs may consider new item/order assignments based on the reduced number of users, locations of users, current assignments, current routes, and/or any other data described herein that may be used to make determinations in the OFS. In some implementations, the dismissed one or more users may have their tasks assigned to the remaining one or more currently active users and/or newly recruited users. For example, items that were to be picked by a dismissed user may be reassigned to one or more remaining pickers.

Although a user may be dismissed automatically by the CCS and/or another person (e.g., a store manager), in some implementations, a user may decide to dismiss themselves on their own accord and/or in response to a verbal request by another person (e.g., a manager or other employee). In this case, a user may dismiss themselves (e.g., using an MSD). In some implementations, a user may request an automatic dismissal from the CCS and/or a manual dismissal from another user (e.g., a manager). In some implementations, the CCS and/or manager may suggest that a user dismiss themselves. In these implementations, the user may decide whether to dismiss themselves. In some implementations, the CCS may make a suggestion to a first user (e.g., a manager) that a second user be dismissed. In these implementations, the first user may have the option to request/command that the second user dismiss themselves. In some implementations, the CCS and/or manager may command the user to dismiss themselves, which a user may not reject.

As part of dismissing a user, the CCS may assign one or more final tasks before the user is dismissed. For example, the CCS may assign a final few item picks, final delivery, or other task that should be completed before dismissal. In some cases, the assigned task may be constrained to less than a threshold amount of work (e.g., an expected time for completion). In some cases, the final tasks may be selected for the user specifically. For example, a user may be dismissed from picking, but requested to pick a final few items on their way back to the packing area or to another location to which they are traveling after dismissal. In a specific example, if a picker is asked to deliver, the CCS may assign a final set of items to pick on the way to the location from which the picker will deliver. As another example, if the picker is dismissed from picking to assist a customer, the CCS may assign items to pick on the way to assist the customer.

In some implementations, the CCS may transition a first user from a first role to a second role (e.g., a picker to a packer, picker to a driver, etc.) based on the satisfaction of both dismissal factors for the first role and recruitment factors for the second role. For example, dismissal conditions may be satisfied for a user's current role, which may result in dismissal. In this example, recruitment conditions may be satisfied for another role, which the user may be assigned to fulfill.

As described herein, a user may be recruited for a specific purpose, after which the user may be dismissed. For example, the user may be recruited and requested to pick a certain item, items, or entire order. In this case, the recruitment message can include the specific purpose and the MSD GUI, or other GUI, may display that specific purpose to the user. The dismissal message may then be generated by the CCS/MSD based on detecting that the task(s) have been completed. Although the dismissal may require detection of completed tasks, in other cases, the MSD, or other device, may be configured to instruct the user to manually dismiss themselves after the task is completed.

In some implementations, the CCS/MSD may automatically determine that a user is not performing the task. For example, delays in completing the task (e.g., delays in scanning items), excessive immobility (e.g., immobile for a threshold period of time), incorrect location for a task (e.g., an assigned picker has not entered the customer area for picking), and other factors may result in a CCS/MSD determination that the user is not performing their assigned tasks. The CCS/MSD may dismiss a user that is not performing their task(s). In some implementations, the CCS/MSD may automatically determine that a user is done performing their tasks. For example, the CCS/MSD may determine when all items have been picked, packed, and/or delivered. In these implementations, the CCS/MSD may dismiss the user that has completed their task(s).

After dismissal, the user may be instructed (e.g., in a GUI, audio, etc.) where to place the MSD or other computing device. In some cases, the user may be instructed to hand off the MSD to another user (e.g., a specific user).

The following example describes how dismissals and recruitments may occur during store operation. During picking, a picker may request dismissal. The CCS may dismiss the picker in response to the request. The CCS may then request another picker to replace the dismissed picker. For example, the CCS may make a general recruitment request to a plurality of pickers or make a specific recruitment request to a specific picker. In some implementations, the replacement picker may acquire the dismissed picker's MSD and continue picking. In some implementations, the replacement picker may have their own MSD. In these implementations, the CCS may transfer the dismissed picker's tasks to the recruited picker's MSD. Such a transfer of tasks may also be performed in cases where a user is automatically dismissed for other reasons.

In some implementations, the CCS/TPCS may assign roles to users based on their location. For example, the CCS may recruit users based on their location. In one example, if the user is located in the packing area, the CCS may recruit the user to be a packer. In another example, if the user is located in the customer area where items are picked, the CCS may recruit the user as a picker. In some implementations, the CCS may provide options to users based on their locations and/or automatically transition roles for users based on their locations. For example, the CCS may provide a picker the option of transitioning to a packer if the picker moves into the packing area. As another example, the CCS may provide a packer the option of transitioning to a picker if the packer leaves the packing area and enters a customer area where picking is performed. As another example, a user may be transitioned to a delivery driver if the user enters a delivery vehicle and begins to deliver orders.

In some implementations, users may manually lay claim to various tasks. Laying claim to a task (i.e., claiming a task) may refer to a user indicating that they intend on completing the task. For example, a user may claim a task by manually selecting the task in a GUI, such as an MSD GUI or GUI on another device. In some implementations, a task may be made available to one or more users, at which point a user may claim the task for themselves to complete. Claiming a task may also be referred to as “calling a task,” such as “calling an item to pick,” “calling an order to pick,” etc. Claiming a task may also be referred to as “taking ownership of the task.”

Users may claim any of the tasks described herein. For example, users may claim picking tasks (e.g., picking items and/or complete orders), packing tasks, delivery tasks, or other tasks described herein, such as restocking tasks, inventory taking tasks, cleanup tasks, and cashier tasks. The tasks for claiming may come from a variety of sources, such as the CCS, TCPS, and/or other users. For example, the CCS may assign items/orders to a user for picking. As another example, a first user (e.g., a manager) may assign a task to one or more other users. In some implementations, users may also claim available roles within the store, such as a picking role, packing role, delivery role, or other role (e.g., a cashier role, stocking role, etc.).

In some implementations, available tasks may be provided to a plurality of users (e.g., simultaneously), each of which may claim one or more of the tasks. For example, the CCS may send orders/items to a plurality of MSDs, one or more of which may claim tasks associated with the orders/items. Although a single user may claim a task that is available to multiple users, in some cases, multiple users may claim the same task if it is a multi-user task (e.g., restocking shelves). Although available tasks may be made available to a plurality of users, in some cases, the CCS/MSDs may make the tasks available to a single user and wait for the user to claim or reject the task, at which time the CCS/MSDs may move on to ask other users if they would like to claim/reject the task.

In some implementations, a task offered to one or more users may require a claim by a user in order for the task to be assigned to the user and subsequently worked on by the user. For example, a CCS may offer a picking task including a plurality of ordered items (e.g., a single customer order) to a plurality of users. In this example, the CCS may not assign the picking task to a user to begin picking until the user has claimed the picking task. In some implementations, a task may be assigned to a plurality of users that may all begin performing the task. In these implementations, a user may claim the task for themselves. For example, the CCS may assign items to a plurality of users, one of which may subsequently claim the assigned items for themselves. As described herein, claiming tasks may result in removal of the tasks (e.g., complete/partial tasks) from other users.

The tasks may be presented to the users in a variety of ways. In some implementations, the tasks may be presented to users in GUIs (e.g., MSD GUIs or other GUIs). The users may interact with the GUIs to claim one or more tasks. For example, a user may select a claiming GUI element associated with a task to claim the task (e.g., a claim button). As another example, a user may perform a gesture to claim a task, such as by swiping a task to the right to claim the task for themselves. The OFS may implement different GUIs for different tasks. For example, different GUIs may be used for offering different tasks. As another example, different user inputs may be used for claiming different types of tasks.

Claiming one or more tasks may cause the MSD, or other user device, to display the task(s) to the user. The tasks may be displayed in different manners, depending on the type of task claimed. For example, if a picker claims one or more customer orders, the MSD may display the orders/items on the MSD for picking. Note that in some cases, the orders/items claimed by the user may have already been displayed for picking. As another example, if a user claims a customer assistance task, the user may be presented with a customer assistance GUI, such as a GUI that indicates the location of the customer, the customer's issue, and/or other details related to customer assistance.

In some implementations, when a first user claims a task, the task may be removed from other user MSDs. For example, if a first picker claims orders/items for picking, the claimed orders/items may be removed from other picker MSDs. As another example, if a first user claims a cleanup task, customer assistance task, or other task provided to a plurality of other user MSDs, the claimed task(s) may be removed from the other user MSDs.

In some implementations, a single task may be performed by multiple users. In these implementations, the CCS/MSDs may be configured to receive multiple claims to a task. For example, two or more users may claim picking tasks for a single customer order. Claims by multiple users may result in the task being removed from other users' MSDs. In some implementations, tasks may be associated with task data structures that indicate a total number of users that may claim the task.

Claimed tasks by a user may indicate a user's intentions and future actions (e.g., future location, future movement, intended types of tasks, etc.). In some implementations, the CCS may be configured to make future decisions regarding a user based on the tasks the user has claimed. For example, if a user claims a customer order for picking, the CCS may assign more items along a route for picking the customer order (e.g., assign items on/near the route). As another example, if a user claims an item for picking, the CCS may assign more items along a path toward the claimed item and/or near the claimed item. As another example, if a user claims a specific type of task, the CCS may assign additional tasks of the same type. In a specific example, if a user claims a cleanup task, the CCS may assign additional cleanup tasks to the user, such as cleanup tasks near the claimed cleanup task. As another example, if a user claims a picking task, the CCS may assign additional picking tasks, as the user may have acquired the proper equipment (e.g., MSD) for continuing with picking tasks. As another example, if a user claims a packing task, the CCS may assign additional packing tasks, as the user may be located in the packing area and be acclimated to packing orders. In this manner, the CCS may determine a user's assigned role in the store based on the user's claims/rejections of specific roles/tasks. In a specific example, as described herein, if a user accepts a restocking task, the CCS may assume that the user can be assigned additional restocking tasks. In the case a user rejects a restocking task (e.g., after claiming a stocking task), the CCS may assume for future task assignments that the user is not focused on restocking.

In some implementations, users may surrender tasks after claiming the tasks. This may result in the tasks becoming available for other users. For example, if a user claims one or more items for picking, the user may subsequently surrender the claimed items back (e.g., before any picking and/or after picking one or more items). In this example, the items may be made available to other users for picking. For example, the items may be assigned to users for picking or made available to claim/reject.

In some implementations, users may manually reject various tasks. Rejecting a task may refer to a user indicating that they do not intend on performing the task. For example, a user may reject a task by manually rejecting the task in a GUI, such as an MSD GUI or GUI on another device.

Users may reject any of the tasks described herein. For example, users may reject picking tasks (e.g., picking items and/or complete orders), packing tasks, delivery tasks, or other tasks described herein, such as restocking tasks, inventory taking tasks, cleanup tasks, and cashier tasks. The tasks for rejection may come from a variety of sources, such as the CCS, TCPS, and/or other users. For example, the CCS may assign orders/items to a user for picking, which may be rejected. As another example, a first user (e.g., a manager) may assign a task to one or more other users that may reject the task. In some implementations, users may also reject available roles within the store, such as a picking role, packing role, delivery role, or other role (e.g., a cashier role, stocking role, etc.).

In some implementations, a user may reject a task that has already been assigned to them. For example, the CCS may assign a plurality of items to a user and the user may reject the items after assignment and display of the items in the picking GUI. In this example, the user may pick some of the assigned items and reject others. In some implementations, the CCS/MSDs may present tasks to users as optional. Optional tasks (e.g., tasks that may require a user to accept/claim the tasks) may be rejected by users.

In some implementations, tasks may be provided to a plurality of users (e.g., simultaneously), each of which may reject one or more of the tasks. In some implementations, a task may be made available (e.g., optional) to a single user that may reject the task. In these implementations, the task may then be made available to one or more other users.

The tasks for rejection may be presented to the users in a variety of ways. In some implementations, the tasks may be presented to users in GUIs (e.g., MSD GUIs or other GUIs). The users may interact with the GUIs to reject one or more tasks. For example, a user may select a rejection GUI element associated with a task to reject the task (e.g., a reject button). As another example, a user may perform a gesture to reject a task, such as by swiping a task to the left to reject the task. The OFS may implement different GUIs for different tasks. For example, different GUIs may be used for offering different tasks. As another example, different user inputs may be used for rejecting different types of tasks.

Rejecting one or more tasks may cause the MSD, or other user device, to remove the task(s) from the user's MSD. In some implementations, rejecting a task may result in the CCS/MSD assigning the task to another user. In some implementations, multiple users may reject the same task presented to them (e.g., leaving the task to the remaining one or more users).

In some implementations, some tasks may not be rejected by users. For example, some tasks may be set as non-rejectable tasks that users may not reject. In some implementations, non-rejectable tasks may be set contextually. For example, in one case, a task may not be rejected if there is only one user available to perform the task. In a specific example, if only one picker is available, the picker may not be allowed to reject a picking task. Similarly, if only one packer is available, the packer may not reject a packing task. As another example, if only one delivery driver is available, the delivery driver may not reject the delivery task. In some implementations, some manager-assigned tasks or CCS-assigned tasks may be configured as non-rejectable (e.g., set by the manager manually and/or CCS automatically).

In some implementations, tasks may be automatically generated (e.g., by the CCS) and provided to a user for claiming/rejecting in a GUI. In some implementations, tasks may be manually generated (e.g., by another user in an MSD or other computing device) and provided to a user for claiming/rejecting in a GUI. In some implementations, the tasks provided to users for claiming/rejecting may be sent out to multiple users from the CCS/TPCS (e.g., simultaneously). In some implementations, the tasks provided to users for claiming/rejecting may be sent out to a single user (e.g., a targeted task to a user based on their location, qualifications, availability, etc.). In some implementations, tasks may be provided sequentially to users. For example, a task may be provided to a first user that rejects the task. In this example, the task may then be provided to a second user that may claim/reject the task. Sequentially providing tasks may also be performed for subsets of users, such as a first set of pickers followed by a second set of pickers.

In some implementations, the claiming/rejecting features of the OFS may be set on/off. In some implementations, the claiming/rejecting features described herein may be configured by a user (e.g., a manager, system administrator, etc.). The claiming/rejecting features described herein may be implemented on a variety of user devices, such as MSDs, other mobile devices (e.g., wearable devices, laptops, etc.), kiosks, desktop devices, etc. A variety of different GUIs, CCS/MSD decisions, and user flows may be associated with claiming and rejecting tasks. The example GUIs, CCS/MSD decisions, and user flows described herein are only examples. As such, different GUIs, CCS/MSD decisions, and user flows may be implemented. Although a user may claim and reject tasks in a GUI, other inputs may be used to claim/reject tasks, such as any method of input on an MSD described herein (e.g., manual buttons, voice, etc.).

In some implementations, the CCS/MSDs may learn the tasks that a user will perform and won't perform based on the tasks that the user claims and rejects. The CCS/MSDs may learn based on a number of claimed/rejected tasks over a period of time, such as a period of 30 minutes, one hour, a single shift, or multiple shifts. The CCS/MSDs may present tasks to the user based on the types of tasks the CCS/MSDs learns that the user may claim or reject (e.g., based on a number of claims/rejections). For example, the CCS/MSDs may present roles/tasks to the user that the user has accepted/claimed in the past (e.g., claimed greater than a threshold number of times within a time period). As another example, the CCS/MSDs may refrain from presenting roles/tasks to the user that they have rejected in the past (e.g., rejected greater than a threshold number of times within a time period). In some implementations, where a plurality of roles/tasks are available to assign to a user, the CCS/MSDs may present roles/tasks that the user has claimed in a more prominent manner than roles/tasks that the user has rejected. For example, the MSD GUI may present the previously claimed roles/tasks higher in a role/task selection interface (i.e., role/task selection GUI). As another example, the MSD GUI may present rejected roles/tasks to the user only after the user has rejected roles/tasks in the GUI that the user has previously claimed.

Implementing claiming and rejecting functionality in the OFS may allow the OFS to be flexible in a variety of situations. Additionally, claiming and rejecting tasks may also provide users with individual and team flexibility in completing tasks. In some cases, the CCS may not have complete situational awareness or complete data to determine the best courses of action for each individual. For example, the CCS may not know users' intentions and all factors (e.g., customer issues/behavior, user mistakes, spills, or other undetectable events) that may be at play while performing assigned tasks. Providing users with the ability to claim/reject tasks (e.g., picking and packing items/orders, delivering orders, etc.) provides flexibility to the users and may even prove to be more efficient than CCS decisions in some scenarios. Furthermore, providing users with the ability to claim/reject tasks may allow the users to handle edge case scenarios that are not easily automatically handled by the CCS.

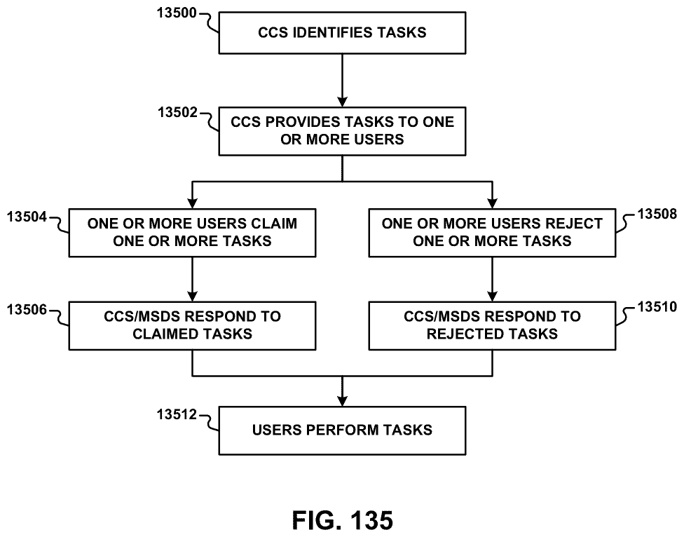

FIG. 135 illustrates a method that describes example operations of an OFS that implements task claiming and task rejection features. The method of FIG. 135 describes operation of the OFS at the task level (e.g., claiming tasks and rejecting tasks). The tasks described in FIG. 135 may include any task described herein, such as picking tasks (e.g., picking one or more items and/or one or more orders), packing tasks (e.g., packing one or more items and/or one or more orders), delivery tasks (e.g., delivering one or more partial/complete orders), inventory taking tasks (e.g., determining inventory using an MSD or other device), cashier tasks (e.g., operating a cash/checkout register), self checkout tasks (e.g., assisting customers with self checkout), cleaning tasks (e.g., sweeping, mopping, organizing, etc.), and other tasks. Although the method describes claiming and rejecting at the task level, in some implementations, the OFS may assign/offer roles to users (e.g., a picker role, packer role, delivery driver role, cashier role, etc.) that may be claimed/rejected in a manner similar to claiming/rejecting tasks described herein.

In block 13500, the CCS identifies one or more tasks. In one example, the one or more tasks may include picking, packing, and/or delivering one or more customer orders. For example, the CCS may receive one or more customer orders and determine that the one or more customer orders should be assigned to one or more pickers. In some cases, the identified tasks may be tasks that currently need to be assigned and/or completed. For example, the identified tasks may include picking a set of items for an unscheduled pickup immediately. In some cases, the identified tasks may include future tasks to be assigned at a later time. For example, the identified tasks may include picking and packing a scheduled customer order for later in the day. The identified tasks may include any arrangement of the tasks described herein. For example, the identified tasks may include any number of tasks and any type(s) of tasks.

In block 13502, the CCS provides the identified one or more tasks to one or more users for claiming or rejection. For example, the CCS may provide the tasks to the users in MSDs and/or other devices that are accessible to the user (e.g., a user mobile device, kiosk, etc.). In some examples, the CCS may provide one or more tasks to a single user and allow the single user to claim or reject the tasks before other users are provided with the tasks. In some examples, the CCS may provide the one or more tasks to multiple users (e.g., simultaneously) and allow each of the multiple users to claim or reject the task(s).

In some implementations, the CCS may rank the provided tasks. For example, the provided tasks may be ranked by urgency. In this example, the most urgent tasks may be ranked higher than less urgent tasks. For example, items/orders that are needed to complete orders immediately may be ranked higher than items that are needed farther in the future. In another example, customer assistance requests and/or other tasks (e.g., cleanup tasks) may be ranked higher than items that are needed in the future. In some implementations, the provided tasks may be arranged on an MSD display based on their rank (e.g., based on a level of urgency). For example, more urgent tasks may be ranked higher on the display than lower ranked tasks. In some cases, the CCS may provide higher ranked tasks to the users, while refraining from providing lower ranked tasks until the higher ranked tasks are claimed.

Users may claim or reject the tasks provided by the CCS. Blocks 13504-13506 describe example operations associated with claiming tasks. Blocks 13508-13510 describe example operations associated with rejecting tasks.

In block 13504, each of the users may claim one or more tasks to indicate to the CCS that they intend to perform the tasks. For example, if an item needs to be urgently picked, a user may claim the item to indicate that they intend to pick the urgently needed item. The tasks may be presented to the user in a variety of contexts. In some examples, the CCS may present the tasks as optional for the users. In these examples, the user may be expected to claim the task before the user is expected to complete the task. In some examples, a task may be assigned to a plurality of users with the understanding that one or more of the users will complete the task alone or as a group. In these examples, a user may optionally claim one or more of the items to indicate to the CCS and others that they intend on picking the one or more claimed items. Furthermore, in these examples, the one or more claimed items may be removed from the MSDs of the other users that did not claim the one or more items.

In block 13506, the CCS/MSDs respond to the claimed tasks. For example, as described herein, the claimed tasks may be removed from other users' MSDs. As another example, the CCS may be configured to make future decisions regarding a user based on the tasks the user has claimed. Additional/alternative responses to claiming tasks are described herein.

In block 13508, each of the users may reject one or more tasks to indicate to the CCS that they do not intend to perform the tasks. For example, if an item needs to be urgently picked, a user may reject the item to indicate that they do not intend on picking the item. A user may reject such an urgent item if they are not able to quickly pick the item (e.g., due to location, other current responsibilities, etc.).

In block 13510, the CCS/MSDs respond to the rejected tasks. Rejection of a task may cause different types of outcomes described herein. In some implementations, the rejected task may be offered to one or more other users to claim. In some implementations, a rejected task may be assigned to another user that may not have the ability to reject the task (e.g., if the user is the last user able to perform the task). As another example, the CCS may be configured to make future decisions regarding a user based on the tasks the user has rejected (e.g., the CCS may refrain from assigning new items near items that were recently rejected by the user or otherwise deprioritize the assignment of such items in the future). Additional/alternative responses to rejecting tasks are described herein.

In block 13512, users may perform tasks according to which tasks have been claimed and rejected. In some implementations, users may complete tasks they have claimed. In some cases, some users may surrender tasks they have previously claimed. For example, a user may affirmatively surrender the task in a GUI (e.g., by selecting a surrender GUI element and/or using a surrender gesture). As another example, a user may drop out of a task by turning off the MSD or signing out of the MSD, which may cause the task to be presented to remaining users. In some cases, rejected tasks may be provided to users a second time, such as when another user has surrendered claimed tasks or otherwise stopped performing the claimed tasks. In these cases, users may claim previously rejected tasks.

Users may claim and/or reject a variety of tasks. As described hereinafter, users may claim/reject one or more of the following: 1) one or more items, 2) one or more orders, 3) one or more locations in the store, 4) one or more generalized roles/tasks (e.g., being a picker, being a packer, etc.), 5) any requests (e.g., requests made by a manager or other user), and any other tasks described herein.

In some cases, a user may want to claim items/orders because: 1) they intend to move in a direction that includes the items/orders, 2) may have additional space in their carrier(s) for the item(s)/order(s), or for another reason. For example, a user may be located next to some items, located close to some items, and/or are heading toward the items. Having a user claim an item may optimize the picking efficiency of the user while also preventing other users from wasting additional effort working toward the items during picking. A user may reject items they are not planning on picking or moving toward. This may be because they are generally too busy or have specific reasons for rejecting the item (e.g., the user has frozen items they want to drop off).

In some cases, a user may claim tasks to be performed in a location (e.g., picking tasks, packing tasks, cleanup tasks, etc.) because they are in/near the location, will be in the location, are experienced in the location, or for another reason. Claiming a location may refer to claiming any of the roles/tasks described herein for the location, such as claiming picking duties for one or more store departments/sections, claiming packing duties for a portion of the packing area, claiming restocking duties for one or more store departments/sections, etc. In some cases, a user may reject a location because the user is not near the location, does not plan to be near the location, is inexperienced with roles/tasks associated with the location, or for other reasons.

In some cases, users may claim roles/tasks that they are qualified to complete and/or have experience completing. If a user is not qualified or experienced for roles/tasks, the user may reject the roles/tasks.

In some implementations, the CCS may assign a set of items to one or more pickers for picking. Each of the pickers may pick the assigned items. In some cases, pickers may claim some items for themselves. For example, a picker may select a claiming GUI element associated with an item to claim the item. In another example, a picker may perform a gesture on the item to claim the item, such as right swiping the item to claim the item. As another example, a picker may hold their finger on the rendered item to claim the item. As another example, the picker may interact with the item GUI in a manner that exposes additional options for the item. For example, the picker may hold their finger on the item, swipe the item, select a menu icon, or perform another gesture to bring up a menu for the item. The menu may include GUI buttons for claiming the item or rejecting the item. In some cases, pickers may reject one or more items. For example, a picker may select a rejecting GUI element associated with an item to reject the item. In another example, a picker may perform a gesture on the item to reject the item, such as left swiping the item to reject the item. As another example, a picker may hold their finger on the rendered item to reject the item.

In some implementations, users may claim/reject items on a per item basis. In some implementations, users may claim/reject a group of items. For example, a user may manually select a group of items (e.g., by touching the rendered items) and claim/reject the items as a group. In some implementations, the CCS/MSD may group items according to certain attributions, such as a department that includes the items, an item type, or other attribute. The grouped items may be grouped under a header and/or grouped within a graphical element (e.g., based on color, within a box, in a bubble, within a darkened border, etc.) that indicates the items are grouped. In these implementations, the users may claim/reject the CCS/MSD-generated group of items. In some cases, the claimed/rejected items may be included in the same customer order. In some cases, the claimed/rejected items may be in different customer orders.

As described herein, the CCS/MSDs may respond to the claiming of items in a variety of ways. For example, the picker that claims the items may have the items remain on their MSD for picking (e.g., exclusively on their MSD). The claimed items may also affect the picker's route. In some cases, the claimed items may be emphasized on the MSD, such as by modification of item text indicating the items have been claimed, modification of item rendering (e.g., bold font, colors, etc.), and/or in another manner. In some implementations, other pickers that did not claim the items may be notified that the items have been claimed (e.g., by another specific picker). In some implementations, the items may be removed from the MSDs of pickers that did not claim the items. In some implementations, the CCS/MSD may modify future operations for the picker that claimed the item(s) as well as other pickers. For example, the CCS may: 1) assign additional items near the claimed items while the user is picking, or after the user has picked, the claimed items, as the user has indicated a willingness to pick items in the location/department, 2) assign items of the same type as the claimed items while the user is picking, or after the user has picked, the claimed items, 3) assign more items from the customer order (e.g., all items from the customer order) that includes the claimed items, 4) suggest additional items/orders (e.g., nearby items, orders including the claimed items, etc.) for the user that may be rendered in an interface immediately after claiming items (e.g., a popout interface, whole screen interface, or other interface), 5) modify routes for the picker that claims items as well as other pickers (e.g., to prevent other pickers from unnecessarily passing the claimed items on a route), 6) refrain from assigning items that are not near, or on the way, to the claimed items, and/or perform other item assignment optimizations described herein based on the knowledge that the user intends on picking the claimed items. In some implementations, the CCS/MSD may remove items from the picker's MSD after the user has claimed items. For example, the CCS/MSD may remove items from the picker's MSD that are not on/along the route including the claimed items.

As described herein, the CCS/MSDs may respond to the rejection of items in a variety of ways. For example, the rejected items may be removed from the picker's MSD that rejected the items. The rejected items may also affect the picker's route. In some implementations, other pickers that did not reject the items may be notified that the items have been rejected (e.g., by another specific picker). If the items were presented to multiple users, the items being rejected by one of the multiple users may remain on the other users' MSD displays. If the items were presented to a subset of users (e.g., one or more users of a plurality of users), the rejected items may be presented to the other users for possible claiming and/or un-rejectable assignment. The items may be presented to the other users based on any factor described herein, such as location of the other users relative to the rejected items, a priority list for pickers, etc.

In some implementations, the CCS/MSD may modify future operations for the picker that rejected the item(s) as well as other pickers. For example, the CCS may: 1) refrain from assigning additional items near the rejected items (e.g., for a short period of time, such as less than a threshold period of time), as the rejecting user may indicate their unwillingness to pick items in the specific location/department, 2) refrain from assigning items of the same type as the rejected items for a period of time, 3) refrain from assigning more items from the customer order (e.g., all items from the customer order) that includes the rejected items (e.g., so another user can pick a majority of the customer order), 4) suggest additional items/orders for the user that may be rendered in an interface immediately after rejecting items (e.g., a popout interface, whole screen interface, or other interface), 5) modify routes for the picker that rejects items as well as other pickers (e.g., to prevent the picker from unnecessarily passing the rejected items on a route), 6) assign items that are not in the location of the rejected items and/or perform other item assignment optimizations described herein based on the knowledge that the user does not intend on picking the rejected items. In addition to refraining from assigning items, the CCS/MSD may remove other items from the user's MSD after the user has rejected items. For example, the CCS/MSD may: 1) remove items from the same customer order as the rejected items, 2) remove items that are near the rejected items, 3) remove items of the same type as the rejected items, 4) remove items in the same department as the rejected items, and/or perform other operations that are immediately reflected on the MSD. In some implementations, the CCS/MSD may assign additional items to a user that has rejected items. For example, the CCS/MSD may assign new items to the user along a newly calculated route (e.g., a route that does not include the rejected items). Refraining from assigning items, orders, or other tasks to a user may include prioritizing the assignment of the items, orders, or other tasks to other users.

In some implementations, the CCS/MSD may force a user to pick items. For example, a user may not be able to reject picking items if they are the only picker. As another example, if a group of users are picking, only a first subset of pickers may be allowed to reject items until a remaining one or more users are forced to pick the items. In some cases, users may be able to claim items that they have previously rejected. For example, rejected items may be accessible in an MSD menu and/or re-presented to a user after rejection. This feature may be beneficial in a case where a user changes their mind with regard to picking items they have once rejected.

Items may be presented to users for claiming/rejecting in a variety of ways. For example, the items may be presented in response to manual requests made by another user, such as another picker and/or a manager. In one example, a user may input items into an MSD that may be needed, such as a recently damaged item that a customer immediately needs. In some implementations, items may be presented to users in an intelligent manner by the CCS/MSDs. For example, the CCS/MSDs may make a suggested list of items for the user to claim (e.g., a list of items near the user that may be picked efficiently) or reject (e.g., a list of items that will be inefficient to pick based on distance from the user). In some implementations, the CCS/MSDs may make a suggested list of items for a user to claim based on the location of already claimed items. For example, the CCS/MSDs may suggest a list of items/orders that are in the same location as the initially claimed item. In some implementations, the CCS/MSDs automatically recommend items to surrender (e.g., after the items have been claimed). For example, if the user leaves a location in which claimed items are located, the CCS/MSDs may recommend to the user that the user surrender the items. Note that the user may also surrender/reject other assigned items, orders, or other tasks at any time (e.g., using a GUI element, turning off the MSD, or in another manner described herein). Presentation of items to the users in an intelligent manner, as described herein, may result in different pickers being provided different MSD GUI displays based on their context (e.g., multiple users may have items presented to them differently for claiming/rejection based on user context).

As described herein, a user may surrender claimed items. In some implementations, an MSD may provide a GUI element to surrender claimed items. In some implementations, an MSD may include a GUI element (e.g., in a menu) that allows the user to surrender all tasks (e.g., quit working using the MSD). In one example, a picker may log out of the MSD to surrender all tasks. In another example, a user may turn off the MSD to surrender all tasks. Surrendering of tasks (e.g., items for picking) may cause reassignment of the tasks by the CCS to other MSDs.

The OFS (e.g., CCS/MSDs) may also implement claiming and rejecting complete customer orders. The OFS may implement claiming and rejecting complete customer orders using similar techniques described herein with respect to single items. For example, the CCS/MSDs may provide similar GUIs to users for claiming, rejecting, and/or surrendering complete orders (e.g., claimed orders by one MSD may be removed from other MSDs). As another example, the CCS/MSD may make similar decisions regarding assignment of current/future tasks to users based on whether the users have claimed/rejected complete customer orders (e.g., the CCS may assign future orders based on indicated intent to pick orders in specific locations).

In some implementations, orders may be displayed based on user location relative to the items in the order. For example, the CCS/MSDs may intelligently display orders to pickers for claiming if the items of the customer order can be efficiently picked, such as when the user is close to one or more items and/or based on a total movement needed for picking. In this example, an order that can be more efficiently picked may be placed higher in a list of possible orders to pick, or the order may otherwise be emphasized in a GUI as a more efficient order to pick. In another example, the CCS may intelligently display orders to pickers for rejection if the items may not be efficiently picked, such as when items are far away and/or greater than a threshold amount of movement is needed. In this example, the order that may not be efficiently picked may be de-emphasized in a GUI relative to orders that may be more efficiently picked. In another example, the CCS/MSDs may intelligently display orders to pickers for claiming if the picker has already picked one or more items from the order. In this example, if the picker has already picked one or more items from the order, the GUI may indicate that the picker has already picked some items and automatically provide the option of claiming the rest of the order (e.g., by providing a GUI element for claiming the order and providing a text description as to why the GUI element is being displayed, such as “Pick the remaining items from the order you have started?”). As another example, the CCS/MSDs may intelligently display orders for rejecting if the picker has not yet picked an item from the orders. In this example, if the picker has not already picked items from a customer order, the GUI may indicate that the order has not yet been started by the picker and provide a GUI element for rejecting the order (e.g., a rejection GUI element may be provided for the order and a text description as to why the GUI element is being displayed, such as “Reject this order, as you have not started picking the order?”).

In some implementations, the MSD GUIs may provide additional context to a user for making a decision to claim/reject an order. For example, the MSD GUI may indicate to a user that an entire order for picking is in their location or within locations near to them (e.g., a GUI may list departments including items in the order, an estimated distance for picking, an estimated time for picking, etc.). In some implementations, the MSD GUI may indicate a number of items in an order and/or the amount of movement required to complete picking the order (e.g., an amount of movement from their current location, an estimated time to pick, etc.). In some implementations, the MSD GUI may indicate a trajectory that will be required for completing the order, such as a series of aisles and/or departments needed for picking the order.

In some implementations, the CCS/MSDs may restrict the types of orders that may be provided to a user for claiming/rejecting. For example, the CCS/MSDs may be configured to prompt a user to claim/reject small orders (e.g., less than a threshold number of items and/or estimated distance/time for picking), since a picker may easily decide whether to claim/reject a smaller order, as the user may more easily understand the requirements for picking the order (e.g., a required amount of movement and time required for picking). In one example, if a user is currently picking a first customer order, the CCS may prompt the user to claim/reject picking a second order (e.g., a small order) that is less than a threshold number of items. In some implementations, the GUI may also provide an estimated amount of extra time and/or movement distance associated with picking the second order. The user may easily decide whether picking the smaller order is possible based on their current workload (e.g., picking the first order) and/or provided estimate of time/movement associated with claiming the second order.

In some implementations, the OFS may implement claiming and/or rejection of items and orders during packing. The OFS may implement claiming and/or rejection of items and orders during packing in a similar manner as described herein with respect to picking. For example, the CCS/TPCS operations, MSD operations, GUIs, or other OFS features may be implemented for claiming/rejecting items and orders for packing in manner that is similar to claiming/rejecting items and orders for picking described herein.

In some implementations, the OFS may implement claiming and/or rejection of locations. For example, a user may claim/reject one or more picking/packing locations in the store, such as store departments, aisle numbers, customer/packing areas, store floors, specific buildings, inside/outside locations, item types, etc. The OFS may implement similar GUIs (e.g., selection GUIs) and decisions (e.g., current/future task assignment decisions) for claiming/rejecting locations as described herein with respect to picking/packing items and orders. For example, in some implementations, the CCS/MSDs may provide a user with a set of locations for picking, such as one or more aisles/departments. In this example, the user may claim/reject a location. Claiming a location may cause the CCS/MSD to assign future tasks in the claimed location (e.g., for a period of time). Rejecting a location may cause the CCS/MSD to refrain from assigning future tasks in the rejected location (e.g., for a period of time).

The CCS/MSDs may intelligently provide a list of locations for claiming/rejecting based on a variety of factors. The options for claiming/rejecting a location may be presented to the user in a variety of ways, such as in a list format or in a store map that displays the locations for claiming/rejecting. For example, a store map may illustrate a top down view of the store and allow a user to select (e.g., touch/click) a portion of the store to claim/reject the portion. The locations suggested to a user for claiming/rejecting may be based on the current/future location of the user. For example, the CCS/MSDs may provide a list of locations to a user for claiming if the user is in/near, or will be in/near, the locations. As another example, the CCS/MSDs may provide a list of locations for a user to claim if the user commonly performs tasks (e.g., picking, packing, restocking, cleanup, etc.) in the locations. The CCS/MSDs may provide a list of locations for rejection to a user if the user does not commonly perform tasks in the locations and/or the user will not be near the locations. Claiming/rejecting locations in the past may allow the CCS/MSDs to learn preferred/unpreferred locations for a user. The CCS/MSDs may assign items to a user and/or present items for claiming/rejecting based on the learned preferred/unpreferred locations.

In some implementations, the OFS may implement claiming and/or rejection of generalized roles/tasks. For example, a user may claim/reject roles, such as being a picker, packer, driver, stocker, re-stocker, cashier, etc. The OFS may implement similar GUIs (e.g., selection GUIs) for claiming and rejecting generalized roles/task as described herein regarding claiming and rejecting items, orders, and/or locations. For example, the OFS may intelligently provide GUIs that allow a user to claim/reject roles (e.g., the GUI may provide roles/tasks for claiming that the user has previously performed). Claiming and rejecting roles may also affect the types of tasks assigned to the user. For example, the CCS/MSDs may not assign tasks to a user that do not correspond to the claimed role. The OFS may also learn the types of roles to provide to users for claiming/rejecting based on historic user behavior (e.g., previous roles/tasks performed, previous roles that were claimed/rejected, previous user locations, etc.).

In some implementations, the OFS may implement claiming and/or rejection of any requests made by another user (e.g., a manager or other user). For example, a user may claim/reject requests by another user for any task, such as preset tasks (e.g., cleanup spill, assist customer, price check, etc.) or custom tasks (e.g., tasks that are spelled out by a manager in text or tasks that are described by voice by a manager and provided as a voice message to users on their MSDs or other devices).

The OFS may also implement claiming and rejection of other types of tasks. For example, a user may claim/reject orders for delivery and delivery routes. In one example, a user may claim/reject delivery routes that are independent from orders (e.g., pre-generated routes to which items will be added later, such as a city route, country route, business delivery route, etc.). In another example, a user may claim/reject delivery routes with orders already attached (e.g., routes that include details, such as number of stops, distance, estimated time to completion, etc.). The OFS may provide GUIs to users for claiming and rejecting routes, such as GUIs that describe a route with expected completion time, drive time, distance, number of orders to deliver, etc. GUIs may also include route maps. In some implementations, claiming routes may remove the route from selection by other users. In some implementations, rejecting a route may cause the CCS to automatically reassign another route or provide a user with a selection of new routes.

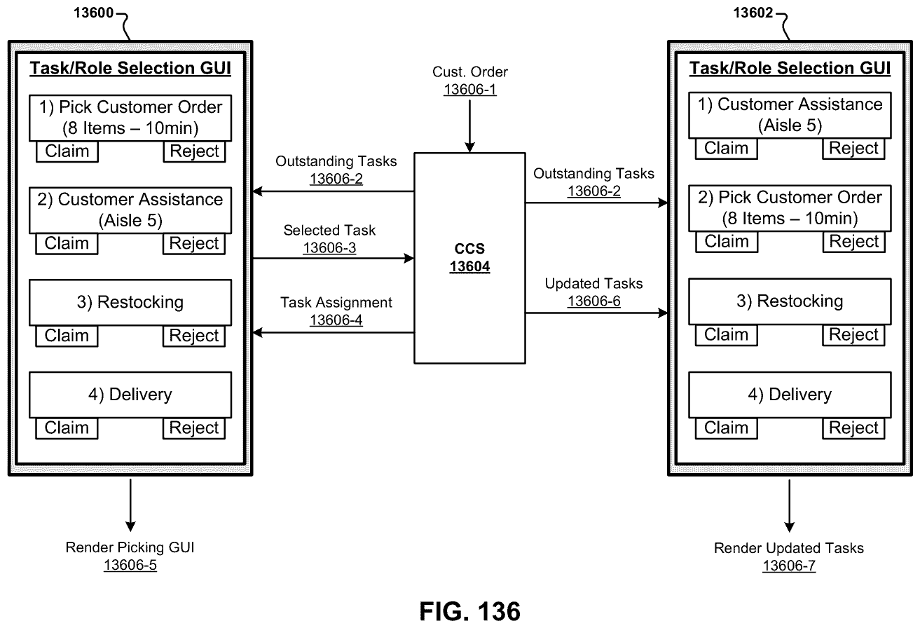

FIG. 136 is a functional block diagram that illustrates operations of a first mobile device 13600, a second mobile device 13602, and a CCS 13604. In FIG. 136, the CCS 13604 determines a plurality of tasks or roles for users to perform. In FIG. 136, the CCS 13604 receives a customer order at 13606-1. One or more of the tasks that may be determined by the CCS 13604 may include tasks associated with the customer order (e.g., in the case the CCS 13604 may instruct separate users to perform separate tasks for the same customer order). For example, tasks may include picking tasks for the customer order, packing tasks for the customer order, and/or delivery tasks for the customer order. Other tasks determined or selected by the CCS 13604 may include tasks that are not associated with the currently received customer order, such as customer assistance tasks that are input into the CCS 13604 automatically (e.g., if the store is equipped with customer assistance buttons) or by another user (e.g., a manager or other user) in response to a customer assistance request from a customer. Other tasks may include other order fulfillment tasks for other customer orders, inventory tasks, restocking tasks, or other tasks described herein. In some cases, the CCS 13604 may assign, or make offers, to users for other roles, such as a picking role, packing role, delivery role, cashier role, restocking role, or other roles described herein. The CCS 13604 may assign/offer tasks or roles according to any of the factors described herein (e.g., current understaffing in specific roles or for specific tasks).

In FIG. 136, the CCS 13604 provides outstanding tasks/roles to the first mobile device 13600 and the second mobile device 13602, as indicated at 13606-2. The tasks/roles may also be provided to other devices (e.g., other users, such as store employees, third parties, etc.). As described herein, the tasks/roles that are offered or assigned to different users may be the same, or may vary based on a variety of factors. In FIG. 136, the first and second mobile devices 13600, 13602 receive the same outstanding tasks/roles and render the tasks/roles in the task/role selection GUI. The example task/role selection GUIs in FIG. 136 include the following tasks/roles: 1) picking the customer order, 2) providing customer assistance (e.g., for a specific customer or as a general role), 3) restocking (e.g., for a specific current set of items or as a general role), and 4) delivery (e.g., for one or more specific orders or as a general role).

Each of the tasks/roles in the task/role selection GUI includes associated claiming and rejecting GUI elements (e.g., claim and reject buttons). In FIG. 136, the claim and reject buttons are rendered as viewable for each task. As described herein, in some implementations, a user may interact with the tasks/roles (e.g., select a menu button, long press the task/role, etc.) to cause the claiming and rejecting GUI elements to appear for one or more tasks. As also described herein, in some implementations, a user may perform a gesture to claim or reject tasks/roles (e.g., a right/left swipe to claim/reject a task or role).

The CCS 13604 and/or mobile devices 13600, 13602 may intelligently offer tasks/roles to different users based on different factors (e.g., historical user behavior, user location, etc.), as described herein. Note that the tasks/roles are the same in FIG. 136, but are in a different arrangement (e.g., ranking) for the first and second mobile devices 13600, 13602. The CCS 13604 and/or mobile devices 13600, 13602 may rank the offered tasks/roles in a different manner for different users based on a variety of factors, such as historical user behavior, user location, and/or based on other factors. For example, in FIG. 136, the second mobile device 13602 may have ranked the customer assistance in aisle 5 higher than picking the customer order because the user associated with mobile device 13602 is in aisle 5, close to aisle 5, or on the way to aisle 5. Additionally/alternatively, the user associated with the first mobile device 13600 may more optimally pick the customer order based on their location or other tasks they currently have assigned.

In some cases, the tasks/roles may be grouped. For example, picking tasks may be grouped with other picking tasks. In some cases, the tasks may be intermixed with one another in the task/role selection GUI (e.g., see FIG. 136) based on ranking factors for tasks/roles described herein. For example, more relevant tasks for the user (e.g., tasks that align better with historical user behavior, location, currently assigned tasks, etc.) may be ranked higher in the task/role selection GUI. In cases where more tasks are available than may be included on a single screen, the user may interact with the task/role selection GUI (e.g., swipe up/down) to scroll through the available tasks/roles. The tasks/roles may also rearrange as various factors with respect to the users or store change. For example, tasks/roles associated with specific locations may become more/less relevant as a user nears/leaves the locations, which may result in the tasks being rearranged on the task/role selection GUI or added/removed from the task/role selection GUI. In one example, a customer assistance task may be rearranged near the top of the list if the user is near/approaching the customer. In another example, a role as a cashier may be rearranged to a lower position in the list if the user leaves the cashier area for a more distant area.

In FIG. 136, as indicated at 13606-3, the first user selects the claim GUI element for the first task in the task/role selection GUI to indicate that the first user intends on performing the first task. The first task in FIG. 136 is picking the customer order indicated at 13606-1. In response to user selection of the claim GUI element for picking the customer order, the first mobile device 13600 sends data to the CCS 13604 that indicates to the CCS 13604 that the user has selected the first task, as indicated at 13606-3.

In response to receiving the indication that the first user has claimed the first task, the CCS 13604 may assign the first task to the first mobile device 13600, as indicated at 13606-4. In FIG. 136, at 13606-5, the first mobile device 13600 transitions to a picking GUI so that the user may perform the assigned picking task. Although a transition to a task-specific GUI (e.g., a picking task) from the task/role selection GUI is illustrated in FIG. 136, in some implementations, the first mobile device 13600 may still provide the first user with options to claim/reject the remaining outstanding tasks (e.g., by selecting a specific task/role selection GUI element, by scrolling up/down the display, by swiping the screen left/right/up/down, etc.). In some cases described herein, the first user may be provided with a task/role surrender GUI element that may be selected in order to surrender the claimed task/role back to the other users, which may cause the previously claimed task to reappear in the other mobile devices' task/role selection GUIs.

As indicated at 13606-6, the CCS 13604 may also update the outstanding tasks/roles for the other mobile devices. For example, the CCS 13604 may send data to the other mobile devices indicating that the picking task has been claimed (e.g., by the first user/device) and/or the CCS 13604 may send updated task/role data (e.g., excluding the picking task) to the other mobile devices.

The second mobile device 13602 may respond to the update by removing the claimed picking task. For example, as indicated at 13606-7, the second mobile device 13602 renders an updated task/role selection GUI excluding the picking task.

As described herein, the data transfers between devices (e.g., MSDs, CCS, TPCS, other mobile devices, etc.) may be implemented in a variety of ways (e.g., using a variety of different communication techniques and/or protocols). As such, the data transfers illustrated in FIG. 136, or other figures, between the mobile devices, CCS, and other computing devices may be implemented using a variety of different communication technologies (e.g., WiFi, cellular, Bluetooth, etc.) and/or a variety of different protocols (e.g., standard protocols and/or custom-developed protocols). Additionally, as described herein, the data stored/used by the devices (e.g., MSDs, CCS, TPCS, other mobile devices, etc.) for the features described herein (e.g., determining available tasks/roles, assigning tasks/roles, rendering interfaces, etc.) may be implemented using a variety of different data storage/processing techniques, data structures, etc.

The OFS may include a variety of types of devices, such as MSDs (e.g., store MSDS, third-party MSDs, etc.), desktops, laptops, kiosks, intercoms, displays (e.g., viewable by users and/or customers), and/or other mobile devices used by store users or customers. The different devices described herein may communicate with one another in a variety of ways, such as via direct/local connections (e.g., Bluetooth, NFC, etc.), via a local communication network (e.g., WiFi in the store), and/or via longer range networks (e.g., the Internet, cell networks, etc.). The various devices described herein may be located in the store and/or outside of the store. In some implementations, the communications may be facilitated by (e.g., go through) the CCS/TPCS.

In some cases herein, users may be described as communicating with one another using MSDs. Although users are described as communicating with MSDs, the communication features (e.g., communication data, algorithms, etc.) described herein may be implemented using any of the devices described herein. Different users (e.g., performing different roles) may communicate using their respective interfaces. For example, a picker may have a picker interface with communication functionality described herein. As another example, a driver may have a driver interface with communication functionality described herein.

Devices may execute a variety of different operating systems and software. In some implementations, the software may be MSD-specific software (e.g., provided by the MSD manufacturer and/or store operator). In some implementations, the various devices may use software applications provided by the store and/or third parties (e.g., applications developed by the stores and/or third parties). In some implementations, some of the software applications executed by the devices may be provided by other parties. For example, communication software applications (e.g., phone applications, text messaging applications, voice messaging applications, and/or other messaging applications) may be provided by other parties in some examples. In some implementations, software applications provided by other parties may be integrated with the software applications provided by the store and/or third parties. For example, messaging applications may be integrated into picking, packing, delivery, and/or customer applications such that users/customers may communicate with other users/customers via applications provided by the store (e.g., via communication applications included in the store-provided applications). The software provided by other parties may also be operated independently of the software applications provided by the stores. Although communication software applications may be provided to the stores and/or third parties, in some implementations, stores and/or third parties may develop their own communication applications/modules.

Any parties or systems described herein may communicate with one another using any of the communication technology, applications, and pathways described herein (e.g., through a CCS, through the Internet, through local in-store communication systems, etc.). For example, users (e.g., pickers, packers, drivers, etc.), customers, a CCS, and/or a TPCS may communicate with one another via any of the communication technologies and pathways. In a specific example, users may use MSDs, or other devices, to communicate with one another inside of the store through a local WiFi network and a local/remote CCS. In another specific example, a user outside of the store may communicate with a user inside of the store via a cellular connection to the Internet and the CCS. In some cases, messages may be sent to a single user. For example, a first user may send a message to a second user. In some cases, messages may be sent to a group of users. For example, a user may send a message to a group of other users.

Communications between users, a CCS, a TCPS, and/or customers may be referred to generally as messages. Messages may be referred to herein in a variety of ways, depending on the context. Names for various messages may generally describe the message's functionality within the OFS. For example, a message may be referred to as a request (e.g., if a user or the CCS is making a request to another user). As another example, a message may be referred to as a response (e.g., if a user is responding to another message, such as a request). As another example, a message may be referred to as a command (e.g., if a user is being commanded by the message). As another example, a message may be referred to as a notification or report (e.g., if the message is notifying one or more users of a situation, such as a spill in an aisle). As another example, a message may be referred to as a confirmation (e.g., if a user is confirming that a task has been completed). As another example, a message may be referred to as an acceptance (e.g., if a user is accepting a task). Communications (e.g., messages) between users/devices may include communication data (e.g., message data). Message data described herein may include, but is not limited to, message text, images, and/or voice data. Message data may also include message metadata. A communication (e.g., a message, request, command, etc.) may be defined by the content of the communication, context of the communication, sending/receiving parties, the manner in which the CCS/MSDs handle the message, and/or other factors. As such, the names given to communications herein may be used interchangeably in some cases. For example, a communication between users may be referred to generally as a message, but in some cases (e.g., if the message requests assistance), the message may also be referred to as a request. In another example, a message that commands a user to perform a task may also be referred to as a command. In some implementations, messages (or other data transfers) may be referred to in an X-Y format, where X denotes the message/data sender and Y denotes the message/data receiver. For example, a message sent from a user device to a CCS may be referred to as a user device-CCS message or a device-CCS message. As another example, a message sent from a CCS to a TPCS may be referred to as a CCS-TPCS message.

Users, a CCS, a TPCS, and/or customers may communicate with one another using a variety of different communication types. For example, communications may include text (e.g., typed and/or selected text), audio (e.g., recorded voice messages), images (e.g., photos captured by an MSD or other device), and/or videos (e.g., videos captured by an MSD or other device). The communications may be sent using a variety of applications, such as messaging applications (e.g., text messaging applications), email applications, custom-developed applications, and/or other applications described herein.

Communications between users and/or the CCS may be manually generated in some cases. For example, users may manually generate messages by selecting a messaging button and then entering text, images, voice, and/or video. As described herein, in some cases, users may generate messages by selecting message templates from menus. The message templates may generate some/all of the text and/or message data to be sent in the message. For example, a user may be provided with a menu that allows the user to select a “Clean up needed” button followed by a set of selectable locations (e.g., department and/or aisle names). In this example, the user may also enter manual text (e.g., in addition to any automated text/data generated by the menu selection). In some implementations, messages may be automatically generated. For example, a CCS and/or MSDs may automatically generate messages. In one example, an MSD may generate a text message to other users indicating another user's location (e.g., as detected by the MSD). In another example, the CCS may automatically generate a command message (e.g., a text message) that commands the user to perform a task. The communications may include any manually/automatically generated context described herein associated with the OFS, such as an MSD location, an MSD estimated arrival time at the packing area, items that have been picked/packed, items that have been assigned, an estimated order completion time, etc. Users may manually enter the context and/or the CCS may automatically generate the context. In some implementations, the menus provided to the users for manually generating messages may intelligently display context GUI elements (e.g., location, estimated completion time, etc.) that a user may select in order to generate the message. For example, a user may select a cleanup menu item and then be presented with a location of the user as an option for generating a message indicating that a cleanup at the current location is needed.

Communications may include communication data (e.g., message data). Message data may include message content, such as user-readable content (e.g., text), user-viewable content (e.g., images, video, etc.), and/or audio content. Users may enter the message data into their MSDs and/or other computing devices. Users may also receive the message data on their MSDs and/or other computing devices. In some cases, users may provide the message content (e.g., manually write the text, record audio, acquire the images, etc.). In some cases, users may select pre-configured messages, such a common text that may be selected from a menu (e.g., “Customer needs assistance”). A user may provide additional user-entered content, such as by indicating a location. In some cases, additional data may be automatically added (e.g., by the CCS/MSD). For example, the MSD/CCS may automatically enter a location associated with the message, such as an aisle location at which a customer needs assistance.

Some messages may be limited to message content, such as a message that only includes text. Although some messages may be limited to message content, in some implementations, messages may include additional data. Additional data included in messages may be referred to as “message metadata.” In general, message metadata may include any of the data described herein that may be required for the CCS/MSDs to perform the functions described herein. Message metadata may include a variety of data associated with generating the message and handling the message. The CCS/MSDs may store the message metadata as the metadata is generated and operated on during handling (e.g., as messages are responded to, tasks associated with messages are handled, etc.).

Message metadata may be generated by the CCS, MSD applications, and/or users, depending on the type of communication. The CCS/MSDs may be configured to operate according to the metadata in the communications, as described herein. For example, an MSD application and/or the CCS may behave in predefined ways to messages for picking, packing, delivery, and/or other tasks, such as requiring acceptance/rejection of the message, performing an action based on the messages (e.g., assigning tasks, reassigning items, reassigning orders, etc.), etc.

In some implementations, message metadata may include a time of message creation/sending, a user that sent the message, and/or the recipient(s) of the message. Message metadata may also include the location of the person that generated the message and/or location of recipients. Message metadata may also include a state of the user that sent the message (e.g., a current role, workload, etc.).

In some implementations, message metadata may indicate one or more tasks associated with a message. The message metadata associated with tasks may vary, depending on the task. In some implementations, the message metadata associated with tasks may be partially/completely hardcoded at the CCS/MSDs. In one example scenario, if a first user hands off an order to a second user because the first user is busy, the message metadata may include an order number, item names in the order, and other data associated with the order/items so that the second user is equipped to handle the order. In another example scenario, if a first user wants assistance picking an order from a second user, message metadata to the second user may include order information that enables the second user to assist the first user in sharing tasks for the order. In another example scenario, if a user sends out a message associated with customer assistance (e.g., a customer needs assistance in a location), the message metadata may indicate a location of the customer, the customer's issue, and/or other data associated with customer assistance.

In some implementations, the message metadata may indicate to the CCS/MSDs how to handle the messages. For example, message metadata may indicate which user(s) receive the messages (e.g., whether the message is a picking request for pickers, delivery request for drivers, etc.). As another example, the message metadata may indicate that one or more users in specific locations should receive the message.

MSDs may render communication content entry GUI elements that the users may use to enter message content (e.g., using a touchscreen keyboard, speech to text, voice/video recording buttons, etc.) and metadata. MSDs may also render GUI elements that provide messages to receivers (e.g., text bubbles, image/video display elements, etc.). In some implementations, MSD GUIs may render preconfigured buttons and/or flows for communications. For example, MSD GUIs may provide a customer assistance button, a cleanup button, a rush item button for an urgently needed item, etc. In some implementations, an MSD GUI may include GUI elements (e.g., a menu item) that allow a user to characterize the message/task by urgency (e.g., “needed immediately” or “can wait”), select a task type (e.g., picking, packing, etc.), select a receiver (e.g., by role and/or specific name), and/or include other context associated with the message.

In some implementations, the MSD GUIs may provide GUI flows that the user may select from in order to generate messages. For example, GUI flows may include preset flows of buttons, menus, and/or other GUI elements for users to use in order to define their messages. GUI flows may produce the data needed for the CCS/MSDs to act upon. In some implementations, GUI flows may allow a user to include freeform messages (e.g., text, audio, video, etc.). GUI flows may include templates for both message senders (e.g., a message originator) and the message receivers. The message sender and receiver may include users and/or the CCS.

In some implementations, the GUI flows for generating/receiving messages may be based on contextual information associated with the users, tasks, or other real-time information. For example, a user may be presented with a context-based communication menu that takes into account their location and the tasks they are performing or will perform. Context-based communications may also take into account other users' current/future locations and tasks. An example context-based message generation GUI may ask a user “Do you want to assign Order X to someone else?” if the user is not completing Order X in a timely manner. As another example, a context-based message may state “You seem busy with current orders, do you want to ask for assistance with picking Order X?”.

In some implementations, the MSDs may provide users (e.g., pickers, packers, drivers, managers, etc.) with GUIs (e.g., buttons, menus, etc.) for contacting other users associated with the same tasks. For example, MSDs may provide interfaces to pickers, packers, drivers, and/or managers associated with fulfilling the same order. The users may use the provided interfaces to send messages and/or interact with other users in the variety of manners described herein.

In some implementations, the MSDs may provide a task overview GUI that provides information related to tasks, such as tasks associated with fulfilling a customer order. A task overview GUI may indicate the users associated with the task (e.g., fulfilling an order), along with other data associated with the task, such as order information for order fulfillment tasks (e.g., items in an order, when the order should be picked, packed, delivered, etc.), task location (e.g., for cleanup, customer assistance, etc.), and other data.

Users may select one or more other users from the task overview GUI in order to quickly contact other users associated with the task. For example, a user may select another one or more users associated with the task from a list (e.g., a list of names in selection buttons) or menu (e.g., a drop down menu or other menu). In some implementations, the task overview GUI may indicate other users that are not associated with the task, such as other pickers, packers, or drivers that are not involved with the specific customer order. In some cases, users may select one or more other users that are not involved with a task (e.g., a user may offload tasks onto other users or ask for assistance from other users).

In some implementations, the lists of users associated with a task may be static. In some implementations, the list of users associated with a task may be dynamic. For example, a list of users associated with a task may change for a variety of reasons, including, but not limited to: 1) the CCS may recruit/dismiss users, 2) some users may request assistance from other users for a task, 3) some users may offload the task to other users, and/or 4) some users may drop out of a task (e.g., drop out of a specific task and/or change their role) or jump in on the task. The list of potential users that will be working on a future task and/or present users currently working on a task may be updated based on any of the above dynamic factors or other factors.

The MSDs may provide GUIs (e.g., buttons, menus, gestures, etc.) that allow a user to contact other users associated with the same task. For example, the MSD GUIs may provide quick access to a list of other users associated with the same task so that the users can easily communicate with one another before, during, and/or after performing the task. In one example, the list of users may be accessed from a button GUI element that displays the list of other users on the MSD GUI for quick communication. In another example, the list of users may be accessed from a menu GUI element (e.g., a drop down menu) that displays the list of users associated with the same task. Additionally, or alternatively, a user may access the list of other users associated with the same task using a gesture (e.g., a swipe up/down on the MSD display) or other user input. In some implementations, the GUI elements/gestures may be available to a user while viewing the main GUI for performing a task. For example, the GUI elements/gestures may be available on a picking/packing MSD interface while the items for picking/packing are displayed. In other examples, the GUI elements/gestures may require the user to bring up another interface (e.g., other than a main GUI interface) for contacting other users.

The MSD GUIs (e.g., a task overview GUI) may provide users with a way to contact other users prior to starting a task, while the task is being performed, and/or after the task has been performed. In some implementations, the lists of users may be grouped based on whether they have not started tasks, are currently performing tasks, and/or will be performing tasks. For example, if a user is currently packing items for an order that is to be delivered, the user may access a menu that includes a list of users that picked the order in the past, as well as a name of a user that will deliver the order in the future. The types of messages (e.g., task-specific messages) sent between users and the message flow (e.g., preconfigured message flows) may vary, depending on the type of task (e.g., picking, packing, delivery, etc.) as well as the status of the task (e.g., whether the task hasn't yet been started, whether the task is being performed at the current time, and/or whether the task has been completed). Example messages and message flows are described herein for different types of tasks and statuses of tasks. Providing message features and message flows that are dependent on task type and status of the task may help users efficiently communicate with one another in a variety of scenarios. For example, some scenarios may be outside of the purview of the CCS/MSDs that may benefit from user communication. In a specific example, if a user encounters a problem that may delay their ability to pick items for an order, the user may quickly and conveniently communicate the scenario to someone that is currently picking/packing the order and may be expecting the picked items (e.g., expecting the items sooner than may be provided by the other user).

In some implementations, multiple users may be performing tasks at the same time that are associated with the same order. In these implementations, the users may access a list of other users performing tasks for the same order. For example, if two pickers are picking items for the same order, an MSD GUI for a first picker may provide the name of a second picker and indicate that they are currently picking items for the order. In this scenario, the first picker may select the name and select one or more preconfigured messages to be sent to the second picker. Example messages (e.g., preconfigured and/or manually generated messages) may include, but are not limited to 1) “I'm running X minutes late”, where the user may enter the value of X, 2) “I'm dropping off items at location X”, where the user and/or MSD may enter the location X, and 3) “Could you please handle items A, B, C for me?”, where A, B, C are items that can be selected in the MSD GUI by the user sending the message. A variety of other types of messages may be generated for any of the OFS communication features described herein. The MSD GUI for the first picker may also provide other names of users (e.g., in separate groupings) that will be performing tasks for the customer order, such as packing/delivering the order.

In some implementations, users can check back with prior users that were involved with tasks for the same order. For example, a packer may check back with one or more pickers that picked an order that the packer is currently packing. In a specific example, a packer may select one or more pickers in the GUI and ask where one or more specific items are located. In another example, a driver may check back with pickers and/or packers that worked on an order the driver is delivering. For example, a driver may ask the packer where packed items are located.

In some implementations, users can send messages to users that will perform tasks in the future (e.g., users that are assigned to perform tasks in the future). For example, a picker may send a message to a packer or driver that will be dealing with the order in the future. In a specific example, a picker may indicate the location of items for packing. In another specific example, a picker may notify packers and/or drivers that the order will be a bit late. In some cases, the messages may be sent to future users at the time the messages are generated. In some implementations, an earlier user may generate a message that will be delivered in the future when the future user begins the future task. For example, a driver may receive messages directed to an order upon starting the driver tasks (e.g., upon logging in to start their driving shift, upon scanning the order to indicate they are acquiring the order, etc.).

In some implementations, users may claim tasks before other future users start the tasks. The claiming of tasks may remove the future tasks from the future users and may notify the future users when the tasks are claimed. In some implementations, a first user may request that a future user perform current tasks. For example, a picker may send a request to a packer for the order requesting that the packer pick the order.

In some implementations, the customer and users fulfilling the customer order may communicate with one another. For example, the customer application may allow a customer to initiate a communication (e.g., text, voice, etc.) to one or more users that are fulfilling their customer order. As another example, an MSD application (e.g., picking, packing, and/or delivery application) may allow the one or more users to initiate a communication with the customer.

In some implementations, a user may request assistance with tasks. For example, a user may request assistance with a task that has already been assigned to the user. In one example, a user that has been assigned to pick one or more items may request that one or more other users pick the one or more items. As another example, a driver that has been assigned to deliver one or more orders may request that one or more other drivers deliver the one or more orders. Other tasks for which a user may request assistance may include, but are not limited to, cleaning tasks, customer checkout tasks, customer assistance tasks, restocking tasks, and inventory tasks. Users may make requests for assistance for a variety of reasons. For example, a user may make a request for assistance if they are unable to complete a task due to an overload of other work. As another example, a user may make a request for assistance picking if the user does not have enough room in their carriers for additional assigned items.

In some cases, a user may request that tasks be completely reassigned to another user. For example, a first user that has been assigned to pick a first customer order may request that one or more other users pick the entire customer order. In some cases, a user may request assistance with completing a portion of a task. For example, a user that is assigned a customer order with a plurality of items may request that one or more other users assist by picking a subset of the customer order.

Users may request assistance by sending a message to one or more other users. In some cases, a user may make the request to a specific user (e.g., by selecting the user in a GUI). In some cases, a user may make the request to a plurality of users. For example, a user may select a plurality of names in an MSD GUI to receive the request and/or select a GUI element that makes a general request for assistance. The MSD/CCS may be configured to select which users receive the general request. In some implementations, a general request may be sent to other users that are performing similar tasks, such as pickers that are currently picking. In some implementations, a general request may be sent to any other available users.

One or more users may receive a request for assistance. For example, an MSD GUI, or other device GUI, may display the request for assistance to the user. In some implementations, the user receiving the request may accept or deny the request (e.g., by touching an accept or deny GUI element, using a gesture, etc.). If the request is accepted, the requesting user may be notified on their MSD GUI that the request has been accepted. The task may also be removed from the requesting user's MSD GUI and added to the accepting user's MSD. In some implementations, a user may accept a portion of a request, such as a portion of a task (e.g., picking a portion of the items). Although users may request tasks from other users, which may involve user-acceptance of the request, in some implementations, a request for assistance may be handled automatically by the CCS. For example, the CCS may pull assigned tasks from one or more users and assign the tasks to the users according to the request.

In some implementations, a user may request additional tasks from one or more other users. For example, a user may request one or more tasks from other users that are currently assigned to the other users. The other users may respond to the request for additional tasks by assigning tasks to the requesting user or rejecting the request. In some cases, a user may request additional tasks when the user is able to handle more tasks than are currently assigned to the user.

A user may request one or more additional tasks in a variety of ways. In some cases, a user may make a general request to one or more users for any task. In some cases, a user may make a request to a specific user for any task from that user. In some cases, a user may make a request for specific types of work (e.g., picking tasks, packing tasks, driving tasks, etc.). In some cases, a user may request specific tasks, such as a request to pick a specific order that has already been assigned to another user. In these cases, users may have access to an MSD GUI that indicates which tasks other users are assigned.

In some implementations, the CCS may automatically handle a user's request for additional tasks. For example, in response to receiving a request, the CCS may automatically pull a task from another user and assign the task to the requesting user. In some implementations, the MSDs may be automatically configured to request tasks from other users and/or the CCS upon a user starting their shift (e.g., starting an MSD, signing in to the MSD, etc.). In some implementations, the MSD/CCS may optimize the tasks that are assigned to a user. For example, the MSDs/CCS may assign picking tasks that may be included on a single route, may minimize movement, maximize items picked, and/or satisfy other efficiency criterion or reasons for assignment described herein.

In some implementations, managers may have their own MSDs or other computing devices with features for monitoring users and performing other actions associated with users (e.g., commanding users to perform tasks). Manager devices and manager interfaces may refer to devices and interfaces that may be used by users that may manage (e.g., supervise) one or more other users. A store or third party may include a variety of managers including, but not limited to, picking managers, packing managers, delivery managers, and other types of managers. In some implementations, managers/supervisors may use different MSDs/devices than other users (e.g., pickers, packers, drivers, etc.). In some implementations, manager MSDs/devices may be the same devices as other MSDs, but may include additional software that provides manager interfaces described herein.

In some implementations, the CCS/MSDs may provide a manager interface GUI including GUI elements for monitoring users and performing other actions associated with users. For example, the manager interface may be provided in an application and/or web-based interface. Using a manager interface, a manager can view real-time information regarding operations of the OFS, such as the current/future outstanding order data, employee data, and other information described herein. The manager interface may also give a manager the ability to manage employees with messages and other requests/commands.

The manager interface may include interface elements (e.g., GUI elements) that allow the manager to view any of the current/historic data associated with the store OFS and/or third-party OFS described herein. Monitoring the OFS data in real time may help the managers make decisions regarding managing employees in real time. In some implementations, users other than managers/supervisors may also have access to monitor some of the data (e.g., data relevant to their roles/tasks). A variety of types of OFS data described herein may be monitored by the manager. The example OFS data described herein that may be monitored by the manager is only example data. As such, additional/alternative OFS data other than that described herein may be monitored by the manager in a manager interface. Example interface elements in the manager interface may include, but are not limited to tables, menus, windows, controls (e.g., buttons, tabs, etc.), etc.

In some implementations, some of the manager interface data and GUI elements described herein may be rendered on the same screen at the same time. In some implementations, the manager may access different screens that include different types of data and GUI elements. For example, the manager may access a first screen that displays current users and user information. In this example, the manager may access a second screen (e.g., via a menu, swipe left/right, etc.) that displays a list of orders and associated order information. Different screens of the manager interface including different data and GUI elements described herein may be accessed in a variety of ways, such as via menus, hyperlinks to new screens, gestures (e.g., swipes left, right, up, down, etc.), or in other manners.

In some implementations, the manager interface may display real-time aggregate data for the OFS, such as data indicating a number of current orders being fulfilled (e.g., number of orders currently being worked on by users), a total number of outstanding orders, a total number of assigned orders, upcoming order data, a number of customer orders that users should be working on to meet current demand (e.g., if there is a backlog), a number of users performing tasks, picking data (e.g., picking rate, number of pickers, etc.), packing data, delivery data, current customer wait times, etc. As described herein, a manager may take actions (e.g., CCS-recommended actions), such as recruiting/dismissing users based on the aggregate data.

In some implementations, the manager interface may display past aggregate data over a defined time period (e.g., a time period that may be selected by the manager in the manager interface), such as past data over the last 15 minutes, 30 minutes, 1 hour, or multiple hours. The past aggregate data may indicate overall user performance with regard to fulfilling orders. For example, the past aggregate data may indicate average order fulfillment times, average customer wait times over time, picking rates over a period of time, packing rates, etc. Providing a manager with past aggregate data may help the manager take informed actions in the OFS, such as recruiting/dismissing users.

In some implementations, the manager interface may include a list of outstanding customer orders being fulfilled or that will need to be fulfilled in the near future. The manager interface may provide high level information for each order in the list. For example, each order may indicate a number of items, an expected time for picking/packing the order, and/or one or more users that will be assigned the order. The manager interface may allow the manager to select specific orders to view additional details regarding the order, such as which items have been picked, will be picked, the locations of the items, etc.

In some implementations, the manager interface may include user data. For example, the manager interface may include a user list (e.g., employee list) with user names and other data. A user list may include summary data for users (e.g., a short blurb indicating their role, how much work they have, how they are performing, etc.). The user list may also allow the manager to select user names (e.g., buttons, links, etc.) in order to surface various actions for the user, such as viewing more data about the user (e.g., user status, current tasks, performance, location, etc.), sending a message to the user, and/or assigning a task to the user. In some implementations, a manager may review user/customer communications (e.g., text, videos, images, etc.) regarding various tasks.

In some implementations, the manager interface may include customer data associated with current customers or near future customers, such as current wait times, whether their orders are likely to be ready in time, etc. The manager interface may also include historic customer data (e.g., for recent customers within hours or minutes). For example, historic customer data may indicate past wait times, whether customer orders were fulfilled accurately, etc.

In some implementations, the manager interface may include a list of outstanding tasks, such as tasks associated with customer orders that need to be picked/delivered or other tasks (e.g., customer assistance, cleanup, etc.). The list of tasks may include additional information associated with the tasks (e.g., whether a user was assigned to the task, the location of the task, etc.). In some implementations, a manager may select (e.g., touch/click) a task to view more information regarding the tasks. In some implementations, a manager may select a task in order to assign a user to the task. The task list may be updated over time. For example, tasks may be removed as the tasks are completed. As another example, tasks may be added as users input tasks into their MSD (e.g., user-reported cleanup tasks, picking/packing tasks, etc.), as customers request assistance, etc.

The manager may take a variety of actions using the manager interface. In some implementations, the manager interface may provide enumerated action buttons, such as message buttons and/or request/command buttons that may be selected in a menu (e.g., cleanup, assist customer, and other buttons). In some implementations, the manager interface may include action assignment gestures, such as dragging and dropping a user name onto a task in order to assign the task to the user. As another example, a manager may drag and drop an order/item onto a user to assign the order/item to the user (e.g., assign an item for immediate picking). In another example, a manager may drag a user name onto a store map in order to assign a location (e.g., department, section, packing area, aisle, etc.) in the store to the user (e.g., for picking).

In some implementations, a manager interface may include messaging functionality. For example, the managers can interact with GUIs to send messages, such as message content and other actions. Custom messages generated by the manager (e.g., text, voice, images, and/or video messages) may give the manager complete flexibility in their requests/commands that may not be provided in the enumerated menus and action GUI elements. The requests/commands may be a general broadcast (e.g., to all users) or sent to one or more specific users (e.g., users in specific roles, by user name, etc.).

Managers may use the manager interface to assign any of the tasks described herein to one or more users. For example, the manager may select a task and then assign it to a user in the manager interface. In a specific example, the manager may select the task from a list and then interact with an assignment GUI element (e.g., assignment button from a menu) and select the user(s) to assign the task. In another specific example, a manager may select the task (e.g., touch the task) and drag it to the user in the manager interface to assign the task. In some implementations, a manager may command a user to go to a location in the store, go to a location outside of the store, meet a person in the store, etc.

In some implementations, a manager interface may allow a manager to recruit/dismiss others. For example, the manager may view all users in the manager interface. The manager may then select users to recruit/dismiss. In some implementations, the manager interface may make recommendations regarding who to recruit/dismiss (e.g., based on the factors described herein).

In some implementations, the manager interface may allow the manager to set orders/items to high priority. For example, the manager may select the orders/items and then interact with a GUI element that sets the orders/items to high priority. The CCS may respond to an order/item being set to high priority as described herein. For example, the CCS may assign the orders/items for immediate picking (e.g., assign the items to the closest user). As another example, the MSDs may emphasize picking/packing of the orders/items that are high priority (e.g., by emphasizing the orders/items in the MSDs by location, color, etc.).

In some implementations, the manager interface may make smart suggestions to the manager for actions. For example, the manager interface may recommend orders/items to prioritize, users that may be assigned tasks, users to recruit/dismiss, etc. The manager interface may make suggestions for any of the task assignments described herein based on any of the associated factors. The manager interface may emphasize the recommendations in the GUI (e.g., using text size/font, color, popups, notifications, etc.).

In some cases, a user (e.g., manager or employee) may request one or more rush items. Rush items may refer to high priority items that a user and/or customer needs immediately. For example, a rush item may be needed by a customer that is currently at the store waiting for the rush item. In this example, a rush item may be requested by the customer and/or a user to replace an item that does not meet customer expectations, such as low quality produce, a damaged item (e.g., damaged box), an item that has been dropped on the floor in front of the customer, an incorrect item, a mis-ordered item, etc. In another example, a rush item may be needed by a user immediately. For example, a packer or driver may need the rush item immediately so that the packer or driver can complete an order and deliver the order immediately, along with other possible orders.

A customer or user may request a rush item. For example, a customer application may include a rush item request GUI element (e.g., a button, menu item, etc.) that a customer may use to request a rush item. In one example, the customer may view an item the customer would like to replace in the customer application (e.g., an item that is part of their current order) and select a rush item request GUI element in order to request a rush item. In another example, a user MSD may include a rush item request GUI element that a user may use to request/notify other users that a rush item is needed.

The CCS may receive a rush item request. The CCS may send out the rush item request to one or more users. In some cases, the CCS may send the rush item request to all active users. In some cases, the CCS may be configured to identify one or more users that may most quickly pick the rush item and bring the rush item to the requesting user/customer. For example, the CCS may select one or more users that are near the rush item, do not have other immediate tasks, and are able to drop other current/future tasks briefly to pick the rush item. In some cases, the CCS may be configured to identify one or more users that may most efficiently pick the rush item. For example, the CCS may send the rush item request to one or more users that will pass the rush item (e.g., on a picking route) in the near future. Although example factors for selecting users that receive a rush item request are described above, the CCS may use any of the item assignment factors described herein to select one or more users that receive the rush item request.

In cases where multiple rush items are needed for multiple customers, the CCS may prioritize the rush items according to a variety of factors. For example, the CCS may prioritize rush items according to which users requested the rush items first (e.g., a first requested rush item may be fulfilled first). As another example, the CCS may prioritize rush items for customer orders that were needed at an earlier time. As another example, the CCS may prioritize rush items for customers that have temperature sensitive items (e.g., hot meals, ice cream, etc.) since those items may require immediate delivery or may require a customer to leave the store immediately with their pickup.

The selected one or more users may receive the rush item request from the CCS. The rush item request may be displayed on the MSDs of the selected one or more users in a prominent manner that indicates the immediacy associated with picking the rush item. For example, the rush item may be displayed at the top of the MSD above all other items (e.g., regardless of the location of the rush item). In another example, the rush item may be rendered in a manner that is different from other items in a picking MSD, such as by using different colors, font sizes, or other renderings that indicate the item is a rush item. In some implementations, a customer/user may request multiple rush items for one or more orders. In these implementations, the MSD GUI may group the rush items together in the interface. Although a rush item may be included in a picking GUI (e.g., at the top of the GUI), the rush item may also be displayed in a prominent manner in other GUIs for users that are not picking. For example, the rush item may be displayed in any MSD/device GUI being carried by a user. In a specific example, a user carrying an MSD, but not currently picking, may receive a graphical rush item notification that may also include associated audio (e.g., a beep) and/or tactile output (e.g., vibration). In some implementations, a user may claim the rush item, as described herein. In some implementations, a GUI may also indicate the nature of the rush item (e.g., why the item is considered a rush item). For example, the MSD GUI may indicate that “the customer is waiting”, “the customer will arrive in X minutes”, “This item replaces a damaged item”, etc.

A user that receives the rush item request may scan the rush item and provide the rush item to the rush item requestor. Scanning the rush item may indicate to the CCS that the rush item will be provided to the requestor. Scanning the rush item may cause the MSDs displaying the rush item to remove the rush item from the MSD displays. In some implementations, the rush item requestor (e.g., a user and/or customer) may receive a notification that the rush item has been scanned, picked, and is on the way to them. The rush item may be handed over to the customer, or otherwise placed in a correct location (e.g., packed into a delivery order). The customer, or other user, may confirm the transfer of the rush item in the customer application or on an MSD.

In some implementations, the user communications may be handled based on the location of the task and/or the location of the users. For example, as described herein, a message for cleanup in an aisle may automatically indicate the location of the cleanup. As another example, the receiver of the message may be selected based on the location of the receiver. For example, the CCS may send a message to the most relevant receiver, such as a receiver that is closest to a task (e.g., closest to cleanup) or can complete a task with the least amount of movement (e.g., pick one or more items with a minimum amount of movement). In another example, if a user requests a stock check in a message, the message may be sent to a receiver that is closest to the area where the stock can be checked. The CCS may also take into account past and future locations of users when sending messages. For example, the CCS may refrain from sending messages to users that have just left locations associated with the messages in order to prevent backtracking. As another example, the CCS may send messages to users that will be relevant in a future location for the user (e.g., a future picking location on a route). In some implementations, a customer may ask for assistance in their application or ask a user in the store (e.g., a store employee). The user may report the customer assistance to the CCS (or the request is sent directly to the CCS from the customer), which may then assign the task to a user (e.g., based on proximity) or broadcast it to a plurality of users that can accept/deny it.

In some implementations, a picker may indicate in the MSD GUI that the picker is returning to the packing area with items. The picker may indicate their return to the packing area for any reason, such as a full carrier or other reason (e.g., melting/cooling items). In some cases, the MSD GUI may receive user input indicating the reason for returning (e.g., from a menu selection or freeform input). If there are any remaining items that need to be picked by the picker (e.g., to complete a customer order), the CCS may reassign the items to be picked. The MSD may also rearrange the picker's current items based on their new location near the packing area after dropping off items. The picker MSD or CCS may also change the items assigned to the picker with the knowledge that the picker will be unable to pick extra items while dropping off current items. The picker MSD or CCS may also remove/assign new items based on knowledge that the picker will be located in the packing area. For example, the CCS/MSD may rearrange items for picking by the picker based on a starting location that is near the packing area.

In some implementations, a manager and/or the CCS may instruct a picker to go to the packing area. Such a command may be automatically generated by the CCS/MSD or manually generated by a user. This may be done for a variety of reasons, such as the picker having a complete order that is needed or the picker having items to complete an order that is needed (e.g., whether the items are part of the same order or the CCS needs the items to complete a different order). In a specific example, if a picker has items that are needed to finish an order, the CCS may instruct the picker to drop off the items in a location for another picker. As another specific example, if a picker has items that are needed to finish an order and the picker is near the packing area, the CCS may instruct the picker to drop off the needed items in the packing area during the route. In some implementations, the CCS may instruct pickers to transfer items if the items are needed and the pickers are near one another. In some cases, the CCS/MSD may instruct a picker to leave their items/order in a location (e.g., a current location) and take one or more items to the packing area or other location immediately. In some implementations, the CCS/MSD may provide context to a user as to which items are need and why the items are needed, such as the time by which the items are needed, a customer location for a customer that needs the items, a specific message entered by a user requesting the item, etc.

In some implementations, a user may indicate their availability, such as whether they are available for tasks and their shift length. For example, a user may indicate that they are available to pick, pack, and/or deliver. The length for which they are available could be set to their shift length or other length specified by the user. A user may also indicate that they are available to perform a specific number of tasks, such as a pick/pack a specific number of orders. A user that indicates their availability may assist the CCS in determining how to assign items to the user and other users. The CCS may also notify users of future tasks they will be expected to perform. For example, the CCS may notify a picker that they will be expected to pick items in 20 minutes (e.g., the time another picker will be leaving the picking role).

In some implementations, the CCS may ask a picker if the picker can perform a specific role or task. In some implementations, the user may be required to accept or deny the request. In some implementations, the CCS may require confirmation from a user that the user is able to perform a role/task (e.g., selection of a confirmation GUI button). For example, the CCS may ask a user whether the user has enough room to pick a specific number of items/orders. In this example, a user may indicate that they do or do not have enough room, which may affect whether the items/orders are assigned to the user (e.g., items may be assigned if the picker indicates they have enough room).

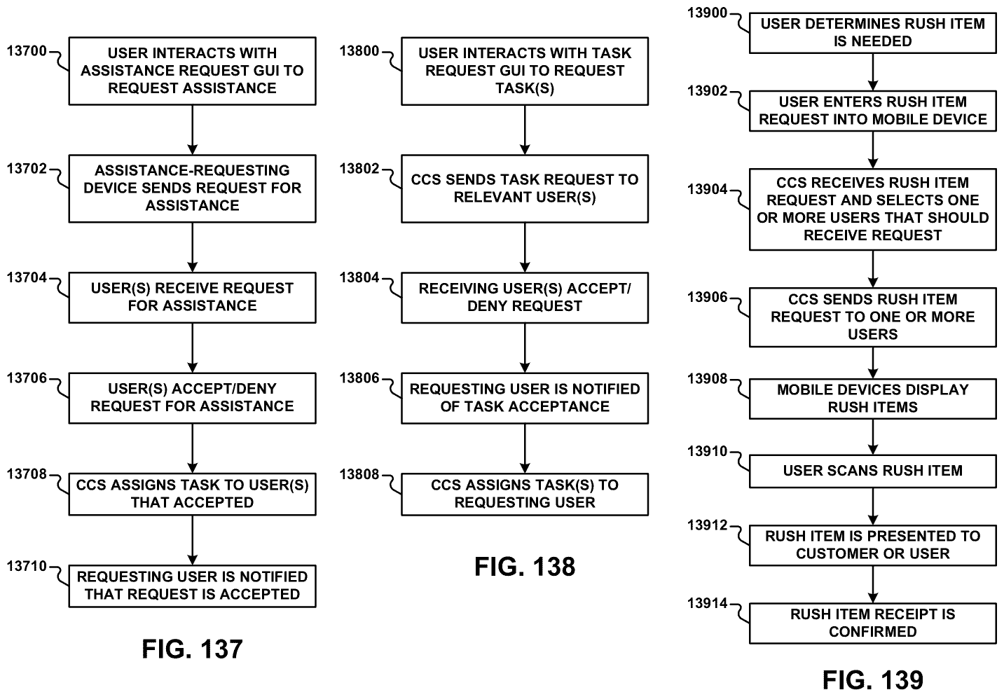

FIG. 137 illustrates a method that describes example communications between users in which a first user requests assistance with a task from one or more other users. In block 13700, a first user interacts with GUI (e.g., an assistance request GUI) to request assistance with one or more tasks from one or more other users. For example, the first user may interact with an assistance request GUI on their user device. The user device used to request assistance may be referred to as an assistance-requesting device. The assistance request GUI elements may allow a user to select one or more tasks for which the user is requesting assistance. Example tasks may include any complete/partial tasks described herein (e.g., partial/complete picking, packing, delivery, etc.). In a specific example, a user may request assistance with a picking task (e.g., picking items or a whole order) by touching items/orders that will need picking by another user. As another example, the user may make a swiping gesture on a task (e.g., a complete customer order, items, etc.) to indicate that the user would like another user to perform the task. In another example, the assistance request GUI may provide a button (e.g., a button in a menu associated with the task) that selects the task. In some implementations, the assistance request GUI may also allow the first user to select one or more other users that receive the request, such as by selecting their names from a menu before/after selecting the task(s). In other implementations, the CCS/MSDs may select the other user(s) that receive the selected task (e.g., the first user may not be required to select the other users that receive the assistance request).

In block 13702, the assistance-requesting device sends the assistance request (e.g., via the CCS and/or directly to user devices via another route). In some cases, the assistance request may be to one or more specific users. In these cases, the first user may specify the names of one or more users that should receive the assistance request (e.g., by selecting the names in a GUI). In some cases, the first user may specify that the assistance request is a general request for any user. In these cases, the assistance request may be sent to a plurality of users. In some cases, the CCS/MSDs may select the one or more users that receive the assistance request, as described herein.

In block 13704, one or more users receive the assistance request. The assistance request may be displayed to the users on their MSD GUIs or on another device (e.g., an intermediate device). In block 13706, the one or more users may accept/deny the assistance request. The users may interact with their GUIs to accept/deny the assistance request (e.g., by touching an accept/deny GUI button, by performing a swiping gesture, or in another manner). The user devices may indicate acceptance/denial to the CCS in a response.

In block 13708, the CCS assigns the task to the user(s) that accepted. In block 13710, the first user is notified that the assistance request has been accepted in their GUI. For example, the CCS may send a notification to the first user device indicating the task has been accepted. In some cases, the first user device may remove the task from the first user device GUI, as the task may be completed by the accepting user(s). In some cases, the task may remain with the first user (e.g., remain unchanged on the first user device GUI). For example, if a user requests assistance with picking a customer order, the items in the customer order may remain with the first user and also be put into a picking interface for an accepting user so that both users may pick the order at the same time.

FIG. 138 illustrates example communications between user devices in which a first user requests additional tasks from other users. In block 13800, a first user (e.g., a task requesting user) interacts with a GUI (e.g., a task request GUI including task requesting GUI elements) to request one or more additional tasks. For example, the first user can select a GUI element (e.g., a task request GUI button) to request additional tasks. In some cases, the first user may request tasks from a specific user (e.g., a specific user selected in the GUI). In some cases, the first user may make a general request to any user for a task. In some implementations, the first user may specify the task in the request (e.g., specify a request that is currently assigned to a specific user or any user). For example, the first user's mobile device may provide a menu of tasks that are currently assigned to specific users (e.g., the CCS may provide a global list of current users and corresponding tasks at the store). In some implementations, the first user may specify a task type (e.g., picking, packing, or delivery) that they are requesting, such as by selecting a task type GUI button or menu item.

In block 13802, the first user device sends the request for additional tasks to the CCS, which then sends the request to the relevant users. For example, the CCS may determine the relevant users based on the parameters specified by the first user in the request (e.g., specific/general users, specific/general tasks, etc.). In one example, if the first user requests a specific task from a specific user, the specific request may be sent to the specific user. In another example, if the first user requests a general task type, the CCS may send requests to any users having tasks assigned of the specified type. Although a task request may be sent to relevant users, as describe herein, in some alternative implementations, the CCS may automatically provide one or more tasks to the requesting user (e.g., automatically pull some assigned tasks from existing users and/or automatically assign new yet-to-be assigned tasks to the first user).

In block 13804, the one or more users that receive the request from the CCS may accept or deny the request. For example, the users may receive the request on their mobile devices in GUIs that allow the users to accept or deny the request by selecting GUI elements (e.g., accept/deny buttons). The requests may be presented to the users in a variety of ways, such as in a menu, a popup notification, etc.

In block 13806, the CCS notifies the first user in their mobile device GUI whether the request is accepted or denied by one or more users. In block 13808, the CCS may automatically assign, to the first user, the tasks that were accepted for transfer to the first user. In some cases, the CCS may block requests for tasks by the first user or prevent acceptance/transfer of tasks from other users to the first user. For example, the CCS may prevent assignment of tasks to a requesting user that is not qualified for the tasks. As another example, the CCS may prevent request/assignment of tasks to the first user if the first user has too many tasks already assigned or too many tasks to be transferred to the first user in response to the request. A user may have too many tasks if the user will not be able to perform the tasks in an acceptable manner (e.g., estimated picking time is too late, estimated delivery time is too late, etc.).

FIG. 139 illustrates a method that describes example communications between user devices in which a first user requests that a rush item be picked immediately by another user. In block 13900, a first user determines that a rush item is needed immediately to fulfill a customer order (e.g., an item is needed for immediate delivery or a customer waiting at the store for pickup). In block 13902, the first user enters the rush item request into their mobile device (e.g., an MSD or other device). For example, the mobile device may provide a rush item request GUI/element that allows the user to specify the rush item that is needed. In some implementations, the rush item GUI may display items from the customer order for selection as a rush item, which may be convenient in the case that the rush item is an item that replaces a damaged, or otherwise unsatisfactory, item in the customer order. Although the first user may generate the rush item request in their mobile device, in some implementations, a customer may use their customer application to generate the rush item request (e.g., using a similar GUI as the first user).

In block 13904, the CCS receives the rush item request and selects one or more users that should receive the request. In some cases, the rush item request may be sent out broadly to all relevant users (e.g., all pickers). In some cases, the CCS may select a subset of available users based on their ability to satisfy the rush item request. For example, the CCS may select users that are close to, or on their way to, the rush item. In another example, the CCS may select users that have available picking bandwidth for the rush item (e.g., they are not assigned a current task or may not currently have an urgent task). Although the CCS may automatically select the receiving users, in some implementations, the first user may be provided with a GUI that allows the first user to select which other user receives the request.

In block 13906, the CCS sends the rush item request to the one or more selected users' mobile devices. In block 13908, the mobile devices that receive the rush request may display the rush item in their mobile device GUI (e.g., MSD GUIs). One or more of the users may then attempt to satisfy the rush item request by picking the rush item. In block 13910, a user that picks the rush item may scan the rush item to indicate that they have the rush item and that the rush item is being brought to satisfy the request. In some cases, instead of scanning the rush item, the user may manually interact with the mobile device GUI to indicate that they have the rush item (e.g., the user may select a button GUI element or swipe the rush item to indicate possession of the rush item). In some implementations, a user may claim the rush item in the mobile device GUI to indicate that they intend on satisfying the rush item request.

In block 13912, the rush item is presented to the customer or other user (e.g., delivery driver). For example, the picker of the rush item may present the item to the customer/user. As another example, the picker of the rush item may hand the rush item off to another user for presentation to the customer/user. For example, the picker may hand the item off to the original requestor or to a user that is loading the customer's vehicle with their customer order. In block 13914, the receipt of the rush item by the customer or other user (e.g., delivery driver) is confirmed. In one example, the user that hands the item over to the customer/user may scan the item to indicate the transfer to the customer/user. In another example, the user that hands over the item to the customer may manually indicate in a GUI that the rush item has been handed to the customer. In some cases, such as when the customer is at the store to pick up the item, the customer may use their customer application to scan the rush item (e.g., scan a barcode, acquire an image, etc.) to indicate that they have received the rush item. In some cases, the customer application may provide a customer GUI that allows the customer to manually confirm receipt of the rush item (e.g., by selecting a confirmation GUI button).

As described herein, in some cases, the CCS may reassign items and/or complete orders to pickers. For example, the CCS may reassign one or more items from a first picker to a second picker. In a specific example, the CCS may reassign items to a second picker that may more efficiently pick the items. In another specific example, the CCS may reassign items to a second picker if the first picker drops out of picking. The CCS may also reassign items to a second picker for other reasons described herein. In some implementations, the CCS may reassign items before picking starts (e.g., after initial assignment, but before the items are picked). For example, the CCS may reassign items due to changing circumstances, such as movement of one or more pickers, items claimed by one or more pickers, or any other conditions that may cause the CCS to determine that items may be reassigned to be picked more efficiently.

In some implementations, the CCS may reassign items after the items have been picked. For example, the CCS may instruct pickers to transfer items to one another after picking. In some implementations, after items have been placed in the packing area, the CCS may reassign packing tasks (e.g., packing one or more items) to other packers. In some implementations, the CCS may also reassign the delivery of an order to a different user. For example, the CCS may reassign delivery of an order to a delivery driver that can more efficiently deliver the order (e.g., due to changing circumstances).

In some cases, the OFS may reassign one or more items from a first customer order to be used in a second customer order (e.g., as a high priority or rush item). For example, after an item has been picked for a first customer order, the CCS, or a user, may request/command that the picked item be used for a second customer order instead of the first customer order. An item that was picked for a first customer order may be reassigned to a second customer order at different stages of the order fulfillment pipeline. For example, an item may be reassigned to a different customer order after picking (e.g., while the item is in a cart) and/or after the item is placed in the packing area (e.g., before or after being collected with other order portions for presentation to the customer). In some implementations, the item may be reassigned to a different picker. In some implementations, a picker may have an item assigned to a different customer order on their own MSD. For example, after a picker picks an item, the item may be reassigned to a different customer order after picking. As a consequence of reassigning a picked item of a first customer order to a second customer order, the item may have to be picked again for the first customer order (e.g., by the original picker or another picker).

Although scenarios including single item transfers between two customer orders are described herein, multiple item transfers between customer orders may be performed by the CCS/MSDs. For example, two items from a first customer order may be transferred to a second customer order. As another example, two items from a first customer order may be transferred to two other customer orders. As another example, a single customer order may have one or more items transferred in from multiple other customer orders. Item transfers between customer orders may be performed by one or more users for any one or more items. In some cases, a single item transfer may use a single user. In other cases, a single item transfer between customer orders may involve multiple users. In a specific example, a picker may place an item for transfer in a packing area location. In this specific example, the item may be taken by a second user (e.g., a packer) to pack into the customer order or hand off to the customer.

A first set of one or more items from a first customer order may be reassigned to a second customer order in cases where the first set of one or more items are needed quickly (e.g., for any reason), such as in a case that a second customer is at/near the store picking up the second customer order or in the case the second customer order is needed immediately for delivery. In some cases, the first set of items may not be immediately needed for the first customer order. For example, the second customer order may be higher priority than the first customer order for a variety of reasons. In one example, the first customer may not be due for pickup or delivery for greater than a threshold period of time, while the second customer order may be needed immediately. In cases where the first set of items are needed more immediately for the second customer order, reassigning the items to the second customer order may provide the second customer with customer satisfaction because of the timely pickup/delivery, while the first customer may not be aware of the item reassignment, as the first customer order may not be delayed (or only slightly delayed) for pickup/delivery.

A first set of one or more items from a first customer order may also be reassigned to a second customer order in cases where reassignment may be more efficient for the users. For example, if an item in the packing area can be taken from a first customer order to quickly finish a second customer order and the reassigned item can repicked and repacked efficiently (e.g., on an existing route), the CCS may instruct a packer to move the item from the first customer order to the second customer order. In this example, the CCS may also instruct a picker to repick the item and replace it in the first customer order (e.g., in the packing area). In some scenarios, when an item has been canceled for a first order (e.g., the customer cancels the item/order), the CCS/MSDs may instruct a user to pull the canceled item from the first order and use it in a second order. Although items may be transferred between customer orders in order to satisfy immediately needed items for customer orders and/or to increase efficiency, items may be reassigned to a different customer order for other reasons.

In some implementations, the CCS/MSDs may implement customer order transfer logic/conditions (“order transfer logic/conditions”) that determine whether to reassign an item from a first customer order to a second customer order. For example, if customer order transfer conditions are satisfied, the CCS/MSDs may instruct a user to transfer an item from a first customer order to a second customer order. The order transfer logic/conditions may include a variety of logic (e.g., triggers, rules, etc.) and conditions, which may be tailored for different stores. As described herein, the order transfer logic/conditions may be tailored to ensure that items are efficiently provided to customers while also minimizing the burden on the users.

The CCS/MSDs may implement a variety of order transfer logic/conditions that may include, but are not limited to, triggering conditions, customer conditions (e.g., customer location, arrival time, wait time, etc.), item conditions (e.g., time to replace the item, location of the item, etc.), and/or other conditions. In some implementations, the decision of whether to use an item from one customer order for another customer order may be subject to initial triggering conditions that may trigger the CCS/MSDs to determine whether to transfer the item. For example, the determination of whether to transfer an item between customer orders may be triggered by a manual request made by a user, manual request made by a customer, and/or an automatic decision made by the CCS/MSDs.

In some implementations, the decision of whether to transfer an item between customer orders may be triggered by a manual request by a customer (e.g., in the customer application), such as a requested rush item (e.g., a new rush order, a missing item from an order that was provided to them, etc.), a replacement item (e.g., for an incorrect item, broken item, etc.), or for another reason. In some implementations, the decision of whether to transfer an item between customer orders may be triggered by a manual request made by a user (e.g., a store employee using an MSD or other computing device), such as a user that is providing an order to a customer (e.g., at the store and/or delivery location). In these cases, the user may indicate the need for an item for any reason, such as a replacement item (e.g., for a broken/damaged item, bad fruit/vegetable selection, etc.), missing item, or for any other reason. In some implementations, the decision of whether to transfer an item between customer orders may be triggered automatically by the CCS/MSDs. For example, the CCS/MSDs may need an item for any reason, such as an item that is needed to complete a customer order for a customer that is almost at the store to pick up the order or already waiting at the store (e.g., waiting for any amount of time or greater than a defined threshold wait time). Additionally, or alternatively, the determination of whether to transfer an item between customer orders may be triggered for high priority items or any other reasons described herein for prioritizing picking, packing, and/or delivery.

In some implementations, the CCS/MSDs may determine that an item should be transferred if one or more order transfer conditions are satisfied. Example transfer conditions may include customer conditions including, but not limited to: 1) the customer receiving the transferred item may be required to be arriving at the store and/or at the store, 2) the customer receiving the transferred item may be required to be waiting for a period of time (e.g., greater than a threshold period of time), 3) the customer having the item taken may not be at the store, waiting for greater than a threshold period of time, and/or arriving soon (e.g., within a threshold period of time), 4) the customer having the item taken should not wait for greater than a threshold period of time as a consequence of item replacement, and/or other conditions associated with the customer wait times.

In some implementations, transfer conditions may include conditions associated with picking the items including, but not limited to: 1) the item should be repicked within a period of time, such as before a customer needs the taken item or the item is needed for delivery, 2) the taken item is not needed for greater than a threshold amount of time, 3) the already picked item should be replaceable by a replacement item by the time the later customer arrives at the store or within a threshold time of arriving, and/or other conditions.

In some implementations, the transfer conditions may be associated with the location of the items (e.g., in the packing area, in the customer area, etc.) and/or the status of the item within the order fulfillment pipeline (e.g., picked, packed, etc.). For example, items that are to be transferred may be required to be located in the packing area (e.g., near a customer pickup location that needs the item). As another example, items that are picked, but not yet in the packing area, may be transferred in the case the item will be available for the customer immediately (e.g., within a threshold period of time). In some implementations, items in customer orders that are ready for customer pickup may not be pulled from the customer order. In other implementations, items in customer orders that are ready for customer pickup may be pulled from the customer order, so long as the items can be replaced.

A variety of order transfer conditions are described herein. An OFS may implement one or more of the order transfer conditions. As such, in some implementations, one or more triggering conditions and/or order transfer conditions may be implemented by an OFS. In implementations using multiple order transfer conditions, the CCS/MSDs may determine whether to transfer items between customer orders based on rules and/or weightings of the different factors. For example, the CCC/MSDs may transfer an item between customer orders if overall customer convenience is maximized (e.g., overall wait times are minimized), such as in a case where a waiting customer has their wait time reduced at the expense of the other customer having a slightly longer wait time. In a specific example, an item may be transferred based on overall customer convenience as calculated based on an increase/reduction in estimated wait time for the waiting customer and the other customer (e.g., one or more goals may be to minimize either customer's estimated wait time and/or overall wait time).

After the CCS makes the determination to transfer an item between customer orders, the CCS may send instructions (e.g., item transfer instructions) to one or more users (e.g., one or more pickers/packers) to perform the item transfer. In some implementations, the instructions may be sent to a single picker. In some implementations, the instructions may be sent to a single packer. In some implementations, instructions may be sent to multiple users, such as 2 pickers, 2 packers, or a picker and a packer. The user(s) may view the instructions on their MSD(s). The instructions may indicate one or more items that should be transferred, current location of the items, the location to which the items should be transferred, as well as the customer orders associated with the items. Example item transfer scenarios and instructions including one or more users are described herein.

The users may follow through with the instructions and scan items to indicate that the items have been transferred. For example, a user that transfers an item may scan the item to indicate the item is being transferred. The user(s) may also scan one or more locations to indicate where the item is taken from and where the item is being placed. The CCS/MSDs may coordinate the instructions so that the transfer is performed efficiently. For example, the MSDs may indicate to the users that they are performing an item transfer in order to give the user(s) context as to why the item is being moved. As another example, to provide context, the MSDs may indicate to the users that are handling replacement of a moved item that they are replacing an item that was taken for an item transfer. The timing for instructions related to an item transfer may vary, depending on the scenario.

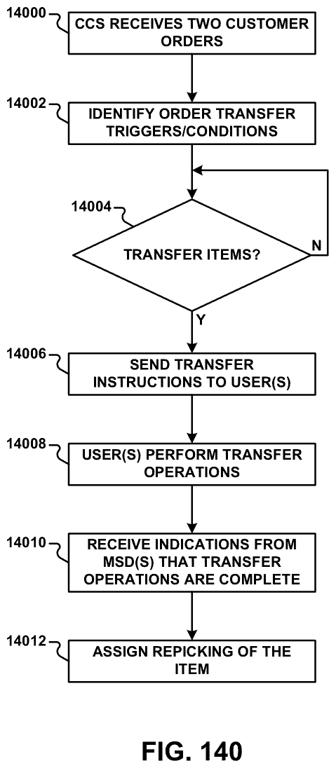

FIG. 140 illustrates a method that describes example operations for transferring items between customer orders. In block 14000, the CCS receives two customer orders. In block 14002, the CCS identifies order transfer conditions/triggers. For example, the CCS may receive a manual request from a customer or user that triggers the determination of various order transfer conditions. In block 14004, the CCS determines whether transfer conditions are satisfied. If transfer conditions are satisfied, the CCS may send transfer instructions to one or more users that instruct the users (e.g., in an MSD GUI) to perform a transfer of one or more items between the two customer orders in block 14006. In block 14008, the instructed user(s) perform the item transfer operations. In block 14010, the CCS receives data from one or more user MSD(s) indicating that the transfer operations are complete. In some implementations, the user(s) may scan items/locations to indicate that items are being transferred. In some implementations, the user(s) may manually indicate (e.g., in an MSD GUI) that the transfer operations are being performed and/or have been performed. In block 14012, the CCS assigns repicking and packing of the item (e.g., by sending item replacement instructions) to one or more users (e.g., any of the one or more available users). In some cases, if a user performing the transfer is still close to the item, the CCS may instruct the same user to repick the item.

Items may be transferred between customer orders in a variety of scenarios. In some implementations, an item may be transferred between customer orders after the item is picked, but before the item is placed in the packing area. In one example, the CCS may instruct a picker that has picked an item for a first customer order to place the item in a different location in the packing area because the item has been transferred to a second customer order. In this example, the picker may remove the item from the initial carrier(s) used for the first customer order and place the item in a location for use in the second customer order. In some cases, the picker may present the item directly to the customer that placed the second customer order. The CCS may assign the item to be repicked for the first customer order to the original picker or a different picker according to the techniques described herein.

In another example, the CCS may instruct a picker that has picked an item for a first customer to place the item in a different carrier being used by the picker. In this example, the picker may have an additional one or more carriers that may be used for additional items or less common scenarios, such as an item transfer scenario. In the case a picker is picking both customer orders included in the item transfer, the picker may transfer the item from a first carrier for a first customer order to a second carrier for a second customer order.

In another example, the CCS may instruct a picker that has picked an item for a first customer order to hand the item over to another user (e.g., another picker) for use in a second customer order. In this example, the other user may take the item to the packing area, pack the item, and/or present the item to the customer. In this example, the CCS may provide instructions to the other user to acquire the item from the initial picker. The CCS may instruct the users to perform the handoff in any location in the store. The handoff may be between the users and/or use a location in the customer area as a drop-off location. The handoff may occur while the user is still picking the first customer order or after the picker is done picking the first customer order.

In some implementations, an item may be transferred between customer orders after the item has been picked and placed in the packing area. In one example, the CCS may instruct a user (e.g., a packer) to pull the item from the current location and place the item in a different location (e.g., a different rack, carrier, etc.) for the other customer order. In some cases, the CCS may instruct the user to hand the item directly to the customer. The transfer may occur any time after the item is in the packing area, even in cases where the item has been packed and is ready for customer pickup.

In some implementations, the CCS/MSDs may instruct the users regarding the transfer of items from one customer order to another, as well as detect the transfer based on item scans or other user inputs. In some implementations, some operations associated with item transfers from one customer order to another may be completed by users and then submitted to the CCS/MSDs (e.g., in an MSD GUI interface). For example, a first user that needs a first item for a first customer order may request that a second user provide the first item from a second customer order (e.g., make a verbal request). In this example, the first user and/or second user may submit the transaction to the CCS (e.g., via an MSD GUI using user input buttons that indicate the transfer to the CCS). In another example, a user may pull an item from the packing area (e.g., before/after the item is packed) and then report to the CCS that the item has been pulled (e.g., via an MSD GUI using user input buttons to indicate to the CCS that the item has been taken). In another example, a user may pull an item from a picker for use in another customer order, which may be reported by either user (e.g., in an MSD GUI). In this manner, some item transfers may be completed by users and then reported to the CCS for additional handling operations. For example, after an item has been reported as pulled from a first customer order for a second customer order, the CCS may assign repicking of the transferred item to another picker. The CCS/MSDs may provide a plurality of different item transfer interfaces for the different item transfer scenarios described herein.

In some implementations, the CCS/MSDs may prioritize the item that is transferred based on various considerations. For example, if multiple options are available for pulling an item, the CCS/MSDs may prioritize the items based on the following one or more factors. In some implementations, the CCS/MSDs may pull items from orders that are not due for pickup (e.g., customer/driver pickup) for greater than a threshold time, which may allow time to replace the item. In some implementations, the CCS/MSDs may pull items based on location (e.g., items may be pulled close to a customer pickup/delivery location, such as a packing area location, when the item is needed quickly). In some implementations, the CCS/MSDs may pull items based on their place in the order filling pipeline. For example, the CCS/MSDs may prioritize pulling items that are not yet packed and/or otherwise ready for customer pickup/delivery.

Although the CCS may reassign an item to a different customer order after the item is picked, in some implementations, the CCS may transition an item from one customer order to another customer order before the item is picked. Although the CCS may reassign items to different customer orders during picking and/or packing, in some implementations, the CCS may transition an item from one customer order to another customer order during delivery.

In some implementations, items may be stocked in a store in areas other than the customer area of the store. Areas inside/outside of the store other than the customer area that are used to stock items may be referred to herein as “alternative stocking areas.” The alternative stocking areas may include designated floor space, designated racks (“alternative stocking racks”), and/or designated rooms/buildings in the packing area or in separate portions of the store. For example, the packing area may include open floor space (e.g., for items/pallets), racks, rooms, or other features that are used to stock items. In some cases, alternative stocking areas may be temperature controlled (e.g., cooled, frozen, and/or heated). For example, alternative stocking areas may include coolers, freezers, and/or heaters. Alternative stocking areas may also be located outside in covered or uncovered areas. The items in the alternative stocking areas may be referred to as “alternatively stocked items.” The alternative stocking area(s) may include alternative stocking locations in a manner similar to other customer areas described herein. Additionally, alternatively stocked items may be associated with the one or more locations in a manner similar to other customer areas described herein (e.g., using location indicators or other mapping technology described herein).

In some cases, the alternatively stocked items may be items that are also stocked in the customer area. In these cases, the alternatively stocked items may be used to restock/resupply the items in the customer area. Such alternatively stocked items may be referred to as “backstock items” in some cases. In some cases, alternatively stocked items may be exclusively stocked in the alternative stocking areas, such that the items are not available in the customer area (e.g., only available to users fulfilling orders for delivery or pickup).

Other alternatively stocked items may include, but are not limited to, canceled items, returned items, items to be restocked, unique items, and predicted items. Canceled items may refer to items that were canceled by the customer after the items were picked and/or packed. The canceled items may be stored in one or more canceled item areas. Returned items may refer to items that customers returned to the store after receiving the item via pickup and/or delivery. The returned items may be stored in one or more returned item areas. Items to be restocked (“restock items”) may refer to any items that were canceled, returned, or otherwise pulled from their usually stocked location. The CCS may instruct users to restock the items in one or more of the original locations. Restock items may be stored in one or more restock item areas, such as a first area at which customers return items (e.g., a customer return location in the front of the store near a customer entry), a second area in which canceled items are located, and/or another location for collecting restock items. Unique items (e.g., customer-specific items) may refer to items that are not usually stocked in the store. Instead, the unique (e.g., customer-specific) items may be ordered by the customers for pickup/delivery from the store. For example, the unique items may be ordered from the store shopping application/website or from another party (e.g., another retailer) for distribution by the store via customer pickup/delivery. The unique items may be stored in a unique item area or a customer-specific item area. Predicted items may refer to items that the CCS/MSDs predict will be used to fulfill a future customer order. The predicted items may not be currently needed to fill a current customer order. Predicted items may be stored in a predicted item area.

Different stores may implement alternative stocking areas and alternatively stocked items in different manners. In some implementations, a store may include a single alternative stocking area that stocks a variety of different alternatively stocked items. In these implementations, the store may not differentiate between different areas for alternatively stocked items but may still track the type of alternatively stocked item (e.g., canceled item, predicted item, etc.) included in the single alternative stocking area. In some implementations, a store may include a plurality of different alternative stocking areas that each include one or more types of alternatively stocked items.

As described herein, the CCS/MSDs may track the location of items in the store for use in generating maps and picking items. The CCS/MSDs may also determine the location of alternatively stocked items in the store. In some implementations, the CCS/MSDs may generate maps that indicate the location of alternative stocking areas. The CCS/MSDs may use the locations of alternative stocking areas and alternatively stocked items during picking and packing in order to increase picking and packing efficiency. The different user GUIs described herein (e.g., picking GUIs and packing GUIs) may indicate associated alternative stocking areas and alternatively stocked items to the users. For example, the GUIs may indicate to pickers that the items to be picked are alternatively stocked items that should be picked from alternative stocking areas. As another example, the GUIs may indicate to packers that items to be packed are alternatively stocked items from alternatively stocked areas. Any of the user GUIs described herein may indicate the status of the items as alternatively stocked items. Additionally, any of the user GUIs described herein may indicate item locations as alternative stocking areas. Indicating, in the GUIS, that items are alternatively stocked items for alternatively stocked areas may help provide context to the user regarding the nature of their tasks (e.g., that the user is picking predicted items for potential upcoming customer orders).

As described herein, the CCS/MSDs may determine the current locations of items in alternative stocking areas. For example, item scans may be used to indicate the placement/removal of items from alternative stocking areas. Additionally, or alternatively, the store may be instrumented to detect the placement and removal of items from locations. In some cases, a user may manually indicate (e.g., in a GUI) the locations of alternatively stocked items (e.g., when placing the items or performing inventory tasks). As such, the CCS/MSDs may have knowledge of the alternatively stocked items in the alternative stocking areas.

The stores may arrange the alternative stocking area locations so that their associated alternatively stocked items provide increased picking and packing efficiency. For example, the alternative stocking areas, such as the predicted item areas, may be located near customer pickup/delivery locations so that the items may be used efficiently to fulfill customer orders. As another example, a canceled item area may be located in the packing area so that the canceled items may be quickly removed from picked/packed orders and placed in the canceled item area. The canceled items may also be efficiently put into another future customer order from the canceled item area. The alternatively stocked items may be picked/packed for any of the reasons described herein, such as for typical orders, item substitutions, and/or urgently needed items. In some implementations, the CCS/MSDs may instruct the users to move items between the different areas (e.g., between the customer area and/or alternative stocking areas), as described herein.

In some implementations, the users may opt into or opt out of picking/packing alternative items (e.g., predicted items). In some implementations, users may request to pick alternative items. In some implementations, users may be prompted in GUIs to indicate whether they are available to pick/pack alternative items.

As described herein, a customer order may be picked at different times by the same picker or different pickers. In some implementations, the CCS/MSDs may request that pickers pick a customer order at different times. For example, a first picker may pick a first portion of a customer order before a second portion of the customer order is picked (e.g., by the same or different picker). Picking the first portion of the customer order earlier than the second portion may optimize the use of employees by having a currently available employee pick instead of being unproductive. Additionally, picking the first portion earlier than the second portion may help ensure timely order fulfillment by reducing the number of items that need picking for customer pickup at a later time.

The CCS/MSDs may determine that an order should be picked at different times based on a variety of factors/triggers. In some implementations, the CCS/MSDs may instruct users to pick a first portion of a customer order earlier than the remaining portion of the customer order based on location availability (e.g., available room in the packing area). Location availability may include current availability (e.g., if there is enough room currently in the packing area). Location availability may also include future availability determinations, such as whether there will be enough space in the packing area for the duration of holding the first portion of the customer order. With respect to future location availability, the CCS/MSDs may determine whether the packing area has enough space to hold current orders and future orders (e.g., placed orders and estimated orders) before the customer order is completed and provided to the customer. Location availability may be determined in a variety of ways. For example, the CCS/MSDs determine location availability based on the total space in the packing area, the total amount of determined space occupied by items (e.g., based on knowledge of item placements), and/or an estimated amount of space occupied by current/future items. Location availability may be determined in terms of a number of cart corrals, a number of racks, a number of shelves on racks, available floorspace, shelf area, and/or using other metrics associated with the various racks and areas described herein.

In some implementations, the CCS/MSDs may instruct users to pick a first portion of a customer order earlier than the remaining portion of the customer order based on picker availability. In some implementations, picker availability may trigger assignment of a customer order (e.g., a portion of a customer order) to the available picker(s). In these implementations, available pickers may be optimally used at the current time in order to conserve future picking resources. In some implementations, if the CCS/MSDs determine that there may be low picker availability in the future, the CCS/MSDs may instruct current pickers to pick a first portion of a customer order earlier than the remaining order, or instruct current pickers to pick the entire customer order.

In some implementations, the CCS/MSDs may instruct users to pick a first portion of a customer order earlier than the remaining portion of the customer order subject to timing considerations. For example, the CCS/MSDs may limit picking based on an estimated amount of time between picking the first portion of the customer order and the remaining portion of the customer order. In a specific example, the CCS/MSDs may be limited to picking the first portion of the customer order within a threshold period of time before the second portion. For example, the CCS/MSDs may restrict picking of the first portion of the customer order if it will be picked too early in advance of the second portion (e.g., greater than a threshold number of hours, days, etc.) based on picker availability.

In some implementations, the CCS/MSDs may instruct users to pick a first portion of a customer order earlier than the remaining portion of the customer order based on order size. For example, the CCS/MSDs may instruct users to pick the first portion of a customer order earlier than a second portion based on the size of the customer order. The size of the customer order may be determined based on a number of items in the customer order, total volume of items in the customer order, total weight of items in the customer order, a number of carriers to be used for the customer order, and/or other factors. In some implementations, the size of the customer order may be determined based on estimated picking time, where a first portion of the customer order may be picked before a second portion when the estimated picking time for the customer order is greater than a threshold time. In these implementations, breaking the customer order up into two separate portions for picking may make picking more manageable for the second portion that may be picked nearer to customer pickup/delivery time).

In some implementations, the CCS/MSDs may instruct users to pick a first portion of a customer order earlier than the remaining portion of the customer order subject to item type considerations. For example, the CCS/MSDs may limit picking based on the types of items being picked. In a specific example, the CCS/MSDs may limit picking to items that may be stored properly in the packing area, such as items that do not require temperature controls (e.g., cooling, freezing, heating, etc.). The CCS/MSDs may allow early picking for temperature controlled items in the case there is current/future packing area space that may properly hold the temperature controlled items.

The MSD GUIs may provide context to the users regarding staggered picking of customer orders. For example, the MSD GUIs may indicate to the pickers and packers that they are picking/packing a first portion of a customer order that will be completed at a later time (e.g., a GUI may indicate that the customer order is an “Order portion-early picking”). As another example, the MSD GUIs may indicate to the pickers and packers that they are picking/packing subsequent portions of a customer order (e.g., a second portion) that will be combined with an already picked/packed first portion (e.g., “Order portion—to be combined”).

Although staggering picking of customer order portions may be based on factors such as location availability, picker availability, timing considerations, order size, estimated picking time, and item type considerations, staggered picking may be based on other factors. In some implementations, the CCS/MSDs may perform multi-factor determinations based on rules, triggering criteria, weightings, and/or other algorithms to determine whether to pick an order in a staggered manner.

As described herein, in some implementations, the store may include a backstock area that includes backstock items. Backstock items (e.g., in one or more backstock areas) may include items that are used to replenish items in the customer area. In some cases, the same items included in a backstock area may also be included in a customer area. In these cases, the items may be associated with two separate locations. In some cases, if items are sold out in the customer area, the items may only be associated with the backstock location. In some cases, when the backstock is empty, some items that may have been associated with the backstock location and the customer area location may only be associated with a single customer area location.

The CCS/MSDs may pick items from the backstock locations in a similar manner as other locations. For example, the CCS/MSDs may be configured to select locations to pick items (e.g., two-location items) in a manner that is most efficient (e.g., minimizes distance, maximizes picking rate, etc.). In some implementations, the CCS/MSDs may implement preferred locations for two-location items, such as backstock items. For example, in some implementations, the CCS/MSDs may preferentially pick from backstock instead of customer area stock in order to maintain maximum inventory in the customer area. In some implementations, users may be instructed in MSD GUIs to move backstock items into the customer area location, such as when the inventory in the customer area is less than a threshold number of items.

The MSD picking/packing GUIs may indicate whether items are included in the backstock area. For example, the MSD GUIs may differentiate alternative stocking areas (e.g., backstock areas) using text (e.g., category/item labels), GUI element colors, font color, font size, etc. In a specific example, the MSD GUI may indicate that one or more items are included in a backstock area using text next to the item(s).

As described herein, alternative stocking areas may include canceled items, returned items, and/or restock items. The alternative areas associated with canceled items, returned, items, and/or restock items may be located in areas that increase efficiency for customers and other users. For example, a canceled item area may be located in the packing area where canceled items may be pulled from carriers and efficiently placed into the nearby canceled item area. As another example, returned items may be located in one or more locations where customers may return items in the store. In a specific example, a returned items area may be located at the front of the store where customers return their items. A restock area including items that will be restocked may be located in any area that makes restocking more efficient. In some cases, a separate restock area (e.g., a single restock area) may be used to collect items to be restocked, such as canceled items and returned items. In other cases, a store may not include a specific restock area outside of the canceled item area(s) and the returned item area(s). In some implementations, a store may include a third party canceled item area for collecting items that were canceled from third party orders. The third party canceled items may be in the same location as other canceled items or may be in an area that is more convenient for third party users to place the items (e.g., near a third party pickup location).

The CCS/MSDs may pick items from the canceled items, returned items, and/or the restock items in a similar manner as other locations. For example, the CCS/MSDs may be configured to select locations to pick items in a manner that is most efficient (e.g., minimize distance, maximize picking rate, etc.). In some implementations, the CCS/MSDs may implement preferred locations for canceled items, returned items, and/or restock items. For example, in some implementations, the CCS/MSDs may preferentially pick from canceled items, returned items, and/or restock items instead of customer area stock in order to maintain maximum inventory in the customer area and minimize the handling of canceled items, returned items, and/or restock items.

The MSD picking/packing GUIs may indicate whether items are included in the canceled items area, returned items area, and/or the restock area. For example, the MSD GUIs may differentiate the areas/items using text (e.g., category/item labels), GUI element colors, font color, font size, etc. In a specific example, the MSD GUI may indicate that one or more items are included in a canceled item area using text next to the item(s) (e.g., text indicating “Items are in Canceled Item Area”).

As described herein, in some implementations, the store may have a unique item area that may include items that are not usually stocked in the store. The unique items (e.g., customer-specific items) may be ordered by the customers for pickup/delivery from the store. In some cases, the items may be ordered from the shopping application for delivery to the store. In some cases, the unique items may be provided to the store via the store's own distribution system (e.g., via a delivery truck operated by the store). In some cases, the items may be ordered from another party other than the store (e.g., another business), such as when the items are not available to be purchased from the shopping application. Unique items not available for purchase via the store shopping application may be provided to the store directly or through the store's distribution system by another delivery party (e.g., United Parcel Service, FedEx, or other delivery service). The MSD picking/packing GUIs may indicate whether items are included in the unique item area.

As described herein, the store may include a predicted item area that includes predicted items that may be picked in anticipation of using the predicted items in a future customer order. The predicted items may refer to items that are picked to fulfill potential future customer orders. Put another way, the predicted items may be items that the CCS/MSDs anticipate will be used to fulfill a future customer order. Although a predicted item may not be needed to fulfill a current customer order, the CCS/MSDs may instruct a user to pick a predicted item for a variety of reasons described herein. The predicted items area may be in a location that provides convenience for later picking, packing, and/or delivery when a customer does order the items. For example, the predicted items area may be located in the packing area, such that the predicted items may be quickly picked and packed (e.g., as a complete order or as part of another order). Although predicted items may be placed into a predicted item area for later usage, in some cases, a customer may order the predicted item during picking. In this case, the predicted item may be placed in the packing area as part of the customer order (e.g., along with other items).

Predictively picking items may provide a variety of efficiency benefits. For example, items in the predictive picking area, such as commonly ordered items, may be easy to pick and integrate into customer orders. In some cases, predicted items may be used to satisfy a customer that urgently needs the predicted item (e.g., to complete an order).

The CCS/MSDs may instruct pickers to pick predicted items based on a variety of factors. The various factors that may cause predictive picking may be referred to herein as “predictive item picking conditions.” If predictive item picking conditions are satisfied, the CCS/MSDs may instruct pickers to pick one or more predicted items. The pickers may be instructed to place the predicted items in the predicted items area.

In some implementations, the CCS/MSDs may instruct a picker to pick predictive items based on the satisfaction of popularity conditions associated with the items. For example, the CCS/MSDs may instruct a picker to pick a predictive item if the item has greater than a threshold level of popularity. Popularity may be determined based on the order volume associated with the item, such as a total number of times the item was ordered, a number of times the item was ordered over a defined period of time (e.g., over a matter of hours, days, or weeks), a number of different customers that have ordered the item, and/or other popularity metrics. Different popularity metrics may be specified for different times of day, days of the week, holidays, days with local events (e.g., sporting events), and/or other time frames. The CCS/MSDs may implement one or more popularity metrics as predictive item picking conditions.

In some implementations, the CCS/MSDs may determine popularity metrics associated with items based on all customer orders (e.g., for the entire store or for multiple stores) or subsets of orders (e.g., online orders). In some implementations, the CCS/MSDs may determine popularity metrics associated with a selected subset of customers, such as recent customers (e.g., customers within the last week, month, year, etc.), more frequent customers (e.g., customers that have shopped multiple times within a threshold amount of time), and/or more consistent customers (e.g., customers that frequently order the same items).

In some implementations, the CCS/MSDs may determine popularity metrics associated with a set of customers that have upcoming pickup/delivery orders (e.g., within minutes, hours, days, or other time frames). For example, the CCS/MSDs may determine popularity of items (e.g., sales numbers over time) for customers that will be arriving at the store within a threshold period of time for pickup. As another example, the CCS/MSDs may determine the popularity of items for customers that will have their order delivered (e.g., leaving the store) within a threshold period of time. If there are items that have greater than a threshold level of popularity (e.g., greater than a threshold number of past purchases or rate of purchases within the set of customers), the CCS/MSDs may instruct pickers to pick the predicted items. Predictive picking of items that are commonly ordered (e.g., number of items ordered over time, per order, etc.) by upcoming customers may help the store to prepare for the scenario a customer may like to add the item to their shopping cart at the last minute (e.g., just before arrival at the store or while waiting at the store). Predictively picking these items may also allow a recommendation system or advertisement system to advertise the items to the upcoming customers with the knowledge that the items can be easily provided at the last minute.

Although the CCS/MSDs may determine whether to instruct pickers to predictively pick items based on a plurality of customers, in some implementations, the CCS/MSDs may predictively pick items based on order history associated with a single customer. For example, the CCS/MSDs may instruct a picker to predictively pick an item that is commonly ordered by a single customer that may arrive at the store within a threshold period of time to pick up a customer order. As another example, the CCS/MSDs may instruct a picker to predictively pick an item that is commonly ordered by a single customer that may have their ordered delivered within a threshold period of time (e.g., a driver may leave the store within a threshold period of time to deliver the order).

In some implementations, the CCS/MSDs may instruct users to predictively pick items based on items that are currently associated with the customers but not yet included in a customer order to be picked. Example items that may be currently associated with a customer may include, but are not limited to, items in a customer's online shopping cart for an order that is not yet placed (e.g., hasn't been paid for or submitted), items in a customer's shopping list in the shopping application (e.g., items the customer intends to reference when shopping in the future in the store or at home), items in a customer wish list (e.g., items a customer is considering buying), and/or items in any other list associated with the customer. The items associated with the customer, but not yet purchased, may indicate items that the customer wants to purchase in the future because the customer has taken action in the shopping application to add the items to a list for future reference/purchase. The CCS/MSDs may instruct users to predictively pick items currently associated with customers, but not yet included in a customer order to be picked, based on the number of items currently associated with customers (e.g., a total number of items across the customers), the number of customers that have the items included in their lists, and/or other factors. For example, the CCS/MSDs may instruct a picker to predictively pick an item if greater than a threshold number of items are included in lists and/or greater than a threshold number of customers have the item included in their lists. In some implementations, the CCS/MSDs may take into account all customers that may place an order at the store. In some implementations, the CCS/MSDs may take into account a subset of customers that will arrive at the store within a threshold period of time or receive delivery of a customer order within a threshold period of time.

In some implementations, predictive picking may be subject to constraints. For example, the CCS/MSDs may restrain predictive picking subject to picker availability and/or picker convenience considerations. With respect to picker availability, the CCS/MSDs may require that pickers have available space in their carriers (e.g., pickers may be required to have empty carriers and/or predicted-item specific carriers) and/or have a sufficient amount of time to spend picking predicted items (e.g., refrain from predictive picking if the picker is picking a rush order or can't meet a schedule). In some implementations, the CCS/MSDS may be configured to assign predicted items to users that are not currently performing tasks. In some implementations, the CCS/MSDs may be configured to assign predicted items to a picker that are located on/near the picker's route. In these implementations, assigning items on/near a picker's location/route (e.g., within a threshold distance) may maximize the use of the picker at the present time and minimize any future inconvenience associated with picking the item for a future order.

In some implementations, the CCS/MSDs may restrain predictive picking subject to predetermined numbers of items that should be maintained in the predicted item area. For example, the CCS/MSDs may be configured to maintain a threshold number of items in the predicted item area by instructing pickers to pick predicted items when the number of items in the predicted item area reaches a threshold value or drops below a threshold value. In some implementations, the CCS/MSDs may instruct a picker to replace items in the predicted item area as the items are removed from the predicted item area for customer orders.

In some implementations, the CCS/MSDs may restrain predictive picking subject to predetermined numbers of items that should be maintained in the customer area of the store. For example, the CCS/MSDs may be configured to maintain a minimum threshold number of items in the customer area by refraining from picking predicted items from the customer area if the number of items is less than a threshold number. In some implementations, the CCS/MSDs may take into account numbers of items in the predicted item area and the customer area to determine whether to perform predictive picking. For example, the CCS/MSDs may be configured to maintain a target ratio (e.g., min, max, or optimal ratio) of items in the predicted item area relative to the customer area. The predetermined numbers and/or ratios of items used to determine whether to predictively pick items may be set on a per-item basis (e.g., by an operator of the store).

Customers may place orders that include some items that may be out of stock at the time of picking the customer order. When items are out of stock during picking, the customer may be prompted in the shopping application/website to select one or more substitution items. For example, the picker may recommend items for substitutions and/or the CCS/MSDs may recommend items for substitution. In some cases, the customer may accept the substitution items (e.g., in the shopping application/website). In these cases, users may pick and pack the accepted substitution items.

In some implementations, the CCS/MSDs may instruct pickers to pick one or more predicted items as possible substitutions for an unstocked (e.g., out-of-stock) ordered item. In some implementations, a picker may pick the predictive item(s) as possible substitution items while picking the customer order (e.g., the CCS/MSDs may instruct the picker to pick the substitutes on the route). Picking substitutions while on the route may save the picker time instead of waiting for a customer approval of one or more suggested substitute items. In some implementations, the CCS/MSDs may instruct one or more other pickers to predictively pick substitute items as they pass by the items. Having substitute items predictively picked may allow a customer to approve substitute items nearer to pickup/delivery time and also minimize the inconvenience of a last minute pick to one or more pickers.

The CCS and/or customer application may determine which substitute items to recommend to a customer in a variety of ways. In some implementations, the CCS and/or customer application may recommend substitute items in the customer application that are smaller/larger versions of the same item. In some implementations, the CCS and/or customer application may recommend substitute items that are similar to the out-of-stock item(s) (e.g., similar types of food/drink products). In some implementations, the CCS and/or customer application may recommend substitute items that were previously accepted by the customer placing the order and/or another customer. In some implementations, the CCS and/or customer application may have a list of one or more potential substitutions to propose for each item.

The CCS/MSDs may determine which substitution items to predictively pick based on a variety of factors. Initially, if an item is out of stock, the CCS/MSDs may determine a set of one or more possible substitution items for the out-of-stock item (e.g., using any known substitute item identification technique). The CCS/MSDs may then determine whether to predictively pick the one or more possible substitute items based on the factors described herein. In some implementations, the CCS/MSDs may instruct a user to predictively pick items based on popularity of the items, such as the most commonly purchased items for the customer and/or an aggregate of customers (e.g., most commonly purchased one of the possible substitute items). In some implementations, the CCS/MSDs may instruct a user to predictively pick a substitute item if the customer has agreed to substitute the item in the past (e.g., in one or more previous customer orders). In some implementations, the CCS/MSDs may instruct a user to predictively pick a substitute item if other customers have agreed to substitute the item in the past.

In some implementations, the CCS/MSDs may pick a best item (e.g., most popular, most purchased by the customer, etc.). In some implementations, the CCS/MSDs may pick a plurality of the possible substitute items (e.g., the most popular items, most purchased items by the customer, etc.). In some cases, the CCS/MSDs may instruct a user to pick all the substitute items if the items are sufficiently popular to be likely purchased by the customer or other customers within a threshold period of time.

The MSD GUIs may indicate to the pickers/packers that the items being picked are predictive substitute items (e.g., using text, colors, font size, or other GUI indication) in order to provide context to the pickers/packers. In some implementations, the pickers may be instructed to place the items in specific carriers (e.g., predicted substitute carriers) so that the items are easily recognizable as predictively picked items during picking/packing. In some implementations, the store may include an alternative stocking location for predictive substitute items.

Although store employees may predictively pick items for store orders, in some implementations, the store employees may also predictively pick items for third parties (e.g., third party pickers, packers, and/or delivery drivers). Additionally, third parties may predictively pick items for the store. Stores and third parties may predictively pick for themselves or one another for any of the reasons described herein. Third parties and stores may share data with one another to accomplish the predictive picking described herein. In some cases, the third parties may use the same alternative stocking areas as the store employees. In some cases, the third parties may have different alternative stocking areas.

As described herein, stocked items may be stocked in one or more locations. For example, in some cases, some stocked items may be stocked only in the customer area. In another example, in some cases, some stocked items may only be stocked in an area other than the customer area (e.g., in a backstock area). In another example, some items may be stocked in both the customer area and an alternative area (e.g., a backstock area). In some cases, stocked items may be located in dynamic locations. For example, customer canceled items or returned items may be stocked temporarily in a canceled/returned items area. In this example, the customer canceled items may be moved from the temporary area back to a typical stocking area (e.g., a customer area) or sold to a customer. Items may also be moved between locations (e.g., between a customer area and other alternative locations).

The CCS/MSDs may track items and their one or more associated locations as described herein. The CCS/MSDs may instruct the users to pick, pack, and deliver items associated with one or more locations as described herein (e.g., based on item location relative to a picker). The CCS/MSDs may generate routes for picking items associated with multiple locations in various ways. In some implementations, the CCS/MSDs may generate routes that minimize travel distance and/or picking time for a picker. In some implementations, the CCS/MSDs may implement rules for picking items that are included in multiple locations. For example, the CCS/MSDs may prioritize picking from one or more locations. In a specific example, the CCS/MSDs may prioritize picking from the canceled/returned items area before the customer area in order to eliminate the need for restocking items. In another example, the CCS may prioritize picking backstock items (e.g., backstock near a customer pickup/delivery location) so that the items in the customer area remain in stock for customer selection while shopping in the store. The CCS/MSDs may take into account any one or more of the multiple factors described herein when generating picking instructions (e.g., picking routes) for picking items in multiple locations.

In some implementations, items for a user to purchase in the shopping application/website for a store may be inserted into the shopping application or other locations (e.g., other applications/websites) as recommended items or advertised items. For example, recommended/advertised items may be inserted into the shopping application in a picking list generated by the user or as an overlay in the shopping application. Recommendations/advertisements may include, but are not limited to, links (e.g., hyperlinks), user-selectable banners (e.g., including text and/or images), videos (e.g., user selectable videos), and/or using other GUI elements. In some implementations, the recommendations/advertisements may include text indicating whether the link is a recommended item or advertised item. In some implementations, recommendations and/or advertisements may be discounted in order to incentivize the customer to add the item to their shopping cart/list.

In some implementations, recommendations/advertisements may be presented to a user as a quick way to add items into their shopping carts. For example, a recommendation/advertisement may be presented in response to the customer travelling to the store to pick up an order, in response to a customer waiting at the store for an order, or in response to a delivery for a customer being ready to be transported to the customer. As described herein, some recommended/advertised items may be presented to a customer based on the ability of a picker to efficiently and quickly pick the item.

In some implementations, the recommendations/advertisements may include a uniform resource identifier (URI), uniform resource locator (URL), and/or other metadata (e.g., item identifier codes) that may add an item to a shopping cart in the shopping application/website in response to user selection. For example, a user may select a recommendation/advertisement link in the shopping application to add the recommended/advertised item to their shopping cart in the shopping application/website. In implementations where the shopping application includes a shopping list (e.g., for the customer to reference during shopping), selection of a recommendation/advertisement link may add the item to their shopping list. In some cases, recommended/advertised item links may also be placed in other applications and websites other than the shopping application/website. In these cases, selecting the recommended/advertised item links on the other applications/websites may add the item to the shopping application cart/list. For example, in these cases, selection of a recommended/advertised item link may cause the shopping application to open and add the item to the shopping application cart/list. In some implementations, the recommendations/advertisements may just be viewable by the customer, but may not be selected by the user in order to add the item to the shopping application cart/list. For example, the recommended/advertised items may be included in a video or other advertisement that may not be selected.

The OFS may include, or be in communication with, a recommendation system and/or an advertisement system that provides the recommendations/advertisements to the customer devices (e.g., directly to the customer devices and/or via the CCS). The recommendation system and/or advertisement system may be operated by the same business entity as the store in some cases. For example, the OFS may include a recommendation system that recommends items to users based on the factors described herein. As another example, the advertisement system may be operated by a business entity that is different than the business entity that operates the store OFS. For example, a company that produces products and/or advertises products may operate an advertisement system that serves advertisements for items to customer devices (e.g., directly to the customer devices and/or via the OFS operated by the store).

The recommendation system may provide recommendations to customers that satisfy recommendation conditions described herein. The advertisement system may provide advertisements to customers that satisfy advertisement conditions described herein. A variety of different recommendation/advertisement conditions are described herein. In some implementations, advertisement conditions may differ from recommendation conditions, depending on the reasons for which the different businesses serve the recommendations/advertisements. For example, advertisement conditions may include conditions associated with financial incentives for showing the advertisements. In one example, advertisements may include a bid price that an advertiser pays to show the advertisement to the customer or cause the purchase of the associated item. The advertisement systems may determine which ads to show based on the amount of the bid price, relevance of the advertisement, and/or other conditions that may provide a beneficial outcome to the store and/or advertiser (e.g., the advertisement system may serve an advertisement that is most likely to cause a sale of the item to a customer).

The recommendations/ads may be served to the customer at different times. In some cases, the recommendations/ads may be shown to the customer while the customer is using the application, such as browsing through items to put together a customer order or customer shopping list. In some cases, the recommendations/ads may be shown while the customer is on the way to the store to pick up a customer order or pick their own items. In some cases, the recommendations/ads may be shown to the customer while the customer is using another application (e.g., other than the shopping application) and/or visiting another website.

The recommendation and advertisement conditions described herein may be similar or different, depending on the implementation of the OFS, recommendation system, and/or the advertisement system (e.g., depending on the system configurations set by the parties that operate the systems). In some cases, this disclosure may refer to a recommendation system that provides recommendations based on the satisfaction of recommendation conditions. In some cases, this disclosure may refer to an advertisement system that provides advertisements based on the satisfaction of advertisement conditions. Features associated with the recommendation system herein (e.g., recommendation conditions) may also be implemented by the advertisement system, and vice versa.

In some implementations, the recommendation system may be configured to recommend items that are located in alternative locations. For example, the recommendation system may be configured to recommend items in alternative locations that can be efficiently picked. In a specific example, the recommendation system may be configured to recommend items to customers that are picking up orders if the items are near a packing area and/or customer pickup location. As another example, the recommendation system may be configured to recommend items to a customer that is receiving a delivery if the items are near the delivery packing location. In some implementations, a store may include a specific advertised items area (e.g., an alternative stocking area in the packing area).

In implementations where the recommendation system is configured to recommend items that are located in an alternative location, the recommendation conditions may specify that a recommended item should be located in an alternative location. A recommendation condition associated with alternative locations may be specified in a variety of ways (e.g., to different levels of location specificity, such as by zone, by alternative location name, GPS, and/or in other manners). In some implementations, a recommendation condition may be satisfied for an item if the item is in a specific alternative location (e.g., a canceled item location, restocking location, predicted picking location, etc.). For example, a recommendation condition may be satisfied for an item if the item is located in a canceled item location. In this example, recommending an item in a canceled item location (e.g., after the item has been pulled from a customer order) may eliminate the need to restock the item into the usual location (e.g., in the customer area or other area of the store). In this example, the canceled item location may be in/near the packing area, as canceled items may be efficiently removed from picked orders.

Any of the one or more alternative locations may be considered by the recommendation system when recommending items to customers. In some implementations, the recommendation conditions may prioritize some alternative locations over other alternative locations (e.g., for efficiency, to prevent spoilage, etc.). For example, the recommendation system may be configured to recommend items in some locations prior to recommending items in other locations. In a specific example, the recommendation system may be configured to recommend items in a canceled item location prior to other alternative locations (e.g., a predicted item location that includes high volume items). In this specific example, the recommendation may promote a sale of an item that otherwise may need to be restocked (e.g., in the item's original location).

The system(s) (e.g., OFS, recommendation system, and/or advertisement system) may recommend/advertise items based on a variety of other recommendation/advertisement conditions (e.g., in addition to, or as alternative to, alternative location conditions described herein). Example additional conditions may include, but are not limited to, expiration date of an item (e.g., close expiration may cause recommendation), whether customers have ordered items before (e.g., recommend/advertise previously purchased items), whether the customer has recently viewed the item in the shopping application or in another application/website, whether the customer currently has the item in an online shopping cart/list, an amount paid by the advertiser for an advertisement, and/or other factors.

The recommendation/advertisement system may serve recommendations/advertisements based on one or more of the various recommendation/advertisement conditions described herein. In some implementations, the recommendation/advertisement system may implement a rules-based algorithm for selecting recommendations/advertisements based on the conditions. In some implementations, the recommendation/advertisement system may prioritize some conditions over other conditions. In some implementations, the recommendation/advertisement system may implement a scoring algorithm to select items to recommend/advertise. Such a scoring algorithm may apply different weights to different conditions. In some implementations, the presence of some conditions may trigger recommendations/advertisements, such as the presence of items in a canceled/restocking area. In some implementations, the recommendation/advertisement system may implement machine learning algorithms (e.g., machine learned models) in the selection of items to recommend/advertise based on a variety of factors (e.g., item location, customer(s) purchase history etc.).

In some implementations, the recommendation/advertisement system may provide recommendations/advertisements for items based on the ability of pickers to efficiently pick the items. In some implementations, the recommendation/advertisement system may take into account the current and/or future location of pickers relative to the items to be recommended/advertised. For example, a recommendation condition may be satisfied if one or more pickers are currently close to an item and/or the item is on/near their picking path (e.g., within a threshold distance of the picking path). In this example, if an item is currently close to a picker and/or on/near the pickers path, the recommendation system may factor in the location of the item relative to one or more pickers when considering whether the item should be recommended. In some cases, the recommendation/advertisement system may be more likely to recommend/advertise items if multiple pickers are in the location of the item or will likely pass near the item in a period of time for which the customer order will be picked. In these cases, items may be more likely to be recommended/advertised when the items are located in a part of the store that will be traversed by multiple pickers, as such items may be more efficiently picked on average relative to other items.

In some implementations, the OFS may be configured to instruct users to pick items in response to determining that the items will be recommended or advertised. For example, the CCS may instruct pickers to pick items that are being recommended/advertised and/or will be recommended/advertised in the near future. In this example, the current and/or future recommendations/advertisements to be generated may trigger the picking of items that otherwise are not included in customer orders (e.g., current or future customer orders at the CCS). The items that are picked based on an upcoming recommendation/advertisement campaign may be placed in a location (e.g., an alternative location) that is convenient to pick when a customer places a customer order including the items for pickup/delivery. For example, the items may be placed in a location near the packing area so that the items can be picked efficiently in response to a likely increase in sales due to recommendations/advertisements. In this example, the CCS may instruct a picker to pick such items, notify the picker that the items are being picked because of current/future recommendations/advertisements, and also instruct the user to place the items into a specific location (e.g., a location for storing recommended/advertised items for efficient order fulfillment).

The store, advertising party, and/or other party may set up a recommendation/advertisement campaign for a variety of reasons. For example, a party that produces products may advertise items in order to increase awareness and sale of the items. As another example, the store may recommend items to increase sales, reduce inventory, and/or prevent items from expiring. The OFS may instruct users to pick items that are being recommended/advertised, or will be recommended/advertised, for any of the reasons described herein, such as additional recommendation/advertisement conditions described herein (e.g., past customer orders, current pending customer orders, customer location, estimated customer arrival time, etc.).

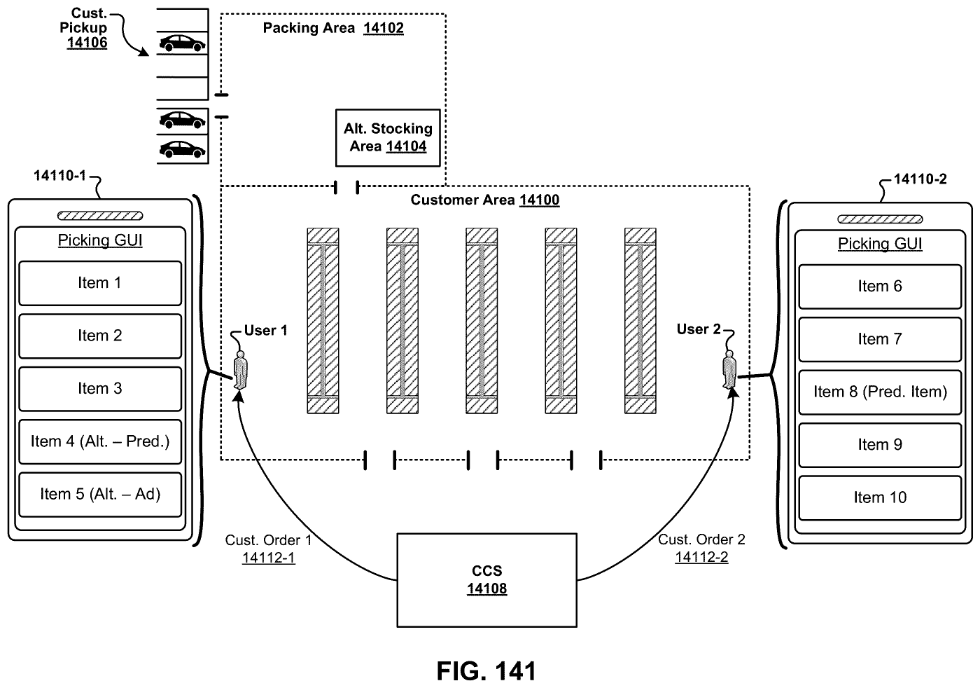

FIG. 141 illustrates a store that includes a customer area 14100 and a packing area 14102. The packing area 14102 includes an alternative stocking area 14104. Note that in the store of FIG. 141, the alternative stocking area is located near the customer pickup area 14106. In this configuration, items that are picked from the alternative stocking area 14104 may be quickly integrated into online customer orders for pickup or delivery (e.g., in the case delivery drivers leave for deliveries from the parking lot in/near the customer pickup area 14106).

In FIG. 141, the CCS 14108 assigns customer orders for picking to two users. A first user, using a first MSD 14110-1, receives customer order 1 14112-1. Items 1-5, which may be the last items to be picked in customer order 1 14112-1, are illustrated in a first picking GUI on first MSD 14110-1. Items 4-5 of customer order 1 are located in the alternative stocking area 14104, as indicated in the first picking GUI (e.g., using text adjacent to the item names). In FIG. 141, the first picking GUI further specifies specific areas/locations in the alternative stocking area 14104 that includes the items. In one example, item 4 is included in a predicted item area/location in the alternative stocking area. In another example, item 5 is included in an advertised item area/location. Note that the customer that placed customer order 1 may have ordered item 5 as a result of viewing/selecting an advertisement or for any other reason. The CCS 14108 may have included items 4-5 in the alternative stocking area 14104 for picking for any of the reasons described herein. For example, including items 4-5 at the end of the route may have been a most efficient route (e.g., fastest route, shortest route, etc.) for picking customer order 1. As another example, the CCS 14108 may have included items 4-5 in the alternative stocking area, as opposed to in the customer area 14100, in order to preserve stock of items 4-5 in the customer area 14100.

In FIG. 141, a second user, using a second MSD 14110-2, receives customer order 2 14112-2. Customer order 2 includes ordered items 6, 7, 9, and 10 for picking. The CCS 14108 has also included predicted item 8 in the picking list for the second user. The CCS 14108 may have included item 8 as a predicted item for any reasons described herein, such as: 1) item 8 may be on/near a route for picking the other items for customer order 2, 2) user 2 may have room in an additional carrier for item 8, 3) item 8 may be a popular item that may benefit from additional stocking in the alternative stocking area 14104, 4) customer order 2 may not be required for pickup for greater than a threshold amount of time (e.g., there is plenty of time to pick customer order 2), and/or for any other reason. Note that the predicted item 8 in the picking GUI on the second MSD 14110-2 is intermixed with the customer order items. The predicted item 8 may be intermixed in such a manner due to location of the items. For example, predicted item 8 may be included in an efficient picking route between items 7 and 9. Although predicted item 8 is intermixed with other ordered items in FIG. 141, in other implementations, predicted items may be grouped separately from other items in a customer order (e.g., predicted item groups and/or individual predicted items may be rearranged separately from picking items). In some implementations, predicted item picking may be performed in a different picking interface than customer order picking. For example, a user that is dedicated to picking predicted items (e.g., for a period of time) may use a dedicated predicted item picking GUI (e.g., similar to other example picking GUIs described herein).

Various examples have been described. These and other examples are within the scope of the following claims.

What is claimed is:

1. A system comprising:
a customer application configured to:
render, on a customer device, a customer graphical user interface (GUI) including a plurality of items for sale at a store;
generate a customer order in response to input received from the customer, wherein the customer order includes a plurality of ordered items for picking in the store; and
generate an order modification interface configured to receive at least one of addition modifications, deletion modifications, and substitution modifications; and
a computing system configured to:
determine whether the customer order is eligible to be modified by the customer based on satisfaction of one or more modification eligibility conditions; and
send an eligibility determination to the customer device that indicates whether the customer order is eligible to be modified, wherein the customer application is configured to receive customer input in the order modification interface that modifies the customer order when the customer order is eligible to be modified.

2. The system of claim 1, wherein the modification eligibility conditions include a location eligibility condition that is not satisfied when the customer is traveling to the store.

3. The system of claim 1, wherein the modification eligibility conditions include a location eligibility condition that is satisfied when the customer is traveling to the store.

4. The system of claim 1, wherein the modification eligibility conditions include a location eligibility condition that is not satisfied when the customer is at the store.

5. The system of claim 1, wherein the modification eligibility conditions include at least one of a deletion-specific modification condition that indicates when an item can be deleted from the customer order, an addition-specific modification condition that indicates when an item can be added to the customer order, and a substitution-specific modification condition that indicates when an item in the customer order can be substituted with another item.

6. The system of claim 1, wherein the modification eligibility conditions include a modification eligibility condition based on an estimated customer time of arrival.

7. The system of claim 1, wherein the modification eligibility conditions include a modification eligibility condition based on whether the customer order is currently being picked by users in the store.

8. The system of claim 1, wherein the modification eligibility conditions include a modification eligibility condition based on whether the customer order has already been picked by users in the store.

9. The system of claim 1, wherein the modification eligibility conditions include a modification eligibility condition based on whether the customer order has been handed over to the customer at the store.

10. The system of claim 1, wherein the modification eligibility conditions include a modification eligibility condition based on whether a user is available to modify the customer order.

11. The system of claim 1, wherein the modification eligibility conditions include a modification eligibility condition based on a type of item to be added or deleted from the customer order.

12. The system of claim 1, wherein the modification eligibility conditions include a modification eligibility condition based on a number of modifications to be made to the customer order.

13. The system of claim 1, wherein the modification eligibility conditions include a modification eligibility condition based on whether an item to be added to the customer order has been advertised to the customer.

14. The system of claim 1, wherein the computing system is configured to:
determine that the customer order is eligible to be modified;
send an eligibility determination to the customer device that indicates the customer order is eligible to be modified; and
after determining that the customer order is eligible to be modified, determine that the customer order is no longer eligible to be modified.

15. The system of claim 1, wherein the customer application is configured to render, on the customer device, at least some of the modification eligibility conditions.
